(19) United States
(12) Patent Application Publication
(10) Pub. No.: US 2019/0205244 A1
(43) Pub. Date: Jul. 4, 2019

(54) MEMORY SYSTEM, METHOD AND COMPUTER PROGRAM PRODUCTS

(71) Applicant: P4TENTS1, LLC, Wilmington, DE (US)

(72) Inventor: Michael S. Smith, Palo Alto, CA (US)

(21) Appl. No.: 16/290,810

(22) Filed: Mar. 1, 2019

Related U.S. Application Data
(63) Continuation of application No. 15/835,419, filed on Dec. 7, 2017.
Application No. 15/835,419 is a continuation-in-part of application No. 15/250,873, filed on Aug. 29, 2016, now abandoned.
Application No. 15/250,873 is a continuation-in-part of application No. 14/981,867, filed on Dec. 28, 2015, now abandoned.
Application No. 14/981,867 is a continuation of application No. 14/589,937, filed on Jan. 5, 2015, now Pat. No. 9,223,507.
Application No. 14/589,937 is a continuation-in-part of application No. 13/441,132, filed on Apr. 6, 2012, now Pat. No. 8,930,647.
Application No. 15/250,873 is a continuation-in-part of application No. 13/710,411, filed on Dec. 10, 2012, now Pat. No. 9,432,298.
Application No. 15/250,873 is a continuation-in-part of application No. 14/169,127, filed on Jan. 30, 2014, now abandoned.
(60) Provisional application No. 61/502,100, filed on Jun. 28, 2011.
(60) Provisional application No. 61/472,558, filed on Apr. 6, 2011.
(60) Provisional application No. 61/569,107, filed on Dec. 9, 2011.
(60) Provisional application No. 61/580,300, filed on Dec. 26, 2011.
(60) Provisional application No. 61/585,640, filed on Jan. 11, 2012.
(60) Provisional application No. 61/602,034, filed on Feb. 22, 2012.
(60) Provisional application No. 61/608,085, filed on Mar. 7, 2012.
(60) Provisional application No. 61/635,834, filed on Apr. 19, 2012.
(60) Provisional application No. 61/647,492, filed on May 15, 2012.
(60) Provisional application No. 61/665,301, filed on Jun. 27, 2012.
(60) Provisional application No. 61/673,192, filed on Jul. 18, 2012.
(60) Provisional application No. 61/679,720, filed on Aug. 4, 2012.
(60) Provisional application No. 61/698,690, filed on Sep. 9, 2012.
(60) Provisional application No. 61/714,154, filed on Oct. 15, 2012.
(60) Provisional application No. 61/759,764, filed on Feb. 1, 2013.
(60) Provisional application No. 61/833,408, filed on Jun. 10, 2013.
(60) Provisional application No. 61/859,516, filed on Jul. 29, 2013.

(51) Int. Cl. G06F 12/02; G06F 12/12; G06F 12/0866; G06F 12/06; G06F 3/06

(52) U.S. Cl. CPC G06F 12/0215; G06F 12/12; G06F 12/0866; G06F 12/0638; G06F 3/0659; G06F 2212/205; G06F 3/0613; G06F 12/0246; G06F 3/0679; G06F 2212/7203; G06F 2212/654; G06F 3/065

(57) ABSTRACT

In various embodiments, an apparatus is provided, comprising: a first semiconductor platform including a first memory; and a second semiconductor platform stacked with the first semiconductor platform and including a second memory; wherein the apparatus is operable for: receiving a read command or write command, identifying one or more faulty components of the apparatus, and adjusting at least one timing in connection with the read command or write command, in response to the identification of the one or more faulty components of the apparatus.

### CROSS-REFERENCE TO RELATED APPLICATIONS

The present application is a continuation of, and claims priority to U.S. patent application Ser. No. 15/835,419, filed Dec. 7, 2017, entitled “SYSTEM, METHOD AND COMPUTER PROGRAM PRODUCT FOR FETCHING DATA BETWEEN AN EXECUTION OF A PLURALITY OF THREADS” which is a continuation-in-part of, and claims priority to U.S. patent application Ser. No. 15/250,873, filed Aug. 29, 2016, entitled “SYSTEM, METHOD AND COMPUTER PROGRAM PRODUCT FOR FETCHING DATA BETWEEN AN EXECUTION OF A PLURALITY OF THREADS,” which is a continuation-in-part of, and claims priority to U.S. patent application Ser. No. 14/981,867, filed Dec. 28, 2015, entitled “SYSTEM, METHOD AND COMPUTER PROGRAM PRODUCT FOR FETCHING DATA BETWEEN AN EXECUTION OF A PLURALITY OF THREADS,” which is a continuation of, and claims priority to U.S. patent application Ser. No. 14/589,937, filed Jan. 5, 2015, entitled “SYSTEM, METHOD AND COMPUTER PROGRAM PRODUCT FOR FETCHING DATA BETWEEN AN EXECUTION OF A PLURALITY OF THREADS,” now U.S. Pat. No. 9,223,507, which is a continuation-in-part of, and claims priority to U.S. patent application Ser. No. 13/441,132, filed Apr. 6, 2012, entitled “MULTIPLE CLASS MEMORY SYSTEMS,” now U.S. Pat. No. 8,930,647, which claims priority to U.S. Prov. App. No. 61/472,558 that was filed Apr. 6, 2011 and entitled “MULTIPLE CLASS MEMORY SYSTEM” and U.S. Prov. App. No. 61/502,100 that was filed Jun. 28, 2011 and entitled “SYSTEM, METHOD, AND COMPUTER PROGRAM PRODUCT FOR IMPROVING MEMORY SYSTEMS” which are each incorporated herein by reference in their entirety for all purposes.

U.S. patent application Ser. No. 15/250,873 is also a continuation-in-part of, and claims priority to U.S. patent application Ser. No. 13/710,411, filed Dec. 10, 2012, entitled “SYSTEM, METHOD, AND COMPUTER PROGRAM PRODUCT FOR IMPROVING MEMORY SYSTEMS”, now U.S. Pat. No. 9,432,298, which claims priority to U.S. Provisional Application No. 61/569,107 (Attorney Docket No.: SMITH090+), titled “SYSTEM, METHOD, AND COMPUTER PROGRAM PRODUCT FOR IMPROVING MEMORY SYSTEMS,” filed Dec. 9, 2011, U.S. Provisional Application No. 61/580,300 (Attorney Docket No.: SMITH100+), titled “SYSTEM, METHOD, AND COMPUTER PROGRAM PRODUCT FOR IMPROVING MEMORY SYSTEMS,” filed Dec. 26, 2011, U.S. Provisional Application No. 61/585,640 (Attorney Docket No.: SMITH110+), titled “SYSTEM, METHOD, AND COMPUTER PROGRAM PRODUCT FOR IMPROVING MEMORY SYSTEMS,” filed Jan. 11, 2012, U.S. Provisional Application No. 61/602,034 (Attorney Docket No.: SMITH120+), titled “SYSTEM, METHOD, AND COMPUTER PROGRAM PRODUCT FOR IMPROVING MEMORY SYSTEMS,” filed Feb. 22, 2012, U.S. Provisional Application No. 61/608,085 (Attorney Docket No.: SMITH130+), titled “SYSTEM, METHOD, AND COMPUTER PROGRAM PRODUCT FOR IMPROVING MEMORY SYSTEMS,” filed Mar. 7, 2012, U.S. Provisional Application No. 61/635,834 (Attorney Docket No.: SMITH140+), titled “SYSTEM, METHOD, AND COMPUTER PROGRAM PRODUCT FOR IMPROVING MEMORY SYSTEMS,” filed Apr. 19, 2012, U.S. Provisional Application No. 61/647,492 (Attorney Docket No.: SMITH150+), titled “SYSTEM, METHOD, AND COMPUTER PROGRAM PRODUCT FOR CONFIGURING A SYSTEM ASSOCIATED WITH MEMORY,” filed May 15, 2012, U.S. Provisional Application No. 61/665,301 (Attorney Docket No.: SMITH160+), titled “SYSTEM, METHOD, AND COMPUTER PROGRAM PRODUCT FOR ROUTING PACKETS OF DATA,” filed Jun. 27, 2012, U.S. Provisional Application No. 61/673,192 (Attorney Docket No.: SMITH170+), titled “SYSTEM, METHOD, AND COMPUTER PROGRAM PRODUCT FOR REDUCING A LATENCY ASSOCIATED WITH A MEMORY SYSTEM,” filed Jul. 18, 2012, U.S. Provisional Application No. 61/679,720 (Attorney Docket No.: SMITH180+), titled “SYSTEM, METHOD, AND COMPUTER PROGRAM PRODUCT FOR PROVIDING CONFIGURABLE COMMUNICATION PATHS TO MEMORY PORTIONS DURING OPERATION,” filed Aug. 4, 2012, U.S. Provisional Application No. 61/698,690 (Attorney Docket No.: SMITH190+), titled “SYSTEM, METHOD, AND COMPUTER PROGRAM PRODUCT FOR TRANSFORMING A PLURALITY OF COMMANDS OR PACKETS IN CONNECTION WITH AT LEAST ONE MEMORY,” filed Sep. 9, 2012, and U.S. Provisional Application No. 61/714,154 (Attorney Docket No.: SMITH210+), titled “SYSTEM, METHOD, AND COMPUTER PROGRAM PRODUCT FOR CONTROLLING A REFRESH ASSOCIATED WITH A MEMORY,” filed Oct. 15, 2012, all of which are incorporated herein by reference in their entirety for all purposes.

U.S. patent application Ser. No. 15/250,873 is also a continuation-in-part of, and claims priority to U.S. patent application Ser. No. 14/169,127, filed Jan. 30, 2014, entitled “SYSTEM, METHOD, AND COMPUTER PROGRAM PRODUCT FOR MODIFYING COMMANDS DIRECTED TO MEMORY”, which claims priority to U.S. Provisional Application No. 61/759,764 (Attorney Docket No.: SMITH230+), titled SYSTEM, METHOD, AND COMPUTER PROGRAM PRODUCT FOR MODIFYING COMMANDS DIRECTED TO MEMORY, filed Feb. 1, 2013, U.S. Provisional Application No. 61/833,408 (Attorney Docket No.: SMITH250+), titled SYSTEM, METHOD, AND COMPUTER PROGRAM PRODUCT FOR PATH OPTIMIZATION, filed Jun. 10, 2013, and U.S. Provisional Application No. 61/859,516 (Attorney Docket No.: SMITH270+), titled SYSTEM, METHOD, AND COMPUTER PROGRAM PRODUCT FOR IMPROVED MEMORY, filed Jul. 29, 2013, all of which is incorporated herein by reference in its entirety for all purposes.

If any definitions (e.g. figure reference signs, specialized terms, examples, data, information, definitions, conventions, glossary, etc.) from any related material (e.g. parent application, other related application, material incorporated by reference, material cited, extrinsic reference, etc.) conflict with this application (e.g. abstract, description, summary, claims, etc.) for any purpose (e.g. prosecution, claim support, claim interpretation, claim construction, etc.), then the definitions in this application shall apply.

### FIELD OF THE INVENTION AND BACKGROUND

Embodiments in the present disclosure generally relate to improvements in the field of memory systems.

### BRIEF SUMMARY

A system, method, and computer program product are provided for modifying commands directed to memory. A first semiconductor platform is provided including a first memory. Additionally, a second semiconductor platform is provided stacked with the first semiconductor platform and including a second memory. Further, at least one circuit is provided, which is separate from a processing unit and operable for receiving a plurality of first commands directed to at least one of the first memory or the second memory. Additionally, the at least one circuit is operable to modify one or more of the plurality of first commands directed to the first memory or the second memory.

A system, method, and computer program product are provided for optimizing a path between an input and an output of a stacked apparatus. Such apparatus includes a first semiconductor platform including a first memory, and a second semiconductor platform that is stacked with the first semiconductor platform and includes a second memory. Further included is at least one circuit separate from a processing unit. The at least one circuit is operable for cooperating with the first memory and the second memory. In use, the apparatus is operable to optimize a path between an input of the apparatus and an output of the apparatus.

A system, method, and computer program product are provided in association with an apparatus including a first semiconductor platform including a first memory, and second semiconductor platform stacked with the first semiconductor platform and including a second memory. In one embodiment, the apparatus may be operable for determining at least one timing associated with a refresh operation independent of a separate processor.

In another embodiment, the apparatus may be operable for receiving a read command or write command. Still yet, one or more faulty components of the apparatus maybe identified. In response to the identification of the one or more faulty components of the apparatus, at least one timing may be adjusted in connection with the read command or write command.

In yet another embodiment, the apparatus may be operable for receiving a first external command. In response to the first external command, a plurality of internal commands may be executed.

In still yet another embodiment, the apparatus may be operable for controlling access to at least a portion thereof. In even still yet another embodiment, the apparatus may be operable for supporting one or more compound commands. In still yet event another embodiment, the apparatus may be operable for accelerating at least one command.

In other embodiment, the apparatus may be operable for utilizing a first data protection code for an internal command, and utilizing a second data protection code for an external command. In another embodiment, the apparatus may be operable for utilizing a first data protection code for a packet of a first type, and utilizing a second data protection code for a packet of a second type. In other embodiments, the apparatus may be operable for utilizing a first data protection code for a first part of a command, and utilizing a second data protection code for a second part of the command.

### BRIEF DESCRIPTION OF THE SEVERAL VIEWS OF THE DRAWINGS

So that the features of various embodiments of the present invention can be understood, a more detailed description, briefly summarized above, may be had by reference to various embodiments, some of which are illustrated in the accompanying drawings. It is to be noted, however, that the accompanying drawings illustrate only embodiments and are therefore not to be considered limiting of the scope of the various embodiments of the invention, for the embodiment(s) may admit to other effective embodiments. The following detailed description makes reference to the accompanying drawings that are now briefly described.

FIG. 1 shows an apparatus for modifying commands directed to memory, in accordance with one embodiment.

FIG. 2 shows a memory system with multiple stacked memory packages, in accordance with one embodiment.

FIG. 3 shows a stacked memory package system, in accordance with one embodiment.

FIG. 4 shows a computation system for a stacked memory package system, in accordance with one embodiment.

FIG. 5 shows a stacked memory package system, in accordance with one embodiment.

FIG. 6 shows a stacked memory package system, in accordance with one embodiment.

FIG. 7 shows a part of the read/write datapath for a stacked memory package, in accordance with one embodiment.

FIG. 8 shows a stacked memory package repair system, in accordance with one embodiment.

FIG. 9 shows a programmable ordering system for a stacked memory package, in accordance with one embodiment.

FIG. 10 shows a stacked memory package system that supports atomic transactions, in accordance with one embodiment.

FIG. 11 shows a stacked memory package system that supports atomic operations across multiple stacked memory packages, in accordance with one embodiment.

FIG. 12 shows a stacked memory package system that supports atomic operations across multiple controllers and multiple stacked memory packages, in accordance with one embodiment.

FIG. 13 shows a CPU with wide I/O and stacked memory, in accordance with one embodiment.

FIG. 14 shows a test system for a stacked memory package system, in accordance with one embodiment.

FIG. 15 shows a stacked memory package system with data migration, in accordance with one embodiment.

FIG. 16 shows a stacked memory package read system, in accordance with one embodiment.

FIG. 17-1 shows an apparatus for path optimization, in accordance with one embodiment.

FIG. 17-2 shows a memory system with multiple stacked memory packages, in accordance with one embodiment.

FIG. 17-3 shows a part of the read/write datapath for a stacked memory package, in accordance with one embodiment.

FIG. 17-4 shows the read/write datapath for a stacked memory package, in accordance with one embodiment.

FIG. 17-5 shows an optimization system, part of a read/write datapath for a stacked memory package, in accordance with one embodiment.

FIG. 18-1 shows an apparatus for improved memory, in accordance with one embodiment.

FIG. 18-2 shows a memory system with multiple stacked memory packages, in accordance with one embodiment.

While one or more of the various embodiments of the invention is susceptible to various modifications, combinations, and alternative forms, various embodiments thereof are shown by way of example in the drawings and will herein be described in detail. It should be understood, however, that the accompanying drawings and detailed description are not intended to limit the embodiment(s) to the particular form disclosed, but on the contrary, the intention is to cover all modifications, combinations, equivalents and alternatives falling within the spirit and scope of the various embodiments of the present invention as defined by the relevant claims.

### DETAILED DESCRIPTION

### Terms, Definitions, Glossary and Conventions

Terms that are special to the field of the various embodiments of the invention or specific to this description may, in some circumstances, be defined in this description. Further, the first use of such terms (which may include the definition of that term) may be highlighted in italics just for the convenience of the reader. Similarly, some terms may be capitalized, again just for the convenience of the reader. It should be noted that such use of italics and/or capitalization and/or use of other conventions, by itself, should not be construed as somehow limiting such terms: beyond any given definition, and/or to any specific embodiments disclosed herein, etc.

More information on the Terms, Definitions, Glossary and Conventions may be found in U.S. Provisional Application No. 61/585,640, filed Jan. 31, 2012, titled “SYSTEM, METHOD, AND COMPUTER PROGRAM PRODUCT FOR IMPROVING MEMORY SYSTEMS;” U.S. Provisional Application No. 61/647,492, filed May 15, 2012, titled “SYSTEM, METHOD, AND COMPUTER PROGRAM PRODUCT FOR CONFIGURING A SYSTEM ASSOCIATED WITH MEMORY;” U.S. Provisional Application No. 61/714,154, filed Oct. 15, 2012, titled “SYSTEM, METHOD, AND COMPUTER PROGRAM PRODUCT FOR CONTROLLING A REFRESH ASSOCIATED WITH A MEMORY;” U.S. Provisional Application No. 61/759,764, filed Feb. 1, 2013, titled “SYSTEM, METHOD, AND COMPUTER PROGRAM PRODUCT FOR MODIFYING COMMANDS DIRECTED TO MEMORY;” U.S. application Ser. No. 13/710,411, filed Dec. 10, 2012, titled “SYSTEM, METHOD, AND COMPUTER PROGRAM PRODUCT FOR IMPROVING MEMORY SYSTEMS;” and U.S. Provisional Application No. 61/833,408, filed Jun. 10, 2013, titled “SYSTEM, METHOD, AND COMPUTER PROGRAM PRODUCT FOR PATH OPTIMIZATION”. Each of the foregoing applications are hereby incorporated by reference in their entirety for all purposes.

Example embodiments described herein may include computer system(s) with one or more central processor units (e.g. CPU, multicore CPU, etc.) and possibly one or more I/O unit(s) coupled to one or more memory systems that may contain one or more memory controllers and memory devices. As used herein, the term memory subsystem refers to, but is not limited to: one or more memory devices; one or more memory devices and associated interface and/or timing/control circuitry; and/or one or more memory devices in conjunction with memory buffer(s), register(s), hub device(s), other intermediate device(s) or circuit(s), and/or switch(es), combinations of these and/or other memory devices, circuits, and the like, etc. The term memory subsystem may also refer to one or more memory devices, in addition to any associated interface and/or timing/control circuitry and/or memory buffer(s), register(s), hub device(s) or switch(es), assembled into substrate(s), package(s), carrier(s), card(s), module(s) or related assembly, which may also include connector(s) or similar means of electrically attaching the memory subsystem with other circuitry, combinations of these, etc.

A multiprocessor is a coupled computer system having two or more processing units (e.g. CPUs, etc.) each sharing memory systems and peripherals. A processor in memory (PIM) may refer to a processor that may be tightly coupled with memory, generally on the same silicon die. Examples of PIM architectures may include IBM Shamrock, Gilgamesh, DIVA, IRAM, etc. PIM designs may be based on the combination of conventional processor cores (e.g. ARM, MIPS, etc.) with conventional memory (e.g. DRAM, etc.). A memory in processor (MIP) may refer to an integration of memory within logic, generally on the same silicon die. The logic may perform computation on data residing in the memory. PIM and MIP architectures may differ in one or more aspects. One difference between a MIP architecture and a PIM architecture, for example, may be that a MIP architecture may have common control for memory and computational logic.

A CPU may use one or more caches to store frequently used data and use a cache-coherency protocol to maintaining coherency (e.g. correctness, sensibility, consistency, etc.) of data between main memory (e.g. one or more memory systems, etc.) and one or more caches. Memory-read/write operations from/to cacheable memory may first check one or more caches to see if the operation target address is in (e.g. resides in, etc.) a cache line. A (cache) read hit, write hit, read miss, write miss, occurs if the address is/is not in a cache line. Data may be aligned in memory when the address of the data is a multiple of the data size in bytes (a byte is usually, but not required to be, 8 bits). For example, the address of an aligned short integer may be a multiple of two, while the address of an aligned integer may be a multiple of four. Cache lines may be fixed-size blocks aligned to addresses that may be multiples of the cache-line size in bytes (usually 32-bytes or 64-bytes). A cache-line fill may read an entire cache line from memory even if data that is a fraction of a cache line is requested. A cache-line fill typically evicts (e.g. removes, etc.) an existing cache line for the new cache line using cache line replacement. If the existing cache line was modified before replacement, a CPU may perform a cache-line writeback to main memory to maintain coherency between caches and main memory. A CPU may also maintain cache coherency by checking or internally probing internal caches and write buffers for a more recent version of the requested data. External devices can also check caches for more recent versions of data by externally probing.

A CPU may use one or more write buffers that may temporarily store writes when main memory or caches are busy. One or more write-combining buffers may combine multiple individual writes to main memory (e.g. performing writes using fewer transactions) and may be used if the order and size of non-cacheable writes to main memory is not important to software.

A multiprocessor system may use a cache coherency protocol to maintain coherency between CPUs. For example, a MOESI (with modified, owned, exclusive, shared, invalid states) protocol may be used. An invalid cache line (e.g. a cache line in the invalid state, marked invalid, etc.) does not hold the most recent data; the most recent data can be either in main memory or other CPU caches. An exclusive cache line holds the most recent data; main memory also holds the most recent data; no other CPU holds the most recent data. A shared cache line holds the most recent data; other CPUs in the system may also hold copies of the data in the shared state; if no other CPU holds it in the owned state, then the data in main memory is also the most recent. A modified cache line holds the most recent data; the copy in main memory is stale (incorrect, not the most recent), and no other CPU holds a copy. An owned cache line holds the most recent data; the owned state is similar to the shared state in that other CPUs can hold a copy of the most recent data; unlike the shared state, the copy in main memory can be stale; only one CPU can hold the data in the owned state, all other CPUs must hold the data in the shared state.

A CPU may perform transaction processing. For example, a CPU may perform operations, processing, computation, functions, etc. on data, information, etc. contained in (e.g. stored in, residing in, etc.) memory and possibly in a distributed fashion, manner, etc. In a computer system, it may be important to control the order of execution, how updates are made to memory, data, information, files and/or databases, and/or other aspects of collective computation, etc. One or more models, frameworks, etc. may describe, define, control, etc. the use of operations etc. and may use a set of definitions, rules, syntax, semantics, etc. using the concepts of transactions, tasks, composable tasks, noncomposable tasks, etc. For example, a bank account transfer operation (e.g. a type of transaction, etc.) might be decomposed (e.g. broken, separated, etc.) into the following steps: withdraw funds from a first account one and deposit funds into a second account. The transfer operation may be atomic. An operation (or set of operations) is atomic (also linearizable, indivisible, uninterruptible) if it appears to the rest of the system to occur instantaneously. For example, if step one fails, or step two fails, or a failure occurs between step one and step two, etc. the entire transfer operation should fail. The transfer operation may be consistent. For example, after the transfer operation succeeds, any other subsequent transaction should see the results of the transfer operation. The transfer operation may be isolated. For example, if another transaction tries to simultaneously perform an operation on either the first or second accounts, what they do to those accounts should not affect the outcome of the transfer option. The transfer operation may be durable. For example, after the transfer operation succeeds, if a failure occurs etc, there may be a record that the transfer took place. An operation, transaction, etc. that obeys these four properties (atomic, consistent, isolated, durable) may be ACID.

Transaction processing may use a number of terms and definitions. For example, tasks, transactions, composable, noncomposable, etc, as well as other terms and definitions used in transaction processing etc, may have different meanings in different contexts (e.g. with different uses, in different applications, etc.). One set of frameworks (e.g. systems, applications, etc.) that may be used, for example, for transaction processing, database processing, etc. may be languages (e.g. computer languages, programming languages, etc.) such as structured transaction definition language (STDL), structured query language (SQL), etc. For example, a transaction may be a set of operations, actions, etc. to files, databases, etc. that must take place as a set, group, etc. For example, operations may include read, write, add, delete, etc. All the operations in the set must complete or all operations may be reversed. Reversing the effects of a set of operations may roll back the transaction. If the transaction completes, the transaction may be committed. After a transaction is committed, the results of the set of operations may be available to other transactions. For example, a task may be a procedure that may control execution flow, delimit or demarcate transactions, handle exceptions, and may call procedures to perform, for example, processing functions, computation, access files, access databases (e.g. processing procedures) or obtain input, provide output (e.g. presentation procedures). For example, a composable task may execute within a transaction. For example, a noncomposable task may demarcate (e.g. delimit, set the boundaries for, etc.) the beginning and end of a transaction. A composable task may execute within a transaction started by a noncomposable task. Therefore, the composable task may always be part of another task's work. Calling a composable task may be similar to calling a processing procedure, e.g. based on a call and return model. Execution of the calling task may continue only when the called task completes. Control may pass to the called task (possibly with parameters, etc.), and then control may return to the calling task. The composable task may always be part of another task's transaction. A noncomposable task may call a composable task and both tasks may be located on different devices. In this case, their transaction may be a distributed transaction. There may be no logical distinction between a distributed and nondistributed transaction. Transactions may compose. For example, the process of composition may take separate transactions and add them together to create a larger single transaction. A composable system, for example, may be a system whose component parts do not interfere with each other. For example, a distributed car reservation system may access remote databases by calling composable tasks in remote task servers. For example, a reservation task at a rental site may call a task at the central site to store customer data in the central site rental database. The reservation task may call another task at the central site to store reservation data in the central site rental database and the history database. The use of composable tasks may enable a library of common functions to be implemented as tasks. For example, applications may require similar processing steps, operations, etc. to be performed at multiple stages, points, etc. For example, applications may require one or more tasks to perform the same processing function. Using a library, for example, common functions may be called from multiple points within a task or from different tasks. The terms task, process, processing, procedure, composable, and other related terms in the fields of systems design may have different meanings depending, for example, on their use, context, etc. For example, task may carry a generic or general meaning encompassing, for example, the motion of work to be done, etc. or may have a very specific meaning particular to a computer language construct (e.g. in STDL or similar). For example, the term transaction may similarly (e.g. similar to task) be used in a very general sense or as a very specific term in a computer program or computer language, etc. Where confusion may arise over these and other related terms, further clarification may be given at their point of use herein.

Transaction processing may use one or more specialized architectural features. For example, there may be a number of software and hardware architecture features that may be used to support transaction processing, database operations, parallel processing, multiprocessor systems, shared memory, etc. For example, computer systems may use (e.g. employ, have, require, support, etc.) a memory ordering that may determine the order in which a CPU (e.g. processor, etc.) issues (e.g. performs, executes, etc.) reads (e.g. loads) and writes (e.g. stores, etc.) to system memory (e.g. through the system bus, interconnect, buffers, etc.). For example, program order (also programmed order, strong ordering, strong order, etc.) may correspond to the order in which memory reference operations, instructions, etc. (e.g. loads/reads, stores/writes, etc.) may be specified in code (e.g. running on a CPU, in an instruction stream, etc.). For example, execution order may correspond to the order in which individual memory-reference instructions are executed on a CPU. The execution order may differ from program order (e.g. due to compiler and/or CPU-implementation optimizations, etc.). For example, perceived order may correspond to the order in which a given CPU perceives its and other CPUs' memory operations. The perceived order may differ from execution order (e.g. due to caching, interconnect and/or memory-system optimizations, etc.). For example, different CPUs may perceive the same memory operations as occurring in different orders.

A multiprocessor system may use a consistency mode. For example, a symmetric multiprocessor (SMP) system may use a memory-consistency model (also memory model, memory ordering, etc.). A sequential consistency model (also sequential consistency, SC, etc.) may perform all reads, writes, loads, stores in-order. A relaxed consistency model (also relaxed consistency, relaxed memory order, RMO, etc.) may allow some types of reordering. For example, loads may be reordered after loads. For example, loads may be reordered after stores. For example, stores may be reordered after stores. For example, stores may be reordered after loads. A weak consistency model may allow reads and writes to be arbitrarily reordered, limited only, for example, by explicit memory barrier instructions. Other memory models may be used (e.g. total-store order (ISO), partial-store order (PSO), program ordering, strong ordering, processor ordering, write ordering with store-buffer forwarding, etc.). For example, processor ordering (also called memory-ordering model e.g. by Intel) may be used by Intel processors, etc. For example, Intel processor ordering may allow reads to pass buffered writes, etc.

A memory system (e.g. main memory, cache, etc.) may use (e.g. include, comprise, contain, etc.) one or more types of memory. For example, a memory type may be an attribute of a region of memory (e.g. virtual memory, physical memory, etc.). Memory type may designate behaviors (e.g. caching, ordering, etc.) for operations (e.g. loads, stores, etc.). Memory types may be explicitly assigned. Some memory types may be inferred by the hardware (e.g. from CPU state, instruction context, etc.). For example, the AMD64 architecture defines the following memory types: Uncacheable (UC), Cache Disable (CD), Write-Combining (WC), Write-Combining Plus (WC+), Write-Protect (WP), Writethrough (WT), Writeback (WB). UC memory access (e.g. reads from or writes to) is not cacheable. Rules may be associated with memory types. For example, reads from UC memory cannot be speculative; write-combining to UC memory is not allowed. Actions may be associated with memory types. For example, UC memory access causes the write buffers to be written to memory and be invalidated prior to the access. Memory types may have different uses. For example, UC memory may be used with memory-mapped I/O devices for strict ordering of reads and writes. CD memory is a form of uncacheable memory that is inferred when the L1 caches are disabled but not invalidated, or for certain conflicting memory type assignments from the Page Attribute Table (PAT) and Memory Type Range Register (MTRR). WC memory access is not cacheable. WC memory reads can be speculative. WC memory writes can be combined internally by the CPU and written to memory as a single write operation. WC memory may be used for graphics-display memory buffers, for example, where the order of writes is not important. WC+ memory is an uncacheable memory type, and combines writes in write-combining buffers. Unlike WC memory (but like CD memory), WC+ memory access probes the caches on all CPUs (including the caches of the CPU issuing the request) to maintain coherency and ensure that cacheable writes are observed by WC+ accesses. WP memory reads are cacheable and allocate cache lines on a read miss. WP memory reads can be speculative. WP memory writes that hit in the cache do not update the cache. Instead, all WP memory writes update memory (write to memory), and WP memory writes that hit in the cache invalidate the cache line. Write buffering of WP memory is allowed. WP memory may be used, for example, in shadowed-ROM memory applications where updates must be immediately visible to all devices that read the shadow locations. WT memory reads are cacheable and allocate cache lines on a read miss. WT memory reads can be speculative. WT memory writes update main memory, and WT memory writes that hit in the cache update the cache line (cache lines remain in the same state after a write that hits a cache line). WT memory writes that miss the cache do not allocate a cache line. Write buffering of WT memory is allowed. WB memory reads are cacheable and allocate cache lines on a read miss. Cache lines can be allocated in the shared, exclusive, or modified states. WB memory reads can be speculative. All WB memory writes that hit in the cache update the cache line and place the cache line in the modified state. WB memory writes that miss the cache allocate a new cache line and place the cache line in the modified state. WB memory writes to main memory only take place during writeback operations. Write buffering of WB memory is allowed. WB memory may provide increased performance and may, for example, be used for most data stored in system memory (e.g. main memory, DRAM, etc.).

A memory system may use one or more memory models. For example, the memory model strength may depend on the type of memory type. For example, the Intel strong uncached memory type (Intel UC memory type) may enforce a strong ordering model. For example, the Intel write back memory type (Intel WB memory type, etc.) may enforce a weak ordering model in which, for example, reads may be performed speculatively, writes may be buffered and combined, etc.

A CPU may use memory ordering. For example, memory ordering may be altered, controlled, modified, etc. by using one or more serializing instructions. For example, a memory barrier (also compiler barrier, memory fence, fence instruction, etc.) may be a class of (e.g. type of, prefix to, etc.) an instruction, directive, macro, routine, function, etc. that may cause hardware (e.g. CPU, etc.) and/or software (e.g. compiler, etc.) to enforce an ordering constraint (e.g. restriction, control, semantic, etc.) on memory operations (e.g. reads, writes, etc.) that may be issued (executed, scheduled, etc.) before and after the memory barrier instruction. A hardware memory barrier may be an instruction provided in different CPU architectures (e.g. Intel IA64 mfence/sfence/lfence instructions, ARMv7 dmb/dsb instructions, etc.). Other instructions (e.g. Intel CPUID instruction, ARMv7 isb, etc.) may also be serializing instructions and/or perform synchronization, etc. Different memory barrier instructions may have different functions and semantics.

A compiler may use a memory barrier (also called a compiler memory barrier to avoid possible confusion with a hardware memory barrier) that may generate (e.g. create, emit, etc.) hardware memory barriers. A compiler memory barrier (e.g. Intel ECC _memory_barrier( ), _Microsoft Visual C++ Compiler ReadWriteBarrier( ), GCC_sync_synchronize, etc.) may prevent a compiler from reordering instructions during compilation, but may not prevent a CPU from reordering execution of the compiled code.

Code may contain keywords (also type qualifiers, etc.) that may control, modify, etc. ordering (e.g. of operations, program order, etc.) For example the volatile keyword may control the behavior of reading and/or writing to a variable (e.g. object, etc.). The behavior of operations on objects may be controlled by semantics. For example, a volatile write (e.g. a write to a volatile object, etc.) may have release semantics. For example, a volatile read may have acquire semantics. An operation OA may have acquire semantics if other CPUs will always see the effect of OA before the effect of any operation subsequent to OA. An operation OR may have release semantics if other CPUs will see the effect of every operation preceding OR before the effect of OR. Behavior of compilers may differ between languages. Behavior of different compilers for the same language may differ, even using the same keywords. Behavior of a keyword may be modified by compiler options, etc.

Code may contain OS functions etc. that may control memory ordering (e.g. Linux smp_mb( ), smp_rmb( ), smp_wmb( ), smp_read_barrier_depends( ), mmiowb( ), etc.). Thus, for example, Linux smp_mb( ) may create an AMD64 mfence instruction, etc.

Code (especially OS kernel code) may use various types of synchronization techniques. For example, techniques used by the Linux kernel may include: memory barriers, per-CPU variables, atomic operations, spin locks, semaphores, mutexes, seqlocks, local interrupt disable, local softirq disable, read-copy-update (RCU), etc.

Code may use per-CPU variables that may duplicate a data structure across multiple CPUs. For example, an atomic operation may include the use of a read-modify-write (RMW) instruction to a counter. For example, a spin lock may implement a lock with busy wait. For example, a semaphore may implement a lock with blocking wait (e.g. sleep, etc.). For example, a seqlock may implement a lock based on an access counter. For example, local interrupt disable may disable interrupt handling on a single CPU. For example, local softirq disable may disable deferrable function handling on a single CPU. For example, an RCU may implement lock-free access to shared data structures through pointers.

Code may use an operation (or set of operations) that may be an atomic operation (also linearizable, indivisible, uninterruptible, etc.) that may appear (e.g. to the rest of the system, etc.) to occur instantaneously, as a single event, etc. For example, several assembly language instructions may use RMW semantics. RMW instructions may access a memory location twice; first to read an old value and second to write a new value. For example, suppose that two kernel control paths running on two CPUs try to RMW the same memory location at the same time using nonatomic operations. At first, both CPUs may try to read the same location. The memory arbiter may serialize memory access and grant access to one CPU and delay the other. When the first read operation has completed, the delayed CPU reads the old value. Both CPUs may then try to write a new value to the memory location, racing each other. Eventually both write operations may succeed, but the two interleaving RMW operations may interfere with results depending on race conditions. One mechanism to prevent race conditions etc. may guarantee that operations are atomic. An atomic operation is executed as a single instruction without interruption and without conflicting access to memory locations used. Atomic operations may be used as a base, building block, foundation, etc. for other mechanisms (e.g. more flexible operations, to create critical regions, etc.). For example, the 80x86 assembly language instructions that perform zero or one aligned memory access operations may be atomic. An unaligned memory access may not be atomic. RMW assembly language instructions (e.g. inc, dec, etc.) that read data from memory, update it, and write the updated value back to memory are atomic if no other CPU has taken the memory bus after the read and before the write.

Code may use assembly language instructions with an opcode prefixed by the lock prefix or lock byte (e.g. 0xf0, etc.) that may be atomic. For example, when a CPU control unit decodes a lock prefix, it may lock the memory bus (e.g. prevent other access to shared memory, etc.) until the instruction with lock prefix is finished. A lock prefix may thus prevent access by other CPUs to one or more memory locations while the locked instruction is being executed.

Code may use assembly language instructions with an opcode prefixed by a repeat string operation prefix (e.g. REP prefix, rep byte, 0xf2, 0xf3, etc.) that are not atomic and that may signal a CPU control unit to repeat the instruction several times. For example, the control unit may check for pending interrupts before executing a new iteration.

Code (e.g. C code, source code, etc.) may use operations such as a=a+1 or a++ but a compiler may not guarantee the use of an atomic instruction for such operations. For example, the Linux kernel includes special types (e.g. atomic_t, local_t, atomically accessible counter types, etc.) with a set of special atomic functions and macros (e.g. atomic_set, atomic_read, etc.) that may be implemented using atomic assembly language instructions. On multiprocessor systems, each such instruction may be prefixed by a lock byte for example. An additional set of atomic functions (e.g. test_and_set_bit, test_and_clear_bit, test_and_change_bit, etc.) may be used to operate on bit masks.

Code and compilers may use optimizations, memory barriers, and/or other constructs that affect ordering of instructions. For example, an optimizing compiler may not guarantee that instructions will be performed in the exact order in which they appear in the source code. For example, a compiler may reorder instructions to optimize register use etc. For example, a CPU may execute one or more instructions in parallel and may reorder (e.g. move, shuffle, reorganize, modify, change, alter, etc.) memory access (e.g. to speed up program code, etc.). To achieve synchronization, it may be required to avoid reordering of instructions, access, etc. For example, it may be required to prevent an instruction placed after a synchronization primitive being executed before the synchronization primitive. For example, it may be required that synchronization primitives act as optimization and memory barriers.

Code may use an optimization barrier (also optimization barrier primitive, etc.) that may ensure that assembly language instructions that may correspond to statements (e.g. code, etc.) placed before the optimization barrier (e.g. primitive, etc.) are not reordered (e.g. by a compiler, etc.) with assembly language instructions corresponding to statements placed after the barrier. For example, the Linux barrier( ) macro may expand to (e.g. be inserted as, generated as, etc.) asm volatile (““:::”memory”) etc, and may act as an optimization barrier. For example, the inserted asm instruction may signal a compiler to insert an assembly language fragment. For example, the volatile keyword in the assembly language fragment may prevent a compiler from reordering (e.g. moving, etc.) the asm instruction. For example, the memory keyword in the assembly language fragment may signal a compiler that one or more memory locations may be changed by the assembly language instruction. Thus, for example, the compiler may be instructed not to optimize the code (e.g. by using values of memory locations stored in CPU registers before the asm instruction, etc.). An optimization barrier may not prevent a CPU from reordering the execution of the assembly language instructions (e.g. CPU instruction reordering, etc.). A memory barrier (also memory barrier primitive, etc.) may prevent CPU instruction reordering. For example, a memory barrier may guarantee that operations placed before the memory barrier are completed (e.g. executed, finished, etc.) before starting the operations placed after the memory barrier. For example, in 80x86 CPUs, the following types of assembly language instructions may be serializing and may act as memory barriers: (1) instructions that operate on I/O ports; (2) instructions prefixed by a lock byte; (3) instructions that write to control registers, system registers, debug registers (e.g. cli and sti that change the status of the IF flag in the eflags register, etc.); (4) lfence, sfence, mfence that implement a read memory barrier, a write memory barrier, a read-write memory barrier, respectively; (5) special assembly language instructions (e.g. iret that terminates an interrupt or exception handler, etc.). The Linux OS may use several memory barrier primitives that may act as optimization barriers and that may prevent a compiler from reordering assembly language instructions around the barrier. A read memory barrier acts only on instructions that read from memory. A write memory barrier acts only on instructions that write to memory. Memory barriers may be used in both multiprocessor systems and uniprocessor systems. The Linux smp_mb( ), smp_rmb( ), smp_wmb( ) memory barriers, for example, may be used to prevent race conditions that might occur only in multiprocessor systems. In uniprocessor systems these primitives may perform no function. Other memory barriers may be used to prevent race conditions occurring both in uniprocessor and multiprocessor systems. The implementation of memory barrier primitives may depend on the system architecture. On an 80x86 CPU, for example, a macro such as rmb( ) may expand to asm volatile (“lfence”) if the CPU supports the lfence assembly language instruction, or to asm volatile (“lock; addl $0,0(%% esp)”:::“memory”) if not. The asm statement may insert an assembly language fragment in the code generated by the compiler and the inserted lfence instruction then may act as a memory barrier. The assembly language instruction lock; addl $0,0(%% esp) adds zero to the memory location on top of the stack; the instruction performs nothing by itself, but the lock prefix may make the instruction act as a memory barrier. The wmb( ) macro may expand to barrier( ) for Intel CPUs that do not reorder write memory accesses, eliminating the need to insert a serializing assembly language instruction in the code. The macro, however, prevents the compiler from reordering the instructions. Notice that in multiprocessor systems, all atomic operations may act as memory barriers because they may use a lock byte.

Code may use a synchronization technique that may use one or more locks to perform locking. When a kernel control path, for example, requires access to a resource (e.g. shared data structure, a critical region, etc.), the kernel control path may acquire a lock for the resource, succeeding only if the resource is free, and the resource is then locked. When the kernel control path releases the lock, the resource is unlocked and another kernel control path may acquire the lock.

Code may use a spin lock, that may be designed to work in a multiprocessor environment. For example, if a kernel control path finds a spin lock open, it may acquire the spin lock and continue execution. If the kernel control path finds the spin lock closed (e.g. by another kernel control path running on another CPU, etc.), the kernel control path may spin (e.g. executing an instruction loop, etc.) until the spin lock is released. The instruction loop used by spin locks may represent a busy wait. For example, the kernel control path may spin and may be busy waiting, even with no work (e.g. tasks, etc.) to do. Spin locks may be used because many kernel resources may only be locked for a short time and it may be more time-consuming to release and then reacquire the CPU. Typically kernel preemption may be disabled in critical regions protected by spin locks. In the case of a uniprocessor system, the spin locks themselves may perform no function, and spin lock primitives may act to disable/enable kernel preemption. Note that kernel preemption may still be enabled during busy waiting, and thus a process busy waiting for release of a spin lock could be replaced by a higher priority process. In Linux, a spin lock may use a spinlock_t structure with two fields: slock, the spin lock state with 1 corresponding to unlocked, and negative values/0 corresponding to locked; break_lock, a flag that signals that a process is busy waiting for the lock. Macros (e.g. spin_lock, spin_unlock, spin_lock_irqsave, spin_unlock_irqrestore, etc.) may be used to initialize, test, set, etc. spin locks and may be atomic to ensure that a spin lock will be updated properly even when multiple processes running on different CPUs attempt to modify a spin lock at the same time. Spin locks may be global and therefore may be required to be protected against concurrent access.

Code may use one or more read/write spin locks that may allow several kernel control paths to simultaneously read the same data structure while no kernel control path modifies the data structure (e.g. to increase concurrency inside the kernel, etc.). If a kernel control path wishes to write to the data structure, the kernel control path may acquire the write version of the read/write spin lock that may grant exclusive access to the data structure. When using read/write spin locks, requests issued by kernel control paths to get/release a lock for reading (e.g. using read_lock( ), etc.) or writing (e.g. using write_lock( ), etc.) may have the same priority; readers must wait until the writer has finished; a writer must wait until all readers have finished.

Code may use a sequential lock (seqlock, also frlock) that may be similar to a read/write spin lock. A seqlock may give a higher priority to writers, allowing a writer to proceed even when readers are active. A writer never waits unless another writer is active. A reader may sometimes be forced to read the same data several times until it gets a valid copy. A seqlock may use a structure (e.g. seqlock_t, etc.) with two fields: a lock (e.g. type spinlock_t, etc.) and an integer that may act as a sequence counter (also sequence number, etc.). A seqlock may be used synchronize two writers and the sequence counter may indicate consistency to readers. When updating shared data, a writer increments the sequence counter, both after acquiring the lock and before releasing the lock. Readers check the sequence counter before and after reading shared data. If the sequence counter values are the same and odd, a writer may have taken the lock while data was being read and data may have changed. If the sequence counter values are different, a writer may have changed the data while it was being read. For either case readers may then retry until the sequence counter values are the same and even.

Code may use a read-copy-update (RCU) (also passive serialization, MP defer, etc.) that may be a synchronization mechanism used to protect data structures that may be accessed for reading by several CPUs. A RCU may determine when all threads have passed through a quiescent state since a particular time and are thus guaranteed to see the effects of any change prior to that time. An RCU may allow concurrent readers and many writers. An RCU may be lock-free (e.g. without locks, may use a counter shared by all CPUs, etc.) and this may be an advantage, for example, over read/write spin locks and seqlocks, that may have an overhead (e.g. due to cache line-snooping, invalidation, etc.). An RCU may synchronize CPUs without shared data structures by limiting the scope of RCU. Only data structures that are dynamically allocated and referenced by means of pointers can be protected by RCU. The kernel cannot go to sleep inside a critical region protected by RCU. Access to the shared resource should be read only most of the time with few writes. For example, when a Linux kernel control path wants to read a protected data structure, it may execute the rcu_read_lock( ) macro. The reader may then dereference the pointer to the data structure and starts reading and cannot sleep until it finishes reading the data structure. The end of a critical region may be marked by the rcu_read_unlock( ) macro. A writer may update the data structure by dereferencing the pointer, making a copy of the data structure, and modifying the copy. The writer may then change the pointer to the data structure to point to the modified copy. Changing the pointer may be an atomic operation, guaranteeing that each reader or writer sees either the old copy or the new one. A memory barrier may be required to guarantee that the updated pointer is seen by the other CPUs only after the data structure has been modified. Such a memory barrier may be included by using a spin lock with RCU to prevent concurrent writes. The old copy of the data structure cannot be freed right away when the writer updates the pointer because any readers accessing the data structure when the writer started an update could still be reading the old copy. The old copy may be freed only after all readers execute the rcu_read_unlock( ) macro. The kernel may require every potential reader to execute the rcu_read_unlock( ) macro before: the CPU performs a process switch, starts executing in user mode, or executes the idle loop. In each case the CPU passes through (e.g. goes through, transitions through, etc.) a quiescent state. A writer may use call_rcu( ) to delete the old copy of the data structure. The call_rcu( ) parameters may include the address of an rcu_head descriptor in the old copy of the data structure and the address of a callback function to be used when all CPUs have gone through a quiescent state and that may free the old copy of the data structure. The call_rcu( ) function stores the address of the callback function and parameters in the rcu_head descriptor, then inserts the descriptor in a list of callbacks for each CPU. Once every tick the kernel checks if the local CPU has passed through a quiescent state. When all the CPUs have passed through a quiescent state, a local task (e.g. tasklet, etc.) may execute all callbacks in the list. An RCU may be used in the Linux OS networking layer and in the Virtual Filesystem.

Code may use a mutex that may be a form of lock that enforces mutual exclusion. When a thread tries to lock a mutex, it is either acquired (if no other thread presently owns the mutex lock) or the requesting thread is put to sleep until the mutex lock is available again (in case another thread presently owns the mutex lock). When there are multiple threads waiting on a single mutex lock, the order in which the sleeping threads are woken is usually not determined. Mutexes are similar to spin locks but with a difference in the way the wait for the lock is handled. Threads are not put to sleep on spin locks, but spin while trying to acquire the spin lock. Thus, spin locks may have a faster response time (as no thread needs to be woken as soon as the lock is unlocked), but may waste CPU cycles in busy waiting. Spin locks may be used, for example, in High Performance Computing (HPC), because in many HPC applications each thread may be scheduled on its own CPU most of the time and therefore there is not much to gain in the time-consuming process of putting threads to sleep.

Code may use a semaphore that may be a form of lock that allows waiters to sleep until the desired resource becomes free. A mutex may be similar to a binary semaphore. A mutex may prevent two processes from accessing a shared resource concurrently in contrast to a binary semaphore that may limit access to a single resource. A mutex may have an owner, the process that locked the mutex, that may be the only process allowed to unlock the mutex. Semaphores may not have this restriction. The Linux OS, for example, may include two forms of semaphores: (1) kernel semaphores that may be used by kernel control paths; (2) System V IPC semaphores that may be used by user mode processes. A kernel semaphore may be similar to a spin lock and may not allow a kernel control path to proceed unless the kernel semaphore lock is open. However, whenever a kernel control path tries to acquire a busy resource protected by a kernel semaphore, the corresponding process may be suspended. The process may be run again when the resource is released. Therefore, kernel semaphores may be acquired only by functions that are allowed to sleep; interrupt handlers and deferrable functions, for example, cannot use kernel semaphores. In the Linux OS, a process may acquire a semaphore lock using the down( ) function that may atomically decrement the value of a semaphore counter and check the value; if the value is not negative the process may acquire the lock else the process is suspended. The up( ) function may release a lock and may atomically increment the semaphore counter and check the value is greater than zero; if the value is not greater than zero, a sleeping process may be woken.

Code may use a read/write semaphore that may be similar to a read/write spin lock except that waiting processes are suspended instead of spinning until the semaphore becomes open. Many kernel control paths may concurrently acquire a read/write semaphore for reading; however, every writer kernel control path must have exclusive access to the protected resource. Therefore, the read/write semaphore can be acquired for writing only if no other kernel control path is holding it for either read or write access. Read/write semaphores may improve concurrency inside the kernel and may thus improve system performance. The kernel may handle all processes waiting for a read/write semaphore in strict FIFO order. Each reader or writer that finds the semaphore closed may be inserted in the last position of a semaphore wait queue list. When the semaphore is released, the process in the first position of the wait queue list are checked. The first process is always woken. If the process is a writer, the other processes in the wait queue continue to sleep. If the process is a reader, all readers at the start of the wait queue, up to the first writer, are also woken and get the lock. However, readers that have been queued after a writer continue to sleep.

Code may use a completion mechanism that may be similar to a semaphore. Completions may solve a race condition that may, for example, occur in multiprocessor systems. For example, suppose process A allocates a temporary semaphore variable, initializes it as closed mutex, passes its address to process B, and then calls down( ) Process A may, for example, destroy the semaphore as soon as it wakes. Later, process B running on a different CPU may, for example, call up( ) on the semaphore. However, up( ) and down( ) may execute concurrently on the same semaphore. Process A may thus be woken and destroy the temporary semaphore, for example, while process B is still executing the up( ) function. As a result, up( ) may, for example, attempt to access a data structure that no longer exists. The completion data structure includes a wait queue head and a flag designed to solve this problem. The function equivalent to up( ) is complete( ) with the address of a completion data structure as argument. The complete( ) function calls spin_lock_irqsave( ) on the spin lock of the completion wait queue, increases the done field, wakes up the exclusive process sleeping in the wait queue, and calls spin_unlock_irqrestore( ). The function equivalent to down( ) is wait_for_completion( ) with the address of a completion data structure as an argument. The wait_for_completion( ) function checks the value of the done flag. If it is greater than zero, wait_for_completion( ) terminates, because complete( ) has been executed on another CPU. Otherwise, the function adds current to the tail of the wait queue as an exclusive process and puts current to sleep in the TASK_UNINTERRUPTIBLE state. Once woken up, the function removes current from the wait queue. Then, the function checks the value of the done flag: if equal to zero the function terminates, otherwise, the current process is suspended again. The functions complete( ) function and wait_for_completion( ) may use the spin lock in the completion wait queue. The difference between completions and semaphores is the use of the spin lock in the wait queue. Completions may use the spin lock to ensure that complete( ) and wait_for_completion( ) cannot execute concurrently. Semaphores may use the spin lock to prevent concurrent down( ) functions affecting the semaphore data structure.

A CPU may be connected to one or more hardware devices. Each hardware device controller may issue interrupt requests (also interrupts, etc.) using, for example, an Interrupt ReQuest (IRQ) signal (e.g. line, wire, etc.). IRQ signals (or IRQs) may be connected to the inputs (e.g. pins, terminals, etc.) of a Programmable Interrupt Controller (PIC), a hardware circuit (also Advanced PIC, APIC, I/O APIC, etc.), combinations of these and/or other interrupt handlers, interrupt controllers, and/or similar interrupt handling circuits, etc.

A CPU may use interrupt disabling. For example, interrupt disabling may be used to ensure that a section of kernel code is treated as a critical section. Interrupt disabling may, for example, allow a kernel control path to continue execution even when a hardware device (e.g. I/O device, etc.) may issue an interrupt request (e.g. IRQ, other interrupt signals, etc.) and thus may provide a mechanism to protect data structures that are also accessed by interrupt handlers. Local interrupt disabling may not protect against concurrent accesses to data structures by interrupt handlers running on other CPUs, so multiprocessor systems may use local interrupt disabling together with spin locks.

A CPU may use a soft interrupt (also softirq, deferrable function, etc.) that may be similar to a hardware interrupt, may be sent to the CPU asynchronously, and may be intended to handle events that may not be related to the running process. A softirq may be created by software, and may be delivered at a time that convenient to the kernel. Softirqs may enable asynchronous processing that may be inconvenient, inappropriate, etc. to be handled using a hardware interrupt including, for example, networking code. Deferrable functions may, for example, be executed at unpredictable times (e.g. termination of hardware interrupt handlers, etc.). Thus, for example, data structures accessed by deferrable functions may be protected against race conditions. In order, for example, to prevent deferrable function execution, interrupts may be disabled on the CPU. Because it may not be possible to activate an interrupt handler, softirqs etc. cannot be generated asynchronously. A kernel may thus, for example, need to disable deferrable functions without disabling interrupts. In Linux, local deferrable functions may be enabled or disabled on a local CPU, for example, by acting on the softirq counter stored in the preempt_count field of the current thread_info descriptor. The do_softirq( ) function never executes the softirqs if the softirq counter is positive. Since tasklet implementation is based on softirqs, setting the softirq counter to a positive value disables the execution of all deferrable functions on a given CPU, not just softirqs. The local_bh_disable macro adds one to the softirq counter of the local CPU, while the local_bh_enable( ) function subtracts one from it. A kernel may thus, for example, use several nested invocations of local_bh_disable. Deferrable functions will be enabled again only by the local_bh_enable macro matching the first local_bh_disable call.

A CPU may contain support for locks, ordering, synchronization, atomic operations, and/or other similar mechanisms. For example, Transactional Synchronization Extensions (TSX) may include Intel extensions to the x86 instruction set architecture to support hardware transactional memory. TSX provides two mechanisms to mark code regions for transactional execution: Hardware Lock Elision (HLE), and Restricted Transactional Memory (RTM). HLE uses instruction prefixes that are backward compatible to CPUs without TSX support. TSX enables optimistic execution of transactional code regions. CPU hardware monitors multiple threads for conflicting memory accesses and may abort and roll back transactions that cannot be successfully completed. Mechanisms are provided in TSX for software to detect and handle failed transactions. For example, HLE includes two instruction prefixes XACQUIRE and XRELEASE that reuse the opcodes of the existing REPNE/REPE prefixes (F2H/F3H). On CPUs that do not support TSX, the REPNE/REPE prefixes are ignored on instructions for which the XACQUIRE/XRELEASE are valid, thus providing backward compatibility. HLE allows optimistic execution of a critical code section by eliding the write to a lock, so that the lock appears to be free to other threads. A failed transaction results in execution restarting from the instruction with XACQUIRE prefix, but treats the instruction as if the prefix were not present. RTM provides a mechanism to specify a fallback code path that may be executed when a transaction cannot be successfully executed. RTM includes three instructions: XBEGIN, XEND, XABORT. The XBEGIN and XEND instructions mark the start and the end of a transactional code region. The XABORT instruction explicitly aborts a transaction. Transaction failure redirects the CPU to the fallback code path specified by the XBEGIN instruction, with abort status returned in the EAX register.

Example embodiments described herein may include computer system(s) with one or more central processor units (CPU) and possibly one or more I/O unit(s) coupled to one or more memory systems that may include one or more memory controllers and memory devices. As used herein, the term memory subsystem refers to, but is not limited to: one or more memory devices; one or more memory devices and associated interface and/or timing/control circuitry; and/or one or more memory devices in conjunction with memory buffer(s), register(s), hub device(s), other intermediate device(s) or circuit(s), and/or switch(es); combinations of these and the like, etc. The term memory subsystem may also refer to one or more memory devices in addition to any associated interface and/or timing/control circuitry and/or one or more memory buffer(s), register(s), hub device(s) and/or switch(es), combinations of these and the like, etc. that may be assembled into, on, with, etc. one or more substrate(s), package(s), carrier(s), card(s), module(s), combinations of these and/or related assemblies, etc. that may also include connector(s) and/or similar means of electrically attaching, linking, connecting, coupling, etc. the memory subsystem with other circuitry and the like, etc. Thus, for example, a memory system may include one or more memory subsystems.

A CPU may use one or more caches to store frequently used data. A system may use a cache-coherency protocol to maintaining coherency (e.g. correctness, sensibility, consistency, etc.) of data between main memory (e.g. one or more memory systems, etc.) and one or more caches. Memory-read/write operations from/to cacheable memory may first check one or more caches to see if the operation target address is in (e.g. resides in, etc.) a cache line. A (cache) read hit, write hit, read miss, write miss, occurs if the address is/is not in a cache line. Data may be aligned in memory when the address of the data is a multiple of the data size in bytes (a byte is usually, but not required to be, 8 bits). For example, the address of an aligned short integer may be a multiple of two, while the address of an aligned integer may be a multiple of four. Cache lines may be fixed-size blocks aligned to addresses that may be multiples of the cache-line size in bytes (usually 32-bytes or 64-bytes). A cache-line fill may read an entire cache line from memory even if data that is a fraction of a cache line is requested. A cache-line fill typically evicts (e.g. removes, replaces, etc.) an existing cache line for the new cache line using cache line replacement. If the existing cache line was modified before replacement, a CPU may perform a cache-line writeback to main memory to maintain coherency between caches and main memory. A CPU may also maintain cache coherency by checking or internally probing internal caches and write buffers for a more recent version of the requested data. External devices can also check caches for more recent versions of data by externally probing.

A cache may include a collection (e.g. pool, group, etc.) of cache entries (e.g. rows etc.). Each cache entry may have a piece of data with a copy of the same data in a backing store (e.g. main memory, memory system, disk system, etc.). Each cache entry may also have a cache tag, which may specify the identity (e.g. part of an address, etc.) of the data in the backing store.

A cache entry (also called cache row, row entry, cache line, line, etc.) may include a tag (also address, etc.), data block (also may be referred to as cache line, line, cache entry, row, block, contents, etc.), flag bits (e.g. dirty bit, valid bit, etc.). A memory address may be divided into (MSB to LSB) tag, index, block offset (offset, displacement). The index (line number) may indicate (e.g. be used as an index to address) the cache entry. The offset may indicate the data location (e.g. word position, etc.) within the cache entry

When a client (e.g. CPU etc.) accesses (e.g. reads, writes, etc.) data in the backing store, it may first check the cache. If an entry can be found with a tag that matches the tag of the required data, a cache hit, the data in the cache may be used. The percentage of accesses that are cache hits is the hit rate (or hit ratio) of the cache. If the cache does not to contain the required data, a cache miss, the data fetched from backing store may be copied to the cache. On a cache miss, an entry may be evicted to make room for new data. The algorithm to select the entry to evict (the victim) is the replacement policy. For example, a least recently used (LRU) replacement policy may replace the least recently used entry. Evicted entries may be stored in a victim cache.

A cache of size LKN bytes may be divided into N sets with K lines per set and L bytes per line. If the replacement policy may choose any entry (e.g. victim choice, etc.) in the cache to hold a copy, the cache is fully associative (N=1). If an entry may go in just one place, the cache is direct mapped (K=1). If an entry may go to one of K places, the cache is K-way set associative.

A compulsory miss (cold miss, first reference miss) is caused by the first reference to a location in memory. A capacity miss occurs regardless of the cache associativity or block size and is due to the finite size of the cache. A conflict miss could have been avoided if the cache had not evicted an entry earlier. A conflict miss can be a mapping miss, unavoidable with a given associativity, or a replacement miss, due to the replacement policy victim choice. A coherence miss occurs when an invalidate is issued by another CPU in a multi-CPU system.

The behavior on write miss is controlled by write hit policy. When a system writes data to a cache, the system must also write the data to backing store. In a write-through cache (also store-through cache), the write to cache and backing store is performed at the same time. In a write-back cache (also copy back cache, write-behind cache, store-in cache), the first write is to the cache and the second write to the backing store is delayed until data in the cache is about to be replaced by new data.

The behavior on write miss is controlled by write miss policy. A write that misses in the cache may (write-allocate) or may not (no-write-allocate) have a line allocated in the cache. A write that misses in the cache may (fetch-on-write) or may not (no-fetch-on-write) fetch the block being written. Data may be written into the cache before (write-before-hit) or only after (no-write-before-hit) checking the cache.

The combination of no-fetch-on-write and write-allocate is write-validate. The combination of write-before-hit, no-fetch-on-write, and no-write-allocate is write-invalidate. The combination of no-fetch-on-write, no-write-allocate, and no-write-before-hit is write-around.

Write misses that that do not result in any data being fetched with a write-validate, write-around, or write-invalidate policy are eliminated misses. A write purge invalidates the cache line on a write hit.

Flags may be used to mark cache entries. A write-back cache tracks the cache entries that have been updated and to be written to the backing store when they are evicted (using lazy write) by marking them as dirty (e.g. using a dirty bit, etc.). A valid bit may indicate whether or not a cache entry has been loaded with valid data and a cache entry may be invalidated by clearing (set to zero) the valid bit.

A fetch policy determines when data should be brought (e.g. fetched, read, loaded, etc.) into the cache. Data may be fetched only when not found in the cache (demand fetch or fetch on miss). Data may be fetched before it is required (prefetch or anticipatory fetch). A data prefetch may be speculative or informed.

Data in the backing store may be changed and thus a copy in the cache may become out-of-date or stale. When data in a cache is changed, copies of the data in other caches may become stale. The cache-coherency protocol may control communication between caches to keep the data coherent.

A CPU may use one or more write buffers (store buffers) that may temporarily store writes when backing store, main memory or caches are busy. One or more write-combining buffers (WCBs) may combine multiple individual writes (e.g. performing writes using fewer transactions) to backing store, main memory, etc. and may be used, for example, if the order and size of non-cacheable writes to main memory is not important to software.

A CPU may empty (e.g. drain, etc.) a write buffer (e.g. by writing the contents to memory, backing store, etc.) as a result of a fence instruction (also memory barrier, member, memory fence, or similar instruction, etc.). For example, x86 CPUs may include one or more of the following operations that may empty the write buffer: the store-fence instruction (SFENCE) forces all memory writes before the SFENCE (in program order) to be written into memory (or to the cache for WB type memory) before memory writes that follow the SFENCE instruction; the memory-fence instruction (MFENCE) is similar to SFENCE, but forces the ordering of loads (reads) and stores (writes); a serializing instruction forces the CPU to retire the serializing instruction and complete both instruction execution and result writeback before the next instruction is fetched from memory; before completing an I/O instruction all previous reads and writes are written to memory and the I/O instruction completes before subsequent reads or writes (writes to I/O address space using an OUT instruction are never buffered); a locked instruction using the LOCK prefix or an implicitly locked XCHG instruction complete after all previous reads and writes and before subsequent reads and writes (locked writes are never buffered, although locked reads and writes are cacheable); interrupts and exceptions are serializing events and force the CPU to empty the write buffer before fetching the first instruction from the interrupt or exception service routine; UC memory reads that are not reordered ahead of writes.

Write combining may allow multiple writes to be combined and temporarily stored in a WCB to be written later in a single write instead of separate writes. Write combining may not be used for general-purpose memory access as the weak ordering does not guarantee program order, etc. For example, a write/read/write sequence to a single address may lead to read/write/write order after write combining. The write buffer may be treated as a fully associative cache and added into the memory hierarchy. Writes to WC memory may be combined by the CPU in a WCB for transfer to main memory at a later time. For example, a number of small (e.g. doubleword etc.) writes to consecutive memory addresses may be combined and transferred to main memory as a single write operation of a complete cache line rather than as individual memory writes.

For example, in the x86 architecture the following instructions may perform writes to WC memory: (V)MASKMOVDQU, MASKMOVQ, (V)MOVNTDQ, MOVNTI, (V)MOVNTPD, (V)MOVNTPS, MOVNTQ, MOVNTSD, MOVNTSS. WC memory may not be cacheable e.g. a WCB may write only to main memory.

The CPU assigns an address range to an empty WCB when a WC-memory write occurs. The size and alignment of this address range is equal to the WCB size. All subsequent writes to WC memory that fall within this address range may be stored by the processor in the WCB entry until the CPU writes the WCB to main memory. After the WCB is written to main memory, the CPU may assign a new address range on a subsequent WC-memory write. Writes to consecutive addresses in WC memory are not required for the CPU to combine them The CPU may combine any WC memory write that falls within the active-address range for a WCB. Multiple writes to the same address may overwrite each other (in program order) until the WCB is written to main memory. It is possible for writes to proceed out of program order when WC memory is used. For example, a write to cacheable memory that follows a write to WC memory can be written into the cache before the WCB is written to main memory.

WCBs may be written to main memory under the same conditions as write buffers, when: executing a store-fence (SFENCE) instruction; executing a serializing instruction; executing an I/O instruction; executing a locked instruction (an instruction executed using the LOCK prefix; executing an XCHG instruction; an interrupt or exception occurs. WCBs are also written to main memory when: (1) a subsequent non-write-combining operation has a write address that matches the WC-buffer active-address range; (2) a write to WC memory falls outside the WCB address range in which case the existing buffer contents are written to main memory and a new address range is established for the latest WC write.

Example embodiments described herein may include systems including, for example, computer system(s) with one or more central processor units (CPUs) and possibly one or more I/O unit(s) coupled to one or more memory systems. A memory system may include one or more memory controllers and one or more memory devices (e.g. DRAM, and/or other memory circuits, functions, etc.). As used herein, the term memory subsystem may refer to, but is not limited to: one or more memory devices; one or more memory devices and associated interface and/or timing/control circuitry; and/or one or more memory devices in conjunction with one or more memory buffer(s), repeaters, register(s), hub device(s), other intermediate device(s) or circuit(s), and/or switch(es); combinations of these and the like, etc. The term memory subsystem may also refer to one or more memory devices in addition to any associated interface and/or timing/control circuitry and/or one or more memory buffer(s), register(s), repeater(s), hub device(s) and/or switch(es), combinations of these and other similar circuits, functions, and the like, etc. that may be assembled into, on, with, etc. one or more substrate(s), package(s), carrier(s), card(s), module(s), combinations of these and/or related assemblies and the like, etc. that may also include connector(s) and/or similar means of electrically attaching, linking, connecting, coupling, etc. the memory subsystem with other circuitry, blocks, functions, and the like, etc. Thus, for example, a memory system may include one or more memory subsystems.

Note that the terms, definitions, etc. described below may be included in this section of the specification merely to avoid repetition, etc. elsewhere in the body of the specification. Inclusion of any term, definition, description, etc. in this section does not imply any limitation whatsoever.

A memory subsystem may include one or more memory controllers, similar functions, and the like. A memory controller may contain, include, etc. one or more logic, circuits, functions, etc. used to enable, perform, execute, control etc. operations to read and write to memory, and/or enable etc. any other functions, operations, etc. (e.g. to refresh DRAM, perform configuration tasks, etc.). A memory controller, for example, may receive one or more requests (e.g. read requests, write requests, etc.) and may create, generate, etc. one or more commands (e.g. DRAM commands, etc.) and/or may create, generate, etc. one or more signals (e.g. DRAM control signals, any other DRAM signals, and/or any other signals and the like, etc.).

Note that the term command (also commands, transactions, etc.) may be used in this specification and/or any other specifications incorporated by reference to encompass (e.g. include, contain, describe, etc.) all types of commands (e.g. as in command structure, command set, etc.), which may include, for example, the number, type, format, lengths, structure, etc. of responses, completions, messages, status, probes, etc. or may be used to indicate a read command or write command (or read/write request, etc.) as opposed (e.g. in comparison with, separate from, etc.) a read/write response, or read/write completion, etc. A specific memory technology (e.g. DRAM, NAND flash, PCM, etc.) may have (e.g. use, define, etc.) additional commands in a command set in addition to and/or as part of basic read and write commands. For example, SDRAM memory technology may use NOP (no command, no operation, etc.), activate, precharge, precharge all, various forms of read command or various types of read command (e.g. burst read, read with auto precharge, etc.), various write commands (e.g. burst write, write with auto precharge, etc.), auto refresh, load mode register, etc. Note also that these technology specific commands (e.g. raw commands, test commands, etc.) may themselves form a command set. Thus, it may be possible to have a first command set, such as a technology-specific command set for SDRAM (e.g. NOP, precharge, activate, read, write, etc.), contained, included, etc. within a second command set, such as a set of packet formats used in a memory system network, for example. Note also that the term command set may be used, for example, to describe the protocol, packet formats, fields, lengths, etc. of packets and/or any other methods (e.g. using signals, buses, etc.) of carrying (e.g. conveying, coupling, transmitting, etc.) one or more commands, responses, requests, completions, messages, probes, status, etc. The command packets (e.g. in a network command set, network protocol, etc.) may contain, include, etc. one or more codes, bits, fields, etc. that may represent (e.g. stand for, encode, convey, carry, transmit, etc.) one or more commands (e.g. commands, responses, requests, completions, messages, probes, status, etc.). For example, different bit patterns in a command field of a packet may represent a read request, write request, read completion, write completion (e.g. for nonposted writes, etc.), status, probe, technology specific command (e.g. activate, precharge, read, write, etc. for SDRAM, etc.), combinations of these and/or any other commands, etc. Note further that command packets, in a memory system network for example, may include one or more commands from a technology-specific command set or that may be translated to one or more commands from a technology-specific command set. For example, a read command packet may contain, include, etc. one or more instructions (or be translated to instructions, contain/include codes that result in, etc.) to issue an SDRAM precharge command. For example, a 64-byte read command packet may be translated (e.g. by one or more logic chips in a stacked memory package, etc.) to a group of commands. For example, the group of commands may include one or more precharge commands, one or more activate commands, and (for example) eight 64-bit read commands to one or more memory regions in one or more stacked memory chips, etc. Note that a command packet may not always be translated to the same group of commands. For example, a read command packet may not always employ a precharge command, etc. The distinction between these slightly different interpretations, uses, etc. of the term command(s) may typically be inferred from the context. Where there may be ambiguity with the term command(s) the context may be made clearer or guidance may be given, for example, by listing commands, examples of commands (e.g. read commands, write commands, etc.). Note that commands may not necessarily be limited to read commands and/or write commands (and/or read/write requests and/or any other commands, messages, probes, status, errors, etc.). Note that the use of the term command herein should not be interpreted to imply that, for example, requests or completions are excluded or that any type, form, etc. of command, instruction, operation, and the like is excluded. For example, in one embodiment, a read command issued by a system CPU and/or other system component etc. to a stacked memory package may be translated, transformed, etc. to one or more technology specific read commands that may be issued to one or more (possibly different) memory technologies in one or more stacked memory chips. Any command, instruction, etc. may be issued etc. by any system component etc. in this fashion, manner, etc. For example, in one embodiment, one or more read commands issued by a system CPU etc. to a stacked memory package may correspond to one or more technology specific read commands that may be issued to one or more (possibly different) memory technologies in one or more stacked memory chips. For example, a system CPU etc. may issue one or more native, raw, etc. SDRAM commands and/or one or more native, raw etc. NAND flash commands, etc. Any native, raw, technology specific, etc. command may be issued etc. by any system component etc. in this fashion and/or similar fashion, manner, etc. Note that once the use and meaning of the term command(s) has been established and/or guidance to the meaning of the term command(s) has been provided in a particular context herein any definition or clarification, etc. may not be repeated each time the term is used in that same or similar context.

Thus, for example, a memory controller may receive one or more requests (e.g. read requests, write requests, etc.) that may also be referred to as commands (e.g. these commands may be transmitted in packet form with one or more fields indicating the type of command (e.g. read command, write command, etc.). Thus, for example, a memory controller may create, generate, etc. one or more commands (e.g. DRAM commands, etc.) and these generated commands may also include read commands, write commands, etc. In general these generated commands may be in a different format, form, may have a different structure, etc. than the commands received by the memory controller. For example, the commands received by the memory controller may be in packet form while the commands generated by the memory controller may be encoded in one or more signals (e.g. control signals, address signals, any other signals, etc.) coupled to one or more memory circuits (e.g. DRAM), etc.

A memory controller may perform one or more functions etc. to order, schedule, etc. and/or otherwise manage, control, etc. the generated commands. The functions etc. may include those of a memory access scheduler. A memory access scheduler may generate, create, manage, control, etc. a schedule that may meet, conform to, etc. the timing, resource, and/or any other constraints, parameters, etc. of a DRAM or any other memory technology, etc. A schedule, may for example, dictate, manage, control, list, and/or otherwise specify the order, timing, priority, etc. of one or more commands. Any memory technology, and/or combinations of memory technologies may be used in one or more embodiments described herein and/or in one or more specifications incorporated by reference, but DRAM and DDR SDRAM may be used as an example. Thus, for example, DRAM and DDR SDRAM may be used as an example to describe and/or illustrate the implementation, architecture, design, etc. of a memory controller, memory access scheduler, scheduling, and/or any other related circuits, functions, behaviors, and the like etc.

A DRAM may have organization (e.g. dimensions, partitions, parts, portions, etc.) that may include one or more banks, rows, and columns. Any partitioning of memory may be used (e.g. including ranks, mats, echelons, sections, etc. as defined above, elsewhere in this specification, and/or in one or more specifications incorporated by reference, etc.). Each bank may operate independently of the other banks and may contain, include, etc. an array, set, collection, group, etc. of memory cells that may be accessed (e.g. read, write, etc.) a row at a time. When a row of this memory array is accessed (row activation) a row of the memory array may transferred, copied, etc. to the bank row buffer (also just row buffer). The row buffer may serve, function, etc. as a cache, store, etc. to reduce the latency of subsequent access to that row. While a row is active in the row buffer, any number of reads or writes (column accesses) may be performed. After completion of the column access, the cached row may be written back to the memory array by performing a bank precharge operation that prepares the bank for a subsequent row activation cycle.

Each DRAM bank may have two main states: IDLE and ACTIVE, In the IDLE state, the DRAM may be precharged, ready for a row access, and may remain in this state until a row activate operation (e.g. activate command, ACT command, or just activation, etc.) is performed on, issued to, etc. the bank. The address and control signals may be used to select the rank, bank, row (page) etc. being activated (also referred to as being opened). Row activation may employ a delay tRCD, during which no other operations may be performed on the bank. A memory controller may thus mark, record, etc. the bank being activated as busy, used, etc. resource for the duration of the activation operation. Operations may be performed on any other banks of the DRAM. Once the row is activated, the bank may enter the ACTIVE state (and the bank may be referred to as open), during which the contents of the selected row are held in the bank row buffer. Any number of pipelined column accesses may be performed while the (open) bank is in the ACTIVE state. To perform either a read or write column access, the address and control signals may be used to select the rank, bank, starting column address etc. of the active row in the selected (open) bank. The time to read a data from the active row (also known as the open page) is tCAS. Note that additional timing constraints may apply depending, for example, on the type, generation, etc. of DRAM, etc. used. A bank may remain in the ACTIVE state until a precharge operation is issued to return the bank to the IDLE state by either issuing a precharge command (PRE) to close the selected bank or a precharge all command to close all open banks (e.g. in a rank, etc.). The precharge operation may employ the use of the address lines to select the bank to be precharged. The precharge operation may use the bank resources for a time tRP, and during that time no further operations may be performed on that bank. A read with auto-precharge or write with auto-precharge command may also be used. Operations may be issued to any other banks during this time. After precharge, the bank may be returned to the IDLE state and may be ready for a new row activation cycle. The minimum time between successive ACT commands to the same bank may be tRC. The minimum time between ACT commands to different banks may be tRRD. Of course, the timing parameters, detailed functional operation, states, etc. described above may vary, change, be different, etc. for different memory technologies, generations of memory technologies (e.g. DDR3, DDR4, etc.), versions of memory technologies (e.g. low-power versions, LPDRAM, etc.), and/or be different with respect to any other similar aspects, features, etc. of memory technologies, etc.

Memory access scheduling may include the process of ordering the memory (e.g. DRAM etc.) operations (e.g. DRAM bank precharge, row activation, and column access) used to satisfy a set of currently pending memory references. An operation may be a memory (e.g. DRAM etc.) command, (e.g. a DRAM row activation or a column access, etc.) e.g. as issued by a memory controller to memory, a DRAM, etc. A memory reference (or just reference) may be a reference to a memory location e.g. generated by a system CPU etc. including loads (reads) or stores (writes) to a memory location. A single memory reference may generate one or more memory operations depending on the schedule.

A memory access scheduler may process a set of pending memory references and may chose one or more operations (e.g. one or more DRAM row, column, or precharge operations, etc.) each cycle, time slot, period, etc. subject to resource constraints, in order to advance and/or otherwise process etc. one or more of the pending memory references. For example, a scheduling algorithm may consider the oldest pending memory reference. For example, this scheduling algorithm may satisfy memory references in the order of arrival. For example, if it is possible to perform, process, etc. a memory reference by performing, processing, etc. an operation, then the memory controller may perform, process, etc. the associated, corresponding, etc. memory access. If it is not possible, preferable, desirable, optimal, etc. to perform, process, etc. the operation employed by the oldest pending memory reference, the memory controller may perform, process, etc. operations for any other pending memory references. As memory references arrive, they may be stored, saved, kept, etc. (e.g. in a table, list, FIFO, any other data structure(s), etc.) and may wait, be queued, be prioritized, etc. to be processed by the memory access scheduler. Memory references may be sorted, prioritized, arranged, etc. (e.g. by DRAM bank, and/or by any parameter, metric, value, number, attribute, aspect, etc.). The stored pending memory references may include, but are not necessarily limited to, the following fields: load/store (L/S), address (row and column), data, and any additional state used by the scheduling algorithm. Examples of state that may be accessed, modified etc. by the scheduler are the age of the memory reference and if the memory reference targets the currently active row.

Each bank may have a precharge manager and a row arbiter. The precharge manager may decide when its associated bank should be precharged. The row arbiter for each bank may decide the row, if any, to be activated when that bank is idle. A column arbiter may be shared by all banks. The column arbiter may grant shared data bus resources to a single column access from all the pending references to all of the banks. The precharge managers, row arbiters, column arbiter, etc. may transmit the selected operations to an address arbiter that may grant shared address resources to one or more of the selected operations.

The precharge managers, row arbiters, column arbiter, etc. may use one or more policies to select DRAM operations. The combination of policies used by the precharge managers, row arbiters, column arbiter, etc. together with the address arbiter policy, may determine the memory access scheduling algorithm. The address arbiter may decide which of the selected precharge, activate, column operations, etc. to perform e.g. subject to the constraints of the address bus and/or any other resources, etc. One or more additional policies may be used including those, for example, that may select precharge operations first, row operations first, column operations first, etc. A column-first scheduling policy may, for example, reduce the access latency to active rows. A precharge-first or row-first scheduling policy may, for example, increase the amount of bank parallelism.

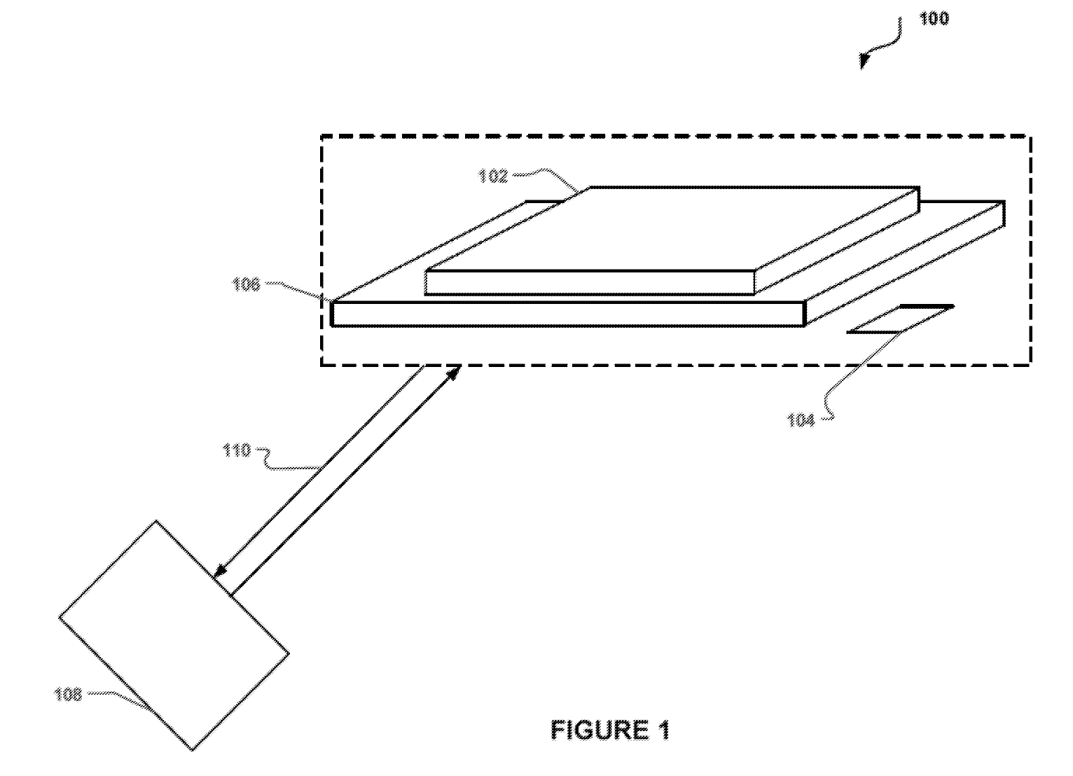

FIG. 1

FIG. 1 shows an apparatus 100 for modifying commands directed to memory, in accordance with one embodiment. As an option, the apparatus 100 may be implemented in the context of any subsequent Figure(s). Of course, however, the apparatus 100 may be implemented in the context of any desired environment.

It should be noted that a variety of optional architectures, capabilities, and/or features will now be set forth in the context of a variety of embodiments in connection with a description of FIG. 1. Any one or more of such optional architectures, capabilities, and/or features may or may not be used in combination with any other one or more of such described optional architectures, capabilities, and/or features. Of course, embodiments are contemplated where any one or more of such optional architectures, capabilities, and/or features may be used alone without any of the other optional architectures, capabilities, and/or features.

As shown, in one embodiment, the apparatus 100 includes a first semiconductor platform 102, which may include a first memory. Additionally, in one embodiment, the apparatus 100 may include a second semiconductor platform 106 stacked with the first semiconductor platform 102. In one embodiment, the second semiconductor platform 106 may include a second memory. As an option, the first memory may be of a first memory class. Additionally, in one embodiment, the second memory may be of a second memory class. Of course, in one embodiment, the apparatus 100 may include multiple semiconductor platforms stacked with the first semiconductor platform 102 or no other semiconductor platforms stacked with the first semiconductor platform.

In another embodiment, a plurality of stacks may be provided, at least one of which includes the first semiconductor platform 102 including a first memory of a first memory class, and at least another one which includes the second semiconductor platform 106 including a second memory of a second memory class. Just by way of example, memories of different classes may be stacked with other components in separate stacks, in accordance with one embodiment. To this end, any of the components described above (and hereinafter) may be arranged in any desired stacked relationship (in any combination) in one or more stacks, in various possible embodiments. Furthermore, in one embodiment, the components or platforms may be configured in a non-stacked manner. Furthermore, in one embodiment, the components or platforms may not be physically touching or physically joined. For example, one or more components or platforms may be coupled optically, and/or by other remote coupling techniques (e.g. wireless, near-field communication, inductive, combinations of these and/or other remote coupling, etc.).

In another embodiment, the apparatus 100 may include a physical memory sub-system. In the context of the present description, physical memory may refer to any memory including physical objects or memory components. For example, in one embodiment, the physical memory may include semiconductor memory cells. Furthermore, in various embodiments, the physical memory may include, but is not limited to, any memory that meets the above definition. In various embodiments, the physical memory may include (but is not limited to) one or more of the following: flash memory (e.g. NOR flash, NAND flash, etc.), random access memory (e.g. RAM, SRAM, DRAM, SDRAM, eDRAM, embedded DRAM, MRAM, ST-MRAM, STT-MRAM, PRAM, PCRAM, combinations of these, etc.), memristor, phase-change memory, FeRAM, FRAM, PRAM, MRAM, resistive RAM, RRAM, spin-torque memory, logic NVM, EEPROM, solid-state disk (SSD) (or other disk, magnetic media, etc.), combinations of these and/or any other physical memory technology and/or other similar memory technology and the like, etc. (volatile memory, nonvolatile memory, etc.).

Additionally, in various embodiments, the physical memory sub-system may include a monolithic memory circuit, a semiconductor die, a chip, a packaged memory circuit, or any other type of tangible memory circuit, or any intangible grouping of tangible memory circuits, combinations of these, etc. In one embodiment, the apparatus 100 or associated physical memory sub-system may take the form of a dynamic random access memory (DRAM) circuit. Such DRAM may take any form including, but not limited to, synchronous DRAM (SDRAM), double data rate synchronous DRAM (DDR SDRAM, DDR2 SDRAM, DDR3 SDRAM, DDR4 SDRAM, etc.), graphics double data rate DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data out DRAM (EDO DRAM), burst EDO RAM (BEDO DRAM), multibank DRAM (MDRAM), synchronous graphics RAM (SGRAM), low-power DRAM (LPDRAM), combinations of these and/or any other DRAM or similar memory technology.

In the context of the present description, a memory class may refer to any memory classification of a memory technology. For example, in various embodiments, the memory class may include, but is not limited to, a flash memory class, a RAM memory class, an SSD memory class, a magnetic media class, and/or any other class of memory in which a type of memory may be classified. Still yet, it should be noted that the memory classification of memory technology may further include a usage classification of memory, where such usage may include, but is not limited power usage, bandwidth usage, speed usage, etc. In embodiments where the memory class includes a usage classification, physical aspects of memories may or may not be identical.

In the one embodiment, the first memory class may include non-volatile memory (NVM) (e.g. FeRAM, MRAM, PRAM, combinations of these and/or any non-volatile memory technology, etc.), and the second memory class may include volatile memory (e.g. SRAM, DRAM, T-RAM, Z-RAM, TTRAM, combinations of these and/or any volatile memory technology, etc.). In another embodiment, one of the first memory or the second memory may include RAM (e.g. DRAM, SRAM, etc.) and the other one of the first memory or the second memory may include NAND flash. In another embodiment, one of the first memory or the second memory may include RAM (e.g. DRAM, SRAM, etc.) and the other one of the first memory or the second memory may include NOR flash. Of course, in various embodiments, any number (e.g. 2, 3, 4, 5, 6, 7, 8, 9, or more, etc.) of combinations of memory classes may be utilized. In the one embodiment, one or more classes of memory may use any combination of one or more memory technologies, etc.

In one embodiment, there may be connections (not shown) that are in communication with the first memory and pass through the second semiconductor platform 106. Such connections that are in communication with the first memory and pass through the second semiconductor platform 106 may be formed utilizing through-silicon via (TSV) technology or any other similar connection technology. Additionally, in one embodiment, the connections may be communicatively coupled to the second memory.

For example, in one embodiment, the second memory may be communicatively coupled to the first memory. In the context of the present description, being communicatively coupled refers to being coupled in any way that functions to allow any type of signal (e.g. a data signal, an electric signal, etc.) to be communicated between the communicatively coupled items. In one embodiment, the second memory may be communicatively coupled to the first memory via direct contact (e.g. a direct connection, etc.) between the two memories. Of course, being communicatively coupled may also refer to indirect connections, connections with intermediate connections therebetween, etc. In another embodiment, the second memory may be communicatively coupled to the first memory via a bus. In one embodiment, the second memory may be communicatively coupled to the first memory utilizing one or more TSVs or similar connection technology.

As another option, the communicative coupling may include a connection via a buffer device. In one embodiment, the buffer device may be part of the apparatus 100. In another embodiment, the buffer device may be separate from the apparatus 100.

Further, in one embodiment, at least one additional semiconductor platform (not shown) may be stacked with the first semiconductor platform 102 and the second semiconductor platform 106. In this case, in one embodiment, the additional semiconductor may include a third memory of at least one of the first memory class or the second memory class, and/or any other additional circuitry. In another embodiment, the at least one additional semiconductor may include a third memory of a third memory class.

In one embodiment, the additional semiconductor platform may be positioned between the first semiconductor platform 102 and the second semiconductor platform 106. In another embodiment, the at least one additional semiconductor platform may be positioned above the first semiconductor platform 102 and the second semiconductor platform 106. Further, in one embodiment, the additional semiconductor platform may be in communication with at least one of the first semiconductor platform 102 and/or the second semiconductor platform 102 utilizing wire bond technology.

Additionally, in one embodiment, the additional semiconductor platform may include additional circuitry in the form of a logic circuit. In this case, in one embodiment, the logic circuit may be in communication with at least one of the first memory or the second memory. In one embodiment, at least one of the first memory or the second memory may include a plurality of subarrays in communication via shared data bus.

Furthermore, in one embodiment, the logic circuit may be in communication with at least one of the first memory or the second memory utilizing TSV technology or similar connection technology. In one embodiment, the logic circuit and the first memory of the first semiconductor platform 102 may be in communication via a buffer. In this case, in one embodiment, the buffer may include a row buffer.

Further, in one embodiment, the apparatus 100 may be configured such that the first memory and the second memory are capable of receiving instructions via a single memory bus 110. The memory bus 110 may include any type of memory bus. Additionally, the memory bus may be associated with a variety of protocols (e.g. memory protocols such as JEDEC DDR2, JEDEC DDR3, JEDEC DDR4, SLDRAM, RDRAM, LPDRAM, LPDDR, combinations of these, etc; protocols such as Wide I/O, Wide I/O SDR, etc; I/O protocols such as PCI, PCI-E, HyperTransport, InfiniBand, QPI, etc; networking protocols such as Ethernet, TCP/IP, iSCSI, combinations of these, etc; storage protocols such as NFS, SAMBA, SAS, SATA, FC, etc; combinations of these and/or other protocols (e.g. wireless, optical, inductive, NFC, etc.); etc.). Of course, other embodiments are contemplated with multiple memory buses.

In one embodiment, the apparatus 100 may include a three-dimensional integrated circuit. In one embodiment, the first semiconductor platform 102 and the second semiconductor platform 106 together may include a three-dimensional integrated circuit. In the context of the present description, a three-dimensional integrated circuit refers to any integrated circuit comprised of stacked wafers and/or dies (e.g. silicon wafers and/or dies, etc.), which are interconnected vertically and are capable of behaving as a single device.

For example, in one embodiment, the apparatus 100 may include a three-dimensional integrated circuit that is a wafer-on-wafer device. In this case, a first wafer of the wafer-on-wafer device may include the first memory of the first memory class, and a second wafer of the wafer-on-wafer device may include the second memory of the second memory class.

In the context of the present description, a wafer-on-wafer device refers to any device including two or more semiconductor wafers that are communicatively coupled in a wafer-on-wafer configuration. In one embodiment, the wafer-on-wafer device may include a device that is constructed utilizing two or more semiconductor wafers, which are aligned, bonded, and possibly cut in to at least one three-dimensional integrated circuit. In this case, vertical connections (e.g. TSVs, other connection technologies, etc.) may be built into the wafers before bonding or created in the stack after bonding. In one embodiment, the first semiconductor platform 102 and the second semiconductor platform 106 together may include a three-dimensional integrated circuit that is a wafer-on-wafer device.

In another embodiment, the apparatus 100 may include a three-dimensional integrated circuit that is a monolithic device. In the context of the present description, a monolithic device refers to any device that includes at least one layer built on a single semiconductor wafer, communicatively coupled, and in the form of a three-dimensional integrated circuit. In one embodiment, the first semiconductor platform 102 and the second semiconductor platform 106 together may include a three-dimensional integrated circuit that is a monolithic device.

In another embodiment, the apparatus 100 may include a three-dimensional integrated circuit that is a die-on-wafer device. In the context of the present description, a die-on-wafer device refers to any device including one or more dies positioned on a wafer. In one embodiment, the die-on-wafer device may be formed by dicing a first wafer into singular dies, then aligning and bonding the dies onto die sites of a second wafer. In one embodiment, the first semiconductor platform 102 and the second semiconductor platform 106 together may include a three-dimensional integrated circuit that is a die-on-wafer device.

In yet another embodiment, the apparatus 100 may include a three-dimensional integrated circuit that is a die-on-die device. In the context of the present description, a die-on-die device refers to a device including two or more aligned dies in a die-on-die configuration. In one embodiment, the first semiconductor platform 102 and the second semiconductor platform 106 together may include a three-dimensional integrated circuit that is a die-on-die device.

Additionally, in one embodiment, the apparatus 100 may include a three-dimensional package. For example, the three-dimensional package may include a system in package (SiP), chip stack MCM, and/or other similar packages or packaged systems, etc. In one embodiment, the first semiconductor platform and the second semiconductor platform are housed in a three-dimensional package.

In one embodiment, the apparatus 100 may be configured such that the first memory and the second memory are capable of receiving instructions from a device 108 via the single memory bus 110. In one embodiment, the device 108 may include one or more components from the following list (but not limited to the following list): a central processing unit (CPU); a memory controller, a chipset, a memory management unit (MMU); a virtual memory manager (VMM); a page table, a table lookaside buffer (TLB); one or more levels of cache (e.g. L1, L2, L3, etc.); a core unit; an uncore unit; PIM, MIP, combinations of these and/or other similar functions, etc.

In the context of the following description, optional additional circuitry 104 (which may include one or more circuitries each adapted to carry out one or more of the features, capabilities, etc. described herein) may or may not be included to cause, implement, etc. any of the optional architectures, features, capabilities, etc. disclosed herein. While such additional circuitry 104 is shown generically in connection with the apparatus 100, it should be strongly noted that any such additional circuitry 104 may be positioned in any components in any manner (e.g. the first semiconductor platform 102, the second semiconductor platform 106, the device 108, an unillustrated logic unit or any other unit described herein, a separate unillustrated component that may or may not be stacked with any of the other components illustrated, a combination thereof, etc.).

In another embodiment, the additional circuitry 104 may or may not be capable of receiving (and/or sending) a data operation request and an associated a field value. In the context of the present description, the data operation request may include (but is not limited to) a data write request, a data read request, a data processing request and/or any other request, command, etc. that involves data. Still yet the field value may include any value (e.g. one or more bits, protocol signal, any indicator, etc.) capable of being recognized in association with a field that is affiliated with memory class selection. In various embodiments, the field value may or may not be included with the data operation request and/or data associated with the data operation request. In response to the data operation request, at least one of a plurality of memory classes may be selected, based on the field value. In the context of the present description, such selection may include any operation or act that results in use of at least one particular memory class based on (e.g. dictated by, resulting from, etc.) the field value. In another embodiment, a data structure embodied on a non-transitory readable medium may be provided with a data operation request command structure including a field value that is operable to prompt selection of at least one of a plurality of memory classes, based on the field value. As an option, the foregoing data structure may or may not be employed in connection with the aforementioned additional circuitry 104 capable of receiving (and/or sending) the data operation request.

In yet another embodiment, the apparatus 100 may include at least one circuit separate from a processing and is operable for receiving a plurality of first commands directed to at least one of the first memory or the second memory. In this case, in one embodiment, the at least one circuit may be operable to modify one or more of the plurality of first commands directed to the first memory or the second memory.

In one embodiment, the at least one circuit may include at least one of an arithmetic logic unit (ALU) or a macros block. Further, in one embodiment, at least one of the ALU or the macros block may be operable to perform one or more copy operation, DMA operation, RDMA operation, address operation, cache operation, data operation, database operation, transactional memory operation, or security operation, etc.

In one embodiment, at least one of the ALU or the macros block may be operable to be programmed by one or more second commands received by the at least one circuit. Further, in one embodiment, at least one of the ALU or the macros block may be coupled to at least one program memory. In one embodiment, at least one program memory may be operable to store at least one of data, information, code, binary code, a code library, source code, text, a table, an index, metadata, a file, a macro, an algorithm, a constant, a settings, a key, a password, a hash, an error codes, or a parameter, etc.

Additionally, in another embodiment, the at least one circuit may be operable to perform transaction ordering. Further, in one embodiment (e.g. when the apparatus 100 is configured such that the first semiconductor platform includes a first memory class and the second semiconductor platform includes a second memory class, etc.), the apparatus 100 may be configured such that the first memory includes a memory of a first type and the second memory includes a memory of a second type.

In various embodiments, the at least one circuit may be configured to include one or more virtual channels, virtual command queues, and/or read bypass paths. Still yet, in one embodiment, the at least one circuit may be operable to perform one or more read operations from in-flight write operations.

In addition, in one embodiment, the at least one circuit may be operable to perform one or more repair operations. In another embodiment, the at least one circuit may be operable to perform reordering of transactions. In this case, in one embodiment, the at least one circuit may be operable such that the reordering of transactions is controlled by one or more tables.

Further, in one embodiment, the at least one circuit may be operable to perform one or more atomic operations. Still yet, in one embodiment, the apparatus 100 may be configured such that the at least one circuit is connected to one or more processing utilizing wide I/O.

As an option, the apparatus 100 may further include one or more test engines and test memory. In this case, in one embodiment, at least one of the one or more test engines may be operable to test the test memory. Further, in one embodiment, the at least one circuit may be operable to move data within at least one of the first memory or the second memory. In another embodiment, the at least one circuit may be operable to allow read commands to be performed across one or more read boundaries. Furthermore, in one embodiment, the at least one circuit may be operable to perform write buffering. Still yet, in one embodiment, the at least one circuit may be operable to perform write combining.

As set forth earlier, any one or more of the foregoing optional architectures, capabilities, and/or features may or may not be used in combination with any other one or more of such optional architectures, capabilities, and/or features. Still yet, any one or more of the foregoing optional architectures, capabilities, and/or features may be implemented utilizing any desired apparatus, method, and program product (e.g. computer program product, etc.) embodied on a non-transitory readable medium (e.g. computer readable medium, etc.). Such program product may include software instructions, hardware instructions, embedded instructions, and/or any other instructions, and may be used in the context of any of the components (e.g. platforms, processing unit, MMU, VMM, TLB, etc.) disclosed herein, as well as semiconductor manufacturing/design equipment, as applicable.

Even still, while embodiments are described where any one or more of the foregoing optional architectures, capabilities, and/or features may or may not be incorporated into a memory system, additional embodiments are contemplated where a processing unit (e.g. CPU, GPU, PIM, MIP, combinations of these and/or other similar processing functions, units, etc.) is provided in combination with or in isolation of the memory system, where such processing unit is operable to cooperate with such memory system to accommodate, cause, prompt and/or otherwise cooperate, coordinate, etc. with the memory system to allow for any of the foregoing optional architectures, capabilities, and/or features, etc. For that matter, further embodiments are contemplated where a single semiconductor platform (e.g. 102, 106, etc.) is provided in combination with or in isolation of any of the other components disclosed herein, where such single semiconductor platform is operable to cooperate with such other components disclosed herein at some point in a manufacturing, assembly, OEM, distribution process, etc., to accommodate, cause, prompt and/or otherwise cooperate with one or more of the other components to allow for any of the foregoing optional architectures, capabilities, and/or features. To this end, any description herein of receiving, processing, operating on, reacting to, etc. signals, data, etc. may easily be replaced and/or supplemented with descriptions of sending, prompting/causing, etc. signals, data, etc. to address any desired cause and/or effect relationship among the various components disclosed herein.

It should be noted that while the embodiments described in this specification and in specifications incorporated by reference may show examples of stacked memory system and improvements to stacked memory systems, the examples described and the improvements described may be generally applicable to a wide range of memory systems and/or electrical systems and/or electronic systems. For example, improvements to signaling, yield, bus structures, test, repair etc. may be applied to the field of memory stacked on one or more CPUs etc. For example, improvements to signaling, yield, bus structures, test, repair etc. may be applied to the field of memory systems in general as well as systems other than memory systems, etc. Furthermore, it should be noted that the embodiments/technology/functionality described herein are not limited to being implemented in the context of stacked memory packages. For example, in one embodiment, the embodiments/technology/functionality described herein may be implemented in the context of non-stacked systems, non-stacked memory systems, etc. For example, in one embodiment, memory chips (possibly using one or more memory technologies, memory types, memory classes, etc.) and/or other components may be stacked on one or more CPUs, multicore CPUs, PIM, MIP, combinations of these and/or other processing units, functions, etc. For example, in one embodiment, memory chips and/or other components may be physically grouped together using one or more assemblies and/or assembly techniques other than stacking. For example, in one embodiment, memory chips and/or other components may be electrically coupled using techniques other than stacking. Any technique that groups together (e.g. electrically and/or physically, etc.) one or more memory components and/or other components may be used.

More illustrative information will now be set forth regarding various optional architectures, capabilities, and/or features with which the foregoing techniques discussed in the context of any of the Figure(s) may or may not be implemented, per the desires of the user. For instance, various optional examples and/or options associated with the configuration/operation of the apparatus 100, the configuration/operation of the first and/or second semiconductor platforms, and/or other optional features (e.g. transforming the plurality of commands or packets in connection with at least one of the first memory or the second memory, etc.) have been and will be set forth in the context of a variety of possible embodiments. It should be strongly noted that such information is set forth for illustrative purposes and should not be construed as limiting in any manner. Any of such features may be optionally incorporated with or without the inclusion of other features described.

It should be noted that any embodiment disclosed herein may or may not incorporate, at least in part, various standard features of conventional architectures, as desired. Thus, any discussion of such conventional architectures and/or standard features herein should not be interpreted as an intention to exclude such architectures and/or features from various embodiments disclosed herein, but rather as a disclosure thereof as exemplary optional embodiments with features, operations, functionality, parts, etc., which may or may not be incorporated in the various embodiments disclosed herein.

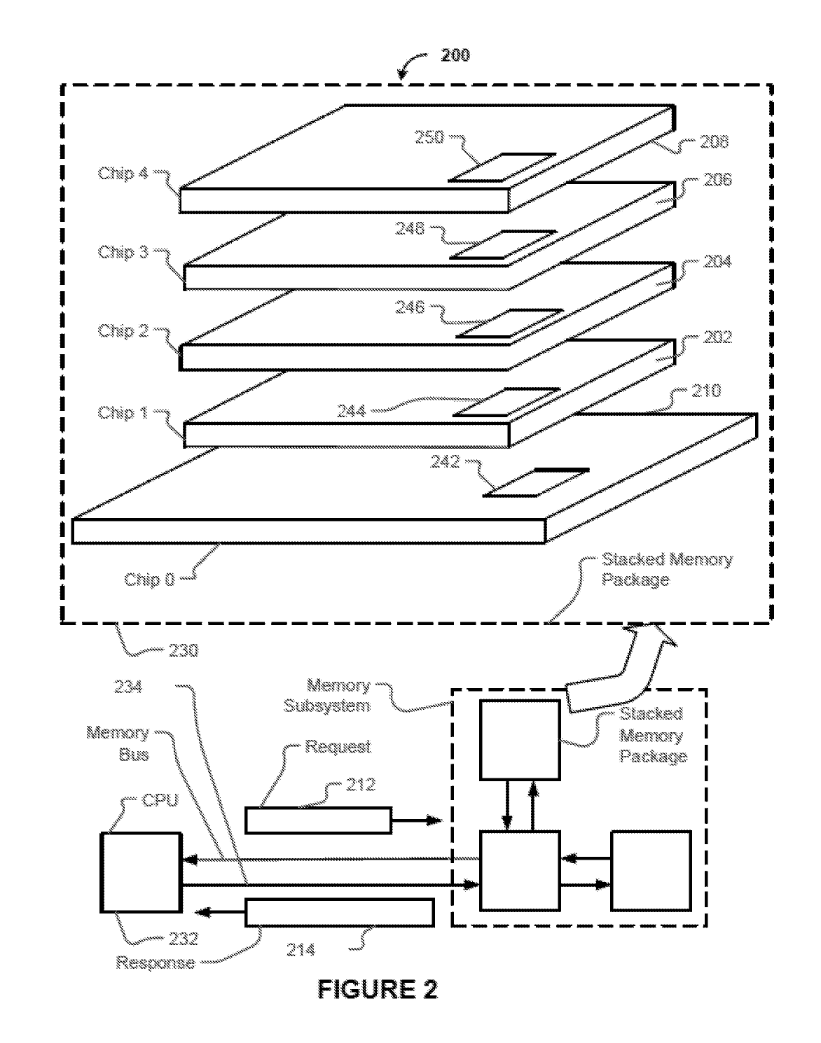

FIG. 2

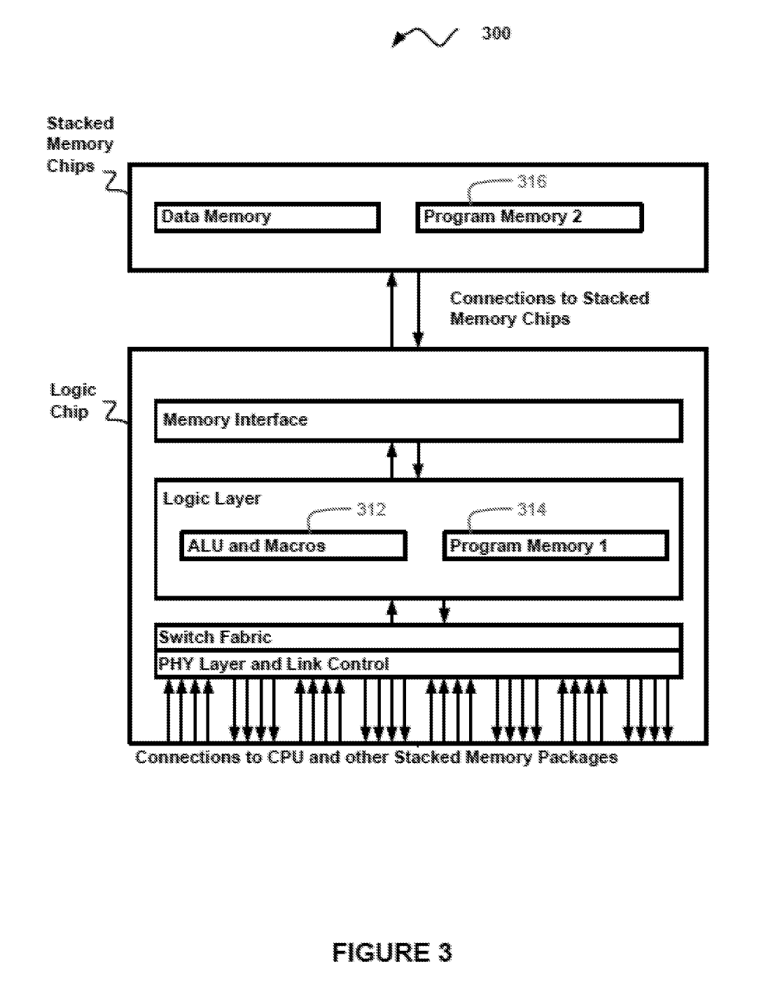

FIG. 2 shows a memory system 200 with multiple stacked memory packages, in accordance with one embodiment. As an option, the system may be implemented in the context of the architecture and environment of the previous figure or any subsequent Figure(s). For example the system of FIG. 3 may be implemented in the context of FIG. 1B of U.S. Provisional Application No. 61/569,107, filed Dec. 9, 2011, titled “SYSTEM, METHOD, AND COMPUTER PROGRAM PRODUCT FOR IMPROVING MEMORY SYSTEMS,” which is hereby incorporated by reference in its entirety for all purposes. For example, the system of FIG. 3 and/or other similar system, architectures, designs, etc. may be implemented in the context of one or more applications incorporated by reference. For example, one or more chips included in the system of FIG. 3 (e.g. memory chips, logic chips, etc.) may be implemented in the context of one or more designs, architectures, datapaths, circuits, structures, systems, etc. described herein and/or in one or more applications incorporated by reference. For example, one or more buses, signaling schemes, bus protocols, interconnect, and/or other similar interconnection, coupling, etc. techniques, etc. included in the system of FIG. 3 (e.g. between memory chips, between logic chips, on-chip interconnect, system interconnect, between CPU and stacked memory packages, between any memory system components, etc.) may be implemented in the context of one or more designs, architectures, circuits, structures, systems, bus systems, interconnect systems, connection techniques, combinations of these and/or other coupling techniques, etc. described herein and/or in one or more applications incorporated by reference. Of course, however, the system may be implemented in any desired environment.

In FIG. 2, in one embodiment, the CPU 232 may be coupled to one or more stacked memory packages 230 using one or more memory buses 234.

In one embodiment, a single CPU may be coupled to a single stacked memory package. In one embodiment, one or more CPUs (e.g. multicore CPU, one or more CPU die, combinations of these and/or other forms of processing units, processing functions, etc.) may be coupled to a single stacked memory package. In one embodiment, one or more CPUs may be coupled to one or more stacked memory packages. In one embodiment, one or more stacked memory packages may be coupled together in a memory subsystem network. In one embodiment, any type of integrated circuit or similar (e.g. FPGA, ASSP, ASIC, CPU, combinations of these and/or other die, chip, integrated circuit and the like, etc.) may be coupled to one or more stacked memory packages. In one embodiment, any number, type, form, structure, etc. of integrated circuits etc. may be coupled to one or more stacked memory packages.

In one embodiment, the memory packages may include one or more stacked chips. In FIG. 2, for example, in one embodiment, a stacked memory package may include stacked chips: 202, 204, 206, 208. In FIG. 2, for example, stacked chips: 202, 204, 206, 208 may be chip 1, chip 2, chip 3, chip 4. In FIG. 2, for example, in one embodiment, one or more of chip 1, chip 2, chip 3, chip 4 may be a memory chip (e.g. stacked memory chip, etc.). In one embodiment, any number of stacked chips, stacked memory chips, etc. may be used. In FIG. 2, for example, in one embodiment, one or more of chip 1, chip 2, chip 3, chip 4 may be a logic chip (e.g. stacked logic chip, etc.).

In FIG. 2, in one embodiment, a stacked memory package may include a chip at the bottom of the stack: 210. In FIG. 2, for example stacked chip 210 may be chip 0. In FIG. 2, in one embodiment, chip 0 may be a logic chip. In one embodiment, nay number of logic chips, stacked logic chips, etc. may be used.

In FIG. 2, in one embodiment, for example, one or more logic chips or parts, portions, etc. of one or more logic chips may be implemented in the context of logic chips described herein and/or in one or more applications incorporated by reference. In FIG. 2, in one embodiment, one or more logic chips may act to buffer, relay, transmit, etc. one or more signals etc. from the CPU and/or other components in the memory system. In FIG. 2, in one embodiment, one or more logic chips may act to transform, receive, transmit, alter, modify, encapsulate, parse, interpret, packetize, etc. one or more signals, packets, and/or other data, information, etc. from the CPUs and/or other components in the memory system. In FIG. 2, in one embodiment, one or more logic chips may perform any functions, operations, transformations, etc. on one or more signals etc. from one or more other system components (e.g. CPUs, other stacked memory packages, IO components, combinations of these and/or any other system components, etc.).

In one embodiment, for example, depending on the packaging details, the orientation of chips in the package, etc. the chip at the bottom of the stack in FIG. 2 may not be at the bottom of the stack when the package is mounted, assembled, connected, etc. Thus, it should be noted that terms such as bottom, top, etc. should be used with respect to diagrams, figures, etc. and not necessarily applied to a finished product, assembled systems, connected packages, etc. In one embodiment, the logical arrangement, connection, coupling, interconnection, etc. and/or logical placement, logical arrangement, etc. of one or more chips, die, circuits, packages, etc. may be different from the physical structures, physical assemblies, physical arrangements, etc. of the one or more chips etc.

In one embodiment, the chip at the bottom of the stack (e.g. chip 210 in FIG. 2) may be considered part of the stack. In this case, for example, the system of FIG. 2 may be considered to include five stacked chips. In one embodiment, the chip at the bottom of the stack (e.g. chip 210 in FIG. 2) may not be considered part of the stack. In this case, for example, the system of FIG. 2 may be considered to include four stacked chips. For example, in one embodiment, one or more chips etc. may be coupled using TSVs and/or TSV arrays and/or other stacking, coupling, interconnect techniques etc. For example, in one embodiment, the chip, die, circuit, etc. at the bottom of a stack may not contain TSVs, TSV arrays, etc. while the chips in the rest of the stack may include such interconnect technology, etc. For example, in this case, one or more assembly steps, manufacturing steps, and/or other processing steps etc. that may be regarded as part of the stacking process, etc. may not be applied or may not be applied in the same way to the chip etc. at the bottom of the stack as they are applied to the other chips in the stack, etc. Thus, for this reason, in this case, the chip at the bottom of a stack, for example, may be regarded as different, unique, etc. in the use of interconnect technology and thus, in some case, may not be regarded as part of the stack.

In one embodiment, one or more of the stacked chips may be a stacked memory chip. In one embodiment, any number, type, technology, form, etc. of stacked memory chips may be used. The stacked memory chips may be of the same type, technology, etc. The stacked memory chips may be of different types, technologies, etc. One or more of the stacked memory chips may contain more than one type of memory, more than one memory technology, etc. In one embodiment, one or more of the stacked chips may be a logic chip. In one embodiment, one or more of the stacked chips may be a combination of a logic chip and a memory chip.

In one embodiment, one or more CPUs, one or more dies containing one or more CPUs (e.g. multicore CPUs, etc.) may be integrated (e.g. packed with, stacked with, etc.) with one or more memory packages. In one embodiment, one or more of the stacked chips may be a CPU chip (e.g. include one or more CPUs, multicore CPUs, etc.).

In FIG. 2, in one embodiment, one or more stacked chips may contain parts, portions, etc. In FIG. 2, in one embodiment, stacked chips may contain parts: 242, 244, 246, 249, 250. For example, in one embodiment, chip 1 may be a memory chip and may contain one or more parts, portions, etc. of memory. For example, in one embodiment, chip 0 may be a logic chip and may contain one or more parts, portions, etc. of a logic chip. In one embodiment, for example, one or more parts of one or more memory chips may be grouped. In FIG. 2, in one embodiment, for example, parts of chip 1, chip 2, chip 3, chip 4 may be parts of memory chips that may be grouped together to form a set, collection, group, etc. For example, in one embodiment the group etc. may be (or may be part of, may correspond to, may be designed as, may be architected as, may be logically accessed as, may be structured as, etc.) an echelon (as defined herein and/or in one or more application incorporated by reference). For example, in one embodiment the group etc. may be a section (as defined herein and/or in one or more application incorporated by reference). For example, in one embodiment the group etc. may be a rank, bank, echelon, section, combinations of these and/or any other logical and/or physical grouping, aggregation, collection, etc. of memory parts etc.

In one embodiment, for example, one or more parts of one or more memory chips may be grouped together with one or more parts of one or more logic chips. In one embodiment, for example, chip 0 may be a logic chip and chip 1, chip 2, chip 3, chip 4 may be memory chips. In this case, part of chip 0 may be logically grouped etc. with parts of chip 1, chip 2, chip 3, chip 4. In one embodiment, for example, any grouping, aggregation, collection, etc. of one or more parts of one or more logic chips may be made with any grouping, aggregation, collection, etc. of one or more parts of one or more memory chips. In one embodiment, for example, any grouping, aggregation, collection, etc. (e.g. logical grouping, physical grouping, combinations of these and/or any type, form, etc. of grouping etc.) of one or more parts (e.g. portions, groups of portions, etc.) of one or more chips (e.g. logic chips, memory chips, combinations of these and/or any other circuits, chips, die, integrated circuits and the like, etc.) may be made.

In FIG. 2, in one embodiment, information may be sent from the CPU to the memory subsystem using one or more requests 212. In one embodiment, information may be sent between any system components (e.g. directly, indirectly, etc.) using any techniques (e.g. packets, signals, messages, combinations of these and/or other signaling techniques, etc.).

In FIG. 2, in one embodiment, information may be sent from the memory subsystem to the CPU using one or more responses 214.

In FIG. 2, in one embodiment, for example, a memory read may be performed by sending (e.g. transmitting from CPU to stacked memory package, etc.) a read request. The read data may be returned in a read response. The read request may be forwarded (e.g. routed, buffered, etc.) between stacked memory packages. The read response may be forwarded between stacked memory packages.

In FIG. 2, in one embodiment, for example, a memory write may be performed by sending (e.g. transmitting from stacked memory package, etc.) a write request. The write response (e.g. completion, notification, etc.), if any, may originate from the target stacked memory package. The write response may be forwarded between stacked memory packages.

In FIG. 2, in one embodiment, a request and/or response may be asynchronous (e.g. split, separated, variable latency, etc.).

In one embodiment, one or more commands may be sent to (e.g. received by, processed by, interpreted by, acted on, etc.) one or more logic chips. In one embodiment, one or more commands may be sent to (e.g. received by, processed by, interpreted by, acted on, etc.) one or more stacked memory chips. In one embodiment, one or more commands may be received by one or more logic chips and one or more modified (e.g. changed, processed, transformed, combinations of these and/or other modifications, etc.) commands, signals, requests, sub-commands, combinations of these and/or other commands, etc. may be forwarded to one or more stacked memory chips, one or more logic chips, one or more stacked memory packages, other system components, combinations of these and/or to any component in the memory system.

For example, in one embodiment, the system may use a set of commands (e.g. read commands, write commands, status commands, register write commands, register read commands, combinations of these and/or any other commands, requests, etc.). For example, in one embodiment, one or more of the commands in the command set may be directed, for example, at one or more stacked memory chips in a stacked memory package (e.g. memory read commands, memory write commands, memory register write commands, memory register read commands, memory control commands, etc.). The commands may be directed (e.g. sent to, transmitted to, received by, etc.) one or more logic chips. For example, a logic chip in a stacked memory package may receive a command (e.g. a read commands, write command, or any command, etc.) and may modify (e.g. alter, change, etc.) that command before forwarding the command to one or more stacked memory chips. In one embodiment, any type of command modification may be used. For example, logic chips may reorder commands. For example, logic chips may combine commands. For example, logic chips may split commands (e.g. split large read commands, etc.). For example, logic chips may duplicate commands (e.g. forward commands to multiple destinations, forward commands too multiple stacked memory chips, etc.). For example, logic chip may add fields, modify fields, delete fields, in one or more commands etc.

In one embodiment, one or more requests and/or responses may include cache information, commands, status, requests, responses, etc. For example, one or more requests and/or responses may be coupled to one or more caches. For example, one or more requests and/or responses may be related, carry, convey, couple, communicate, etc. one or more elements, messages, status, probes, results, etc. related to one or more cache coherency protocols. For example, one or more requests and/or responses may be related, carry, convey, couple, communicate, etc. one or more items, fields, contents, etc. of one or more cache hits, cache read hits, cache write hits, cache read miss, cache read hit, cache lines, etc. In one embodiment, one or more requests and/or responses may contain data, information, fields, etc. that is aligned and/or unaligned. In one embodiment, one or more requests and/or responses may correspond to (e.g. generate, create, result in, initiate, etc.) one or more cache line fills, cache evictions, cache line replacement, cache line writeback, probe, internal probe, external probe, combinations of these and/or other cache and similar operations and the like, etc. In one embodiment, one or more requests and/or responses may be coupled (e.g. transmit from, receive from, transmit to, receive to, etc.) one or more write buffers, write combining buffers, other similar buffers, stores, FIFOs, combinations of these and/or other like functions, etc. In one embodiment, one or more requests and/or responses may correspond to (e.g. generate, create, result in, initiate, etc.) one or more cache states, cache protocol states, cache protocol events, cache protocol management functions, etc. For example, in one embodiment, one or more requests and/or responses may correspond to one or more cache coherency protocol (e.g. MOESI, etc.) messages, probes, status updates, control signals, combinations of these and/or other cache coherency protocol operations and the like, etc. For example, in one embodiment, one or more requests and/or responses may include one or more modified, owned, exclusive, shared, invalid, dirty, etc. cache lines and/or cache lines with other similar cache states etc.

In one embodiment, one or more requests and/or responses may include transaction processing information, commands, status, requests, responses, etc. In one embodiment, for example, one or more requests and/or responses may include one or more of the following (but not limited to the following): transactions, tasks, composable tasks, noncomposable tasks, etc. In one embodiment, for example, one or more requests and/or responses may perform, be used to perform, correspond to performing, form a part or parts or portion or portions of performing, etc. one or more atomic operations, set of atomic operations, and/or other linearizable, indivisible, uninterruptible, etc. operations, combinations of these and/or other similar transactions, etc. In one embodiment, for example, one or more requests and/or responses may perform, be used to perform, correspond to performing, form a part of portion of performing, etc. one or more transactions that are atomic, consistent, isolated, durable, and/or combinations of these, etc. In one embodiment, for example, one or more requests and/or responses may perform, be used to perform, correspond to performing, form a part of portion of performing, etc. one or more transactions that correspond to (e.g. are a result of, are part of, create, generate, result from, for part of, etc.) a task, a transaction, roll back of a transaction, commit of a transaction, a composable task, a noncomposable task, and/or combinations of these and/or other similar tasks, transactions, operations and the like, etc. In one embodiment, for example, one or more requests and/or responses may perform, be used to perform, correspond to performing, form a part of portion of performing, etc. one or more transactions that correspond to a composable system, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) memory ordering, implementing program order, implementing order of execution, implementing strong ordering, implementing weak ordering, implementing one or more ordering models, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more memory-consistency models including, but not limited to, one or more of the following: sequential memory-consistency models, relaxed consistency models, weak consistency models, TSO, PSO, program ordering, strong ordering, processor ordering, write ordering with store-buffer forwarding, combinations of these and/or other similar models and the like, etc.

In one embodiment, for example, one or more parts, portions, etc. of one or more memory chips, memory portions of logic chips, combinations of these and/or other memory portions may form one or more caches, cache structures, cache functions, etc.

In one embodiment, for example, one or more caches may be used to cache (e.g. store, hold, etc.) data, information, etc. stored in one or more stacked memory chips. In one embodiment, for example, one or more caches may be implemented (e.g. architected, designed, etc.) using memory on one or more logic chips. In one embodiment, for example, one or more caches may be constructed (e.g. implemented, architected, designed, etc.) using memory on one or more stacked memory chips. In one embodiment, for example, one or more caches may be constructed (e.g. implemented, architected, designed, logically formed, etc.) using a combination of memory on one or more stacked memory chips and/or one or more logic chips. For example, in one embodiment, one or more caches may be constructed etc. using non-volatile memory (e.g. NAND flash, etc.) on one or more logic chips. For example, in one embodiment, one or more caches may be constructed etc. using logic NVM (e.g. MTP logic NVM, etc.) on one or more logic chips. For example, in one embodiment, one or more caches may be constructed etc. using volatile memory (e.g. SRAM, embedded DRAM, eDRAM, etc.) on one or more logic chips. For example, in one embodiment, one or more caches may be constructed etc.

In one embodiment, for example, one or more caches may be logically connected in series with one or more memory system, memory structure, memory circuits, etc. included on one or more stacked memory chips and/or one or more logic chips. For example, the CPU may send a request to a stacked memory package. For example, the request may be a read request. For example, a logic chip may check, inspect, parse, deconstruct, examine, etc. the read request and determine if the target of the read request (e.g. memory location, memory address, memory address range, etc.) is held (e.g. stored, saved, present, etc.) in one or more caches. If the data etc. requested is present in one or more caches then the read request may be completed (e.g. read data etc. provided, supplied, etc.) from a cache (or combination of caches, etc.). If the data etc. requested is not present in one or more caches then the read request may be forwarded to the memory system, memory structures, etc. For example, the read request may be forwarded to one or more memory controllers, etc.

In one embodiment, for example, one or more memory structures (e.g. in one or more logic chips, in one or more stacked memory chips, in combinations of these and/or in any memory structures in the memory system, etc.) may be used to accelerate writes. For example, one or more write requests may be retired (e.g. completed, satisfied, signaled as completed, response generated, write commit made, etc.) by storing write data and/or other data, information, etc. in one or more write acceleration structures. For example, in one embodiment, one or more write acceleration structures may include one or more write acceleration buffers (e.g. FIFOs, register files, other storage structures, data structures, etc.). For example, in one embodiment, a write acceleration buffer may be used on one or more logic chips. For example, in one embodiment, a write acceleration buffer may include one or more structures of non-volatile memory (e.g. NAND flash, logic NVM, etc.). For example, in one embodiment, a write acceleration buffer may include one or more structures of volatile memory (e.g. SRAM, eDRAM, etc.). For example, in one embodiment, a write acceleration buffer may be battery backed to ensure the contents are not lost in the event of system failure or other similar system events, etc. In one embodiment, any form of cache protocol, cache management, etc. may be used for one or more write acceleration buffers (e.g. copy back, writethrough, etc.). In one embodiment, the form of cache protocol, cache management, etc. may be programmed, configured, and/or otherwise altered e.g. at design time, assembly, manufacture, test, boot time, start-up, during operation, at combinations of these times and/or at any times, etc.

In one embodiment, for example, one or more caches may be logically separate from the memory system (e.g. other parts of the memory system, etc.) in one or more stacked memory packages. For example, one or more caches may be accessed directly by one or more CPUs. For example, one or more caches may form an L1, L2, L3 cache etc. of one or more CPUs. In one embodiment, for example, one or more CPU die may be stacked together with one or more stacked memory chips in a stacked memory package. For example, in FIG. 2, chip 0 may be a CPU chip (e.g. CPU, multicore CPU, multiple CPU types on one chip, combinations of these and/or any other arrangements of CPUs, equivalent circuits, etc.). For example, in FIG. 2, one or more of chip 1, chip 2, chip 3, chip 4; parts of these chips; combinations of parts of these chips; and/or combinations of any parts of these chips with other memory (e.g. on one or more logic chips, on the CPU die, etc.) may function, behave, operate, etc. as one or more caches. In one embodiment, for example, the caches may be coupled to the CPUs separately from the rest of the memory system, etc. For example, one or more CPU caches may be coupled to the CPUs using wide I/O or other similar coupling technique that may employ TSVs, TSV arrays, etc. For example, one or more connections may be high-speed serial links or other high-speed interconnect technology and the like, etc. For example, the interconnect between one or more CPUs and one or more caches may be designed, architected, constructed, assembled, etc. to include one or more high-bandwidth, low latency links, connections, etc. For example, in FIG. 2, in one embodiment, the memory bus may include more than one link, connection, interconnect structure, etc. For example, a first memory bus, first set of memory buses, first set of memory signals, etc. may be used to carry, convey, transmit, couple, etc. memory traffic, packets, signals, etc. to one or more caches located, situated, etc. on one or more memory chips, logic chips, combinations of these, etc. For example, a second memory bus, second set of memory buses, second set of memory signals, etc. may be used to carry, convey, transmit, couple, etc. memory traffic, packets, signals, etc. to one or more memory systems (e.g. one or more memory systems, memory structures, memory circuits, etc. separate from the memory caches, etc.) located, situated, etc. on one or more memory chips, logic chips, combinations of these, etc. In one embodiment, for example, one or more caches may be logically connected, coupled, etc. to one or more CPUs etc. in any fashion, manner, arrangement, etc. (e.g. using any logical structure, logical architecture, etc.).

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more memory types. In one embodiment, for example, one or more requests, responses, messages, etc. may perform, be used to perform, correspond to performing, form a part, portion, etc. of performing, executing, initiating, completing, etc. one or more operations, transactions, messages, control, status, etc. that correspond to (e.g. form part of, implement, construct, build, execute, perform, create, etc.) one or more of the following (but not limited to the following) memory types; Uncacheable (UC), Cache Disable (CD), Write-Combining (WC), Write-Combining Plus (WC+), Write-Protect (WP), Writethrough (WT), Writeback (WB), combinations of these and/or other similar memory types and the like, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more of the following (but not limited to the following): serializing instructions, read memory barriers, write memory barriers, memory barriers, barriers, fences, memory fences, instruction fences, command fences, optimization barriers, combinations of these and/or other similar, barrier, fence, ordering, reordering instructions, commands, operations, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more semantic operations (e.g. corresponding to volatile keywords, and/or other similar constructs, keywords, syntax, etc.). In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more operations with release semantics, acquire semantics, combinations of these and/or other similar semantics and the like, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more of the following (but not limited to the following): memory barriers, per-CPU variables, atomic operations, spin locks, semaphores, mutexes, seqlocks, local interrupt disable, local softirq disable, read-copy-update (RCU), combinations of these and/or other similar operations and the like, etc. In one embodiment, for example, one or more requests and/or responses may perform, be used to perform, correspond to performing, form a part of portion of performing, etc. one or more operations, transactions, messages, status, etc. that may correspond to (e.g. form part of, implement, etc.) one or more of the following (but not limited to the following): smp_mb( ), smp_rmb( ), smp_wmb( ), mmiowb( ), other similar Linux macros, other similar Linux functions, etc, combinations of these and/or other similar OS operations and the like, etc.

In one embodiment, one or more requests and/or responses may include any information, data, fields, messages, status, combinations of these and other data etc. (e.g. in a stacked memory package system, memory system, and/or other system, etc.).

FIG. 3

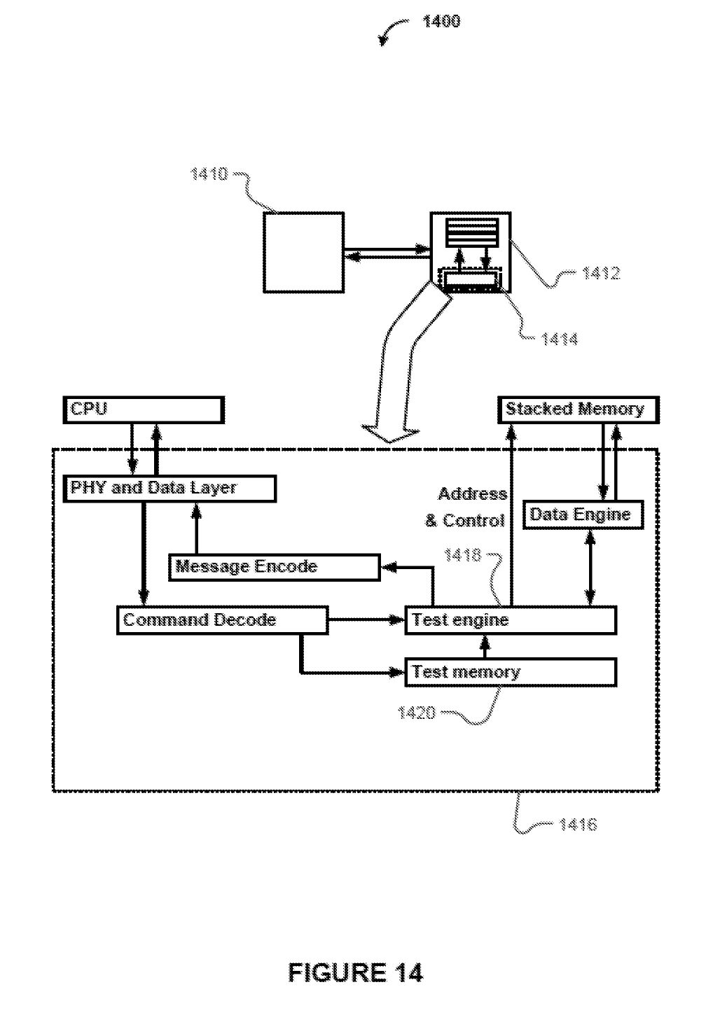

FIG. 3 shows a stacked memory package system 300, in accordance with one embodiment. As an option, the system of FIG. 3 may be implemented in the context of the architecture and environment of the previous Figures and/or any subsequent Figure(s). For example the system of FIG. 3 may be implemented in the context of FIG. 14 of U.S. Provisional Application No. 61/569,107, filed Dec. 9, 2011, titled “SYSTEM, METHOD, AND COMPUTER PROGRAM PRODUCT FOR IMPROVING MEMORY SYSTEMS,” which is hereby incorporated by reference in its entirety for all purposes. Of course, however, the system may be implemented in any desired environment.

In FIG. 3, in one embodiment, the stacked memory package system may include one or more stacked memory chips. Any number and/or types of stacked memory chips may be used.

In FIG. 3, for example, in one embodiment, the one or more stacked memory chips may include one or more parts, portions, regions, memory classes (as defined herein and/or in one or more specifications incorporated by reference), etc. For example, in one embodiment, the one or more stacked memory chips may include a data memory region. The data memory region may be used, for example, to store system data, user data, normal memory system data, etc. For example, in one embodiment, the one or more stacked memory chips may include a program memory region. In one embodiment, the program memory region may be used, for example, to store program data, program code, etc. In FIG. 3, the program memory region in the one or more stacked memory chips may be program memory 2.

In one embodiment, for example, program memory 2 may use the same memory technology as data memory. In one embodiment, program memory 2 may use a different memory technology as data memory. In one embodiment, the memory regions, technology, size, memory class (as defined herein and/or in one or more specifications incorporated by reference) etc. of program memory 2 and data memory may be programmed, configured, etc. The configuration of data memory, program memory, etc. may be performed at any time (e.g. design, manufacture, assembly, test, start-up, run time, combinations of these times and/or at any time, etc.). In one embodiment, for example, program memory 2 need not be present and the system may use program memory 1, for example. Any configuration, type, arrangement, architecture, construction, technology, etc. of any number of program memories may be used.

In FIG. 3, in one embodiment, for example, the stacked memory package system may include a logic chip. FIG. 3 shows one logic chip for use with stacked memory chips in a stacked memory chip package, but any number and/or type of logic chips may be used. In one embodiment, for example, the logic chip(s) may be part of (e.g. integrated with, partly integrated with, distributed with or between, etc.) the one or more stacked memory chips.

In FIG. 3, in one embodiment, for example, the logic chip may include a PHY layer and link layer control.

In FIG. 3, in one embodiment, for example, the logic chip may include a switch fabric. In one embodiment, for example, the switch fabric may be part of (e.g. included within, overlapped with, substantially within, etc.) the PHY layer and link control. In one embodiment, the switch fabric may be part of the logic layer. In one embodiment, there may be more than one switch fabric.

In FIG. 3, in one embodiment, for example, the PHY layer may be coupled to one or more CPUs (e.g. system CPUs, CPUs on a die in the stacked memory package, external CPUs, CPUs on the same die as the logic chip in a stacked memory package, etc.) and/or one or more other stacked memory packages in a memory system etc. Any type of coupling may be used (e.g. optical, high-speed serial, parallel bus, wide I/O, wireless, combinations of these and/or other coupling technologies, techniques, etc.).

In FIG. 3, in one embodiment, for example, the logic chip(s) may include one or more regions (e.g. areas, etc.) of program memory. For example, in one embodiment, the one or more stacked memory chips may include a program memory region that may be used, for example, to store program data, program code, etc. In FIG. 3, the logic chip program memory region may be program memory 1. In one embodiment, program memory 1 may use NAND flash, for example. Program memory 1 may use any size, type, form, etc. of memory technology. In one embodiment, program memory 1 need not be present and the system may use program memory 2, for example.

In FIG. 3, in one embodiment, for example, the logic layer of the logic chip may include one or more of the following (but not limited to the following) functional blocks, circuits, functions, etc: (1) bank/subbank queues; (2) redundancy and repair; (3) fairness and arbitration; (4) ALU and macros; (5) virtual channel control; (6) coherency and cache; (7) routing and network; (8) reorder and replay buffers; (9) data protection; (10) error control and reporting; (11) protocol and data control; (12) DRAM registers and control; (13) DRAM controller algorithm; (14) miscellaneous logic, (15) combinations of these and/or other similar functions or other functions, etc. Not all these functional blocks, etc. in the logic layer of the logic chip may be shown in FIG. 3.

In FIG. 3, in one embodiment, for example, the memory interface layer of the logic chip may include one or more of the following (but not limited to the following) functional blocks, circuits, functions, etc: row address MUX, bank control logic, column address latch, read FIFO, data interface, address register, and/or other memory interface functions, circuit blocks, etc. Not all these functional blocks, etc. in the memory interface layer of the logic chip may be shown in FIG. 3.

In one embodiment, for example, one or more of the functional blocks, etc. in the memory interface layer of the logic chip may be located in the logic layer of the logic chip. One or more of the functional blocks, etc. in the memory interface layer of the logic chip may be located in the logic layer of the logic chip. One or more of the functional blocks, etc. in the memory interface layer of the logic chip and/or the logic layer of the logic chip may be distributed between the logic layer of the logic chip and the memory interface layer of the logic chip. All or part of one or more of the functional blocks, etc. in the memory interface layer of the logic chip and/or the logic layer of the logic chip may be located in one or more stacked memory chips.

In FIG. 3, in one embodiment, for example, the memory interface layer of the logic chip and the stacked memory chips may be coupled using one or more control signals, buses, and/or other signals, etc.

In FIG. 3, in one embodiment, for example, the logic layer of the logic chip and the memory interface layer of the logic chip may be coupled using one or more control signals, buses, and/or other signals, etc.

In FIG. 3, in one embodiment, for example, the switch fabric of the logic chip and the logic layer of the logic chip may be coupled using one or more control signals, buses, and/or other signals, etc.

In one embodiment, for example, one or more functional blocks etc. in the stacked memory package system may include a function block that may perform the function of an ALU and macros block, 312. In one embodiment, for example, the ALU and macros block (e.g. processor, processor unit, controller, microcontroller, combinations of these and/or other programmable compute unit, etc.) may be programmed to perform one or more macros, routines, operations, algorithms, etc. In one embodiment, for example, the ALU and macros block etc. may be programmed by hardware, firmware, software, combinations of these, etc. In one embodiment, for example, the ALU and macros block etc. may be programmed or partially programmed, etc. using one or more program memories. In one embodiment, for example, the program memory may be volatile memory, non-volatile memory, combinations of these and/or any other form of memories, etc.

In one embodiment, one or more functional blocks etc. in the stacked memory package system may include a function block that may perform the function of program memory 1, 314. In one embodiment, program memory 1 may be part of one or more logic chips in a stacked memory package system. For example, all or part of program memory 1 may be used to store part or all of one or more macros, programs, routines, functions, algorithms, settings, information, data, etc. For example, program memory 1 may be used in combination with one or more ALU and macro blocks etc. to perform one or more macros, macro functions, operations, etc. FIG. 3 shows a single ALU and macros block, but any number may be used.

In one embodiment, for example, one or more functional blocks etc. in the stacked memory package system may include a function block that may perform the function of program memory 2, 316. In one embodiment, for example, program memory 2 may be part of one or more stacked memory chips in a stacked memory package system. For example, all or part of program memory 2 may be used to store part or all of one or more macros, programs, routines, functions, algorithms, settings, information, data, etc. For example, program memory 2 may be used in combination with one or more ALU and macros blocks etc. to perform one or more macros, macro functions, operations, etc. FIG. 3 shows a single program memory block, but any number may be used.

Note that FIG. 3 shows a single block labeled as an ALU and macros block, but any arrangement of blocks, circuits, functions, combinations of these and/or similar circuit blocks or functions and the like may be used. Similarly, FIG. 3 shows a separate single block that may perform the function of program memory. Any arrangement and number of circuits, circuit blocks, function blocks, combinations of these and/or other similar circuits, functions, etc. may be used separately or in combination to perform the functions, operations, etc. of the ALUs and macros block and program memory block shows in FIG. 3.

In one embodiment, for example, the logic chip may include one or more ALU and macros block, compute processors, macro engine, ALU, CPU, Turing machine, controller, microcontroller, core, microprocessor, stream processor, vector processor, FPGA, PLD, programmable logic, compute engine, computation engine, combinations of these and/or other computation functions, blocks, circuits, etc. In one embodiment the ALU and macros block(s) may be located in one or more logic chips (as shown for example, by ALU and macros circuit block in FIG. 3). In one embodiment the function of one or more ALU and macros block(s) may be distributed between one or more logic chips and one or more stacked memory chips in a stacked memory package system.

In one embodiment, for example, it may be advantageous to provide the logic chip and thus the memory system with various compute resources.

For example, in a memory system without compute resources the CPU (e.g. external CPU, etc.) may perform the following steps: fetch a counter variable stored in the memory system as data from a memory address (possibly involving a fetch of 256 bits or more depending on cache size and word lengths, possibly requiring the opening of a new page etc.); (2) increment the counter; (3) store the modified variable back in main memory (possibly to an already closed page, thus incurring extra latency etc.).

In one embodiment, for example, in a memory system with compute resources, one or more ALU and macros block(s) etc. in the logic chip may be programmed (e.g. by packet, message, request, etc.) to increment the counter directly in memory thus reducing latency (e.g. time to complete the increment operation, etc.) and power (e.g. by saving operation of PHY and link layers, etc.). Any similar and/or other techniques to program a memory system with compute resources may be used. A memory system with compute resources may be used for one or more uses, purposes, etc. (e.g. to perform functions, algorithms, and/or to perform other similar operations, etc.).

In one embodiment, for example, uses of the ALU and macros block(s) etc. may include, but are not limited to, one or more of the following (either directly (e.g. self-contained, in cooperation with other logic on the logic chip, etc.) or indirectly in cooperation with other system components, one or more CPUs, etc.); to perform pointer arithmetic and/or other arithmetic and computation functions; move, relocate, duplicate and/or copy etc. blocks of memory (e.g. perform CPU software bcopy( ) functions, etc.); be operable to aid in direct memory access (DMA) and/or remote DMA (RDMA) operations (e.g. increment address counters, implement protection tables, perform address translation, etc.); perform cache functions or cache related functions, operations, etc; manage caches, cache contents, cache fields, cache behavior, cache policies, cache settings, cache types, etc; perform and/or manage memory coherence policies; deduplicate data in memory, in requests, in responses, etc; compress data in memory or in requests (e.g. gzip, 7z, other compression algorithm, format, standard, etc.); expand (e.g. decompress, etc.) data; scan data (e.g. for virus, in programmable fashion (e.g. by packet, message, etc.) or preprogrammed patterns, etc.); compute hash values (e.g. MD5, other algorithms, etc.); implement automatic packet counters and/or data counters; read/write counters; error counting; perform semaphore operations; perform operations to filter, modify, transform, alter or otherwise change data, information, metadata, etc. (e.g. in memory, in requests, in commands, in responses, in completions, in packets, etc.); perform atomic load and/or store operations; perform memory indirection operations; be operable to aid in providing or directly provide transactional memory and/or transactional operations (e.g. atomic transactions, database operations, etc.); maintain, manage, create, etc. one or more databases, etc; perform one or more database operations (e.g. in response to commands, requests, etc.); manage, maintain, control, etc. memory access (e.g. via password, keys, etc.); perform, control, maintain, etc. security operations (e.g. encryption, decryption, key management, etc.); compute memory offsets; perform memory array functions; perform matrix operations; implement counters for self-test; perform or be operable to perform or aid in performing self-test operations (e.g. walking ones tests, other tests and test patterns, etc.); compute latency and/or other parameters e.g. to be sent to the CPU and/or other logic chips; perform search functions and/or search operations; create metadata (e.g. indexes, other data properties, etc.); analyze memory data; track memory use; perform prefetch or other optimizations; calculate refresh periods; perform temperature throttling calculations or other calculations related to temperature; handle cache policies (e.g. manage dirty bits, write-through cache policy, write-back cache policy, other cache functions, combinations of these and/or other cache functions, etc.); manage priority queues; manage virtual channels; manage traffic queues; manage memory sparing; manage hot swap; manage memory scrubbing and/or other memory reliability functions; initialize memory (e.g. to all zeros, to all ones, etc.); perform memory RAID operations; perform error checking (e.g. CRC, ECC, SECDED, combinations of these and/or other error checking codes, coding, etc.); perform error encoding (e.g. ECC, Huffman, LDPC, combinations of these and/or other error codes, coding, etc.); perform error decoding; maintain records, tables, indexes, catalogs, use, etc. of one or more spare memory regions, spare circuits, spare functions, etc; enable, perform, manage, etc. testing of TSV arrays and/or other connections; perform management of memory repair operations, functions, algorithms, etc; enable, perform or be operable to perform any other logic function, system operation, etc. that may require programmed or programmable calculations; perform combinations of these functions, operations, etc. and/or other functions, operations etc.

In one embodiment, for example, the one or more ALU and macros block(s) etc. may be programmable using high-level instruction codes (e.g. increment this address, etc.) etc. and/or low-level (e.g. microcode, machine instructions, etc.) sent in messages and/or requests.

In one embodiment, for example, the logic chip may contain stored program memory (e.g. in volatile memory (e.g. SRAM, eDRAM, etc.) or in non-volatile memory (e.g. flash, NAND flash, NVRAM, logic NVM, etc.). In one embodiment, the stored program memory or parts of the stored program memory may be located in one or more stacked memory chips and/or in any part, die, portion etc. of a stacked memory package and/or memory system (including, for example, memory in one or more other stacked memory packages, memory in one or more CPU die, etc.). In one embodiment, the stored program memory may store data, information, code, binary code, code libraries, source code, text, tables, indexes, metadata, files, macros, algorithms, constants, settings, keys, passwords, hashes, error codes, parameters, combinations of these and/or any other information, etc. In one embodiment, the stored program memory may include one or more memory blocks, regions, technologies, etc. In one embodiment, stored program code may be moved between non-volatile memory and volatile memory to improve execution speed. In one embodiment, program code and/or data may also be cached by the logic chip using fast on-chip memory, etc. In one embodiment, programs and algorithms may be sent to (e.g. transmitted to, stored in, etc.) the logic chip and stored at start-up, during initialization, at run time, at combinations of these times, and/or at any time during operation. In one embodiment, data macros, operations, programs, routines, etc. may be performed on data and/or any information contained in one or more requests, completions, commands, responses, information already stored in any memory, data read from any memory as a result of a request and/or command (e.g. memory read, etc.), data stored in any memory (e.g. in one or more stacked memory chips (e.g. data, register data, etc.); in memory or register data etc. on a logic chip; etc.) as a result of a request and/or command (e.g. memory system write, configuration write, memory chip register modification, logic chip register modification, combinations of these and/or other commands, etc.), or combinations of these, etc.

In one embodiment, for example, the logic chip may contain a CPU. Thus, for example, the block labeled ALU and macros in FIG. 3 may be a CPU, may be part of a CPU, may be part of one or more CPUs, may include one or more CPUs, etc. Thus, for example, a memory system may contain more than one CPU with different relationships to system memory (e.g. different logical connections, different logical coupling, different functions with respect to system memory, etc.) to. For example, a memory system may contain a CPU that may be referred to as a system CPU (e.g. a CPU connected to a stacked memory package, a CPU integrated in a stacked memory package, etc.). For example, a memory system may contain a CPU that may be referred to as a logic chip CPU (e.g. a CPU coupled to memory in a stacked memory package, etc.). For example, in one embodiment, a system CPU may be capable of sending instructions to a logic chip CPU that may then execute those instructions on the contents of system memory, etc. Note that the terms system CPU and logic CPU may not reflect the logical and/or physical locations of either the system CPU or logic chip CPU. For example, one or more system CPUs may be integrated on a first chip, die, integrated circuit, etc. and one or more logic chip CPUs may be integrated on the same first die with the first die being stacked, for example, with a second die etc. including one or more types of system memory. Note that the terms system CPU and logic chip CPU may be used, for example, to help distinguish between one or more CPUs in an architecture. Not that the use of the term CPU alone does not necessarily imply that the CPU (as used in that context, in a particular context, in a particular figure, etc.) is limited to one type, kind, form, etc. of CPU. For example, a logic chip CPU may be an ALU, a collection of ALUs, a programmable logic block, a programmable logic block with program and/or other storage, a collection of functions, combinations of logic functions and/or any logic blocks and the like, etc. For example, a system CPU may be a single CPU, a single CPU chip, multiple chips, a multichip package, a multicore CPU chip, a collection or network of CPUs, a group of similar CPUs (e.g. a homogeneous multicore CPU, etc.), a group of CPUs with different architectures (e.g. a heterogeneous multicore CPU, etc.), combinations of these and/or other similar CPU structures, logic structures, architectures and the like, etc. Note also that one or more system CPUs (or parts of one or more system CPUs, one or more functions of a system CPU, etc.) may be integrated on one or more logic chips. Note also that one or more logic chips (or logic chip functions, part of one or more logic chips, etc.) may be integrated on one or more system CPUs.

In one embodiment, any number, type, architecture, etc. of first CPUs (e.g. system CPUs, etc.) may be integrated in any fashion, manner, etc. (e.g. in any location, on the same die, on different die, in the same package, in different packages, etc.) from any number, type, architecture, etc. of second CPUs (e.g. logic chip CPUs, etc.). Note also that one or more of the logic chip CPUs, or parts, portions, etc. of one or more logic chip CPUs may be located in one or more memory chips, etc. Thus, for example, the term logic chip CPU may be used to distinguish the functions, operations, etc. of a logic chip CPU from a system CPU, etc. Thus, for example, the term logic chip CPU may not necessarily means that the logic chip CPU must always be located entirely on a logic chip. Thus, for example, the functions, operations, etc. of a logic chip CPU may be distributed between more than one chip (e.g. between one or more logic chips and one or more stacked memory chips, etc.).

In one embodiment, for example, one or more logic chip CPUs may be used on a logic chip. In one embodiment, for example, a logic chip CPU may be assigned, associated with, coupled with, connected to, function with, etc. one or more memory controllers. For example, in one embodiment, a logic chip CPU may be assigned, designated, etc. to perform, handle, operate on, execute, etc. all operations, instructions, etc. associated with, corresponding to, etc. a certain (e.g. fixed, programmable, configurable, etc.) memory range (e.g. range of addresses, etc.). For example, in one embodiment, there may be eight memory controllers or memory controller functions in a stacked memory package and there may be eight logic chip CPUs with one assigned to each memory controller. In one embodiment, any number of logic CPUs may be used in any arrangement, configuration, etc. For example, one logic chip CPU may be assigned to one memory controller, two memory controllers, or any number of memory controllers, etc. For example, a memory controller may be coupled to one logic chip CPU, two logic chip CPUs, or any number of logic chip CPUs, etc.

In one embodiment, for example, the logic chip CPUs, or parts, portions of one or more logic chip CPUs (e.g. address bus, data bus, other internal buses, bus structures, registers, register files, FIFO, buffers, pipelines, combinations of these and/or other internal logical structures and the like, etc.) may be coupled, interconnected, networked, etc.

In one embodiment, for example, the logic chip CPUs and/or one or more functions, aspects, behaviors, circuits, etc. of the logic chip CPUs may be constructed, designed, architected, wired, connected, etc. in a hierarchical, nested, and/or other similar fashion. For example, there may be one logic chip in a stacked memory package, there may be four memory controllers on a logic chip, there may be four logic chip CPUs of a first kind associated with each memory controller, and there may be one logic chip CPU of a second kind that may perform, execute, operate etc. in a more general, wide, overall, etc. fashion, manner, etc. Thus, for example, the second kind, type, architecture, design, etc. of logic chip CPU may perform housekeeping functions, error management, test, distribution of work, tasks, etc. to other parts, portions, etc. to other parts of the memory system, to other system components, to other parts of the stacked memory package, to other circuits in the logic chip (including other logic chip CPUs, etc.), to combinations of these and/or to any other circuits, functions, blocks, and the like, etc. Thus, for example, in one embodiment, the first and second kind of logic CPUs may act cooperatively and/or separately to perform external tasks, functions, operations, instructions, etc. (e.g. handle atomic tasks, instructions, operations, etc; handle operations directed at a specific address range; handle operations associated with a specific memory controller or memory controller function; combinations of these and/or any other similar operations, functions, tasks, instructions, and the like, etc.). Thus, for example, in one embodiment, the first and second kind of logic CPUs may act cooperatively and/or separately to perform internal tasks, functions, operations, instructions, etc. (e.g. perform housekeeping functions, handle error management, generate status and control, handle system messages, perform test functions, allocate spare memory regions, combinations of these and/or other similar functions, etc.).

In one embodiment, for example, the logic chip, logic chip CPU, combinations of these and/or other logic in the memory system, etc. may receive one or more instructions, commands, requests, data, information, combinations of these and/or any other similar instructions, etc. In one embodiment, for example, the logic chip etc. may receive one or more instructions etc. from one or more system CPUs. In one embodiment, for example, one or more system CPUs may be in a separate package, die, chip, etc. from the logic chip. In one embodiment, for example, one or more system CPUs may be located, packaged, assembled, etc. in the same package, die, chip, etc. as the logic chip.

In one embodiment, for example, one or more system CPUs and/or other system components etc. may send a stream, series, batch, collection, group, etc. of one or more instructions. In one embodiment, for example, the stream etc. of one or more instructions (e.g. instruction stream, etc.) may be directed to, targeted at, transmitted to, coupled to, etc. one or more logic chips and/or other system components etc. In one embodiment, for example, the one or more logic chips etc. may process, interpret, parse, execute, perform, etc. the instruction stream, part or parts of the instruction stream, and/or otherwise perform one or more operations etc. on the instruction stream, etc.

In one embodiment, for example, a system CPU may be capable, operable to, architected to, etc. execute, perform, etc. one or more instructions remotely. In one embodiment, for example, a system CPU may remotely execute instructions in memory (e.g. located within memory, in the same component as the memory, in the same package as the memory, etc.).

In one embodiment, for example, a system CPU may send (e.g. transmit, etc.) the following instruction stream: load A1, R1 (instruction 1); load A2, R2 (instruction 2); add R1, R2, R3 (instruction 3); store A3, R3 (instruction 4). For example, instruction 1 may cause loading of register R1 from memory address A1. For example, instruction 2 may cause loading of register R2 from memory address A2. For example, instruction 3 may cause addition of register R1 to register R2 with result in register R3. For example, instruction 4 may cause storing of register R3 to memory address A3. In one embodiment, for example, register R1, R2, R3 may be connected to, coupled to, part of, included in, etc. the logic chip CPU.

In one embodiment, for example, a system CPU may send (e.g. transmit, etc.) the following instruction stream: add A1, A2, A3 (instruction 1). In this case, for example, instruction 1 may cause the logic chip CPU and/or other circuits, functions, etc. to add the contents of memory address A1 to the contents of memory address A2 and store the result in memory address A3.

In one embodiment, for example, the system CPU and/or other circuits, functions, etc. may be capable of generating and the logic CPU and/or other circuits, functions, etc. may be capable of receiving one or more instructions etc. and/or one or more instruction streams etc. (e.g. one or more instructions in one or more streams, etc.). For example, the instructions may include (but are not limited to) one or more of the following: load, store, read, write, add, subtract, compare and swap, logical compare, shift (logical, arithmetic, etc.), combinations of these and/or any other logical instruction, collection or combination of instructions, etc. For example, the instructions may include (but are not limited to) one or more pointer operations, etc. For example, the instructions may include an instruction such as add P1, P2, P3; in this case the logic CPU etc. may add the contents of the address pointed to by P1, to the contents of the address pointed to by P2, and store the result in the address pointed to by P3. In one embodiment, one or more instructions, instruction parameters, etc. may use any type of pointers, handles, logical indirection, abstract reference, descriptors, indexes, double indirection, pointer arrays, pointer lists, combinations of these and/or other logical addressing techniques and the like, etc. In one embodiment, one or more instructions, instruction parameters, etc. may use any types or combinations of addressing, address parameters, address indirection, chained addressing, address shortcuts, address mnemonics, relative addressing, paging, overlays, address ranges, combinations of these and/or any form of parameter format, form, type, structure, etc.

In one embodiment, for example, there may be more than one system CPU. In one embodiment, a first system CPU may send, for example, a command to add the contents of address A1 and the contents address A2 and return a result to a second system CPU. In one embodiment, the result may include (but is not limited to) one or more of the following: data, completion, response, message, status, control, combinations of these and/or any other data, information, etc. In one embodiment, for example, a message may be sent to the second system CPU. In one embodiment, for example, a completion (e.g. completion with data, completion without data, etc.) may be sent to the second system CPU.

In one embodiment, for example, a first result may be sent to the first system CPU and a second result may be sent to the second system CPU. In one embodiment, for example, the first result may be the same (e.g. a copy, etc.) as the second result. In one embodiment, for example, the first result may be different from the second result. In one embodiment, the logic chip and/or other circuits, functions, etc. may perform (e.g. execute, cause to be executed, initiate, forward, etc.) any operations, combinations of operations, etc. as a result of one or more instructions etc. from a source (e.g. system CPU, other system components, other stacked memory package, other logic chip, etc.) and may generate, create, form, assemble, construct, transmit, etc. one or more results (e.g. data, responses, messages, control signals, status, state, etc.). In one embodiment, the logic chip etc. may perform any operations etc. as a result of one or more instructions etc. from a source and may generate etc. one or more results for a target (e.g. ultimate end recipient, final destination, etc.).

In one embodiment, the source may be a first system CPU. In one embodiment, the target may be a second system CPU. In one embodiment, the source and/or the target may be any system components (e.g. a logic chip, a stacked memory package, a CPU, combinations of these and/or any system components and the like, etc.). In one embodiment, the source may be different from the target. In one embodiment, the source may be the same as the target. In one embodiment, the instructions, instruction format, instruction parameters, instruction parameter format, etc. may be programmable and/or configurable. In one embodiment, the generation of results, the format of results, the content of results, the targets (e.g. destination for results, etc.), combinations of these and/or any other aspect of instructions, instruction results, and the like, etc. may be programmable and/or configurable. In one embodiment, any aspect of instructions, instruction execution, result generation, result routing, combinations of these and/or other aspects, parameters, behavior, functions, of instructions and the like, etc. may be programmed, configured, etc. Programming etc. may be performed at design time, manufacture, assembly, test, boot, start-up, during operation, at combinations of these times and/or at any times, etc.

In one embodiment, the instructions etc. may include information, data, indications, etc. as to the route, path, paths, alternative paths, etc. that the result(s) may use. For example, the result(s) may be routed through one or more intermediate nodes, components, etc. In one embodiment, the path, paths, etc. to be used, followed, etc. by one or more results may be programmed, configured, etc. For example, one or more routing tables, maps, etc. may be stored, held, etc. in one or more logic chips and/or other circuits, blocks, functions, combinations of these and/or similar components and the like, etc.

In one embodiment, for example, one or more logic chip CPUs may be an ALU block, an ALU block with macros, and/or any similar type of programmable logic block with or without associated program storage for macros, routines, algorithms, code, microcode, etc. In one embodiment, for example, there may be a logic chip CPU on a logic chip performing one or more central functions, operations, etc, with one or more ALUs etc. associated with each memory controller.

In one embodiment, for example, parts, portions, etc. of the ALUs, ALUs with macros blocks, etc. may be located on one or more memory chips. Thus, for example, in one embodiment, a first kind of logic chip CPU (e.g. a general-purpose CPU, housekeeping CPU, central CPU, global CPU, master CPU, etc.) may be located on a logic chip and a second kind of logic chip CPU (e.g. an ALU, ALU with macros, slave CPU, etc.) may be located on a memory chip.

In one embodiment, for example, one or more logic CPUs of a first kind may act as a master, control, director, etc. and may control, direct, manage, distribute work, distribute instructions, distribute operations, perform combinations of these and/or other functions, etc. In one embodiment, for example, one or more logic CPUs of a first kind may control etc. one or more logic chip CPUs of a second kind.

In one embodiment, for example, any number, type, architecture, design, function, etc. of a first kind of logic chip CPU (e.g. a general-purpose CPU, housekeeping CPU, central CPU, global CPU, etc.) may be used. In one embodiment, any number, type, architecture, design, function, etc. of a second kind of logic chip CPU (e.g. an ALU, ALU with macros, slave CPU, etc.) may be used. In one embodiment, any number, type, architecture, design, function, etc. of a first kind of logic chip CPU (e.g. a general-purpose CPU, housekeeping CPU, central CPU, global CPU, etc.) may be located, placed, logically placed, connected, coupled, etc. in any manner, in any locations, distributed in placement, etc. In one embodiment, any number, type, architecture, design, function, etc. of a second kind of logic chip CPU (e.g. an ALU, ALU with macros, etc.) may be located, placed, logically placed, connected, coupled, etc. in any manner, in any locations, distributed in placement, etc. In one embodiment, any number, type, architecture, design, function, etc. of any number of kinds of logic chip CPU may be used, located, placed, architected, couple, connected, interconnected, networked, etc. in any manner, fashion, etc.

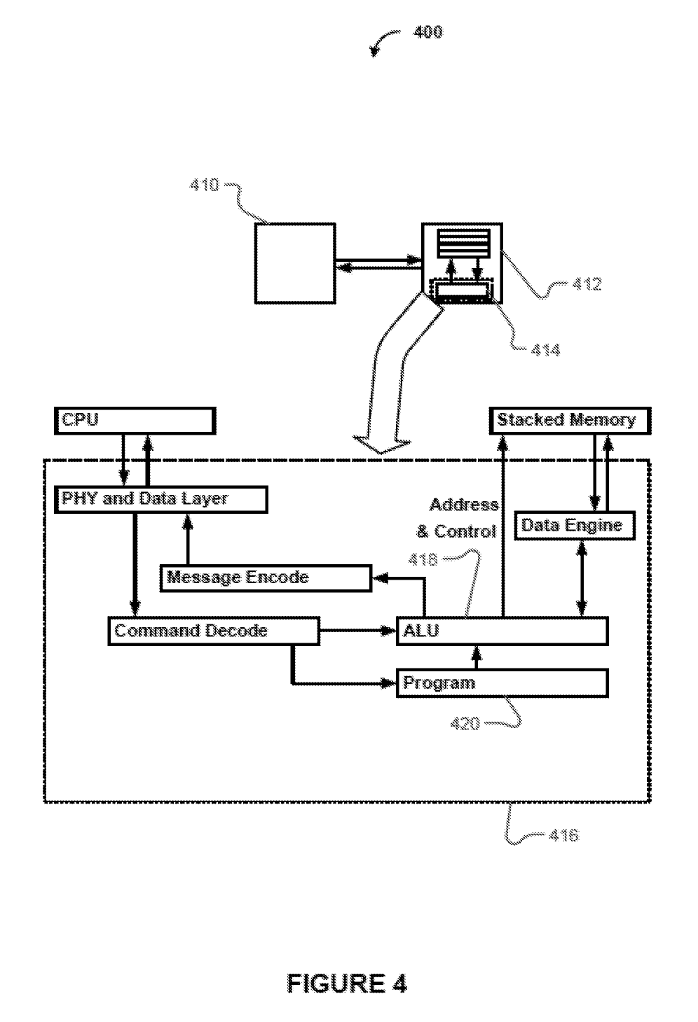

FIG. 4

FIG. 4 shows a computation system for a stacked memory package system 400, in accordance with one embodiment. As an option, the stacked memory package may be implemented in the context of the previous Figure(s) and/or any subsequent Figure(s). Of course, however, the stacked memory package may be implemented in the context of any desired environment.

In FIG. 4, the stacked memory package system 400 may include a CPU, 410. In FIG. 4, one CPU is shown, but any number may be used. In one embodiment, the CPU may be integrated with the stacked memory package.

In FIG. 4, in one embodiment, the stacked memory package system 400 may include a stacked memory package, 412. In FIG. 4, one stacked memory package is shown, but any number may be used.

In FIG. 4, in one embodiment, the stacked memory package may include a logic chip die, 414. In FIG. 4, one logic chip die is shown, but any number may be used. In one embodiment, the logic chip die may be part of one or more stacked memory chips. In one embodiment, the logic chip die may be integrated with the CPU (e.g. on the same die, in the same package, etc.).

In FIG. 4, in one embodiment, the logic chip die may include a logic chip, 416. In FIG. 4, one logic chip is shown, but any number may be used.

In FIG. 4, in one embodiment, the logic chip may include an ALU, 418. In FIG. 4, one ALU is shown, but any number, types, technology, architecture, combinations, etc. may be used. In one embodiment, the ALU (or equivalent functions, similar functions, etc.) may be any form of logic capable of performing logical operations, arithmetic calculations, logical functions, all or parts of one or more algorithms, and/or combinations of these and/or any computational elements, etc. In one embodiment, for example, the ALU may be a block capable of performing arithmetic and logical functions (e.g. add, subtract, shift, etc.) or may be a specialized block, etc. or may be a set of functions, circuits, blocks, combinations of these and/or any block(s) etc. capable of performing any functions, commands, requests, operations, algorithms, combinations of these and/or similar functions and the like, etc. Thus the use of the term ALU should not be interpreted as limiting the functions, capabilities, operations, architecture, structure, etc. of the block as shown, for example, in FIG. 4. Note that FIG. 4 may not show all the connections of the ALU (or equivalent blocks, etc.) to all other components, circuits, blocks, functions, etc. Note that FIG. 4 may simplify some of the connections, interconnections, coupling etc. of the circuits, blocks, functions, etc. Note that, in one embodiment, the ALU may be a CPU etc. but this may or may not be the same function or part of the same function as shown by the CPU 410. For example, in one embodiment, the CPU 410 may control, perform, manage, etc. one or more functions or part of one or more functions that may also be performed etc. on the ALU 418. Thus, in one embodiment, for example, one or more functions, operations etc. may be shared between one or more CPUs and one or more ALUs, etc. For example, in one embodiment, the CPU 410 may be a multiprocessor (e.g. Intel Core series, etc.), other multicore CPU (e.g. ARM, etc.), a collection of CPUs, cores, etc. (e.g. heterogeneous, homogeneous, etc.), combinations of these and/or any other CPU, multicore CPU, and the like, etc. For example, in one embodiment, the CPU 410 may be a system CPU (as defined herein and/or for example, in the context of FIG. 3). For example, in one embodiment, the ALU 418 may be an ARM core, other IP block, multicore CPU, etc. For example, in one embodiment, the ALU 418 and/or part of the ALU and/or associated functions (e.g. program memory, other logic circuits, functions, etc.) may be a logic chip CPU (as defined herein and/or for example, in the context of FIG. 3).

In FIG. 4, in one embodiment, the logic chip die may include a program, 420. In FIG. 4, one program is shown, but any number may be used. In one embodiment the program (e.g. code, microcode, data, information, combinations of these, etc.) may be stored in memory (e.g. program memory, program store, etc.). The memory may be of any type, use any technology, use combinations of types, technologies, etc. For example, the memory may use logic non-volatile memory (logic NVM), etc. In one embodiment the program, parts or portions of the program, etc. may be stored in one or more stacked memory chips.

In one embodiment, in one embodiment, the ALU and/or equivalent function(s) (e.g. CPU, state machine, computation engine, macro, macro engine, engine, programmable logic, microcontroller, microcode, combinations of these and/or other computation functions, circuits, blocks, etc.) and/or other logic circuits, functions, blocks, etc. may perform one or more operations (e.g. algorithms, commands, procedures, transactions, transformations, combinations of these and/or other operations, etc.) on the command stream and/or data, etc.

For example, in one embodiment, the ALU etc. may perform command ordering, command reordering, command formatting, command interleaving, command nesting, command structuring, multi-command processing, command batching, combinations of these and/or any other operations, instructions, etc. For example, in one embodiment, the ALU etc. may perform operations on, with, using, etc. data in memory, data in commands, requests, completions, responses, combinations of these and/or any other data, information, stored data, packets, packet contents, packet data fields, packet headers, packet data, packet information, tables, databases, indexes, metadata, control fields, register information, control register contents, error codes (e.g. CRC, parity, etc.), failure codes and/or failure information, messages, status bits, status information, measurement data, traffic data, traffic statistics, error data, error information, address data, spare memory use data, test data, test information, test patterns, test metrics, data layer information, link layer information, link status, routing data and/or routing information, paths, etc, other logical layer information (e.g. PHY, data, link, MAC, etc.), combinations of these and/or any other information, data, stored information, stored data, etc.

In one embodiment, for example, such command and/or other operations etc. may be used, for example, to construct, simulate, emulate, combinations of these and/or otherwise mimic, perform, execute, etc. one or more operations that may be used to implement one or more transactional memory semantics (e.g. behaviors, appearances, aspects, functions, etc.) or parts of one or more transactional memory semantics. For example, transactional memory may be used in concurrent programming to allow a group of load and store instructions to be executed in an atomic manner and/or in other similar structured or controlled fashion, manner, behavior, semantic, etc. For example, command structuring, batching, etc. may be used to implement commands, functions, behaviors, combinations of these, etc. that may be used and/or required to support (e.g. implement, emulate, simulate, execute, perform, enable, combinations of these, etc.) one or more of the following (but not limited to the following); hardware lock elision (HLE), instruction prefixes (e.g. XACQUIRE, XRELEASE, etc.), nested instructions and/or transactions (e.g. using XBEGIN, XEND, XABORT, etc.), restricted transactional memory (RTM) semantics and/or instructions, transaction read-sets (RS), transaction write-sets (WS), strong isolation, commit operations, abort operations, combinations of these and/or other instruction primitives, prefixes, hints, functions, behaviors, etc.

In one embodiment, for example, such command and/or other operations etc. may be used, for example, in combination with logical operations, etc. that may be performed by one or more logic chips and/or other logic, etc. in a stacked memory package. For example, one or more commands may be structured (e.g. batched, etc.) to emulate the behavior of a compare-and-swap (also CAS) command. A compare-and-swap command may correspond, for example, to a CPU compare-and-swap instruction or similar instruction(s), etc. that may correspond to one or more atomic instructions used, for example, in multithreaded execution, etc. in order to implement synchronization, etc. A compare-and-swap command may, for example, compare the contents of a target memory location to a field in the compare-and-swap command and if they are equal, may update the target memory location. An atomic command or series of atomic commands, etc. may guarantee that a first update of one or more memory locations may be based on known state (e.g. up to date information, etc.). For example, the target memory location may have been already altered, etc. by a second update performed by another thread, process, command, etc. In the case of a second update, the first update may not be performed. The result of the compare-and-swap command may, for example, be a completion that may indicate the update status of the target memory location(s). In one embodiment, the combination of a compare-and-swap command with a completion may be, emulate, etc. a compare-and-set command. In one embodiment, a response may return the contents read from the memory location (e.g. not the updated value that may be written to the memory location). A similar technique may be used to emulate, simulate, etc. one or more other similar instructions, commands, behaviors, combinations of these, etc. (e.g. a compare and exchange instruction, double compare and swap, single compare double swap, combinations of these, etc.). Such commands and/or command manipulation and/or command construction techniques and/or command interleaving, command nesting, command structuring, combinations of these, etc., may be used for example to implement synchronization primitives, mutexes, semaphores, locks, spinlocks, atomic instructions, combinations of these and/or other similar instructions, instructions with similar functions and/or behavior and/or semantics, signaling schemes, etc. Such techniques may be used, for example, in memory systems for (e.g. used by, that are part of, etc.) multiprocessor systems, etc.

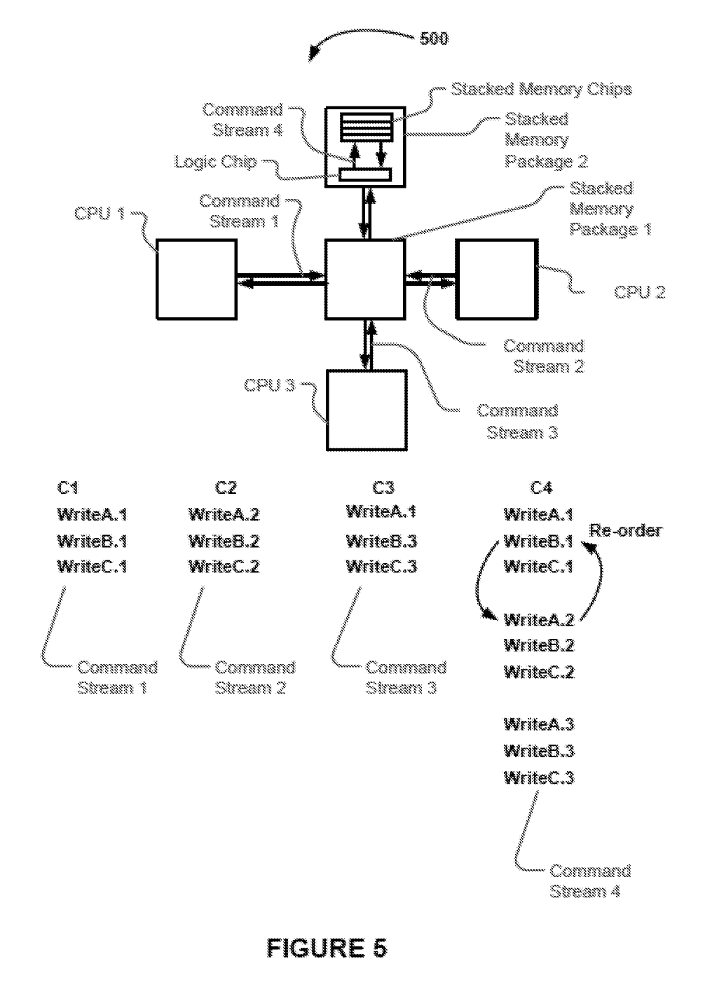

FIG. 5 Transaction Ordering in a Stacked Memory Package System

FIG. 5 shows a stacked memory package system 500, in accordance with one embodiment. As an option, the stacked memory package system may be implemented in the context of the previous Figure(s) and/or any subsequent Figure(s).

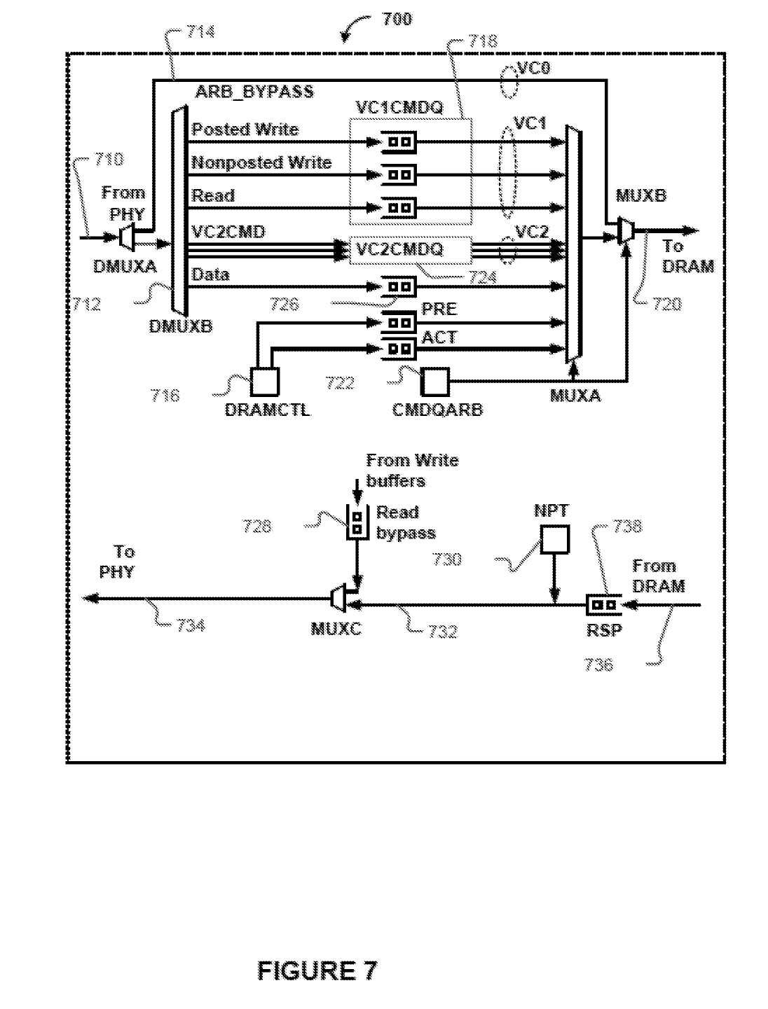

As an option, for example, the stacked memory package system may be implemented in the context of FIG. 20-7 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” which is hereby incorporated by reference in its entirety for all purposes. Of course, however, the system may be implemented in any desired environment.

In FIG. 5, in one embodiment, the stacked memory package system may include one or more stacked memory packages. Any number and/or types of stacked memory packages may be used.

In FIG. 5, in one embodiment, the stacked memory packages may include one or more stacked memory chips. Any number and/or types of stacked memory chips may be used.

In FIG. 5, in one embodiment, the stacked memory packages may include one or more logic chips. Any number and/or types of logic chips may be used. Not all stacked memory packages need contain the same number of logic chips. In one embodiment, the logic chip and/or logic chip functions may be included on one or more stacked memory chips.

In FIG. 5, in one embodiment, the stacked memory package system may include one or more CPUs. Any number and/or types of CPUs may be used. In one embodiment, one or more CPUs may be integrated with one or more stacked memory packages.

In FIG. 5, in one embodiment, the stacked memory package system may include one or more command streams that may carry commands, requests, responses, completions, messages, etc. In one embodiment, the command streams may couple or act to couple one or more CPUs with one or more stacked memory packages. For example, in one embodiment, one or more commands streams may be carried (e.g. transmitted, etc.) using (e.g. employing, etc.) one or more high-speed serial links that may couple one or more CPUs to one or more stacked memory packages, etc. Any number and/or types of command streams may be used. Any type of coupling, connections, interconnect, etc. between the one or more CPUs and one or more stacked memory packages may be used.

For example, in one embodiment, the transactions (commands, etc.) on the command streams (e.g. carried by the command streams, etc.) may be as shown in FIG. 5, and as follows:

CPU #1 (e.g. command stream 1) write ordering: write A.1, write B.1, write C.1.

CPU #2 (e.g. command stream 2) write ordering: write A.2, write B.2, write C.2.

CPU #3 (e.g. command stream 3) write ordering: write A.3, write B.3, write C.3.

In one embodiment, the timing of these commands may be such that all commands in command stream 1 are issued (e.g. placed in the command stream, transmitted in the command stream, etc.) before all commands in command stream 2; and all commands in command stream 2 are issued before all commands in command stream 3. This need not be the case, as ordering etc. may still be performed with commands interleaved between one or more sources (where a source may be a CPU, stacked memory package, or any system component, etc.), etc. Here A, B, C may refer, in general, to different memory locations (e.g. addresses, etc.). In FIG. 5, command stream 4 may be the order of commands as seen, for example, by the stacked memory chips (e.g. by one or more memory controllers, as present on one or more command buses, etc.) in a stacked memory package. For example, in FIG. 5, commands in command stream 1, command stream 2, command stream 3, may all be directed at the same stacked memory package, but this need not be the case. Commands may be ordered, re-ordered etc. in one or more streams at any location and/or any locations in a memory system, etc. Ordering may be performed on commands with different addresses (e.g. A, B, C may represent different addresses, etc.) but this need not be the case. For example, in one embodiment, command ordering, re-ordering, etc. may be performed on commands that are targeted at the same address.

In one embodiment, for example, writes from individual CPUs may be guaranteed to be performed in program order. For example, the ordering in time of the writes in command stream 1, command stream 2, command stream 3, may be as shown in command stream 4. For example, write A.1 may be guaranteed to be performed before write B.1, but for example, write A.2 may be performed before write B.1. In one embodiment, ordering may follow (e.g. adhere to, etc.) program order but any ordering scheme, rules, structure, arrangement, etc. may be used.

In one embodiment, for example, writes from multiple CPUs may be guaranteed to be performed in order e.g. executed in order, completed in order, issued in order, presented to one or more memory chips, presented to one or more memory controllers, arranged in one or more buffers and/or data structures and/or FIFOs, combinations of these and/or other ordering operations, manipulations, prioritizations, presentations, combinations of these, etc. For example, in command stream 4, write A.2 may be guaranteed to be performed before write A.3 and write A.1 may be guaranteed to be performed before write A.32. Any commands etc. from any sources (e.g. CPUs, memory controllers, stacked memory packages, logic chips, combinations of these and/or any memory system components, etc.) may be ordered, execution controlled, arranged in internal logic structures, arranged in internal data structures. Ordering, arrangement, presentation, etc. may be performed in any manner. For example, in one embodiment, ordering, reordering, shuffling, combinations of these operations and/or any manipulation and the like etc. of one or more commands etc. may be performed by arranging, altering, modifying, changing, combining these operations on, etc. one or more pointers, tags, table entries, labels, fields, bits, flags, combinations of these and/or any other data, information etc. in one or more tables, FIFOs, LIFOs, buffers, lists, linked lists, data structures, queues, registers, register files, rings, circular buffers, matrices, vectors, buses, bundles, combinations of these and/or other logical structures, signal groups, and/or equivalents to these and the like, etc.

In one embodiment, for example, one or more logic chips in one or more stacked memory packages may re-order commands (e.g. writes, reads, any commands, requests, completions, responses, combinations of these, etc.) e.g. from different CPUs, from different system components, from different stacked memory packages, etc. For example, in one embodiment memory ordering may be memory write ordering #1 (e.g. command stream 4): write A.1, write B.1, write C.1, write A.2, write B.2, write C.2, write A.3, write B.3, write C.3. For example, this memory write ordering (e.g. memory write ordering #1 in command stream 4) may be as shown in FIG. 5. For example, in one embodiment memory ordering may be memory write ordering #2 (e.g. command stream 4): write A.1, write B.1, write C.1, write A.3, write B.3, write C.3, write A.2, write B.2, write C.2.

In one embodiment, for example, memory ordering may be performed by adhering to a fixed set of memory ordering rules (or ordering rules, etc.) For example, ordering rules may determine whether reads may pass writes. For example, ordering rules may determine whether ordering depends on virtual channels (if present). For example, some or all commands in virtual channel 0 may be allowed to pass some or all commands in virtual channel 1, etc. For example, ordering rules may determine how ordering may depend on the command address. For example, ordering rules may determine how ordering may depend on the command tag, sequence number, combinations of these, and/or any field, flag, etc. in the command. For example, reads may be allowed to pass writes except to the same memory address, etc. For example, commands expecting a completion (e.g. read, write with completion, etc.) may be handled (e.g. ordered, re-ordered, manipulated, etc.) differently than commands without completion, etc. For example, ordering rules may determine how ordering may depend on one or more of the following (but not limited to the following): property, metric, feature, facet, aspect, content, field, data, address, parameter, combinations of these, and/or any other information in and/or associated with one or more commands, requests, completions, responses, messages, combinations of these, etc.

In one embodiment, for example, memory ordering rules may be programmed, configured, modified, altered, changed, etc. Programming of ordering rules may be fixed, dynamic, and/or a combination of fixed and dynamic. Programming of ordering rules, behaviors, functions, parameters, combinations of these and/or any aspect of memory ordering etc. may be performed at design, manufacture, test, assembly, start-up, boot time, during operation, at combinations of these times and/or at any times. For example, ordering rules or any data related to ordering etc. may be stored as state information in one or more logic chips, one or more CPUs, one or more memory system components, combinations of these and/or any memory system component, etc. In one embodiment, ordering rules and/or any related ordering information, rules, algorithms, tables, data structures, combinations of these, etc. may be stored in volatile memory and/or non-volatile memory and/or any memory. In one embodiment, ordering rules may be divided, separated, partitioned, combinations of these, etc. into one or more sets of ordering rules. For example, in one embodiment, a first set of ordering rules may be assigned to a first virtual channel and a second set of ordering rules may be assigned to a second virtual channel, etc. Any assignment of ordering rule sets may be used. Ordering rules and sets may be used for any purpose(s), etc. Ordering rule sets may be constructed based on any property, metric, division, combinations of these, etc. Ordering rule sets may be programmed individually and/or together. In one embodiment, a default set or sets of ordering rules may be used. In one embodiment, ordering rule sets may overlap (e.g. in scope, function, etc.). For example, a set (or sets) of precedence rules may be used to resolve overlap between one or more ordering rule sets. For example, ordering rule set ORS1 may permit (e.g. allow, enable, etc.) command C1 to pass command C2 but ordering rules set ORS2 may not permit command C1 tp pass command C2. A precedence rule set may dictate (e.g. enforce, direct, etc.) that ORS1 may take precedence (e.g. win, overrule, override, etc.) ORS2. Any number of precedence rule sets and/or ordering rule sets and/or equivalent functions etc. may be used. The precedence rule sets, ordering rule sets, etc. may be of any form, type, make up, contents, format, etc. The precedence rule sets, ordering rule sets, etc. may be programmed, configured, stored, altered, modified etc. in any fashion, by any manner, at any time, etc. For example, in one embodiment, rules, rule sets, etc. may be stored as a matrix, table, etc. For example, in one embodiment, rules etc. may be stored in one or more forms including one or more of the following (but not limited to the following): text, code, pseudo-code, microcode, operations, instructions, combinations of these, etc.

In one embodiment, for example, memory ordering or the operations involved in re-ordering commands, etc. may be altered, changed, modified, etc. by one or more commands, contents of one or more commands, etc. For example, a command may have an order control field that when set (e.g. a bit value set to 1, using a specified code, bit pattern, flag, other field(s), etc.) may allow a command to pass one or more other commands. For example, in one embodiment, a write command, read command, etc. may have a bit that when set allows a write command to pass other write commands, a read command to write read commands, etc. Any number of bit fields and/or similar flags, data structures, tables, etc. may be used in any command or combination of commands etc. In one embodiment, the one or more bits, fields, flags, combinations of these, etc. in one or more order control fields may be used to control operations on the command that contain the order control fields. In one embodiment, the one or more bits, fields, flags, combinations of these, etc. in one or more order control fields may be used to control operations on one or more commands, one or more of these commands may contain one or more order control fields. For example, in one embodiment, one or more control fields etc. in a first set of one or more commands may act to control the ordering behavior of a second set of one or more commands. In one embodiment, the first set of one or more commands (e.g. commands with control fields, etc.) may be equal (e.g. the same as, etc.) the second set of one or more commands (e.g. ordered commands, etc.). In one embodiment, the first set of one or more commands may be different from (e.g. not the same as, etc.) the second set of one or more commands. In one embodiment, any number of order control fields in any number of a first set of commands may be used to control, direct, alter, modify, change, etc. the ordering behavior, appearance, etc. of any number of commands in a second set of commands. There may be any relationship between the first set of commands and the second set of commands. For example the first set of commands may the same as the second set of commands. For example, the first set of commands may include the second set of commands. For example, the second set of commands may include the first set of commands. For example, the first set of commands may be distinct (e.g. different, separate, exclusive of, disjoint from, etc.) the second set of commands.

For example, in one embodiment, an order control command may be directed to one or more ordering agents (e.g. logic in a CPU, logic in a stacked memory chip, logic in one or more system components, combinations of these and/or any memory system components, and/or equivalents to these, etc.), For example, an order control command may be directed to a logic chip to allow a certain type of command (e.g. write, read, response, completion, message, etc.) to be ordered, re-ordered, etc. For example, an order control command may be directed to a logic chip to allow a certain range of commands to be re-ordered. For example, a set of commands directed to a certain range of memory addresses may be targeted by one or more order control commands and the command set may thus be controlled, modified, reordered, given priority, allowed to pass other commands, rearranged in one or more buffers, combinations of these, etc. For example, am address range and/or address ranges and/or ranges of addresses (e.g. contiguous addresses, non-contiguous addresses, sequential addresses, non-sequential addresses, one or more groups of addresses, combinations of these, etc.) may correspond to a memory class (as defined herein and/or in one or more specifications incorporated by reference, etc.), part of a memory class, one or more memory classes, combinations of these and/or any memory parts, portions, etc. For example, in one embodiment, commands directed to a first memory class may be ordered, re-ordered, etc. with respect to commands targeted at a second memory class, etc. In one embodiment, any combination of order control fields, order control commands, combinations of these, equivalents to these, and or any other ordering control techniques and the like etc. may be used to add, delete, create, control, modify, program, alter, change, combinations of these and/or perform other operations etc. the behavior, function, properties, parameters, algorithms, etc. of one or more ordering agents or the like.

In one embodiment, for example, one or more of CPU 1, CPU 2, CPU 3 may be integrated on the same die. For example, in one embodiment, one or more of CPU 1, CPU 2, CPU 3 may be CPU cores on a multicore CPU, etc.

In one embodiment, for example, memory ordering may be performed (e.g. ordering rules enforced, commands re-ordered, etc.) by a combination of one or more CPUs, one or more stacked memory packages, one or more system components, combinations of these and/or any memory system component, etc.

In one embodiment, for example, any commands, requests, completions, responses, messages, register reads, register writes, combinations of these and/or other commands, responses, completions, packets, bus data, combinations of these and/or any information transmissions, etc. may be ordered, re-ordered etc. by any component in a memory system, by any combination of components in a memory system, etc. FIG. 5 shows the ordering etc. of downstream write commands (e.g. in the downstream direction, on the downstream bus, away from the CPU, towards the memory, etc.). Any commands, completions, responses, etc. (e.g. reads, writes, loads, stores, messages, status, operational data, error messages, combinations of these and/or other information, etc.) flowing (e.g. signaled, transmitted, coupled, communicated, combinations of these, etc.) in any direction (e.g. downstream, upstream, between CPUs, between stacked memory packages, between any system components, combinations of these, etc.) and/or on any path, bus, wire, etc. (e.g. upstream path, downstream path, path between CPUs, path between stacked memory packages, path between stacked memory chips, path between logic chips, combinations of these paths, and/or serial/parallel combinations of these paths, and/or any paths, etc.) may be ordered, re-ordered, otherwise manipulated, etc. Thus, for example, downstream read commands may also be ordered etc. Thus, for example, upstream read completions may also be ordered etc. Thus, for example, upstream write completions may also be ordered etc.

In one embodiment, for example, memory ordering may include the use of command combining. For example, one or more commands from the same source and/or different sources may be combined. For example, one or more completions may be combined. For example, one or more read completions may be combined. For example, read completion (e.g. with data) may be combined with one or more write completions (e.g. without data, etc.). For example, messages, status, control, combinations of these and/or any other transmitted data, information, etc. may be combined by themselves (e.g. one or more messages may be combined, a message may be combined with control information, etc.) and/or with any other command, request, completion, response, etc.

In one embodiment, for example, memory ordering may include the use of command deletion. For example, a first write command to a first address may be deleted (e.g. omitted, superseded, etc.) when followed in time by a second write command to the same address, etc.

In one embodiment, for example, memory ordering and/or any form, type, function, etc. of command manipulation, ordering, re-ordering, etc. may be programmed (e.g. fixed, dynamically, etc.) according to memory class, virtual channel, command type (e.g. read, write, etc.), command length (e.g. size of write, etc.).

In one embodiment, for example, one or more commands to be ordered, re-ordered, otherwise manipulated etc. may be processed, stored, queued, arranged, manipulated, etc. in (e.g. using, employing, etc.) a single logical unit, circuit, function, etc. For example, in one embodiment, such commands may be stored in a single buffer, FIFO, queue, combinations of these circuits, functions, etc. and/or similar functions and the like. For example, in one embodiment, for example, the buffer etc. may be located (e.g. a part of, included within, etc.) in a memory controller and/or equivalent function. In one embodiment, commands and data may be stored in separate buffers, FIFOs, queues, data structures, combinations of these and/or other equivalent circuit functions, etc. For example, in one embodiment, write commands and write data may be stored separately. Any implementation of queuing functions, buffering, ordering operations etc. may be used. For example, the logical view (e.g. logical representation, functional representation, etc.) of command ordering, memory ordering, etc. may be that of a single logical buffer queue, FIFO, and/or other logical structure etc. while the physical implementation (e.g. physical circuits, etc.) may use (e.g. employ, consist of, include, etc.) one or more buffers, queues, FIFOs, data structures, logic circuits, state machines, combinational logic, controllers, combinations of these, etc. For example, in one embodiment, ordering etc. may be performed by logically manipulating pointers, markers, tags, labels, handles, fields, etc. in one or more data structures etc. rather than physically moving, shuffling, jockeying, arranging, sorting, etc. data and/or commands.

For example, in FIG. 5, in one embodiment, command stream 4, for example, may be directed at, originate from, be transmitted from, etc. a single memory controller. For example, all commands that may be ordered, re-ordered, otherwise manipulated etc. may be directed at the same memory controller (e.g. pass through the same controller, be stored in the same controller, transmitted by the same memory controller, issued by the same memory controller, serviced by the same memory controller, collected at the same controller, etc.).

In one embodiment, command stream 4 in FIG. 5, for example, may include (e.g. contain, represent, etc.) more than one path (e.g. bus, link, signal bundle, etc.) corresponding to (e.g. connected to, coupled with, in communication with, etc.) more than one memory part, portion, echelon, stacked memory chip, etc. For example, in one embodiment, the logic chip in stacked memory package 2 may contain four memory controllers. For example, in one embodiment, stacked memory package 2 may contain four stacked memory chips. For example, in one embodiment, each memory controller on the logic chip in stacked memory package 2 may be coupled to a stacked memory chip. Thus, for example, in one embodiment command stream 4 in FIG. 5 may include one or more sub-streams, etc. In one embodiment, it may be required to order etc. commands in one or more sub-streams. In one embodiment, for example, each memory controller may be associated with, correspond to, etc. a sub-stream. In one embodiment, for example, each memory controller may be associated with, correspond to, etc. more than one sub-stream. For example, in one embodiment, each memory controller may be assigned an address range (e.g. to a memory region, to part of memory, to an echelon, etc.). In one embodiment, for example, it may be required to order commands targeted at different address ranges that may correspond to (e.g. may be assigned to, may be serviced by, etc.) different memory controllers. In one embodiment, one or more buffers, FIFOs, register files, combinations of these and/or other storage elements and/or components etc. may be used to ensure ordering of commands between memory controllers. For example, an atomic operation may require a first command directed at (e.g. targeting, corresponding to, associated with, etc.) a first memory controller to be executed (e.g. issued to the memory, forwarded to the memory, result completed by the memory, response generated, and/or other operation completed, etc.) before (e.g. ahead of, preceding, etc.) the execution of a second command directed at a second memory controller.

In one embodiment, for example, a stacked memory package may include more than one memory controller. In one embodiment, an ordering buffer (or queue, FIFO, etc.) may be used to store, queue, manipulate, order, re-order, perform combinations of these functions and/or other operations and the like, etc. For example, in one embodiment, an ordering buffer etc. may be used in front of (e.g. logically preceding, ahead of, etc.) one or more memory controllers. In this case, for example, the ordering buffer may be a request ordering buffer (or command ordering buffer, etc.) For example, such a request ordering buffer may be used to buffer one or more write commands (or requests, etc.), one or more read commands (or requests, etc.), etc. to be ordered, re-ordered, otherwise manipulated etc. In this case, for example, one or more commands (e.g. write, read, load, store, etc.) may be ordered etc. before being issued (e.g. sent, transmitted, forwarded, etc.). In one embodiment, for example, the ordered commands may then be issued from a request ordering buffer to the memory controllers and/or equivalent function(s). For example, in one embodiment, the commands and/or data etc. may be sorted by address, switched by address, issued by address, directed by address, etc. In one embodiment, for example, the ordered commands may then be issued from (e.g. transmitted from, forwarded from, etc.) one or more request ordering buffers to (e.g. towards, directed at, coupled to, etc.) one or more stacked memory chips.

In one embodiment, for example, one or more request ordering buffers may be used to order etc. any commands, messages, data payloads, etc. For example, a first request ordering buffer may be used to store and/or order etc. commands while a second request ordering buffer may be used to store and/or order etc. write data etc. For example, a first set (e.g. a group, one or more, etc.) of request ordering buffers may be used to store and/or order write commands and/or data, while a second set of request ordering buffers may be used to store and/or order messages, register writes, other commands, etc. For example, one or more request ordering buffers may be used for one or more VCs, etc. Any number of sets of request ordering buffers may be used. Any number of sets of request ordering buffers may be used to divide an input command stream (e.g. by VCs, by traffic class, by memory class, by memory model, by type of cache, by memory type, by type of commands, by combinations of these and/or any other parameter, metric, feature, etc. of the command stream, etc.). Any numbers of request ordering buffers may be used in each set. The construction, implementation, functions, operations, etc. of each request ordering buffer and/or each set of request ordering buffers may be different. For example, the implementation etc. of request ordering buffers for write commands and/or write data may be different from the implementation etc. of request ordering buffers for messages, etc. For example, in one embodiment, there may be one or more request ordering buffers for reads, one or more request ordering buffers for writes, one or more request ordering buffers for messages, etc. For example, in one embodiment, one or more request ordering buffers may be used for each traffic class, virtual channel, or any other subdivision, portion, part, etc. of a channel, path, coupling, etc. between system components (e.g. between CPUs, between stacked memory packages, between other system components, between CPUs and system components, etc.).

In one embodiment, for example, an ordering buffer etc. may be used after (e.g. logically following, behind, etc.) one or more memory controllers, after the stacked memory chips, after a switch, after other equivalent functions, circuits, etc. In this case, for example, the ordering buffer may be a response ordering buffer. For example, such a response ordering (or completion ordering, etc.) buffer may be used to buffer one or more read completions, read responses, other responses and/or completions, etc. to be ordered, re-ordered, combined, aggregated, joined, separated, divided, tagged, otherwise manipulated etc. In this case, for example, one or more read completions etc. may be ordered etc. before being transmitted etc. (e.g. to a CPU, other system memory component, etc.). For example, in one embodiment, a read command may read across one or more memory chips, parts of memory, portions of memory, and/or cross one or more memory boundaries etc. For example, in one embodiment, a response ordering buffer or equivalent function may act to combine a first set of one or more results (e.g. responses, completions, read data chunks, etc.) of a first set of one or more read commands to create a second set of results. For example, a first read command may be a read of 64B. For example, the first read command may be split to two read commands, a second read command of 32B and a third read command of 32B. The second read command and the third read command may be issued (e.g. forwarded, sent, transmitted, coupled, etc.) to one or more memory parts, one or more memory portions, one or more stacked memory chips, one or more stacked memory packages, combinations of these and/or any memory regions etc. For example, the second read command and the third read command may cross a memory boundary. For example, second read command and the third read command may be to addresses such that the third read command addresses a spare memory region, etc. For example, the second read command and the third read command may be associated with (e.g. correspond to, be directed to, be targeted to, etc.) more than one memory controller. In one embodiment, a response ordering buffer or equivalent function may act to combine the results of the second read command and the third read command. For example, the result of the combination may logically appear to be a single completion corresponding to the first read command. For example, a first read result of 32B and a second read result of 32B may be combined to a third read result of 64B. Any number of any type of commands may be split in this fashion. Any number of any type of results may be combined in this fashion.

In one embodiment, for example, one or more ordering buffer(s) may be separate from the memory controllers, may be combined with one or more memory controllers, and/or may be implemented in any fashion, etc. In one embodiment, for example, any number and/or type etc. of ordering buffers may be used. For example, in one embodiment, a set of ordering buffers (e.g. read ordering buffers, write ordering buffers, combinations of ordering buffers, etc.) may be used for (e.g. corresponding to, associated with, etc.) one or more echelons, one or more memory classes (as defined herein and/or in one or more specifications incorporated by reference, etc.), and/or any portions of memory, and/or any groups of portions of memory, combinations of these, etc.

In one embodiment, for example, ordering buffers, equivalent functions, etc. may be coupled (e.g. coupled in the same stacked memory package, coupled between stacked memory packages, coupled in/on the same chip, coupled between chips, combinations of these couplings and/or coupled in any manner, fashion, etc. on chip, between chips, in the same package, between packages, etc.). For example, in one embodiment, ordering buffers on the same chip may be coupled (e.g. may communicate via one or more signals, may exchange information, may exchange data, may exchange packets, combinations of these and/or communicate via any similar or like techniques, etc.). For example, in this case, in one embodiment, a first ordering buffer may communicate with (e.g. send one or more signals, receive one or more signals, combinations of these and/or other information exchanges, etc.) a second ordering buffer. For example, in one embodiment, a first ordering buffer may communicate with a second ordering buffer information that may allow a first set of one or more commands associated with (e.g. stored in, controlled by, held by, etc.) the first ordering buffer to be ordered, re-ordered, sorted, arranged, issued, transmitted, shuffled, queued, forwarded, combinations of these and/or other manipulations, operations, functions, etc. with respect to a second set of one or more commands associated with the second ordering buffer. In one embodiment, for example, any number of ordering buffers and/or any types of ordering buffers may be so coupled and may communicate with each other and/or any other system component, stacked memory chip, logic chip, CPU, stacked memory package, combinations of these and/or any system component, etc. For example, two or more request ordering buffers may be coupled. For example, two or more response ordering buffers may be coupled. For example, one or more request ordering buffers may be coupled to one or more response ordering buffers. For example, in one embodiment, coupling between one or more request ordering buffers and one or more response ordering buffers may allow the control of read ordering relative to write ordering, etc.

In one embodiment, for example, one or more ordering buffer(s) may be located on one or more logic chips in a stacked memory package. In one embodiment, for example, one or more ordering buffer(s) may be located on one or more stacked memory chips in a stacked memory package. In one embodiment, one or more ordering buffer(s) and/or the functions of one or more ordering buffer(s) may be distributed between one or more stacked memory chips and one or more logic chips in a stacked memory package.

In one embodiment, for example, the coupling of ordering buffers that are located on different stacked memory packages may use (e.g. be coupled, use as communication links, etc.) one or more high-speed serial links and/or other equivalent coupling techniques. In one embodiment, for example, the ordering buffers may use the same high-speed serial links that may be used for commands, responses etc. between, for example, one or more CPUs and one or more stacked memory packages. In one embodiment, for example, the coupling of ordering buffers that are located on the same stacked memory package may use (e.g. be coupled, use as communication links, etc.) a dedicated bus, path etc. In one embodiment, for example, any form of coupling, communication, signaling path, signaling technique, combinations of these and/or other signaling technique etc. may be used to couple ordering buffers etc. located on the same stacked memory package, located in different stacked memory packages, located in/on the same chip, located on different chips, and/or located on any system component, etc,

In one embodiment, for example, the coupling of ordering buffers may use the same protocol (e.g. packet structure, packet fields, data format, etc.) as the commands, responses, completions (e.g. read command format, write command format, message command format, etc.). Thus, for example, in one embodiment the ordering buffers may use a form of command packet (e.g. with unique command field, unique header, etc.) to exchange ordering information, commands, etc. In one embodiment, the coupling of ordering buffers may use a special (e.g. dedicated, separate, etc.) protocol that may be different from the protocol used for commands, responses, completions, etc.

In one embodiment, for example, the coupling of ordering buffers may be programmable. The programming of one or more couplings between ordering buffers may be performed at any time and/or combinations of times, etc. For example, in one embodiment the ordering of reads, writes, etc. may be switched on or off. For example, in one embodiment, the ordering may be switched on or off by enabling or disabling, and/or otherwise modifying, changing, altering, configuring, etc. one or more couplings between ordering buffers.

In one embodiment, for example, the functions of the coupling of ordering buffers may be programmable. For example, in one embodiment the control of ordering of reads with respect to reads, writes with respect to writes, reads with respect to writes, and/or any combinations of commands, responses, completions, messages, etc. may be changed, altered, programmed, modified, configured, etc. For example, in one embodiment, the ordering of commands etc, and/or ordering of commands with respect to other commands etc. and/or any ordering, re-ordering, other manipulation etc. may be controlled by enabling, disabling, and/or otherwise modifying, changing, altering, configuring, etc. one or more couplings between ordering buffers. For example, in one embodiment, the priority of one or more signals coupling ordering buffers may be changed. For example, in one embodiment, one or more algorithms used by one or more arbiters, priority encoders, and/or equivalent functions etc. of one or more ordering buffers may be changed. In one embodiment, for example, any aspect, function, behavior, algorithm, parameter, feature, metric, and/or combinations of these, etc. of the coupling, coupling functions, ordering buffer, combinations of these and/or other circuits, functions, programs, algorithms, etc. associated with ordering may be programmed.

A system that is capable of ordering between memory controllers may be an atomic ordering memory system. A system that is not capable of ordering between memory controllers may be a nonatomic ordering memory system. In one embodiment, for example, the requirement to order commands and/or responses between memory controllers may be configurable. For example, in one embodiment or configuration the CPU may be aware of the memory address ranges handled by each controller. In this case, for example, if the CPU wishes to complete an atomic operation it may limit reads/writes etc. to a single memory controller where ordering may be guaranteed (e.g. by buffering, FIFOs etc. in a memory controller). In one embodiment, for example, it may simply be a property of the memory system that in one configuration there is no guarantee of ordering between commands to different addresses or different address ranges etc. In one embodiment, the memory system may be configured to be atomic or nonatomic. In one embodiment, there may be different levels, types, forms, etc. of atomic ordering memory systems. In one embodiment of a homogeneous atomic ordering memory system, the entire memory system, including, for example, multiple stacked memory packages may be ordered. In one embodiment of a heterogeneous atomic ordering memory system, the memory system may be divided into one or more parts, portions, etc. of one or more homogeneous atomic ordering memories. For example, in one embodiment, a stacked memory package may form a single homogeneous atomic ordering memory and a collection of one or more stacked memory packages in a memory system may form a heterogeneous atomic ordering memory system,

In one embodiment, ordering buffers (e.g. request ordering buffers, response ordering buffers, etc.) may be used to implement atomic ordering. In one embodiment, the ordering buffers, FIFOs, etc. may be separate from buffers, FIFOs, etc. used in each memory controller. In one embodiment, when atomic ordering is disabled, the ordering buffers may be used, added to, merged with, etc. the memory controller buffer resources. In one embodiment, buffer resources may be allocated (e.g. by programming, by configuration, etc.) between individual memory controllers and ordering buffer functions, for example. Programming and/or configuration of buffer, storage, FIFO, etc. resources may be performed at design time, assembly, manufacture, test, boot time, during operation, at combinations of these times and/or at any time.

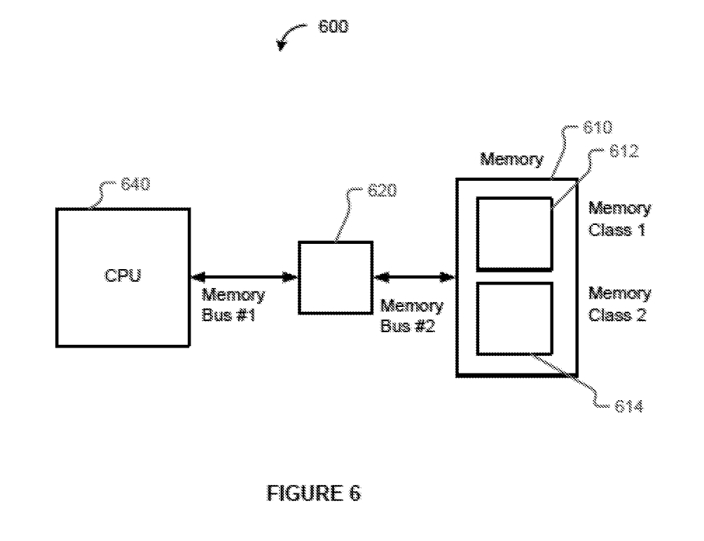

FIG. 6

FIG. 6 shows a stacked memory package system 600, in accordance with one embodiment. As an option, the stacked memory package system may be implemented in the context of the previous Figure(s) and/or any subsequent Figure(s).

As an option, for example, the stacked memory package system may be implemented in the context of U.S. application Ser. No. 13/441,132, filed Apr. 6, 2012, titled “MULTIPLE CLASS MEMORY SYSTEMS,” which is hereby incorporated by reference in its entirety for all purposes. In particular the stacked memory package system may be implemented in the context of FIG. 23C of U.S. application Ser. No. 13/441,132. Of course, however, the system may be implemented in any desired environment.

In FIG. 6, the stacked memory package system may include a system component 620. In FIG. 6, one system component is shown, but any number may be used. In one embodiment the system component may be a buffer chip. In one embodiment the system component may be a logic chip. In one embodiment the system component may be integrated with one or more other system components, CPUs, stacked memory packages, and/or any system component.

In FIG. 6, the stacked memory package system may include memory 610. In FIG. 6, one memory block is shown, but any number may be used. In one embodiment, the memory may be a stacked memory package. In one embodiment, the memory may be a stack of stacked memory chips. In one embodiment, the memory may be integrated together with the system component (e.g. a logic chip, a buffer chip, etc.) in a stacked memory package, for example. The memory may consist of any number of stacked memory packages. The stacked memory packages may contain any number of stacked memory chips. In one embodiment, for example, the CPU(s), system component(s) (e.g. buffer chips, logic chips, etc.), memory block(s), and/or other system components (which may not be shown in FIG. 6) may be integrated in a single package. In one embodiment, for example, the CPU(s), system component(s), memory block(s), and/or other system components may be integrated, assembled, included, etc. in more than one package.

In FIG. 6, the memory may include a first memory class 612 and a second memory class 614 (with memory class as defined herein and/or in one or more applications incorporated by reference). In FIG. 6, two memory classes are shown, but any number may be used. In one embodiment, for example, memory classes may be grouped, collected, apportioned, distributed, allocated, and/or otherwise located etc. in any fashion among the memory block(s), memory chips, stacked memory chips, stacked memory packages, etc.

In FIG. 6, in one embodiment, the CPU may be coupled to the system component (e.g. buffer chip, logic chip, etc.) using (e.g. employing, via, etc.) a first memory bus, memory bus #1. In FIG. 6, one such memory bus is shown, but any number, type, or form of bus and/or coupling etc. may be used. For example, in one embodiment, memory bus #1 may be a set, group, collection, etc. of high-speed serial links.

In FIG. 6, in one embodiment, the system component may be coupled to the memory using a second memory bus, memory bus #2. In FIG. 6, one such memory bus is shown, but any number, type, or form of bus and/or coupling etc. may be used. For example, in one embodiment, memory bus #2 may be a set, group, collection, etc. of high-speed serial links. For example, in one embodiment, the system component may act to transfer commands, data etc. (e.g. in packets, etc.) from memory bus #2 (which may, for example, include one or more high-speed serial inks) to memory bus #2 (which may for example, include separate buses for command, data, control, etc.). For example, in one embodiment, memory bus #2 may be a set, group, collection, etc. of high-speed serial links.

In FIG. 6, in one embodiment, the memory classes may be coupled to memory bus #2. In one embodiment, coupling may use (e.g. employ, include, etc.) TSVs or TSV arrays for example. In one embodiment, the system component may be part of the CPU die or integrated on the CPU die and the coupling may use wide IO, for example.

In one embodiment, the CPU, memory system, or combinations of these and/or other agents, components, functions, etc. (including for example the system OS, system BIOS, software, firmware, human user or operator, combinations of these and/or other agents etc.) may allocate (e.g. assign, classify, equate, etc.) one or more memory types (as defined herein) to one or more memory classes (as defined herein and/or in one or more specification incorporated by reference) in the memory system. In one embodiment, memory types may be explicitly assigned, implicitly inferred, otherwise assigned, etc. In one embodiment, rules may be associated with (e.g. correspond to, be assigned to, etc.) memory types. For example, in one embodiment, rules may include permission, allowance, enabling, disabling, etc. of one or more of the following (but not limited to the following): speculative access, speculative fetch, write combining, write aggregation, out of order access, etc.

In one embodiment, one or more memory classes may be used to impose a memory model (with the term as defined herein) on the memory system. In one embodiment, the memory model may be implemented, architected, constructed, enabled, etc. in the context of FIG. 5. For example, the mechanics, techniques, algorithms, etc. described in conjunction with FIG. 5 may be used to create (e.g. generate, impose, employ, etc.) one or more of the following (but not limited to the following) memory models: sequential consistency model, relaxed consistency model, weak consistency model, TSO, PSO, program ordering, strong ordering, processor ordering, write ordering with store-buffer forwarding, combinations and/or permutations of these and/or any other memory model, etc.

In one embodiment, for example, memory class 1 and/or memory class 2 may be one or more of the following (but not limited to the following) memory types: Uncacheable (UC), Cache Disable (CD), Write-Combining (WC), Write-Combining Plus (WC+), Write-Protect (WP), Writethrough (WT), Writeback (WB), combinations of these and/or any other memory types, classifications, designations, formulations, combinations of these and/or other memory classes etc.

In one embodiment, a memory class may correspond to one or more memory types. For example, in one embodiment, a memory class may correspond to one or more memory models. Any number of memory types may be used with any number of memory classes. Any number of memory models may be used with any number of memory classes.

In one embodiment, the composition (e.g. use, allocation, architecture, make up, etc.) of memory types and/or memory models in (e.g. employing, using, etc.) one or more memory classes may be fixed (e.g. static, etc.) and/or flexible (e.g. programmed, configured, dynamic, etc.). In one embodiment, for example, memory types and/or memory models and/or use of memory classes may be configured at design time, manufacture, assembly, test, boot time, during operation, at combinations of these times and/or at any time, etc. Programming, configuration etc. may be performed by the CPU, OS, BIOS, firmware, software, user, combinations of these and/or by any techniques. For example, in one embodiment, the memory system configuration (e.g. number, size, type, capability of memory system components etc.) may be determined at start-up. For example, in one embodiment, the CPU and/or BIOS etc. may probe the memory system at start-up. Once the memory system is probed and the memory configuration, parameters, etc. have been determined, the CPU etc. may, for example, configure certain regions, portions, parts etc. of memory. For example, certain regions of memory may be designated (e.g. allocated, assigned, mapped, equated, etc.) to one or more memory classes. For example, one or more memory classes may be designated etc. as (e.g. to correspond to, to behave according to, etc.) one or more memory models. For example, a first memory class may be designated as WB memory (e.g. as defined herein). For example, a second memory class may be designated as UC memory (e.g. as defined herein). Any number of memory classes may be used with any memory models (e.g. including, but not limited to, memory models defined herein, etc.) For example, in one embodiment, a first part, portion, etc. of the memory may be NAND flash memory. For example, in one embodiment, a second part, portion, etc. of the memory may be DRAM memory. For example, in one embodiment, the first memory portion may be assigned as a first memory class. For example, in one embodiment, the second memory portion may be assigned as a second memory class. For example, in one embodiment, the first memory portion or part of the first memory portion (e.g. first memory class, etc.) may be assigned as a first portion of UC memory. For example, in one embodiment, the second memory portion or part of the second memory portion (e.g. second memory class, etc.) may be assigned as a second portion of WB memory. Any part, parts, portion, portions of memory may be assigned in any fashion. For example, a first portion of the DRAM may be assigned as UC memory and a second portion of the DRAM may be assigned as WB memory, etc. For example, a first portion of the DRAM may be assigned as memory class #1 and a second portion of the DRAM may be assigned as memory class #2, etc.

In one embodiment, the memory models, memory classes, memory types, combinations of these and/or other memory parameters, behaviors, ordering, etc. may be implemented, architected, constructed, enabled, etc. in the context of FIG. 5. For example, one or more ordering buffers and/or equivalent functions may be used to control memory ordering. The programming, configuration, etc. of one or more ordering buffers and/or equivalent functions may be used to implement, alter, modify, configure, program, enforce, ensure, etc. one or more ordering rules, rule sets, etc. For example, the CPU, system, etc. may control, modify etc. the behavior of caching, buffering of memory pages, speculative reads, write combining, write buffering, etc.

FIG. 7 Stacked Memory Package Read/Write Datapath

FIG. 7 shows a part of the read/write datapath for a stacked memory package 700, in accordance with one embodiment. As an option, the read/write datapath may be implemented in the context of the previous Figure(s) and/or any subsequent Figure(s).

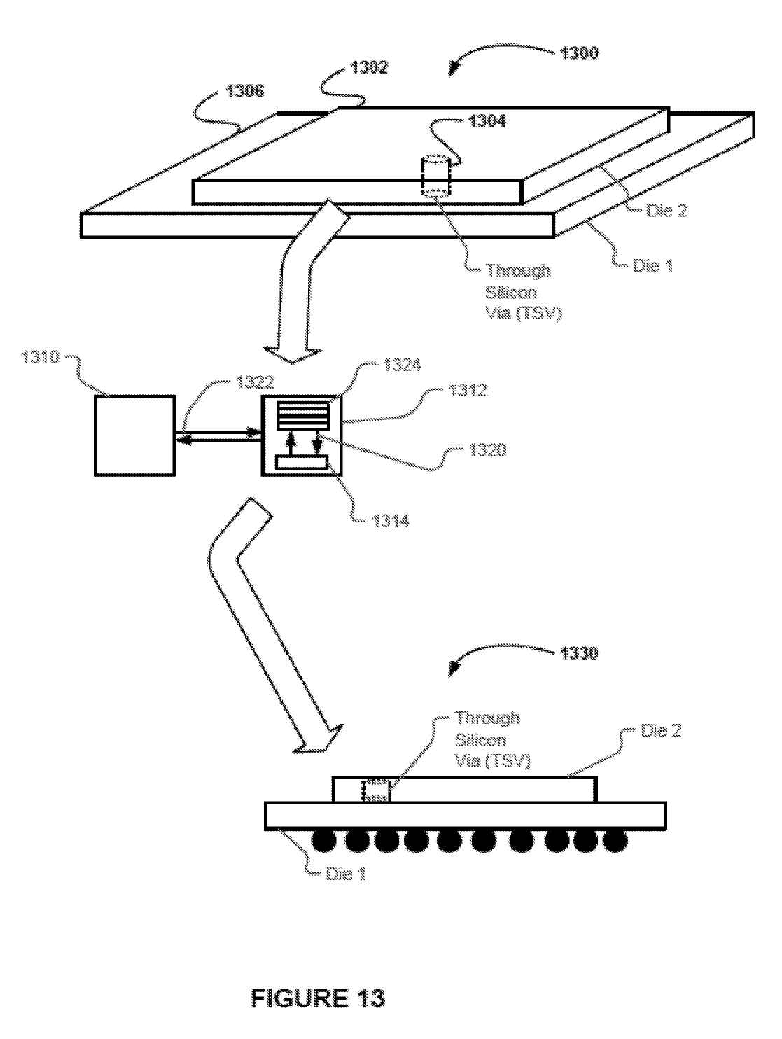

As an option, for example, the read/write datapath may be implemented in the context of FIG. 19-13 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” which is hereby incorporated by reference in its entirety for all purposes. Of course, however, the system may be implemented in any desired environment.

In FIG. 7, in one embodiment, part of the read/write datapath for a stacked memory package may be located, for example, between (e.g. logically between, etc.) the PHY and DRAM (or other memory type(s), technology, etc.). For example, in one embodiment, the part of the read/write datapath for a stacked memory package as shown in FIG. 7 may include the functions of a receiver arbiter or RxARB block that may, for example, perform arbitration (e.g. prioritization, separation, division, allocation, etc.) of received (e.g. received by a stacked memory package, etc.) commands (e.g. write commands, read commands, other commands and/or requests, etc.) and data (e.g. write data, etc.). For example, in one embodiment, the part of the read/write datapath for a stacked memory package as shown in FIG. 7 may include the functions of a transmitter arbiter or TxARB block that may, for example, perform arbitration (e.g. prioritization, separation, division, allocation, combining, tagging, etc.) of responses, completions, messages, commands (e.g. read responses, write completions, other commands and/or completions and/or responses, etc.) and data (e.g. read data, etc.).

In FIG. 7, in one embodiment, the read/write datapath for a stacked memory package may include (e.g. contain, use, employ, etc.) the following blocks and/or functions (but is not limited to the following): (1) DMUXA: the demultiplexer may take requests (e.g. read request, write request, commands, etc.) from, for example a receiver crossbar block (e.g. switch, MUX array, etc.) and split them into priority queues etc; (2) DMUXB: the demultiplexer may take requests from DMUXA and split them by request type; (3) VC1CMDQ: may be assigned to the isochronous command queue and may store those commands (e.g. requests, etc.) that correspond to isochronous operations (e.g. real-time, video, etc.); (4) VC2CMDQ: may be assigned to the non-isochronous command queue and may store those commands that are not isochronous; (5) DRAMCTL: the DRAM controller may generate commands for the DRAM (e.g. precharge (PRE), activate (ACT), refresh, power down, and/or other controls, etc.); (6) MUXA: the multiplexer may combine (e.g. arbitrate between, select according to fairness algorithm, etc.) command and data queues (e.g. isochronous and non-isochronous commands, write data, etc.); (7) MUXB: the multiplexer may combine commands with different priorities (e.g. in different virtual channels, etc.); (8) CMDQARB: the command queue arbiter may be responsible for selecting (e.g. in round-robin fashion, using other fairness algorithm(s), etc.) the order of commands to be sent (e.g. transmitted, presented, etc.) to the DRAM; (9) RSP: the response FIFO may store read data etc. from the DRAM etc; (10) NPT: the non-posted tracker may track (e.g. store, queue, order, etc.) tags, markers, fields, etc. from non-posted requests (e.g. non-posted writes, etc.) and may insert the tag etc. into one or more responses (e.g. with data from one or more reads, etc.); (11) MUXC: the multiplexer may combine (e.g. merge, aggregate, join, etc.) responses from the NPT with responses (e.g. read data, etc.) from the read bypass FIFO; (12) Read Bypass: the read bypass FIFO may store, queue, order, etc. one or more responses (e.g. read data, etc.) that may be sourced from one or more write buffers (thus for example a read to a location that is about to be written with data stored in a write buffer may bypass the DRAM).

In FIG. 7, in one embodiment, one possible arrangement of commands (e.g. posted requests, non-posted requests, etc.) and priorities (e.g. VC0, VC1, VC2, etc.) has been shown. Other variations (e.g. numbers and/or types of commands, requests etc, number and/or types of virtual channels, priorities, etc.) are possible.

For example, In FIG. 7, in one embodiment, commands, requests, etc. may be separated between isochronous and non-isochronous. The associated (e.g. corresponding, etc.) datapaths, functions, etc. may be referred to as the isochronous channel (ISO) and non-isochronous channel (NISO). The ISO channel may be used, for example, for memory commands associated with processes that may require real-time responses or higher priority (e.g. playing video, etc.). The command set may include a flag (e.g. bit field, etc.) in the read request, write request, etc. For example, there may be a bit in the control field in the basic command set that when set (e.g. set equal to 1, etc.) corresponds to ISO commands. Other types of channels may be used. Any number of channels may be used. The number and types of channels may be programmable and/or configured. Other methods, techniques, circuits, functions, etc. may be used to process, manage, store, prioritize, arbitrate, MUX, de-MUX, divide, separate, queue, order, re-order, shuffle, bypass, combine, or perform combinations of these and/or other operations and their equivalents etc.

For example, In FIG. 7, in one embodiment, commands, requests, etc. may be separated into three virtual channels (VCs): VC0, VC1, VC2. In FIG. 7, VC0 may, for example, correspond to the highest priority. The function of blocks between (e.g. logically between, etc.) DMUXB and MUXA may perform arbitration of the ISO and NISO channels. Commands in VC0 bypass (e.g. using ARB_BYPASS path, etc.) the arbitration functions of DMUXB through MUXA. In FIG. 7, the ISO commands are assigned to VC1. In FIG. 7, the NISO commands are assigned to VC2. Any assignment of commands, requests, etc. to any number of channels may be used. Multiple types of commands may be assigned, for example, to a single channel. For example, multiple channels may be used for one type of command, etc.

In one embodiment, all commands (e.g. requests, etc.) may be divided into one or more virtual channels.

In one embodiment, all virtual channels may use the same datapath.

In one embodiment, a bypass path may be used for the highest priority traffic (e.g. in order to avoid slower arbitration stages, etc.).

In one embodiment, isochronous traffic may be assigned to one or more virtual channels.

In one embodiment, non-isochronous traffic may be assigned to one or more virtual channels.

In one embodiment, the Rx datapath may allow reads from in-flight write operations. Thus, for example, in FIG. 7 in one embodiment, an in-flight write (e.g. a write with data, etc.) may be stored, queued, etc. in one or more buffers, FIFOs, queues, etc. in the Rx datapath, etc.). In this case a read to the same address, or a read to a location (e.g. address, etc.) within the write data address range may be accelerated by allowing the read to use the store write data. The read data may then use, for example, the read bypass FIFO in the TX datapath. The read data may be merged with tag, etc. from the non-posted tracker NPT and a complete response (e.g. read response, etc.) formed for transmission.

In one embodiment, one or more VCs may correspond to one or more memory types.

In one embodiment, one or more VCs may correspond to one or more memory models.

In one embodiment, one or more VCs may correspond to one or more types of cache, or to caches with different functions, behavior, parameters, etc.

In one embodiment, one or more VCs may correspond to one or more memory classes (as defined herein and/or in one or more applications incorporated by reference).

In one embodiment, any type of channel, virtual path, separation of datapath functions and/or operations, etc. may be used to implement on or more VCs or the equivalent functions and/or behavior of one or more VCs. For example, the Rx datapath may implement the functionality, behavior, properties, etc. of a datapath having one or more VCs without necessarily using separate physical queues, buffers, FIFOs, etc. For example, the function of the VC1CMDQ, shown in FIG. 7 as using three separate FIFOs, may be implemented using a single data structure with, for example, pointers and/or tags and/or data fields to mark, demarcate, link, identify, etc. posted write commands, nonposted write commands, read commands, etc. Similarly, the VC1CMDQ and VC2CMDQ may be implemented using a single data structure. Data (e.g. write data, etc.) may be stored in separate FIFOs (e.g. as shown in FIG. 7) or in a data structure with commands. Any arrangement of circuits, data structures, queues, FIFOs, combinations of these and/or other or equivalent functions, circuits, etc. may be used. The structure (e.g. implementation, architecture, etc.) of the datapath using de-MUXes, FIFOs, queues, MUXes, etc. that is shown in FIG. 7 is intended to show the nature, type, possible functions, etc. of a representative datapath implementation. However, any equivalent, similar, etc. techniques, circuits, architectures, functions, etc. for storing, queuing, shuffling, ordering, re-ordering, prioritizing, issuing, etc. commands and/or data etc. may be used. Note that not all connections (e.g. logical connections, physical connections, etc.) may be shown in FIG. 7 in order, for example, to simplify and clarify the explanation of the datapath functions. For example, the connection between the Rx datapath command queues and the nonposted tracker NPT may not be shown, etc.

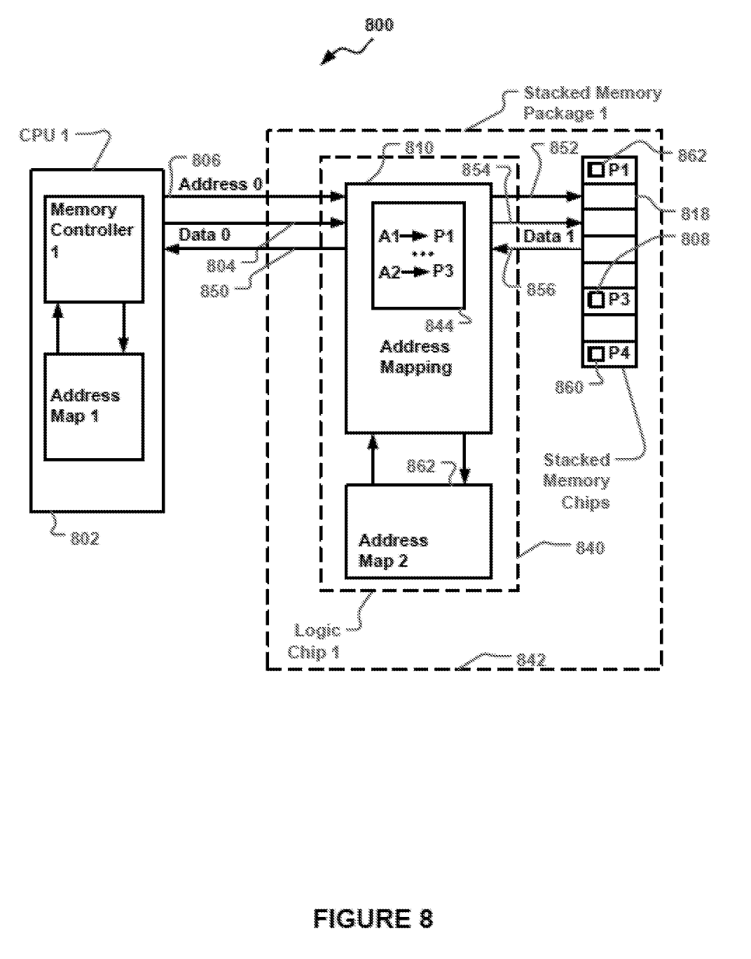

FIG. 8 Stacked Memory Package Repair System

FIG. 8 shows a stacked memory package repair system 800, in accordance with one embodiment. As an option, the stacked memory package repair system may be implemented in the context of the previous Figure(s) and/or any subsequent Figure(s).

In FIG. 8, in one embodiment, the stacked memory package repair system may comprise a system that may comprise one or more CPUs 802 and one or more stacked memory packages 842. In FIG. 8 one CPU is shown, but any number may be used. In FIG. 8 one stacked memory package is shown, but any number may be used. In FIG. 8 the stacked memory package may comprise one or more stacked memory chips 818 and one or more logic chips 840. In FIG. 8 one logic chip is shown, but any number may be used. In FIG. 8 eight stacked memory chips are shown, but any number of any number of types may be used.

In FIG. 8, in one embodiment, the CPU may include one or more memory controllers e.g. memory controller 1. In FIG. 8 the CPU may include one or more address maps, e.g. address map 1.

In FIG. 8, in one embodiment, the CPU, memory controllers, address maps, etc. may be coupled to the memory system, logic chips, and one or more stacked memory packages using an address 0 bus 806, an upstream data 0 bus 850, a downstream data 0 bus 804. Any number of address buses, data buses, control buses, other buses, signals, etc. may be used. Any type, technology, topology, form, etc. of bus, signaling, etc. may be used. In one embodiment, the buses may be high-speed serial links and may embed (e.g. include, carry, contain, convey, couple, communicate, etc.) data, command, control, other information etc. in one or more packets, etc.

In FIG. 8, in one embodiment, the logic chip may include one or more address maps 862. In FIG. 8 the logic chip may include one or more address mapping blocks 810, e.g. address map 2. In FIG. 8 the address mapping block may include one or more address mapping functions 844.

In FIG. 8, in one embodiment, the logic chips may be coupled to one or more stacked memory chips using an address 1 bus 852, an upstream data 1 bus 856, a downstream data 1 bus 854. Any number of address buses, data buses, control buses, other buses, signals, etc. may be used. Any type, technology, topology, form, etc. of bus, signaling, etc. may be used. In one embodiment, the buses may use TSV technology and TSV arrays. In one embodiment, the buses may be high-speed serial links and may embed (e.g. include, carry, contain, convey, couple, communicate, etc.) data, command, control, other information etc. in one or more packets, etc.

In FIG. 8, in one embodiment, the stacked memory chips may include one or more physical memory regions (e.g. address ranges, parts or portions of memory, memory echelons, etc.). Each memory region may have a physical memory address (e.g. start address, end address, address range, etc.). For example, memory region 862 may have physical memory address P1. For example, memory region 808 may have physical memory address P3. For example, memory region 860 may have physical memory address P4, etc.

In one embodiment, one or more logic chips in a stacked memory package may be operable to map memory addresses. Addresses may be mapped in order to repair, replace, map, map out, etc. one or more bad, broken, faulty, erratic, suspect, busy (e.g. due to testing, etc.), etc. memory regions. For example, in FIG. 8 the logic chip may contain and maintain (e.g. program, configure, create, update, modify, alter, etc.) an address mapping function 844 (e.g. maps, tables, data structures, logic structures, combinations of these and/or other similar logic functions, circuits, etc.). In FIG. 8 the address mapping function may contain one or more links (e.g. pointers, tables, indexes, combinations of these and/or other similar functions etc.) between one or more logical memory addresses (e.g. A1, A2, etc.) and the addresses, locations, status (e.g. bad, good, broken, replaced, to be replaced, testing, etc.), and/or other properties, information, status, parameters, of the physical memory addresses (e.g. P1, P3, etc.).

In one embodiment, the CPU may include an address map that may be used, for example, to map out bad memory regions. In one embodiment, one or more CPUs and one or more logic chips may contain one or more maps that may be used to map out bad memory regions, for example. In one embodiment, the system (e.g. CPU, OS, BIOS, operator, software, firmware, logic, state machines, combinations of these and/or other agents, etc.) may act to maintain one or more maps or be operable to maintain one or more maps. For example, in one embodiment, the system may populate the address maps, tables, other data structures etc. with good/bad address information, links, etc. at start-up.

In one embodiment, the memory system may use DRAM (e.g. in one or more stacked memory chips, etc.) or other volatile or nonvolatile storage (e.g. embedded DRAM, SRAM, NVRAM, NV logic, etc.) including storage on one or more logic chips etc. or combinations of storage elements, storage components, other memory, etc. to map one or more bad memory regions to one or more good memory regions.

In one embodiment, the memory system may use NAND flash on one or more stacked memory chips to store the maps. In one embodiment, the memory system may use NVRAM on one or more logic chips to store the maps. In one embodiment, the memory system may use NVRAM on one or more logic chips to store the maps. In one embodiment, one or more maps may use NAND flash or any non-volatile memory technology. In one embodiment, one or more maps may use embedded memory technology (e.g. integrated with logic on one or more logic chips in a stacked memory package). In one embodiment, one or more maps may use a separate memory chip. In one embodiment, one or more maps may be integrated with one or more CPUs, etc. For example, one or more maps may use logic non-volatile memory (NVM). The logic NVM used may be one-time programmable (OTP) and/or multiple-time programmable (MTP). The logic NVM used may be based on floating gate, Silicon-Oxide-Nitride-Oxide-Silicon (SONOS), oxide breakdown, trapped charge technologies, and/or any memory technology, etc.

For example, in one embodiment the mapping system may be architected as follows. Assume that the stacked memory chips in a stacked memory package include DRAM (e.g. DDR4 SDRAM, DDR3 SDRAM, etc.). Assume about 10% of DRAM is bad (e.g. due to bad TSVs, faulty DRAM that cannot be repaired using spare rows and/or spare columns, and/or otherwise bad, faulty, inaccessible, unreliable, etc.). Assume that a DRAM mat (e.g. a portion of a stacked memory chip, etc.) is 1024×1024b equal to 1 k×1 kb or 1 Mb. Then a DRAM die (e.g. stacked memory chip, etc.) may contain 4×64×64 mats=4×4096 Mb=16 Gb or 2 GB per DRAM die. Assume there may be 8 DRAM die per memory package for 16 GB total memory (one stacked memory package). Thus there may be 4×64×64×8 mats or 32768 mats or 32 k mats per stacked memory package. Assume a 64-bit memory address. The map size may thus be 32 k×64 or 2 Mb (1 Gb=2\hat{ }30 bits, 1 Mb=2\hat{ }20 bits). Thus, for example, in one embodiment, a map of 2 Mb may be used to map out 10% of a 16 GB stacked memory package at the level of a DRAM mat of size 1 Mb. The 2 Mb map may be stored using DRAM, NVRAM, using other memory, using combinations of these and/or other storage elements, components, etc.

In one embodiment, one or more maps (e.g. mat map, etc.) may be stored, located, etc. on one or more stacked memory chip(s), on part or portions of one or more stacked memory chip(s), etc. In one embodiment, one or more map mats (or other maps, e.g. at other level of hierarchy, etc.) may be accessed via a separate controller.

In one embodiment, one or more maps may be stored, located, etc. on eDRAM (e.g. on one or more logic chips, etc.) that may be, for example, loaded (e.g. copied, populated, read, etc.) from NVM and/or other nonvolatile logic. Maps may be stored, loaded, updated, configured, programmed, maintained, etc. in any fashion.

In one embodiment, maps, map storage, map loading, mapping, etc. may be architected according to the density, cost, other properties of memory technology available. For example, 500 Mb of SLC NAND flash in 180 nm technology may occupy approximately 130 mm\hat{ }2. Thus a map size of up to 5 Mb using this technology may be reasonable, while a map size of 100 Mb or more may be considered expensive. For example, 40 Mb of a typical NVM logic technology may occupy approximately 10 mm\hat{ }2. Thus a map size of up to 5 Mb using this technology may be reasonable, while a map size of 100 Mb or more may be considered expensive.

In one embodiment, different memory technologies, different loading techniques, etc. may be used for different maps. For example, in one embodiment, there may be a first type of map, an assembly map, and/or mapping that is used to hold data (e.g. bad addresses, bad address ranges, bad rows, bad columns, bad mats, etc.) on memory that is determined to be bad at, for example, assembly time. For example, in one embodiment, there may be a second type of map, a run time map, and/or mapping that is used to hold data on memory that is determined to be bad at, for example, run time (e.g. during operation, at start-up, at boot time, at certain designated test times, etc.). For example, in one embodiment, the memory system may use one-time programmable (OTP) memory (e.g. OTP NVM logic, etc.) for the assembly map and may use multiple time programmable (MTP) memory for the run time map. Any number of maps may be used. Any types of maps may be used (e.g. run time maps, test time maps, assembly time maps, etc.). Any type of memory technology may be used for any maps.

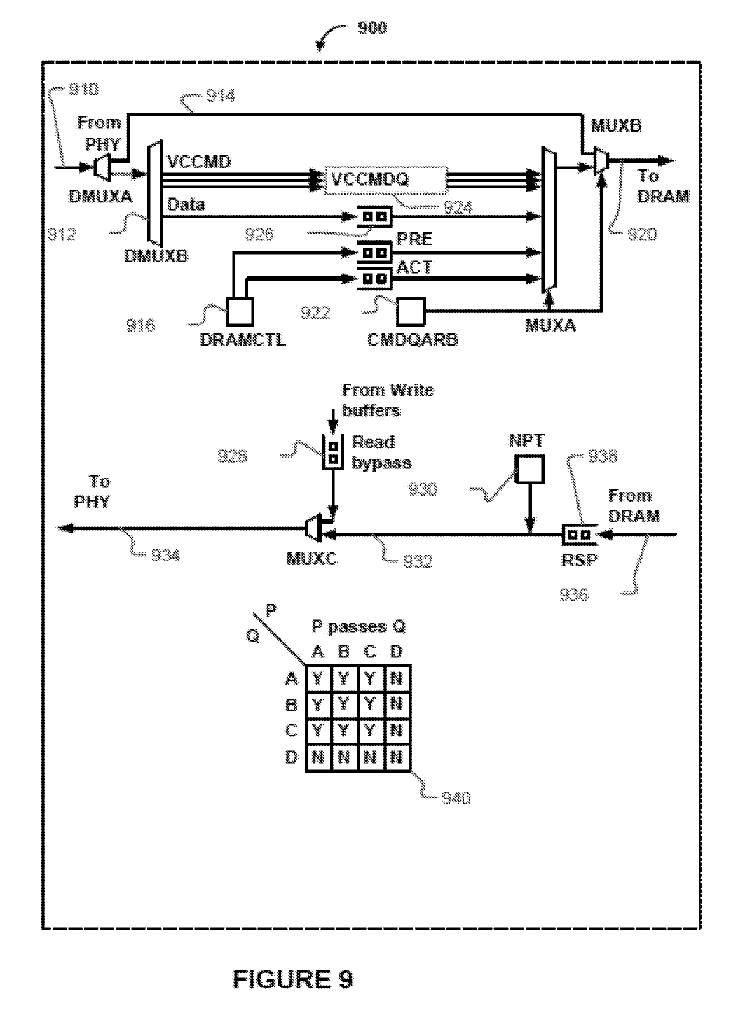

FIG. 9 Memory Type and Class.

FIG. 9 shows a programmable ordering system for a stacked memory package 700, in accordance with one embodiment. As an option, the programmable ordering system may be implemented in the context of the previous Figure(s) and/or any subsequent Figure(s).

As an option, for example, the programmable ordering system may be implemented in the context of FIG. 19-13 of U.S. application Ser. No. 13/710,411, filed Dec. 10, 2012, titled “SYSTEM, METHOD, AND COMPUTER PROGRAM PRODUCT FOR IMPROVING MEMORY SYSTEMS.” As an option, for example, the programmable ordering system may be implemented in the context of FIG. 7. Of course, however, the system may be implemented in any desired context, environment, etc.

In FIG. 9, in one embodiment, the programmable ordering system for a stacked memory package may include, for example, part of the read/write datapath. In FIG. 9, the read/write datapath for a stacked memory package may be located, for example, between (e.g. logically between, etc.) the PHY and DRAM. Any physical layer (e.g. PHY, etc.) may be used. Any memory technology or combinations of memory technologies may be used (e.g. DRAM, SDRAM, NAND flash, etc.). For example, in one embodiment, the part of the read/write datapath for a stacked memory package as shown in FIG. 9 may include the functions of a receiver arbiter or RxARB block that may, for example, perform arbitration (e.g. prioritization, separation, division, allocation, etc.) of received (e.g. received by a stacked memory package, etc.) commands (e.g. write commands, read commands, other commands and/or requests, etc.) and data (e.g. write data, etc.). For example, in one embodiment, the part of the read/write datapath for a stacked memory package as shown in FIG. 9 may include the functions of a transmitter arbiter or TxARB block that may, for example, perform arbitration (e.g. prioritization, separation, division, allocation, combining, tagging, etc.) of responses, completions, messages, commands (e.g. read responses, write completions, other commands and/or completions and/or responses, etc.) and data (e.g. read data, etc.).

In FIG. 9, in one embodiment, the read/write datapath for a stacked memory package may include (e.g. contain, use, employ, etc.) the following blocks and/or functions (but is not limited to the following): (1) DMUXA: the demultiplexer may take requests (e.g. read request, write request, commands, etc.) from, for example, a receive crossbar (e.g. switch, etc.) block and split them into priority queues etc; (2) DMUXB: the demultiplexer may take requests from DMUXA and split them by request type; (3) VCCMDQ: may store commands (e.g. requests, etc.) that correspond to one or more virtual channel operations; (4) other VCCMDQ (not shown) may be assigned to other channels and may store those commands assigned to those channels, etc; (5) DRAMCTL: the DRAM controller may generate commands for the DRAM (e.g. precharge (PRE), activate (ACT), refresh, power down, etc.); (6) MUXA: the multiplexer may combine (e.g. arbitrate between, select according to fairness algorithm, etc.) command and data queues (e.g. isochronous and non-isochronous commands, write data, etc.); (7) MUXB: the multiplexer may combine commands with different priorities (e.g. in different virtual channels, etc.); (8) CMDQARB: the command queue arbiter may be responsible for selecting (e.g. in round-robin fashion, using other fairness algorithm(s), etc.) the order of commands to be sent (e.g. transmitted, presented, issued, executed, forwarded, etc.) to the DRAM; (9) RSP: the response FIFO may store read data etc. from the DRAM etc; (10) NPT: the non-posted tracker may track (e.g. store, queue, order, etc.) tags, markers, fields, etc. from non-posted requests (e.g. non-posted writes, etc.) and may insert the tag etc. into one or more responses (e.g. with data from one or more reads, etc.); (11) MUXC: the multiplexer may combine (e.g. merge, aggregate, join, etc.) responses from the NPT with responses (e.g. read data, etc.) from the read bypass FIFO; (12) Read Bypass: the read bypass FIFO may store, queue, order, etc. one or more responses (e.g. read data, etc.) that may be sourced from one or more write buffers (thus for example a read to a location that is about to be written with data stored in a write buffer may bypass the DRAM).

In FIG. 9, only one VC has been shown but any number of VCs may be used and any assignment of commands (e.g. posted requests, non-posted requests, etc.) and priorities may be made to any VC (e.g. VC0, VC1, VC2, etc.). In one embodiment, any variation of assignment (e.g. numbers and/or types of commands, requests etc, number and/or types of virtual channels, priorities, etc.) is possible. For example, in one embodiment, one VCCMDQ may be used for multiple virtual channels. For example, in one embodiment, one VCCMDQ may be used for one virtual channel. For example, in one embodiment, a first VCCMDQ may be used for a first VC and a second VCCMDQ may be used for a second set of more than one VCs, etc.

For example, in FIG. 9, in one embodiment, commands, requests, etc. may be separated between isochronous and non-isochronous. The associated (e.g. corresponding, etc.) datapaths, functions, etc. may be referred to as the isochronous channel (ISO) and non-isochronous channel (NISO). The ISO channel may be used, for example, for memory commands associated with processes that may require real-time responses or higher priority (e.g. playing video, etc.). The command set may include a flag (e.g. bit field, etc.) in the read request, write request, etc. For example, there may be a bit in the control field in the basic command set that when set (e.g. set equal to 1, etc.) corresponds to ISO commands. In one embodiment, other types of channels may be used. In one embodiment, any number of channels may be used. In one embodiment, the number and types of channels may be programmable and/or configured. In one embodiment, other methods, techniques, circuits, functions, etc. may be used to process, manage, store, prioritize, arbitrate, MUX, de-MUX, divide, separate, queue, order, re-order, shuffle, bypass, combine, or perform combinations of these and/or other operations and their equivalents etc.

For example, in FIG. 9, in one embodiment, commands, requests, etc. may be separated into one or more virtual channels (VCs): VC0, VC1, VC2. THE VCs may use one or more VCCMQs, etc. In FIG. 9, VC0 may, for example, correspond to the highest priority. The function of blocks between (e.g. logically between, etc.) DMUXB and MUXA may perform arbitration of the ISO and NISO channels. Commands in VC0 may, for example, bypass (e.g. using ARB_BYPASS path, etc.) the arbitration functions of DMUXB through MUXA. In FIG. 9, the ISO commands may be assigned to VC1. In FIG. 9, the NISO commands may be assigned to VC2, etc. Any assignment of commands, requests, etc. to any number of channels may be used. Multiple types of commands may be assigned, for example, to a single channel. For example, multiple channels may be used for one type of command, etc.

In one embodiment, all commands (e.g. requests, etc.) may be divided into one or more virtual channels. In one embodiment, all virtual channels may use the same datapath. In one embodiment, a bypass path may be used for the highest priority traffic (e.g. in order to avoid slower arbitration stages, etc.). In one embodiment, isochronous traffic may be assigned to one or more virtual channels. In one embodiment, non-isochronous traffic may be assigned to one or more virtual channels.

In one embodiment, the Rx datapath may allow reads from in-flight write operations. Thus, for example, in FIG. 9 an in-flight write (e.g. a write with data, etc.) may be stored, queued, etc. in one or more buffers, FIFOs, queues, etc. in the Rx datapath, etc.). In this case a read to the same address, or a read to a location (e.g. address, etc.) within the write data address range may be accelerated by allowing the read to use the store write data. The read data may then use, for example, the read bypass FIFO in the TX datapath. The read data may be merged with tag, etc. from the non-posted tracker NPT and a complete response (e.g. read response, etc.) formed for transmission.

In one embodiment, one or more VCs may correspond to one or more memory types. In one embodiment, one or more VCs may correspond to one or more memory models. In one embodiment, one or more VCs may correspond to one or more types of cache, or to caches with different functions, behavior, parameters, etc. In one embodiment, one or more VCs may correspond to one or more memory classes (as defined herein and/or in one or more applications incorporated by reference).

In one embodiment, any type of channel, virtual path, separation of datapath functions and/or operations, etc. may be used to implement on or more VCs or the equivalent functions and/or behavior of one or more VCs. For example, the Rx datapath may implement the functionality, behavior, properties, etc. of a datapath having one or more VCs without necessarily using separate physical queues, buffers, FIFOs, etc. For example, the function of the VCCMDQ, shown in FIG. 9 as using a single FIFO may be implemented using one or more data structures, circuits, functions, etc. with, for example, pointers and/or tags and/or data fields to mark, demarcate, link, identify, etc. posted write commands, nonposted write commands, read commands, etc. Similarly, one or more VCCMDQs may be implemented using a single data structure. Data (e.g. write data, etc.) may be stored in separate FIFOs (e.g. as shown in FIG. 9) or in a data structure with commands. Any arrangement of circuits, data structures, queues, FIFOs, combinations of these and/or other or equivalent functions, circuits, etc. may be used. The structure (e.g. implementation, architecture, etc.) of the datapath using de-MUXes, FIFOs, queues, MUXes, etc. that is shown in FIG. 9 is intended to show the nature, type, possible functions, etc. of a representative datapath implementation. However, any equivalent, similar, etc. techniques, circuits, architectures, functions, etc. for storing, queuing, shuffling, ordering, re-ordering, prioritizing, issuing, etc. commands and/or data etc. may be used. Note that not all connections (e.g. logical connections, physical connections, etc.) may be shown in FIG. 9 in order, for example, to simplify and clarify the explanation of the datapath functions. For example, the connection between the Rx datapath command queues and the nonposted tracker NPT may not be shown, etc.

In one embodiment, the operation of the datapath (e.g. VCCMDQs, equivalent functions, etc.) may be determined (e.g. managed, directed, steered, programmed, configured, etc.) by one or more ordering tables 940. An ordering table may include (but is not limited to) one or more ordering rules (e.g. including but not limited to ordering rules as defined herein in the context of FIG. 5, etc.). For example, in FIG. 9 the ordering table may include a list of commands A, B, C, D. For example command A may correspond to a posted write, command B may correspond to a nonposted write, command C may correspond to a posted read, command D may correspond to a nonposted read, etc. Any number of commands may be included in the ordering table. Any types of commands may be included in the ordering table (e.g. reads, writes, loads, stores, requests, completions, commands, responses, messages, status, control, error, etc.). More than one ordering table may be used. For example, a first ordering table may apply to commands that target the same address (e.g. same start address, overlapping address ranges, etc.). For example, a second ordering table may apply to commands that target a different address (e.g. different start address, nonoverlapping address ranges, etc.). Ordering tables may be programmed and/or configured, etc. Programming etc. may be performed at design time, manufacture, assembly, test, start-up, boot time, during operation, at combinations of these times and/or at any time etc.

In one embodiment, the ordering table may contain entries (e.g. Y, N, etc.) that may indicate whether command P may pass (e.g. be ordered with respect to, etc.) command Q, where command P may be A, B, C, D, etc. and command Q may be A, B, C, D, etc. The ordering table may thus form a matrix etc. that dictates (e.g. governs, controls, indicates, manages, represents, defines, etc.) passing semantics. An ordering table entry of Y may allow (e.g. permit, enable, etc.) command P to pass command Q. An ordering table entry of N may prevent (e.g. disallow, disable, etc.) command P to pass command Q. Any form of table entry may be used. For example entries Y and N may be represented by 1 and 0, etc. There may be more than two entry vales. For example an entry vale of X may represent a don't care value, etc. Any number of ordering table entry values may be used for any purpose.

In one embodiment, a group, groups, sets, etc. of commands may be used in one or more ordering tables. For example, a first ordering table may describe the ordering rules of ISO traffic vs NISO traffic etc. For example, a second ordering table may describe the ordering rules of VC0 traffic vs VC1 traffic etc. Using groups, sets, etc. may reduce the number, size, complexity etc. of ordering tables. For example, an ordering table may be used to control the passing semantics (e.g. allowed passing behavior, etc.) of iso traffic and non-iso traffic in the context of FIG. 19-13 of U.S. application Ser. No. 13/710,411, filed Dec. 10, 2012, titled “SYSTEM, METHOD, AND COMPUTER PROGRAM PRODUCT FOR IMPROVING MEMORY SYSTEMS.” Any number of ordering tables may be used with (e.g. based on, corresponding to, etc.) any numbers of groups, sets, etc. of commands, requests, completions, responses, messages, etc. and/or types of traffic, channel types, targeted memory controller, memory address range, and/or any similar or like parameters, metrics, behaviors, features, functions, properties, etc.

In one embodiment, the CPU and/or other agent (e.g. OS, BIOS, firmware, software, user, combinations of these and/or other similar controls, agents, etc.) may load (e.g. store, write, etc.) and/or cause to load a matrix, or parts or portions of a matrix, combinations of these and/or other passing semantic parameters, information, ordering data, combinations of these and/or other data, etc. The data may be loaded to one or more ordering tables and/or other associated logic, state machines, registers, etc. that may control passing semantics, for example.

In one embodiment, passing semantics or the equivalent, like, etc. may be used to control command processing with respect to one or more of the following (but not limited to the following): traffic classes, virtual channels, bypass mechanisms, memory types (e.g. UC etc.), memory technology, memory class (as defined herein and/or in one or more specification incorporated by reference), ordering, reordering, combinations of these and/or other similar, equivalent, etc. mechanisms, techniques, etc.

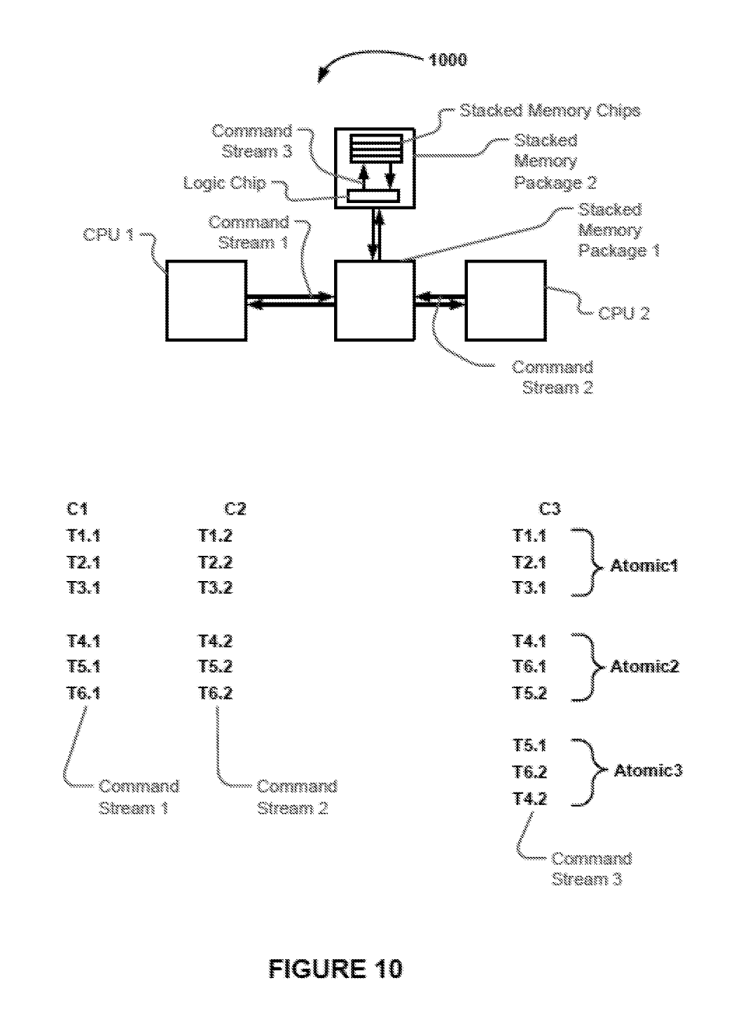

FIG. 10. Atomic Operations

FIG. 10 shows a stacked memory package system that supports atomic transactions 1000, in accordance with one embodiment. As an option, the stacked memory package system may be implemented in the context of the previous Figure(s) and/or any subsequent Figure(s).

As an option, for example, the stacked memory package system may be implemented in the context of FIG. 5. As an option, for example, the stacked memory package system may be implemented in the context of FIG. 7. As an option, for example, the stacked memory package system may be implemented in the context of FIG. 20-7 of U.S. application Ser. No. 13/710,411, filed Dec. 10, 2012, titled “SYSTEM, METHOD, AND COMPUTER PROGRAM PRODUCT FOR IMPROVING MEMORY SYSTEMS.” Of course, however, the stacked memory package system may be implemented in the context of any desired environment.

In FIG. 10, in one embodiment, the stacked memory package system may include one or more stacked memory packages. Any number and/or types of stacked memory packages may be used.

In FIG. 10, in one embodiment, the stacked memory packages may include one or more stacked memory chips. Any number and/or types of stacked memory chips may be used.

In FIG. 10, in one embodiment, the stacked memory packages may include one or more logic chips. Any number and/or types of logic chips may be used. Not all stacked memory packages need contain the same number of logic chips. In one embodiment, the logic chip and/or logic chip functions may be included on one or more stacked memory chips.

In FIG. 10, in one embodiment, the stacked memory package system may include one or more CPUs. Any number and/or types of CPUs may be used. In one embodiment, one or more CPUs may be integrated with one or more stacked memory packages.

In FIG. 10, in one embodiment, the stacked memory package system may include one or more command streams that may carry commands, requests, responses, completions, messages, etc. In one embodiment, the command streams may couple or act to couple one or more CPUs with one or more stacked memory packages. For example, in one embodiment, one or more commands streams may be carried (e.g. transmitted, etc.) using (e.g. employing, etc.) one or more high-speed serial links that may couple one or more CPUs to one or more stacked memory packages, etc. Any number and/or types of command streams may be used. Any type of coupling, connections, interconnect, etc. between the one or more CPUs and one or more stacked memory packages may be used.

For example, in one embodiment, the transactions (commands, etc.) on the command streams (e.g. carried by the command streams, etc.) may be as shown in FIG. 10, and as follows:

CPU #1 (e.g. command stream 1, C1) command ordering: command T1.1, command T2.1, command T3.1, command T4.1, command T5.1, command T6.1.

CPU #2 (e.g. command stream 2, C2) command ordering: command T1.2, command T2.2, command T3.2, command T4.2, command T5.2, command T6.2.

Here T1, T2, T3, etc. may refer, in general, to transactions (which typically may correspond to a single command, request etc. (e.g. read, load, write, store, etc. but in general may include more than one command, etc.) that may apply (e.g. be directed to, be applied to, etc.) different memory locations (e.g. addresses, address ranges, etc.). In FIG. 10, command stream 3 (C3) may be the order of commands as seen, for example, by the stacked memory chips (e.g. by one or more memory controllers, as present on one or more command buses, etc.) in a stacked memory package. For example, in FIG. 10 commands in command stream 1, command stream 2, command stream 3, may all be directed at the same stacked memory package (e.g. stacked memory package 2 in FIG. 10), but this need not be the case. Commands may be ordered, re-ordered etc. in one or more streams at any location and/or any locations in a memory system, etc. Ordering may be performed on commands with different addresses (e.g. T1, T2, T3, etc. may target different addresses, etc.) but this need not be the case. For example, in one embodiment, command ordering, re-ordering, etc. may be performed on commands that are targeted at the same address, same address range, overlapping address range, etc.

In one embodiment, one or more commands may be processed in sets, groups, collections, etc. as one or more atomic operations. For example, in FIG. 10, commands T1.1, T2.1, T3.1 may be processed (e.g. treated, handled, executed, issued, and/or otherwise manipulated etc.) as a first atomic operation, atomic1. For example, in FIG. 10, commands T4.1, T6.1, T5.2 may be processed as a second atomic operation, atomic2. For example, in FIG. 10, commands T5.1, T6.2, T4.2 may be processed as a third atomic operation, atomic3. Notice that: (1) atomic1 may include three commands, transactions, instructions, etc. that may have been issued (e.g. by CPU1, etc.) and placed in command stream 1 in the same order as they are to be executed; (2) atomic2 may include three commands that (a) were issued from more than one source (e.g. T4.1 from CPU1 and T5.2 from CPU2) and (b) may include one or more commands (e.g. T4.1 and T6.1) that are not sequential (e.g. T5.1 appears between T4.1 and T6.1); (3) atomic3 may include three commands that are not issued in the order they are to be executed (e.g. T4.2 was issued after T6.2). Note that the non-atomic commands have not been shown in command stream 3 for simplicity and clarity of explanation. Depending on non-atomic operation ordering the non-atomic commands may appear interleaved between atomic operations in commands stream 3.

For example, atomic operation atomic1 may illustrate (e.g. correspond to, provide an example of, etc.) an in-order atomic operation and a sequential atomic operation.

For example, atomic operation atomic2 may illustrate an multi-source atomic operation and a non-sequential atomic operation.

For example, atomic operation atomic3 may illustrate an out-of-order atomic operation (as well as a multi-source atomic operation).

In one embodiment, atomic operation support may include (e.g. support, implement, etc.) one or more of the following (but not limited to the following): in-order atomic operations, sequential atomic operations, multi-source atomic operation, non-sequential atomic operation, out-of-order atomic operations, and/or any combinations of these, etc.

In one embodiment, for example, command tags etc. may be used to mark, identify, order, re-order, shuffle, position, and/or perform ordering and/or other operations on one or more commands. For example, in one embodiment, a command tag, ID, etc. (e.g. a first 32-bit integer, an ID field, and/or other identifying number, bit field, etc.) may be used to uniquely identify a command in a command stream. (Tags may be reused, or rollover, but only one command may correspond to a tag field and be live, in use, in flight, etc. at any one time). For example, in one embodiment, an additional tag field (e.g. atomic operation tag, etc.) may be added to the command (e.g. use an additional field, use a special command format, populate an otherwise normally unused field, etc.). For example, in one embodiment, the atomic operation tag, for example, may include one or more of the following (but not limited to the following): the atomic operation number (e.g. an identifier, number, tag, ID etc. unique at any one time within the memory system); the number of commands (e.g. transactions, requests, etc.) in the atomic operation; the order of execution of commands (e.g. a number that indicates, starting with 0, the order of execution, etc.); flags, fields, data, and/or other information on any interactions with other atomic operations (e.g. if atomic operations are to be chained, linked, executed together, etc.); source identification (e.g. CPU number, stacked memory package identification, system component identification, etc; timestamp or other timing information, etc; any other information (e.g. actions to be performed on errors, hints and/or flexibility on command execution, etc.).

In one embodiment, for example, commands may be issued (e.g. created, forwarded, transmitted, sent, etc.) from any number of sources (e.g. CPUs, stacked memory packages, other system components, etc.). In one embodiment, for example, commands may be issued in any order.

In one embodiment, for example, one or more groups, sets, collections etc. of commands may be issued in a memory system that may support atomic operations and that may be compatible with split-transaction memory operations in PCI-e 3.0. For example, in one embodiment, one or more commands issued by a CPU may be converted, manipulated, translated, etc. to one or more PCI-e commands, transactions, etc. For example, in one embodiment, one or more commands issued by a CPU and adhering to (e.g. compatible with, etc.) a PCI-e standard (e.g. PCI-e 2.0, PCI-e 3.0, derivations of these standards, derivatives of these standards, etc.) may be converted, manipulated, translated, etc. to one or more commands, transactions, etc. that may be processed by one or more stacked memory packages. For example, in one embodiment, one or more logic chips in a stacked memory package, may translate, convert, modify, and/or otherwise perform manipulation on one or more commands to translate to one or more PCI-e transactions and/or translate from one or more PCI-e transactions. Such translation, for example, may include the translation, conversion, etc. of one or more atomic operations.

In one embodiment, for example, one or more logic chips (e.g. in a stacked memory package, etc.) and/or other agents etc. may perform re-ordering of operations in one or more atomic operations. In one embodiment, for example, one or more logic chips and/or other agents etc. may perform collection (e.g. grouping, aggregation, combining, other operations, etc.) of one or more operations from multiple sources in an atomic operation. For example, in one embodiment, a stacked memory package system with atomic operation support may be used in order to complete one or more bank transactions, etc. For example, it may be required to withdraw first monies from a first account #1 and deposit the same first monies in a second account #2 as an atomic transaction.

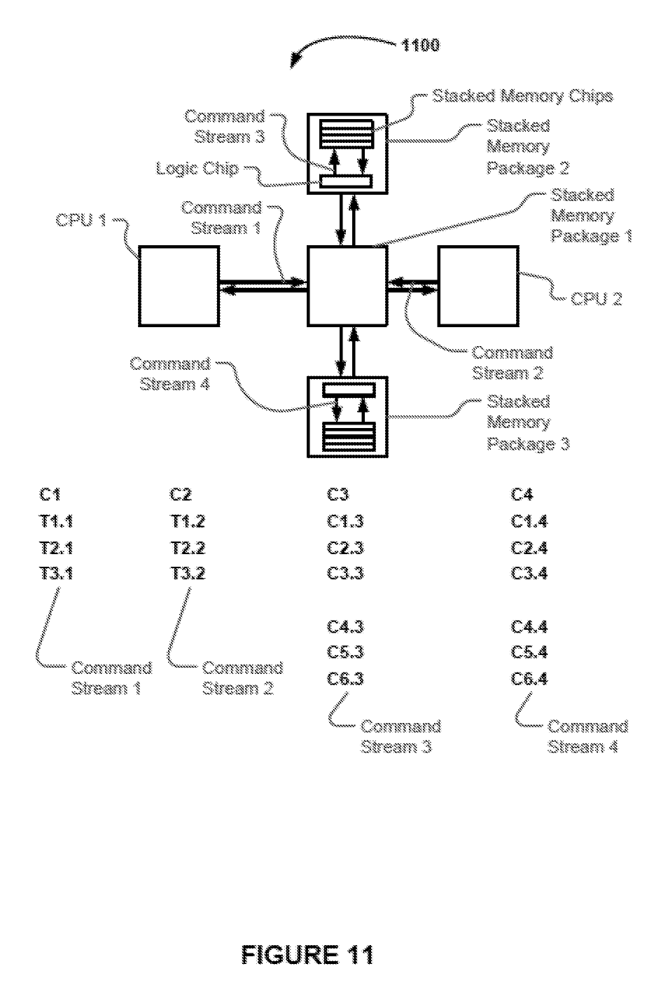

FIG. 11. Atomic Operations Across Multiple Stacked Memory Packages

FIG. 11 shows a stacked memory package system that supports atomic operations across multiple stacked memory packages 1100, in accordance with one embodiment. As an option, the stacked memory package system may be implemented in the context of the previous Figure(s) and/or any subsequent Figure(s).

As an option, for example, the stacked memory package system may be implemented in the context of FIG. 5. As an option, for example, the stacked memory package system may be implemented in the context of FIG. 7. As an option, for example, the stacked memory package system may be implemented in the context of FIG. 10. As an option, for example, the stacked memory package system may be implemented in the context of FIG. 20-7 of U.S. application Ser. No. 13/710,411, filed Dec. 10, 2012, titled “SYSTEM, METHOD, AND COMPUTER PROGRAM PRODUCT FOR IMPROVING MEMORY SYSTEMS.” Of course, however, the stacked memory package system may be implemented in the context of any desired environment.

In FIG. 11, in one embodiment, the stacked memory package system may include one or more stacked memory packages. Any number and/or types of stacked memory packages may be used.

In FIG. 11, in one embodiment, the stacked memory packages may include one or more stacked memory chips. Any number and/or types of stacked memory chips may be used.

In FIG. 11, in one embodiment, the stacked memory packages may include one or more logic chips. Any number and/or types of logic chips may be used. Not all stacked memory packages need contain the same number of logic chips. In one embodiment, the logic chip and/or logic chip functions may be included on one or more stacked memory chips.

In FIG. 11, in one embodiment, the stacked memory package system may include one or more CPUs. Any number and/or types of CPUs may be used. In one embodiment, one or more CPUs may be integrated with one or more stacked memory packages.

In FIG. 11, in one embodiment, the stacked memory package system may include one or more command streams that may carry commands, requests, responses, completions, messages, etc. In one embodiment, the command streams may couple or act to couple one or more CPUs with one or more stacked memory packages. For example, in one embodiment, one or more commands streams may be carried (e.g. transmitted, etc.) using (e.g. employing, etc.) one or more high-speed serial links that may couple one or more CPUs to one or more stacked memory packages, etc. Any number and/or types of command streams may be used. Any type of coupling, connections, interconnect, etc. between the one or more CPUs and one or more stacked memory packages may be used.

For example, in one embodiment, the transactions (commands, etc.) on command stream 1 and command stream 2 (e.g. carried by the command streams, etc.) may be as shown in FIG. 11, and may be as follows:

CPU #1 (e.g. command stream 1, C1) command ordering: command T1.1, command T2.1, command T3.

CPU #2 (e.g. command stream 2, C2) command ordering: command T1.2, command T2.2, command T3.2.

Here T1, T2, T3, etc. may refer, in general, to transactions (which typically may correspond to a single command, request etc. (e.g. read, load, write, store, etc. but in general may include more than one command, etc.) that may apply (e.g. be directed to, be applied to, etc.) different memory locations (e.g. addresses, address ranges, etc.). In FIG. 11, command stream 3 (C3) and command stream 4 (C4) may be the order of commands as seen, for example, by the stacked memory chips (e.g. by one or more memory controllers, as present on one or more command buses, etc.) in a stacked memory package. For example, in FIG. 11 commands in command stream 1, command stream 2, command stream 3, command stream 4, may be directed at different stacked memory packages (e.g. stacked memory package 2 and stacked memory package 3 in FIG. 11). In one embodiment, commands may be ordered, re-ordered etc. in one or more streams at any location and/or any locations in a memory system, etc. In one embodiment, ordering etc. may be performed on commands with different addresses (e.g. T1, T2, T3, etc. may target different addresses, etc.). For example, in one embodiment, command ordering, re-ordering, etc. may be performed on commands that are targeted at the same address, same address range, overlapping address range, etc.

For example, in one embodiment, the transactions (commands, etc.) on command stream 3 and command stream 4 may be as shown in FIG. 11, and may be as follows:

Stacked memory package 2 (e.g. command stream 3, C3) command ordering: command C1.3, command C2.3, command C3.3, command C4.3, command C5.3, command C6.3.

Stacked memory package 3 (e.g. command stream 4, C4) command ordering: command C1.4, command C2.4, command C3.4, command C4.4, command C5.4, command C6.4.

Here C1, C2, C3, C4, C5, C6, etc. may refer, in general, to commands in time slots (which typically may correspond to a single command, request etc. (e.g. read, load, write, store, etc. but in general may include more than one command, etc.) that may apply (e.g. be directed to, be applied to, etc.) different memory locations (e.g. addresses, address ranges, etc.).

For example, in FIG. 11, in one embodiment, to take a simple case for illustration, command T1.1 may correspond to (e.g. be placed in, be order to, be transmitted in, etc.) time slot C1.3; T2.1 may correspond to time slot C2.3, T3.1 may correspond to time slot C3.3, T1.2 may correspond to time slot C4.3, T2.2 may correspond to time slot C5.3, T3.2 may correspond to time slot C5.3. In this simple case, command stream 1 and command stream 2 map directly and sequentially to command stream 3. Such need not be the case. For example, commands from C1 may map to C3 and C4. For example, commands from C2 may map to C3 and C4. For example, commands from C1 may map to C3 and C4. For example, in some cases, commands from C1 (or C2, etc.) may be reordered (or may be allowed to reorder, permitted to reorder, caused to reorder, etc.) and may map to C3 and/or C4. For example, in a more complex case, command T1.1 may correspond to (e.g. map to, be ordered to, etc.) time slot C1.3; T2.1 may correspond to time slot C1.4, T3.1 may correspond to time slot C2.3, T1.2 may correspond to time slot C4.3, T2.2 may correspond to time slot C3.3 (e.g. out-of-order, reordered, etc.), T3.2 may correspond to time slot C5.3. Thus, in one embodiment, commands may be ordered (e.g. placed, located, inserted, etc.) from a first set of one or more command streams (e.g. C1, C2, etc. from sources such as CPU1, CPU2, etc.) to a second set of command streams (e.g. C3, C4, etc. to targets such as stacked memory package 2 and stacked memory package 3, etc.)

In one embodiment, one or more time slots in a first set of one or more command streams may be aligned with commands from a second set of one or more commands streams. For example, in FIG. 11, in one embodiment, it may be required that C3.4 execute at a certain time (e.g. is issued to a memory controller, is received by a DRAM, result is completed, and/or some other specified operation is complete, executed, started, finished and/or a specified state, results, etc. is achieved, etc.). For example, it may be required that C3.4 executes etc. after C4.3 (e.g. on a different stream, etc.). In this case, for example, the C4.3 time slot is aligned after the command C3.4 (or simply C4.3 is aligned after C3.4 or that it is required to align C4.3 after C3.4, etc.).

For example, in one embodiment, an additional tag field (e.g. alignment tag, etc.) may be added to the command (e.g. use an additional field, use a special command format, populate an otherwise normally unused field, etc.). For example, in one embodiment, the alignment tag, for example, may include one or more of the following (but not limited to the following): an alignment number (e.g. an identifier, number, tag, ID, and/or other reference to the command to align with, etc. unique at any one time within the memory system); flags, fields, data, and/or other information on any interactions with other commands; source identification (e.g. CPU number, stacked memory package identification, system component identification, etc; timestamp or other timing information, etc; any other information (e.g. actions to be performed on errors, hints and/or flexibility on alignment, etc.).

In one embodiment, one or more elements, parts, portions, etc. of alignment tag information and/or one or more alignment operations may be shared, commonly used, etc. with one or more elements, parts, portions, etc. of atomic operation tags and/or one or more atomic operations.

In one embodiment, alignment and/or any reordering etc. may be performed using one or more ordering buffers (e.g. as described in the context of FIG. 5 and/or using similar techniques to that described in the context of FIG. 5, etc.).

In one embodiment, alignment and/or any reordering etc. may be programmed and/or configured, etc. Programming may be performed at design time, manufacture, assembly, test, start-up, boot time, during operation, at combinations of these times and/or at any time, etc.

In FIG. 11, command stream 3 (C3) and command stream 4 (C4) may be the order of commands as seen, for example, by the stacked memory chips (e.g. by one or more memory controllers, as present on one or more command buses, etc.) in a stacked memory package. For example, in FIG. 11, in one embodiment, commands in command stream 1, command stream 2, command stream 3, command stream 4, may be directed at different stacked memory packages (e.g. to stacked memory package 2 and to stacked memory package 3 in FIG. 11). In one embodiment, commands may be ordered, re-ordered etc. in one or more streams at any location and/or any locations in a memory system, etc. In one embodiment, ordering may be performed on commands with different addresses (e.g. T1, T2, T3, etc. may target different addresses, etc.). For example, in one embodiment, command ordering, re-ordering, etc. may be performed on commands that are targeted at the same address, same address range, overlapping address range, etc.

In one embodiment, alignment and/or any reordering etc. may be performed by one or more logic chips in the stacked memory system. For example, one or more messages, control signals, and/or information, data (e.g. atomic operation tag information, alignment tag information, and/or other data, information, tags, fields, signals, etc.) may be exchanged between one or more logic chips, stacked memory packages, other system components, etc. For example, it may be required to align C4.3 after C3.4 (where, for example C3.4, C4.3 may represent both the time slot and the command in that time slot). In this case, in one embodiment, this command ordering may be achieved by using one or more logic chips. For example, in one embodiment, the logic chip in stacked memory package 3 (e.g. the target of stream 4 containing command C3.4, etc.) may send a signal, packet, control field, combinations of these and/or other indication(s) that may allow (e.g. direct, manage, control, etc.) the logic chip in stacked memory package 2 (e.g. the target of command stream 3 containing command C4.3, etc.) to order (e.g. delay, prevent execution of, store, hold off, stage, shuffle, etc.) command C4.3 such that command C4.3 executes after C3.4, etc. Any technique may be used to exchange information to perform alignment, ordering, etc. Any bus, signals, signal bundles, protocol, packets, fields in packets, combinations of these and/or other coupling, communication, etc. may be used to exchange information to perform alignment, ordering, etc. For example, in one embodiment, alignment data etc. may be sent on the same high-speed serial links used to transmit commands. For example, in one embodiment, alignment data may share packets with commands (e.g. alignment data etc. may be injected in, part of, inserted in, included with, appended to, etc. one or more command packets, etc.).

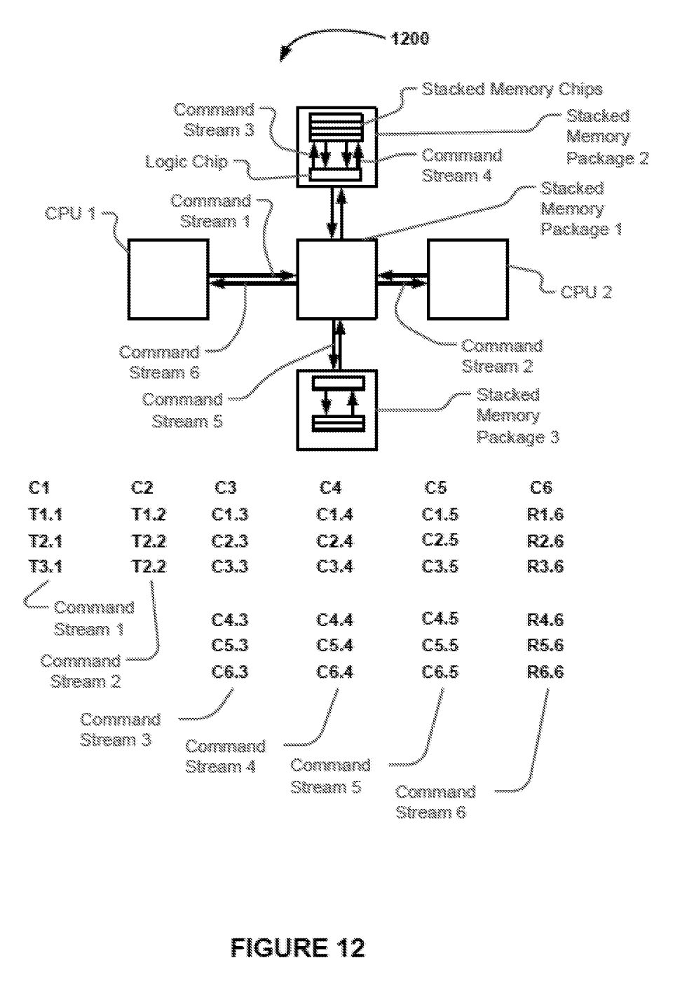

FIG. 12. Atomic Operations Across Multiple Controllers and Multiple Stacked Memory Packages.

FIG. 12 shows a stacked memory package system that supports atomic operations across multiple controllers and multiple stacked memory packages 1200, in accordance with one embodiment. As an option, the stacked memory package system may be implemented in the context of the previous Figure(s) and/or any subsequent Figure(s).

As an option, for example, the stacked memory package system may be implemented in the context of FIG. 5. As an option, for example, the stacked memory package system may be implemented in the context of FIG. 7. As an option, for example, the stacked memory package system may be implemented in the context of FIG. 10. As an option, for example, the stacked memory package system may be implemented in the context of FIG. 11. As an option, for example, the stacked memory package system may be implemented in the context of FIG. 20-7 of U.S. application Ser. No. 13/710,411, filed Dec. 10, 2012, titled “SYSTEM, METHOD, AND COMPUTER PROGRAM PRODUCT FOR IMPROVING MEMORY SYSTEMS.” Of course, however, the stacked memory package system may be implemented in the context of any desired environment.

In FIG. 12, in one embodiment, the stacked memory package system may include one or more stacked memory packages. Any number and/or types of stacked memory packages may be used.

In FIG. 12, in one embodiment, the stacked memory packages may include one or more stacked memory chips. Any number and/or types of stacked memory chips may be used.

In FIG. 12, in one embodiment, the stacked memory packages may include one or more logic chips. Any number and/or types of logic chips may be used. Not all stacked memory packages need contain the same number of logic chips. In one embodiment, the logic chip and/or logic chip functions may be included on one or more stacked memory chips.

In FIG. 12, in one embodiment, the stacked memory package system may include one or more CPUs. In one embodiment, any number and/or types of CPUs may be used. In one embodiment, one or more CPUs may be integrated with one or more stacked memory packages.

In FIG. 12, in one embodiment, the stacked memory package system may include one or more command streams that may carry commands, requests, responses, completions, messages, etc. In one embodiment, the command streams may couple or act to couple one or more CPUs with one or more stacked memory packages. For example, in one embodiment, one or more commands streams may be carried (e.g. transmitted, etc.) using (e.g. employing, etc.) one or more high-speed serial links that may couple one or more CPUs to one or more stacked memory packages, etc. In one embodiment, any number and/or types of command streams may be used. In one embodiment, any type of coupling, connections, interconnect, etc. between the one or more CPUs and one or more stacked memory packages may be used.

For example, in one embodiment, the transactions (commands, etc.) on command stream 1 and command stream 2 (e.g. carried by the command streams, etc.) may be as shown in FIG. 12, and may be as follows:

CPU #1 (e.g. command stream 1, C1) command ordering: command T1.1, command T2.1, command T3.

CPU #2 (e.g. command stream 2, C2) command ordering: command T1.2, command T2.2, command T3.2.

Here T1, T2, T3, etc. may refer, in general, to transactions (which typically may correspond to a single command, request etc. (e.g. read, load, write, store, etc. but in general may include more than one command, etc.) that may apply (e.g. be directed to, be applied to, etc.) different memory locations (e.g. addresses, address ranges, etc.). In FIG. 12, command stream 3 (C3), command stream 4 (C4), command stream 5 (C5) may be the order of commands as seen, for example, by the stacked memory chips (e.g. by one or more memory controllers, as present on one or more command buses, etc.) in a stacked memory package. For example, in FIG. 12 commands in command stream 1, command stream 2, command stream 3, command stream 4, command stream 5, may be directed at different stacked memory packages (e.g. stacked memory package 2 and stacked memory package 3 in FIG. 11). For example, in FIG. 12 responses in command stream 6 may be directed at one or more CPUs (e.g. CPU1 in FIG. 11).

In one embodiment, one or more commands may be duplicated, copied, mirrored, etc. For example, in one embodiment, a read response may be duplicated by a logic chip. For example, a first read response may be directed at CPU1, the first read response may be duplicated (e.g. copied, mirrored, etc.) as a second read response, and the second read response may be directed at CPU2. Any form of duplication, mirroring, copying, etc. may be used. For example, in one embodiment, a special format of command, response, completion, request, message, etc. may be used to direct the command etc. to more than one target. For example, a broadcast message may be directed to all system components (or a subset of system components, etc.) in a memory system. For example, a duplicate response, completion, etc. may be used to inform one or more system components (e.g. CPU, stacked memory package, etc.) that an operation has completed. Such a mechanism, technique etc. may be used, employed, etc. to perform or partly perform etc. alignment, ordering, combinations of these and/or other operations (e.g. across memory controllers, across stacked memory packages, between system components, and/or for performing functions associated with coherence, IO functions or operations, and/or other memory functions, behaviors, operations and the like, etc.).

In one embodiment, commands may be ordered, re-ordered etc. in one or more streams at any location and/or any locations in a memory system, etc. In one embodiment, ordering may be performed on commands with different addresses (e.g. T1, T2, T3, etc. may target different addresses, etc.). For example, in one embodiment, command ordering, re-ordering, etc. may be performed on commands that are targeted at the same address, same address range, overlapping address range, etc.

For example, in one embodiment, the transactions (commands, etc.) on command stream 3, command stream 4, command stream 5 may be as shown in FIG. 11, and may be as follows:

Stacked memory package 2 (e.g. command stream 3, C3, corresponding to a first memory controller in stacked memory package 2) command ordering: command C1.3, command C2.3, command C3.3, command C4.3, command C5.3, command C6.3.

Stacked memory package 2 (e.g. command stream 4, C4 corresponding to a second memory controller in stacked memory package 2) command ordering: command C1.4, command C2.4, command C3.4, command C4.4, command C5.4, command C6.4.

Stacked memory package 3 (e.g. command stream 4, C4, corresponding to a first memory controller in stacked memory package 3) command ordering: command C1.4, command C2.4, command C3.4, command C4.4, command C5.4, command C6.4.

Here C1, C2, C3, C4, C5, C6, etc. may refer, in general, to commands in time slots (which typically may correspond to a single command, request etc. (e.g. read, load, write, store, etc. but in general may include more than one command, etc.) that may apply (e.g. be directed to, be applied to, etc.) different memory locations (e.g. addresses, address ranges, etc.).

For example, in FIG. 12, to take a simple case for illustration, command T1.1 may correspond to (e.g. be placed in, be order to, be transmitted in, etc.) time slot C1.3; T2.1 may correspond to time slot C2.3, T3.1 may correspond to time slot C3.3, T1.2 may correspond to time slot C4.3, T2.2 may correspond to time slot C5.3, T3.2 may correspond to time slot C5.3. In this simple case, command stream 1 and command stream 2 may map directly and sequentially to command stream 3. Such need not be the case. For example, commands from C1 may map to both C3 and C4. For example, commands from C2 may map to both C3 and C4. For example, commands from C1 and C2 may map to both C3 and C4. For example, in some cases, commands from C1 (or C2, etc.) may be reordered (or may be allowed to reorder, permitted to reorder, caused to reorder, etc.) and may map to C3 and/or C4. For example, in a more complex case, command T1.1 may correspond to (e.g. map to, be ordered to, etc.) time slot C1.3; T2.1 may correspond to time slot C1.4, T3.1 may correspond to time slot C2.3, T1.2 may correspond to time slot C4.3, T2.2 may correspond to time slot C3.3 (e.g. out-of-order, reordered, etc.), T3.2 may correspond to time slot C5.3. Thus, in one embodiment, commands may be ordered (e.g. placed, located, inserted, etc.) from a first set of one or more command streams (e.g. C1, C2, etc. from sources such as CPU1, CPU2, etc.) to a second set of command streams (e.g. C3, C4, etc. to targets such as stacked memory package 2 and stacked memory package 3, etc.).

In one embodiment, one or more time slots in a first set of one or more command streams may be aligned with commands from a second set of one or more commands streams in the same memory package but associated with a different memory controller. For example, in FIG. 12, it may be required that C3.4 execute at a certain time (e.g. is issued to a memory controller, is received by a DRAM, result is completed, and/or some other specified operation is complete, executed, started, finished and/or a specified state, results, etc. is achieved, etc.). For example, it may be required that C3.4 executes etc. after C4.3 (e.g. on a different stream, associated with a different memory controller, etc.). In this case, for example, the C4.3 time slot is aligned after the command C3.4 (or simply C4.3 is aligned after C3.4 or that it is required to align C4.3 after C3.4, etc.).

In one embodiment, alignment and/or any reordering etc. may be performed by one or more logic chips in the stacked memory system. For example, one or more control signals, and/or information, data (e.g. atomic operation tag information, alignment tag information, and/or other data, information, tags, fields, signals, etc.) may be exchanged between one or more logic chips, etc. For example, it may be required to align C4.3 after C3.4 (where, for example C3.4, C4.3 may represent both the time slot and the command in that time slot). In this case, in one embodiment, this command ordering may be achieved by using one or more logic chips. For example, in one embodiment, a first logic chip in stacked memory package 2 (e.g. the target of stream 4 containing command C3.4, etc.) may send one or more signals, control fields, control bits, flags, combinations of these and/or other indication(s), indicator(s), etc. that may allow (e.g. direct, manage, control, etc.) a second logic chip in stacked memory package 2 (e.g. the target of command stream 3 containing command C4.3, etc.) to order (e.g. delay, prevent execution of, store, hold off, stage, shuffle, etc.) command C4.3 such that command C4.3 executes after C3.4, etc. In one embodiment the first logic chip may be the same as the second logic chip, but need not be so. Any technique may be used to exchange information to perform alignment, ordering, etc. Any bus, signals, signal bundles, protocol, packets, fields in packets, combinations of these and/or other coupling, communication, etc. may be used to exchange information to perform alignment, ordering, etc.

For example, in one embodiment, the commands (responses, completions, etc.) on command stream 6 may be as shown in FIG. 12, and may be as follows:

Stacked memory package 1 (e.g. command stream 6, C6, e.g. corresponding to a stream transmitted by a logic chip in stacked memory package 1) response ordering: response R1.6, response R2.6, response R3.6, response R4.6, response R5.6, response R6.6.

In one embodiment, responses, completions, etc. may be ordered, aligned, and/or otherwise manipulated. Thus, for example, in one embodiment, one or more responses, completions etc. may be ordered (e.g. across multiple memory controllers, across multiple stacked memory packages and/or other system components etc.). Thus, for example, in one embodiment, one or more responses, completions etc. may be aligned (e.g. across multiple memory controllers, across multiple stacked memory packages and/or other system components etc.). Other operations (e.g. read response combing, read response splitting, duplication of responses, broadcast of completions, etc.) may also be performed. In one embodiment, one or more responses may be generated as a result of one or more atomic operations. For example, in one embodiment, a single response may be generated to indicate the result (e.g. successful completion, failure with error, etc.). For example, in one embodiment, a single response may be generated to indicate the result of multiple reads in an atomic operation. For example, in one embodiment, a single write completion may be generated to indicate the result of multiple nonposted writes in an atomic operation, etc.

For example, T1.1 (e.g. in C1) may a first read command; T2.1 (e.g. in C1) may be a second read command. In one embodiment, it may be required that the response corresponding to T1.1. be R2.6 and the response corresponding to T2.1 be R1.6. Note that T1.1 and T2.1 may be targeted at the same address, different addresses, the same stacked memory package, different stacked memory packages, the same memory controller on a stacked memory package, different memory controllers on the same stacked memory package, etc. Ordering, alignment etc. may be performed on responses using the same or similar techniques as that described for commands (e.g. writes, read requests, etc.). For example, to perform ordering, alignment, etc. of responses across multiple memory controllers on the same stacked memory package tag information etc. may be signaled between memory controllers. For example, to perform ordering, alignment, etc. of responses across multiple stacked memory packages tag information etc. may be signaled between stacked memory packages. Any technique, mechanism, etc. may be used to exchange tag information etc. or any other information required to support ordering, alignment, etc. of responses, completions, etc.

FIG. 13. CPU with Wide I/O and Stacked Memory.

FIG. 13 shows a CPU with wide I/O and stacked memory 1300, in accordance with one embodiment. As an option, the CPU with wide I/O and stacked memory may be implemented in the context of the previous Figure(s) and/or any subsequent Figure(s). Of course, however, the CPU with wide I/O and stacked memory may be implemented in the context of any desired environment.

In one embodiment, the construction, composition, assemblage, architecture, coupling, and/or other features etc. illustrated in FIG. 13 may be applied (e.g. used, employed, etc.) in whole or in part as described herein and/or applied with (e.g. in conjunction with, in combination with, etc.) slight modification, minor changes, etc. in the context of one or more embodiments that may use stacked memory packages described herein and/or in one or more applications incorporated by reference. For example, as an option, the CPU with wide I/O and stacked memory may be used in the context of one or more embodiments that may use stacked memory packages in U.S. application Ser. No. 13/441,132, filed Apr. 6, 2012, titled “MULTIPLE CLASS MEMORY SYSTEMS,” and/or U.S. application Ser. No. 13/710,411, filed Dec. 10, 2012, titled “SYSTEM, METHOD, AND COMPUTER PROGRAM PRODUCT FOR IMPROVING MEMORY SYSTEMS.”

In FIG. 13, in one embodiment, the CPU with wide I/O and stacked memory may include a silicon die (e.g. chip, integrated circuit, etc.), die 1 1306. In FIG. 13, die 1 may be a CPU or may include one or more CPUs (e.g. CPU, multi-core CPU, etc.). In FIG. 13, one CPU 1301 is shown, but any number may be used.

In FIG. 13, in one embodiment, the CPU with wide I/O and stacked memory may include die 2 1302. In FIG. 13, die 2 may be a memory chip 1312. In one embodiment, die 2 may use any memory technology (e.g. DRAM, SDRAM, NVRAM, NAND flash, etc.). In one embodiment, die 2 may include one or more memory technologies (e.g. DRAM, SDRAM, NVRAM, NAND flash, combinations of these and/or any other memory technology, etc.). In FIG. 13, one memory chip is shown, but any number may be used (e.g. in one embodiment, one or more memory chips may be stacked on a CPU die, etc.).

In FIG. 13, in one embodiment, the CPU(s) and memory chip(s) may be coupled using TSV technology and TSVs 1304. In FIG. 13, only one TSV (exaggerated in size for clarity) is shown but typically tens, hundreds, thousands, hundreds of thousands, etc. may be used (with the number depending on process technology capability, yield, other manufacturing factors, cost, space, other design factor, and/or other factors, etc.).

In FIG. 13, in one embodiment, the memory chip(s) may contain one or more logic chips 1314. In FIG. 13, one logic chip is shown, but any number may be used.

In FIG. 13, in one embodiment, the memory chip(s) may contain one or more memory regions 1324 (e.g. memory parts, memory portions, etc.).

In FIG. 13, the CPUs and memory chip(s) may be coupled using one or more buses 1322. In one embodiment, the buses may be routed (e.g. connected, electrically coupled, joined, etc.) using TSV technology.

In FIG. 13, in one embodiment, the CPUs and memory chip(s) may be assembled (e.g. integrated, mounted, etc.) in a package 1330. Any type of packages and/or packaging may be used (e.g. BGA, chip scale, package-on-package, land grid array, combinations of these and/or other packages and package technologies, etc.).

In one embodiment, there may be one or more CPUs on die 1 and one or more CPUs on die 2. For example, a first CPU, CPU A may be included on die 1 and may be connected (e.g. coupled, etc.) to one or more memory chips with a second CPU, CPU B located on die 2. Any number of first CPUs may be used (e.g. CPU A may be a set of CPUs, multi-core CPU, etc.).

In one embodiment, the second CPU B may be located on a logic chip. Any number of second CPUs may be located on any number of logic chips. In one embodiment, for example, CPU B could be more than one CPU. In one embodiment, for example, there may be more than one memory controller on die 2 and there may be one CPU per memory controller. In one embodiment, for example, there may be more than one memory chip and thus more than one memory controller and there may be one CPU per memory controller.

In one embodiment, die 1 and die 2 may be coupled via (e.g. using, employing, with, etc.) one or more high-speed serial links.

In one embodiment, the CPU(s) on die 1 may be connected one or more memory chips via (e.g. using, employing, etc.) wide I/O. In one embodiment, each CPU on die 1 may be coupled to a part of the memory on one or more memory chips using wide I/O. In one embodiment, the CPUs on die 1 may be divided into one or more sets (e.g. pairs of CPUs etc.). In one embodiment, a first set of CPUs on die 1 (e.g. a first pair, etc.) may be coupled to a part of the memory on one or more memory chips using wide I/O. Thus, for example, a pair of CPUs (or any number) may share, partially share, multiplex, etc. a wide I/O connection.

In one embodiment, the logic chip(s) may be located on die 1 (e.g. with one or more CPUs, etc.). In one embodiment, a part or portions etc. of one or more logic chips may be located on die 1. In one embodiment, the logic chip functions etc. may distributed between die 1 and one or more memory chips (e.g. one or more die 2, etc.).

In one embodiment, one or more CPUs and the functions or part of the functions etc. of one or more logic chips may be located on the same die (e.g. integrated, etc.) and may be connected (e.g. coupled, etc.) to one or more memory chips. In one embodiment such an arrangement may use wide I/O to couple one or more die. In one embodiment such an arrangement may also include one or more CPUs as part of the logic chip functions. Thus in one embodiment, for example, there may be two types of CPU on a single die: (a) a first type of CPU that couples to the memory and using the memory to store program data etc; (b) a second type of CPU used by the logic chip functions (e.g. for test, for diagnosis, for repair, to implement macros, and/or other logical operations, etc.).

FIG. 14. Test System for a Stacked Memory Package.

FIG. 14 shows a test system for a stacked memory package system 1400, in accordance with one embodiment. As an option, the stacked memory package may be implemented in the context of the previous Figure(s) and/or any subsequent Figure(s). Of course, however, the stacked memory package may be implemented in the context of any desired environment.

In FIG. 14, in one embodiment, the stacked memory package system 1400 may include a CPU, 1410. In FIG. 14, one CPU is shown, but any number may be used. In one embodiment, the CPU may be integrated with the stacked memory package.

In FIG. 14, in one embodiment, the stacked memory package system 1400 may include a stacked memory package, 1412. In FIG. 14, one stacked memory package is shown, but any number may be used.

In FIG. 14, in one embodiment, the stacked memory package may include a logic chip die, 1414. In FIG. 14, one logic chip die is shown, but any number may be used. In one embodiment, the logic chip die may be part of one or more stacked memory chips. In one embodiment, the logic chip die may be integrated with the CPU (e.g. on the same die, in the same package, etc.).

In FIG. 14, in one embodiment, the logic chip die may include a logic chip, 1416. In FIG. 14, one logic chip is shown, but any number may be used.

In FIG. 14, in one embodiment, the logic chip may include a test engine, 1418. In FIG. 14, one test engine is shown, but any number may be used.

In FIG. 14, in one embodiment, the logic chip may include a test memory, 1420. In FIG. 14, one test memory is shown, but any number may be used. In one embodiment, the test memory may be of any type(s). For example, in one embodiment, the test memory may use logic non-volatile memory (logic NVM).

In one embodiment, the test engine (or equivalent function, etc.) may be any form of logic capable of performing logical operations, arithmetic calculations, logical functions, pattern generation, test sequence generation, test operations, all or parts of one or more test algorithms, programs, sequences, and/or other algorithms, etc. In one embodiment, the test engine may be a block capable of performing arithmetic and logical functions (e.g. add, subtract, shift, etc.) or may be a more specialized block, a set of functions, circuits, blocks, and/or any block(s) etc. capable of performing any functions, commands, requests, operations, algorithms, etc. Thus the use of the term test engine should not be interpreted as limiting the functions, capabilities, operations, etc. of the block as shown, for example, in FIG. 14. Note that FIG. 14 may not show all the connections of the test engine (or equivalent block) to all other components, circuits, blocks, functions, etc. Note that FIG. 14 may simplify some of the connections, interconnections, coupling etc. of the circuits, blocks, functions, etc. Note that, in embodiment, the test engine may be a CPU etc. but this may or may not be the same function or part of the same function as shown by the CPU 1410. For example, in one embodiment, the CPU 1410 may control, perform, manage, etc. one or more functions or part of one or more functions that may also be performed etc. on the test engine 1418. Thus, in one embodiment, for example, one or more functions, operations etc. may be shared between one or more CPUs and one or more test engines, etc. For example, in one embodiment, the CPU 1410 may be a multiprocessor (e.g. Intel Core series, etc.), other multicore CPU (e.g. ARM, etc.), a collection of CPUs, cores, etc. (e.g. heterogeneous, homogeneous, etc.) and/or any other CPU, multicore CPU, etc. For example, in one embodiment, the test engine 1418 may be an ARM core, other IP block, multicore CPU, combinations of these and/or other circuits, blocks, etc.

In one embodiment, the test engine and/or equivalent function (e.g. CPU, state machine, computation engine, macro, macro engine, engine, programmable logic, microcontroller, microcode, combinations of these and/or other computation functions, circuits, blocks, etc.) and/or other logic circuits, functions, blocks, etc. may perform one or more test operations (e.g. algorithms, commands, procedures, combinations of these and/or other test operations, etc.).

For example, in one embodiment, the test engine(s) etc. may create one or more test patterns (e.g. walking ones, etc.).

In one embodiment, one or more test patterns may be stored in the test memory (e.g. logic NVM, etc.).

In one embodiment, the CPU may be programmed to generate one or more test patterns. The one or more test patterns may be sent (e.g. transmitted, communicated, coupled, etc.) to one or more stacked memory packages. In one embodiment, the one or more test patterns generated by the CPU may be stored in the test memory. In one embodiment, a part or portions etc. of the stacked memory may be used to store all, part, portions, etc. of one or more test patterns.

In one embodiment, one or more CPUs on the one or more logic chips in a stacked memory package may be used as one or more test engines. In one embodiment, one or more programs, routines, algorithms, macros, code, combinations of these, parts or portions of these, combinations of parts or portions of these and/or other test data, information, measurements, results, etc. may be stored in the test memory.

In one embodiment, the test engine may be associated with (e.g. be coupled to, be connected to, be in communication with, correspond to, etc.) one or more memory controllers. For example, the logic chip may contain a number of independent, semi-independent, coupled, etc. memory controllers with each memory controller associated with one or more memory regions in the stacked memory chips. In this case, for example, there may one test engine per memory controller or set of memory controllers.

In one embodiment, the test system may use one or more external CPUs (e.g. one or more CPUs coupled to one or more stacked memory chips, etc.) to perform part or portions of the test functions. Thus, in one embodiment, for example one or more test functions, operations, etc. may be shared between one or more CPUs and one or more test engines.

In one embodiment, the test system may be used in conjunction with (e.g. in combination with, etc.) a repair system. For example, the test system may be used in the context of (e.g. in conjunction with, etc.) the repair system of FIG. 8. For example, the test system may generate, use, create one or more test patterns, programs, etc. to determine the connectivity, functionality, other properties, etc. of one or more connection paths, interconnect paths, buses, control lines, signal lines, wires, TSV arrays, TSV structures, etc. For example, the test system may generate, use, create one or more test patterns, programs, etc. to determine the connectivity, functionality, other properties, etc. of one or more circuits, decoders, buffers, memory circuits, sense amplifiers, and/or other control circuits, peripheral circuits, array circuits, etc. For example, as a result of performing one or more such test operations etc. the test system may store test results, test data, test information, connectivity maps, combinations of these and/or other test information in one or more address maps, test memory blocks, and/or other memory, storage, etc. The repair system and/or other circuits, blocks, functions may then use this and/or other information to perform sparing, repair, replacement, address remapping, combinations of these and/or other repair operations, etc.

In one embodiment, one or more memory structures (e.g. memory regions, etc.) on one or more logic chips may store data that is unable to be stored in one or more memory chips (e.g. due to faults, etc.). In one embodiment, these memory structures may, for example, form one or more spare regions of memory (e.g. spare memory regions, logic chip spare memory regions, etc.). In one embodiment, one or more spare memory regions may be part of test memory. In one embodiment, one or more test memories may be part, parts, etc. of the spare memory regions. In one embodiment, one or more spare memory regions may be volatile memory (e.g. SRAM, eDRAM, etc.). In one embodiment, one or more spare memory regions may be volatile memory (e.g. SRAM, eDRAM, etc.). In one embodiment, one or more spare memory regions may be volatile memory (e.g. SRAM, eDRAM, etc.). In one embodiment, one or more spare memory regions may be non-volatile memory (e.g. NVRAM, NAND flash, logic NVM, etc.). In one embodiment, one or more spare memory regions may form indexes, tables, mapping structures, and/or other data structures, logical structures and the like, etc. that may be used, employed, etc. in order to direct, change, modify, map, substitute, redirect, replace, alter, etc. one or more commands, requests, addresses, other address information, etc. For example, in one embodiment, the data structures may redirect commands etc. from faulty address locations etc. in one or more stacked memory chips to one or more alternate, spare, backup, mapped, etc. memory regions, etc. For example, in one embodiment, the alternate etc. memory regions may be located on one or more logic chips, one or more memory chips, combinations of these and/or other memory regions, spaces, circuits, locations, etc. For example, in one embodiment, any arrangement, architecture, design, etc. of spare memory regions may be used. For example, in one embodiment, any arrangement, architecture, design, etc. of data structures, tables, maps, indexes, pointers, handles, combinations of these and/or other logical structures, circuits, functions, etc. may be used to access, organize, create, maintain, configure, program, operate, etc. one or more spare memory regions.

For example, in one embodiment, configuration data etc. may be used to store information etc. about errors, faulty memory regions, unused spare memory regions, mapped spare memory regions (e.g. one or more regions being used to replace, etc. faulty memory regions, etc.), combinations of these and/or other data, information, etc. about spare memory regions, faulty memory regions, etc. For example, in one embodiment, configuration data, information, tables, indexes, pointers, etc. may be loaded from non-volatile memory (e.g. in a logic chip, etc.). For example, in one embodiment, configuration data etc. may be loaded from a first set of one or more non-volatile memories to a second set of one or more memories. For example, in one embodiment, the second set of memories may include non-volatile memory, volatile memory (e.g. DRAM in a stacked memory chip, etc.), combinations of these and/or any memory technology, etc.

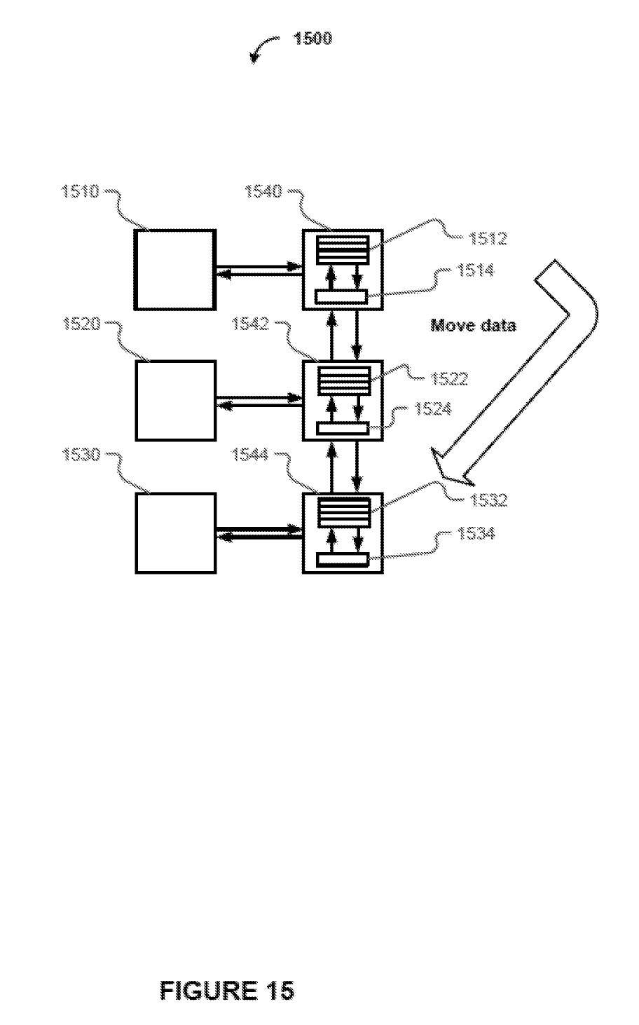

FIG. 15. Data Migration in a Stacked Memory Package System.

FIG. 15 shows a stacked memory package system with data migration 1500, in accordance with one embodiment. As an option, the stacked memory package system with data migration may be implemented in the context of the previous Figure(s) and/or any subsequent Figure(s).

In FIG. 15, in one embodiment, the stacked memory package system with data migration may include one or more CPUs 1510, 1520, 1530. Any number of CPUs may be used. For example, in FIG. 15, CPU 1510 may be CPU A. For example, in FIG. 15, CPU 1520 may be CPU B. For example, in FIG. 15, CPU 1530 may be CPU C.

In FIG. 15, in one embodiment, the stacked memory package system with data migration may include one or more stacked memory packages 1540, 1542, 1544. Any number of stacked memory packages may be used. For example, in FIG. 15, stacked memory package 1540 may be stacked memory package X. For example, in FIG. 15, stacked memory package 1542 may be stacked memory package Y. For example, in FIG. 15, stacked memory package 1544 may be stacked memory package Z.

In FIG. 15, in one embodiment, CPU A may continually operate on data Z, located in stacked memory package Z, which may be electrically remote from CPU A.

In one embodiment, the memory system may recognize the inefficiency of operating remotely on data and may move data, or cause data to be moved. For example, in one embodiment, the OS, BIOS, software, firmware, user, one or more CPUs, one or more logic chips, combinations of these and/or other agents may measure traffic, collect statistics, maintain MIBs, maintain counters, observe communications, and/or perform other measurements, observations etc. For example, in one embodiment, the OS, BIOS, software, firmware, user, one or more CPUs, one or more logic chips, combinations of these and/or other agents may determine that the memory system is being used inefficiently, the efficiency of the memory system may be improved, and/or otherwise determine that a data move and/or other operation may be executed (e.g. initiated, performed, scheduled, etc.), etc. For example, in one embodiment, the OS, BIOS, software, firmware, user, one or more CPUs, one or more logic chips, combinations of these and/or other agents may command, program, configure, reconfigure, etc. the memory system and initiate, execute, perform, schedule, etc. for example, a data move operation and/or other associated operations, etc.

For example, in FIG. 15, in one embodiment, one or more agents may recognize that data Z in a first location is far (e.g. electrically remote, etc.) from a second location (e.g. CPU A, etc.) and may move a part of, portions of, or the whole of data X to a third location (e.g. to X or to, both nearer to CPU A, etc.).

Other variations of this mechanism are possible. For example in one embodiment, one or more data swaps may be performed. For example, CPU A may be operating on data Y while CPU B operates on data X. In this case, for example, data X and data Y are electrically far from CPU A and CPU B. In this case, for example, data X and data Y may be swapped.

In one embodiment, one or more CPUs may perform swapping or cause swapping to be performed. For example, in one embodiment, the CPUs may perform partial swaps based on the content of memory. For example, in one embodiment, the CPUs may swap one or more of the following types of data (but not limited to the following types of data): stack, heap, code, program data, page files, pages, files, objects, metadata, indexes, combinations of these (including groups, sets, collections etc. of these) and/or other memory data structures. For example, swapping may be performed in the context of FIG. 20-8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS.”. Any agents may cause such swapping and/or perform such swapping. Swapping between more than two memory regions may be performed. For example, P may be swapped to Q, Q may be swapped to R, R may be swapped to P, etc. Swaps may be performed according to the size of the data to be swapped. The data to be swapped may be chosen, selected, etc. according to the swap spaces, regions, etc. available.

In one embodiment, the swap candidates (e.g. data X and data Y, etc.) may require translation and/or other manipulation (e.g. endian swap, etc.). For example, data X and data Y may correspond to different architectures, etc. In one embodiment, one or more swap operations may include translation. For example, one or more of the following (but not limited to the following) may be translated, modified, and/or otherwise manipulated: stack, heap, data, etc.

In one embodiment, data moves, swapping, etc. may be implemented in the context of copying, mirroring, duplication and/or other applications described elsewhere herein and/or in one or more applications incorporated by reference.

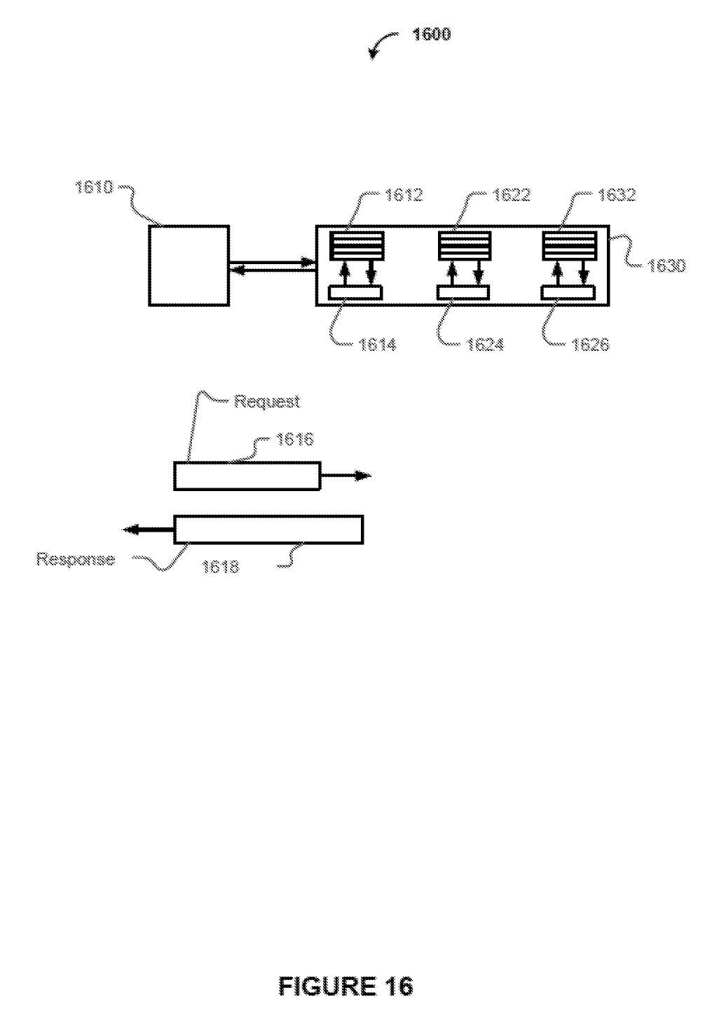

FIG. 16 Stacked Memory Package Read System

FIG. 16 shows a stacked memory package read system 1600, in accordance with one embodiment. As an option, the stacked memory package read system may be implemented in the context of the previous Figure(s) and/or any subsequent Figure(s).

In FIG. 16, in one embodiment, the stacked memory package read system may include a stacked memory package 1630. More than one stacked memory package may be used.

In FIG. 16, in one embodiment, the stacked memory package may include memory controllers: 1614, 1624, 1626. Any number of memory controllers may be used.

In FIG. 16, in one embodiment, the stacked memory package may include portions of stacked memory chips: 1612, 1622, 1632. Any number of portions of stacked memory chips may be used.

In FIG. 16, the stacked memory package read system may include a request 1616. Requests (e.g. read requests, etc.) may be used by the CPU(s) to request data from the stacked memory package(s).

In FIG. 16, in one embodiment, the stacked memory package read system may include a response 1618. Responses (e.g. read responses, etc.) may be used by the stacked memory package(s) to return requested data to the CPU(s).

In FIG. 16, in one embodiment, a request may cross a memory address boundary. For example, the CPU(s) may be unaware of how the stacked memory package is logically constructed, e.g. how the memory controllers are allocated to the portions of memory, etc. For example, in one embodiment a 128-byte read may correspond to two reads of 64 bytes across a boundary. For example, in one embodiment, a boundary could be located across (e.g. between, etc.) memory controllers.

In one embodiment, a stacked memory package read system may use NPT (non-posted tracking) to: (a) split a request, and (b) re-join responses. The NPT logic and functions may be implemented in the context of FIG. 7, for example and/or in the context of other similar embodiments described herein and/or in one or more applications incorporated by reference. For example, in this manner (e.g. using this technique and/or similar techniques, etc.) the CPU may be unaware (and may not need to know) how the stacked memory package is logically organized.

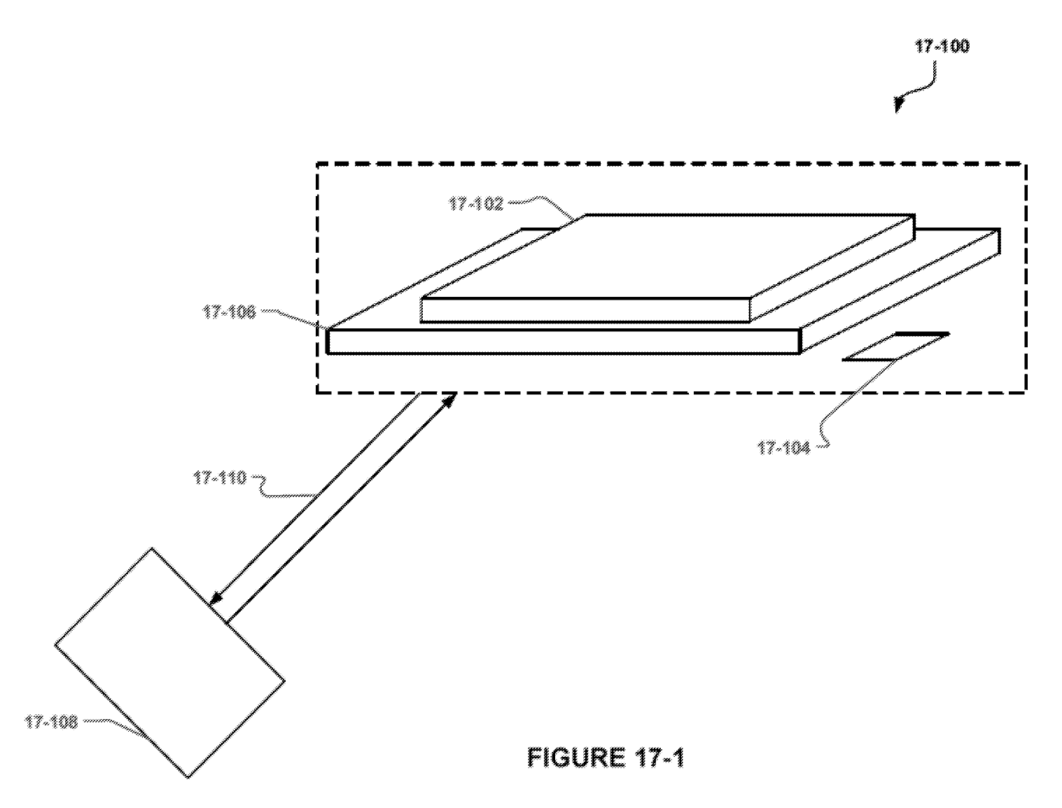

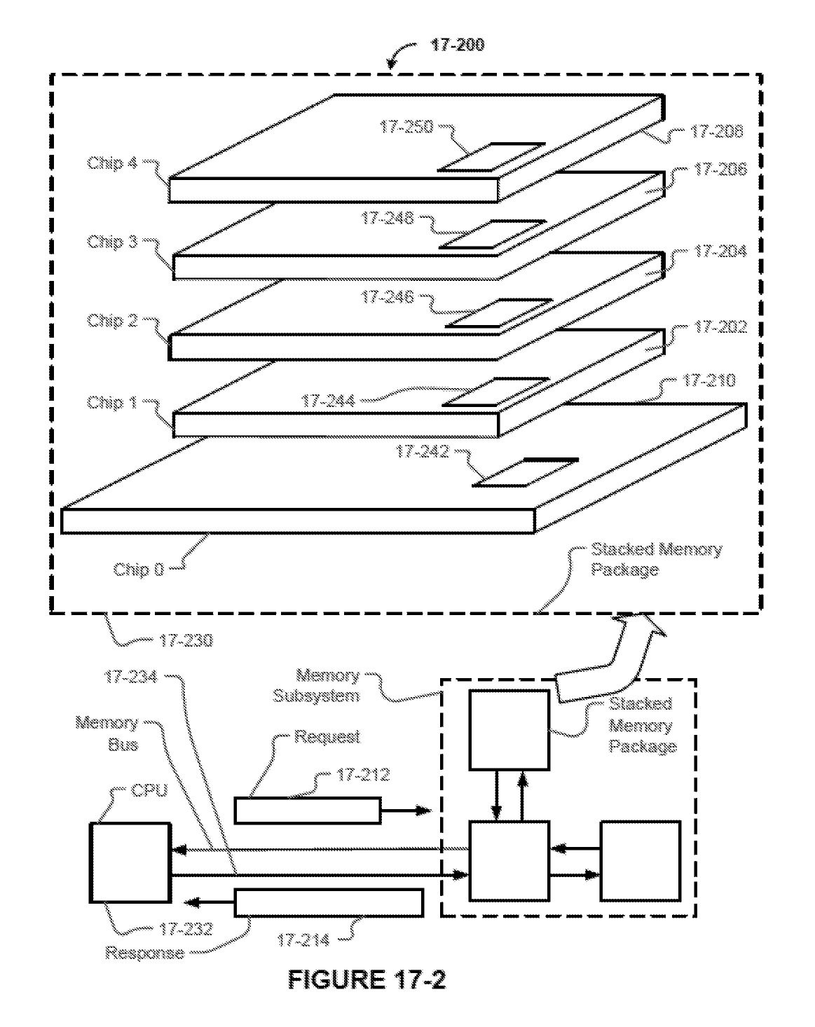

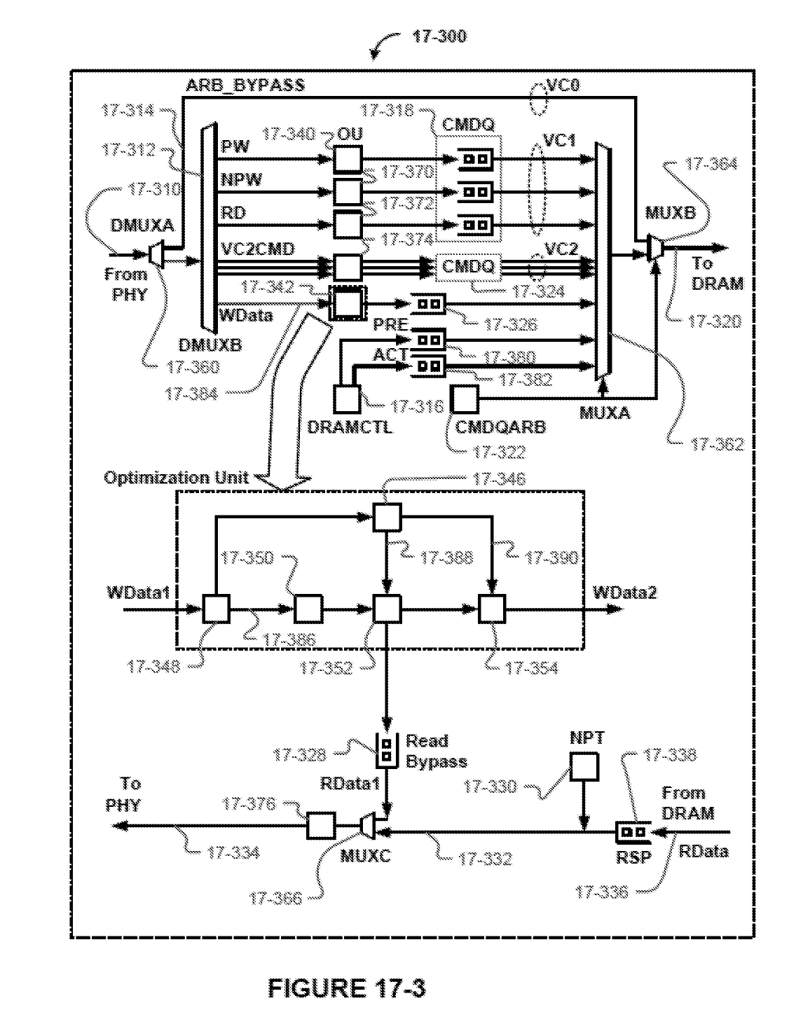

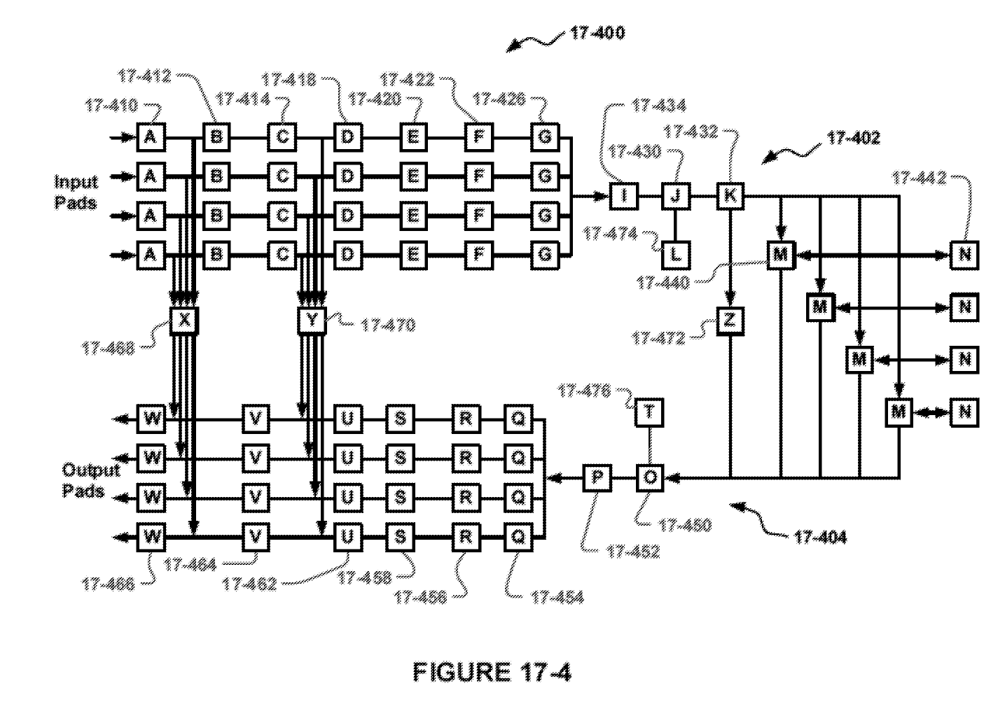

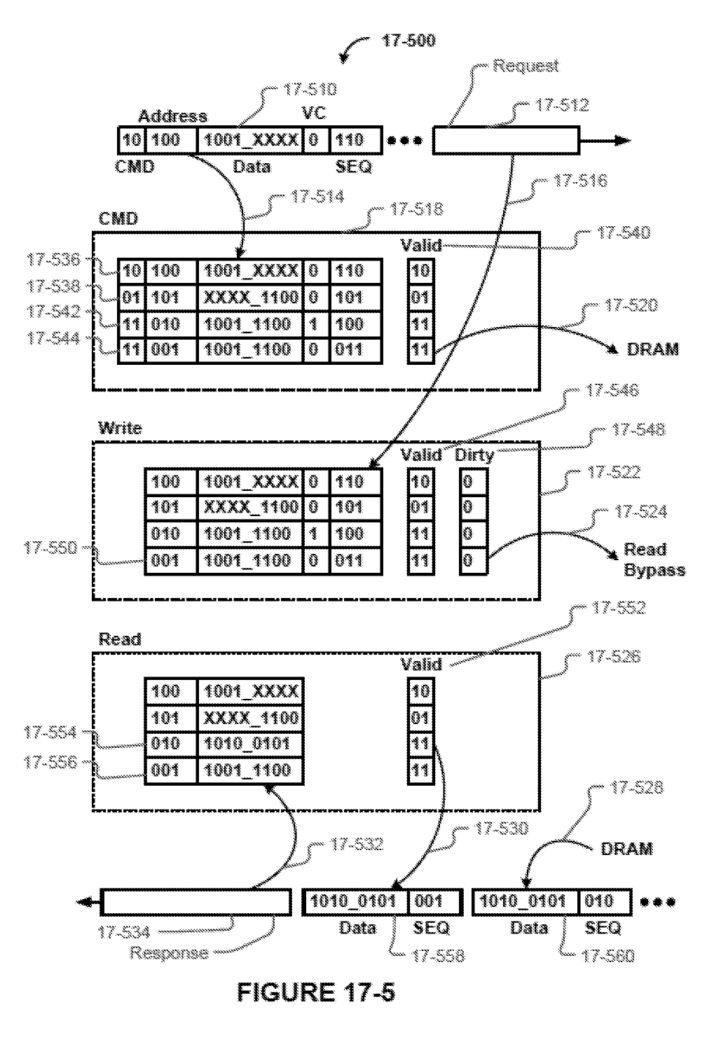

FIG. 17-1

FIG. 17-1 shows an apparatus 17-100 for path optimization, in accordance with one embodiment. As an option, the apparatus 17-100 may be implemented in the context of any subsequent Figure(s). Of course, however, the apparatus 17-100 may be implemented in the context of any desired environment.

It should be noted that a variety of optional architectures, capabilities, and/or features will now be set forth in the context of a variety of embodiments in connection with a description of FIG. 17-1. Any one or more of such optional architectures, capabilities, and/or features may or may not be used in combination with any other one or more of such described optional architectures, capabilities, and/or features. Of course, embodiments are contemplated where any one or more of such optional architectures, capabilities, and/or features may be used alone without any of the other optional architectures, capabilities, and/or features.

As shown, in one embodiment, the apparatus 17-100 includes a first semiconductor platform 17-102, which may include a first memory. Additionally, in one embodiment, the apparatus 17-100 may include a second semiconductor platform 17-106 stacked with the first semiconductor platform 17-102. In one embodiment, the second semiconductor platform 17-106 may include a second memory. As an option, the first memory may be of a first memory class. Additionally, in one embodiment, the second memory may be of a second memory class. Of course, in one embodiment, the apparatus 17-100 may include multiple semiconductor platforms stacked with the first semiconductor platform 17-102 or no other semiconductor platforms stacked with the first semiconductor platform.

In another embodiment, a plurality of stacks may be provided, at least one of which includes the first semiconductor platform 17-102 including a first memory of a first memory class, and at least another one which includes the second semiconductor platform 17-106 including a second memory of a second memory class. Just by way of example, memories of different classes may be stacked with other components in separate stacks, in accordance with one embodiment. To this end, any of the components described above (and hereinafter) may be arranged in any desired stacked relationship (in any combination) in one or more stacks, in various possible embodiments. Furthermore, in one embodiment, the components or platforms may be configured in a non-stacked manner. Furthermore, in one embodiment, the components or platforms may not be physically touching or physically joined. For example, one or more components or platforms may be coupled optically, and/or by other remote coupling techniques (e.g. wireless, near-field communication, inductive, combinations of these and/or other remote coupling, etc.).

In another embodiment, the apparatus 17-100 may include a physical memory sub-system. In the context of the present description, physical memory may refer to any memory including physical objects or memory components. For example, in one embodiment, the physical memory may include semiconductor memory cells. Furthermore, in various embodiments, the physical memory may include, but is not limited to, flash memory (e.g. NOR flash, NAND flash, other flash memory and similar memory technologies, etc.), random access memory (e.g. RAM, SRAM, DRAM, SDRAM, eDRAM, embedded DRAM, MRAM, PRAM, combinations of these, etc.), memristor, phase-change memory, FeRAM, PRAM, MRAM, resistive RAM, RRAM, a solid-state disk (SSD) or other disk, magnetic media, combinations of these and/or any other physical memory and/or memory technology etc. (volatile memory, nonvolatile memory, etc.) that meets the above definition.

Additionally, in various embodiments, the physical memory sub-system may include a monolithic memory circuit, a semiconductor die, a chip, a packaged memory circuit, or any other type of tangible memory circuit, or any intangible grouping of tangible memory circuits, combinations of these, etc. In one embodiment, the apparatus 17-100 or associated physical memory sub-system may take the form of a dynamic random access memory (DRAM) circuit. Such DRAM may take any form including, but not limited to, synchronous DRAM (SDRAM), double data rate synchronous DRAM (DDR SDRAM, DDR2 SDRAM, DDR3 SDRAM, etc.), graphics double data rate DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data out DRAM (EDO DRAM), burst EDO RAM (BEDO DRAM), multibank DRAM (MDRAM), synchronous graphics RAM (SGRAM), combinations of these and/or any other DRAM or similar memory technology.

In the context of the present description, a memory class may refer to any memory classification of a memory technology. For example, in various embodiments, the memory class may include, but is not limited to, a flash memory class, a RAM memory class, an SSD memory class, a magnetic media class, and/or any other class of memory in which a type of memory may be classified. Still yet, it should be noted that the memory classification of memory technology may further include a usage classification of memory, where such usage may include, but is not limited power usage, bandwidth usage, speed usage, etc. In embodiments where the memory class includes a usage classification, physical aspects of memories may or may not be identical.

In the one embodiment, the first memory class may include non-volatile memory (e.g. FeRAM, MRAM, PRAM, combinations of these and/or other similar memory technologies and the like, etc.), and the second memory class may include volatile memory (e.g. SRAM, DRAM, T-RAM, Z-RAM, TTRAM, combinations of these and/or other similar memory technologies and the like, etc.). In another embodiment, one of the first memory or the second memory may include RAM (e.g. DRAM, SRAM, etc.) and the other one of the first memory or the second memory may include NAND flash. In another embodiment, one of the first memory or the second memory may include RAM (e.g. DRAM, SRAM, etc.) and the other one of the first memory or the second memory may include NOR flash. Of course, in various embodiments, any number (e.g. 2, 3, 4, 5, 6, 7, 8, 9, or more, etc.) of combinations of memory classes may be utilized.

In one embodiment, there may be connections (not shown) that are in communication with the first memory and pass through the second semiconductor platform 17-106. Such connections that are in communication with the first memory and pass through the second semiconductor platform 17-106 may be formed utilizing through-silicon via (TSV) technology. Additionally, in one embodiment, the connections may be communicatively coupled to the second memory.

For example, in one embodiment, the second memory may be communicatively coupled to the first memory. In the context of the present description, being communicatively coupled refers to being coupled in any way that functions to allow any type of signal (e.g. a data signal, an electric signal, etc.) to be communicated between the communicatively coupled items. In one embodiment, the second memory may be communicatively coupled to the first memory via direct contact (e.g. a direct connection, etc.) between the two memories. Of course, being communicatively coupled may also refer to indirect connections, connections with intermediate connections therebetween, etc. In another embodiment, the second memory may be communicatively coupled to the first memory via a bus. In one embodiment, the second memory may be communicatively coupled to the first memory utilizing one or more TSVs.

As another option, the communicative coupling may include a connection via a buffer device. In one embodiment, the buffer device may be part of the apparatus 17-100. In another embodiment, the buffer device may be separate from the apparatus 17-100.

Further, in one embodiment, at least one additional semiconductor platform (not shown) may be stacked with the first semiconductor platform 17-102 and the second semiconductor platform 17-106. In this case, in one embodiment, the additional semiconductor may include a third memory of at least one of the first memory class or the second memory class, and/or any other additional circuitry. In another embodiment, the at least one additional semiconductor may include a third memory of a third memory class.

In one embodiment, the additional semiconductor platform may be positioned between the first semiconductor platform 17-102 and the second semiconductor platform 17-106. In another embodiment, the at least one additional semiconductor platform may be positioned above the first semiconductor platform 17-102 and the second semiconductor platform 17-106. Further, in one embodiment, the additional semiconductor platform may be in communication with at least one of the first semiconductor platform 17-102 and/or the second semiconductor platform 17-102 utilizing wire bond technology.

Additionally, in one embodiment, the additional semiconductor platform may include additional circuitry in the form of a logic circuit. In this case, in one embodiment, the logic circuit may be in communication with at least one of the first memory or the second memory. In one embodiment, at least one of the first memory or the second memory may include a plurality of subarrays in communication via shared data bus.

Furthermore, in one embodiment, the logic circuit may be in communication with at least one of the first memory or the second memory utilizing TSV technology. In one embodiment, the logic circuit and the first memory of the first semiconductor platform 17-102 may be in communication via a buffer. In this case, in one embodiment, the buffer may include a row buffer.

Further, in one embodiment, the apparatus 17-100 may be configured such that the first memory and the second memory are capable of receiving instructions via a single memory bus 17-110. The memory bus 17-110 may include any type of memory bus. Additionally, the memory bus may be associated with a variety of protocols (e.g. memory protocols such as JEDEC DDR2, JEDEC DDR3, JEDEC DDR4, SLDRAM, RDRAM, LPDRAM, LPDDR, combinations of these, etc.; I/O protocols such as PCI, PCI-E, HyperTransport, InfiniBand, QPI, etc.; networking protocols such as Ethernet, TCP/IP, iSCSI, combinations of these, etc.; storage protocols such as NFS, SAMBA, SAS, SATA, FC, etc.; combinations of these and/or other protocols (e.g. wireless, optical, inductive, NFC, etc.); etc.). Of course, other embodiments are contemplated with multiple memory buses.

In one embodiment, the apparatus 17-100 may include a three-dimensional integrated circuit. In one embodiment, the first semiconductor platform 17-102 and the second semiconductor platform 17-106 together may include a three-dimensional integrated circuit. In the context of the present description, a three-dimensional integrated circuit refers to any integrated circuit comprised of stacked wafers and/or dies (e.g. silicon wafers and/or dies, etc.), which are interconnected vertically and are capable of behaving as a single device.

For example, in one embodiment, the apparatus 17-100 may include a three-dimensional integrated circuit that is a wafer-on-wafer device. In this case, a first wafer of the wafer-on-wafer device may include the first memory of the first memory class, and a second wafer of the wafer-on-wafer device may include the second memory of the second memory class.

In the context of the present description, a wafer-on-wafer device refers to any device including two or more semiconductor wafers that are communicatively coupled in a wafer-on-wafer configuration. In one embodiment, the wafer-on-wafer device may include a device that is constructed utilizing two or more semiconductor wafers, which are aligned, bonded, and possibly cut in to at least one three-dimensional integrated circuit. In this case, vertical connections (e.g. TSVs, etc.) may be built into the wafers before bonding or created in the stack after bonding. In one embodiment, the first semiconductor platform 17-102 and the second semiconductor platform 17-106 together may include a three-dimensional integrated circuit that is a wafer-on-wafer device.

In another embodiment, the apparatus 17-100 may include a three-dimensional integrated circuit that is a monolithic device. In the context of the present description, a monolithic device refers to any device that includes at least one layer built on a single semiconductor wafer, communicatively coupled, and in the form of a three-dimensional integrated circuit. In one embodiment, the first semiconductor platform 17-102 and the second semiconductor platform 17-106 together may include a three-dimensional integrated circuit that is a monolithic device.

In another embodiment, the apparatus 17-100 may include a three-dimensional integrated circuit that is a die-on-wafer device. In the context of the present description, a die-on-wafer device refers to any device including one or more dies positioned on a wafer. In one embodiment, the die-on-wafer device may be formed by dicing a first wafer into singular dies, then aligning and bonding the dies onto die sites of a second wafer. In one embodiment, the first semiconductor platform 17-102 and the second semiconductor platform 17-106 together may include a three-dimensional integrated circuit that is a die-on-wafer device.

In yet another embodiment, the apparatus 17-100 may include a three-dimensional integrated circuit that is a die-on-die device. In the context of the present description, a die-on-die device refers to a device including two or more aligned dies in a die-on-die configuration. In one embodiment, the first semiconductor platform 17-102 and the second semiconductor platform 17-106 together may include a three-dimensional integrated circuit that is a die-on-die device.

Additionally, in one embodiment, the apparatus 17-100 may include a three-dimensional package. For example, the three-dimensional package may include a system in package (SiP) or chip stack MCM. In one embodiment, the first semiconductor platform and the second semiconductor platform are housed in a three-dimensional package.

In one embodiment, the apparatus 17-100 may be configured such that the first memory and the second memory are capable of receiving instructions from a device 17-108 via the single memory bus 17-110. In one embodiment, the device 17-108 may include one or more components from the following list (but not limited to the following list): a central processing unit (CPU); a memory controller, a chipset, a memory management unit (MMU); a virtual memory manager (VMM); a page table, a table lookaside buffer (TLB); one or more levels of cache (e.g. L1, L2, L3, etc.); a core unit; an uncore unit; combinations of these and/or other similar components, etc.

In the context of the following description, optional additional circuitry 17-104 (which may include one or more circuitries, components, blocks, etc. each adapted to carry out one or more of the features, capabilities, etc. described herein) may or may not be included to cause, implement, etc. any of the optional architectures, features, capabilities, etc. disclosed herein. While such additional circuitry 17-104 is shown generically in connection with the apparatus 17-100, it should be strongly noted that any such additional circuitry 17-104 may be positioned in any components (e.g. the first semiconductor platform 17-102, the second semiconductor platform 17-106, the device 17-108, an unillustrated logic unit or any other unit described herein, a separate unillustrated component that may or may not be stacked with any of the other components illustrated, a combination thereof, etc.).

In another embodiment, the additional circuitry 17-104 may or may not be capable of receiving (and/or sending) a data operation request and an associated a field value. In the context of the present description, the data operation request may include a data write request, a data read request, a data processing request and/or any other request that involves data. Still yet the field value may include any value (e.g. one or more bits, protocol signal, any indicator, etc.) capable of being recognized in association with a field that is affiliated with memory class selection. In various embodiments, the field value may or may not be included with the data operation request and/or data associated with the data operation request. In response to the data operation request, at least one of a plurality of memory classes may be selected, based on the field value. In the context of the present description, such selection may include any operation or act that results in use of at least one particular memory class based on (e.g. dictated by, resulting from, etc.) the field value. In another embodiment, a data structure embodied on a non-transitory readable medium may be provided with a data operation request command structure including a field value that is operable to prompt selection of at least one of a plurality of memory classes, based on the field value. As an option, the foregoing data structure may or may not be employed in connection with the aforementioned additional circuitry 17-104 capable of receiving (and/or sending) the data operation request.

In yet another embodiment, any one or more of the components shown in the present figure may be individually and/or collectively operable to optimize a path between an input and an output thereof. In the context of the present description, the aforementioned path may include one or more non-transitory mediums (or portion thereof) by which any anything (e.g. signal, data, command, etc.) is communicated from the input, to the output, and/or anywhere therebetween. Further, in one embodiment, the input and output may include pads of any one or more components (or combination of components) shown in the present figure.

In one embodiment, the path may include a command path. In another embodiment, the path may include a data path. For that matter, any type of path may be included.

Further, as mentioned earlier, any one or more components (or combination of components) may be operable to carry out the optimization. For instance, in one possible embodiment, the optimization may be carried out, at least in part, by the aforementioned logic circuit.

Still yet, in one embodiment, the optimization may be accomplished in association with at least one command. As an option, in some embodiments, the optimization may be in association with the at least one command by reordering, ordering, insertion, deletion, expansion, splitting, combining, and/or aggregation. As other options, in other embodiments, the optimization may be carried out in association with the at least one command by generating the at least one command from a received command, generating the at least one command in the form of at least one raw command, generating the at least one command in the form of at least one signal, and/or via a manipulation thereof. In the last-mentioned exemplary embodiment, the manipulation may be of command timing, execution timing, and/or any other manipulation, for that matter. In still other embodiments, the optimization may be carried out in association with the at least one command by optimizing a performance and/or a power.

In other embodiments, the aforementioned optimization may be accomplished in association with data. For example, in one possible embodiment, the optimization may be carried out in association with data utilizing at least one command for placing data in the first memory and/or the second memory.

In still other embodiments, the aforementioned optimization may be accomplished in association with at least one read operation using any desired technique (e.g. buffering, caching, etc.). In still yet other embodiments, the aforementioned optimization may be accomplished in association with at least one write operation, again, using any desired technique (e.g. buffering, caching, etc.).

In other embodiments, the aforementioned optimization may be performed by distributing a plurality of optimizations. For example, in different optional embodiments, a plurality of optimizations may be distributed between the first memory, the second memory, the at least one circuit, a memory controller and/or any other component(s) that is described herein.

As set forth earlier, any one or more of the foregoing optional architectures, capabilities, and/or features may or may not be used in combination with any other one or more of such optional architectures, capabilities, and/or features. Still yet, any one or more of the foregoing optional architectures, capabilities, and/or features may be implemented utilizing any desired apparatus, method, and program product (e.g. computer program product, etc.) embodied on a non-transitory readable medium (e.g. computer readable medium, etc.). Such program product may include software instructions, hardware instructions, embedded instructions, and/or any other instructions, and may be used in the context of any of the components (e.g. platforms, processing unit, MMU, VMM, TLB, etc.) disclosed herein, as well as semiconductor manufacturing/design equipment, as applicable.

Even still, while embodiments are described where any one or more of the foregoing optional architectures, capabilities, and/or features may or may not be incorporated into a memory system, additional embodiments are contemplated where a processing unit (e.g. CPU, GPU, etc.) is provided in combination with or in isolation of the memory system, where such processing unit is operable to cooperate with such memory system to accommodate, cause, prompt and/or otherwise cooperate, coordinate, etc. with the memory system to allow for any of the foregoing optional architectures, capabilities, and/or features. For that matter, further embodiments are contemplated where a single semiconductor platform (e.g. 17-102, 17-106, etc.) is provided in combination with or in isolation of any of the other components disclosed herein, where such single semiconductor platform is operable to cooperate with such other components disclosed herein at some point in a manufacturing, assembly, OEM, distribution process, etc., to accommodate, cause, prompt and/or otherwise cooperate with one or more of the other components to allow for any of the foregoing optional architectures, capabilities, and/or features. To this end, any description herein of receiving, processing, operating on, reacting to, etc. signals, data, etc. may easily be replaced and/or supplemented with descriptions of sending, prompting/causing, etc. signals, data, etc. to address any desired cause and/or effect relationship among the various components disclosed herein.

It should be noted that while the embodiments described in this specification and in specifications incorporated by reference may show examples of stacked memory system and improvements to stacked memory systems, the examples described and the improvements described may be generally applicable to a wide range of memory systems and/or electrical systems and/or electronic systems. For example, improvements to signaling, yield, bus structures, test, repair etc. may be applied to the field of memory systems in general as well as systems other than memory systems, etc. Furthermore, it should be noted that the embodiments/technology/functionality described herein are not limited to being implemented in the context of stacked memory packages. For example, in one embodiment, the embodiments/technology/functionality described herein may be implemented in the context of non-stacked systems, non-stacked memory systems, etc. For example, in one embodiment, memory chips and/or other components may be physically grouped together using one or more assemblies and/or assembly techniques other than stacking. For example, in one embodiment, memory chips and/or other components may be electrically coupled using techniques other than stacking. Any technique that groups together (e.g. electrically and/or physically, etc.) one or more memory components and/or other components may be used.

More illustrative information will now be set forth regarding various optional architectures, capabilities, and/or features with which the foregoing techniques discussed in the context of any of the Figure(s) may or may not be implemented, per the desires of the user. For instance, various optional examples and/or options associated with the configuration/operation of the apparatus 17-100, the configuration/operation of the first and/or second semiconductor platforms, and/or other optional features (e.g. transforming the plurality of commands or packets in connection with at least one of the first memory or the second memory, etc.) have been and will be set forth in the context of a variety of possible embodiments. It should be strongly noted that such information is set forth for illustrative purposes and should not be construed as limiting in any manner. Any of such features may be optionally incorporated with or without the inclusion of other features described.

It should be noted that any embodiment disclosed herein may or may not incorporate, at least in part, various standard features of conventional architectures, as desired. Thus, any discussion of such conventional architectures and/or standard features herein should not be interpreted as an intention to exclude such architectures and/or features from various embodiments disclosed herein, but rather as a disclosure thereof as exemplary optional embodiments with features, operations, functionality, parts, etc., which may or may not be incorporated in the various embodiments disclosed herein.

FIG. 17-2

FIG. 17-2 shows a memory system 17-200 with multiple stacked memory packages, in accordance with one embodiment. As an option, the system may be implemented in the context of the architecture and environment of the previous figure or any subsequent Figure(s). Of course, however, the system may be implemented in any desired environment.

For example, as an option, the memory system 17-200 with multiple stacked memory packages may be implemented in the context of the architecture and environment of FIG. 17-1 or any subsequent Figure(s). For example the system of FIG. 17-2 may be implemented in the context of FIG. 1B of U.S. Provisional Application No. 61/569,107, filed Dec. 9, 2011, titled “SYSTEM, METHOD, AND COMPUTER PROGRAM PRODUCT FOR IMPROVING MEMORY SYSTEMS,” which is hereby incorporated by reference in its entirety for all purposes. For example, the system of FIG. 17-2 and/or other similar system, architectures, designs, etc. may be implemented in the context of one or more applications incorporated by reference. For example, one or more chips included in the system of FIG. 17-2 (e.g. memory chips, logic chips, etc.) may be implemented in the context of one or more designs, architectures, datapaths, circuits, structures, systems, etc. described herein and/or in one or more applications incorporated by reference. For example, one or more buses, signaling schemes, bus protocols, interconnect, and/or other similar interconnection, coupling, etc. techniques, etc. included in the system of FIG. 17-2 (e.g. between memory chips, between logic chips, on-chip interconnect, system interconnect, between CPU and stacked memory packages, between any memory system components, etc.) may be implemented in the context of one or more designs, architectures, circuits, structures, systems, bus systems, interconnect systems, connection techniques, combinations of these and/or other coupling techniques, etc. described herein and/or in one or more applications incorporated by reference. Of course, however, the system may be implemented in any desired environment.

In FIG. 17-2, in one embodiment, the CPU 17-232 may be coupled to one or more stacked memory packages 17-230 using one or more memory buses 17-234.

In one embodiment, a single CPU may be coupled to a single stacked memory package. In one embodiment, one or more CPUs (e.g. multicore CPU, one or more CPU die, combinations of these and/or other forms of processing units, processing functions, etc.) may be coupled to a single stacked memory package. In one embodiment, one or more CPUs may be coupled to one or more stacked memory packages. In one embodiment, one or more stacked memory packages may be coupled together in a memory subsystem network. In one embodiment, any type of integrated circuit or similar (e.g. FPGA, ASSP, ASIC, CPU, combinations of these and/or other die, chip, integrated circuit and the like, etc.) may be coupled to one or more stacked memory packages. In one embodiment, any number, type, form, structure, etc. of integrated circuits etc. may be coupled to one or more stacked memory packages.

In one embodiment, the memory packages may include one or more stacked chips. In FIG. 17-2, for example, in one embodiment, a stacked memory package may include stacked chips: 17-202, 17-204, 17-206, 17-208. In FIG. 17-2, for example, stacked chips: 17-202, 17-204, 17-206, 17-208 may be chip 1, chip 2, chip 3, chip 4. In FIG. 17-2, for example, in one embodiment, one or more of chip 1, chip 2, chip 3, chip 4 may be a memory chip (e.g. stacked memory chip, etc.). In one embodiment, any number of stacked chips, stacked memory chips, etc. may be used. In FIG. 17-2, for example, in one embodiment, one or more of chip 1, chip 2, chip 3, chip 4 may be a logic chip (e.g. stacked logic chip, etc.).

In FIG. 17-2, in one embodiment, a stacked memory package may include a chip at the bottom of the stack: 17-210. In FIG. 17-2, for example stacked chip 17-210 may be chip 0. In FIG. 17-2, in one embodiment, chip 0 may be a logic chip. In one embodiment, nay number of logic chips, stacked logic chips, etc. may be used.

In FIG. 17-2, in one embodiment, for example, one or more logic chips or parts, portions, etc. of one or more logic chips may be implemented in the context of logic chips described herein and/or in one or more applications incorporated by reference. In FIG. 17-2, in one embodiment, one or more logic chips may act to buffer, relay, transmit, etc. one or more signals etc. from the CPU and/or other components in the memory system. In FIG. 17-2, in one embodiment, one or more logic chips may act to transform, receive, transmit, alter, modify, encapsulate, parse, interpret, packetize, etc. one or more signals, packets, and/or other data, information, etc. from the CPUs and/or other components in the memory system. In FIG. 17-2, in one embodiment, one or more logic chips may perform any functions, operations, transformations, etc. on one or more signals etc. from one or more other system components (e.g. CPUs, other stacked memory packages, I/O components, combinations of these and/or any other system components, etc.).

In one embodiment, for example, depending on the packaging details, the orientation of chips in the package, etc. the chip at the bottom of the stack in FIG. 17-2 may not be at the bottom of the stack when the package is mounted, assembled, connected, etc. Thus, it should be noted that terms such as bottom, top, etc. may be used with respect to (e.g. with reference to, etc.) diagrams, figures, etc. and not necessarily applied to a finished product, assembled systems, connected packages, etc. In one embodiment, the logical arrangement, connection, coupling, interconnection, etc. and/or logical placement, logical arrangement, etc. of one or more chips, die, circuits, packages, etc. may be different from the physical structures, physical assemblies, physical arrangements, etc. of the one or more chips etc.

In one embodiment, the chip at the bottom of the stack (e.g. chip 17-210 in FIG. 17-2) may be considered part of the stack. In this case, for example, the system of FIG. 17-2 may be considered to include five stacked chips. In one embodiment, the chip at the bottom of the stack (e.g. chip 17-210 in FIG. 17-2) may not be considered part of the stack. In this case, for example, the system of FIG. 17-2 may be considered to include four stacked chips. For example, in one embodiment, one or more chips etc. may be coupled using TSVs and/or TSV arrays and/or other stacking, coupling, interconnect techniques etc. For example, in one embodiment, the chip, die, circuit, etc. at the bottom of a stack may not contain TSVs, TSV arrays, etc. while the chips, dies, etc. in the rest of the stack may include such interconnect technology, etc. For example, in this case, one or more assembly steps, manufacturing steps, and/or other processing steps etc. that may be regarded as part of the stacking process, etc. may not be applied (or may not be applied in the same way, etc.) to the chip, die, etc. at the bottom of the stack as they are applied to the other chips, dies, etc. in the stack, etc. Thus, for this reason, in this case, the chip at the bottom of a stack, for example, may be regarded as different, unique, etc. in the use of interconnect technology and thus, in some case, may not be regarded as part of the stack.

In one embodiment, one or more of the stacked chips may be a stacked memory chip. In one embodiment, any number, type, technology, form, etc. of stacked memory chips may be used. The stacked memory chips may be of the same type, technology, etc. The stacked memory chips may be of different types, memory types, memory technologies, etc. One or more of the stacked memory chips may contain more than one type of memory, more than one memory technology, etc. In one embodiment, one or more of the stacked chips may be a logic chip. In one embodiment, one or more of the stacked chips may be a combination of a logic chip and a memory chip. In one embodiment, one or more of the stacked chips may be a combination of a logic chip and a CPU chip. In one embodiment, one or more of the stacked chips may be any combination of a logic chips, memory chips, CPUs and/or any other similar functions and the like etc.

In one embodiment, one or more CPUs, one or more dies (e.g. chips, etc.) containing one or more CPUs (e.g. multicore CPUs, etc.) may be integrated (e.g. packed with, stacked with, etc.) with one or more memory packages. In one embodiment, one or more of the stacked chips may be a CPU chip (e.g. include one or more CPUs, multicore CPUs, etc.). In one embodiment, the CPU chips, dies containing CPUs, logic chips containing CPUs, etc. may be connected, coupled, etc. to one or more memory chips using a wide I/O connection and/or similar bus techniques. For example, in one embodiment, data etc. may be transferred between one or more memory chips and one or more other dies, chips, etc. containing logic, CPUs, etc. using buses that may be 512 bits, 1024 bits, 2048 bits or any number of bits in width, etc.

In FIG. 17-2, in one embodiment, one or more stacked chips may contain parts, portions, etc. In FIG. 17-2, in one embodiment, stacked chips may contain parts: 17-242, 17-244, 17-246, 17-249, 17-250. For example, in one embodiment, chip 1 may be a memory chip and may contain one or more parts, portions, etc. of memory. For example, in one embodiment, chip 0 may be a logic chip and may contain one or more parts, portions, etc. of a logic chip. In one embodiment, for example, one or more parts of one or more memory chips may be grouped. In FIG. 17-2, in one embodiment, for example, parts of chip 1, chip 2, chip 3, chip 4 may be parts of memory chips that may be grouped together to form a set, collection, group, etc. For example, in one embodiment, the group etc. may be (or may be part of, may correspond to, may be designed as, may be architected as, may be logically accessed as, may be structured as, etc.) an echelon (as defined herein and/or in one or more application incorporated by reference). For example, in one embodiment the group etc. may be a section (as defined herein and/or in one or more application incorporated by reference). For example, in one embodiment the group etc. may be a rank, bank, echelon, section, combinations of these and/or any other logical and/or physical grouping, aggregation, collection, etc. of memory parts etc.

In one embodiment, for example, one or more parts of one or more memory chips may be grouped together with one or more parts of one or more logic chips. In one embodiment, for example, chip 0 may be a logic chip and chip 1, chip 2, chip 3, chip 4 may be memory chips. In this case, part of chip 0 may be logically grouped etc. with parts of chip 1, chip 2, chip 3, chip 4. In one embodiment, for example, any grouping, aggregation, collection, etc. of one or more parts of one or more logic chips may be made with any grouping, aggregation, collection, etc. of one or more parts of one or more memory chips. In one embodiment, for example, any grouping, aggregation, collection, etc. (e.g. logical grouping, physical grouping, combinations of these and/or any type, form, etc. of grouping etc.) of one or more parts (e.g. portions, groups of portions, etc.) of one or more chips (e.g. logic chips, memory chips, combinations of these and/or any other circuits, chips, die, integrated circuits and the like, etc.) may be made.

In FIG. 17-2, in one embodiment, information may be sent from the CPU to the memory subsystem using one or more requests 17-212. In one embodiment, information may be sent between any system components (e.g. directly, indirectly, etc.) using any techniques (e.g. packets, signals, messages, combinations of these and/or other signaling techniques, etc.).

In FIG. 17-2, in one embodiment, information may be sent from the memory subsystem to the CPU using one or more responses 17-214.

In FIG. 17-2, in one embodiment, for example, a memory read may be performed by sending (e.g. transmitting from CPU to stacked memory package, etc.) a read request. The read data may be returned in a read response. The read request may be forwarded (e.g. routed, buffered, etc.) between stacked memory packages. The read response may be forwarded between stacked memory packages.

In FIG. 17-2, in one embodiment, for example, a memory write may be performed by sending (e.g. transmitting from stacked memory package, etc.) a write request. The write response (e.g. completion, notification, etc.), if any, may originate from the target stacked memory package. The write response may be forwarded between stacked memory packages.

In FIG. 17-2, in one embodiment, a request and/or response may be asynchronous (e.g. split, separated, variable latency, etc.). For example, a request and/or response may be part of a split transaction and/or carried, transported, conveyed, communicated, etc. by a split transaction bus, etc.

In one embodiment, one or more commands may be sent to (e.g. received by, processed by, interpreted by, acted on, etc.) one or more logic chips. In one embodiment, one or more commands may be sent to (e.g. received by, processed by, interpreted by, acted on, etc.) one or more stacked memory chips. In one embodiment, one or more commands may be received by one or more logic chips and one or more modified (e.g. changed, processed, transformed, combinations of these and/or other modifications, etc.) commands, signals, requests, sub-commands, combinations of these and/or other commands, etc. may be forwarded to one or more stacked memory chips, one or more logic chips, one or more stacked memory packages, other system components, combinations of these and/or to any component in the memory system.

For example, in one embodiment, the system may use a set of commands (e.g. read commands, write commands, raw commands, status commands, register write commands, register read commands, combinations of these and/or any other commands, requests, etc.). For example, in one embodiment, one or more of the commands in the command set may be directed, for example, at one or more stacked memory chips in a stacked memory package (e.g. memory read commands, memory write commands, memory register write commands, memory register read commands, memory control commands, etc.). The commands may be directed (e.g. sent to, transmitted to, received by, etc.) one or more logic chips. For example, a logic chip in a stacked memory package may receive a command (e.g. a read commands, write command, or any command, etc.) and may modify (e.g. alter, change, etc.) that command before forwarding the command to one or more stacked memory chips. In one embodiment, any type of command modification may be used. For example, logic chips may reorder commands. For example, logic chips may combine commands. For example, logic chips may split commands (e.g. split large read commands, separate read/modify/write commands, split partial write commands, split masked write commands, etc.). For example, logic chips may duplicate commands (e.g. forward commands to multiple destinations, forward commands too multiple stacked memory chips, etc.). For example, logic chip may add fields, modify fields, delete fields, in one or more commands etc. In one embodiment, any logic, circuits, functions etc. located on, included in, include as part of, etc. one or more datapaths, logic chips, memory controllers, memory chips, etc. may perform one or more of the above described functions, operations, actions and the like etc.

In one embodiment, one or more requests and/or responses may include cache information, commands, status, requests, responses, etc. For example, one or more requests and/or responses may be coupled to one or more caches. For example, one or more requests and/or responses may be related, carry, convey, couple, communicate, etc. one or more elements, messages, status, probes, results, etc. related to one or more cache coherency protocols. For example, one or more requests and/or responses may be related, carry, convey, couple, communicate, etc. one or more items, fields, contents, etc. of one or more cache hits, cache read hits, cache write hits, cache read miss, cache read hit, cache lines, etc. In one embodiment, one or more requests and/or responses may contain data, information, fields, etc. that is aligned and/or unaligned. In one embodiment, one or more requests and/or responses may correspond to (e.g. generate, create, result in, initiate, etc.) one or more cache line fills, cache evictions, cache line replacement, cache line writeback, probe, internal probe, external probe, combinations of these and/or other cache and similar operations and the like, etc. In one embodiment, one or more requests and/or responses may be coupled (e.g. transmit from, receive from, transmit to, receive to, etc.) one or more write buffers, write combining buffers, other similar buffers, stores, FIFOs, combinations of these and/or other like functions, etc. In one embodiment, one or more requests and/or responses may correspond to (e.g. generate, create, result in, initiate, etc.) one or more cache states, cache protocol states, cache protocol events, cache protocol management functions, etc. For example, in one embodiment, one or more requests and/or responses may correspond to one or more cache coherency protocol (e.g. MOESI, etc.) messages, probes, status updates, control signals, combinations of these and/or other cache coherency protocol operations and the like, etc. For example, in one embodiment, one or more requests and/or responses may include one or more modified, owned, exclusive, shared, invalid, dirty, etc. cache lines and/or cache lines with other similar cache states etc.

In one embodiment, one or more requests and/or responses may include transaction processing information, commands, status, requests, responses, etc. In one embodiment, for example, one or more requests and/or responses may include one or more of the following (but not limited to the following): transactions, tasks, composable tasks, noncomposable tasks, etc. In one embodiment, for example, one or more requests and/or responses may perform, be used to perform, correspond to performing, form a part or parts or portion or portions of performing, etc. one or more atomic operations, set of atomic operations, and/or other linearizable, indivisible, uninterruptible, etc. operations, combinations of these and/or other similar transactions, etc. In one embodiment, for example, one or more requests and/or responses may perform, be used to perform, correspond to performing, form a part of portion of performing, etc. one or more transactions that are atomic, consistent, isolated, durable, and/or combinations of these, etc. In one embodiment, for example, one or more requests and/or responses may perform, be used to perform, correspond to performing, form a part of portion of performing, etc. one or more transactions that correspond to (e.g. are a result of, are part of, create, generate, result from, for part of, etc.) a task, a transaction, roll back of a transaction, commit of a transaction, a composable task, a noncomposable task, and/or combinations of these and/or other similar tasks, transactions, operations and the like, etc. In one embodiment, for example, one or more requests and/or responses may perform, be used to perform, correspond to performing, form a part of portion of performing, etc. one or more transactions that correspond to a composable system, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) memory ordering, implementing program order, implementing order of execution, implementing strong ordering, implementing weak ordering, implementing one or more ordering models, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more memory-consistency models including, but not limited to, one or more of the following: sequential memory-consistency models, relaxed consistency models, weak consistency models, TSO, PSO, program ordering, strong ordering, processor ordering, write ordering with store-buffer forwarding, combinations of these and/or other similar models and the like, etc.

In one embodiment, for example, one or more parts, portions, etc. of one or more memory chips, memory portions of logic chips, combinations of these and/or other memory portions may form one or more caches, cache structures, cache functions, etc.

In one embodiment, for example, one or more caches, buffers, stores, etc. may be used to cache (e.g. store, hold, etc.) data, information, etc. stored in one or more stacked memory chips. In one embodiment, for example, one or more caches may be implemented (e.g. architected, designed, etc.) using memory on one or more logic chips. In one embodiment, for example, one or more caches may be constructed (e.g. implemented, architected, designed, etc.) using memory on one or more stacked memory chips. In one embodiment, for example, one or more caches may be constructed (e.g. implemented, architected, designed, logically formed, etc.) using a combination of memory on one or more stacked memory chips and/or one or more logic chips. For example, in one embodiment, one or more caches may be constructed etc. using non-volatile memory (e.g. NAND flash, etc.) on one or more logic chips. For example, in one embodiment, one or more caches may be constructed etc. using logic NVM (e.g. MTP logic NVM, etc.) on one or more logic chips. For example, in one embodiment, one or more caches may be constructed etc. using volatile memory (e.g. SRAM, embedded DRAM, eDRAM, etc.) on one or more logic chips. For example, in one embodiment, one or more caches may be constructed etc.

In one embodiment, for example, one or more caches, buffers, stores, etc. may be logically connected in series (e.g. in the datapath, etc.) with one or more memory system, memory structure, memory circuits, etc. included on one or more stacked memory chips and/or one or more logic chips. For example, the CPU may send a request to a stacked memory package. For example, the request may be a read request. For example, a logic chip may check, inspect, parse, deconstruct, examine, etc. the read request and determine if the target (e.g. object, etc.) of the read request (e.g. memory location, memory address, memory address range, etc.) is held (e.g. stored, saved, present, etc.) in one or more caches, buffers, stores, etc. If the data etc. requested is present in one or more caches etc. then the read request may be completed (e.g. read data etc. provided, supplied, etc.) from a cache (or combination of caches, etc.). If the data, etc. requested is not present in one or more caches then the read request may be forwarded to the memory system, memory structures, etc. For example, the read request may be forwarded to one or more memory controllers, etc.

In one embodiment, for example, one or more memory structures, temporary storage, buffers, stores, combinations of these and the like etc. (e.g. in one or more logic chips, in one or more datapaths, in one or more memory controllers, in one or more stacked memory chips, in combinations of these and/or in any memory structures in the memory system, etc.) may be used to optimize, accelerate, etc. writes. For example, one or more write requests may be retired (e.g. completed, satisfied, signaled as completed, response generated, write commit made, etc.) by storing write data and/or other data, information, etc. in one or more write acceleration structures, optimization units, and/or other circuits that may optimize and/or otherwise change, modify, improve performance, etc. Similarly one or more like structures may be used, designed, configured, programmed, operated, etc. to optimize, accelerate, etc. reads.

For example, in one embodiment, one or more write acceleration structures etc. may include one or more write acceleration buffers (e.g. FIFOs, register files, other storage structures, data structures, etc.). For example, in one embodiment, a write acceleration buffer may be used on one or more logic chips, in the datapaths of one or more logic chips, in one or more memory controllers, in one or more memory chips, and/or in combinations of these etc. For example, in one embodiment, a write acceleration buffer may include one or more structures of non-volatile memory (e.g. NAND flash, logic NVM, etc.). For example, in one embodiment, a write acceleration buffer may include one or more structures of volatile memory (e.g. SRAM, eDRAM, etc.).

For example, in one embodiment, a write acceleration buffer may be battery backed to ensure the contents are not lost in the event of system failure or other similar system events, etc. In one embodiment, any form of cache protocol, cache management, etc. may be used for one or more write acceleration buffers (e.g. copy back, writethrough, etc.). In one embodiment, the form of cache protocol, cache management, etc. may be programmed, configured, and/or otherwise altered e.g. at design time, assembly, manufacture, test, boot time, start-up, during operation, at combinations of these times and/or at any times, etc.

In one embodiment, for example, one or more caches may be logically separate from the memory system (e.g. other parts of the memory system, etc.) in one or more stacked memory packages. For example, one or more caches may be accessed directly by one or more CPUs. For example, one or more caches may form an L1, L2, L3 cache etc. of one or more CPUs. In one embodiment, for example, one or more CPU die may be stacked together with one or more stacked memory chips in a stacked memory package. Thus, in this case, for example, one or more stacked memory chips may form one or more cache structures for one or more CPUs in a stacked memory package.

For example, in FIG. 17-2, the CPU 17-232 may be integrated with one or more stacked memory packages and/or otherwise included, attached, directly coupled, assembled, packaged in, combinations of these and/or using other integration techniques and the like etc.

For example, one or more CPUs may be included at the top, bottom, middle, multiple locations, etc. and/or anywhere in one or more stacks of one or more stacked memory devices. For example, one or more CPUs may be included on one or more chips (e.g. logic chips, buffer chips, memory chips, memory devices, etc.).

For example, in FIG. 17-2, chip 0 may be a CPU chip (e.g. CPU, multicore CPU, multiple CPU types on one chip, combinations of these and/or any other arrangements of CPUs, equivalent circuits, etc.).

For example, in FIG. 17-2, one or more of chip 1, chip 2, chip 3, chip 4; parts of these chips; combinations of parts of these chips; and/or combinations of any parts of these chips with other memory (e.g. on one or more logic chips, on the CPU die, etc.) may function, behave, operate, etc. as one or more caches. In one embodiment, for example, the caches may be coupled to the CPUs separately from the rest of the memory system, etc. For example, one or more CPU caches may be coupled to the CPUs using wide I/O or other similar coupling technique that may employ TSVs, TSV arrays, etc. For example, one or more connections may be high-speed serial links or other high-speed interconnect technology and the like, etc. For example, the interconnect between one or more CPUs and one or more caches may be designed, architected, constructed, assembled, etc. to include one or more high-bandwidth, low latency links, connections, etc. For example, in FIG. 17-2, in one embodiment, the memory bus may include more than one link, connection, interconnect structure, etc. For example, a first memory bus, first set of memory buses, first set of memory signals, etc. may be used to carry, convey, transmit, couple, etc. memory traffic, packets, signals, etc. to one or more caches located, situated, etc. on one or more memory chips, logic chips, combinations of these, etc. For example, a second memory bus, second set of memory buses, second set of memory signals, etc. may be used to carry, convey, transmit, couple, etc. memory traffic, packets, signals, etc. to one or more memory systems (e.g. one or more memory systems, memory structures, memory circuits, etc. separate from the memory caches, etc.) located, situated, etc. on one or more memory chips, logic chips, combinations of these, etc. In one embodiment, for example, one or more caches may be logically connected, coupled, etc. to one or more CPUs etc. in any fashion, manner, arrangement, etc. (e.g. using any logical structure, logical architecture, etc.).

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more memory types. In one embodiment, for example, one or more requests, responses, messages, etc. may perform, be used to perform, correspond to performing, form a part, portion, etc. of performing, executing, initiating, completing, etc. one or more operations, transactions, messages, control, status, etc. that correspond to (e.g. form part of, implement, construct, build, execute, perform, create, etc.) one or more of the following (but not limited to the following) memory types; Uncacheable (UC), Cache Disable (CD), Write-Combining (WC), Write-Combining Plus (WC+), Write-Protect (WP), Writethrough (WT), Writeback (WB), combinations of these and/or other similar memory types and the like, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more of the following (but not limited to the following): serializing instructions, read memory barriers, write memory barriers, memory barriers, barriers, fences, memory fences, instruction fences, command fences, optimization barriers, combinations of these and/or other similar, barrier, fence, ordering, reordering instructions, commands, operations, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more semantic operations (e.g. corresponding to volatile keywords, and/or other similar constructs, keywords, syntax, etc.). In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more operations with release semantics, acquire semantics, combinations of these and/or other similar semantics and the like, etc.

In one embodiment, for example, one or more requests and/or responses may perform, be used to perform, correspond to performing, form a part of portion of performing, etc. one or more operations, transactions, messages, status, etc. that correspond to (e.g. form part of, implement, etc.) one or more of the following (but not limited to the following): memory barriers, per-CPU variables, atomic operations, spin locks, semaphores, mutexes, seqlocks, local interrupt disable, local softirq disable, read-copy-update (RCU), combinations of these and/or other similar operations and the like, etc. In one embodiment, for example, one or more requests and/or responses may perform, be used to perform, correspond to performing, form a part of portion of performing, etc. one or more operations, transactions, messages, status, etc. that may correspond to (e.g. form part of, implement, etc.) one or more of the following (but not limited to the following): smp_mb( ), smp_rmb( ), smp_wmb( ), mmiowb( ), other similar Linux macros, other similar Linux functions, etc., combinations of these and/or other similar OS operations and the like, etc.

In one embodiment, one or more requests and/or responses may include any information, data, fields, messages, status, combinations of these and other data etc. (e.g. in a stacked memory package system, memory system, and/or other system, etc.).

FIG. 17-3 Stacked Memory Package Read/Write Datapath

FIG. 17-3 shows a part of the read/write datapath for a stacked memory package 17-300, in accordance with one embodiment. As an option, the read/write datapath may be implemented in the context of the previous Figure(s) and/or any subsequent Figure(s).

As an option, for example, the read/write datapath of FIG. 17-3 may be implemented in the context of FIG. 19-13 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” which is hereby incorporated by reference in its entirety for all purposes. As an option, for example, the read/write datapath may be implemented in the context of FIG. 23-7 and/or FIG. 23-9 of U.S. Provisional Application No. 61/759,764, filed Feb. 1, 2013, titled “SYSTEM, METHOD, AND COMPUTER PROGRAM PRODUCT FOR MODIFYING COMMANDS DIRECTED TO MEMORY” which is hereby incorporated by reference in its entirety for all purposes. As an option, for example, the read/write datapath of FIG. 17-3 may be implemented in the context of one or more other Figures that may include one or more components, circuits, functions, behaviors, architectures, etc. associated with, corresponding to, etc. datapaths that may be included in one or more other applications incorporated by reference. Of course, however, the read/write datapath of FIG. 17-3 may be implemented in any desired environment.

In FIG. 17-3, in one embodiment, part of the read/write datapath for a stacked memory package may be located, for example, between (e.g. logically between, included within, part of, etc.) the PHY and DRAM (or other memory type(s), technology, etc.).

Note that FIG. 17-3 may show one or more circuits etc. that may be used to process commands, requests, etc. in the receive datapath and/or transmit datapath of a stacked memory package. The techniques, circuits, functions, behavior, etc. of the circuits etc., shown in FIG. 17-3 may be applied, used, etc. in multiple locations in the datapaths. For example, one or more of the circuits, functions, structures, etc. shown in FIG. 17-3 may be part of one or more memory controllers. For example, one or more of the circuits, functions, structures, etc. shown in FIG. 17-3 may be part of one or more stacked memory chips. Thus, for example, one or more of the circuits, functions, structures, etc. shown in FIG. 17-3 or parts, portions, etc. of these circuits, functions, structures, etc. may be included, distributed, apportioned, etc. between one or more logic chips in a stacked memory package, one or more stacked memory chips, and/or included in any location in a stacked memory package, etc.

In FIG. 17-3, in one embodiment, the read/write datapath for a stacked memory package may include a read (Rx) datapath located between the PHY (e.g. receiving signals from the PHY, etc.) and DRAM (e.g. passing signals to the DRAM, etc.). In FIG. 17-3, in one embodiment, the read/write datapath for a stacked memory package may include a transmit (Tx) datapath located between the DRAM (e.g. receiving signals from the DRAM, etc.) and PHY (e.g. passing signals to the PHY, etc.).

In FIG. 17-3, datapath, bus, signals etc. 17-310 may transfer, couple, communicate, etc. one or more commands (e.g. requests, possibly in packet form etc.) from the PHY, PHY layers, PHY circuits, lower level logical layers, etc.

In FIG. 17-3, datapath, bus, signals etc. 17-320 may transfer etc. commands etc. to one or more memory chips, stacked memory chips, DRAM, and/or any memory technology, circuits associated with memory and the like, etc. Data at this point in the datapath may typically be coupled in bus form with other signals, control signals, etc. but may also be in packet from.

In FIG. 17-3, datapath, bus, signals etc. 17-336 may transfer etc. read data (e.g. response data, data read from one or more memory chips, data read from one or more DRAM, etc.) and/or any other information, data, etc. from one or more memory chips, stacked memory chips, DRAM, and/or any memory technology, circuits associated with memory and the like, etc. Data at this point in the datapath may typically be coupled in bus form with other signals, control signals, etc. but may also be in packet from.

In FIG. 17-3, datapath, bus, signals etc. 17-334 may transfer etc. one or more responses (e.g. read responses, possibly in packet form etc.), messages, status, etc. to the PHY, PHY layers, PHY circuits, and/or other lower (e.g. lower in ISO layers, towards PHY logical layer in hierarchy, etc.).

For example, in one embodiment, one or more parts of the read/write datapath for a stacked memory package as shown in FIG. 17-3 may include the functions of a receiver arbiter or RxARB block (or other equivalent circuits, functions, etc. as described elsewhere herein and/or in one or more applications incorporated by reference) that may, for example, perform arbitration (e.g. prioritization, separation, division, allocation, etc.) of received (e.g. received by a stacked memory package, etc.) commands (e.g. write commands, read commands, other commands and/or requests, etc.) and data (e.g. write data, etc.).

For example, in one embodiment, one or more parts of the read/write datapath for a stacked memory package as shown in FIG. 17-3 may include the functions of a transmitter arbiter or TxARB block (e.g. as described elsewhere herein and/or in one or more applications incorporated by reference) that may, for example, perform arbitration (e.g. prioritization, separation, division, allocation, combining, tagging, etc.) of responses, completions, messages, commands (e.g. read responses, write completions, other commands and/or completions and/or responses, etc.) and data (e.g. read data, etc.).

In FIG. 17-3, in one embodiment, the read/write datapath for a stacked memory package may include (e.g. contain, use, employ, etc.) the following blocks and/or functions (but is not limited to the following): (1) DMUXA 17-360: the demultiplexer may take requests e.g. read (RD) request, posted write (PW) request, non-posted write (NPW) request, other request and/or commands, etc. from, for example a receiver crossbar block (e.g. switch, MUX array, etc.) and split them into one or more priority queues etc.; (2) DMUXB 17-312: the demultiplexer may take requests from DMUXA and split them by request type; (3) VC1CMDQ 17-318: that may be assigned to the isochronous command queue and may store those commands (e.g. requests, etc.) that correspond to isochronous operations (e.g. real-time, video, etc.); (4) VC2CMDQ 17-324: may be assigned to the non-isochronous command queue and may store those commands that are not isochronous; (5) DRAMCTL 17-316: the DRAM controller may generate commands for the DRAM e.g. precharge (PRE), activate (ACT), refresh, power down, and/or other controls, etc.; (6) MUXA 17-362: the multiplexer may combine (e.g. arbitrate between, select according to fairness algorithm, etc.) command and data queues (e.g. isochronous and non-isochronous commands, write data, etc.); (7) MUXB 17-364: the multiplexer may combine commands with different priorities e.g. in different virtual channels, etc.; (8) CMDQARB 17-322: the command queue arbiter may be responsible for selecting (e.g. in round-robin fashion, using other fairness algorithm(s), etc.) the order of commands to be sent (e.g. transmitted, presented, etc.) to the DRAM; (9) RSP 17-338: the response FIFO may store read data etc. from the DRAM etc.; (10) NPT 17-330: the non-posted tracker may track (e.g. store, queue, order, etc.) tags, markers, fields, etc. from non-posted requests (e.g. non-posted writes, etc.) and may insert the tag etc. into one or more responses (e.g. with data from one or more reads, etc.); (11) MUXC 17-366: the multiplexer may combine (e.g. merge, aggregate, join, etc.) responses from the NPT with responses (e.g. read data, etc.) from the read bypass FIFO; (12) Read Bypass 17-328: the read bypass FIFO may store, queue, order, etc. one or more responses (e.g. read data, etc.) that may be sourced from one or more write buffers (thus for example a read to a location that is about to be written with data stored in a write buffer may bypass the DRAM); (13) OU 17-340, 17-342, 17-370, 17-372, 17-374, 17-376: one or more optimization units (OUs) may be present to optimize, accelerate, etc. reads, writes, other commands etc. and/or buffer, store and/or cache commands, data, etc.; (14) Data FIFO 17-326; (15) Precharge Command FIFO 17-380; (16) Activate Command FIFO 17-382.

For example, In FIG. 17-3, in one embodiment, commands, requests, etc. may be separated between isochronous (ISO) and non-isochronous (NISO). The associated (e.g. corresponding, etc.) datapaths, functions, etc. may be referred to, for example, as the isochronous channel and non-isochronous channel. The ISO channel may be used, for example, for memory commands associated with processes (e.g. threads, applications, programs, etc.) that may require real-time responses or higher priority (e.g. playing video, etc.). The command set may include a flag (e.g. bit field, etc.) in the read request, write request, etc. to indicate priority etc. For example, in one embodiment, there may be a bit in the control field in the basic command set that when set (e.g. set equal to 1, etc.) corresponds to ISO commands. For example, in one embodiment, the basic command set may include separate command codes etc. for ISO, NISO commands, etc. In one embodiment, other types of channels, circuits, etc. (e.g. other than isochronous, non-isochronous, etc.) may be used. In one embodiment, any number, type, structure, architecture, etc. of channels may be used. For example, in one embodiment, one channel may be dedicated to low-power use, etc. In one embodiment, the allocation, assignment etc. of channels may be programmable, configured, altered, etc. In one embodiment, programming etc. of the allocation etc. of one or more channels, channel functions, combinations of these and/or other channel features, behavior, functions and the like etc. may be performed at any time.

For example, in one embodiment, one or more channels may be dedicated for use by one or more functions, programs, applications, engines, subcircuits, IP blocks, etc. For example in a cell phone, there may be one or more channels, functions, circuits, paths, combinations of these and/or other resources etc. assigned solely for one or more cell phone functions or blocks, circuits, functions, etc. associated with, corresponding to, coupled to, connected with, etc. cell phone functionality. For example, such an assignment, partitioning, allocation, etc. may ensure that a cell phone operates in real-time, provides low latency response, is not stalled by other running applications, etc.

In one embodiment, the number, types, architecture, parameters, functions, etc. of channels may be programmable, configured, altered, etc. In one embodiment, programming etc. of one or more channels, channel parameters, channel functions, channel behavior, combinations of these and/or other datapath features, aspects, parameters, behavior, functions and the like etc. may be performed at any time.

In one embodiment, one or more methods, techniques, circuits, functions, etc. may be used to process, manage, store, prioritize, arbitrate, MUX, de-MUX, divide, separate, queue, order, re-order, shuffle, bypass, combine, or perform combinations of these and/or other functions, behaviors, operations and their equivalents etc.

In one embodiment, one or more commands may be divided into one or more virtual channels (VCs). In one embodiment, one or more types, classes, etc. of commands (e.g. requests, etc.) may be divided into one or more VCs.

In one embodiment, any number, type, form, architecture, makeup, connection, coupling, etc. of VCs and/or equivalent, similar, like functions, etc. may be used. In one embodiment, all VCs may use the same datapath. In one embodiment, all VCs may use one or more datapaths. In one embodiment, any number, type, form, architecture, makeup, connection, coupling, etc. of buses, circuits, signals, logic, combinations of these and other similar functions etc. may be used to implement one or more VCs, paths, circuits, traffic classes, priority queues, priority classes, combinations of these and/or other similar paths, classes and the like etc.

In one embodiment, one or more bypass paths may be used for the highest priority traffic (e.g. in order to avoid slower arbitration stages, etc.).

In one embodiment, for example, ISO traffic may be assigned to one or more VCs. In one embodiment, for example, NISO traffic may be assigned to one or more VCs. In one embodiment, for example, traffic, commands, packets, combinations of these and the like etc. may be assigned to VCs on any basis, selection criteria, etc.

For example, In FIG. 17-3, in one embodiment, commands, requests, etc. may be separated into three virtual channels: VC0, VC1, VC2. In FIG. 17-3, VC0 may, for example, correspond to (e.g. be assigned to, may carry traffic with, etc.) the highest priority. The function of blocks between (e.g. logically between, etc.) DMUXB and MUXA may perform arbitration of the ISO and NISO channels. Commands in VC0 bypass (e.g. using ARB_BYPASS path, etc.) the arbitration functions of DMUXB through MUXA. In FIG. 17-3, the ISO commands may be assigned to VC1. In FIG. 17-3, for example, the NISO commands may be assigned to VC2. In one embodiment, any assignment of commands, requests, etc. to any number, type, architecture, etc. of channels may be used. In one embodiment, multiple types of commands may be assigned, for example, to a single channel. For example, in one embodiment, multiple channels may be used for one type of command, etc.

For example, in FIG. 17-3, in one embodiment, commands, requests, etc. may be separated into one or more VCs: VC0, VC1, VC2. For example, in FIG. 17-3, in one embodiment, one or more VCs may use one or more VC command queues or VCCMDQs (e.g. VC0CMDQ, VC1CMDQ, VC2CMDQ etc.). For example, in FIG. 17-3, VC1 may use VC1CMDQ and VC2 may use VC2CMDQ. For example, in one embodiment, any number of command queues may be used by any number of VCs (including none of them or all of them).

In FIG. 17-3, VC0 may, for example, correspond to the highest priority (e.g. highest priority channel, etc.). In one embodiment, for example, the function of blocks between (e.g. logically between, etc.) DMUXB and MUXA may perform arbitration of the ISO and NISO channels. In one embodiment, for example, commands in VC0 may, for example, bypass (e.g. using ARB_BYPASS path, etc.) the arbitration functions of DMUXB through MUXA. In FIG. 17-3, for example, the ISO commands may be assigned to VC1. In FIG. 17-3, for example, the NISO commands may be assigned to VC2, etc. In one embodiment, any assignment of commands, requests, etc. to any number of channels may be used. In one embodiment, multiple types of commands may be assigned, for example, to a single channel. In one embodiment, for example, multiple channels may be used for one type of command, etc.

In one embodiment, one or more VCs and/or other equivalent channels, paths, circuits, etc. (e.g. channels etc.) may be optimized. Thus, for example, in one embodiment, not all channels, circuits, paths, etc. in the Rx (or TX) datapath need be the same. For example, one or more channels etc. may be optimized for latency, power, bandwidth and/or one or more other parameters, metrics, aspects, features, combinations of these and the like etc. For example, in one embodiment, the optimization for latency may include a design, architecture, function etc. of one or more channels that is self-contained, streamlined, otherwise optimized, etc. In FIG. 17-3, in one embodiment for example, VC0 may carry, transmit, transfer, convey, couple, etc. both data and requests, commands, etc. In this case, for example, the data path 17-314 (labeled ARB_BYPASS in FIG. 17-3) may carry both data and commands, etc. In this case, for example, the data path 17-384 may carry data for the other VCs (e.g. apart from VC0, etc.).

In FIG. 17-3, one possible arrangement of commands (e.g. posted requests, non-posted requests, etc.) and priorities (e.g. VC0, VC1, VC2, etc.) may be shown. In FIG. 17-3, one possible arrangement of command queues may be shown. In FIG. 17-3, one possible arrangement of virtual channels may be shown. In one embodiment, for example, other variations, options, architectures, etc. (e.g. numbers and/or types of commands, requests etc., number and/or types of VCs, priorities, command queues, etc.) are possible and may be used.

In FIG. 17-3, for example, any number of VCs may be used. In FIG. 17-3, for example, any assignment of commands (e.g. posted requests, non-posted requests, other commands, etc.). In FIG. 17-3, for example, any assignment of priorities may be made to any VC (e.g. VC0, VC1, VC2, etc.). In FIG. 17-3, for example, any assignment and/or types of VCs, traffic classes, combinations of these and/or other channels, paths, and the like etc. may be used. In one embodiment, any variation of assignment (e.g. numbers and/or types of commands, requests etc., number and/or types of virtual channels, priorities, etc.) is possible and may be used. For example, in one embodiment, one VCCMDQ may be used for multiple virtual channels (e.g. shared, multiplexed, etc.). For example, in one embodiment, one VCCMDQ may be used for one virtual channel. For example, in one embodiment, a first VCCMDQ may be used for a first VC and a second VCCMDQ may be used for a second set of more than one VCs, etc. For example, in one embodiment, assignment of resources (e.g. VCs, VCCMDQs, other queues, FIFOs, circuits, functions, etc.) may be configurable, programmable, modified, altered, etc. For example, in one embodiment, the configurable assignment of resources may be performed at design time, manufacture, assembly, test, boot, start-up, run time, during operation, at combinations of these times and/or at any times, etc.

In one embodiment, for example, the Rx datapath may allow reads from in-flight write operations. Thus, for example, in FIG. 17-3 an in-flight write (e.g. a write with data, etc.) may be stored, queued, etc. in one or more buffers, FIFOs, queues, combinations of these and/or other storage etc. in the Rx datapath, etc. In this case a read to the same address, or a read to a location (e.g. address, etc.) within the write data address range may be optimized (e.g. accelerated, etc.) by allowing the read to use the stored write data. In one embodiment, the read data may then use, for example, the read bypass FIFO in the TX datapath. In one embodiment, the read data may be merged with tag, etc. from the non-posted tracker NPT and a complete response (e.g. read response, etc.) formed, assembled, packaged, etc. for transmission.

In one embodiment, for example, one or more VCs may correspond to one or more memory types. In one embodiment, one or more VCs may correspond to one or more memory models. In one embodiment, one or more VCs may correspond to one or more types of cache, or to caches with different functions, behavior, parameters, etc. In one embodiment, one or more VCs may correspond to one or more memory classes (as defined herein and/or in one or more applications incorporated by reference).

In one embodiment, any type of channel, virtual channel, virtual path, separation of datapath functions and/or operations, combinations of these and the like etc. may be used to implement on or more VCs or the equivalent functions and/or behavior of one or more VCs.

For example, in one embodiment, the Rx datapath and/or other datapaths, circuits, functions, etc. may implement the functionality, behavior, properties, etc. of one or more datapaths (e.g. channels, logic paths, etc.) having one or more VCs (or other equivalent channels etc.) without necessarily using separate physical queues, buffers, FIFOs, etc. For example, the function of a VCCMDQ, shown in FIG. 17-3 (e.g. VC1CMDQ, VC2CMDQ, etc.) as using a single FIFO (e.g. per command type, etc.), may be implemented using one or more data structures, circuits, functions, etc. with, for example, pointers and/or tags and/or data fields to mark, demarcate, link, identify, etc. posted write commands, non-posted write commands, read commands, combinations of these and/or other commands etc. Similarly, in one embodiment, one or more VCCMDQs may be implemented using a single data structure. A data structure may include, but is not limited to, one or more of the following: table (possibly with data, indexes, tags, flags, pointers, links, combinations of these and other information etc.), temporary storage, FIFO, register, logic, state machine, arbiters, encoders, decoders, combinations of these and/or other logic circuits, functions, storage, and the like etc. For example, in one embodiment, data (e.g. write data, etc.) may be stored in separate FIFOs (e.g. as shown in FIG. 17-3 separate from commands) or in a data structure (e.g. memory, storage, table, etc.) together with commands. For example, in one embodiment, different command types (e.g. posted write requests, non-posted write requests, read requests, other commands, requests, etc.) may be stored in separate FIFOs (e.g. as shown in FIG. 17-3, in one command queue such as VC1CMDQ for example) or in a common structure for all types of commands. For example, in one embodiment, different command types (e.g. posted write requests, non-posted write requests, read requests, etc.) may be stored in separate FIFOs but with all commands of a given type stored together, e.g. posted writes with different priorities may be stored together, etc. In one embodiment, for example, any arrangement of circuits, data structures, queues, FIFOs, combinations of these and/or other or equivalent functions, circuits, and the like etc. may be used.

For example, in one embodiment, the Tx datapath etc. may implement the functionality, behavior, properties, etc. of one or more VCs similar in function etc. to the Rx datapath (e.g. similar in architecture etc. to the VCs shown in the Rx datapath of FIG. 17-3).

In FIG. 17-3, for example, the structure (e.g. implementation, architecture, etc.) of the datapath using de-MUXes, FIFOs, queues, MUXes, etc. is intended to show the nature, type, possible functions, etc. of a representative datapath implementation. However, any equivalent, similar, etc. techniques, circuits, architectures, functions, etc. for storing, queuing, shuffling, ordering, re-ordering, prioritizing, issuing, etc. commands and/or data etc. may be used. Note that in FIG. 17-3 not all connections (e.g. logical connections, physical connections, etc.) may be shown in order, for example, to simplify and/or clarify the explanation of the datapath functions etc. For example, the connection, coupling, logical functions, logical circuits, etc. between the Rx datapath command queues and the non-posted tracker NPT may not be shown, etc.

In FIG. 17-3, in one embodiment, one or more OUs may be used. In FIG. 17-3, in one embodiment, one or more OUs may be used in the receive path. In FIG. 17-3, in one embodiment, one or more OUs may be used in the transmit path. In one embodiment, any number, type, architecture, hierarchical structure, etc. of OUs and/or other similar functions, circuit structures, and the like etc. may be used.

In FIG. 17-3, in one embodiment, for example an OU may be used for each command type. Thus, for example, in one embodiment, a separate OU may be used for posted write requests (OU 17-340), non-posted write requests (OU 17-370), read requests (OU 17-372), etc. as shown in FIG. 17-3 for VC1. Thus, for example, one or more OUs may be used for commands, requests, etc. in VC2 as shown by a single receive path OU block 17-374 in FIG. 17-3. In one embodiment, the OU block 17-374 may include one or more OUs similar to that used for VC1 in FIG. 17-3 for example. Note that, in FIG. 17-3, three separate OUs are shown for VC1 (e.g. VC1 Posted Write Request OU 17-340, VC1 Non-Posted Write Request OU 17-370, VC1 Read Request OU 17-372, etc.), but one OU block 17-374 is shown for VC2. In one embodiment, the OU block 17-374 may be an identical, or nearly identical, copy of the three OUs used for VC1. In one embodiment, the OU block 17-374 may be separately optimized and thus may be different from the OUs used for VC1.

In one embodiment, the OUs may be different for different priority channels (e.g. channels, paths, circuits, etc. with different priorities, for different traffic classes, etc.). For example, in one embodiment, one or more OUs for a higher priority channel may be optimized to reduce latency and/or one or more other parameters, metrics, features, properties, aspects, and the like, etc. In one embodiment, any number, type, architecture, combinations, etc. of OUs may be used in any combination, manner, etc. for any commands, command types, data, etc. used in any number, type, etc. of channels, paths, virtual channels, combinations of these and/or other similar datapaths, architectures, circuit structures and the like etc.

In FIG. 17-3, in one embodiment, for example an OU may be used for data associated with, contained in, included with, etc. one or more commands, requests, etc. For example, in FIG. 17-3, the Write Data OU block 17-342 may include one or more OUs, one or more subcircuits, etc. that may operate etc. on write data. For example, in FIG. 17-3, the Read Data OU block 17-376 may include one or more OUs, one or more subcircuits, etc. that may operate etc. on read data.

For example, in FIG. 17-3, in one embodiment, the Write Data OU block 17-342 may include one or more OUs, with separate OUs for each VC etc. For example, in FIG. 17-3, in one embodiment, the Write Data OU block 17-342 may include data for all VCs etc. In one embodiment, any circuits, functions, combinations of these and the like etc. may be used for, part of, etc. any number, type, architecture, form, etc. of data OUs. In one embodiment, any number, type, architecture of OUs may be used for data in combination etc. with any number, type, architecture of OUs used for commands, requests, etc.

In one embodiment, one or more OUs may act, operate, function, etc. in a cooperative, collaborative, joined, coupled, etc. manner. For example, a separate OU used for commands may be a command OU and a separate OU used for data may be a data OU. In one embodiment, the command OU and data OU may be connected, coupled, associated, etc. so that, for example, the data OU holds the data associated with, corresponding to, etc. one or more commands in the command OU. For example, in FIG. 17-3 all the write data may be held, stored, processed, etc. in the Write Data OU 17-342, while commands, requests, etc. in VC1 associated with the data are held etc. in one or more commands OUs (e.g. a VC1 Posted Write Request OU 17-340, VC1 Non-Posted Write Request OU 17-370, VC1 Read Request OU 17-372, etc.). In one embodiment, for example, there may be different write data OUs for each VC.

In one embodiment, for example, one or more command OUs may be coupled etc. to one or more data OUs to form one or more higher-level functions for optimization, acceleration, etc. For example, in FIG. 17-3, the VC1 Posted Write Request OU 17-340, VC1 Non-Posted Write Request OU 17-370, VC1 Read Request OU 17-372 may be coupled to the Write Data OU 17-342 and/or Read Data OU 17-376 to effectively, virtually, collaboratively, etc. form, act as, operate as, etc. a higher-level (e.g. at a higher level of hierarchy, etc.) write acceleration unit, acceleration buffer, optimization unit and/or other similar function, etc. that may operate to accelerate and/or otherwise optimize etc. one or more commands, requests, etc.

For example, in one embodiment, a command OU may act, operate, function, etc. to perform one or more operations, alterations, modifications, combinations of these and/or other functions on one or more commands, requests, etc. In one embodiment, the operations etc. performed by one or more commands OUs may be coupled, connected, joined, etc. to one or more operations etc. performed by one or more data OUs to accelerate and/or otherwise optimize etc. one or more commands, requests, etc.

For example, in one embodiment, a command OU may operate etc. to combine, aggregate, join, coalesce, etc. one or more commands, requests, etc. For example, a write request OU may operate etc. to combine one or more write requests. For example, in one embodiment, it may be beneficial to combine write requests to a certain granularity, size, length, etc. For example, in one embodiment, it may be beneficial to combine, aggregate, etc. write requests to the granularity etc. of a cache line (e.g. 64 bytes, etc.). For example, in one embodiment, it may be beneficial to combine, aggregate, etc. write requests to the granularity etc. of an internal data bus width (e.g. write datapath width in a DRAM, etc.). In one embodiment, the combining of writes may be permitted by the type of memory being used (e.g. WC memory, etc.). In one embodiment, the control of write combining and/or one or more features, functions, behaviors, etc. associated with, corresponding to, etc. write combining may be controlled by the memory type, memory class (as defined herein and/or in one or more applications incorporated by reference), and/or by any other parameters, settings, configurations, techniques, combinations of these and the like etc.

For example, a read request OU may operate etc. to combine one or more read requests. For example, in one embodiment, it may be beneficial to combine read requests to a certain granularity, size, length, etc. For example, in one embodiment, it may be beneficial to combine, aggregate, etc. read requests to the granularity etc. of a cache line (e.g. 64 bytes, etc.). For example, in one embodiment, it may be beneficial to combine, aggregate, etc. read requests to the granularity etc. of an internal data bus width (e.g. read datapath width in a DRAM, etc.) and/or to optimize some other parameter, requirement, etc. For example, it may be beneficial to combine one or more read responses to achieve, create, generate, etc. an optimum packet size (e.g. data payload size, payload length, etc.) for transmission (e.g. to maximize bandwidth, channel utilization, link efficiency, etc.) and/or any other reason etc.

For example, in one embodiment, a data OU may act, operate, function, etc. to perform one or more operations and/or other functions on data, etc. For example, the data OU may act to cache, store, hold, etc. data etc.

For example, in FIG. 17-3, a Write Data OU 17-342 may be as shown in the exploded view. For example, in FIG. 17-3, the Write Data OU may include one or more circuits, functions, sub-circuits, other OUs, etc. For example, the Write Data OU may include a write data buffer 17-350. For example, the Data OU may include a write data cache 17-352. For example, the Data OU may include a write data aggregator 17-346.

For example, in FIG. 17-3, in one embodiment, the Write Data OU may receive write data WData1. Write Data OU block 17-348 may be coupled (not shown in FIG. 17-3 in order to clarify the drawing) to one or more command OUs (e.g. VC1 Posted Write Request OU 17-340, VC1 Non-Posted Write Request OU 17-370, and/or other command OUs in other VCs, etc.). Write Data OU block 17-348 and/or the command OUs may determine that one or more write requests may be transferred to the write data aggregator 17-346 where data from one or more writes may be combined.

For example, in FIG. 17-3, in one embodiment, the Write Data OU may receive write data WData1. Write Data OU block 17-348 may be coupled (not shown in FIG. 17-3 in order to clarify the drawing) to one or more command OUs. Write Data OU block 17-348 and/or one or more command OUs may determine that one or more requests, commands, etc. may be transferred to the write data buffer 17-350 where data from one or more writes may be buffered, for example, to rate match the input request rate with the capacity, bandwidth, availability, etc. of the DRAM write path(s). In one embodiment one or more functions of the data FIFO(s) (e.g. data FIFO 17-326 in FIG. 17-3) may be subsumed into, included in, part of, merged with, etc. the write data buffer (e.g. write data buffer 17-350 in FIG. 17-3) or one or more write data buffer functions, etc.

For example, in FIG. 17-3, in one embodiment, the Write Data OU may receive write data WData1. Write Data OU block 17-348 may be coupled to one or more command OUs (not shown in FIG. 17-3 in order to clarify the drawing). Write Data OU block 17-348 and/or one or more command OUs may determine that one or more requests, commands, etc. may be transferred to the write data cache 17-352 where data from one or more writes may be cached, for example, to allow future reads to bypass a DRAM write before returning data in a response. For example, data may be provided to the transmit datapath via the read bypass FIFO, etc. as described elsewhere herein and/or in one or more applications incorporated by reference. In one embodiment one or more functions of the data FIFO(s) (e.g. data FIFO 17-326 in FIG. 17-3) may be subsumed into, included in, part of, etc. the write data cache (e.g. write data cache 17-352 in FIG. 17-3) or one or more write data cache functions, etc.

In FIG. 17-3, in one embodiment, in one embodiment, the Write Data OU may include one or more connections between write data buffer 17-350, write data cache 17-352, write data aggregator 17-346. For example, in FIG. 17-3, circuit block 17-348 may select, de-mux, and/or otherwise choose those commands and/or data from those commands that may be suited, eligible, etc. for processing, operations, etc. that may be performed by write data aggregator 17-346. For example, in one embodiment, these selected etc. commands and/or command data may bypass the write data cache 17-352. For example in one embodiment one or more combined writes, or combined write data, may be uncacheable, etc. For example, in one embodiment, these selected etc. commands and/or command data may be re-injected, added, inserted, etc. into the write data cache 17-352 using connection 17-388. For example, in FIG. 17-3, the circuit block 17-348 may select, de-mux, and/or otherwise choose those commands and/or data from those commands that may be suited, eligible, etc. for processing, operations, etc. that may be performed by write data buffer 17-350. For example, the circuit block 17-348 may forward commands, data, etc. to write data buffer 17-350 using connection 17-386. For example, in FIG. 17-3, circuit block 17-354 may combine etc. commands, data, etc. from write data aggregator 17-346 and write data cache 17-352. Note that other connections, coupling, arrangements of circuits and/or transfer of commands, data, etc. are possible without substantially altering the functions, behavior, etc. of the Write Data OU.

For example, in one embodiment, optimizations of commands, requests, etc. such as command re-ordering, command combining, command splitting, command aggregation, command coalescing, command buffering, data caching, combinations of these and/or other similar operations on one or more commands etc. may be implemented in the context of one or more embodiments described in one or more applications incorporated by reference.

For example, in one embodiment, write combining etc. may be implemented in the context of FIG. 22-11 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” and the accompanying text. For example, one or more requests (e.g. reads, writes, etc.) that may correspond to sub-regions of memory may overlap such that they may be combined. In one embodiment, such an action, operation, etc. may be performed, for example for writes, by the write data aggregator of FIG. 17-3 and/or other such circuits, functions, etc. In one embodiment, such an action may be performed, for example, by a feedforward and/or other path in the memory chip (or in a logic chip or buffer chip etc., as shown, for example, in FIG. 22-2A of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, in one or more specifications incorporated by reference, and, for example, FIG. 7C of U.S. Provisional Application No. 61/502,100, filed Jun. 28, 2011, titled “SYSTEM, METHOD, AND COMPUTER PROGRAM PRODUCT FOR IMPROVING MEMORY SYSTEMS”, FIG. 1B of U.S. Provisional Application No. 61/569,107, filed Dec. 9, 2011, titled “SYSTEM, METHOD, AND COMPUTER PROGRAM PRODUCT FOR IMPROVING MEMORY SYSTEMS”, FIG. 7 of U.S. Provisional Application No. 61/602,034, filed Feb. 22, 2012, titled “SYSTEM, METHOD, AND COMPUTER PROGRAM PRODUCT FOR IMPROVING MEMORY SYSTEMS”, as well as (but not limited to) the accompanying text descriptions of these figures). The feedforward path may, for example, stall, cancel, delete, and/or otherwise modify etc. the operation(s) associated with one or more first requests and replace the one or more first requests with one or more second requests.

For example, in one embodiment, the optimizations of commands, requests, etc. including, but not limited to, such optimizations as command re-ordering, command combining, command splitting, command aggregation, command coalescing, command buffering, data caching, combinations of these and/or other similar operations on one or more commands etc. as described above, elsewhere herein, and/or in one or more applications incorporated by reference may be implemented in the context of memory partitioning, segmentation, division, etc. as described, for example, in the context of FIG. 22-13 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. Such optimizations etc. may be possible using a flexible memory architecture such as that shown, for example, in FIG. 22-13 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” with the use of region and sub-region partitioning. Such optimizations may include (but are not limited to) parallel operation, command and/or request reordering, command or request combining, command or request splitting, pipelining, and/or other similar operations and the like etc.

Other arrangements, architectures, connections of functions, etc. of one or more OUs and/or other associated circuits blocks, functions, etc. are possible. In one embodiment, for example, the write buffer function may be designed, constructed, implemented, etc. as one unit (e.g. a single unit handling both data and commands, etc.). In one embodiment, for example, the write data aggregator function may be designed, constructed, implemented, etc. as one unit (e.g. a single unit handling both data and commands, etc.). In one embodiment, for example, the write cache function may be designed, constructed, implemented, etc. as one unit (e.g. a single unit handling both data and commands, etc.).

Note that the circuits, functions, blocks, etc. that may be shown in FIG. 17-3 along with other associated circuits, blocks, functions, etc. may correspond to (e.g. use part of, be a part of, may have circuits common with, be partially implemented with, etc.) a part, portion, etc. of a Rx datapath and/or Tx datapath of a stacked memory package.

In one embodiment, the receive or Rx portions of the functions, circuits, blocks, etc. shown in FIG. 17-3 may correspond etc. to one or more blocks in FIG. 26-4 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, including, but not limited to, for example one or more Rx Buffers or parts, portions of one or more Rx Buffers, etc.

In one embodiment, the transmit or Tx portions of the functions, circuits, blocks, etc. shown in FIG. 17-3 may correspond etc. to one or more blocks in FIG. 26-5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, including, but not limited to, for example, one or more Tag Lookup blocks, Response Header Generator blocks, Tx Buffers and/or parts, portions, etc. of one or more of these blocks, etc.

In one embodiment, one or more of the transmit or Tx portions of the functions, circuits, blocks, etc. shown in FIG. 17-3 and/or one or more of the receive or Rx portions of the functions, circuits, blocks, etc. shown in FIG. 17-3 may correspond etc. to circuits, blocks, functions implemented in the context of FIGS. 19-13, 17-3, 17-8, 27-5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, and/or other Figures that may include, for example, one or more TxARB blocks and/or parts, portions, etc. of one or more of these blocks, etc.

In one embodiment, one or more of the functions, circuits, blocks, etc. shown in FIG. 17-3 may be implemented in the context of FIG. 28-4 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, including the accompanying text that describes, for example, the use of one or more FIFOs, buffers, structures, etc. that may be used to reorder, order, schedule, and/or otherwise manipulate command execution, timing etc.

FIG. 17-4 Stacked Memory Package Read/Write Datapath

FIG. 17-4 shows the read/write datapath for a stacked memory package 17-400, in accordance with one embodiment. As an option, the read/write datapath for a stacked memory package (also read/write datapath, stacked memory package datapath, etc.) may be implemented in the context of the previous Figure(s) and/or any subsequent Figure(s).

As an option, for example, one or more parts of the read/write datapath for a stacked memory package 17-400 may use one or more parts of the datapath shown in FIG. 17-3.

As an option, for example, the read/write datapath of FIG. 17-4 may be implemented in the context of FIG. 26-9 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, which is hereby incorporated by reference in its entirety for all purposes.

As an option, for example, the read/write datapath of FIG. 17-4 may be implemented in the context of one or more other Figures that may include one or more components, circuits, functions, behaviors, architectures, etc. associated with, corresponding to, etc. datapaths that may be included in one or more applications incorporated by reference. Of course, however, the read/write datapath of FIG. 17-4 may be implemented in any desired environment.

In one embodiment, the stacked memory package datapath may contain one or more datapaths. For example, in one embodiment, the stacked memory package datapath may contain one or more Rx datapaths and one or more Tx datapaths. For example, in FIG. 17-4, the stacked memory package datapath may contain Rx datapath 17-402 and Tx datapath 17-404. In one embodiment, one or more parts (e.g. portions, sections, etc.) of the stacked memory package datapath may be contained on a logic chip, CPU, etc.

In FIG. 17-4, the Rx datapath may include circuit blocks A-K.

In FIG. 17-4, the Rx datapath may include one or more of the following (but not limited to the following) circuit blocks and/or functions: block A 17-410, which may be part of the pad macros and/or pad cells and/or near pad logic, etc.; block B 17-412; block C 17-414; block D 17-418; block E 17-420; block F 17-422; block G 17-424; block H 17-426; block 117-434; block J 17-430; block K 17-432; block L 17-474.

For example, in one embodiment, block A may be the input pads, input receivers, deserializer, and associated logic; block B may a symbol aligner; block C may be a DC balance decoder, e.g. 8B/10B decoder, etc.; block D may be lane deskew and descrambler; block E may be a data aligner; block F may be an unframer (also deframer); block G may be a CRC checker; block H may be a flow control Rx block. In one embodiment, the number of Rx datapath blocks in one or more portions, parts of the Rx datapath may correspond to the number of Rx links used to connect a stacked memory package in a memory system. For example, the Rx datapath of FIG. 17-4 may correspond to a stacked memory chip with four high-speed serial links. This, in FIG. 17-4, the Rx datapath may contain four copies of these circuit blocks (e.g. blocks A-G), but any number may be used.

For example, in one embodiment, block I may be an Rx crossbar; block J may be one or more Rx buffers; block K may be an Rx router block; block L may be a receive path acceleration unit (OU). In one embodiment there may be one copy of blocks I-L in the Rx datapath, but any number may be used. Of course the number of physical circuit blocks used to construct blocks I-L may be different than the logical number of blocks I-L. Thus, for example, even though there may be one Rx crossbar in an Rx datapath, the Rx crossbar may be split into one or more physical circuit blocks, circuit macros, circuit arrays, switch arrays, arrays of MUXes, etc.

In one embodiment, the stacked memory package datapath may contain one or more memory controllers. For example, in FIG. 17-4, the stacked memory package datapath may include one or more memory controllers M 17-440. The memory controllers may be regarded as part of the Rx datapath and/or part of the Tx datapath.

In one embodiment, the number of memory controllers in one or more portions, parts of the Rx datapath and/or part of the Tx datapath may depend on (e.g. be related to, be a function of, etc.) the number of memory regions in a stacked memory package. For example, a stacked memory package may have eight stacked memory chips with 64 memory regions. Each memory controller may control 16 memory regions. Thus, in FIG. 17-4, the Rx datapath may contain four copies of the memory controller (e.g. block M), but any number may be used.

In one embodiment, the stacked memory package datapath may contain one or more stacked memory chips. For example, in FIG. 17-4, the stacked memory package datapath may include one or more stacked memory chips N 17-442. The one or more stacked memory chips may be connected to the one or more memory controllers using TSVs or other forms of through-wafer interconnect (TWI), etc.

Note that different variations, combinations, etc. of memory chips, portions of memory chips and memory controllers may be used. For example, in one embodiment, the read/write datapath for a stacked memory package 17-400, or one or more parts of the read/write datapath, may be implemented in the context of (e.g. be based on, use one or more parts of, share one or more parts with, be derived from, etc.) one or more architectures, components, circuits, structures and/or other parts and the like etc. of one or more Figures in one or more applications incorporated by reference and/or the accompanying text.

For example, in one embodiment, the read/write datapath for a stacked memory package 17-400 may be implemented in the context of FIG. 17-4 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. In this case, for example, the connection of the memory controllers may be such that each memory controller is connected, coupled, controls, etc. one or more memory regions on one or more memory chips. For example, in one embodiment, the stacked memory package may contain eight stacked memory chips. Each stacked memory chip may contain 16 memory regions. Thus, for example, the stacked memory package may contain a total of 8×16=128 memory regions. The stacked memory package may comprise four links to the external memory system. Thus, for example, there may be 16 groups of memory regions and associated logic. Thus, for example, each of the 16 groups of memory regions and associated logic may include 128/16=8 memory regions. Thus, each memory controller, for example, may control a group containing eight memory regions. The eight memory regions in each group may, for example, form an echelon (as defined herein and/or in one or more applications incorporated by reference). Of course, other arrangements of memory regions, and associated logic may be used.

For example, in one embodiment, the read/write datapath for a stacked memory package 17-400 may be implemented in the context of FIG. 26-8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, in one embodiment, a stacked memory package may contain 2, 4, 8, 16, or any number #SMC of stacked memory chips. In one embodiment, the stacked memory chips may be divided into one or more groups of memory regions (e.g. echelons, ranks, groups of banks, groups of arrays, groups of subarrays, etc. with terms as defined herein and/or in one or more applications incorporated by reference). In one embodiment, there may be the same number of memory regions on each stacked memory chip. For example, each stacked memory chip may contain 4, 8, 16, 32, or any number of #MR memory regions (including an odd number of memory regions, possibly including spares, and/or regions for error correction, etc.). The stacked memory package may thus contain #SMC×#MR memory regions. An echelon or other grouping, ensemble, collection etc. of memory regions may contain 16, 32, 64, 128, or any number #MRG of grouped memory regions. In one embodiment, there may be the same number of memory regions in each group of memory regions. Thus, a stacked memory package may contain 2, 4, 8, 16, or any number #SMC×#MR/#MRG of grouped memory regions, groups of memory regions. In one embodiment, there may be one memory controller assigned to (e.g. associated with, connected to, coupled to, in control of, etc.) each group of memory regions. Thus, there may be #SMC×#MR/#MRG memory controllers. For example, in a stacked memory package with eight stacked memory chips (#SMC=8), there may be 16 memory regions associated with each memory region group (#MRG=16) and 64 memory regions per stacked memory chip (#MR=64). There may thus be 8×64/16=32 memory controllers per stacked memory package in this example configuration. Of course, any number of stacked memory chips, memory regions, and memory controllers may be used. Thus, each stacked memory chip may contain 4, 8, 16, 32, or any number of #MX memory controllers (including an odd number of memory controllers, possibly including spares, and/or memory controllers for error correction, test, reliability, characterization, etc.). In one embodiment, for example, there may be different numbers of memory regions on each stacked memory chip. In one embodiment, there may be different numbers of memory regions in each group of memory regions. In one embodiment, there may be more than one memory controller assigned to each group of memory regions. In one embodiment, there may be more than one group of memory regions assigned to each memory controller. In one embodiment, the number of groups of memory regions assigned to each memory controller may not be the same for every memory controller. For example, there may be spare or redundant memory controllers and/or memory regions and/or groups of memory regions. For example, there may be more than one type (e.g. technology, etc.) of stacked memory chip. For example, there may be more than one type (e.g. technology, etc.) of memory region grouping. For any of these reasons and/or other reasons (e.g. design constraints, technology constraints, power constraints, cost constraints, performance requirements, etc.) the number of groups of memory regions assigned to each memory controller and/or number of memory controllers assigned to each group of memory regions may not be the same for every memory controller.

For example, in one embodiment, the read/write datapath for a stacked memory package 17-400 may be implemented in the context of FIG. 27-1C of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. Thus, for example, the construction, architecture, etc. of the Rx datapath logic including, but not limited to, the memory controllers and memory regions may be hierarchical. For example, the stacked memory package may include one or more first circuit blocks C1 that may include one or more second circuit blocks C2. For example, a stacked memory package may include four input links, may include four stacked memory chips, and each stacked memory chip may include eight memory portions, regions, etc. In this case, there may be four copies of first circuit block C1 and each first circuit block C1 may include two copies of second circuit block C2 (thus there may be a total of eight copies of second circuit block C2, one for each group of four memory portions, etc.). In one embodiment, the second circuit block C2 may include part of the Rx datapath function(s), one or more memory controllers, one or more memory portions, part of the Tx datapath as well as other associated logic, etc. The stacked memory package may include one or more third circuit blocks C3. One or more copies of the third circuit block C3 may be included in the second circuit block C2. In one embodiment, the third circuit block C3 may include (but is not limited to) one or more memory portions e.g. bank, bank group, section (as defined herein), echelon (as defined herein), rank, combinations of these and/or other groups or groupings, etc.

For example, in one embodiment, the read/write datapath for a stacked memory package 17-400 may be implemented in the context of FIG. 27-4 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, the stacked memory package architecture may include one or more copies of a memory controller. For example, four copies of the memory controller may be used, but any number may be used (e.g. 4, 8, 16, 32, 64, 128, odd numbers, etc.). For example, there may be a one-to-one correspondence between memory controllers and memory portions (e.g. there may be one memory controller for each memory portion on a stacked memory chip, etc.) but any number of copies of the memory controller may be used for each memory portion on a stacked memory chip. Thus, (for example) 8, 10, 12, etc. memory controllers may be used for stacked memory chips that may contain 8 memory portions (and thus the number of memory controllers used for each memory portion on a stacked memory chip is not necessarily an integer). Examples of architectures that do not use a one-to-one structure may be shown in other Figure(s) herein and/or Figure(s) in specifications incorporated by reference and accompanying text.

For example, in one embodiment, the read/write datapath for a stacked memory package 17-400 may be implemented in the context of one or more Figures, or parts of one or more Figures, and/or the accompanying text in one or more applications incorporated by reference. For example, the read/write datapath for a stacked memory package 17-400 may be implemented in the context of FIG. 17-4 and/or FIG. 26-8 and/or FIG. 27-1C and/or FIG. 27-4 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” and/or the context of one or more other Figures, etc. thereof. Thus, for example, any architectures, circuit, structure and the like described in one or more Figures herein and/or in one or more applications incorporated by reference may focus on, describe, explain, depict, etc. one or more particular features, aspects, behaviors, etc. of a system, component, part of a system, etc. However, it should be understood that those features etc. may be used, employed, implemented, etc. in combination, in conjunction, together, etc. For example, one or more features, aspects, behaviors of one or more datapaths described in various Figures may be used in combination, etc.

In FIG. 17-4, the Tx datapath may include one or more copies of circuit blocks O-W.

In FIG. 17-4, the Tx datapath may include one or more of the following (but not limited to the following) circuit blocks and/or functions: block O 17-450; block P 17-452; block T 17-476.

For example, in one embodiment, block O may be one or more Tx buffers; block P may be a Tx crossbar; block T may be a transmit path OU. In one embodiment, there may be one Tx crossbar in the Tx datapath, but any number may be used.

In FIG. 17-4, the Tx datapath may include one or more of the following (but not limited to the following) circuit blocks and/or functions: block Q 17-454; block R 17-456; block S 17-458; block T 17-460; block U 17-462; block V 17-464; block W 17-466.

For example, in one embodiment, block Q may be a tag lookup block; block R may be a response header generator; block S may be a flow control Tx block; block T may be a CRC generator; block U may be a frame aligner; block V may be a scrambler and DC balance encoder; block W may contain serializer, output drivers, output pads and associated logic, etc.

In one embodiment, the number of Tx datapath blocks in one or more portions, parts of the Tx datapath may correspond to the number of Tx links used to connect a stacked memory package in a memory system. For example, the Tx datapath of FIG. 17-4 may correspond to a stacked memory chip with four high-speed serial links. This, in FIG. 17-4, the Tx datapath may contain four copies of these circuit blocks (e.g. blocks Q-W), but any number may be used.

In one embodiment, the number of Tx links may be different from the number of Rx links.

In one embodiment, the number of circuit blocks may depend on the number of links. Thus, for example, if a stacked memory package has two Rx links there may be two copies of circuit blocks A-G. Thus, for example, if the same stacked memory package has eight Tx links there may be eight copies of circuit blocks Q-W.

In one embodiment, the frequency of circuit block operation may depend on the number of links. Thus, for example, if a stacked memory package has two Rx links there may be four copies of circuit blocks A-G that operate at a clock frequency F1. If, for example, the same stacked memory package has eight Tx links there may be four copies of circuit blocks Q-W that operate at a frequency F2. In order to equalize throughput, for example, F2 may be four times F1.

In one embodiment, the number of enabled circuit blocks may depend on the number of links. Thus, for example, if a stacked memory package has two Rx links there may be four copies of circuit blocks A-G, but only two copies of blocks A-G may be enabled. If, for example, the same stacked memory package has four Tx links there may be four copies of circuit blocks Q-W that are all enabled.

One or more of the circuit blocks and/or functions that may be shown in FIG. 17-4 may not be present in all implementations or may be logically located in a different place in the stacked memory package datapath, outside the stacked memory package datapath, etc. Not all functions and blocks that may be present in some implementations may be exactly as shown in FIG. 17-4. For example, one or more Tx buffers and/or one or more Rx buffers may be part of the memory controller(s), etc. The clocked elements and/or clocking elements that may be present in the stacked memory package datapath may not be shown in FIG. 17-4. The stacked memory package datapath may, for example, contain one or more clocked circuit blocks, synchronizers, DLLs, PLLs, etc.

In one embodiment, one or more circuit blocks and/or functions may provide one or more short-cuts.

For example, in FIG. 17-4, block X 17-468 may provide one or more short-cuts (e.g. from Rx datapath to Tx datapath, between one or more blocks in the Rx datapath, between one or more blocks in the Tx datapath, etc.). In one embodiment, block X may link an output from one block A to four inputs of block W. Thus four outputs may be linked to four inputs using a total of 16 connections (e.g. each block A output connects to four block W inputs). In one embodiment, block X may link an output from one block A to one input of block W. Thus, four outputs may be linked to four inputs using a total of four connections (e.g. each block A output connects to a different block W input). In one embodiment, block X may link the outputs from each block A to one input of block W. Thus four outputs may be linked to one input using a total of four connections (e.g. each block A output connects to a one block W input). In one embodiment, block X may perform a crossbar and/or broadcast function. Thus, for example, any output of any blocks A (1-4) may be connected (e.g. coupled, etc.) to any number (1-4) of inputs of any blocks W. In one embodiment, the connection and/or switching functions of the short-cuts may be programmable. For example, block X may be configured, programmed, reconfigured etc. at various times (e.g. at design time, at manufacture, at test, at start-up, during operation, etc.). Programming may be performed by the system (e.g. CPU, OS, user, etc.), by one or more logic chips in a memory system, by combinations of these, etc. Of course, a block performing these and/or similar short-cut functions may be placed at any point in the datapath. Of course, any number of blocks performing similar functions may be used.

For example, block X may perform a short-cut at the physical (e.g. PHY, SerDes, etc.) level and bridge, repeat, retransmit, forward, etc. packets between one or more input links and one or more output links.

For example, block Y 17-470 may perform a similar function to block X. In one embodiment short-cuts may be made across protocol layers. For example, in FIG. 17-4, blocks A-B may be part of the physical layer, blocks C-D may be part of the data link layer, blocks U-W may be part of the physical layer, etc. Thus, for example, block Y may extract (e.g. branch, forward, etc.) one or packets, packet contents, etc. from the data link layer of the Rx datapath and inject (e.g. forward, connect, insert, etc.) packets, packet contents, etc. into the physical layer of the Tx datapath. Block Y may also perform switching and/or crossbar and/or programmable connection functions as described above for block X, for example. Block Y may also perform additional logic functions to enable packets to cross protocol layers. The additional logic functions may, for example, include (but are not limited to): re-timing or other clocking functions, protocol functions that are required but are bypassed by the short-cut (e.g. scrambling or descrambling, DC balance encode or DC balance decode, CRC check or CRC generation, etc.), routing (e.g. connection based on packet contents, framing information, data in one or more control words, other data in one or more serial streams, etc.), combinations of these and/or other logic functions, etc.

For example, block Z 17-472 may perform a similar function to block X and/or block Y. In one embodiment, short-cuts may be made for routing, testing, loopback, programming, configuration, etc. For example, in FIG. 17-4 block Z may provide a short-cut from the Rx datapath to the Tx datapath. For example, in FIG. 17-4, block K may be an Rx router block.

For example, in one embodiment, circuit block K and/or other circuit blocks may inspect incoming packets, commands, requests, control words, metaframes, virtual channels, traffic classes, framing characters and/or symbols, packet contents, serial data stream contents, etc. (e.g. packets, data, information in the Rx datapath, etc.) and determine that a packet and/or other data, information, etc. is to be forwarded. Thus, for example, circuit block K and/or other circuit blocks may inspect incoming packets PN, etc. and determine that one or more packets PX etc. are to be routed directly (e.g. forwarded, sent, connected, coupled, etc.) to the Tx datapath (e.g. via circuit block K, etc.), and thus bypass, for example, memory controller(s) M. For example, the forwarded packets PX may be required to be forwarded to another stacked memory package.

For example, in one embodiment, circuit block L and/or other circuit blocks may perform optimization, acceleration, and/or other similar, related functions and the like. For example, circuit block L may perform one or more optimizations of commands, requests, etc. including, but not limited to, such optimizations as command re-ordering, command combining, command aggregation, command coalescing, command buffering, data caching, etc. as described above, elsewhere herein, and/or in one or more applications incorporated by reference. For example, in one embodiment, circuit block L may include one or more OUs (as described in the context of FIG. 17-3, for example). Note that some portions, parts, etc. of circuit block L or the functions, etc. performed by circuit block L may be logically in series with the Rx datapath (e.g. buffer functions, parts of buffer functions, etc.). Thus the placement, connection, etc. of circuit block L in the drawing of FIG. 17-4 should not necessarily be construed as implying that all circuits, functions, etc. of circuit block L are logically as drawn. For example, those parts, portions of circuit block L that may function as a cache may operate with data passing between circuit block J and circuit block L (and possibly other blocks). For example, those parts, portions of circuit block L that may function as a buffer may operate with control passing between circuit block J and circuit block L (and possibly other blocks).

For example, in one embodiment, circuit block T and/or other circuit blocks may perform optimization, acceleration, and/or other similar, related functions and the like. For example, circuit block T may perform one or more optimizations of responses, etc. including, but not limited to, such optimizations as response re-ordering, response combining, response aggregation, response coalescing, response buffering, data caching, etc. as described above, elsewhere herein, and/or in one or more applications incorporated by reference. For example, in one embodiment, circuit block T may include one or more OUs (as described in the context of FIG. 17-3, for example). Note that some portions, parts, etc. of circuit block T or the functions, etc. performed by circuit block T may be logically in series with the Tx datapath (e.g. buffer functions, parts of buffer functions, etc.). Thus the placement, connection, etc. of circuit block T in the drawing of FIG. 17-4 should not necessarily be construed as implying that all circuits, functions, etc. of circuit block T are logically as drawn. For example, those parts, portions of circuit block T that may function as a cache may operate with data passing between circuit block O and circuit block T (and possibly other blocks). For example, those parts, portions of circuit block T that may function as a buffer may operate with control passing between circuit block T and circuit block O (and possibly other blocks).

Note that one or more parts, portions (including all) of the optimization etc. functions described in connection with (e.g. in the context of, as part of, etc.) circuit block L and/or circuit block T may be performed, located, partially located, shared, distributed, apportioned, etc. For example, one or more parts, portions (including all) of the optimization etc. functions may be located in one or more of the circuit blocks M (e.g. memory controllers, associated logic, etc.) and/or circuit blocks N (e.g. memory circuits, associated logic, etc.).

Note that circuit block L and T may cooperate, collaborate, be coupled with each other, communicate with each other, etc. as described for example in the context of OUs in FIG. 17-3. Note that circuit block L and/or T may cooperate, collaborate, etc. as described for example in the context of OUs in FIG. 17-3. Note that circuit block L and/or T may cooperate, collaborate, be coupled with, communicate with, etc. one or more other blocks, etc.

Note that one or more parts, portions (including all) of the optimization etc. functions described in connection with (e.g. in the context of, as part of, etc.) circuit block L and/or circuit block T and/or any other blocks etc. may be performed, located, partially located, shared, distributed, apportioned, etc. with one or more other blocks. For example, some or all of command combining, data combining, etc. may be performed in one or more blocks that are part of the PHY layer, etc.

Note that parts or all of circuit block L and/or circuit block T may be located, or parts or all of their functions located, at one or more other logical, physical, electrical locations in the datapath (e.g. Rx datapath and Tx datapath). For example, buffering, caching, etc. may be performed at one or more locations in the PHY layer, etc. For example, buffering, caching, etc. may be performed at one or more locations in the memory controllers, memory circuits, etc.

In FIG. 17-4 for example, in one embodiment, circuit block Z may be used for read bypass and/or other similar functions, etc. Thus, for example, circuit block L (and possibly with other blocks) may determine that a read command may be bypassed. In this case, for example, read data may be passed from a cache, buffer, store, etc. using circuit block Z directly to the Tx datapath. For example, circuit block T may act together with circuit block L (and possibly with other blocks) to inject (e.g. add, insert, etc.) the cached etc. read data into one or more responses.

For example, combining etc. (including read combining) may be implemented in the context of FIG. 26-4 and/or FIG. 26-4 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, a stacked memory package or other memory system component, etc. may receive packets P1, P2, P3, P4. The packets may be sent and received in the order P1 first, then P2, then P3, and P4 last. There may be four memory controllers M1, M2, M3, and M4.

In one embodiment, for example, re-ordering etc. may be performed by one or more memory controllers and/or optimization units etc. included in one or more memory controllers. Packets P1 and P2 may be processed by M1 (e.g. P1 may contain a command, read request etc., addressed to one or more memory regions controlled by M1, etc.). Packet P3 may be processed by M2. Packet P4 may be processed by M3. In one embodiment, M1 may reorder P1 and P2 so that any command, request, etc. in P1 is processed before P2. M1 and M2 may reorder P2 and P3 so that P3 is processed before P2 (and/or P1 before P2, for example). M2 and M3 may reorder P3 and P4 so that P4 is processed before P3, etc. In one embodiment, one or more memory controllers and/or other circuit blocks, etc. may collaborate, communicate, cooperate, etc. in order to order, re-order, and/or otherwise control the execution (e.g. processing, retirement, completion, etc.) of commands (e.g. reads, writes, other commands, requests, etc.). For example, command ordering may be controlled by using one or more fields, controls, flags, signals, etc. that may use one or more of the following (but not limited to the following): tag, ID, sequence number, timestamp, combinations of these and/or other similar information and the like, etc.

In one embodiment, for example, combining, re-ordering etc. may be performed by one or more optimization units, OUs, and/or other circuits, blocks, etc. in the Rx datapath (e.g. including circuit block L in FIG. 17-4, for example).

In one embodiment, for example, combining, re-ordering etc. may be performed by one or more optimization units, OUs, and/or other circuits, blocks, etc. in the Tx datapath (e.g. including circuit block T in FIG. 17-4, for example).

For example, a stacked memory package or other memory system component, etc. may receive packets P1, P2, P3, P4. The packets may be sent and received in the order P1 first, then P2, then P3, and P4 last. There may be four memory controllers M1, M2, M3, M4. Packet P2 may contain a read command that requires reads using M1 and M2. Packet P1 may be processed by M1 (e.g. P1 may contain a read request addressed to one or more memory regions controlled by M1, etc.). Packets P1 may be processed by M1 (e.g. P1 may contain a read request addressed to one or more memory regions controlled by M2, etc.). The responses from M1 and M2 may be combined (possibly requiring reordering) to generate a single response packet P5. Combining, for example, may be performed by logic in M1, logic in M2, logic in both M1 and M2, logic outside M1 and M2, combinations of these, etc. In one embodiment, combining, for example, may be performed by logic in one or more OUs in one or more memory controllers, in the Rx datapath (e.g. including circuit block L in FIG. 17-4), in the Tx datapath (e.g. including circuit block T in FIG. 17-4), distributed between one or more circuit blocks in the Rx and/or Tx datapaths, and/or located in any location in the read/write datapath of a stacked memory package, etc.

In one embodiment, write combining may be performed in a similar manner to that described above. Note that optimizations such as combining etc. may be controlled by one or more policies, memory models, memory types, memory ordering, ordering rules, memory classes (as defined herein and/or in one or more applications incorporated by reference, etc.), and/or any other similar policies, rules, models, schemes, etc. that may apply to memory, memory coherency, memory consistency, cache coherency, and the like, etc. Thus, for example, in one embodiment, the functions, behaviors, parameters, enabling, disabling, etc. of one or more optimization functions, optimization units, parts of these and/or any other similar circuits, functions, blocks, etc. may be configurable, programmable, etc. For example, the functions etc. may depend on the memory model(s) etc. used by a memory system. For example, in one embodiment, the memory models etc. may be determined at design time, manufacture, assembly, test, start-up, boot time, and/or at any time. For example, in one embodiment, the CPU may store (e.g. in BIOS, in EEPROM, combination of these and/or other software, firmware, hardware, other storage techniques, etc.) parameters, data, information, etc. that may define, characterize, and/or otherwise specify one or more memory models etc. or parts of these. For example, in one embodiment, the CPU may program, configure, and/or otherwise set, define, etc. the functions, operations, behavior, etc. of one or more optimization functions, optimization units, etc. For example, the CPU may specify whether reads may pass buffered writes etc.

In one embodiment, packets may include (e.g. contain, hold, specify, etc.) more than one command. In one embodiment, a command may span (e.g. be defined by, be included in, etc.) more than one packet. Processing of commands (e.g. including optimizations such as combining, ordering, caching, etc.) as described above, elsewhere herein, and/or in one or more applications incorporated by reference may be performed on commands and/or packets. For example, in one embodiment, a first type of optimization etc. may be performed before a packet is de-multiplexed to command, data, etc. For example, ordering may be performed at the packet level (e.g. using timestamps, etc.). For example, in one embodiment, a second type of optimization etc. may be performed after a packet is de-multiplexed to command, data, etc. For example, combining, caching, etc. may be performed after the packet is de-multiplexed. For example, combining may be based on command type, etc. (e.g. multiple short write commands may be combined into a long write command, etc.)

In one embodiment, a memory controller and/or a group of memory controllers (possibly with other circuit blocks and/or functions, etc.) may perform such operations (e.g. reordering, modification, alteration, combinations of these, etc.) on requests and/or commands and/or responses and/or completions etc. (e.g. on packets, groups of packets, sequences of packets, portion(s) of packets, data field(s) within packet(s), data structures containing one or more packets and/or portion(s) of packets, on data derived from packets, etc.), to effect (e.g. implement, perform, execute, allow, permit, enable, etc.) one or more of the following (but not limited to the following): reduce and/or eliminate conflicts (e.g. between banks, memory regions, groups of memory regions, groups of banks, etc.), reduce peak and/or average and/or averaged (e.g. over a fixed time period, etc.) power consumption, avoid collisions between requests/commands and refresh, reduce and/or avoid collisions between requests/commands and data (e.g. on buses, etc.), avoid collisions between requests/commands and/or between requests/commands and other operations, increase performance, minimize latency, avoid the filling of one or more buffers and/or over-commitment of one or more resources etc., maximize one or more throughput and/or bandwidth metrics, maximize bus utilization, maximize memory page (e.g. SDRAM row, etc.) utilization, avoid head of line blocking, avoid stalling of pipelines, allow and/or increase the use of pipelines and pipelined structures, allow and/or increase the use of parallel and/or nearly parallel and/or simultaneous and/or nearly simultaneous etc. operations (e.g. in datapaths, etc.), allow or increase the use of one or more power-down or other power-saving modes of operation (e.g. precharge power down, active power down, deep power down, etc.), allow bus sharing by reordering commands to reduce or eliminate bus contention or bus collision(s) (e.g. failure to meet protocol constraints, improve timing margins, etc.), etc., perform and/or enable retry or replay or other similar commands, allow and/or enable faster or otherwise special access to critical words (e.g. in one or more CPU cache lines, etc.), provide or enable use of masked bit or masked byte or other similar data operations, provide or enable use of read/modify/write (RMW) or other similar data operations, provide and/or enable error correction and/or error detection, provide and/or enable memory mirror operations, provide and/or enable memory scrubbing operations, provide and/or enable memory sparing operations, provide and/or enable memory initialization operations, provide and/or enable memory checkpoint operations, provide and/or enable database in memory operations, allow command coalescing and/or other similar command and/or request and/or response and/or completion operations (e.g. write combining, response combining, etc.), allow command splitting and/or other similar command and/or request and/or response and/or completion operations (e.g. to allow responses to meet maximum protocol payload limits, etc.), operate in one or more modes of reordering (e.g. reorder reads only, reorder writes only, reorder reads and writes, reorder responses only, reorder commands/request/responses within one or more virtual channels etc., reorder commands/request/responses between (e.g. across, etc.) one or more virtual channels etc., reorder commands and/or requests and/or responses and/or completions within one or more address ranges, reorder commands and/or requests and/or responses and/or completions within one or more memory classes, combinations of these and/or other modes, etc.), permit and/or optimize and/or otherwise enhance memory refresh operations, satisfy timing constraints (e.g. bus turnaround times, etc.) and/or timing windows (e.g. tFAW, etc.) and/or other timing parameters etc., increase timing margins (analog and/or digital), increase reliability (e.g. by reducing write amplification, reducing pattern sensitivity, etc.), work around manufacturing faults and/or logic faults (e.g. errata, bugs, etc.) and/or failed connections/circuits etc., provide or enable use of QoS or other service metrics, provide or enable reordering according to virtual channel and/or traffic class priorities etc., maintain or adhere to command and/or request and/or response and/or completion ordering (e.g. for PCIe ordering rules, HyperTransport ordering rules, other ordering rules/standards, etc.), allow fence and/or memory barrier and/or other similar operations, maintain memory coherence, perform atomic memory operations, respond to system commands and/or other instructions for reordering, perform or enable the performance of test operations and/or test commands to reorder (e.g. by internal or external command, etc.), reduce or enable the reduction of signal interference and/or noise, reduce or enable the reduction of bit error rates (BER), reduce or enable the reduction of power supply noise, reduce or enable the reduction of current spikes (e.g. magnitude, rise time, fall time, number, etc.), reduce or enable the reduction of peak currents, reduce or enable the reduction of average currents, reduce or enable the reduction of refresh current, reduce or enable the reduction of refresh energy, spread out or enable the spreading of energy required for access (e.g. read and/or write, etc.) and/or refresh and/or other operations in time, switch or enable the switching between one or more modes or configurations (e.g. reduced power mode, highest speed mode, etc.), increase or otherwise enhance or enable security (e.g. through memory translation and protection tables or other similar schemes, etc.), perform and/or enable virtual memory and/or virtual memory management operations, perform and/or enable operations on one or more classes of memory (with memory class as defined herein including specifications incorporated by reference), combinations of these and/or other factors, etc.

In one embodiment, one or more memory controller(s) and/or associated logic etc. may insert (e.g. existing and/or new) commands, requests, packets or otherwise create and/or delete and/or modify commands, requests, responses, packets, etc. For example, copying (of data, other packet contents, etc.) may be performed from one memory class to another via insertion of commands. For example, successive write commands to the same, similar, adjacent, etc. location may be combined. For example, successive write commands to the same, location may allow one or more commands to be deleted. For example, commands may be modified to allow the appearance of one or more virtual memory regions. For example, a read to a single virtual memory region may be translated to two (or more) reads to multiple real (e.g. physical) memory regions, etc. The insertion, deletion, creation and/or modification etc. of commands, requests, responses, completions, etc. may be transparent (e.g. invisible to the CPU, system, etc.) or may be performed under explicit system (e.g. CPU, OS, user configuration, BIOS, etc.) control. The insertion and/or modification of commands, requests, responses, completions, etc. may be performed by one or more logic chips in a stacked memory package, for example. The modification (e.g. command insertion, command deletion, command splitting, response combining, etc.) may be performed by logic and/or manipulating data buffers and/or request/response buffers and/or lists, indexes, pointers, etc. associated with the data structures in the data buffers and/or request/response buffers.

In one embodiment, for example, combining, re-ordering etc. may be performed in the context of FIG. 28-1 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, the apparatus shown in FIG. 28-1 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” may be operable such that the transforming of commands, requests, etc. may include combining. In another embodiment, the apparatus may be operable such that the transforming includes splitting. In another embodiment, the apparatus may be operable such that the transforming includes modifying. In another embodiment, the apparatus may be operable such that the transforming includes inserting. In yet another embodiment, the apparatus may be operable such that the transforming includes deleting. For example, the functions, operation, etc. of the datapath shown in FIG. 17-4 may be used in conjunction with, may be part of, may have elements in common with, etc. the apparatus of FIG. 28-1 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”.

In one embodiment, for example, combining, re-ordering etc. may be performed in the context of FIG. 28-6 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, including, for example, the accompanying text that may describe, but is not limited to describing, the operation of a memory controller and/or a group of memory controllers. For example, In one embodiment, a memory controller and/or a group of memory controllers (possibly with other circuit blocks and/or functions, etc.) may perform such operations (e.g. reordering, modification, alteration, batching, scheduling, combinations of these, etc.) on requests and/or commands and/or responses and/or completions etc. (e.g. on packets, groups of packets, sequences of packets, portion(s) of packets, data field(s) within packet(s), data structures containing one or more packets and/or portion(s) of packets, on data derived from packets, etc.), to effect (e.g. implement, perform, execute, allow, permit, enable, etc.) one or more of the following (but not limited to the following): reduce and/or eliminate conflicts (e.g. between banks, memory regions, groups of memory regions, groups of banks, etc.), reduce peak and/or average and/or averaged (e.g. over a fixed time period, etc.) power consumption, avoid collisions between requests/commands and refresh, reduce and/or avoid collisions between requests/commands and data (e.g. on buses, etc.), avoid collisions between requests/commands and/or between requests/commands and other operations, increase performance, minimize latency, avoid the filling of one or more buffers and/or over-commitment of one or more resources etc., maximize one or more throughput and/or bandwidth metrics, maximize bus utilization, maximize memory page (e.g. SDRAM row, etc.) utilization, avoid head of line blocking, avoid stalling of pipelines, allow and/or increase the use of pipelines and pipelined structures, allow and/or increase the use of parallel and/or nearly parallel and/or simultaneous and/or nearly simultaneous etc. operations (e.g. in datapaths, etc.), allow or increase the use of one or more power-down or other power-saving modes of operation (e.g. precharge power down, active power down, deep power down, etc.), allow bus sharing by reordering commands to reduce or eliminate bus contention or bus collision(s) (e.g. failure to meet protocol constraints, improve timing margins, etc.), etc., perform and/or enable retry or replay or other similar commands, allow and/or enable faster or otherwise special access to critical words (e.g. in one or more CPU cache lines, etc.), provide or enable use of masked bit or masked byte or other similar data operations, provide or enable use of read/modify/write (RMW) or other similar data operations, provide and/or enable error correction and/or error detection, provide and/or enable memory mirror operations, provide and/or enable memory scrubbing operations, provide and/or enable memory sparing operations, provide and/or enable memory initialization operations, provide and/or enable memory checkpoint operations, provide and/or enable database in memory operations, allow command coalescing and/or other similar command and/or request and/or response and/or completion operations (e.g. write combining, response combining, etc.), allow command splitting and/or other similar command and/or request and/or response and/or completion operations (e.g. to allow responses to meet maximum protocol payload limits, etc.), operate in one or more modes of reordering (e.g. reorder reads only, reorder writes only, reorder reads and writes, reorder responses only, reorder commands/request/responses within one or more virtual channels etc., reorder commands/request/responses between (e.g. across, etc.) one or more virtual channels etc., reorder commands and/or requests and/or responses and/or completions within one or more address ranges, reorder commands and/or requests and/or responses and/or completions and/or probes, etc. within one or more memory classes, combinations of these and/or other modes, etc.), permit and/or optimize and/or otherwise enhance memory refresh operations, satisfy timing constraints (e.g. bus turnaround times, etc.) and/or timing windows (e.g. tFAW, etc.) and/or other timing parameters etc., increase timing margins (analog and/or digital), increase reliability (e.g. by reducing write amplification, reducing pattern sensitivity, etc.), work around manufacturing faults and/or logic faults (e.g. errata, bugs, etc.) and/or failed connections/circuits etc., provide or enable use of QoS or other service metrics, provide or enable reordering according to virtual channel and/or traffic class priorities etc., maintain or adhere to command and/or request and/or response and/or completion ordering (e.g. for PCIe ordering rules, HyperTransport ordering rules, other ordering rules/standards, etc.), allow fence and/or memory barrier and/or other similar operations, maintain memory coherence, perform atomic memory operations, respond to system commands and/or other instructions for reordering, perform or enable the performance of test operations and/or test commands to reorder (e.g. by internal or external command, etc.), reduce or enable the reduction of signal interference and/or noise, reduce or enable the reduction of bit error rates (BER), reduce or enable the reduction of power supply noise, reduce or enable the reduction of current spikes (e.g. magnitude, rise time, fall time, number, etc.), reduce or enable the reduction of peak currents, reduce or enable the reduction of average currents, reduce or enable the reduction of refresh current, reduce or enable the reduction of refresh energy, spread out or enable the spreading of energy required for access (e.g. read and/or write, etc.) and/or refresh and/or other operations in time, switch or enable the switching between one or more modes or configurations (e.g. reduced power mode, highest speed mode, etc.), increase or otherwise enhance or enable security (e.g. through memory translation and protection tables or other similar schemes, etc.), perform and/or enable virtual memory and/or virtual memory management operations, perform and/or enable operations on one or more classes of memory (with memory class as defined herein including specifications incorporated by reference), combinations of these and/or other factors, etc.

In one embodiment, for example, combining, insertion, deletion, etc. may be performed in the context of FIG. 28-6 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, including, for example, the accompanying text that may describe, but is not limited to describing, the operation of a memory controller and/or a group of memory controllers. For example, in one embodiment, the memory controller(s) may insert (e.g. existing and/or new) commands, requests, packets or otherwise create and/or delete and/or modify commands, requests, responses, packets, etc. For example, copying (of data, other packet contents, etc.) may be performed from one memory class to another via insertion of commands. For example, successive write commands to the same, similar, adjacent, etc. location(s) may be combined. For example, successive write commands to the same and/or related locations may allow one or more commands to be deleted. For example, commands may be modified to allow the appearance of one or more virtual memory regions. For example, a read to a single virtual memory region may be translated to two (or more) reads to multiple real (e.g. physical) memory regions, etc. The insertion, deletion, creation and/or modification etc. of commands, requests, responses, completions, etc. may be transparent (e.g. invisible to the CPU, system, etc.) or may be performed under explicit system (e.g. CPU, OS, user configuration, BIOS, etc.) control. The insertion and/or modification of commands, requests, responses, completions, etc. may be performed by one or more logic chips in a stacked memory package, for example. The modification (e.g. command insertion, command deletion, command splitting, response combining, etc.) may be performed by logic and/or manipulating data buffers and/or request/response buffers and/or lists, indexes, pointers, etc. associated with the data structures in the data buffers and/or request/response buffers.

In one embodiment, for example, combining, insertion, deletion, etc. may be performed in the context of FIG. 28-6 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, including, for example, the accompanying text that may describe, but is not limited to describing, the ordering of commands, etc. For example, the priority (e.g., arbitration etc. by traffic class, memory class, etc.) may also affect the order of a sequence (e.g. command sequence, etc.). Thus, for example, there may be two channels, A and B, in a stream where channel A may have higher priority than channel B. For example, the example command sequence A1, B1, A2, B2, A3, B3, A4, B4, . . . (where A1 etc. are commands) may be re-ordered as a result of priority. For example, the following sequence: A1, A2, A3, B1, B2, A4, . . . may represent the stream with no interleaving and with priority. Such reordering (e.g., prioritization, arbitration, etc.) may be performed in the Rx datapath (e.g., for read/write commands, requests, messages, control, etc.) and/or the Tx datapath (e.g., for responses, completions, messages, control, etc.) and/or other logic in a stacked memory package, for example. Such reordering (e.g., prioritization, etc.) may be used to implement features related to memory classes (as defined herein and/or in one or more specifications incorporated by reference); perform, enable, implement, etc. one or more virtual channels (e.g., real-time traffic, isochronous traffic, etc.); improve latency; reduce congestion; eliminate blocking (e.g., head of line blocking, etc.); to implement combinations of these and/or other features, functions, etc. of a stacked memory package.

FIG. 17-5 Optimization System for Read/Write Datapath

FIG. 17-5 shows an optimization system 17-500, part of a read/write datapath for a stacked memory package, in accordance with one embodiment. As an option, the optimization system may be implemented in the context of the previous Figure(s) and/or any subsequent Figure(s).

In FIG. 17-5, the optimization system may include one or more tables, data structures, storage structures, and/or other similar logical structures and the like etc. The one or more tables etc. may be used to optimize commands, requests, data, responses, combinations of these and the like etc. For example, the optimization system may perform, implement, partially implement, etc. one or more optimizations of commands, data, requests, responses, etc. such as command re-ordering, command combining, command splitting, command aggregation, command coalescing, command buffering, data caching, combinations of these and/or other similar operations on one or more commands, requests, responses, messages, data, etc.

As an option, for example, the optimization system may be implemented in the context of one or more other Figures that may include one or more components, circuits, functions, behaviors, architectures, etc. associated with, corresponding to, etc. datapaths that may be included in one or more other applications incorporated by reference. For example, the optimization system shown in FIG. 17-5 may focus on the tables etc. used by one or more datapaths or by circuit blocks included in one or more datapaths. For example, the tables etc. shown in FIG. 17-5 may be used by one or more optimization units, acceleration units, acceleration buffers, etc. as described herein and/or in one or more applications incorporated by reference. For example, the optimization system may be implemented in the context of FIG. 17-4 and/or FIG. 17-3. Of course, however, the optimization system of FIG. 17-5 may be implemented in any desired environment.

In FIG. 17-5, a stream of (e.g. multiple, set of, group of, one or more, etc.) requests 17-510, 17-512 (e.g. commands, raw commands, packets, read commands, write commands, messages, etc.) are received by (e.g. processed by, operated on, coupled by, etc.) a receive datapath (e.g. included in a logic chip in a stacked memory package, etc. as described elsewhere herein and/or in one or more applications incorporated by reference).

In FIG. 17-5, a request may include (but is not limited to) one or more of the following fields: (1) CMD: a command code, operation code, etc.; (2) Address: the memory address; (3) Data: write data and/or other data; (4) VC: the virtual channel number; (5) SEQ: a sequence number, identifying each command in the system. Any number and type of fields may be used.

In FIG. 17-5, the command code is (e.g. occupies, uses, etc.) a 2-bit field and may be used to indicate a command in one or more command sets, e.g. 11=standard write, 01=partial write with first word valid, 10=partial write with second word valid, 00=read, etc. The command code may be any length, use any coding/encoding scheme, etc. In one embodiment the command code may include more than one field. For example, in one embodiment the command code may be split into command type (e.g. read, write, raw command, other, etc.) and command sub-type (e.g. 32-byte read, masked write, etc.). There may be any number, type, organization of commands. Commands may be read requests, write requests of different formats (e.g. short, long, masked, etc.). Commands may include raw memory or other commands e.g. commands to generate one or more activate, precharge, refresh, and/or other native DRAM commands, test signals, calibration cycles, power management, termination control, register reads/writes, combinations of these and/or any other like signals, commands, instructions, etc. Commands may be messages (e.g. from CPU to memory system, between logic chips in stacked memory packages, and/or between any system components, etc.).

In FIG. 17-5, the virtual channel is shown as using a 1-bit field, but may use any length and/or format.

In FIG. 17-5, the sequence number is shown as a 3-bit field but may use any length and/or format. In one embodiment, for example, the sequence number may be a unique identifier for each command in a system. Typically for example, the sequence number may be long enough (e.g. use enough bits etc.) to keep track of some or all commands pending, outstanding, queued, etc. For example, if it is required to have up to 256 commands pending, the sequence number may be log(2) 256 or 8 bits long etc. In one embodiment, any technique, logic, tables, structures, fields, etc. may be used to track, list, maintain, etc. one or more types of commands (e.g. posted commands, non-posted commands, etc.). In one embodiment, for example, more than one type of sequence numbering (e.g. more than one sequence) may be used (e.g. different sequences for different command types, etc.).

In one embodiment, the request, command, etc. fields may be different from that shown in FIG. 17-5 (e.g. may use different lengths, may be in a different order, may not be present, may use more than one bit group, etc.) for different commands.

In one embodiment, one or more fields shown in FIG. 17-5 may not be present in all commands, requests, etc.

In one embodiment, one or more fields may be split (e.g use more than one bit group etc.).

In FIG. 17-5, the optimization system includes a command optimization table 17-518.

In FIG. 17-5, the optimization system includes a write optimization table 17-522.

In FIG. 17-5, the optimization system includes a read optimization table 17-526.

In FIG. 17-5, the optimization tables may be filled, populated, generated, etc. using information, data, fields, etc. from one or more commands, requests, responses, packets, messages, etc. In one embodiment, one or more optimization tables may be filled, populated, generated, etc. using one or more population policies (e.g. rules, protocol, settings, etc.). In one embodiment, for example, a population policy may control, dictate, govern, indicate, and/or otherwise specify etc. how a table is populated. For example, a population policy may control which commands are used to populate a table. For example, a population policy may control which fields are used to populate a table. For example, a population policy may specify fields that are generated to populate a table. In one embodiment, for example, a policy (including, but not limited to, a population policy) may control, specify, etc. any aspect of one or more tables and/or logic etc. associated with one or more tables etc. In one embodiment, for example, a population policy may be programmed, configured, and/or otherwise set, changed, altered, etc. In one embodiment, for example, a population policy may be programmed, configured etc. at design time, manufacture, assembly, start-up, boot time, during operation, at combinations of these times and/or at any time etc. In one embodiment, for example, any policy, settings, configuration, etc. may be programmed at any time.

For example, in FIG. 17-5, the command optimization table is shown as being populated from a command 17-510 as represented by arrow 17-514. The command may be a read request, write request, raw command, etc. In one embodiment, for example, only commands that may be eligible (e.g. appropriate, legal, validated, satisfy constraints, filtered, constrained, selected, etc.) may be used to populate the command optimization table. In FIG. 17-5, control logic (not shown) associated with (e.g. coupled to, connected to, etc.) the command optimization table may populate the valid field 17-540, which may be used to indicate which data bytes in the command optimization table are valid. The valid field may be derived from the command code, for example.

In one embodiment, for example, commands may include one or more sub-commands etc. that may be eligible to populate the command optimization table. For example, in one embodiment, one or more commands may be expanded. In this case, the command expansion may include the insertion, creation, generation, a combination of these and/or other similar operations and the like etc. of one or more table entries per command. For example, a write command with an embedded read command may be expanded to two commands. An expanded command may result from expanding a command with one or more embedded commands, etc. For example, a write command with an embedded read command may be expanded to an expanded read command and an expanded write command. For example, a write command with an embedded read command may be expanded to one or more expanded read commands and one or more expanded write commands. In one embodiment, the expansion process, procedures, functions, algorithms, etc. and/or any related operations etc. may be programmed, configured, etc. The programming etc. may be performed at any time.

In one embodiment, command expansion from a command with embedded commands may result in the creation, generation, addition, insertion, etc. of one or more commands other than the embedded commands. For example, a write command with an embedded read command may be expanded to one or more read commands and one or more write commands and/or one or more other expansion commands. For example, in one embodiment, a write command with an embedded read command may be expanded to one or more read commands and one or more write commands and/or one or more ordering commands, fence commands, raw commands, and/or any other commands, signals, packets, responses, messages, combinations of these and the like etc. In one embodiment, any command, command sequence, set of commands, group of commands, etc. (including a single multi-purpose command, for example) may be expanded to one or more commands, expanded commands, messages, responses, raw commands, signals, ordering commands, fence commands, combinations of these and/or any other commands, signals, packets, responses, messages and the like etc.

In one embodiment, for example, command splitting may be regarded as, viewed as, function as, etc. a subset of, as part of, as being related to, etc. command expansion. Thus, for example, a write command with a 256 byte data payload may be split or expanded to two writes with 128 byte payloads, etc. In one embodiment, command expansion may be viewed as more flexible and powerful than command splitting. For example, command expansion may be defined as the technique by which any ordering commands, signals, techniques etc. that may be used (e.g. as expansion commands, etc.) may be inserted, generated, controlled, implemented, etc.

Note that one or more operations may be performed on embedded commands as part of command expansion, etc. For example, data fields may be modified (e.g. divided, split, separated, etc.). For example, sequence numbers may be created, added, modified, etc. In one embodiment, any modification, generation, alteration, creation, translation, mapping, etc. of one or more fields, data, and/or other information in a command, request, raw request, response, message etc. may be performed. For example, the modification etc. may be performed as part of command expansion etc. For example, the command modification etc. may be programmed, configured, etc. For example, the command modification programming etc. may be performed at any time.

In one embodiment, for example, the command modification, field modification etc. may be implemented in the context of FIG. 19-11 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” and/or in the accompanying text including, but not limited to, the text describing, for example, address expansion.

In one embodiment, for example, command expansion may include the generation, creation, insertion, etc. of one or more fields, bits, data, and/or other information etc. For example, command expansion may include the generation of one or more valid bits. In one embodiment, any number of bits, fields, types of fields, data, and/or other information may be generated using command expansion. The one or more fields, bits, data, and/or other information etc. may be part of a command, expanded command, generated command, etc. and/or may form, generate, create, etc. one or more table entries, one or more parts of one or more table entries, and/or generate any other part, piece, portion, etc. of data, information, signals, etc.

In one embodiment, for example, one or more expanded commands (e.g. expanded read commands and/or expanded write commands, etc.) and/or expanded fields (e.g. addresses, other fields, etc.) may correspond to, result in, generate, create, etc. multiple entries and/or multiple fields in one or more optimization tables.

In one embodiment, for example, the optimization system of FIG. 17-5 and/or optimization systems described elsewhere herein and/or described in one or more applications incorporated by reference may be implemented in the context of the packet structures, command structures, command formats, packet formats, request formats, response formats, etc. that may be shown in one or more Figures of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, which is hereby incorporated by reference in its entirety for all purposes. For example, the address field formats etc. may be implemented in the context of FIG. 23-4 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, the addressing of one or more memory chips, stacked memory packages, portions or parts of one or more memory chips (e.g. echelons, sections, banks, sub-banks, etc. as defined herein and/or in one or more applications incorporated by reference, etc.) may be implemented in the context of FIG. 23-5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, the formats of various commands, requests, etc. may be implemented in the context of FIG. 23-6A and/or FIG. 23-6B, and/or FIG. 23-6C of U.S. application Ser. No. 13/710,411, filed Dec. 10, 2012, titled “SYSTEM, METHOD, AND COMPUTER PROGRAM PRODUCT FOR IMPROVING MEMORY SYSTEMS” along with the accompanying text. For example, the formats of various commands, requests, etc. that may include various sub-commands, sub-requests, embedded requests, etc. may be implemented in the context of FIG. 23-7 and/or FIG. 23-8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” along with the accompanying text.

For example, in one embodiment, a read request may include (but is not limited to) the following fields: ID, identification; a read address field that in turn may include (but is not limited to) module, package, echelon, bank, subbank fields. Other fields (e.g., control fields, error checking, flags, options, etc.) may be present in the read requests. For example, a type of read (e.g., including, but not limited to, read length, etc.) may be included in the read request. For example, the default access size (e.g., read length, write length, etc.) may be a cache line (e.g., 32 bytes, 64 bytes, 128 bytes, etc.). Other read types may include a burst (of 1 cache line, 2 cache lines, 4 cache lines, 8 cache lines, etc.). As one option, a chopped (e.g. short, early termination, etc.) read type may be supported (for 3 cache lines, 5 cache lines, etc.) that may terminate a longer read type. Other flags, options and types may be used in the read requests. For example, when a burst read is performed the order in which the cache lines are returned in the response may be programmed etc. Not all of the fields described need be present. For example, if there are no subbanks used, then the subbank field may be absent (e.g. not present, present but not used, zero or a special value, etc.), or ignored by the receiver datapath, etc.

For example, in one embodiment, a read response may include (but is not limited to) the following fields: ID, identification; a read data field that in turn may include (but is not limited to) data fields (or subfields) D0, D1, D1, D2, D3, D4, D5, D6, D7. Other fields, subfields, flags, options, types etc. may be (and generally are) used in the read responses. Not all of the fields described need be present. Of course, other sizes for each field may be used. Of course, different numbers of fields (e.g. different numbers of data fields and/or data subfields, bit groups, etc. may be used). Fields may be a single group (e.g. collection, sequence, etc.) of bits, and/or one or more bit groups, related bit groups, and/or any combination of these and the like, etc.

For example, in one embodiment, a write request may include (but is not limited to) the following fields: ID, identification; a write address field that in turn may include (but is not limited to) module, package, echelon, bank, subbank fields; a write data field that in turn may include (but is not limited to) data fields (or subfields) D0, D1, D1, D2, D3, D4, D5, D6, D7. Other fields (e.g., control fields, error checking, flags, options, etc.) subfields, etc. may be present in the write requests. For example, a type of write (e.g. including, but not limited to, write length, etc.) may be included in the write request. For example, the default write size may be a cache line (e.g., 32 bytes, 64 bytes, 128 bytes, etc.). Other flags, options and types may be used in the write requests. Not all of the fields described need be present. For example, if there are no subbanks used, then the subbank field may be absent (e.g. not present, present but not used, zero or a special value, etc.), or may be ignored by the datapath receiver, other logic, etc. Of course, other sizes for each field may be used. Of course, different numbers of fields (e.g. different numbers of data fields and/or data subfields etc. may be used).

In one embodiment, the command optimization table may function, for example, to perform write combining. For example, in FIG. 17-5, the command optimization table is shown as including two writes 17-536, 17-538. In one embodiment, for example, these two partial writes may be combined to produce a single write. In one embodiment, any types of commands, requests, messages, responses, combinations of these and the like etc. may be combined, aggregated, coalesced, etc. For example, in one embodiment, one or more masked writes, partial writes, etc. may be combined. For example, in one embodiment, one or more reads may be combined. For example, in one embodiment, one or more commands may be combined to allow optimization of one or more commands at the memory chips. For example, multiple commands may be combined to allow for burst DRAM operations (reads, writes, etc.). For example, such combining and/or other command manipulation etc. may be performed in the context of FIG. 23-5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” and the accompanying text including, but not limited to, the description of supporting memory chip burst lengths, etc. Such combining, and/or other command manipulation, etc. may be programmed, configured, etc. The programming etc. of combining functions, behavior, techniques, etc. and/or other command manipulation, etc. may be performed at any time.

In one embodiment, the command optimization table and/or other tables, structures, logic, etc. may function, for example, to expand raw commands. For example, a raw command may contain a native DRAM instruction. For example, a native DRAM instruction may include (but is not limited to) commands such as: activate (ACT), precharge (PRE), refresh, read (RD), write (WR), register operations, configuration, calibration control, termination control, error control, status signaling, etc. For example, a raw command may contain a command code etc. such that the raw command may be expanded to a sequence, group, set, collection, etc. of commands, signals, etc. that may include one or more native DRAM commands, command signals (e.g. CKE, ODT, CS, etc.), address signals, row address, column address, bank address, multiplexed address signals, combinations of these and the like etc. For example, these expanded commands may be forwarded to one or more memory controllers and/or applied to (e.g. transferred to, queued for, forwarded to, sent to, coupled to, communicated to, etc.) one or more DRAM, stacked memory chips, portions of stacked memory chips, etc. Such expansion may include the generation, creation, translation, etc. of one or more control signals, addresses, command fields, command signals, and/or any other similar command, command component, signal, combinations of these and the like etc. For example, chip select signals, ODT signals, refresh commands, combinations of these and/or other signals, commands, data, information, combinations of these and the like etc. may be generated, translated, timed, retimed, staggered, and/or otherwise manipulated etc. possibly as a function or functions of other signals, command fields, settings, configurations, modes, etc. For example, refresh signals may be generated, created, ordered, scheduled, etc. in a staggered fashion in order to minimize maximum power consumption, minimize signal interference, minimize supply voltage noise, minimize ground bounce, and/or optimize any combinations of these factors and/or any other factors etc.

Thus, for example, in one embodiment, a command optimization table and/or other tables, structures, logic, associated logic, combinations of these and the like etc. may function, operate, etc. to control not only the content (e.g. of fields, bits, data, other information, etc.) of one or more commands, expanded commands, issued commands, queued commands, requests, etc. but also the timing (e.g. absolute timing of command execution, relative timing of execution of one or more commands, etc.) of commands, expanded commands, generated commands, raw commands, etc.

For example, in one embodiment, a command optimization table and/or other tables, structures, logic, etc. may function, operate, etc. to control the sequence of a number of commands. For example, the sequencing may be such that a sequence of commands meets, satisfies, respects, obeys, fulfills, etc. one or more timing parameters, timing restrictions, desired operating behavior, etc. of one or more stacked memory chips and/or portions of one or more stacked memory chips. For example, sequencing may include ensuring that a DRAM parameter such as tFAW is met. Of course, it may be desired to sequence commands etc. such that any timing parameter and/or similar rule, restriction, protocol requirement, etc. for any memory technology and/or combination of memory technologies etc. and/or timing behavior of any associated circuits, functions, etc. may be met, satisfied, obeyed, etc. For example, it may be desired, beneficial, etc. to sequence commands such that a target balance between types of commands may be met. For example, it may be beneficial to balance reads and write commands in order to maximize bus utilization, memory efficiency, etc. For example, it may be beneficial to sequence commands to reduce or eliminate bus turnaround times. For example, it may be beneficial to sequence commands to reduce or eliminate bus collision. For example, it may be beneficial to sequence commands to reduce or eliminate signal interference, power noise, power consumption and the like. In one embodiment, for example, the control, programming, configuration, operation, functions, etc. of command sequencing may be performed, partly performed, etc. by one or more state machines and/or similar logic, circuits, etc. Such state machines etc. may be programmed, configured, etc. For example, the state machine transitions, states, triggers etc. may be programmed using a simple code, text file, command code, mode change, configuration write, register write, combinations of these and/or other similar operations etc. that may be conveyed, transmitted, signaled, etc. in a command, raw command, configuration write, combinations of these and/or other similar operations etc. The programming etc. of such state machines may be performed at any time. For example, in this way the order, priority, timing, sequence, and/or other properties of one or more commands sequences, sets and/or groups of commands etc. issued, executed, queued, transferred etc. to one or more memory chips, portions of one or more memory chips, one or more memory controllers, etc. may be controlled.

In one embodiment, logic (e.g. the logic chip(s) in a stacked memory package, datapath logic, memory controllers, one or more optimization units, combinations of these and/or other logic circuits, structures and the like etc.) may translate (e.g., modify, store and modify, merge, separate, split, create, alter, logically combine, logically operate on, etc.) one or more requests (e.g., read request, write request, message, flow control, status request, configuration request and/or command, other commands embedded in requests (e.g., memory chip and/or logic chip and/or system configuration commands, memory chip mode register or other memory chip and/or logic chip register reads and/or writes, enables and enable signals, controls and control signals, termination values and/or termination controls, I/O and/or PHY settings, coding and data protection options and controls, test commands, characterization commands, raw commands including one or more DRAM commands, other raw commands, calibration commands, frequency parameters, burst length mode settings, timing parameters, latency settings, DLL modes and/or settings, power saving commands or command sequences, power saving modes and/or settings, etc.), combinations of these, etc.) directed at one or more logic chip(s) and/or one or more memory chips. For example, logic in a stacked memory package may split a single write request packet into two write commands per accessed memory chip. For example, logic may split a single read request packet into two read commands per accessed memory chip with each read command directed at a different portion of the memory chip (e.g., different banks, different subbanks, etc.). As an option, logic in a first stacked memory package may translate one or more requests directed at a second stacked memory package.

In one embodiment, logic in a stacked memory package may translate one or more responses (e.g., read response, message, flow control, status response, characterization response, etc.). For example, logic may merge two read bursts from a single memory chip into a single read burst. For example, logic may combine mode or other register reads from two or more memory chips. As an option, logic in a first stacked memory package may translate one or more responses from a second stacked memory package, etc.

In one embodiment, the command optimization table may function to perform, for example, command buffering. For example, in FIG. 17-5, the command optimization table is shown as including two writes 17-542, 17-544. In one embodiment, these two writes may be retired (e.g. removed, transferred, operations performed, commands executed, etc.) from the table according to one or more arbitration, control, throttling, priority, and/or other similar policies, algorithms, techniques and the like etc. For example, commands, requests, etc. such as reads, writes, etc. may be transferred to one or more memory controllers and data written to DRAM and/or data read from DRAM on one or more stacked memory chips. For example, in FIG. 17-5, the command optimization table is shown as retiring write 17-544 to DRAM as represented by arrow 17-520.

In one embodiment, the command optimization table structure may be optimized to reduce the storage (e.g. space, number of bits, etc.) used to hold (e.g. store, etc.) multiple partial writes. In one embodiment, the command optimization table structure may be optimized, altered, modified, etc. to increase the speed of operation (e.g. of one or more optimization functions, etc.). Thus, for example, in one embodiment, the fields, contents, encoding, etc. of one or more tables shown in FIG. 17-5 may be altered, varied, different, etc. from that shown.

In one embodiment, for example, one or more tables may be constructed, designed, structured, and/or otherwise made operable to operate in one or more modes of operation. For example, a first mode of operation of one or more optimization tables and/or optimization units, control logic, etc. may be such to optimize speed (e.g. latency, bandwidth, combinations of these and/or other related performance metrics, etc.). For example, chosen metrics may include, but are not limited to, one or more of the following: peak bandwidth, minimum bandwidth, maximum bandwidth, average bandwidth, standard deviation of bandwidth, other statistical measures of bandwidth, average latency, maximum latency, minimum latency, standard deviation of latency, other statistical measures of latency, combinations of these and/or other measures, metrics and the like etc. For example, a second mode of operation of one or more optimization tables and/or optimization units, control logic, etc. may be such to optimize power (e.g. minimize power, operate such that power does not exceed a threshold, etc.). One or more such operating modes may be configured, programmed, etc. Configuration etc. of one or more such operating modes may be performed at any time.

In one embodiment, for example, one or more modes of operation and/or any other aspect, property, behavior, function, etc. of one or more optimization tables, optimization units, control logic associated with optimization, and/or any other logic, circuits, functions, etc. may be configured, programmed, etc. using a model. For example, in one embodiment, the optimization system of FIG. 17-5 may be implemented in the context of FIGS. 23-6A, 23-6B, and/or 23-6C of U.S. application Ser. No. 13/710,411, filed Dec. 10, 2012, titled “SYSTEM, METHOD, AND COMPUTER PROGRAM PRODUCT FOR IMPROVING MEMORY SYSTEMS” and the accompanying text including, but not limited to, the text describing the models, protocols, channel efficiency, etc. For example, in one embodiment, one or more measurements, parameters, settings, etc. may be used as one or more inputs to a model, collection of models, etc. that may model the behavior, aspects, functions, responses, performance, etc. of one or more parts of a memory system. For example, in one embodiment, the model may then be used to adjust, alter, modify, tune, and/or otherwise program, configure, reconfigure etc. one or more aspects, features, parameters, inputs, outputs, behavior, algorithms, and/or other functions of the like of one or more optimization tables, optimization data structures, optimization units, control logic and/or any other logic, control logic, logic structures, etc. of a memory system.

In one embodiment, the command optimization table may be split, divided, separated, etc. into one or more separate tables for command combining and command buffering, for example. In one embodiment, the command optimization table may be split etc. into separate tables for read buffering and write buffering, for example.

In one embodiment, the command optimization table may perform command reordering. For example, in one embodiment, command reordering may be based on the sequence number. For example, in one embodiment, command reordering may be controlled by, determined by, governed by, etc. one or more memory ordering rules, ordering policies, etc. For example, in one embodiment, command reordering may be determined by the memory type, memory class (as described herein and/or in one or more applications incorporated by reference), etc.

In one embodiment, the command optimization table or any tables, structures, etc. may perform or be used to perform any type of command, request, etc. processing, handling, operations, manipulations, changes, and/or similar functions and the like etc.

In one embodiment, any number, type, form, of tables with any content, data, information, format, structure, etc. may be used for any number, type, etc. of optimization functions and the like, etc.

In FIG. 17-5, the write optimization table is shown as being populated from a request 17-512 as represented by arrow 17-516. In one embodiment, only commands that may be eligible (e.g. appropriate, legal, satisfy constraints, etc.) may be used to populate the write optimization table. For example, control logic associated with (e.g. coupled to, connected to, etc.) the write optimization table may populate the write optimization table with write request or a subset of write requests, etc. The eligible commands, requests, etc. may be configured and/or programmed.

In one embodiment, for example, the configuration etc. of table population rules, algorithms and other similar techniques etc. and/or configuration of any aspect, behavior, etc. of table operation may be performed at any time. In one embodiment, for example, a command, request, trigger, etc. to configure etc. one or more tables, table structures, table functions, table behavior, table contents, etc. may result in the emptying, clearing, flushing, zeroing, resetting, etc. of one or more fields, bits, structures, tables and/or logic associated with, coupled to, connected with, etc. one or more tables etc.

In FIG. 17-5, control logic associated with (e.g. coupled to, connected to, etc.) the write optimization table may populate the valid field 17-546, which may be used to indicate which data bytes in the write optimization table are valid. The valid field may be derived from the command code, for example. In FIG. 17-5, control logic associated with the write optimization table may populate the dirty bit 17-548, which may be used to indicate which entries in the write optimization table are dirty.

In one embodiment, the write optimization table may act to perform as a cache, temporary store, etc. for write data. For example, write optimization table entry 17-550 may store data that is scheduled to be written to address 001. If, for example, a read request is received while this entry is in the write optimization table, the data may be forwarded to the transmit datapath. For example, the data may be forwarded using a read bypass technique and using a read bypass path as described herein and/or in one or more applications incorporated by reference. Forwarded data may be combined with the sequence number from the read request (and possibly other information, data, fields, etc.) to form one or more read responses.

In one embodiment, combined writes (e.g. from a command optimization table, etc.) may be included in the write optimization table. In one embodiment, combined writes may be excluded from the write optimization table (for example, to preserve program order and/or other memory ordering model etc.).

In one embodiment, the write optimization table may use an address organized (e.g. including, etc.) as tag, index, offset, etc. (e.g. in order to reduce cache size, increase cache speed, etc.). In one embodiment, the write optimization table may be of any size, type, organization, structure, etc. In one embodiment, the write optimization table may use any population policy, replacement policy, write policy, hit policy, miss policy, combinations of these and/or any other policy and the like, etc.

In FIG. 17-5, a stream of (e.g. multiple, set of, group of, one or more, etc.) responses 17-534, 17-560, 17-558 etc. (e.g. read responses, messages, etc.) are processed by a transmit datapath (e.g. included in a logic chip in a stacked memory package, etc. as described elsewhere herein and/or in one or more applications incorporated by reference).

In FIG. 17-5, the responses may include data from a memory controller connected to memory (e.g. DRAM in one or more stacked memory chips, etc.) as indicated, for example, by arrow 17-528.

In FIG. 17-5, a response etc. may include (but is not limited to) one or more of the following fields: (1) Data: read data and/or other data; (2) SEQ: a sequence number, identifying each command in the system. Any number and type of fields may be used.

In FIG. 17-5, the read optimization table is shown as being populated from a response 17-534 as represented by arrow 17-532. Table population (e.g. for any tables, structures, etc. shown in FIG. 17-5) may be performed by control logic, state machines, and/or other logic etc. (not explicitly shown in FIG. 17-5 in order to improve clarity) that may be coupled to, connected to, associated with, etc. one or more tables, table structures, table storage, etc.

In one embodiment, only commands, responses, etc. that may be eligible may be used to populate the read optimization table. For example, control logic associated with the read optimization table may populate the read optimization table with read responses or a subset of read responses, etc. The eligible commands, requests, etc. may be configured and/or programmed. Configuration etc. of table population rules, algorithms and other similar techniques etc. and/or configuration of any aspect, behavior, etc. of table operation may be performed at any time.

In FIG. 17-5, control logic associated with (e.g. coupled to, connected to, etc.) the read optimization table may populate the valid field 17-552, which may be used to indicate which data bytes in the read optimization table are valid.

In one embodiment, the read optimization table may act to perform as a cache, temporary store, etc. for read data. For example, read optimization table entry 17-554 may store data that is stored in memory address 010. If, for example, a read request is received for address 010 while read optimization table entry 17-554 is in the read optimization table, the data from read optimization table entry 17-554 may be used in the transmit datapath to form the read response (as indicated by arrow 17-530 in FIG. 17-5). In one embodiment, the data from read optimization table entry 17-554 may be combined with the sequence number from the read request to form the response, for example. Note that reads of length that are less than a full read optimization table entry may also be completed using the valid bits to determine if the requested data is valid data in the read optimization table entry.

In one embodiment, one or more read optimization tables may act, operate, function, etc. to allow the ordering, reordering, interleaving, and/or other similar organization of one or more read responses etc. For example, in one embodiment, responses may be reordered to correspond to program order. For example, in one embodiment, responses may be reordered to correspond to the order in which read requests were received. For example, in one embodiment, responses may be reordered to correspond to a function of sequence numbers (e.g. by increasing sequence number, etc.). For example, in one embodiment, responses may be reordered to correspond to a function of one or more parameters, metrics, measures, etc. For example, in one embodiment, responses may be reordered by a hierarchical technique, in a hierarchical manner, according to hierarchical rules, etc. For example, in one embodiment, responses may be ordered by source of the request first (e.g. at the highest level of hierarchy, etc.) and then by sequence number. Of course, any parameter, field, metric, data, information, combinations of these and the like may be used to control ordering. For example, ordering may be a function of virtual channel, traffic class, memory class (as defined herein and/or in one or more applications incorporated by reference), etc. Such ordering control etc. may be configured, programmed, etc. Such programming etc. of ordering may be performed at any time. Ordering may be controlled by the request, for example. For example, in one embodiment, a request for multiple words, cache lines, etc. may include a desired response ordering. For example, a CPU may indicate that a response include a critical word first. For example, a CPU may indicate a particular response ordering, etc. Of course any technique etc. may be used to program, configure, control, alter, modify, etc. one or more operations, behavior, functions, etc. of ordering.

In one embodiment, the read optimization table may be part of the optimization units, tables, etc. that may be part of the Rx datapath. In this case, for example, the data may be forwarded using a read bypass technique and using a read bypass path as described herein and/or in one or more applications incorporated by reference. Forwarded data may be combined with the sequence number from the read request (and possibly other information, data, fields, etc.) to form one or more read responses.

In one embodiment, the read optimization table may use an address organized (e.g. including, etc.) as tag, index, offset, etc. (e.g. in order to reduce cache size, increase cache speed, etc.). In one embodiment, the read optimization table may be of any size, type, organization, structure, etc. In one embodiment, the read optimization table may use any population policy, replacement policy, write policy, hit policy, miss policy, combinations of these and/or any other policy and the like, etc. In one embodiment, the read optimization table may be combined with, part of, included with, coupled to, connected to, and/or otherwise logically associated with one or more other tables. For example, in one embodiment, the read optimization table, or parts of the read optimization table, may be combined with one or more parts of a write optimization table. In one embodiment, any table, or part of a table, may be combined, integrated, coupled to, connected to, joined with, shared with, cooperate with, collaborate with, etc. one or more other tables.

In FIG. 17-5, the optimization tables are shown with different formats. For example, the write optimization table is shown as using a 2-bit valid field and dirty bit and the read optimization table has no dirty bit. In one embodiment, the optimization tables may use different formats from that shown in FIG. 26-5. For example, depending on the polices and algorithms used one or more optimization tables may contain additional fields (e.g. additional address parts or portions, indexes, offsets, pointers, combinations of these and/or other similar data, information and the like, etc.), different sized fields (e.g. different number of bits, etc.), different bits (e.g. additional flags, marks, pointers, etc.), etc. from that shown in FIG. 17-5. For example, in one embodiment, a common structure may be used for one or more optimization tables. For example, in one embodiment, one or more read optimization tables and one or more write optimization tables may be combined in such a way as to form one or more read/write optimization tables. For example, in one embodiment, the percentage of table space (e.g. number of table entries, etc.) used for read optimization and/or write optimization in a read/write optimization table may be varied. For example, in one embodiment, the percentage of table spaces used for optimization in a read/write optimization table may be programmed, configured, etc. In one embodiment any combinations of tables may be used in one or more locations in a datapath (e.g. command optimization tables, read optimization tables, write optimization tables, read/write optimization tables, command/read/write optimization tables, etc.).

In one embodiment, for example, the configuration of table space may be performed at design time, manufacture, assembly, test, boot, start-up, during operation, at combinations of these times and/or at any time, etc. For example, the allocation of storage, memory, etc. to one or more tables (e.g. command optimization tables, read optimization tables, write optimization tables, read/write optimization tables, command/read/write optimization tables, etc.) may be a function of performance. For example, in one embodiment, one or more control logic blocks, circuits, functions, etc. may monitor the performance of one or more optimization tables and/or parts, portions of one or more optimization tables, etc. For example, in one embodiment, the hit rate of one or more optimization tables may be measured, monitored, sampled, predicted, modeled, and/or otherwise obtained in a similar manner etc. Of course, any measure, metric, parameters, function, etc. related to, associated with, corresponding to any aspect, behavior, etc. of performance may be so obtained. For example, if a read optimization table is performing with a high hit rate, the table space assigned to the read optimization table may be increased, etc. Of course, any aspect, parameter, structure, function, behavior, size, format, combinations of these and/or other similar properties and the like of one or more optimization tables and/or logic, functions, circuits, etc. associated with, connected to, coupled to, attached to, corresponding to, etc. one or more optimization tables may be changed, programmed, altered, modified, configured, set, and/or otherwise controlled, etc. In one embodiment, for example, the configuration of table space, control of table functions, and/or any other aspect of tables, associated logic etc. may be static (e.g. fixed, relatively fixed, may be held fixed, may be set, etc.) and/or dynamic (e.g. may be changed, may be changed continuously, may be changed at a steady rate, may be changed in response to system events, may be changed in response to signals, may be changed in response to one or more commands, may be changed in response to measurement, may be changed in a feedback loop, may be changed according to user input, may be changed according to combinations of these and/or other similar actions, events, triggers, etc.).

Note that the sizes of fields, widths of fields, contents of fields, etc. in the data structures, tables, etc. shown in FIG. 17-5 may be different from that shown. For example, the command field in may be 8 bits wide, or any number. For example, the address field in a 64-bit system may be 64 bits wide, or any number. For example, the address field in a 32-bit system may be 32 bits wide, or any number. For example, the data field may be 2, 4, 8, 16, 32, 64, 72, 128, 256 bytes wide, or any number. For example, the data field may be variable width and depend on command (e.g. may be different widths depending on the type of write command, etc.). For example, any field may be variable width and depend, for example, on command (e.g. fields may be different widths depending on the type of command and/or other factors, etc.). For example, the data field may be zero for read commands, etc. For example, the data field (and/or any field) may be used for information other than data in certain commands types (e.g. raw commands etc.). For example, the virtual channel field may be 2, 4, 8 bits wide, or any number. For example, the sequence number field may be 8, 16 bits wide, or any number. For example, the valid field may be 1, 2, 8, 16, 32, 64 bits wide, or any number and/or may depend on (e.g. be a function of, etc.) the width of the data field. For example, there may be any number of dirty bits.

In one embodiment, for example, one or more fields in one or more tables etc. may be split. For example, one or more commands may include sub-commands. For example, one or more read commands may be included, piggy-backed, etc. in a write command. Thus, the format, shape, appearance, layout, structure etc. of commands, requests, responses, messages, raw commands, etc. may be such that the corresponding, associated, etc. format, shape, appearance, layout, structure etc. of one or more tables, data structures, fields in these structures and/or tables, etc. may also be varied, shaped, designed, etc. accordingly (e.g. to accommodate, hold, store, process, operate on, etc. one or more commands, raw commands, requests, responses, messages, etc.).

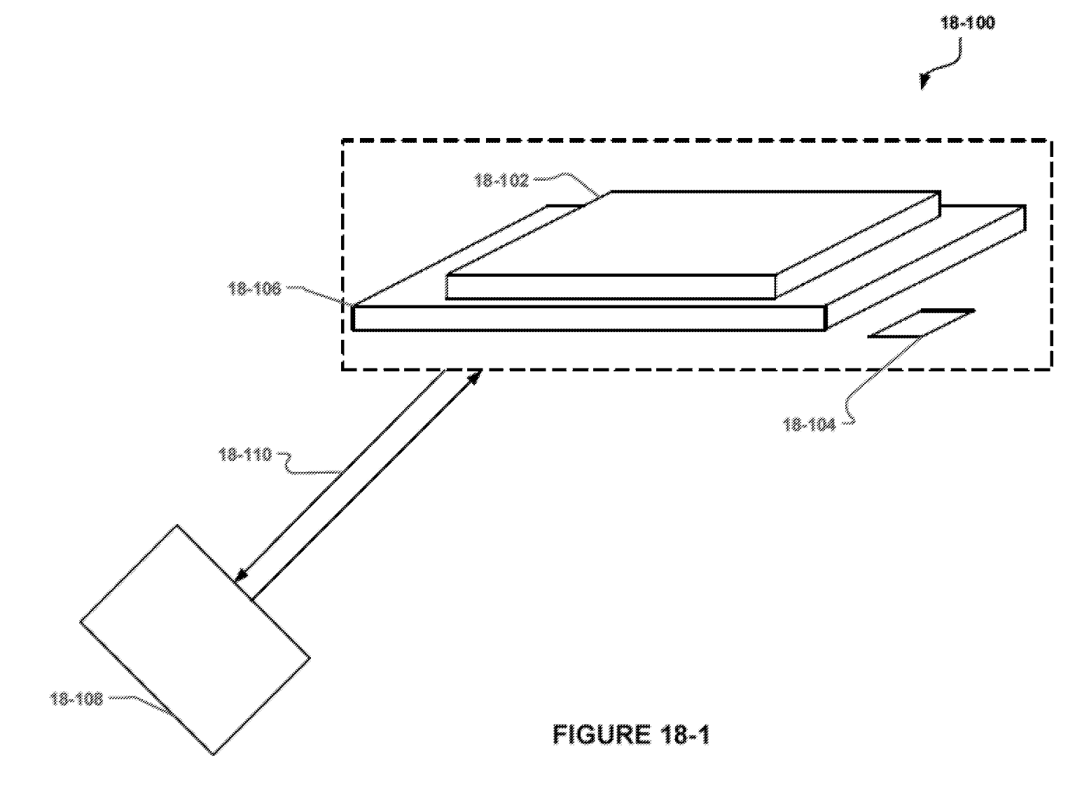

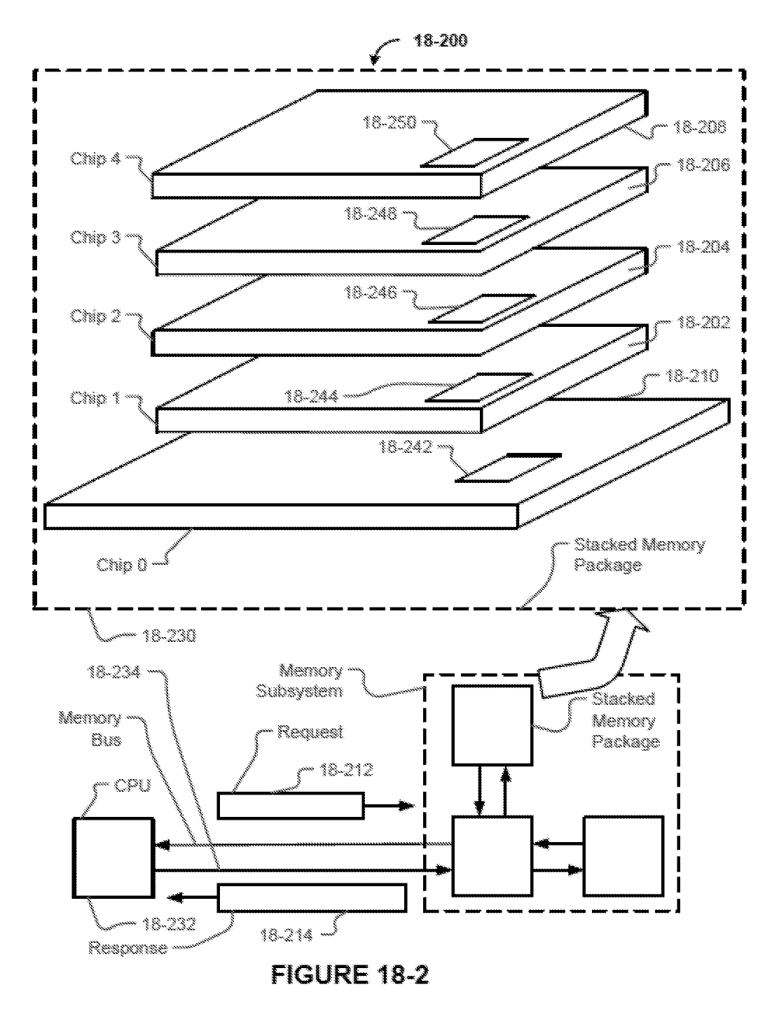

FIG. 18-1

FIG. 18-1 shows an apparatus 18-100 for improved memory, in accordance with one embodiment. As an option, the apparatus 18-100 may be implemented in the context of any subsequent Figure(s). Of course, however, the apparatus 18-100 may be implemented in the context of any desired environment.

It should be noted that a variety of optional architectures, capabilities, and/or features will now be set forth in the context of a variety of embodiments in connection with a description of FIG. 18-1. Any one or more of such optional architectures, capabilities, and/or features may or may not be used in combination with any other one or more of such described optional architectures, capabilities, and/or features. Of course, embodiments are contemplated where any one or more of such optional architectures, capabilities, and/or features may be used alone without any of the other optional architectures, capabilities, and/or features.

As shown, in one embodiment, the apparatus 18-100 includes a first semiconductor platform 18-102, which may include a first memory. Additionally, in one embodiment, the apparatus 18-100 may include a second semiconductor platform 18-106 stacked with the first semiconductor platform 18-102. In one embodiment, the second semiconductor platform 18-106 may include a second memory. As an option, the first memory may be of a first memory class. Additionally, in one embodiment, the second memory may be of a second memory class. Of course, in one embodiment, the apparatus 18-100 may include multiple semiconductor platforms stacked with the first semiconductor platform 18-102 or no other semiconductor platforms stacked with the first semiconductor platform.

In another embodiment, a plurality of stacks may be provided, at least one of which includes the first semiconductor platform 18-102 including a first memory of a first memory class, and at least another one which includes the second semiconductor platform 18-106 including a second memory of a second memory class. Just by way of example, memories of different classes may be stacked with other components in separate stacks, in accordance with one embodiment. To this end, any of the components described above (and hereinafter) may be arranged in any desired stacked relationship (in any combination) in one or more stacks, in various possible embodiments. Furthermore, in one embodiment, the components or platforms may be configured in a non-stacked manner. Furthermore, in one embodiment, the components or platforms may not be physically touching or physically joined. For example, one or more components or platforms may be coupled optically, and/or by other remote coupling techniques (e.g. wireless, near-field communication, inductive, combinations of these and/or other remote coupling, etc.).

In another embodiment, the apparatus 18-100 may include a physical memory sub-system. In the context of the present description, physical memory may refer to any memory including physical objects or memory components. For example, in one embodiment, the physical memory may include semiconductor memory cells. Furthermore, in various embodiments, the physical memory may include, but is not limited to, flash memory (e.g. NOR flash, NAND flash, other flash memory and similar memory technologies, etc.), random access memory (e.g. RAM, SRAM, DRAM, SDRAM, eDRAM, embedded DRAM, MRAM, PRAM, combinations of these, etc.), memristor, phase-change memory, FeRAM, PRAM, MRAM, PCRAM, resistive RAM, RRAM, a solid-state disk (SSD) or any other disk, magnetic media, combinations of these and/or any other physical memory and/or memory technology etc. (volatile memory, nonvolatile memory, etc.) that meets the above definition.

Additionally, in various embodiments, the physical memory sub-system may include a monolithic memory circuit, a semiconductor die, a chip, a packaged memory circuit, or any other type of tangible memory circuit, or any intangible grouping of tangible memory circuits, combinations of these, etc. In one embodiment, the apparatus 18-100 or associated physical memory sub-system may take the form of a dynamic random access memory (DRAM) circuit. Such DRAM may take any form including, but not limited to, synchronous DRAM (SDRAM), double data rate synchronous DRAM (DDR SDRAM, DDR2 SDRAM, DDR3 SDRAM, DDR4 SDRAM, etc.), graphics double data rate DRAM (GDDR, GDDR2, GDDR3, GDDR4, GDDR5, etc.), quad data rate DRAM (QDR DRAM), RAMBUS XDR DRAM (XDR DRAM), fast page mode DRAM (FPM DRAM), video DRAM (VDRAM), extended data out DRAM (EDO DRAM), burst EDO RAM (BEDO DRAM), multibank DRAM (MDRAM), synchronous graphics RAM (SGRAM), combinations of these and/or any other DRAM or similar memory technology and the like, etc.

In the context of the present description, a memory class (or type of memory class, etc.) may refer to any memory classification (e.g. class, type, form, version, generation, etc.) of a memory technology. For example, in various embodiments, the memory class may include, but is not limited to, a flash memory class, a RAM memory class, an SSD memory class, a magnetic media class, and/or any other class of memory, storage, and the like in which a type of memory etc. may be classified (e.g. identified, marked, typed, etc.). Still yet, it should be noted that the memory classification of memory technology may further include a usage classification of memory, where such usage may include, but is not limited to: power usage, bandwidth usage, speed usage, reliability of usage, cost of usage, latency of access, frequency of use, voltage supply used, combinations of these and/or one or more other factors, metrics, parameters, features, and the like, etc. In embodiments where one or more memory classes may include one or more classifications (e.g. a usage classification, etc.), one or more physical aspects of memories may or may not be identical. In one embodiment, the memory classification of memory technology may further include any number, type, form, technique, etc. of classification.

In the one embodiment, the first memory class may include non-volatile memory (e.g. FeRAM, MRAM, PRAM, logic NVM, combinations of these and/or other non-volatile memory technologies and the like, etc.), and the second memory class may include volatile memory (e.g. SRAM, DRAM, T-RAM, Z-RAM, TTRAM, combinations of these and/or any other volatile memory technologies and the like, etc.). In another embodiment, one of the first memory or the second memory may include RAM (e.g. DRAM, SRAM, etc.) and the other one of the first memory or the second memory may include NAND flash, and/or other memory technologies and the like, etc. In another embodiment, one of the first memory or the second memory may include RAM (e.g. DRAM, SRAM, etc.) and the other one of the first memory or the second memory may include NOR flash, and/or other memory technologies and the like, etc. Of course, in various embodiments, any number (e.g. 2, 3, 4, 5, 6, 7, 8, 9, or more, etc.) of combinations of memory classes may be utilized. Of course, in various embodiments, as an option, any type, kind, form, number, technology, etc. and/or combinations of types etc. of memory classes may be utilized. For example, in one embodiment, as an option, volatile memory technology and/or non-volatile memory technology may be used separately and/or in combination, etc. For example, in one embodiment, as an option, a memory class may include more than one memory technology. For example, in one embodiment, as an option, two memory classes may include the same or similar memory technology, but used in a different manner, fashion, way, etc. For example, in one embodiment, as an option, two memory classes may include the same or similar memory technology, but operating at different speeds, etc. For example, in one embodiment, as an option, two memory classes may include the same or similar memory technology, but operating at different voltages, etc. For example, in one embodiment, as an option, two memory classes may include the same or similar memory technology, but programmed, configured, etc. to operate in a different manner, fashion, mode, state, configuration, version, etc. For example, in one embodiment, as an option, any number and/or any type of memory may be used and/or programmed, configured, etc. to operate in any number of classes, manners, fashions, uses, etc.

In one embodiment, there may be connections (not shown) that are in communication with the first memory and pass through the second semiconductor platform 18-106. Such connections that are in communication with the first memory and pass through the second semiconductor platform 18-106 may be formed utilizing through-silicon via (TSV) technology. Additionally, in one embodiment, the connections may be communicatively coupled to the second memory.

For example, in one embodiment, the second memory may be communicatively coupled to the first memory. In the context of the present description, being communicatively coupled refers to being coupled in any way that functions to allow any type of signal (e.g. a data signal, an electric signal, information, etc.) to be communicated (e.g. passed between, linked, transmitted/received, etc.) between the communicatively coupled items. In one embodiment, the second memory may be communicatively coupled to the first memory via direct contact (e.g. a direct connection, etc.) between the two memories. Of course, being communicatively coupled may also refer to indirect connections, connections with one or more intermediate connections therebetween, one or more intermediate circuits therebetween, combinations of these, etc. In another embodiment, the second memory may be communicatively coupled to the first memory via a bus. In one embodiment, the second memory may be communicatively coupled to the first memory utilizing one or more TSVs. For example, in one embodiment, as an option, one or more connections may be made using vias, interposers, bumps, pillars, balls, pads, wires, bonds, solder, conductive epoxy, substrates, traces, pins, combinations of these and/or any other connection technique, technology, structure, and the like, etc. For example, in one embodiment, connections may be made using one or more passive components (e.g. resistors, capacitors, inductors, etc.). For example, in one embodiment, as an option, one or more connections may be made using one or more passive components such as switches, etc. For example, in one embodiment, as an option, one or more connections may be made using any type, number, configuration, etc. of active components, circuits, devices, etc. and/or type, number, configuration, etc. of passive components, circuits, etc. For example, in one embodiment, as an option, one or more connections may be programmable, configurable, changeable, etc.

As another option, the communicative coupling may include a connection via a buffer device. In one embodiment, the buffer device may be part of the apparatus 18-100. In another embodiment, the buffer device may be separate from the apparatus 18-100. In one embodiment, the communicative coupling may include a connection via one or more buffer devices, circuits, blocks, repeaters, registers, combinations of these and/or any other similar circuits and the like, etc.

Further, in one embodiment, at least one additional semiconductor platform (not shown) may be stacked with the first semiconductor platform 18-102 and the second semiconductor platform 18-106. In this case, in one embodiment, the additional semiconductor may include a third memory of at least one of the first memory class or the second memory class, and/or any other additional circuitry. In another embodiment, the at least one additional semiconductor may include a third memory of a third memory class. Of course, any number, type, form, etc. of semiconductors, platforms, memories, memory classes, etc. may be used.

In one embodiment, the additional semiconductor platform may be positioned between the first semiconductor platform 18-102 and the second semiconductor platform 18-106. In another embodiment, the at least one additional semiconductor platform may be positioned above the first semiconductor platform 18-102 and the second semiconductor platform 18-106. Further, in one embodiment, the additional semiconductor platform may be in communication with at least one of the first semiconductor platform 18-102 and/or the second semiconductor platform 18-102 utilizing wire bond technology. Of course, any number, type, form, etc. of orientation, positioning, communication, communication technology, etc. may be used.

Additionally, in one embodiment, the additional semiconductor platform may include additional circuitry in the form of a logic circuit. In this case, in one embodiment, the logic circuit may be in communication with at least one of the first memory or the second memory. In one embodiment, at least one of the first memory or the second memory may include a plurality of subarrays in communication via shared data bus. In one embodiment, as an option, one or more additional semiconductor platforms may include any number (zero, one or more, etc.) additional logic circuits.

Furthermore, in one embodiment, the logic circuit may be in communication with at least one of the first memory or the second memory utilizing TSV technology. In one embodiment, the logic circuit and the first memory of the first semiconductor platform 18-102 may be in communication via a buffer. In this case, in one embodiment, the buffer may include a row buffer. In one embodiment, as an option, one or more logic circuits may be in communication with any number of memories using any number of types of connection technology, where the connection technology may include passive connections (e.g. wires, TSVs, pillars, vias, traces, bumps, pins, combinations of these, etc.), active circuits (e.g. buffers, registers, repeaters, combinations of these and/or other similar circuits and the like, etc.), and/or any other components (e.g. passive components, resistors, capacitors, inductors, switches, combinations of these and/or any other components the like, etc.).

Further, in one embodiment, the apparatus 18-100 may be configured such that the first memory and the second memory are capable of receiving instructions via a single memory bus 18-110. The memory bus 18-110 may include any type of memory bus. Additionally, the memory bus may be associated with (e.g. use, follow, employ, adhere to, etc.) a variety (e.g. selection, set, suite, etc.) of protocols e.g. memory protocols such as JEDEC DDR2, JEDEC DDR3, JEDEC DDR4, SLDRAM, RDRAM, LPDRAM, LPDDR, combinations of these, etc; I/O protocols such as PCI, PCI-Express, HyperTransport, InfiniBand, QPI, Interlaken, etc; networking protocols such as Ethernet, TCP/IP, iSCSI, combinations of these, etc; storage protocols such as NFS, SAMBA, SAS, SATA, FC, etc; derivatives, versions, modifications, etc. of these and/or other protocols; combinations of these and/or other protocols (e.g. wireless, optical, inductive, NFC, etc.) and the like, etc. Of course, other embodiments are contemplated that may, for example, use multiple memory buses.

For example, in one embodiment, as an option, one or memory buses may include, use, employ, implement, etc. one or more high-speed serial protocols. For example, in one embodiment, one or more memory buses may use different protocols, versions of protocols, combinations of protocols, etc. For example, in one embodiment, a first memory bus may use a first version of a bus protocol and a second memory bus may use a second version of a bus protocol. In this case, for example, the first protocol version may run at (e.g. operate at, be clocked at, etc.) a first clock speed and the second protocol version may operate at a second clock speed, etc. Versions of a protocol may include (but are not limited to) different voltages, different speeds, different latencies, different impedances, different power, different timing, different electrical signaling (e.g. differential signaling, single-ended signaling, etc.), or different combinations of these and/or any other parameters, metrics, features, properties, aspects, behaviors, timings, and the like, etc.

In one embodiment, the apparatus 18-100 may include a three-dimensional integrated circuit. In one embodiment, the first semiconductor platform 18-102 and the second semiconductor platform 18-106 together may include a three-dimensional integrated circuit. In the context of the present description, a three-dimensional integrated circuit refers to any integrated circuit comprised of stacked wafers and/or dies (e.g. silicon wafers and/or dies, etc.), which are interconnected vertically (e.g. on top of one another, etc.) and are capable of behaving as a single device. Of course, any number, type, form, etc. of wafers, dies, chips, integrated circuits, and the like etc. may be used.

In one embodiment, for example, an integrated circuit comprising stacked dies may be capable of emulating, simulating, etc. one or more abstract devices. In one embodiment, for example, an integrated circuit comprising four dies may be capable of behaving as a single device. In one embodiment, for example, an integrated circuit comprising four dies may be capable of behaving as two devices (e.g. as though two die formed one abstract, virtual, simulated, emulated, etc. device, etc.).

For example, in one embodiment, the apparatus 18-100 may include a three-dimensional integrated circuit that is a wafer-on-wafer device. In this case, a first wafer of the wafer-on-wafer device may include the first memory of the first memory class, and a second wafer of the wafer-on-wafer device may include the second memory of the second memory class. Of course, any number, type, form, etc. of wafer-on-wafer, dies-on-wafer, chips-on-wafer, and/or any combination(s) of wafers, dies, chips, integrated circuits, and the like etc. may be used.

In the context of the present description, a wafer-on-wafer device refers to any device including two or more semiconductor wafers that are communicatively coupled in a wafer-on-wafer configuration. In one embodiment, the wafer-on-wafer device may include a device that is constructed utilizing two or more semiconductor wafers, which are aligned, bonded, and possibly cut in to at least one three-dimensional integrated circuit. In this case, vertical connections (e.g. TSVs, etc.) may be built into the wafers before bonding or created in the stack after bonding. In one embodiment, the first semiconductor platform 18-102 and the second semiconductor platform 18-106 together may include a three-dimensional integrated circuit that is a wafer-on-wafer device.

In another embodiment, the apparatus 18-100 may include a three-dimensional integrated circuit that is a monolithic device. In the context of the present description, a monolithic device refers to any device that includes at least one layer built on a single semiconductor wafer, communicatively coupled, and in the form of a three-dimensional integrated circuit. In one embodiment, the first semiconductor platform 18-102 and the second semiconductor platform 18-106 together may include a three-dimensional integrated circuit that is a monolithic device.

In another embodiment, the apparatus 18-100 may include a three-dimensional integrated circuit that is a die-on-wafer device. In the context of the present description, a die-on-wafer device refers to any device including one or more dies positioned on a wafer. In one embodiment, the die-on-wafer device may be formed by dicing a first wafer into singular dies, then aligning and bonding the dies onto die sites of a second wafer. In one embodiment, the first semiconductor platform 18-102 and the second semiconductor platform 18-106 together may include a three-dimensional integrated circuit that is a die-on-wafer device.

In yet another embodiment, the apparatus 18-100 may include a three-dimensional integrated circuit that is a die-on-die device. In the context of the present description, a die-on-die device refers to a device including two or more aligned dies in a die-on-die configuration. In one embodiment, the first semiconductor platform 18-102 and the second semiconductor platform 18-106 together may include a three-dimensional integrated circuit that is a die-on-die device.

Additionally, in one embodiment, the apparatus 18-100 may include a three-dimensional package. For example, the three-dimensional package may include a system in package (SiP) or chip stack MCM. In one embodiment, the first semiconductor platform and the second semiconductor platform are housed in a three-dimensional package. Of course, any number, type, form, etc. of package, integrated package, package-in-package (PiP), package-on-package (PoP), chip-scale package (CSP), combinations of these and/or any advanced package, packaging technology, assembly technology, module technology, and the like etc. may be used.

In one embodiment, the apparatus 18-100 may be configured such that the first memory and the second memory are capable of receiving instructions from a device 18-108 via the single memory bus 18-110. In one embodiment, the device 18-108 may include one or more copies of one or more components from the following list (but not limited to the following list): a central processing unit (CPU); a memory controller, a chipset, a memory management unit (MMU); a virtual memory manager (VMM); a page table, a table lookaside buffer (TLB); any other tables and/or data structures, etc.; one or more levels of cache (e.g. L1, L2, L3, etc.); a core unit (e.g. CPUs, processors, etc.); an uncore unit (e.g. circuits, blocks, etc. outside the core unit, outside the CPUs, etc.); FIFOs; buffers; MUXes; de-MUXes; priority encoders; any other encoders; decoders; arbitration circuits; registers; register files; memories; scratchpad memories; scoreboards; tables; look-up tables; counters; data correction unit; error detection unit; error correction unit; state machine; combinations of these and/or any other similar system components, other components, circuits, logic, blocks, functions, units, and the like, etc. In one embodiment, more than one memory bus may be used. In one embodiment, any number, type, form, structure, etc. of memory bus and the like may be used.

Note that some embodiments of a stacked memory package described elsewhere herein and/or in one or more specification incorporated by reference may include a separate CPU or similar processor (e.g. a microcontroller, macro engine, etc.) and in some cases the device 18-108 (or the equivalent system component, other component, device, circuit, etc.) may be referred to as a system CPU, separate processor, etc. in order to avoid potential confusion. Note that some embodiments of a stacked memory package described herein may include the system CPU, separate processor, etc. as part of, included within, etc. the stacked memory package. Thus, for example, it is possible that a stacked memory package may include, may contain, etc. more than one CPU. In some cases, for example, one or more CPUs may be used as system CPUs, separate processors, etc. In one embodiment, it is possible that a single CPU included in a stacked memory package may perform multiple functions and perform, execute, implement, etc. the functions, operations, etc. of a system CPU in addition to functions, operations, etc. associated with the memory system of a stacked memory package. For example, a single CPU, one or more cores of a multi-core CPU, etc. may perform the functions etc. of a system CPU in addition to performing functions such as macro operations, test, etc. of the memory system. For example, a system CPU may be any form, type, kind, number, etc. of processor that may include (but is not limited to) one or more of the following: network processor, programmable processor, configurable processor, stream processor, graphics processor, VLIW processor, vector processor, scalar processor, superscalar processor, SIMD processor, and/or any other processor type, architecture, etc. For example, one or more separate system components may include one or more CPUs etc. that may function as one or more system CPUs. For example, one or more separate system components (and that may possibly include one or more CPUs etc. that may function as one or more system CPUs) may be integrated, combined, included, assembled etc. with one or more stacked memory packages. Thus, it should be noted, that the architecture, design, etc. of a stacked memory package may be intended to be flexible in use. Thus a stacked memory package may be intended to be used with a wide variety of systems, systems architectures, CPU architectures, etc. Thus the applications of a stacked memory package may include, for example, systems that may include other components, system components (including CPUs, etc.), other components and the like etc. In such systems, for example, one or more such components etc. may be integrated with one or more stacked memory packages. Thus, for example, a reference to, description of, illustration of, etc. a separate CPU and/or separate component, system component, etc. may refer to logical, electrical and/or other form of abstract separation and may not necessarily imply a physical separation etc. Note though that a separate CPU etc. may be physically apart, separately located, in a separate package, etc. from a stacked memory package.

In the context of the following description, optional additional circuitry 18-104 (which may include one or more circuitries, components, blocks, functions, etc. each adapted, designed, intended, programmed, configured, etc. to carry out one or more of the features, capabilities, functions, behaviors, operations, etc. described herein) may or may not be included to cause, implement, etc. any of the optional architectures, features, capabilities, functions, etc. disclosed herein. While such additional circuitry 18-104 is shown generically in connection with the apparatus 18-100, it should be strongly noted that any such additional circuitry 18-104 may be positioned in, located in, distributed between, etc. (e.g. logically, electrically, and/or physically, etc.) any components (e.g. the first semiconductor platform 18-102, the second semiconductor platform 18-106, the device 18-108, an unillustrated logic unit or any other unit described herein, a separate unillustrated component that may or may not be stacked with any of the other components illustrated, a combination thereof, etc.).

In another embodiment, the additional circuitry 18-104 may or may not be capable of receiving (and/or sending) a data operation request and an associated field value. In the context of the present description, the data operation request may include a data write request, a data read request, a data processing request and/or any other request that involves data. Still yet the field value may include any value (e.g. one or more bits, protocol signal, any indicator, etc.) capable of being recognized in association with a field that is affiliated with memory class selection. In various embodiments, the field value may or may not be included with the data operation request and/or data associated with the data operation request. In response to the data operation request, at least one of a plurality of memory classes may be selected, based on the field value. In the context of the present description, such selection may include any operation or act that results in use of at least one particular memory class based on (e.g. dictated by, resulting from, etc.) the field value. In another embodiment, a data structure embodied on a non-transitory readable medium may be provided with a data operation request command structure including a field value that is operable to prompt selection of at least one of a plurality of memory classes, based on the field value. As an option, the foregoing data structure may or may not be employed in connection with the aforementioned additional circuitry 18-104 capable of receiving (and/or sending) the data operation request.

In yet another embodiment, any one or more of the components shown in the present figure may be individually and/or collectively operable to optimize a path between an input and an output thereof. In the context of the present description, the aforementioned path may include one or more non-transitory mediums (or portion thereof) by which anything (e.g. signal, data, command, etc.) is communicated from the input, to the output, and/or anywhere therebetween. Further, in one embodiment, the input and output may include pads of any one or more components (or combination of components) shown in the present figure.

In one embodiment, the path may include a command path. In another embodiment, the path may include a data path. For that matter, any type, number, form, structure, etc. of paths, circuits, components, blocks, functions, combinations of these and the like, etc. may be included. In one embodiment, for example, one or more paths may carry data, commands, signals, combinations of these and/or any other similar information and the like, etc.

Further, as mentioned earlier, any one or more components (or combination of components) may be operable to carry out the optimization. For instance, in one possible embodiment, the optimization may be carried out, at least in part, by the aforementioned logic circuit. In one embodiment, the optimization may be carried out by one or more logic circuits, components, blocks, functions, combinations of these, parts of these, and/or other similar circuits and the like, etc.

Still yet, in one embodiment, the optimization may be accomplished in association with at least one command. As an option, in some embodiments, the optimization may be in association with the at least one command by reordering, ordering, insertion, deletion, expansion, splitting, combining, and/or aggregation. As other options, in other embodiments, the optimization may be carried out in association with the at least one command by generating the at least one command from a received command, generating the at least one command in the form of at least one raw command, generating the at least one command in the form of at least one signal, and/or via a manipulation thereof. In the last-mentioned exemplary embodiment, the manipulation may be of command timing, execution timing, and/or any other manipulation, for that matter. In still other embodiments, the optimization may be carried out in association with the at least one command by optimizing a performance and/or a power.

In other embodiments, the aforementioned optimization may be accomplished in association with data. For example, in one possible embodiment, the optimization may be carried out in association with data utilizing at least one command for placing data in the first memory and/or the second memory.

In still other embodiments, the aforementioned optimization may be accomplished in association with at least one read operation using any desired technique (e.g. buffering, caching, etc.). In still yet other embodiments, the aforementioned optimization may be accomplished in association with at least one write operation, again, using any desired technique (e.g. buffering, caching, etc.).

In other embodiments, the aforementioned optimization may be performed by distributing a plurality of optimizations. For example, in different optional embodiments, a plurality of optimizations may be distributed between the first memory, the second memory, the at least one circuit, a memory controller and/or any other component(s) that is described herein.

As set forth earlier, any one or more of the foregoing optional architectures, capabilities, and/or features may or may not be used in combination with any other one or more of such optional architectures, capabilities, and/or features. Still yet, any one or more of the foregoing optional architectures, capabilities, and/or features may be implemented utilizing any desired apparatus, method, and program product (e.g. computer program product, etc.) embodied on a non-transitory readable medium (e.g. computer readable medium, etc.). Such program product may include software instructions, hardware instructions, embedded instructions, and/or any other instructions, and may be used in the context of any of the components (e.g. platforms, processing unit, MMU, VMM, TLB, etc.) disclosed herein, as well as semiconductor manufacturing/design equipment, as applicable.

Even still, while embodiments are described where any one or more of the foregoing optional architectures, capabilities, and/or features may or may not be incorporated into a memory system, additional embodiments are contemplated where a processing unit (e.g. CPU, system CPU, GPU, any other processors, any other processor units, microprocessors, processor functions, programmable processors, configurable processors, processor cores, similar processor functions, system components, other components and the like etc.) is provided in combination with or in isolation of the memory system, where such processing unit is operable to cooperate with such memory system to accommodate, cause, prompt and/or otherwise cooperate, coordinate, etc. with the memory system to allow for any of the foregoing optional architectures, capabilities, and/or features. For that matter, further embodiments are contemplated where a single semiconductor platform (e.g. 18-102, 18-106, etc.) is provided in combination with or in isolation of any of the other components disclosed herein, where such single semiconductor platform is operable to cooperate with such other components disclosed herein at some point in a manufacturing, assembly, OEM, distribution process, etc. to accommodate, cause, prompt and/or otherwise cooperate with one or more of the other components to allow for any of the foregoing optional architectures, capabilities, and/or features. To this end, any description herein of receiving, processing, operating on, reacting to, etc. signals, data, etc. may easily be replaced and/or supplemented with descriptions of sending, prompting/causing, etc. signals, data, etc. to address any desired cause and/or effect relationship among the various components disclosed herein.

It should be noted that while the embodiments described in this specification and in specifications incorporated by reference may show examples of stacked memory system and improvements to stacked memory systems, the examples described and the improvements described may be generally applicable to a wide range of memory systems and/or electrical systems and/or electronic systems. For example, improvements to signaling, yield, bus structures, test, repair etc. may be applied to the field of memory systems in general as well as systems other than memory systems, etc. Furthermore, it should be noted that the embodiments/technology/functionality described herein are not limited to being implemented in the context of stacked memory packages. For example, in one embodiment, the embodiments/technology/functionality described herein may be implemented in the context of non-stacked systems, non-stacked memory systems, etc. For example, in one embodiment, memory chips and/or other components may be physically grouped together using one or more assemblies and/or assembly techniques other than stacking. For example, in one embodiment, memory chips and/or other components may be electrically coupled using techniques other than stacking. Any technique that groups together (e.g. electrically and/or physically, etc.) one or more memory components and/or other components may be used.

In one optional embodiment, the apparatus may be operable for determining at least one timing associated with a refresh operation independent of a separate processor. In one embodiment, the separate processor may include a central processing unit, a general processor, a graphics processor, and/or any other processor separate from a package including the components of the apparatus. Of course, other embodiments are contemplated where the separate processor may be housed within the foregoing package, but yet separate from the first and/or second semiconductor platform, etc.

One option in connection with the present embodiment may involve the apparatus being operable for determining the at least one timing associated with the refresh operation independent of the separate processor such that the separate processor is unaware of the at least one timing. As another option, the at least one timing may be determined in an independent manner such that it is determined autonomously.

As yet another option, the apparatus may be operable such that the at least one aspect of the refresh operation may be initialized by the separate processor, after which the apparatus may be operable for determining the at least one timing associated with the refresh operation independent of the separate processor.

Even still, at least one aspect of the at least one timing associated with the refresh operation may be adjusted. For example, the apparatus may be operable such that the adjustment is a function of a prediction of a memory access. In another example, the adjustment may be a function of one or more internal commands. In yet another example, the adjustment may be a function of one or more external commands. As another example, the one or more external commands may include at least one of a read command or a write command. In still yet another example, the adjustment may be a function of one or more external commands associated with at least one of a virtual channel, a traffic class, or a memory class. Still yet, in the context of another example, the adjustment may involve at least one of an interruption, a re-scheduling, or a postponement in connection with the refresh operation.

In another embodiment, the apparatus may be operable for receiving a read command or write command. Still yet, one or more faulty components of the apparatus may be identified. In response to the identification of the one or more faulty components of the apparatus, at least one timing may be adjusted in connection with the read command or write command.

In such embodiment, the apparatus may be optionally operable for repairing the one or more faulty components of the apparatus. For example, the repairing may be adjusted in response to a command. As yet another example, the command may include the read command or the write command.

As yet additional exemplary options, the one or more faulty components may include at least one circuit, at least one through silicon via, a part of a memory array, and/or any other component, for that matter.

In yet another embodiment, the apparatus may be operable for receiving a first external command. In response to the first external command, a plurality of internal commands may be executed.

As an option, the apparatus may be operable such that the plurality of internal commands may include the first external command. Still yet, the plurality of internal commands may provide transaction processing that is at least one of atomic, consistent, isolated, or durable.

In still yet another embodiment, the apparatus may be operable for controlling access to at least a portion thereof. As an option, the controlling access may include locking. Further, the access may be controlled utilizing one or more special commands. As yet another option, the access may involve at least one of: at least one memory address, at least one memory address range, at least one region, at least one part, or at least one portion of the apparatus.

Still yet, the access may involve at least one of: at least one logic chip, the first semiconductor platform, or the second semiconductor platform.

In even still yet another embodiment, the apparatus may be operable for supporting one or more compound commands. As an option, the one or more compound commands may include one or more multi-part commands, one or more multi-command commands, one or more external commands, and/or any compound command, for that matter.

Optionally, the one or more external commands may be capable of being expanded to one or more internal commands. Further, the one or more internal commands may include one or more instructions to perform one or more logical operations or one or more arithmetic operations. As yet another option, the one or more internal commands may include one or more instructions to perform an operation that compares a plurality of operands. Still yet, the one or more internal commands may include one or more instructions to perform an operation that increments an operand. Even still, the one or more internal commands includes one or more instructions to perform an operation that adds a plurality of operands.

In still yet event another embodiment, the apparatus may be operable for accelerating at least one command. As an option in the context of the present embodiment, the at least one command may include a read request or a write request. Further, the apparatus may be operable such that the at least one command is accelerated by retiring the at least one command before the at least one command would otherwise be executed. Still yet, the retiring may include at least one of completing, satisfying, signaling a request as completed, generating a response, making a write commitment, executing, or queuing.

In other embodiment, the apparatus may be operable for utilizing a first data protection code for an internal command, and utilizing a second data protection code for an external command. In another embodiment, the apparatus may be operable for utilizing a first data protection code for a packet of a first type, and utilizing a second data protection code for a packet of a second type. In other embodiments, the apparatus may be operable for utilizing a first data protection code for a first part of a command, and utilizing a second data protection code for a second part of the command.

As an option in the context of any of the foregoing embodiments, the first data protection code and the second data protection code may include cyclic redundancy check codes. Further, the first data protection code and the second data protection code may include different types of codes. Even still, the first data protection code and the second data protection code may include different types of codes including at least one of a cyclic redundancy check code, a checksum, or a hash value.

More illustrative information will now be set forth regarding various optional architectures, capabilities, and/or features with which the foregoing techniques discussed in the context of any of the Figure(s) may or may not be implemented, per the desires of the user. For instance, various optional examples and/or options associated with the configuration/operation of the apparatus 18-100, the configuration/operation of the first and/or second semiconductor platforms, and/or other optional features (e.g. determining at least one timing associated with a refresh operation independent of a separate processor, etc.) have been and will be set forth in the context of a variety of possible embodiments. It should be strongly noted that such information is set forth for illustrative purposes and should not be construed as limiting in any manner. Any of such features may be optionally incorporated with or without the inclusion of other features described.

It should be noted that any embodiment disclosed herein may or may not incorporate, at least in part, various standard features of conventional architectures, as desired. Thus, any discussion of such conventional architectures and/or standard features herein should not be interpreted as an intention to exclude such architectures and/or features from various embodiments disclosed herein, but rather as a disclosure thereof as exemplary optional embodiments with features, operations, functionality, parts, etc. which may or may not be incorporated in the various embodiments disclosed herein.

FIG. 18-2

FIG. 18-2 shows a memory system 18-200 with multiple stacked memory packages, in accordance with one embodiment. As an option, the system may be implemented in the context of the architecture and environment of the previous figure or any subsequent Figure(s). Of course, however, the system may be implemented in any desired environment.

For example, as an option, the memory system 18-200 with multiple stacked memory packages may be implemented in the context of the architecture and environment of FIG. 18-1 or any subsequent Figure(s). For example the system of FIG. 18-2 may be implemented in the context of FIG. 1B of U.S. Provisional Application No. 61/569,107, filed Dec. 9, 2011, titled “SYSTEM, METHOD, AND COMPUTER PROGRAM PRODUCT FOR IMPROVING MEMORY SYSTEMS,” which is hereby incorporated by reference in its entirety for all purposes. For example, the system of FIG. 18-2 and/or any other similar system, architectures, designs, etc. may be implemented in the context of one or more applications incorporated by reference. For example, one or more chips included in the system of FIG. 18-2 (e.g. memory chips, logic chips, etc.) may be implemented in the context of one or more designs, architectures, datapaths, circuits, structures, systems, etc. described herein and/or in one or more applications incorporated by reference. For example, one or more buses, signaling schemes, bus protocols, interconnect, and/or any other similar interconnection, coupling, etc. techniques, etc. included in the system of FIG. 18-2 (e.g. between memory chips, between logic chips, on-chip interconnect, system interconnect, between system CPU and stacked memory packages, between any memory system components, etc.) may be implemented in the context of one or more designs, architectures, circuits, structures, systems, bus systems, interconnect systems, connection techniques, combinations of these and/or any other coupling techniques, etc. described herein and/or in one or more applications incorporated by reference. Of course, however, the system may be implemented in any desired environment.

In FIG. 18-2, in one embodiment, the CPU 18-232 (e.g. system CPU, etc.) may be coupled to one or more stacked memory packages 18-230 using one or more memory buses 18-234.

In one embodiment, a single CPU may be coupled to a single stacked memory package. In one embodiment, one or more CPUs (e.g. multicore CPU, one or more CPU die, combinations of these and/or any other forms of processing units, processing functions, etc.) may be coupled to a single stacked memory package. In one embodiment, one or more CPUs may be coupled to one or more stacked memory packages. In one embodiment, one or more stacked memory packages may be coupled together in a memory subsystem network. In one embodiment, any type of integrated circuit or similar (e.g. FPGA, ASSP, ASIC, CPU, GPU, parts of these, combinations of these and/or any other die, chip, wafer, integrated circuit and the like, etc.) may be coupled to one or more stacked memory packages. In one embodiment, any number, type, form, structure, etc. of integrated circuits etc. may be coupled to any type, any number, any form, of stacked memory packages and/or any parts, portions, etc. of such stacked memory packages. In one embodiment, a system CPU may be shared with a stacked memory package and may perform one or more functions, operations, behaviors, etc. associated with the memory. For example, in one embodiment, a shared CPU, shared cores, etc. may perform all and/or part of one or more test functions, repair operations, and the like etc.

In one embodiment, the memory packages may include one or more stacked chips. In FIG. 18-2, for example, in one embodiment, a stacked memory package may include stacked chips: 18-202, 18-204, 18-206, 18-208. In FIG. 18-2, for example, stacked chips: 18-202, 18-204, 18-206, 18-208 may be chip 1, chip 2, chip 3, chip 4. In FIG. 18-2, for example, in one embodiment, one or more of chip 1, chip 2, chip 3, chip 4 may be a memory chip (e.g. stacked memory chip, etc.). In one embodiment, any number, type, form, kind, hierarchy, nesting, and/or other arrangement etc. of stacked chips, stacked memory chips, etc. may be used. In FIG. 18-2, for example, in one embodiment, one or more of chip 1, chip 2, chip 3, chip 4 may be a logic chip (e.g. stacked logic chip, etc.).

In FIG. 18-2, in one embodiment, a stacked memory package may include a chip at the bottom of the stack: 18-210. In FIG. 18-2, for example stacked chip 18-210 may be chip 0. In FIG. 18-2, in one embodiment, chip 0 may be a logic chip. In one embodiment, any number, type, form, etc. of logic chips, stacked logic chips, etc. may be used.

In FIG. 18-2, in one embodiment, for example, one or more logic chips or parts, portions, etc. of one or more logic chips may be implemented in the context of logic chips described herein and/or in one or more applications incorporated by reference. In FIG. 18-2, in one embodiment, one or more logic chips may act to buffer, relay, transmit, etc. one or more signals etc. from the CPU and/or any other components in the memory system. In FIG. 18-2, in one embodiment, one or more logic chips may act to transform, receive, transmit, create, delete, re-time, shuffle, re-order, check, filter, queue, prioritize, alter, modify, encapsulate, parse, interpret, packetize, etc. one or more signals, packets, commands, requests, instructions, messages, and/or any other data, information, etc. from the CPUs, system components, and/or any other components in the memory system. In FIG. 18-2, in one embodiment, one or more logic chips may perform any functions, operations, transformations, commands, modifications, alterations, changes, etc. on one or more signals etc. from one or more system components (e.g. CPUs, any other stacked memory packages, I/O components, combinations of these and/or any other system components, etc.).

In one embodiment, for example, the logic chip may be part of another chip, system component, other component, etc and/or distributed between, part of, etc. one or more chips, system components, other components, etc. For example, in one embodiment, the chip positioned at the bottom of a stacked memory package (or at any location, position, etc.) may be a CPU or include one or more CPUs etc. and also may include one or more functions, circuits, blocks, components, etc. that may perform functions, operations, behaviors, etc. included in, associated with, corresponding to, belonging to, etc. a logic chip, part or portions of a logic chip, etc. Thus, it should be noted that reference to a logic chip, logic chip functions, etc. herein and/or in one or more specifications incorporated by reference may include reference to any chip, part of one or more chips, functions on one or more chips etc. For example, reference to a logic chip etc. may include reference to one or more chips, circuits, functions, blocks, parts or portions of these, combinations of these, etc. that may be included on any chips, components, and/or similar structures and the like, etc. For example, in one embodiment, a logic chip, logic chip functions etc. may be distributed, partitioned, apportioned, etc. between one or more chips, components, blocks, parts or portions of these, and/or any other similar structures, objects and the like, etc. For example, in one embodiment, a logic chip, logic chip functions etc. may be distributed, partitioned, apportioned, etc. between one or more CPUs, processors, cores, parts or portions of these, etc. and/or included within, part of, performed by, executed by, etc. one or more CPUs (possibly including part of one or more system CPUs, and/or other system components, etc.), etc. Of course any number, type, form, kind, structure, arrangement, architecture, distribution, partitioning, construction, connection, interconnection, positioning, implementation, execution, performance, etc. of logic chips, logic chip functions, logic chip operations, logic chip behaviors, and the like etc. may be used, employed, effected, etc.

In one embodiment, for example, depending on the packaging details, assembly, the orientation of chips in the package, positioning of chips in the package, and/or any other similar details and the like etc. the chip at the bottom of the stack in FIG. 18-2 may not be at the bottom of the stack when the package is mounted, assembled, connected, viewed, drawn, illustrated, etc. Thus, it should be noted that physical and/or figurative terms such as bottom, top, middle, etc. may be used with respect to (e.g. with reference to, etc.) diagrams, figures, drawings, etc. and not necessarily applied to a finished product, assembled systems, connected packages, and the like etc. In one embodiment, for example, the logical and/or electrical arrangement, connection, coupling, interconnection, etc. and/or logical placement, logical arrangement, etc. of one or more chips, die, circuits, packages, any other components, assemblies, structures, etc. may be different, modified, altered, etc. from the physical structures, physical assemblies, physical arrangements, physical placements, etc. of the one or more chips etc. Similarly, in one embodiment, the electrical arrangement, connection, coupling, interconnection, etc. and/or electrical placement, electrical arrangement, etc. of one or more chips, die, circuits, packages, any other components, assemblies, structures, etc. may be different, modified, altered, etc. from the physical structures, physical assemblies, physical arrangements, physical placements, etc. of the one or more chips etc. Thus, for example, the electrical arrangement etc. of a design may be the same, similar, etc. to that shown even though the physical arrangement etc. may be different, appear to be different, etc.

In one embodiment, for example, depending on the packaging details, system constraints, system functions, and/or any other considerations and the like (e.g. for system, package, assembly, manufacture, performance, power, cost, yield, etc.), the mechanical, physical, electrical, and/or one or more other aspects of a stack, a stacked memory package, packages, chips, and/or any other components, parts, portions, pieces, assemblies, sub-assemblies, and the like may be different, modified, altered, etc. from that shown and/or described herein and/or as described in one or more specifications incorporated by reference. For example, in one embodiment, an electrical, logical, etc. construction, design, architecture, etc. may be the same, similar, etc. to that shown but one or more mechanical, physical, etc. aspects may be different from that shown and/or described, etc. For example, in one embodiment, the physical, mechanical, etc. construction, structure, appearance, etc. may be the same, similar, etc. to that shown but one or more electrical, logical, connection, interconnection, coupling etc. aspects may be different from that shown, etc. For example, in one embodiment, one or more electrical, logical, connection, interconnection, coupling, physical, mechanical, etc. aspects, constructions, behaviors, functions, and the like etc. may be the same, similar, etc. to that shown and/or described, but one or more other aspects may be different, slightly different, modified, altered, changed, in a different configuration, etc. from that shown, described, etc.

In one embodiment, the chip at the bottom of the stack (e.g. chip 18-210 in FIG. 18-2) may be considered part of the stack. In this case, for example, the system of FIG. 18-2 may be considered to include five stacked chips. In one embodiment, the chip at the bottom of the stack (e.g. chip 18-210 in FIG. 18-2) may not be considered part of the stack. In this case, for example, the system of FIG. 18-2 may be considered to include four stacked chips. For example, in one embodiment, one or more chips etc. may be coupled using TSVs and/or TSV arrays and/or any other stacking, connection, joining, coupling, interconnect techniques, combinations of these and the like, etc. For example, in one embodiment, TSVs and/or any other coupling techniques may be used together with, in conjunction with, etc. one or more substrates, interposers, platforms, and the like etc. For example, in one embodiment, the chip, die, circuit, etc. at the bottom of a stack may not include TSVs, TSV arrays, etc. while the chips, dies, etc. in the rest of the stack may include such interconnect technology, etc. For example, in this case, one or more assembly steps, manufacturing steps, and/or any other processing steps etc. that may be regarded as part of the stacking process, etc. may not be applied (or may not be applied in the same way, may be applied in a different way, etc.) to the chip, die, etc. at the bottom of the stack as they are applied to the other chips, dies, etc. in the stack, etc. Thus, for this reason, in this case, the chip at the bottom of a stack, for example, may be regarded as different, unique, special, etc. in the use of interconnect technology etc. and thus, in some cases, may be regarded, viewed, considered, etc. as part of the stack or may not be regarded etc. as part of the stack.

In one embodiment, one or more of the stacked chips may be a stacked memory chip. In one embodiment, any number, type, technology, form, architecture, structure, etc. of stacked memory chips may be used. In one embodiment, the stacked memory chips may be of the same type, technology, etc. In one embodiment, the stacked memory chips may be of different types, memory types, memory technologies, sizes, capacity, etc. In one embodiment, one or more of the stacked memory chips may include more than one type of memory, more than one memory technology, etc. In one embodiment, one or more of the stacked chips may include a logic chip, part of a logic chip, etc. In one embodiment, one or more of the stacked chips may include a combination of a logic chip, part of a logic chip, etc. and a memory chip. In one embodiment, one or more of the stacked chips may include a combination of a logic chip and a CPU chip. In one embodiment, one or more of the stacked chips may include any combination, parts, portions, etc. of any number, type, form, structure, etc. of logic chips, memory chips, CPUs and/or any other similar functions, circuits, and the like etc.

In one embodiment, a stacked memory package may include more than one stack. For example, in one embodiment, a stacked memory package may include four stacks with each stack including four memory chips. Stacks may be homogeneous (all of the same memory type, technology, etc.). Stacks may be heterogeneous (e.g. including chips of different types, technology, size, etc.). Of course, any number, type, form, kind, arrangement, structure, architecture, design, etc. of stacks with any number, type, form, kind, etc. of stacked memory chips may be used.

In one embodiment, for example, one or more CPUs, one or more chips (e.g. dies, etc.), combinations of these and/or parts, portions, etc. of these including, containing, etc. one or more CPUs (e.g. multicore CPUs, etc.), parts of CPUs, etc. may be integrated (e.g. packaged with, stacked with, assembled with, connected to, coupled to, interconnected with, etc.) with one or more memory packages, module, assemblies, etc. In one embodiment, one or more of the stacked etc. chips may be a CPU chip (e.g. include one or more CPUs, multicore CPUs, etc.), part of a CPU, etc. In one embodiment, the CPU chips, dies including etc. CPUs, logic chips including etc. CPUs, CPU parts, etc. may be connected, coupled, interconnected, joined, etc. to one or more memory chips using a wide I/O connection and/or similar bus techniques. For example, in one embodiment, data etc. may be transferred between one or more memory chips and one or more other dies, chips, etc. including etc. logic, CPUs, etc. using buses that may be 512 bits, 1024 bits, 2048 bits or any number of bits in width, etc.

In one embodiment, for example, a first set of one or more CPU chips, dies, etc. may include a matrix, group, and/or other arrangement, collection, set, etc. of CPUs; and a second set of one or more memory chips etc. may include a matrix etc. of memory circuits. In one embodiment, the CPU chips etc. containing, including, etc. CPUs; and memory chips etc. including memory etc. may be connected etc. using a wide I/O connection, TSV arrays, and/or similar bus and/or interconnection techniques. In one embodiment, for example, the functions associated with one or more logic chips etc. may be integrated, included, distributed between, etc. the one or more CPU chips and/or one or more memory chips. In one embodiment, for example, one or more logic chips etc. may be connected etc. to the one or more CPU chips and/or one or more memory chips. Of course, any number, type, form, kind, arrangement, structure, architecture, design, etc. of stacks with any number, type, form, kind, etc. of stacked memory chips, CPU chips, and/or logic chips may be used. Of course, the CPU chips, dies, etc. may also be physically separate from the stacked memory package, stacked memory chips and/or logic chips.

In FIG. 18-2, in one embodiment, one or more stacked chips may contain, include, etc. parts, portions, etc. In FIG. 18-2, in one embodiment, stacked chips may contain, include, etc. parts: 18-242, 18-244, 18-246, 18-249, 18-250. For example, in one embodiment, chip 1 may be a memory chip and may contain, include, etc. one or more parts, portions, regions, partitions, etc. of memory. For example, in one embodiment, chip 0 may be a logic chip and may contain, include, etc. one or more parts, portions, regions, partitions, etc. of a logic chip. In one embodiment, for example, one or more parts etc. of one or more memory chips may be grouped and/or otherwise associated etc. In FIG. 18-2, in one embodiment, for example, parts of chip 1, chip 2, chip 3, chip 4 may be parts of memory chips that may be grouped together to form a set, collection, group, region, partition, etc. For example, in one embodiment, the group etc. may be (or may be part of, may correspond to, may be designed as, may be architected as, may be logically accessed as, may be structured as, etc.) an echelon (as defined herein and/or in one or more application incorporated by reference). For example, in one embodiment the group etc. may be a section (as defined herein and/or in one or more application incorporated by reference). For example, in one embodiment the group etc. may be a rank, bank, echelon, section, combinations of these and/or any other logical and/or physical grouping, aggregation, collection, partitioning, etc. of memory parts, portions, regions, partitions, etc.

As used herein a memory echelon may be used to represent (e.g. denote, may be defined as, etc.) a grouping of memory circuits (or grouping of memory regions, memory grouping, etc.). Other terms (e.g. bank, rank, etc.) may be avoided for such a grouping because of possible confusion. In addition terms that may describe memory region groupings such as bank, rank, etc. may be avoided in some examples, descriptions, figures, etc. because of possible confusion. Thus it should be noted that examples, descriptions, figures etc. that may use an echelon as an example of memory grouping may also apply to any other memory groups (e.g. including, but not limited to, groups such as banks, ranks, and/or any other groups, nested groups, and the like etc.). A memory echelon may correspond to a bank or rank (e.g. SDRAM bank, SDRAM rank, etc.), combinations of these, combinations of parts of these, combinations of groups of these, and/or any other memory grouping, logical grouping, physical grouping, abstract grouping and the like etc. A memory echelon may correspond to a bank or rank, but need not (and typically does not, and in general does not). Typically a memory echelon may be composed of portions on different memory die and may span all the memory die in a stacked package, but need not. For example, in an 8-die stack, one memory echelon (ME1) may comprise, include, etc. portions in dies 1-4 and another memory echelon (ME2) may comprise etc. portions in dies 5-8. Or, for example, one memory echelon (ME1) may comprise etc. portions in dies 1, 3, 5, 7 (e.g. die 1 is on the bottom of the stack, die 8 is the top of the stack, etc.) and another memory echelon ME2 may comprise etc. portions in dies 2, 4, 6, 8, etc. In general a memory echelon may include any number, type, form, kind, arrangement, grouping, collection, etc. of memory circuits and/or associated logic circuits, support circuits, etc. In general there may be any number of memory echelons and/or any arrangement of memory echelons in a stacked die package (including fractions, parts, portions, etc. of an echelon, where an echelon may span more than one memory package for example).

The term partition has recently come to be used to describe a group of banks typically on one stacked memory chip. This specification and/or one or more specifications incorporated by reference may avoid the use of the term partition in this sense because there is no consensus on the definition of the term partition, and/or there may be no consistent use of the term partition, and/or there is conflicting use of the term partition in current use. For example, there may be no consistent definition of how the banks in a partition may be related and/or there may be conflicting current use of the term banks in connection with a partition.

The term vault has recently come to be used to describe a group of partitions, but may also sometimes used to describe the combination of partitions with some of a logic chip (or base logic, etc.). This specification and/or one or more specifications incorporated by reference may avoid the use of the term vault in this sense because there may be no consensus on the definition of the term vault, and/or there may be no consistent use of the term vault, and/or there may be conflicting use of the term vault in current use.

The term slice and/or the term vertical slice has recently come to be used to describe a group of banks (e.g. a group of partitions for example, with the term partition used as described above). Some of the specifications incorporated by reference may use the term slice in a similar, but not necessarily identical, manner. Thus, to avoid any confusion over the use of the term slice, this specification and/or one or more specifications incorporated by reference may use the term section to describe a group of portions (e.g. arrays, subarrays, banks, any other portions(s), etc.) that are grouped together logically (possibly also electrically and/or physically), possibly on the same stacked memory chip, and that may form part of a larger group across multiple stacked memory chips for example. Thus, for example, the term section may include a slice (e.g. a section may be a slice, etc.) as the term slice may be previously used in one or more specifications incorporated by reference. The term slice previously used in one or more specifications incorporated by reference may be equivalent to the term partition in current use (and used as described above, but recognizing, realizing, etc. that the term partition may not be consistently defined, consistently used, etc.).

In one embodiment, for example, one or more parts of one or more memory chips may be grouped, logically grouped, collected, etc. together with one or more parts of one or more logic chips. In one embodiment, for example, chip 0 may be a logic chip and chip 1, chip 2, chip 3, chip 4 may be memory chips. In this case, part of chip 0 may be logically grouped etc. with parts of chip 1, chip 2, chip 3, chip 4. In one embodiment, for example, any grouping, aggregation, collection, etc. of one or more parts of any number, type, form, etc. of logic chips may be made with any grouping, aggregation, collection, etc. of any number, type, form, etc. of memory chips. In one embodiment, for example, any grouping, aggregation, collection, etc. (e.g. logical grouping, physical grouping, collection, combinations of these and/or any type, form, etc. of grouping etc.) of one or more parts (e.g. portions, groups of portions, etc.) of one or more chips (e.g. logic chips, memory chips, combinations of these and/or any other circuits, chips, die, integrated circuits and the like, etc.) may be made.

For example, in FIG. 18-2, part 18-242 of chip 0 may be logically grouped, associated with, connected to, coupled to, communicate with, etc. one or more parts of one or more stacked memory chips. For example, in one embodiment, part 18-242 of chip 0 may be logically grouped etc. with parts 18-244, 18-246, 18-248, 18-250. In this case, for example, in one embodiment, parts 18-244, 18-246, 18-248, 18-250 may be considered an echelon. In one embodiment, part 18-242 of chip 0 may include one or more circuits, components, functions, blocks, etc. that may be considered logically part of one or more echelons (or any other memory circuit collection, set, grouping, partitioning, etc.). In this case, for example, it may also be considered that all or a portion etc. of part 18-242 of chip 0 may be considered part of one or more echelons etc. that may be formed by parts 18-244, 18-246, 18-248, 18-250, etc.

For example, in FIG. 18-2, in one embodiment, part 18-242 of chip 0 may include all or part of one or more memory controllers that may be logically grouped etc. with one or more memory portions etc. For example, in one embodiment, one or more memory controllers may be logically grouped with, associated with, coupled to, connected to, correspond to, etc. one or more echelons (and/or any similar grouping, partitioning, portions, sets, collections, etc. of memory circuits etc.). For example, in one embodiment, the connections, coupling, etc. of one or more memory controllers to one or more memory portions etc. may be configurable, programmable, etc. For example, in one embodiment, the connections, coupling, etc. of one or more memory controllers to one or more memory portions etc. may be made, designed, architected, etc. to use, employ, etc. one or more configurable connection circuits (e.g. switches, switch matrix, MUXes, combinations of these and/or any other programmable, configurable connection circuits, functions, and the like, etc.).

As an option, for example, the parts of one or more stacked memory chips and/or the parts of one or more logic chips (as shown, for example, in FIG. 18-2) may be implemented in the context of FIGS. 1B, 2, 3, 4, 5, 6, 7, 8, 9, 11 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” which is hereby incorporated by reference in its entirety for all purposes. For example, one or more echelons may be grouped to form one or more super-echelons, as may be shown, for example, in FIG. 5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text. For example, in FIG. 18-2, in one embodiment, parts 18-244, 18-246 may form echelon E1; parts 18-248, 18-250 may for echelon E2; echelons E1 and E2 may for super-echelon SE1, etc. Of course any hierarchical arrangement(s), groups of groups, combinations of groups, sets, portions, partitions, and/or any other similar arrangements and the like etc. may be used.

As an option, for example, the parts of one or more stacked memory chips and/or the parts of one or more logic chips of FIG. 18-2 may be implemented in the context of one or more other Figures that may include one or more components, circuits, functions, behaviors, architectures, etc. associated with, corresponding to, etc. stacked memory packages that may be included in one or more other applications incorporated by reference. Of course, however, the parts of one or more stacked memory chips and/or the parts of one or more logic chips of FIG. 18-2 may be implemented in any desired environment.

As an option, for example, note that the parts of one or more stacked memory chips and/or the parts of one or more logic chips of FIG. 18-2 may be regarded, viewed logically etc. in a different manner, form, composition, grouping, etc. than the physical construction, implementation, connection, coupling, etc. For example, in one embodiment, one or more stacked memory chips may include one or more spare portions. For example, in FIG. 18-2, in one embodiment, the four parts 18-244, 18-246, 18-248, 18-250 may be viewed logically as four separate (e.g. individual, independent, etc.) logical parts. For example, in FIG. 18-2, in one embodiment, the four parts 18-244, 18-246, 18-248, 18-250 may be implemented as five physical parts with one part being operable to act, function, etc. as a spare. Thus, for example, in one embodiment, a logical view of an echelon that may include four parts 18-244, 18-246, 18-248, 18-250 may also have a physical view that may include five parts (with one spare part). For example, in one embodiment, a physical view may be implemented in the context of FIG. 18-1B of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, in one embodiment, a logical view may be implemented in the context of FIG. 18-1C of U.S. application Ser. No. 13/710,411, filed Dec. 10, 2012, titled “SYSTEM, METHOD, AND COMPUTER PROGRAM PRODUCT FOR IMPROVING MEMORY SYSTEMS”.

As an option, for example, note that the parts of one or more stacked memory chips and/or the parts of one or more logic chips of FIG. 18-2 may be viewed using an abstract view in a different manner, fashion, etc. than the logical view etc. and/or the physical view etc. For example, in one embodiment, an abstract view may be implemented in the context of FIG. 18-1D of U.S. application Ser. No. 13/710,411, filed Dec. 10, 2012, titled “SYSTEM, METHOD, AND COMPUTER PROGRAM PRODUCT FOR IMPROVING MEMORY SYSTEMS”.

Memory Controllers

In one embodiment of a stacked memory package, for example, with reference to FIG. 18-2, memory chip 1 may include four copies of part 18-244; memory chip 2 may include four copies of part 18-246; memory chip 3 may include four copies of part 18-248; memory chip 4 may include four copies of part 18-250. For example, in FIG. 18-2, in one embodiment, logic chip 0 may include four copies of part 18-242. In one embodiment, the memory package may thus include four memory echelons (e.g. E1, E2, E3, E4) with four memory controllers (e.g. M1, M2, M3, M4), with, for example, echelon E1 including parts 18-244, 18-246, 18-248, 18-250 and possibly all or part of part 18-242. Of course any number, type, form, structure of parts, portions, partitions, arrangements, etc. of memory chips, memory circuits, etc. may be used in any combination with any number, type, form, kind, parts, portions, etc. of memory controllers and/or any other similar circuits, blocks, functions and the like etc.

In this case, for example, in one embodiment, the four memory controllers (e.g. M1, M2, M3, M4) may operate independently, or relatively independently, of one another. For example, each memory controller may execute, process, perform, etc. instructions, commands, requests in a parallel, simultaneous, nearly simultaneous, pipelined, etc. manner. In this case, for example, in one embodiment, there may be one memory controller per memory region, area, class, etc. In this case, for example, in one embodiment, there may be one memory controller per echelon. In one embodiment, one or more memory controllers may be shared between one or more echelons and/or other memory areas, regions, address ranges, memory classes, etc. In one embodiment, there may be one or more memory controller per echelon etc. In one embodiment, any number, type, form, configuration, arrangement, connection, coupling, etc. of memory controllers may be used in combination with any, number, type, arrangement, configuration, connection, coupling, etc. of memory controllers. In one embodiment, for example, one or more memory controllers may be coupled, connected, linked, etc. In one embodiment, for example, one or more memory controllers may be shared, apportioned, multiplexed, time-shared, etc. between one or more memory circuits, groups of memory circuits, memory areas, memory regions, address ranges, memory class, and/or any other parts, portions, partitions, etc. of memory and the like etc.

In the above case, for example, in one embodiment, the four memory controllers (e.g. M1, M2, M3, M4) may operate in a collaborative, cooperating, communicating, etc. fashion, manner, etc. with one another, in conjunction and/or in any like manner, fashion, etc. In this case, for example, in one embodiment, one or more cooperating memory controllers may also collaborate etc. with one or more other circuits, functions, components, etc. In this case, for example, in one embodiment, the collaboration etc. of the one or more cooperating memory controllers may be implemented, or partially implemented, using communication with one or more other circuits, blocks, functions, components, etc. Similarly, one or more parts of one or more memory chips may act in a collaborative, cooperative, coupled, etc. fashion with/without associated memory controllers.

In this case, for example, in one embodiment, the four memory controllers (e.g. M1, M2, M3, M4) and/or any other circuits, functions, blocks, chips, combinations and/or parts of these etc. may collaborate with one another to perform one or more functions. For example, in one embodiment, such functions may include (but are not limited to) one or more of the following: checkpointing of data, mirroring data from one part of a memory system to another, duplicating data, copying data, moving data, processing data, changing data, checking data, parsing data, searching data, replicating data, manipulating data, combinations of these and/or any other similar functions and the like, etc. For example, a checkpoint system, function, etc. may be implemented in the context of FIG. 7 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. Of course memory controllers may be architected, designed, connected, coupled, programmed, configured, etc. to collaborate, communicate, cooperate etc. in any manner, fashion, etc. for any purpose, function, etc.

For example, in one embodiment, a memory controller may act to manipulate data in more than one echelon etc. For example, in one embodiment, a memory controller may be instructed to write data to more than one echelon etc. For example, in one embodiment, a memory controller may read, write, manipulate, modify, change, search, parse, and/or otherwise process, alter, etc. data in one or more parts, portions, etc. of memory in order to perform copy functions, checkpoint functions, duplication functions, atomic operations, data processing functions, combinations of these and any other similar functions, operations, algorithms, processes, and the like, etc. Further, in one embodiment, one or more memory controllers may collaborate, cooperate, etc. to perform such data manipulation, etc. Of course such data manipulation etc. may be performed at any level of partitioning, at any level of hierarchy, at any granularity, etc. of the memory system, etc. and in any manner, fashion, etc. Thus, for example, data included in a bank, rank, row, column, cell, cache line, echelon, section, combinations and/or parts of these and/or any other grouping, collection, set, etc. of memory cells etc. may be manipulated in any fashion, manner, etc. In one embodiment, the manipulation, processing, etc. functions, operations, etc. of one or more memory controllers and associated one or more parts, portions, etc. of one or more memory chips may be programmable, configurable, operable to be modified, etc. Such programming etc. may be performed etc. at any time and/or in any manner, context, fashion, etc.

Further, in one embodiment, the coupling, communication, association, linking, collaboration, independence, cooperation, etc. functions of one or more memory controllers and associated one or more parts, portions, etc. of one or more memory chips may be configurable, programmable, operable to be modified, etc. Any configuration, programming, etc. of one or more functions, behaviors, operations, capabilities, collaborative functions, collaborative behavior, etc. etc. of memory controllers and associated one or more parts, portions, etc. of one or more memory chips may be performed in any manner, fashion, etc, and/or at any time (e.g. manufacture, design, test, assembly, start-up, boot time, during operation, combinations of these times and/or at any times).

Refresh

Further, in one embodiment of a stacked memory package, such collaborative etc. functions, behavior, etc. as described above, elsewhere herein and/or in one or more specifications incorporated by reference may include functions other than data manipulation. For example, in one embodiment of a stacked memory package, such collaborative etc. functions, behavior, etc. may include refresh, refresh operations, actions, functions, etc. associated with refresh, refresh behavior, refresh timing, refresh functions, refresh actions, and/or any other aspect of refresh and the like etc. For example, a refresh system, function, etc. may be implemented in the context of FIG. 20-19 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, a refresh system, function, etc. may be implemented in the context of FIG. 29-2 and/or any other figures of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or in the context of the text description that is associated with FIG. 29-2 (including, but not limited to, for example, the description of collaborative, coordinated, cooperative, etc. refresh operations, etc.) and/or in the context of the text description that is associated with any other figures.

Further, in one embodiment of a stacked memory package, such collaborative etc. functions, behavior, etc. may include any functions, behavior, operations and the like, etc. For example, in one embodiment of a stacked memory package, collaboration etc. between one or more memory controllers and/or other logic etc. may be performed (e.g. executed, made, implemented, etc.) by any type, form, kind, manner, fashion, etc. of communication (e.g. coupling of signals, exchange of information, etc.). For example, in one embodiment, collaboration etc. between one or more memory controllers to perform refresh operations may be enabled by communication with one or more central refresh scheduling circuits, blocks, functions, etc. For example, in one embodiment of a stacked memory package, collaboration etc. between one or more memory controllers to perform refresh etc. may be made by communication etc. with one or more circuits, functions, etc. that may sense temperature and/or provide temperature data, information, etc. (e.g. via measurement, via signals, via any other information, etc.) and/or any other information, data, signals, and the like etc. For example, in one embodiment, one or more temperature sensing functions, temperature sending, etc. may be distributed across (e.g. amongst, within, in proximity to, etc.) one or more memory chips. In one embodiment, the temperature information and/or other data, information, etc. from one or more stacked memory chips and/or from one or more portions of one or more memory chips, may be used to control, govern, regulate, manage, limit, operate, and/or otherwise modify the refresh behavior, functions, operations, timing, etc. of one or more memory controllers, and/or other refresh control circuits, functions, etc. In one embodiment, each memory controller and/or other logic etc. may control etc. refresh functions etc. independently. In one embodiment, one or more memory controllers etc. may control etc. a set of refresh functions etc. collectively (e.g. via collaboration, collectively, etc.). In one embodiment, a first set (e.g. group, collection, list, etc.) of one or more refresh operations may be performed in an independent manner etc. while a second set of one or more refresh operations may be performed in a collective manner etc.

For example, in one embodiment, one or more refresh operations, parts of refresh operations, one or more refresh operation parameters, etc. may be dependent on local conditions (e.g. local temperature, local traffic activity, etc.). Local conditions may include (but are not limited to), for example, conditions, measurements, metrics, statistics, properties, aspects, and/or any other features etc. of one or more parts of a memory chip, parts of a logic chip, groups or sets of these, combinations of these, and/or any other parts, portions, etc. of one or more system components, circuits, chips, packages, and the like etc. In this case, for example, one or more aspects of refresh may be performed in an independent manner or relatively independent manner (e.g. autonomously, semi-autonomously, at the local level, etc.). For example, each memory controller etc. may monitor activity (e.g. commands, requests, etc.), temperature of logically attached memory circuits, and/or any other metrics, parameters, data, information, etc. For example, in this case, in one embodiment, a memory controller etc. may make local decisions etc. to control etc. refresh timing, length of refresh, staggering of refresh signals, etc. For example, in one embodiment, one or more stacked memory packages may control refresh operations at the memory system level, while one or more logic circuits may control refresh operations at the package level, etc. Thus, for example, in one embodiment, it may be beneficial to control one or more aspects of refresh operation in a hierarchical fashion, manner, etc. Of course one or more refresh operations, parts of refresh operations, one or more refresh operation parameters, etc. may be dependent on any aspect, parameters, input, control, data, information, etc. including any number, type, form, structure etc. of local sources, external sources, remote sources, etc. Of course refresh, refresh operations, refresh controls, and/or other refresh related activities, etc. may be controlled, performed, executed, regulated, managed, etc. by any circuits, functions, blocks including, but not limited to, for example, one or more memory controllers.

For example, in one embodiment, a first set of one or more aspects, features, parameters, timing, behaviors, functions, etc. of refresh may be controlled etc. at a first level (e.g. of hierarchy, at a first layer, etc.) and a second set of one or more aspects of refresh may be controlled etc. at a second level etc. Any number, type, arrangement, depth, etc. of levels etc. (e.g. of hierarchical operation, of layers, etc.) may be used. For example, in one embodiment, a central (e.g. high level, higher level, top layer, etc.) control function may control etc. a window of time in which a memory controller and/or other logic etc. may perform refresh operations. In this case, for example, a memory controller etc. may decide when within that time window to actually perform memory refresh operations, etc. For example, it may be beneficial to assign, designate, program, configure, etc. a first set, group, collection, etc. of one or more aspects of refresh to a central and/or high-level function. For example, one or more logic chips, parts of one or more logic chips, etc. in a stacked memory package may have more information on activity (e.g. number, type, form, kind, etc. of traffic etc.), power consumption, voltage levels, power supply noise, combinations of these and/or any other system metrics, parameters, statistics, etc. In this case, for example, it may be beneficial to assign a first set of one or more aspects etc. of refresh to one or more logic chips and assign a second set of one or more aspects etc. of refresh to lower-level (e.g. lower in hierarchy, etc.) components, circuits, etc. For example, in one embodiment, one or more logic chips, parts of one or more logic chips, etc. may provide, signal, and/or otherwise indicate a refresh period and/or one or more other parameters, metrics, controls, signals, combinations of these and the like etc. to any other circuits, components, functions, blocks, etc. (e.g. to one or more memory controllers, to one or more memory chips, parts of one or more memory chips, combinations of these and/or any other associated circuits, functions, logic, other components, etc.).

Other forms of interaction, information exchange, control, communication, etc. may be used. For example, in one embodiment, one or more memory controllers and/or any other circuits, functions, blocks, etc. may request permission to perform refresh from a central resource that may then arbitrate, allocate, etc. refresh operations to the memory controllers. Conversely, one or more central resources, circuits, functions, blocks, etc. may grant permission, trigger, and/or otherwise control, manage, regulate, time, etc. one or more local refresh operations, functions, behaviors, timings, schedules, etc. For example, in one embodiment, one or more memory circuits and/or any other circuits, functions, blocks, etc. may request permission to perform refresh from a central resource (e.g. logic chip and/or any other circuits, etc.) that may then arbitrate, allocate, etc. refresh operations to the memory circuits. For example, in one embodiment, the central resource that may act to control refresh may be a logic chip in the stacked memory package. For example, in one embodiment, the central resource that may act to control refresh in a first stacked memory package may be a logic chip in a second stacked memory package. For example, in one embodiment, the central resource that may act to control refresh in a stacked memory package may be a system CPU, and/or other system component, etc.

For example, in one embodiment, one or more commands, requests, etc. may include information that may control one or more refresh operations, one or more aspects of refresh operations, and/or any aspect of refresh behavior, refresh functions, refresh operations, refresh actions, combinations of these and/or any other similar functions, actions, behaviors, and the like, etc. For example, in one embodiment, a request (e.g. read request, write request, any other requests, etc.) may include, contain, etc. information, data, etc. on whether the request may interrupt one or more refresh operations. Of course any number, type, structure, form, kind, combination, etc. of one or more commands, requests, messages, etc. may be used to modify, control, direct, alter, and/or otherwise change, etc. one or more aspects of refresh, etc.

For example, in one embodiment, a bit may be set in a read request that may allow, permit, enable, etc. a current, pending, queued, scheduled, etc. refresh operation to be interrupted and/or otherwise manipulated (e.g. with respect to timing, scheduling and/or other parameter, property, value, metric, and the like etc.). Any form of indication, signaling, marking, etc. may be used to indicate, control, implement, manage, limit, time, re-time, delay, advance, etc. refresh interrupt and/or any other aspect of refresh functions, operations, behaviors, timing, etc. In one embodiment, the function etc. (e.g. resulting behavior, etc.) of a refresh operation interrupt may be to delay the refresh operation. In one embodiment, the function of a refresh operation interrupt may be to reschedule the refresh operation. In one embodiment, the function of a refresh operation interrupt may be to alter, modify, change, reorder, re-time, etc. any aspect of the refresh operation (e.g. scheduling, timing, priority, duration, order, address range, refresh target, etc.). In one embodiment, any number, type, form, kind, etc. of one or more bits, fields, flags, codes, etc. in one or more commands, requests, messages, etc. may be used to control, modify, alter, program, configure, change, and/or otherwise manage, etc. any functions, properties, metrics, parameters, timing, grouping, and/or any other aspects and the like etc. of any number, type, form, kind, etc. of refresh operations and/or any other operations, functions, behaviors, timing, etc. associated with refresh, etc. For example, in one embodiment, one or more command codes may be used to indicated commands that may interrupt refresh operations, etc. For example, in one embodiment, commands directed to a part, portion, etc. of memory may be allowed to interrupt and/or otherwise alter, modify, change, etc. refresh operations etc. For example, in one embodiment, commands, requests, etc. that use a specified memory class (as defined herein and/or in one or more specifications incorporated by reference) may be allowed to interrupt and/or otherwise alter, modify, change, etc. refresh operations etc. For example, in one embodiment, commands that use a specified virtual channel may be allowed to interrupt and/or otherwise alter, modify, change, etc. refresh operations etc. Of course any number, type, form, structure, etc. of mechanism, algorithm, etc. may be used to control, interrupt, modify, and/or otherwise alter refresh behavior, operations, actions, functions, etc.

Other forms of refresh control, management, etc. may be used in addition to interruption (e.g. refresh interrupt, etc.). For example, scheduling, prioritization, ordering, combinations of these and/or any aspect of refresh etc. may be similarly controlled, managed, regulated, modified, manipulated, etc.

Similar techniques to those described above, elsewhere herein, and/or in one or more specifications incorporated by reference may be used for scheduling, timing, ordering, etc. of commands as a function, for example, of refresh operations and/or any other operations etc. For example, in one embodiment, a command may be marked etc. to indicate that it may be scheduled and/or otherwise changed in one or more aspects to accommodate (e.g. permit, allow, enable, etc.) one or more other operations (e.g. refresh, repair, test, calibration, and/or any other system functions, and/or any other operation(s), etc.). For example, in one embodiment, a set, series, sequence, collection, group, etc. of commands may be similarly marked etc. For example, in one embodiment, any technique to mark, designate, indicate, singulate, group, collect, etc. one or more commands, requests, messages, etc. that may be manipulated, re-timed, re-ordered, ordered, prioritized, and/or otherwise changed in one or more aspects etc. may be used. For example, in one embodiment, the marking etc. of commands etc. may take any form and/or be performed in any manner, fashion, etc.

For example, in one embodiment, one or more commands, requests, etc. may use, employ, implement, etc. a specified part of memory, part of a datapath, traffic class, virtual channel, combinations of these and/or any other similar techniques to separate, mark, designate, identify, group, etc. traffic, data, information, etc. that are used in a memory system. For example, in one embodiment, commands that use a specified part of memory, part of a datapath, traffic class, combinations of these and/or any other similar metrics, markings, designations, identifications, groupings, etc. may be allowed to interrupt refresh. For example, high-priority traffic, real-time traffic etc. may be allowed to interrupt one or more refresh operations, etc. For example, video traffic (e.g. associated with, corresponding to, etc. multimedia files, etc.) may be assigned a specified virtual channel, traffic class, etc. that may allow interruption of one or more refresh operations and/or operations associated with refresh, etc. In one embodiment, the modification of behavior may include one or more aspects, facets, features, properties, functions, behaviors, etc. of refresh operation. Thus, in one embodiment, any aspect, facet, feature, property, function, behavior, metric, parameter, and the like etc. of refresh operation may be modified in a similar fashion, manner, etc.

For example, in one embodiment, collaboration etc. between one or more circuit functions, blocks, etc. may be performed etc. by communication, coupling of signals, exchange of information, etc. For example, information may be used to schedule, order, arrange, direct, control and/or otherwise manage etc. one or more refresh operations, etc. For example, in one embodiment, a prefetch unit (prefetcher, prefetch block, prefetch circuit, predictor, etc.) may predict, and/or otherwise calculate etc. future memory access (e.g. based on history analysis, by analyzing strides and other patterns of memory access, using Markov chain based analysis, using any other statistical analysis techniques, and/or any similar analysis, calculations, models and the like, etc.). In one embodiment, the prefetcher may provide information to one or more circuits that may, for example, control refresh operations. For example, the information provided may indicate, and/or be used to indicate, etc. which memory regions, etc. may be most suitable targets for refresh. For example, a stacked memory package may be divided into regions A, B, C, D (e.g. for the purposes of refresh, etc.). For example, in one embodiment, the prefetcher may predict that access (e.g. in a future window of time of predetermined length, etc.) may be made to regions A, B, C. This information may be used, for example, by a refresh engine and/or any other refresh control circuits to schedule, plan, control, order, queue, etc. refresh operations to memory region D. Of course any number of memory regions, groups of memory regions, arrangements of memory regions, sets of memory addresses, ranges of memory addresses, collections of memory regions, echelons, banks, sections, combinations and/or arrangements of these and/or any other part, portions, of memory etc. may be tracked, used for prediction, used to schedule refresh, etc. Thus, for example, in one embodiment, one or more prefetch units may provide hints (e.g. directly as memory addresses that may not be likely to be accessed and/or indirectly as memory addresses that are likely to be accessed, etc.) and/or any other data, information, etc. Such hints etc. may be provided by one or more prefetch units e.g. located on one or more logic chips, etc. Hints etc. may also be provided from commands, requests, messages, etc. from one or more CPUs in the system. Hints etc. may be provided as inputs (direct and/or indirect), generated internally to one or more stacked memory packages, combinations of these, and/or provided, obtained, received, combined, assembled, etc. from any number, type, etc. of sources.

For example, in one embodiment, a prefetch unit that may provide hints etc. to prefetch one or memory addresses, memory address ranges, etc. may also provide hints to one or more other parts, portions, functions, etc. of a logic chip, stacked memory chip, stacked memory package, etc. For example, the prefetch unit may provide one or more hints etc. to logic that may provide one or more refresh functions, etc. For example, the prefetch unit may provide one or more hints etc. to logic that may provide one or more repair functions, etc. For example, the prefetch unit may provide one or more hints etc. to logic that may provide any type of function, behavior, etc.

For example, in one embodiment, logic may provide hints etc. to one or more refresh, repair, etc. functions. Such logic may perform, operate, etc. in a manner, fashion, etc. similar to a memory prefetcher, memory predictor, etc. In one embodiment, one or more logic units, logic functions, circuits, etc. may be customized, adapted, modified, etc. to produce, generate, calculate, track, form, etc. one or more hints, controls, and/or other data, information etc. for one or more repair, refresh, etc. functions and the like. For example, in one embodiment, a predictor, prefetcher, etc. may be used uniquely, solely, especially, etc. for repair functions, refresh functions, etc. Thus, for example, a predictor, prefetcher and/or similar function may be used for one or more repair, refresh functions, operations, etc. does not have to be used (but may be used) for memory access prediction (e.g. to generate, create etc. one or more memory accesses, etc.).

For example, in one embodiment, one or more hints etc. provided to schedule memory access, memory refresh, memory repair, combinations of these, and/or any operations, functions, behaviors and the like etc. may be provided etc. at different levels of granularity. For example, one or more prefetch, predictor, etc. functions may provide a first level of granularity (e.g. which chips are most likely to be accessed, etc.) to one or more repair functions etc. and provide a second level of granularity (e.g. which range of memory addresses is most likely to be accessed, etc.) to refresh functions, etc. Of course, any level of granularity for any number, type, form, etc. of functions, etc. may be used. For example, in one embodiment, the granularity corresponding to, associated with, etc. each function (e.g. repair, memory access, refresh, any other functions, etc.) may be programmed, configured, and/or otherwise controlled, etc. The programming etc. may be performed at any time and/or in any fashion, manner, using any techniques, etc.

Note that there may be a difference between speculative prefetch, prediction, etc. For example, a speculative prefetch unit may examine memory references and detect patterns (e.g. strides, etc.) that may be present in a series, group, collection, set, stream, sample, etc. of memory references, etc. For example, a speculative prefetch unit may generate, create, etc. one or more access operations, etc. to prefetch one or more units of data etc. that may be accessed in future operations. For example, a prediction unit, prediction function, etc. may examine memory reference patterns and predict locations, types, etc. of access. For example, a prediction unit may predict the stacked memory chips, and/or parts, pieces, portions, etc., of stacked memory chips that may be likely, most likely, etc. to be accessed in future, etc. For example, a prediction unit may provide, send, convey, signals, etc. one or more predictions to one or more other circuits, functions, etc. in a stacked memory package. For example, a prediction unit may provide etc. one or more predictions to a refresh function, refresh circuits, repair functions, repair circuits, and/or any other circuits, functions, etc. located on one or more logic chips, one or more stacked memory chips, etc.

Thus, for example, in one embodiment, one or more prefetch, predictors, prediction functions, etc. may modify, alter, change, control, manage, dictate, program, configure, etc. the operation, functions, and/or any other aspects of refresh behavior etc.

In one embodiment, the modification etc. of behavior as described above, elsewhere herein and/or in one or more specifications incorporated by reference may include behaviors, functions, processes, etc. other than refresh interrupt, refresh scheduling, and/or any other refresh associated operations, refresh related operations, etc. For example, in one embodiment, repair operations (e.g. including, but not limited to, the substitution of one or more spare memory circuits etc. for one or more failing memory circuits etc.) may be scheduled, timed, queued, etc. in a similar fashion to refresh operations. Thus, in one embodiment, commands, requests, instructions, etc. may be manipulated, changed, created, altered, modified, etc. with respect to repair operations, refresh operations, any other operations, etc. in a manner, fashion, using techniques, etc. similar to that described herein for refresh operations. For example, in one embodiment urgent, prioritized, etc. commands, requests, may cause one or more repair operations, etc. to be delayed, rescheduled, re-ordered, prioritized, postponed, queued, deleted, moved in time, and/or otherwise manipulated, changed, modified, altered, etc.

For example, in one embodiment, commands, requests, responses, messages, any other similar functions, and/or associated circuit operations, etc. may be throttled, governed, regulated, and/or otherwise controlled, etc. For example, in one embodiment, requests to a certain memory region, memory space, range of addresses, groups of addresses, sets of addresses, etc. may be throttled etc. in order to provide thermal management (e.g. to prevent overheating, to control refresh period, to control other functions, to control other behaviors, etc.). In this case, one or more commands may be designated and/or otherwise marked, indicated, sorted, prioritized, etc. to alter, change, modify, bypass, create, generate, etc. one or more such controls (e.g. governing, throttling, regulating, monitoring, controlling, etc.). Thermal management and thermal management operations (e.g. governing, throttling, limiting, etc.) are used by way of example. Any type of system management, control, regulation, limiting, direction, behavior, function, operation, etc. may be used to govern etc. the flow (e.g. execution, queuing, retirement, implementation, ordering, timing, etc.) of one or more commands, requests, responses, completions, etc. Thus, for example, in one embodiment, one or more commands, command flows, command operations, etc. may be controlled with respect to any type of system management, control, function, behavior, and the like, etc. For example, in one embodiment, memory access (e.g. by read commands, write commands, etc.) may be throttled, controlled, modulated, and/or otherwise manipulated etc. during one or more repair operations, test operations, etc. Of course, memory access etc. may be governed, throttled, etc. as a result of, during, etc. any operation, function, behavior, and the like etc.

Thus, in one embodiment, the modification of behavior (e.g. command behavior, control behavior, etc. that may be controlled as described above, etc.) may include any facets, aspects, features, properties, functions, behaviors, etc. of any operations, system operations, system functions, device operations, circuit functions, control functions, etc. including, but not limited to, one or more of the following: refresh, system management, housekeeping functions, repair functions, test functions, calibration functions, maintenance functions, error handling, retry mechanisms, replay operations, system interrupts, configuration, programming, any other system functions, combinations of these and/or any other control(s), operation(s), and the like etc.

In one embodiment, control, management, regulation, governing, etc. of system behavior may be a function of one or more bits, flags, fields, data, information, codes, signals, etc. one or more of which may be included in and/or correspond to one or more commands, requests, etc. In one embodiment, as an option, such control etc. may be implemented using a table, look-up table, index table, map, and/or any other data structure, similar structures, logic, and the like, etc. For example, in one embodiment, a table etc. may be programmed, populated, filled, utilized, etc. For example, in one embodiment, a table etc. may include one or more of the following (but is not limited to the following): command type, priority, and/or any other fields, etc. In one embodiment, as an option, a field, signal, flag, etc. such as priority may control, for example, command operations and/or other operations, etc. In one embodiment, as an option, a field etc. such as priority may control, for example, whether or not a function such as refresh may be interrupted and/or otherwise manipulated. Thus, for example, as an option, a read request with code “000” may have priority “0”; and a read request with code “001” may have priority “1”. In this case, for example, a read request with priority “0” may not be allowed to interrupt a refresh operation but a read request with priority “1” may be allowed to interrupt a refresh operation. Other similar techniques may be used to control any types of operations (e.g. command execution, command ordering, refresh operations, thermal management, repair operations, and/or any other operations, parts of operations and the like etc.). Any type, number, form, etc. of priorities and/or other control fields, etc. may be used. Any type, form, field, data, information, etc. may be used to control priorities etc. Any type, number, form of tables, tabular structures, and/or any other data structures, similar logic and the like may be used. For example, one or more tables or similar structures may be used to map one or more traffic classes, virtual channels, etc. to one or more priorities etc. For example, there may be one priority etc. for refresh operations and another priority for repair operations, etc. One or more aspects of the control of system behavior may be programmed, configured, etc. For example, the table of command type with priorities may be programmed etc. Of course any contents, entries, values, etc. of any tables etc. may be programmed, configured, etc. Programming, configuration, etc. may be performed at any times and/or in any context, manner, fashion, etc. and/or using any techniques, etc. For example, programming etc. may be performed at design time, manufacture, assembly, test, start-up, boot time, during operation, at combinations of these times, and/or at any times, etc. Of course, the programming, control, management, regulation, governing, operations, mapping, etc. described above may be performed in any manner, fashion, etc.

For example, in one embodiment, a part of memory, part of a datapath, traffic class, virtual channel, memory class, combinations of these and/or any other similar metrics, markings, designations, fields, flags, parameters, etc. may be specified, programmed, configured, and/or otherwise set etc. by any techniques etc. For example, in one embodiment, a part of memory may be specified by an address (e.g. in a command, in a request, etc.). In this case, for example, in one embodiment, a range of addresses may be specified by a command, message, etc. For example, a memory class may be specified, defined, etc. by one or more ranges of addresses, groups of addresses, sets of addresses, etc. that may be held in one or more tables, memory, and/or any other storage structures, etc. For example, in one embodiment, a traffic class may be specified by a bit, field, flag, code, etc. in one or more commands, requests, etc. For example, in one embodiment, a channel, virtual channel, memory class, etc. may be specified by a bit, field, flag, code, encoding, data, information, etc. in one or more commands, requests, etc. For example, in one embodiment, as an option, a channel, memory class, etc. may be specified by bit values “01” that may correspond to a table entry that includes an address range “0000_0000” to “0001_000”, for example. Of course any format, size, length, etc. of bit fields etc. and any format, size, length, etc. of address range(s) etc. in any number, form, type, etc. of table(s) and/or similar structure(s), logic and the like etc. may be used. The programming etc. of refresh behavior, any other behavior(s), memory classes, virtual channels, address ranges, combinations of these and/or any other factors, properties, metrics, parameters, timing, signals, etc. that may affect, control, determine, govern, implement, direct, etc. one or more aspects of refresh functions, operations, behavior, signals, timing, grouping, etc. may be performed at any time. For example, in one embodiment, programming etc. may be performed at design time, manufacture, assembly, test, start-up, boot time, during operation, at combinations of these times, and/or at any times, etc. and/or in any fashion, context, manner, etc.

For example, in one embodiment, as an option, a stacked memory package may perform all refresh operations independently, autonomously, etc. from the rest of the memory system. For example, in one embodiment, as an option, a stacked memory package may perform one or more refresh operations independently, autonomously, etc. from the system CPU, separate CPU, and/or any other system components, etc. For example, in one embodiment, as an option, a stacked memory package may determine the timing, scheduling, re-timing, re-scheduling, shuffling, ordering, and/or any other timing characteristics, parameters, behaviors, etc. of one or more refresh operations in an independent, autonomous, etc. manner, fashion, etc. from the system CPU, separate CPU, and/or any other system components, etc. For example, in one embodiment, one or more stacked memory packages in a memory system may perform any and/or all refresh operations independently, autonomously, semi-autonomously, etc. For example, in one embodiment, a stacked memory package may perform refresh operations in collaboration etc. with one or more other stacked memory packages. For example, in one embodiment, a stacked memory package may perform refresh operations in collaboration etc. with one or more other system components, including, but not limited to, one or more CPUs. For example, in one embodiment, a stacked memory package may perform refresh operations in collaboration etc. with one or more other stacked memory packages and use a CPU and/or one or more other system components to act in a collaborative etc. manner. For example, in one embodiment, the CPU may gather (e.g. collect, receive, request, etc.) temperatures, activity, and/or any other system metrics, parameters, measurements, data, information, statistics, averages, etc. and may use this information (e.g. process the information, provide information, etc.) to control etc. one or more refresh operations, operations associated with refresh, and/or any other operation and the like, etc. For example, in one embodiment, one or more logic chips may gather temperature information in order to perform one or more refresh operations in any manner, fashion, using any techniques described above, elsewhere herein, and/or in one or more specifications incorporated by reference, etc.

For example, in one embodiment, one or more stacked memory packages may time, order, re-order, stagger, interleave, alternate, and/or otherwise schedule, time, re-time, etc. one or more refresh operations in order to reduce overall power, to reduce average power, to reduce peak power, and/or otherwise control the timing, profile (e.g. versus time, etc.), peak, average, or any other properties of power, voltage, current, noise, coupled noise, supply bounce, ground bounce, dV/dt, dI/dt, and/or any other similar, related, etc. metric, parameter and the like etc. For example, in one embodiment, one or more stacked memory packages may time etc. one or more refresh operations etc. by exchanging information, signals, messages, status, etc. For example, in one embodiment, one or more stacked memory packages may time etc. one or more refresh operations in order to control power, current, etc. of the system including one or more CPUs.

For example, in one embodiment, one or more stacked memory packages and/or one or more CPUs and/or other system components, etc. may time etc. one or more refresh operations and/or any other operations, functions, behaviors, etc. in such a way to control, throttle, manage, limit, and/or otherwise perform one or more functions of one or more metrics (e.g. including, but not limited to, metrics such as power, current, noise, etc.) that are caused by and/or that may be a result of simultaneous, nearly simultaneous operation, etc. operation of one or more CPUs etc. and one or more memory systems. For example, in one embodiment, one or more memory regions, partitions, classes, etc. of one or more stacked memory packages may be placed into one or more power-down states and/or any other states (e.g. power conserving states, reduced power modes, reduced operating modes, power-off modes, etc.) while one or more CPUs etc. are performing power-intensive functions, etc. For example, in this case, in one embodiment, one or more CPUs etc. may initiate a memory system power-down state operation. Such operations may include entry into one or more power states, exit from one or more power states, and/or any operations etc. related to one or more power states, power-down states, power-off states, low-power modes, and/or any other modes, states, and the like etc. For example, in this case, in one embodiment, one or more stacked memory packages, logic chips, etc. may initiate, trigger, and/or otherwise control etc. entry and/or exit etc. to/from a memory system power-down state and/or any other power state, mode, etc. For example, in this case, in one embodiment, one or more CPUs etc. and one or more memory packages may collaboratively may control etc. memory system power, a memory system power-down state, and/or any similar, related, etc. aspect of memory power, memory state, etc.

It may be beneficial in a memory system to control the timing of, for example, power intensive operations. For example, operations such as refresh may consume large amounts of power or cause spikes in power etc. Other operations may also consume enough power to cause potential problems (such as supply noise etc.) if too many components, parts, circuits, blocks, etc. perform the same operation simultaneously or nearly simultaneously. For example, a first stacked memory package may perform a first set (e.g. group, collection, etc.) of refresh operations and a second stacked memory package may perform a second set of refresh operations. For example, each set of refresh operations may allow eight memory regions to be refreshed concurrently. Each individual refresh operation may have a particular current, power, etc. profile. For example, the peak current during an individual refresh operation may occur in the first 2 ns (e.g. time period, etc.) of the refresh operation, thus forming a 2 ns window (e.g. period, duration, etc.) of peak power. In one embodiment, for example, it may be beneficial to time, adjust, control, manage, schedule, etc. the first set of refresh operations so that each of the eight concurrent refresh operations are staggered, overlapped, pipelined, and/or otherwise timed, relatively timed, adjusted, etc. so that none of the 2 ns windows overlap, and/or overlap in a controlled manner, fashion, etc. In one embodiment, for example, it may be beneficial to time etc. the first and second set of refresh operations so that each of the 16 concurrent refresh operations in two stacked memory packages are staggered, overlapped, pipelined, and/or otherwise timed, adjusted, controlled, managed, etc. so that none of the 2 ns windows overlap and/or overlap in a controlled manner, fashion, etc. Of course specific timing, timing relationships, time values, time periods, overlaps, etc. are used by way of example only. Any timing, number of refresh operations, form of overlapping operations, adjustment techniques, and/or any other aspect of refresh timing, operations, and the like etc. may be used, controlled, managed, etc.

The execution, performance, etc. of operations, functions, behaviors, etc. may also consume enough power to cause potential problems (such as supply noise etc.) if too many components, parts, circuits, blocks, etc. perform certain combinations of operations simultaneously or nearly simultaneously etc. For example, in one embodiment, any number, form, type, manner etc. of operations (including, but not limited to, refresh, power modes, bank activation, read operations, write operations, repair operations, power-down entry and/or exit, calibration, programming, configuration, etc.) may be timed, adjusted, and/or otherwise manipulated etc. to control and/or otherwise manage one or more metrics, parameters, etc. of a system, system components, etc. (e.g. CPUs, stacked memory packages, any other system components, combinations of these, etc.). For example, in this case, in one embodiment, the metrics etc. may include, but are not limited to, one or more of the following: component power, system power, peak power, refresh power, refresh current, operating current, coupled noise, ground bounce, supply bounce, supply noise, functions of these (e.g. average, maximum, peak, minimum, any other statistical metrics, time derivatives, integrals, weighted averages, weighted functions, etc.), combinations of these and the like etc.

For example, in one embodiment, one or more refresh operations, parts of refresh operations, one or more refresh operation parameters, etc. may be automatic, automated, semi-automatic, autonomous, semi-autonomous, etc. For example, in one embodiment, automatic, automated, autonomous, etc. refresh operation(s), parts of refresh operations, etc. may include the performance, execution, scheduling, etc. of one or more facets, functions, behaviors, and/or any other aspects etc. of one or more refresh operations (including all refresh operations, etc.) and/or refresh related functions, operations, etc. without the involvement, participation, input from, etc. external sources (e.g. external to a stacked memory package, etc.). In this case, for example, a CPU or any other system component etc. may initially configure, otherwise program, etc. one or more aspects of refresh operation. In this case, for example, the refresh operation may be regarded as, viewed as, etc. semi-automatic, semi-autonomous, etc. For example, in one embodiment, after initial configuration etc. refresh operation may be automatic, autonomous, etc. For example, in one embodiment, after initial configuration etc. refresh operation may be automatic, autonomous, etc. such that the system CPU and/or other equivalent functions, components etc. are unaware of the refresh operations, refresh timing, refresh scheduling, etc. Of course, refresh operations; parts of refresh operations; any timing of refresh; modification, programming, configuration, etc. of one or more refresh operation parameters, etc. and/or any other aspects, facets, behaviors, functions, etc. of refresh and the like may be performed etc. in any manner, fashion, context, etc. at any times and/or using any techniques, etc.

For example, in one embodiment, refresh operations, functions, etc. and/or one or more parts, portions, etc. of one or more refresh operations etc. may be controlled, managed, guided, regulated, governed, manipulated, etc. by circuits, functions, etc. internal (e.g. included in, that are part of, etc.) a stacked memory package. For example, in one embodiment, one or more refresh operations, parts of refresh operations, one or more refresh operation parameters, etc. may be configured, programmed, etc. The configuration etc. may be performed at any time (e.g. manufacture, design, test, assembly, start-up, boot time, during operation, combinations of these times and/or at any times). For example, in one embodiment, one or more refresh operations, parts of refresh operations, one or more refresh operation parameters, etc. may be programmed under system CPU control and/or under control of one or more system components, etc. For example, in one embodiment, one or more refresh operations, parts of refresh operations, one or more refresh operation parameters, etc. may be programmed under control of one or more refresh engines, refresh circuits, refresh functions, etc. For example, a refresh engine etc. may be included on a logic chip, memory chip, distributed in functionality between these and/or any other system components, etc. For example, in one embodiment, a refresh engine etc. may include a processor, controller, microcontroller, state machine, combinations of these and/or programmable circuits, any other circuits, etc. that may allow one or more refresh operations, aspects of refresh operations, and/or any other operations etc. to be programmed using firmware, microcode, bitfiles, combinations of these and the like, etc. For example, in one embodiment, a refresh engine etc. may perform one or more refresh functions as a result of calculating, acting on, reacting to, etc. one or more functions of temperature, voltage, activity, any other system parameters, supplied metrics, measurements, input signals, configured parameters, combinations of these and/or any other data, information and the like, etc. For example, in one embodiment, one or more processors etc. that may control refresh, form a refresh engine, etc. may be different from the system CPUs or separate processors in the system. For example, in one embodiment, one or more processors etc. that may control refresh, form a refresh engine, etc. may be shared, part of, include one or more cores and/or otherwise be related to the system CPUs or separate processors in the system. For example, in one embodiment, a system CPU, one core of a multicore system CPU, part or all of a separate CPU, etc. may run code that may predict memory access and forward that information etc. to a stacked memory package in order to control refresh etc. For example, in one embodiment, a CPU, controller, etc. that may be included on a logic chip in a stacked memory package, etc. may run code that may predict memory access and forward that information etc. to one or more memory controllers and/or other logic to control refresh etc.

Example embodiments described above, elsewhere herein, and/or in one or more specifications incorporated by reference may include one or more systems, techniques, algorithms, mechanisms, functions, circuits, etc. to perform refresh, refresh operations, refresh functions, related functions and the like etc. in a memory system.

Note that the use, meaning, etc. of terms refresh commands, refresh operations, refresh signals, and/or any other aspects of refresh operation etc. may be slightly different in the context of their use. For example, in one embodiment, the use of these and/or any other related terms may be different with respect to a stacked memory package (e.g. using SDRAM, flash, and/or any other memory technology, etc.) relative to (as compared to, in comparison with, etc.) their use with respect to, for example, a standard SDRAM part. For example, one or more refresh commands (e.g. command types, types of refresh command, etc.) may be applied to the pins of a standard SDRAM part as signals. In this case, for example, commands may be defined by the states (e.g. high H, low L, etc.) of signals at one or more external pins, including (but not limited to) CS#, RAS#, CAS#, WE#, CKE. For example, in one embodiment, the signal states may be measured (e.g. defined, considered, captured, etc.) at the rising edges of one or more periods (cycles) of the clock (e.g. CK and/or CK#, etc.). For example, with respect to an SDRAM part, a refresh command (e.g. function, behavior, etc.) may correspond to CKE=H (previous and next cycle); CS#, RAS#, CAS#=L; WE#=H. Other refresh commands for an SDRAM part may include self refresh entry and self refresh exit, for example. In some SDRAM parts, the external pins (e.g. signals, etc.) CKE, CK, CK# may form inputs to the control logic. For example, in some SDRAM parts, external pins such as CS#, RAS#, CAS#, WE# etc. may form inputs to the command decode logic, which may be part of the control logic. Further, in some SDRAM parts, the control logic and/or command decode logic may generate one or more signals that may control the refresh operations of the part. Additionally, in some SDRAM parts, refresh may be used during operation and may be issued each time a refresh operation is required, desired, etc. Still yet, in some SDRAM parts, the address of the row and bank to be refreshed may be generated by an internal refresh controller and internal refresh counter that, for example, may provide the address of the bank and row to be refreshed. The use and meaning of terms including refresh commands, refresh operations, and refresh signals in the context of, for example, a stacked memory package (e.g. possibly without external pins CS#, RAS#, CAS#, WE#, CKE, etc.) may be different from that of a standard part and may be further defined, clarified, expanded, etc, in one or more of the embodiments described herein and/or in one or more specifications incorporated by reference. The timings (e.g. timing parameters, timing restrictions, relative timing, timing windows, timing margins, timing requirements, minimum timing, maximum timing, combinations of these and/or any other timings, parameters, etc.) of refresh commands, refresh operations, associated operations, refresh signals, any other refresh properties, behaviors, functions, combinations of these, etc. may be different in the context of their use. For example, timings etc. may be different with respect to a stacked memory package (e.g. using SDRAM, flash, combinations of these, and/or any other memory technology, etc.) relative to (as compared to, in comparison with, etc.) their use with respect to, for example, a standard SDRAM part. For example, SDRAM parts may employ a refresh period of 64 ms (e.g. a static refresh period, a maximum refresh period, etc.). In some cases, the static refresh period as well as any other refresh related parameters may be functions of temperature. For example, one or more values, parameters, timing parameters, etc. may change for case temperature tCASE greater than 95 degrees Celsius, etc. For example, SDRAM parts with 8 k rows (=8*1024=8192 rows) may employ a row refresh interval (e.g. refresh interval, refresh cycle, parameter tREFI, refresh-to-activate period, refresh command period, etc.) of approximately 7.8 microseconds (=64 ms/8 k). The time taken to perform a refresh operation may be the parameter tRFC, etc. with minimum value tRFC(MIN) etc. For example, a refresh period may start when the refresh command is registered and may end after the minimum refresh cycle time e.g. tRFC(MIN) later. Typical values of the parameter tRFC(MIN) may vary from 50 ns to 500 ns. For example, some SDRAM parts may employ a refresh operation (a refresh cycle) at an interval (e.g. the parameter tREFI, etc.) that may average 7.8 microseconds (maximum) when the case temperature is less than or equal to 85 degrees C. or 3.9 microseconds (e.g. when the case temperature is less than or equal to 95 degrees C., etc.). For example, the parameter tRFC(MIN) may be a function of the SDRAM part size. As another example, the parameter tRFC may be 28 clocks (105 ns) for 512 Mb parts, 34 clocks (127.5 ns) for 1 Mb parts, 52 clocks (195 ns) for 2 Gb parts, 330 ns for 4 Gb parts, etc. As another example, the parameter tRFC may be 110 ns for 1 Gb parts, 160 ns for 2 Gb parts, 260 ns for 4 Gb parts, 350 ns for 8 Gb parts, etc. For example, the parameter tRFC(MIN) for next-generation SDRAM parts may be higher than for current or previous generation SDRAM parts. The timing, timing parameters, etc. of a standard SDRAM part (e.g. DDR, DDR2, DDR3, DDR4, etc.) may be specified with respect to external pins. For example, the timing of refresh command(s), refresh operations, refresh signals and the relevant, related, pertinent, etc. timing parameters, including, for example, tRFC(MIN), tREFI, static refresh period, etc. may be specified, determined, measured, etc. with respect to the signals at the external pins of the part. The timing (e.g. timing parameters, timing restrictions, relative timing, ordering, etc.) of refresh commands, refresh operations, refresh signals, any other refresh properties, behaviors, functions, etc. in the context of, for example, a stacked memory package (e.g. possibly without externally visible tRFC(MIN), tREFI, etc.) may be different from that of a standard part and may be further defined, clarified, expanded, explained, etc, in one or more of the embodiments described herein and/or in one or more specifications incorporated by reference.

Commands

Note that although the collaborative, cooperative, etc. functioning of memory controllers and/or other circuits has been described with respect to refresh operations other functions, operations, behaviors, and the like etc. may also be performed in a similar collaborative fashion, manner, etc. For example, in one embodiment, the processing of commands, requests, responses, completions, messages and/or any other aspect, feature, function, behavior, etc. of a memory system may be performed, executed, implemented, supported, etc. using such techniques that may include cooperation, collaboration, etc. For example, in one embodiment, such operations as test, self-test, repair, error handling, data scrubbing, compression, deduplication, data protection, coding, error correction, data copying, checkpointing, and/or any other similar operations may be performed, executed, implemented, etc. using cooperation, collaboration, etc. as described above, elsewhere herein and/or in one or more specifications incorporated by reference.

In FIG. 18-2, in one embodiment, information, data, signals, controls, packets, commands, instructions, messages, flags, indicators, and/or any other data, information and the like etc. may be sent from the CPU to the memory subsystem using one or more requests (or commands, etc.) 18-212. In one embodiment, information may be sent between any system components (e.g. directly, indirectly, etc.) using any techniques (e.g. packets, signals, buses, messages, combinations of these and/or any other signaling techniques, communication techniques, etc.). In one embodiment, a request may include any information (e.g. request, data, message, signals, raw commands, status, control signals, flags, fields, indicators, combinations of these and/or any data, information and the like etc.). In one embodiment, information may be split, divided, distributed, etc. across any number and type of requests, packets, etc. In one embodiment, a request may include any number, types, form, etc. of information. For example, in one embodiment, a request may include both a read request and a write request. In one embodiment, a request may include any information of any type, form, aspect, etc. to be exchanged, communicated, coupled, linked, transmitted, etc. between one or more system components, circuits, blocks, functions, chips, etc. Of course, as an option, a request may include any number, type, form, etc. of information etc.

In FIG. 18-2, in one embodiment, information may be sent from the memory subsystem to the CPU using one or more responses (or completions, etc.) 18-214. Similarly to a request, for example, a response may include any type, form, view, aspect, structure, etc. of any information, data, signals, indicators, flags, messages, status, errors, and/or any similar information and the like etc. to be exchanged etc. between any system components etc.

In FIG. 18-2, in one embodiment, for example, a memory read may be performed by sending (e.g. transmitting from CPU to stacked memory package, etc.) a read request. The read data may be returned in a read response. The read request may be forwarded (e.g. routed, buffered, repeated, etc.) between stacked memory packages to the intended target stacked memory package (e.g. to the location of the data requested, etc.). The read response may be forwarded etc. between stacked memory packages and/or between, to/from, etc. any other system components etc.

In FIG. 18-2, in one embodiment, for example, a memory write may be performed by sending (e.g. transmitting from stacked memory package, etc.) a write request. The write request may be forwarded (e.g. routed, buffered, repeated, etc.) between stacked memory packages and/or any other system components etc. to the intended target stacked memory package (e.g. to the location of the write request, etc.). In one embodiment, for example, the write response (e.g. completion, notification, etc.), if any, may originate from the target stacked memory package. In one embodiment, for example, the write response may be forwarded etc. between stacked memory packages and/or any other system components etc.

In FIG. 18-2, in one embodiment, a request and/or response may be asynchronous (e.g. split, separated, with variable latency between request and response, etc.). For example, in one embodiment, a request and/or response may be part of a split transaction and/or carried, transported, conveyed, communicated, etc. by a split transaction bus, etc. For example, in one embodiment, the latency (e.g. delay, etc.) between a request and a response may be variable (e.g. different for different requests, etc.). Note that, in some situations, the term command may be used to include requests as well as responses and completions (for example when command is used in the context of a command set which may include the definitions, formats, etc. of all commands, requests, responses, completions, messages, etc. used in a memory system).

In one embodiment, one or more commands may be sent to (e.g. received by, processed by, interpreted by, acted on, etc.) one or more logic chips. In one embodiment, one or more commands may be sent to (e.g. received by, processed by, interpreted by, acted on by, etc.) one or more stacked memory chips. In one embodiment, one or more commands etc. may be received by one or more logic chips and one or more modified (e.g. changed, processed, transformed, combinations of these and/or any other modifications, etc.) commands, signals, requests, sub-commands, combinations of these and/or any other commands, etc. may be forwarded to one or more stacked memory chips, one or more logic chips, one or more stacked memory packages, any other system components, combinations of these and/or to any component(s) in the system, memory system, memory subsystem, etc.

For example, in one embodiment, the system may use a set of commands (e.g. read commands, write commands, raw commands, status commands, register write commands, register read commands, combinations of these and/or any other commands, requests, messages, etc.) that may form one or more command sets. For example, in one embodiment, a first command set may include raw, native or any other basic operations, instructions, etc. For example, in one embodiment, a second command set may include read operations, write operations, requests, instructions, messages, etc.

In one embodiment, one or more of the commands in the command set may be directed, for example, at one or more stacked memory chips in a stacked memory package (e.g. memory read commands, memory write commands, memory register write commands, memory register read commands, memory control commands, responses, completions, messages, combinations of these and/or any other commands and the like, etc.). In one embodiment, the commands may be directed (e.g. sent to, transmitted to, received by, targeted to, etc.) one or more logic chips. For example, in one embodiment, a logic chip in a stacked memory package may receive a command (e.g. a read command, write command, or any command, request, etc.) and may modify (e.g. alter, change, etc.) that command before forwarding the command to one or more stacked memory chips. In one embodiment, any type of command modification (e.g. manipulation, changing, alteration, combinations of these functions and/or any other similar functions and the like, etc.) may be used, employed, implemented, etc. For example, in one embodiment, one or more logic chips may reorder (e.g. re-time, shuffle, prioritize, arbitrate, etc.) commands etc. For example, in one embodiment, one or more logic chips may combine (e.g. join, add, merge, etc.) commands etc. For example, in one embodiment, one or more logic chips may split commands (e.g. split large read commands, separate read/modify/write commands, split partial write commands, split masked write commands, perform combinations of these functions and/or any other similar functions and the like, etc.). For example, in one embodiment, one or more logic chips may duplicate commands (e.g. forward commands to multiple destinations, forward commands to multiple stacked memory chips, perform combinations of these functions and/or any other similar functions and the like, etc.). For example, in one embodiment, a logic chip may operate on one or more commands etc. For example, in one embodiment, a logic chip may add fields, modify fields, delete fields, perform combinations of these functions and/or any other similar functions and the like, etc. on one or more commands etc. In one embodiment, any logic, circuits, functions etc. located on, included in, included as part of, distributed between, etc. one or more datapaths, logic chips, memory controllers, memory chips, combinations of these and/or any other components etc. may perform (e.g. implement, execute, etc.) one or more of the above described functions, operations, actions, combinations of these and the like etc. on one or more commands etc. In one embodiment, for example, any logic etc. in, included in any part of a system may perform any type, form, manner of manipulation etc. as described above etc. on one or more commands etc.

In one embodiment, for example, one or more requests and/or responses may include cache information, commands, status, requests, responses, messages, etc. For example, one or more requests and/or responses may be coupled to one or more caches. For example, in one embodiment, one or more requests and/or responses may be related to, carry, convey, couple, communicate, signal, transmit, etc. one or more elements, messages, status, probes, results, etc. related to, associated with, corresponding to, etc. one or more cache coherency protocols etc. For example, in one embodiment, one or more requests and/or responses may be related to, carry, convey, couple, communicate, signal, transmit, etc. one or more items, fields, contents, etc. of one or more cache hits, cache read hits, cache write hits, cache read miss, cache read hit, cache lines, etc. In one embodiment, for example, one or more requests and/or responses may include data, information, fields, etc. that are aligned and/or unaligned. In one embodiment, one or more requests and/or responses may correspond to (e.g. generate, create, result in, initiate, etc.) one or more cache line fills, cache evictions, cache line replacement, cache line writeback, probe, internal probe, external probe, combinations of these and/or any other cache operations, functions, and similar operations and the like, etc. In one embodiment, one or more requests and/or responses may be coupled (e.g. transmit from, receive from, transmit to, receive to, etc.) one or more write buffers, write combining buffers, any other similar buffers, stores, FIFOs, combinations of these and/or any other like functions, circuits, etc. In one embodiment, for example, one or more requests and/or responses may correspond to (e.g. generate, create, result in, initiate, etc.) one or more cache states, cache protocol states, cache protocol events, cache protocol management functions, and/or any other cache related functions and the like etc. For example, in one embodiment, one or more requests and/or responses may correspond to one or more cache coherency protocol (e.g. MOESI, etc.) messages, probes, status updates, control signals, combinations of these and/or any other cache coherency protocol operations and the like, etc. For example, in one embodiment, one or more requests and/or responses may include one or more modified, owned, exclusive, shared, invalid, dirty, etc. cache lines and/or cache lines with any other similar cache states etc.

In one embodiment, for example, one or more requests and/or responses may perform, be used to perform, correspond to performing, form a part or parts or portion or portions of performing, etc. transaction processing, database operations, database functions, and the like etc. In one embodiment, for example, one or more requests and/or responses may include transaction processing information, database operations, database functions, commands, status, requests, responses, results, indications, etc. In one embodiment, for example, one or more requests and/or responses may include information related to, corresponding to, associated with, etc. one or more of the following (but not limited to the following): transactions, tasks, composable tasks, noncomposable tasks, combinations of these and/or any other similar information and the like, etc. In one embodiment, for example, one or more requests and/or responses may perform, be used to perform, correspond to performing, form a part or parts or portion or portions of performing, etc. one or more atomic operations, set of atomic operations, and/or any other linearizable, indivisible, uninterruptible, etc. operations, combinations of these and/or any other similar operations, transactions, and the like, etc.

In one embodiment, for example, one or more requests and/or responses may perform, be used to perform, correspond to performing, form a part or portion of performing, generate the performance of, directly create, indirectly create, execute, implement, etc. one or more transactions, operations, etc. that may include, possess, etc. one or more of the following (but not limited to the following) properties: atomic, consistent, isolated, durable, and/or combinations of these and/or any other similar properties of operations, transactions, and the like, etc. In one embodiment, for example, one or more requests and/or responses may perform one or more transactions that are atomic, consistent, isolated, durable, etc.

In one embodiment, for example, one or more requests and/or responses may perform, be used to perform, correspond to performing, form a part of portion of performing, execute, implement, etc. one or more transactions that may correspond to (e.g. are a result of, are part of, create, generate, result from, for part of, etc.) a task, a transaction, a roll back of a transaction, a commit of a transaction, an atomic task, a composable task, a noncomposable task, and/or combinations of these and/or any other similar tasks, transactions, database operations, database functions, any other operations, commands, and the like, etc. In one embodiment, for example, one or more requests and/or responses may perform, be used to perform, correspond to performing, form a part of portion of performing, execute, implement, etc. one or more transactions that may correspond to a composable system, any other similar system, etc.

In one embodiment, for example, one or more requests and/or responses may perform, be used to perform, correspond to performing, form a part of portion of performing, etc. one or more operations, transactions, messages, status, etc. that may correspond to (e.g. form part of, implement, etc.) memory ordering (e.g. as defined above, elsewhere herein and/or in one or more specifications incorporated by reference, etc.). In one embodiment, for example, one or more requests and/or responses may perform, be used to perform etc. one or more operations etc. that may correspond to one or more of the following, but not limited to the following: implementing program order, implementing order of execution, implementing strong ordering, implementing weak ordering, implementing one or more ordering models, implementing combinations of these and/or any other implementations that may correspond to similar ordering, ordering models, program ordering, and/or any similar ordering and the like, etc.

In one embodiment, for example, one or more locks, memory locks, process locks, thread locks, synchronization functions, and/or any other locks, access controls, and/or similar software, logic, etc. constructs, techniques, mechanisms, algorithms, and the like etc. may be used. For example, one or more messages, parts or portions of a message, etc. from a CPU and/or any other system component may control, create, manage, remove, insert, modify, alter, change, etc. one or more aspects, properties, parameters, etc. of one or more locks, controls, and the like etc. For example, a lock etc. may control access to one or more memory addresses, memory address ranges, and/or any region, part, portion, etc. of memory, storage, etc. on one or more logic chips, stacked memory chips, and/or in any location. For example, control, management, restriction, allowance, timing, ordering, security, trust, credentials, certification, synchronization, etc. of access may be determined by CPU, request ID, thread, process and/or any information, data, aspect, parameter, field, flag, bits, etc. For example, one or more fields, bits, flags, etc. included in one or more requests, raw commands, and/or any other commands, requests, etc. may be used to control, manage, manipulate, modify, regulate, govern, synchronize, time, arbitrate, and/or otherwise control etc. one or more locks, one or more lock properties, one or more lock parameters, one or more lock functions, and/or any aspect, behavior, function, etc. of one or more locks, access controls, locked resources, locked access, etc. Locks and/or access controls may include any function, technique, behavior, logic, etc. that may control, regulate, govern, and/or otherwise manage access to memory and/or any manage any operation(s) related to memory, etc. For example, locks and/or access controls may restrict access and/or other actions, operations, etc. to a memory location, memory region, memory class, etc. For example, locks and/or access controls may limit memory access etc. to a particular thread, CPU, etc. For example, locks and/or access controls may limit memory operations (e.g. changing memory, modifying memory, copying memory, repair, and/or any operations and the like etc.). For example, locks and/or access controls may restrict access etc. during a limited time period. For example, locks and/or access controls may manage access etc. by one or more threads etc. Of course locks and/or access controls may restrict and/or otherwise manage access etc. by any system component, CPU, etc. in any manner, fashion, etc. and/or using any functions, behaviors, techniques, etc.

In one embodiment, for example, a memory system including one or more stacked memory packages may support, provide, use, employ, implement, etc. one or more synchronization techniques, synchronization primitives (e.g. synchronization operations, synchronization instructions, and/or any other synchronization related, timing related functions, behaviors, and the like etc.). For example, supported synchronization techniques may include, but are not limited to: memory barriers, per-CPU variables, atomic operations, spin locks, semaphores, mutexes, seqlocks, read-copy-update (RCU), combinations of these and/or any other synchronization techniques, primitives, operations, and/or any similar functions, and the like etc.

In one embodiment, for example, a memory system including one or more stacked memory packages may support one or more OS, kernel, etc. synchronization techniques, synchronization primitives, synchronization functions, synchronization behaviors, synchronization operations, and/or any other synchronization related mechanisms, etc. For example, a memory system including one or more stacked memory packages may provide support etc. for local interrupt disable, local softirq disable, etc.

In one embodiment, for example, support for an atomic operation in a memory system including one or more stacked memory packages may include support for, implementation of, support for one or more parts of, portions of, etc. one or more read-modify-write (RMW) instructions. For example, atomic operation support etc. may include support for a RMW command, request, instruction, raw command, etc. For example, atomic operation support etc. may include support for a RMW command directed to, operating on, etc. a counter in memory, a memory location, a data variable, a memory location counter, a counter held in cache and/or any other storage locations, and/or any other counter mechanism, circuit, function, etc. Such support may be provided, implemented, executed, controlled, managed, etc. by a logic chip, a stacked memory chip, combinations of these and/or any other logic, circuits, functions, etc. in one or more stacked memory packages and/or any other system components etc.

In one embodiment, for example, support for a spin lock in a memory system including one or more stacked memory packages may include support for a lock with spin (e.g. with spinning, with busy-wait, with busy-waiting, etc.). In one embodiment, for example, spinning etc. may be implemented, supported, etc. in (e.g. using, employing, with, etc.) a logic chip, a stacked memory chip, combinations of these and/or any other logic, circuits, functions, etc. In one embodiment, spinning etc. may be implemented, for example, using logic, functions, circuits, etc. that may repeatedly check (e.g. continuously, in a loop, as a process, etc.) to see if a condition is met, true, etc. (e.g. an input is queued, a lock is available, a memory location has been updated, and/or any other condition, test, check, comparison, occurrence, event, signal, combinations of these and the like etc.). In one embodiment, for example, spinning etc. may also be used to generate a programmable, configurable, fixed, variable, etc. time delay, sleep period, wait period, spin time, and/or any similar function including delay, time, period, and the like etc.

In one embodiment of a memory system including one or more stacked memory packages, for example, support (e.g. hardware, software, firmware etc. that may implement one or more features, etc.) for a semaphore, flag, bit, field, variable, etc. in may include implementation of a lock with blocking wait (e.g. sleep, etc.) or other similar lock implementation. For example, support for a semaphore may include support to read, write, and/or otherwise access, etc. a variable, data location, etc. in memory, special register, cache location, and/or any location that may hold, keep, store, etc. data, variables, references, addresses, etc. For example, the semaphore, variable, etc. may provide an abstraction, a mechanism, an algorithm, a technique, etc. to control, manage, regulate, etc. access (e.g. by multiple processes on a CPU, by multiple processes on one or more CPUS, etc.) to a common resource (e.g. memory location, etc.) e.g. in a parallel programming environment and/or a multi user environment etc. For example, support for a semaphore, variable, etc. may include one or more techniques, circuits, functions, etc. to store, change, modify, access, track, etc. the number of resources, how many units of a resource are available, etc and/or any resource aspect, resource property, and the like etc. For example, support for a semaphore etc. may include one or more techniques etc. to store etc. the number of resources etc in one or more records, variables, memory locations, registers, and/or any other memory, storage locations, etc. For example, the record etc. may be kept, stored, maintained, etc. as a counter, multi-word counter, multiple counters, etc. For example, support for a semaphore etc. may include functions, circuits, etc. that may provide, execute, generated, create, etc. one or more operations to safely (i.e. without race conditions, in an atomic manner, etc.) modify (e.g. add, subtract, increment, decrement, adjust, and/or otherwise modify etc.) the record etc. For example, support for a semaphore may include functions etc. that may provide etc. one or more operations to safely modify the record etc. as units are required, consumed, requested, etc. or are freed, become free, are produced, etc. In one embodiment, for example, support for a semaphore may include the ability to wait, sleep, spin, etc. if necessary, required, desired, etc. In one embodiment, for example, support for a semaphore may include the ability to wait etc. until a unit, or a programmable number of units, etc. of a resource is free, is freed, is produced, becomes available, is made available, etc. In one embodiment, for example, support for semaphores may include support for one or more counting semaphores. For example, a counting semaphore may allow an arbitrary resource count (e.g. any number of resource units, etc.). In one embodiment, for example, support for semaphores may include support for one or more binary semaphores. For example, a binary semaphore may be restricted to, use, employ, etc. the values 0 and 1 (e.g. with the binary values 0/1 corresponding to a single resource being locked/unlocked, unavailable/available, etc.). Of course any number, type, form, structure, etc. of locks may be implemented, supported, etc. Of course any number, type, form, structure, etc. of resource may be used. Of course any number, type, form, structure, etc. of resources, records, counts, counters, locks, flags, semaphores, etc. may be used, utilized, and/or otherwise employed in any of the schemes, algorithms, steps, functions, actions, behaviors, etc. described above and/or elsewhere herein and/or in one or more applications incorporated by reference.

In one embodiment, for example, support for one or more parts etc. of a seqlock may be provided that may implement a lock based on an access counter.

In one embodiment, for example, support for one or more parts etc. of a read-copy update (RCU) synchronization primitive may be provided, implemented, etc. that may implement lock-free access to shared data structures through pointers.

In one embodiment, for example, support for, implementation of, etc. one or more locks, lock primitives, synchronization, synchronization operations, and the like may include support for one or more of the following, but not limited to the following: locks, synchronization, lock mechanisms, synchronization mechanisms, advisory locks, mandatory locks, lock elision, lock eliding, elided locks, lock acquisition, lock release, database locks, spinlocks, test-and-set primitives and/or operations, fetch-and-add primitives and/or operations, compare-and-swap primitives and/or operations, put-and-delete primitives and/or operations, Dekker's algorithm, Peterson's algorithm, Lamport's bakery algorithm, Szymanski's Algorithm, Taubenfeld's black-white bakery algorithm, exclusive locks, synclocks, mutex, mutual exclusion, re-entrant mutex, concurrency controls, atomic operations, read writer locks, RCU primitives, semaphores, wait handles, event wait handles, lightweight synchronization, spin wait, barriers, double-checked locking, lock hints, recursive locks, timed locks, hierarchical locks, combinations of these and/or any other locks, locking mechanisms, controls, synchronization primitives, operations and the like, etc.

Of course any number, type, form, structure, behavior, function, etc. of locks, lock primitives, lock operations, synchronization operations, and/or any other related lock elements, lock structures, counters, lock mechanisms, lock components, synchronization components, combinations of these and/or any other related aspect of locks, locking mechanisms and the like etc. may be used, implemented, employed, supported, etc. (e.g. including different forms, types, structures, etc. of locks, lock functions, lock mechanisms, lock techniques, and/or any other lock related aspects etc. as described above, elsewhere herein, and/or in one or more specifications incorporated by reference, etc.).

In one embodiment, for example, one or more lock instructions and/or lock operations, lock functions, and/or any lock related functions, synchronization related functions and the like etc. may be used, supported, implemented, executed, processed, employed, etc by one or more stacked memory packages etc. For example, in one embodiment, a compare-and-swap instruction (CAS) may be used, etc. For example, in one embodiment, a CAS instruction may be an atomic instruction. For example, in one embodiment, a CAS instruction may be used to achieve synchronization e.g. in multithreaded operation etc. For example, in one embodiment, a CAS instruction may compare a first value and a second value. For example, the first value may correspond to the data contents of a memory location (e.g. with the location provided, transmitted, conveyed, carried, sent, etc. to one or more stacked memory packages etc. as part of the instruction command, part of a command packet, part of a raw command, part of a raw command embedded in a request, and/or otherwise transmitted, sent, conveyed, etc.). For example, the second value may be provided as part of the CAS instruction command etc. For example, in one embodiment, only if the first value and the second value are the same, equal, etc. the CAS instruction may modify the contents of the memory location to a third value (e.g. provided as part of the instruction command etc.). In one embodiment, for example, the CAS instruction may be performed, executed, etc. as a single atomic operation. In one embodiment, for example, the CAS instruction may indicate, respond with, include, etc. a result, response, indication, flag, status, error, etc. For example, in one embodiment, the CAS instruction may indicate a Boolean response (e.g. a compare-and-set instruction, operation, etc.). For example, in one embodiment, the CAS instruction may indicate a response equal to the first value read from the memory location. Of course any number, type, form, structure, etc. of response, indication, result, etc. may be used. Of course a CAS instruction has been used by way of example. Any type, form, number, structure, etc. of instruction etc. may be used to implement etc. any lock operations, lock functions, and/or any lock related functions, synchronization related functions and the like etc.

In one embodiment, for example, one or more lock instructions and/or lock operations, lock commands, lock functions, locking behaviors, and/or any lock related functions, synchronization related functions and the like etc. may be used, supported, implemented, executed, processed, employed, etc by one or more memory controllers and/or any other logic, circuits, and the like etc. in a stacked memory package etc. In one embodiment, for example, a CAS instruction may be supported, implemented, executed, etc. by one or more memory controllers etc. that may be included in a stacked memory package.

In one embodiment, for example, one or more memory references (e.g. memory access commands, requests, etc.) may be stored in one or more memory controllers using, employing, etc. one or more tables, data structures, FIFOs, buffers, indexes, pointers, linked lists, and/or any other similar storage, memory, storage structures, and the like etc. Any form, type, number of memory references, access commands, requests, and the like etc. may be used. Memory references etc. may be sorted, marked, arbitrated, multiplexed, prioritized, and or otherwise processed, manipulated, etc. In one embodiment, for example, memory references etc. may be sorted etc. by, using, based on, employing, etc. the DRAM bank and/or any other partition etc. employed by the access. In one embodiment, for example, memory references etc. may be sorted etc. based on echelon, section, bank, combinations of these and/or based on any other memory division, partition, parts, portions, and/or based on any metric, parameter, command field, and the like etc. In one embodiment, for example, memory references etc. may be sorted etc. by traffic class, memory class, and/or any similar field, parameter, metric, marking, property, and the like etc. In one embodiment, for example, memory references etc. may be sorted etc. by tag, ID, timestamp, and/or other similar parameters, fields, data, information and/or any other similar property and the like, etc. Note that, in one embodiment, sorting etc. may be performed according to, based on, using, etc. more than one parameter etc. Thus, for example, data (e.g. pending memory references and associated information etc.) may be partitioned in more than one way, using more than one parameter, index, metric, value, etc. Thus, for example, pending memory references etc. and associated information, data, etc. may be partitioned into one or more memory sets (as defined herein and/or in one or more specifications incorporated by reference) e.g. by using one or more parameters, metrics, values, and/or any other command, memory reference properties, and the like etc. In one embodiment, for example, each stored pending memory reference etc. may include the following fields (but not limited to the following fields): load/store (L/S) indication, row address, column address, data, state information used by the scheduling algorithm, combinations of these and/or any other similar fields and the like, etc. The pending memory reference state information may include any information carried, conveyed, transported, etc. by one or more commands received, for example, by the memory controller. The pending memory reference state information may include any information generated, created, modified, etc. by the memory controller, memory access scheduler, and/or any other logic, etc. For example, the pending memory reference state information may include, but is not limited to, the following information: traffic class, virtual channel, type of traffic (e.g. ISO, real-time, etc.), priority (e.g. from a command packet, generated by the memory controller, etc.), request ID, any other tag or ID information, request or reference type (e.g. load, store, read, write, raw instruction, atomic instruction, lock, test instruction, register operation, mode register operation, configuration operation, message, status, etc.), memory class, timestamp (e.g. in/from a command packet, generated by the memory controller, etc.), any other command packet fields (e.g. command type, command code, raw command code, instruction code, and/or any field, data, information, etc. from any instruction, command, request, reference, etc.), any other command and/or packet flags, any other command and/or packet bits, combinations of these and/or any other data, information, from any source, etc. Note that the stored pending memory reference data, fields, information, etc. do not necessarily have to be stored in the same structure, etc. For example, in one embodiment, pending memory reference data etc. may be stored separately from any other fields, data, information, etc. For example, in one embodiment, each bank and/or any other memory partitioning(s) etc. may have its own pending memory reference data storage, etc. For example, in one embodiment, all pending memory reference data may be stored in one or more structures etc. and the space etc. assigned to, associated with, corresponding to, allocated to, etc. the structure(s) for each bank and/or any other partitioning of the data etc. may be dynamic, programmed, configured and/or otherwise set, changed, modified, etc. Such dynamic space allocation etc. may be performed at any time in any manner, fashion, etc. and using any techniques, etc.

In one embodiment, for example, pending memory reference state information used by the scheduling algorithm may be used to support lock instructions, etc. In one embodiment, for example, one or more bits, flags, fields, counters, pointers, etc. to mark, indicate, track, record, etc. lock state and/or otherwise support lock instructions, etc. may be included, appended, etc. to pending memory reference data etc.

For example, in one embodiment, one or more memory controllers may include one or more memory access schedulers. For example, a memory access scheduler, parts of a memory access scheduler, etc. may be implemented in the context of FIG. 28-4 and/or any other figures of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, one or more pending memory reference storage structures, etc. may use one or more FIFOs, and/or any other similar logic structures, circuits, functions, etc. that may be implemented in the context of FIG. 28-4 and/or any other figures of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or the text description that is associated with FIG. 28-4 (including, but not limited to, for example, the description of data structures, lists, arbiters, arbitration, command/reference ordering, memory sets, memory classes, etc. and their uses, functions, properties, etc.).

For example, in one embodiment, one or more memory controllers may include portion, part, etc. of an Rx datapath, For example, in one embodiment, a portion of an Rx datapath may include (but is not limited to): a FIFO or similar data structure etc. (RxFIFO); an arbiter or similar circuit function, etc. (RxARB); and/or any other components, etc. For example, the RxFIFO may include one or more copies of FIFOs, lists, tables, and/or any other similar data structures etc. For example, the RxFIFO may include, for example, two lists (e.g. linked lists, register structures, tabular storage, etc.). For example, the two lists may include FIFO A and FIFO B. For example, in one embodiment, the RxFIFO may store (e.g. maintain, capture, operate on, etc.) one or more commands, parts of one or more commands, etc. (e.g. write commands, read, commands, any other requests, pending memory references, etc.) received by the memory controller. The commands etc. may include one or more fields that may include (but are not limited to) the following fields: CMD (e.g. command, read, write, any other request, etc.); ADDR (e.g. address field, reference, any other address information, etc.); TAG (e.g. identifying sequence number, command ID, etc.); DATA (e.g. write data for write commands, etc.).

For example, in one embodiment, the lists etc. in one or more FIFO structures etc. may include information from (e.g. extracted from, copied from, stored in, etc.) one or more commands (e.g. read commands, write commands, memory references, and/or any memory access commands and the like, etc.). For example, FIFO A may store commands (and/or information associated with commands, memory references, and the like, etc.) that may have odd addresses, odd references; and FIFO B may store commands or information associated with commands that may have even addresses etc. For example, in one embodiment, one or more memory portions may be separated (e.g. collected, grouped, partitioned, etc.) into two memory sets, groups, etc: with one memory set labeled A and one memory set labeled B. For example, memory portions labeled A may correspond to (e.g. be associated with, etc.) memory portions with odd addresses and memory portions labeled B may correspond to memory portions with even addresses. Any technique of separation, any address bit(s) position(s), etc. may be used (e.g. separation is not limited to even and odd addresses, etc.). Any physical grouping may be used (e.g. groups, memory sets, etc. A and B may be on the same chip, on different chips, combinations of these and/or any other groupings, etc.). Any function etc. may be used, performed, etc. on one or more groups, etc. Grouping, collections, sets, lists, etc. may be used for any purpose, function, operation, etc. For example, in one embodiment, there may be two lists etc. using one or more FIFO structures etc. Of course, any number, type, form, structure, etc. of lists may be used. For example, in one embodiment, there may be four entries for each FIFO, but any number, type, form, etc. of entries may be used. For example, in one embodiment, the FIFO structure etc. may include addresses, commands, portions of commands, pointers, linked lists, tabular data, and/or any other data, fields, information, flags, bits, etc. to maintain, control, store, operate on, etc. one or more commands, pending memory references, etc.

For example, in one embodiment, the RxARB and/or any other control logic, etc. may order the execution (or schedule the execution, the retirement, the processing, the handling, etc.) of one or more commands stored (or otherwise maintained, etc.) in the FIFO structure(s). For example, the RxARB may cause the commands associated with (e.g. stored in, pointed to, maintained by, etc.) FIFO A to be executed (e.g. in cooperation, in conjunction with, etc. one or more memory controllers etc.) in a first time period, time slot, etc; and the commands associated with FIFO B to be executed in a second time period, time slot, etc.

For example, in one embodiment, such use of one or more FIFO structure(s) may have the effect of (e.g. permit, allow, enable, etc.), for example, executing commands associated with memory portions labeled A in a first time period and executing commands associated with memory portions labeled B in a second time period. Such a design, architecture, etc. may be useful, for example, in controlling power dissipation, improving signal integrity, in the ordering of memory references, and/or performing any other functions, etc. to manage, control, order and/or otherwise process a set, group, stream, etc. of commands, memory references, etc. in a stacked memory package.

For example, in one embodiment, the effect of command reordering may thus be to segregate, separate, partition, etc. a group of memory portions (e.g. in a memory system, in a stacked memory package, in a stacked memory chip, in combinations of these, etc.) into one or more memory classes (as defined herein and/or one or more specifications incorporated by reference), memory sets, collections of memory portions, sets of memory portions, partitions, combinations of these and/or any other groups, etc. Thus, for example, in one embodiment, the effect of command reordering may be to provide an abstract view of the memory portions. For example, in this case, the memory system may act as (e.g. appear as, behave as, have an aspect of, be viewed as, etc.) one large physical assembly (e.g. structure, array, collection, etc.) of memory portions. The abstract view in this case may be thus be one large memory structure, etc. The effect of command reordering in this case may be to have the memory structure be separated into two memory structures (e.g. virtual structures, etc.) each operating in a different time period (e.g. the logical view, etc.). Thus, for example, in one embodiment, power dissipation properties, metrics, functions, behaviors, etc. of the memory structure may be reduced, improved, controlled, etc. relative to a memory structure without command reordering. In addition, for example, the location(s) of power dissipation may be controlled (e.g. density, hot spots, etc.). For example, in one embodiment, if memory portion sets (memory sets) A and B are on the same stacked memory chip, then the power dissipation, power dissipation density, hot spots, etc. of each stacked memory chip may be reduced. For example, in one embodiment, if memory sets A and B are on different memory chips then the power dissipation (e.g. power dissipation density, location(s) of power dissipation, timing of power dissipated, etc.) in a stack of stacked memory chips may be controlled, managed, limited, regulated, etc.

In one embodiment, for example, one or more (memory) sets may be used to perform locking, implement locks, etc. For example, in one embodiment, a set may correspond to a list of atomic instructions to be performed in order, as an atomic unit, etc. Thus, for example, in one embodiment, a CAS instruction may be expanded to, broken down to, divided as, formulated as, etc. a memory set that may include, contain, consist of, comprise, etc. a sequence, collection, group, etc. of instructions, commands, memory references, etc. For example, in one embodiment, a CAS instruction may expand etc. into a set of three commands. For example, in one embodiment, instructions may expand, etc. into one or more expanded commands (e.g. sub-commands, sub-instructions, etc.). For example, in one embodiment, an expanded command may be an internal command. For example, in one embodiment, an internal command may be generated by logic on a logic chip in a stacked memory package, etc. For example, in one embodiment, in the above case, the first expanded command may be an internal command. For example, in this case, the internal command may be a memory read of a first value issued to a memory reference (e.g. a read command, memory reference). For example, in one embodiment, the second expanded command may be an internal command to perform a compare operation between the first value and a second value. For example, in one embodiment, the third expanded command may be a memory write internal command that may write a third value, issued to the memory reference.

In one embodiment, there may be one or more other forms of commands in addition to, for example, internal commands. In one embodiment, for example, an external command may be a command that is not part of, generated from, etc. another instruction, command, etc. For example, in one embodiment, an external command may be a read request issued by a CPU to one or more stacked memory chips. Of course an external command may be any type, form, etc. of read command, read request, write command, write request, and/or any other type, form, etc. of command, raw command, request, status, message, combinations of any of these, etc. An external command may, for example, in one embodiment, describe a command etc. as transmitted by a CPU, as received by a stacked memory package (e.g. as a packet, series of packets, set of packets, etc.), and/or as processed by logic on a stacked memory chip (e.g. as represented on an internal bus, internal to a logic chip, etc.), as processed by a stacked memory chip (e.g. as one or more DRAM commands, etc.) and/or as represented, carried, transmitted, conveyed, coupled, etc. in any manner, fashion, using any techniques, etc.

In one embodiment, for example, an internal command may be a command that is part of, generated from, etc. another instruction, command, etc. For example, in one embodiment, one or more internal commands may be generated from an external command. For example, in one embodiment, one or more internal commands may be expanded from (e.g. generated from, created from, translated from, modified from, etc.) an external command. For example, in one embodiment, one or more external commands may expand to (e.g. generate, create, modify to, be altered to, be changed to, etc.) one or more internal commands. Note, however, that not all external commands need be expanded etc. to internal command(s).

In one embodiment, for example, the difference between an internal command and an external command may depend on one or more of the following (but not limited to the following) properties, etc. of the command: context, use, employment, implementation, origin, source, location, etc. In one embodiment, for example, the difference between an internal command and an external command may be considered to be the origin of a command. For example, in one embodiment, an external command may be viewed as being created, generated, originating from, etc. a source, sources, etc. external to a stacked memory package, etc. For example, commands created etc. outside the package of a stacked memory package, etc. may be considered external commands, etc. In one embodiment, for example, the difference between an internal command and an external command may be considered to be the visibility of a command. For example, in one embodiment, an external command may be viewed, may exist, may be represented, may be transmitted, may be conveyed, may be carried, etc. externally to a stacked memory package, etc. For example, in one embodiment, an internal command may be viewed as being created, generated, originating from, etc. a source, sources, etc. internal to a stacked memory package, etc. and/or visible, existing, etc. inside a stacked memory package, etc. Note that commands may include responses, completions, etc. In this case, for example, an external response may be a response that is generated internally to a stacked memory package but that is visible outside the stacked memory package, etc. Although the use and meaning of terms including internal commands and external commands in the context of, for example, a stacked memory package may be clear from the context in which the terms are used these terms may further defined, clarified, expanded, etc, in one or more of the embodiments described herein and/or in one or more specifications incorporated by reference.

For example, in one embodiment, a CAS instruction, CAS commands, etc. may be an external instruction, command, operation, etc. For example, in one embodiment, a CAS instruction etc. may be generated, created, formed, transmitted, etc. by a CPU and/or other system component (e.g. outside a stacked memory package, etc.). For example, in one embodiment, a CAS instruction etc. may expand into, map into, generate, etc. a set of one or more commands (e.g. to one or more sub-commands, sub-instructions, etc.). For example, in one embodiment, a CAS instruction, command, etc. may be represented, may be associated with, may correspond to, etc. a command code and/or similar code, other designation, etc. For example, the command code etc. for a CAS instruction may be 1000. Of course command codes etc. may be of any type, form, length, number, etc. Of course commands may be identified, designated, etc. by codes, fields, etc. or by any other similar technique, etc. For example, the command code for a read command READ may be 0001. For example, the command code for a write command WRITE may be 0010. For example, the command code for a compare instruction COMPARE may be 0100. For example, in one embodiment, a CAS instruction may expand into the sequence etc. of commands/instructions: 0001, 1000, 0010 (e.g. READ, COMPARE, WRITE). In this case, for example, one or more of the expanded commands etc. may be internal commands, instructions, operations, etc. In this case, for example, one or more of the internal commands may use the same command codes as the equivalent, corresponding, etc. external commands. For example, in one embodiment, in this case the command code for an internal read command may be the same as the command code for an external read command (e.g. both may use, be represented by, etc. command code 0001, etc.). In this case, for example, in one embodiment, one or more additional fields, bits, flags, combinations of these and/or any other data, etc. may be used to bind, collect, group, glue, etc. one or more internal commands. For example, in one embodiment, the sequence of READ, COMPARE, WRITE commands corresponding to a CAS instruction may be bound etc. For example, in one embodiment, a command tag, ID, sequence number, etc. that may be present, part of, included within, etc. the external command may be extended. For example a CAS instruction (e.g. an external command, etc.) may have a command tag etc. of 00011 (e.g. decimal 3). Of course, external command tags etc. may be of any type, form, length, number, etc. For example, in one embodiment, the CAS instruction may be expanded etc. to three internal commands with tags of 00011_00 (for the internal READ), 00011_01 (for the internal COMPARE), 00011_10 (for the internal WRITE). In this case, in one embodiment, the sequence of the extended tags, tag extensions, extensions, etc. (e.g. appended bits 00, 01, 10, etc. may serve to indicate the sequence of instructions and/or commands, etc. Of course, internal command tags etc. may be of any type, form, length, number, etc. Of course, command tag extensions, may be of type, form, length, etc. Of course extending of tags, etc. may take any type, form, etc. and/or be performed in any manner, fashion, using any techniques, etc. Of course, any techniques may be used to bind etc. one or more commands, instructions, etc. In one embodiment, for example, internal command tags may serve to bind, implement the binding of, perform binding of, etc. one or more internal instructions. In one embodiment, for example, one or more internal instructions may be bound etc. to form one or more atomic operations, etc. In one embodiment, for example, binding of commands, binding of instructions, and/or any type, form, etc. of binding, collecting, grouping, etc. one or more commands, instructions, requests, responses, messages, status, etc. may be performed, executed, implemented, etc. in any manner, fashion, using any techniques, etc.

For example, in one embodiment, a CAS instruction may expand etc. into a set of one or more special, unique, etc. commands. For example, in one embodiment, a CAS instruction, command, etc. may be represented, associated with, etc. a command code. For example, in one embodiment, the command code for a CAS instruction may be 1000. For example, the command code for an external read command READ may be 0001. For example, the command code for an external write command WRITE may be 0010. For example, the command code for an internal read command READ may be 1001. For example, the command code for an internal write command WRITE may be 1010. For example, the command code for a compare instruction COMPARE may be 0100. For example, in one embodiment, a CAS instruction may expand into the sequence, group, set, collection, etc. of commands and/or instructions: 1001, 1000, 1010 (e.g. INTERNAL_READ, COMPARE, INTERNAL WRITE). In this case, for example, in one embodiment, one or more of the internal commands etc. may use a different command code from the equivalent, corresponding, etc. external commands etc. For example, in this case, in one embodiment, the command code for an internal read command may be 0001 and the command code for an external read command may be 0001, etc. Thus, it may be seen, for example, from the above descriptions of command codes, tag extensions, command expansion, etc. that handling, processing, storing, controlling, managing, etc. of internal commands and/or instructions, external commands and/or instructions, grouping of commands and/or instructions, expansion etc. of commands and/or instructions, and/or any other command, instruction, etc. handling and the like etc. may be performed, executed, managed, etc. in a number of ways, fashions, manners, and/or using a number of techniques, etc.

In one embodiment, for example, a command set may include, define, contain, include, comprise, etc. the set, collection, group, list, etc. of commands, instructions, requests, responses, completions, etc. For example, the command set may include the set of commands, requests, instructions, messages, status, etc. that may be transmitted, sent, etc. by a CPU and/or any other system component to a stacked memory package. For example, the command set may include the set of completions, responses, messages, status, etc. that may be received etc. by a CPU and/or any other system component from a stacked memory package. In one embodiment, for example, a command set may comprise any form, type, number, structure of commands, requests, completions, responses, messages, status, error, and the like including, but not limited to: write commands, write requests, read commands, read requests, atomic commands, super commands, multi-part commands, read responses, write completions, error messages, status messages, mode register commands, more register responses, combinations of these and the like etc. In one embodiment, for example, there may be more than one variation, variant, version, etc. of one or more such commands etc in a command set. For example, there may be read requests for various lengths of read in a command set. For example, there may be write requests of various lengths in a command set. There may be various fields, flags, bits, bit fields, tokens, and/or any other data, information, etc. that may be included in one or more commands etc. in a command set. For example, the various fields etc. may correspond to, include, contain, etc. one or more of the following, but not limited to the following: bit masks, critical word order, traffic class, virtual channel, traffic type, memory class, command ID, tag, credits, tokens, sequence number, error codes, data protection codes, checksums, CRC, hash values, flow control, addresses, operand values, operation codes, operators, instructions, reserved fields, user-specific fields and/or values, timestamps, metadata, priority, ordering information, atomic operation, transaction type, transaction data, instruction codes, command codes, write data, data masks, read data, response data, response codes, response flags, request data, completion data, completion codes, completion flags, error and/or any other status, data poisoning, headers, header type, packet type, packet length, header length, data length, tail fields, byte counts, flags, digests, markers, messages, register addresses, register data, and/or any other fields, flags, bits, data, information, and the like etc.

Thus, for example, in one embodiment, a command set may include one or more access operations, commands, requests, etc. An access operation etc. may refer to a operation etc. that accesses memory (e.g. a read, load, write, store, etc.). Thus, for example, in one embodiment, a CAS instruction may be part of, included in, etc. a command set. A CAS instruction may be referred to, for example, as a data operation, data instruction, data command, etc. A data operation etc. may perform some operation on data obtained from, read from, and/or otherwise related to one or more data objects etc. stored in memory, etc. Other instructions, commands, operations in a command set etc. may include: read, write, compare-and-swap, test-and-set, fetch-and-add, add, subtract, shift, increment, decrement, and/or any other similar data operations, access operations, instructions, atomic instructions, primitives, combinations of these and/or any other arithmetic and/or logical instructions, operations, functions and the like, etc.

Thus, for example, in one embodiment, a command set may include one or more external commands etc. Thus, for example, in one embodiment, a command set may be an external command set. For example, in one embodiment, an external command set may be a command set that may include those commands, instructions, operations, etc. that may be visible, conveyed, transported, encoded, represented, manifested, etc. externally to, outside of, etc. a stacked memory package. For example, in one embodiment, external commands may be those commands etc. that are visible, conveyed, carried, transported, encoded, represented, manifested, etc. outside, external to, etc. a stacked memory package. Note that, in one embodiment, a stacked memory package may modify, change, alter, etc. an external command (e.g. as an external command etc. is forwarded etc.). Note that, in one embodiment, a stacked memory package may generate etc. one or more external commands. For example, in one embodiment, a stacked memory package may generate responses, completions, etc. For example, in one embodiment, a stacked memory package may generate an error message etc.

In one embodiment, for example, there may be one or more command sets. For example a first command set may correspond to a set of internal commands. For example, a second command set may correspond to a set of external commands. In one embodiment, for example, the difference between an internal command and an external command may be considered to be the visibility of a command. For example, in one embodiment, an external command may be viewed, may exist, may be represented, may be transmitted, may be conveyed, may be carried, etc. externally to a stacked memory package, etc. For example, in one embodiment, an internal command may be viewed as being created, generated, originating from, etc. a source, sources, etc. internal to a stacked memory package, etc. and/or visible, existing, etc. inside a stacked memory package, etc. Thus, for example, an internal command set may be regarded, viewed, defined, etc. as a set of commands that may be visible, observable, operable, executable, functional, defined, etc. inside a stacked memory package. Thus, for example, an external command set may be regarded, viewed, defined, etc. as a set of commands that may be visible, observable, operable, executable, functional, defined, etc. outside a stacked memory package. In one embodiment, for example, one or more external commands may map to one or more internal commands (e.g. in a one-to-many and/or any other mapping etc.) In one embodiment, for example, a compare instruction, which may be part of an internal command set, may be expanded from, included with, etc. a CAS instruction, which may be part of an external command set. Of course the distinction between an internal commands et and an external commands set need not depend on a physical boundary (e.g. such as a package, assembly, structure, etc.). In one embodiment, for example, the boundary between an internal command set and an external command set may not be physical, but may be defined by a logical boundary or any other similar boundary, line, partitioning, etc. In one embodiment, for example, the boundary between an internal command set and an external command set may depend on the command. Thus, for example, in one embodiment, one or more external commands may be converted, mapped, changed, etc. to/from internal commands. The point at which the conversion, etc. is made may also be viewed as a boundary between internal commands and external commands. Thus, for example, each command may be viewed as having a boundary.

In one embodiment, for example, there may be more than one internal command set. For example, a complex command may map to one or more commands. For example, an external CAS command may map to one or more internal commands of a first type. For example, an external CAS command may map to a set of internal commands that may include a READ command that may be a member of a first internal command set (e.g. a first command set, etc.). In one embodiment, for example, the internal READ command may then be mapped to, generate, etc. one or more low-level commands (e.g. native DRAM commands, signals, combinations of commands and signals, etc.). For example, in this case, the one or more low-level DRAM commands may be viewed as a second type of internal command set (e.g. a second command set, etc.). Thus, in general, there may be any number of command sets (e.g. internal command sets, external command sets, etc.). Thus, in general, the boundaries between commands in different commands sets may be physical (e.g. package boundaries, etc.), logical (e.g. located at circuits that perform command conversion, etc.), and/or make take any other form. Thus, in general, the boundaries between commands in different commands sets may depend on the commands. Note also that the number of boundaries may be different for each command. For example, a complex command (e.g. CAS command, etc.) may map to one or more internal commands of a first type (e.g. including a READ command, etc.) at a first boundary that may subsequently map to one or more internal commands of a second type (e.g. low-level command, etc.) at a second boundary. Thus, for example, in this case, a complex command may cross two boundaries. For example, a simple command (e.g. READ command, etc.) may directly to one or more internal commands (e.g. low-level commands, etc.) at a third boundary. Thus, for example, in this case, a simple command may cross a single boundary. In one embodiment, in this case, the second boundary (for the complex command) may be the same as the third boundary (for the simple command), but need not be.

In one embodiment, for example, a command set (e.g. internal command set, external command set, etc.), command mapping, command conversion, command execution, command functions, etc. and/or any aspect of any commands, instructions, command sets, instruction sets, etc. may be configurable, programmable, etc. The configuration etc. may be performed etc. in any manner, any fashion, at any time, and/or using any techniques, etc. In one embodiment, for example, one or more part, portions, etc. of one or more aspects, features, functions, etc. that are part of, associated with, correspond to, etc. a command set may be controlled, performed, executed, etc. using microcode, etc.

In one embodiment, for example, one or more commands, instructions, requests, responses, completions, and/or any members, parts, structures, etc. of a command set, instruction set, etc. may be made up from, may include, may contain, may be constructed from, etc. one or more parts, pieces, portions. In one embodiment, for example, a first command and a second command may be, may form, may include, may comprise, may contain, etc. two parts, portions, pieces, etc. of a third command, a multi-part command, that may carry one or more embedded (e.g. included, inserted, nested, contained, etc.) commands, such as the first command and the second command. Of course, any number, type, form, structure, etc. of parts, pieces, portions, etc. may be used.

In one embodiment, a command may include multiple commands. For example, in one embodiment, a write with reads command may include a write command with one or more embedded read commands. Such a command may be referred to as a multi-command command (also referred to as a jumbo command, super command, etc.). A super command may be used, in one embodiment, for example, to logically inject, insert, etc. one or more read commands into a long write command. Of course, multiple commands, multi-command commands, super commands, jumbo commands, and/or any other similar form, structure, type, etc. of commands, requests, responses, completions, messages, etc. and the like may be used for any purpose, function, etc.

The difference between a multi-part command and a super command etc. may depend on context, etc. For example, in one embodiment, commands may be transmitted using one or more packets. In this case, for example, in one embodiment, a super command may be a single command packet, packet structure, etc. that may include more than one command. Thus, for example, in one embodiment, a read command may be inserted inside, as part of, included within, etc. a write command to form a super command. The use of a super command may be beneficial, for example, to transmit, convey, send, carry, etc. one or more commands so that the processing etc. of a long write packet does not stall, impede, otherwise hinder, etc. processing of a short read command. In this case, for example, in one embodiment, the short read command may be embedded, inserted, injected etc. inside a packet structure of a write command. For example, in one embodiment, a multi-part command may include one or more packets etc. that may include more than one command. Thus, for example, in one embodiment, a read command packet (or packets) may be inserted between, embedded between, etc. packets (and/or any other parts, portions, pieces, packet fragments, packet segments, etc.) of a write command to form a multi-part command. The difference between a multi-part command and a super command etc. may depend on the point at which commands are observed, transmitted, received, conveyed, processed, executed, performed, etc. As a first example, in one embodiment, there may be little or no difference between the effects, parts, results, etc. etc. of a multi-part command and a super command etc. by the time that either has been translated, decomposed, processed, executed, etc. as one or more native DRAM commands. As a second example, in one embodiment, there may be little or no difference between a multi-part command and a super command etc. by the time that one or more responses have been generated, etc. Indeed, it may be beneficial, for example, in one embodiment, to ensure that the effects, parts, results, etc. of a first command sequence including a first write command and a first read command may be identical, equivalent, nearly equivalent, closely equivalent, logically equivalent, etc. to a second command sequence using a multi-part command that may include the equivalent of the first write command and the second read command. Similarly, it may be beneficial, for example, in one embodiment, to ensure that the effects, parts, results, etc. of a first command sequence including a first write command and a first read command may be identical, equivalent, nearly equivalent, closely equivalent, logically equivalent, etc. to a second command sequence using a super command that may include the equivalent of the first write command and the second read command.

For example, in one embodiment, in the case of a CAS instruction, the first value may correspond to the data contents of the memory reference, a memory location, etc. (e.g. with the location provided, transmitted, conveyed, carried, sent, etc. to one or more stacked memory packages etc. as part of (e.g. a field, memory reference, etc.) the CAS instruction command (or any other command that results in, is translated to, etc. a CAS instruction command, etc.), part of a command packet, part of a raw command, part of a raw command embedded in a request, and/or otherwise transmitted, sent, conveyed, etc.)

For example, in one embodiment, in the case of a CAS instruction, the first internal command may be generated by control logic, etc. located on one or more logic chips in a stacked memory package. In one embodiment, in the case that the first internal command is a memory read, the read command may use the same format, be stored in the same way, processed in the same way, retired, in the same way, scheduled in the same way and/or otherwise treated, handled, processed, etc. in the same way as an external read command, external memory reference (e.g. a read command that is not part of, generated from, etc. another instruction, command, etc.). In one embodiment, in the case that the first internal command is a memory read, the read command may use a special, unique, etc. command code and/or any other command fields, etc. to indicate, denote, etc. that the internal command is/was generated internally from an external command (e.g. CAS instruction, etc.).

For example, in the case of a CAS instruction, in one embodiment, the second value may be provided as part of the CAS instruction command etc (e.g. as an address field, a memory reference, etc.).

For example, in one embodiment, in the case of a CAS instruction, the second internal command may be generated by control logic, etc. located on one or more logic chips in a stacked memory package. In the case that the second internal command is a compare operation, compare command, compare instructions, etc. the command etc. may use a special, unique, etc. command code, etc. In one embodiment, the special command (e.g. compare command, compare instruction, compare instruction code, etc.), may use the same format, be stored in the same way, processed in the same way, retired, in the same way, scheduled in the same way and/or otherwise treated, handled, processed, etc. in the same way as an external read command, external memory reference (e.g. a read command that is not part of, generated from, etc. another instruction, command, etc.).

For example, in the case of a CAS instruction, in one embodiment, the second internal command may compare the first value and second value and only if the first value and the second value are the same, equal, etc. the third instruction may modify the contents of the memory location to a third value (e.g. provided as part of the instruction command etc.).

For example, in one embodiment, in the case of a CAS instruction, the third internal command may be generated by control logic, etc. located on one or more logic chips in a stacked memory package.

In one embodiment, for example, the CAS instruction may be performed, executed, etc. as a single atomic operation. In one embodiment, for example, the CAS instruction may indicate, respond with, include, etc. a result, response, indication, flag, status, error, etc. For example, in one embodiment, the CAS instruction may indicate a response equal to the first value read from the memory location. Of course any number, type, form, structure, etc. of response, indication, result, etc. may be used.

In one embodiment, for example, one or more operations, commands, requests, instructions, transactions, and the like etc. may be atomic. An operation (or set of operations, command, instructions, transactions, and the like etc.) may be atomic (also linearizable, indivisible, uninterruptible) if it appears to the system (e.g. rest of the system, a part of the system, etc.) to occur (e.g. execute, be performed, etc.) instantaneously and/or in a manner that cannot be divided, separated into steps, interrupted, etc.

For example, in one embodiment, the term atomic (or similar terms, terms with similar meanings, etc.) may describe, be applied to, correspond to, etc. a unitary command, request, instruction, action, function, behavior, transaction, and/or any other similar object and the like, etc. that may be essentially indivisible, unchangeable, whole, irreducible, etc. For example, in one embodiment, an atomic operation, command, instruction, transaction, etc. may be an operation etc. that will either complete or return to (or may be returned to) its original state. For example, an atomic operation etc. may return to (or may be returned to) its original state if a power interruption, abnormal situation, and/or like event, any other error, etc. occurs. For example, in one embodiment, an atomic operation, command, instruction, transaction, etc. may be an operation etc. executed, performed, competed, etc. in such a manner, fashion, etc. that no change in state may take place in the time between the receiving of a signal (and/or any other indication, signaling method, etc.) to change state and the setting, changing, etc. of the state, etc. The state of a system may include, for example, a set of variables, all the stored information, etc. at a given instant in time, to which the system (including, for example, circuits, programs, etc.) has access.

For example, in one embodiment, an atomic operation etc. may be a basic unit (e.g. indivisible unit, fundamental unit, etc.) of instructions sequences, collection of commands, command stream, executable code, data, combinations of these, etc. For example, in one embodiment, an atomic operation etc. may allow a CPU etc. to simultaneously read a location and write it in the same bus operation (or appear to do so to the system, etc.). For example, in one embodiment, such an atomic operation etc. may prevents any other CPU, I/O device, any other system component etc. from writing or reading memory until the atomic operation etc. is completed. For example, an atomic operation, atomic execution, etc. may imply the indivisibility, irreducibility, etc. of an operation etc. For example, in one embodiment, an atomic operation, atomic execution, etc may be such that the operation, execution, etc. must be performed entirely, completely, in full, to completion, successfully, etc. or not performed etc. at all.

A compound command may be a command that may include one or more commands that may include atomic and non-atomic commands. An atomic command may not include more than one command that may be executed outside the context of the atomic command. For example, in one embodiment, a compound command may include a first command and a second command. For example, the first command may fail and the second command may succeed. For example, in one embodiment, an atomic command may include, or be equivalent to, or may translate to, etc. a first command (and/or instruction, etc.) and a second command (and/or instruction, etc.). For example, in one embodiment, the first command and the second command may fail or the first command and the second command may succeed, but both commands must succeed or fail together, as a unit, in a unitary fashion, manner, etc. For example, in one embodiment, a multi-part command and/or super command etc. may be viewed, represented, etc. as a compound command.

In one embodiment, batched commands may be a group of commands, instructions, combinations of these and the like etc. that may be batched, collected, and/or otherwise grouped etc. together or otherwise structured, etc. may be treated (e.g. parsed, stored, prioritized, executed, completed, managed, controlled, etc.) as if the batch, collection, set, group, etc. of commands were, appeared to be, may be viewed as, appear to execute as, etc. an atomic command or a sequence, set, etc. of atomic commands and/or any other commands, etc.

Of course atomic instructions, atomic commands, atomic operations, internal commands, internal instructions, external commands, external instructions, and/or one or more expanded commands (e.g. resulting from the expansion, generation, creation, modification, etc. of one or more atomic instructions, multi-part command, jumbo command, super command, and/or any other commands, instructions, compound instructions, compound commands, etc.), and/or any instruction, command, request, and the like may be executed, retired, processed, handled, managed, controlled, queued, arbitrated, prioritized, batched, grouped, collected, etc. by any designs, mechanisms, circuits, functions, in any manner, fashion, etc. and/or by using any techniques, etc. that may be consistent with (e.g. follow, obey, etc.) the descriptions above, elsewhere herein and/or in one or more specifications incorporated by reference, etc.

For example, in one embodiment, the execution, implementation, design, architecture, microarchitecture, structure, etc. of one or more atomic instructions, atomic commands, atomic operations, internal commands, internal instructions, external commands, external instructions, and/or one or more expanded commands (e.g. resulting from the expansion, generation, creation, modification, etc. of one or more atomic instructions, multi-part command, jumbo command, super command, and/or any other commands, instructions, compound instructions, compound commands, etc.), and/or any instruction, command, request, and the like may use one or more sub-instructions, micro-instructions, and/or any other commands, instructions, etc. that are below the level of hierarchy, are parts of, may form parts of, etc. such instructions, commands, etc.

For example, in one embodiment of a stacked memory package, one or more instructions, commands, requests, etc. may be microcoded. Of course one or more instructions, commands, requests, etc. may be implemented, executed, structured, composed, etc. in any manner, fashion, and/or using any techniques etc. including those that may be described above, elsewhere herein and/or in one or more specifications incorporated by reference. For example, in one embodiment, a first set of commands, instructions, etc. may be microcoded while a second set of commands, instructions, etc. may have a fixed and/or otherwise programmable architecture, design, implementation, etc.

For example, in one embodiment, a compare instruction (e.g. as used in a CAS instruction, that may be an expanded instruction and/or internal command etc. resulting from expansion of a CAS instruction and/or command etc.) may be microcoded. For example, the microcode for a compare instruction may comprise, include, consist of, etc. one or more steps, functions, processes, etc. For example, in one embodiment, the microcode for a compare instruction may effect, cause, initiate, perform, execute, etc. as a first step the copying, transfer, moving, etc. of one or more operands (e.g. values etc. to be compared) to one or more registers etc. For example, in one embodiment, the microcode for a compare instruction may effect as a second step a comparison (e.g. using a comparator, ALU, any other computation engine, macro engine, processor, processor unit, combinations of these and/or the like etc.) of operands etc. For example, in one embodiment, the microcode for a compare instruction may effect as a third step an indication, transfer, copying, flagging, etc. of one or more results, errors, status, combinations of these and the like, etc. Of course the microcode may be of any type, form, structure, etc. Of course the microcode may be managed, controlled, programmed, configured, etc. in any manner, fashion, and/or using any techniques etc. For example, one or more parts, portions, pieces, etc. of microcode may be updated, uploaded, changed, modified, altered, configured, and/or otherwise programmed, etc. at any time.

For example, in one embodiment of a stacked memory package, one or more parts, portions, etc. of any command set (e.g. internal command set, external command set, any other command set, any other groups of commands, sets of instructions, etc.) may be microprogrammed and/or otherwise programmable, configurable, etc.

For example, in one embodiment of a stacked memory package, each of the steps in a microcode program, structure, etc. may include, consist of, be assembled from, may be viewed as, etc. one or more microinstructions. For example, in one embodiment, microinstructions may be part of microcode, a microprogram, etc. Of course the microinstructions may be of any number, type, form, structure, etc. Of course the microinstructions may be managed, controlled, programmed, configured, etc. in any manner, fashion, and/or using any techniques etc.

For example, in one embodiment of a stacked memory package, microcode may include, form, comprise, function as, etc. a layer of hardware-level instructions, data structures, and the like etc. that may be involved in the implementation of, execution of, performance of, etc. one or more higher level machine code instructions and the like, etc. For example, in one embodiment of a stacked memory package, microcode may include, comprise, etc. one or more microinstructions in a microinstruction set. For example, in one embodiment, the microarchitecture of part, portions, etc. of a stacked memory package, may involve, use, include, require, implement, correspond to, etc. the use, execution, etc. of one or more register-transfer level (RTL) functions, descriptions, etc. The microinstructions, microcode, RTL, microprograms, microarchitecture may take any form, type, etc. For example RTL may be coded in a first language (e.g. a high-level language, Verilog, VHDL, etc.) and may be translated, compiled, converted, etc. to hardware (e.g. logic gates, etc.), a hardware description, ROM code, program bitfiles (e.g. for FPGAs, any other configurable logic, any other programmable logic, etc.), microcode-programmable CPUs, CPUs, ALUs, macro engines, combinations of these, and/or any other similar functions, circuits, and the like, etc.

For example, in one embodiment of a stacked memory package, the microarchitecture may include microcode, microinstructions, microprogarms, and/or any other functions, circuits, etc. to support, implement, execute, process, manage, control, etc. any number, type, form, structure of commands, instructions, and/or any other operations and the like etc. For example, in one embodiment of a stacked memory package, one or more memory controllers, memory access schedulers, macro engines, datapaths, and/or any other circuits, functions, etc. may be microcoded. For example, in one embodiment of a stacked memory package, the microarchitecture of a memory controller, any other circuits, functions, etc. may include microcode, microinstructions, and/or any other functions, circuits, etc. to support, implement, execute, process, manage, control, etc. any number, type, form, structure of commands, instructions, and/or any other operations and the like etc.

For example, in one embodiment of a stacked memory package, one or more microprograms may include, comprise consist of, etc. a set, series, collection, group, etc. of microinstructions. For example, in one embodiment, one or more microinstructions may control a CPU, ALU, memory controller, macro engine, and/or any other parts, portions, groups, collections, etc. of logic circuits and the like. For example, in one embodiment, a microinstruction may correspond to, describe, implement, specify, etc. one or more of the following operations (but not limited to the following operations): connecting, coupling, etc. of registers, etc. (e.g. to a bus, to a functional unit, etc.); setting an ALU etc. to perform arithmetic, logical, compare, and/or any similar operations and the like; setting control inputs, flags, settings, and/or any other signals and the like etc; storing of results in one or more registers; updating flags, condition codes, error flags, overflow bits, status codes, and/or any other signals and the like etc; controlling program counters, etc; performing jumps, stack operations, and/or any other similar functions and the like, etc.

For example, in one embodiment of a stacked memory package, one or more microprograms may control the operation of one or more repair operations, repair logic, and/or any other aspect of repair, etc.

For example, in one embodiment of a stacked memory package, one or more microprograms may implement, perform, execute, etc. one or more complex instructions, complex commands, atomic commands, macro commands (e.g. directed to a macro engine, etc.), external commands, internal commands, super commands, multi-command commands, jumbo commands, raw commands, DRAM commands, native commands, test commands, repair commands, combinations of these and/or any similar commands, requests, instructions, and the like, etc.

For example, in one embodiment of a stacked memory package, one or more microprograms may implement, execute, perform, control, etc. one or more aspects, functions, behaviors, etc. of one or more memory controllers, memory schedulers, memory access schedulers, memory arbitration functions and/or any other memory, control, datapath functions, etc. For example, one or more aspects, features, parameters, etc. of command timing, command ordering, command scheduling, and/or any aspect of command processing, command operations, command execution, command arbitration and the like may be controlled, implemented, executed, performed, etc. using microprograms and/or any similar programming, configuration functions, and the like etc.

For example, in one embodiment, microprograms and/or any similar programming, configuration functions, and the like etc may be used to implement, execute, perform, control, etc. one or more of any aspects, functions, behaviors, etc. of one or more components, circuits, functions, behaviors, operations, etc. of a stacked memory package. For example, in one embodiment of a stacked memory package, one or more microprograms, any other programmable techniques, etc. may implement, execute, perform, control, etc. one or more aspects, functions, behaviors, etc. of one or more test functions, self-test functions, and/or any aspect of tests, testing, self-testing and the like etc.

In one embodiment of a stacked memory package, commands, requests, messages, etc. may be received by the stacked memory package from one or more sources. For example, one or more CPUs may transmit, issue, generate, convey, etc. commands etc. to a stacked memory package. For example, commands etc. may be transmitted etc. to a stacked memory package using one or more high-sped serial links. In one embodiment of a stacked memory package, the order in which commands etc. are executed, retired, performed, etc. may be controlled, managed, determined, etc.

In one embodiment of a stacked memory package, one or more commands may be executed, retired, performed, etc. by (e.g. using, employing, etc.) one or command operations. A command operation may be any operation, process, technique, function, behavior, combinations of these and the like etc. associated with, corresponding to, etc. the performance, execution, completion and/or any other similar processing etc. of one or more commands.

It should be noted that the term command as used to describe command ordering and related techniques herein may be used to describe any aspect of any form of command. A command may include any type of request, message, etc. as received, for example, by a stacked memory package and/or any other system component. A command may also include responses, completions, status, etc. as transmitted, for example, from a stacked memory package and/or any other system component. A command, in general, as applied to ordering etc. may be any command, instruction, message, response, completion, etc. A command, in general, as applied to ordering etc. may be any member of any type of command set. A command, in general, as applied to ordering etc. may be any type of command. For example, commands, in general, as applied to ordering etc. may include, but are not limited to, one or more of the following: an internal command, an external command, a complex command, a compound command, a super command, a multi-command command, a jumbo command, an atomic command, a macro command (e.g. directed at a macro engine, etc.), raw command, DRAM command, native command, test command, repair command, refresh command, expanded command, combinations of these and/or any type of command, instruction, and the like etc.

It should be noted that the terms order, ordering, scheduling, reordering, pre-emption, arbitration, timing, etc. as used to describe command ordering and related techniques herein may be used to describe any aspect of command processing, execution, and/or related command operations, etc. The order of commands, may for example, refer to the order in time in which commands are processed, executed, retired, queued, scheduled, etc.

It should be noted that the ordering of commands may be different at different points in time (e.g. as commands are reordered, scheduled, etc.). It should be noted that the ordering of commands may be different at different parts of the system (e.g. commands may have a first order when transmitted by a source but have a second order when received by a target, etc.).

It should be noted that the terms retirement, execution, completion, scheduling, etc. may refer to the performance, execution, completion, etc. of one or more command operations. For example, a first read command may be transmitted by a CPU at a first time, received by a stacked memory package at a second time, queued in a memory controller at a third time, executed by a DRAM at a fourth time, a completion with read data transmitted by the stacked memory package at a fifth time, and received by the CPU at a sixth time. For example, a second read command may have a different order (e.g. be earlier or later, etc.) with respect to the first read command at each of the first, second, third, fourth, fifth, and sixth times. Thus, it may be seen that the order and/or ordering of commands may apply to a particular point in time and/or a particular part of the system and/or particular part of one or more command operations, etc.

In one embodiment of a stacked memory package, one or more commands, instructions, requests, messages, responses, completions, etc. may be guaranteed to be executed, retired, processed, returned, transmitted, etc. in order. In one embodiment, command etc. ordering may be performed, guaranteed, ensured, implemented, etc. with respect to any group, set, collection, etc. of commands. For example, as an option, all commands sourced by one CPU may be guaranteed etc. to be executed etc. in order. For example, as an option, all commands received on a single link to the same memory reference (e.g. address, etc.) may be guaranteed etc. to be executed etc. in order. For example, as an option, all read responses resulting from read requests sourced by one CPU may be guaranteed etc. to be returned etc. in order. For example, as an option, all DRAM writes resulting from write requests sourced by one CPU may be guaranteed etc. to be completed (e.g. data written to DRAM) etc. in order. In one embodiment, as an option, command etc. ordering may be made, guaranteed, ensured, etc. with respect to a memory controller. For example, as an option, all read responses resulting from read requests to each memory controller may be guaranteed etc. to be returned etc. in order. For example, commands etc. directed to a memory controller, a memory regions, a memory class, and/or any other specific circuit, logic block, memory area, etc. may be guaranteed to be executed, retired, processed, etc. in order. For example, as an option, commands etc. that are targeted to a range of addresses may be guaranteed to be executed, retired, processed, etc. in order. Other ordering rules, scheduling algorithms, ordering processes, and/or any other variations in ordering configurations, behaviors, etc. are possible and may be described herein and/or in one or more specifications incorporated by reference.

In one embodiment of a stacked memory package, one or more sets, groups, collections, etc. of commands, requests, etc. including, but not limited to, atomic instructions, atomic commands and/or one or more sub-instructions, micro-instructions, expanded commands, etc. resulting from the expansion, generation, creation, modification, etc. of one or more atomic instructions, multi-part command, jumbo command, super command, and/or any other compound instructions, complex instructions, etc. may be guaranteed to be executed, retired, processed, etc. in a pre-determined order, a programmable order, a configurable order, or in any order, according to any schedule, etc.

For example, a set of commands etc. may be guaranteed to be executed, retired, processed, etc. in order by any design, mechanisms, using any techniques, etc. For example, in one embodiment, one or more memory controllers may schedule commands etc. so that the commands directed at the memory controller (e.g. commands directed at memory regions, addresses, etc, associated with the memory controller, etc.) may be executed etc. in order. In one embodiment, for example, as an option, command etc. ordering may be made, guaranteed, ensured, etc. with respect to commands directed at a memory reference (e.g. memory address, etc.). Thus, for example, if a first command that targets a first address is received on a first high-speed serial link before a second command that targets the first address is received on the first high-speed serial link then the first command may be guaranteed to be performed, executed, retired, completed, etc. before the second command.

For example, in one embodiment, one or more memory controllers may coordinate scheduling of commands etc. so that the commands may be executed etc. in order across one or more memory controllers. For example, circuits may use tags, timestamps, etc. to enable ordering, scheduling, etc. For example, in one embodiment, memory controllers, schedulers, any other circuits, etc. may use existing tags, any other similar fields, etc. that may be included in one or more commands etc. in order to schedule the commands etc. For example, in one embodiment, memory controllers, schedulers, any other circuits, etc. may generate, create, insert, add, etc. one or more tags, any other similar fields, etc. that may be included in, attached to, associated with, correspond to, etc. one or more commands etc. in order to schedule the commands etc.

For example, in one embodiment, collaboration etc. between one or more memory controllers, schedulers, and/or any other circuits, blocks, functions, etc. may be performed (e.g. executed, made, implemented, etc.) by communication (e.g. coupling of signals, exchange of information, etc.) with one or more central command scheduling circuits, blocks, functions, etc. For example, in one embodiment, collaboration etc. between one or more memory controllers may be made by communication etc. with one or more circuits, functions, etc. that may provide scheduling, ordering, arbitration, priority, interrupt, and/or any other data, information, etc. (e.g. via measurement, via signals, via any other information, etc.). For example, in one embodiment, one or more scheduling, ordering, etc. functions may be distributed across (e.g. amongst, within, in proximity to, etc.) one or more memory chips. In one embodiment, the scheduling, ordering, etc. information from one or more stacked memory chips and/or from one or more portions of one or more memory chips, may be used to control, govern, and/or otherwise modify the scheduling, ordering, etc. behavior, functions, operations, etc. of one or more memory controllers, etc. In one embodiment, each memory controller may control etc. ordering functions etc. independently. In one embodiment, one or more memory controllers may control etc. a set of ordering functions etc. collectively (e.g. via collaboration, collectively, etc.). In one embodiment, a first set (e.g. group, collection, list, etc.) of one or more ordering operations etc. may be performed in an independent manner etc. while a second set of one or more ordering operations etc. may be performed in a collective manner etc.

For example, in one embodiment, one or more ordering operations, parts of ordering operations, one or more ordering operation parameters, etc. may be dependent on local conditions (e.g. local traffic activity, repair operations, refresh operations, error conditions, and/or any other operations and/or activities, events, etc.). Local conditions may include (but are not limited to), for example, conditions, measurements, metrics, statistics, properties, aspects, and/or any other features etc. of one or more parts of a memory chip, parts of a logic chip, groups or sets of these, combinations of these, and/or any other parts, portions, etc. of one or more system components, circuits, chips, packages, and the like etc. In this case, for example, one or more aspects of ordering, scheduling, etc. may be performed in an independent manner or relatively independent manner (e.g. autonomously, semi-autonomously, at the local level, etc.). For example, each memory controller may monitor activity (e.g. commands, requests, etc.), activities of logically attached memory circuits, and/or any other metrics, parameters, data, information, etc. For example, in this case, in one embodiment, a memory controller may make local decisions etc. to control etc. command order, command priority, command arbitration, command re-ordering, command scheduling, command timing, staggering of commands, and/or any aspect of command timing, command execution, retiring of commands, timing of responses, etc. For example, in one embodiment, one or more stacked memory packages may control ordering operations at the memory system level, while one or more logic circuits may control ordering operations at the package level, etc. Thus, for example, in one embodiment, it may be beneficial to control one or more aspects of ordering operation in a hierarchical fashion, manner, etc. Of course one or more ordering operations, parts of ordering operations, one or more ordering operation parameters, etc. may be dependent on any aspect, parameters, input, control, data, information, etc. including any number, type, form, structure etc. of local sources, external sources, remote sources, etc.

For example, in one embodiment, a first set of one or more aspects, features, parameters, timing, behaviors, functions, etc. of command, request, response, completion etc. ordering, scheduling, execution, etc. may be controlled etc. at a first level (e.g. of hierarchy, at a first layer, etc.) and a second set of one or more aspects of ordering etc. may be controlled etc. at a second level. Any number, type, arrangement, depth, etc. of levels of hierarchical operation may be used. For example, in one embodiment, a central (e.g. high level, higher level, etc.) control function may control etc. a window of time in which a memory controller may perform commands etc. In this case, for example, a memory controller may decide when within that time window to actually perform memory commands, command operations, etc. For example, it may be beneficial to assign, designate, program, configure, etc. a first set, group, collection, etc. of one or more aspects of command execution, ordering, operations, etc. to a central and/or high-level function. For example, one or more logic chips, parts of one or more logic chips, etc. in a stacked memory package may have more information on activity (e.g. number, type, form, etc. of traffic etc.), power consumption, voltage levels, power supply noise, combinations of these and/or any other system metrics, parameters, statistics, etc. In this case, for example, it may be beneficial to assign a first set of one or more aspects etc. of command execution, command ordering, any other command operations, etc. to one or more logic chips and assign a second set of one or more aspects of command execution, command ordering, any other command operations, etc. to lower-level (e.g. lower in hierarchy, etc.) components, circuits, etc. For example, in one embodiment, one or more logic chips, parts of one or more logic chips, etc. may provide, signal, and/or otherwise indicate, trigger, control, manage, etc. a command execution, command ordering, command operation, etc. and/or one or more other aspects, behaviors, algorithms, timing, order, staggering, parameters, metrics, controls, signals, combinations of these and the like etc. to any other circuits, components, functions, blocks, etc. (e.g. to one or more memory controllers, to one or more memory chips, parts of one or more memory chips, combinations of these and/or any other associated circuits, functions, etc.).

Other forms of interaction, information exchange, control, management, timing, ordering, re-ordering, relative ordering, etc. may be used. For example, in one embodiment, one or more memory controllers and/or any other circuits, functions, blocks, etc. may request permission to execute commands, order commands, perform command operations, etc. from a central resource that may then arbitrate, allocate, etc. command operations etc. to one or more memory controllers. For example, in one embodiment, one or more memory circuits and/or any other circuits, functions, blocks, etc. may request permission to execute commands, perform commands, perform command ordering, command reordering, perform any other command operations and the etc. from a central resource (e.g. logic chip and/or any other circuits, etc.) that may then arbitrate, allocate, etc. command operations etc. to the memory circuits etc.

For example, in one embodiment, one or more commands, requests, messages, control signals, etc. may include information, fields, data, flags, bits, signals, combinations of these and the like etc. that may control, manage, trigger, initiate and/or otherwise affect etc. one or more command operations, one or more aspects of command operations, and/or any aspect of command behavior, command functions, command operations, command actions, combinations of these and/or any other similar functions, actions, behaviors, and the like, associated with commands, command execution, command operations, etc. For example, in one embodiment, a request (e.g. read request, write request, any other requests, etc.) may include information on whether the request may interrupt one or more other operations and/or otherwise affect one or more command operations, etc. Of course any number, type, structure, form, combination, etc. of one or more commands, requests, messages, etc. may be used to modify, control, direct, alter, and/or otherwise change, etc. one or more aspects of command operations, command execution, command ordering, command reordering, etc.

For example, in one embodiment, a bit may be set in a read request that may allow, permit, enable, etc. a current, pending, queued, scheduled, etc. command operation to be interrupted. Any form of indication, signaling, marking, etc. may be used to indicate, control, implement, etc. command interrupt, command ordering, command scheduling, command timing, command reordering, and/or any other aspect of command operations, functions, behaviors, timing, etc. In one embodiment, the behavior of a command operation interrupt may be to delay the command, and/or any aspect of command operations, etc. In one embodiment, the behavior of a command operation interrupt may be to reschedule the command, and/or one or more aspects of command operations. In one embodiment, the behavior of a command operation interrupt may be to alter, modify, change, reorder, re-time, etc. any aspect of the command operation (e.g. scheduling, timing, priority, duration, order, address range, command target, etc.). In one embodiment, any number, type, form, etc. of one or more bits, fields, flags, codes, etc. in one or more commands, requests, messages, etc. may be used to control, modify, alter, program, configure, change, etc. any functions, properties, metrics, parameters, timing, grouping, and/or any other aspects etc. of any number, type, form, etc. of command operations and/or any other operations associated with one or more commands, requests, completions, responses, etc. For example, in one embodiment, one or more command codes may be used to indicated commands that may interrupt command operations, etc. For example, in one embodiment, commands directed to a part, portion, etc. of memory may be allowed to interrupt, pre-empt, etc. any other commands etc. For example, in one embodiment, commands, requests, etc. that use a specified memory class (as defined herein and/or in one or more specifications incorporated by reference) may be allowed to interrupt any other commands, command operations, any other operations (e.g. refresh operations, repair operations, and/or any other operations, functions, behaviors, and the like etc.). For example, in one embodiment, commands that use a specified virtual channel may be allowed to interrupt any other commands etc. Of course any number, type, form, structure, etc. of mechanism, algorithm, etc. may be used to control, interrupt, modify, and/or otherwise alter command behavior, operations, actions, functions, etc.

Other forms of command operations control may be used in addition to interruption (e.g. command interrupt, etc.). For example, scheduling, prioritization, ordering, combinations of these and/or any aspect of command execution, command operations, etc. may be controlled. Similar techniques to those described above, elsewhere herein, and/or in one or more specifications incorporated by reference may be used for scheduling, timing, ordering, etc. of commands as a function, for example, of command operations and/or any other operations etc. For example, in one embodiment, a command may be marked etc. to indicate that it may be scheduled and/or otherwise changed in one or more aspects to accommodate (e.g. permit, allow, enable, etc.) one or more other operations (e.g. execution of any other command, any other system functions, and/or any other operation(s), etc.). For example, in one embodiment, a set, series, sequence, collection, group, etc. of commands may be similarly marked etc. For example, in one embodiment, any technique to mark, designate, indicate, singulate, group, collect, etc. one or more commands, requests, messages, etc. that may be manipulated, re-timed, re-ordered, ordered, prioritized, and/or otherwise changed in one or more aspects etc. may be used. For example, in one embodiment, the marking etc. of commands etc. may take any form and/or be performed in any manner, fashion, etc.

For example, in one embodiment, one or more commands, requests, etc. may use, employ, implement, etc. a specified part of memory, part of a datapath, traffic class, virtual channel, combinations of these and/or any other similar techniques to separate, mark, designate, identify, group, etc. traffic, data, information, etc. that are used in a memory system. For example, in one embodiment, commands that use a specified part of memory, part of a datapath, traffic class, combinations of these and/or any other similar metrics, markings, designations, identifications, groupings, etc. may be allowed to interrupt any other command, command operations, any other operations, etc. For example, high-priority traffic, real-time traffic etc. may be allowed to interrupt one or more command operations, etc. For example, video traffic (e.g. associated with, corresponding to, etc. multimedia files, etc.) may be assigned a specified virtual channel, traffic class, etc. that may allow interruption of one or more command operations and/or operations associated with command execution, etc. In one embodiment, the modification of behavior may include one or more facets, aspects, features, properties, functions, behaviors, etc. of command operations. Thus, in one embodiment, any facet, aspect, feature, property, function, behavior, etc. of command operations may be modified in a similar fashion.

In one embodiment, control of system behavior (including, but not limited to, command operations, etc.) may be a function of one or more bits, flags, fields, data, information, codes, etc. in one or more commands, requests, etc. In one embodiment, control may be implemented using a table, look-up table, index table, map, and/or any other data structure. For example, in one embodiment, a table may be programmed that may include (but is not limited to): command type, priority. The priority may control, for example, whether or not a function such as refresh, repair, test, configuration, and/or any other functions, behaviors, and the like etc. may be interrupted and/or otherwise manipulated. Thus, for example, a read request with code “000” may have priority “0”; and a read request with code “001” may have priority “1”. In this case, for example, a read request with priority “0” may not be allowed to interrupt any other commands, command operations, etc. but a read request with priority “1” may be allowed to interrupt operations etc. Other similar techniques may be used to control any types of operations (e.g. memory access, refresh, repair, test, thermal management, etc.). Any type, number, form, etc. of priorities may be used. Any type, form, field, data, information, etc. may be used to control priorities. Any type, number, form of tables, tabular structures, and/or any other data structures may be used. For example, one or more tables may be used to map one or more traffic classes, virtual channels, etc. to one or more priorities. For example, there may be a first priority for command operations, a second priority for refresh operations, and a third priority for repair operations, etc. One or more aspects of the control of system behavior may be programmed, configured, etc. For example, the table of command type with priorities may be programmed etc. Programming, configuration, etc. may be performed at any times and in any manner, fashion, etc. using any techniques, etc. For example programming etc. may be performed at design time, manufacture, assembly, test, start-up, boot time, during operation, at combinations of these times, and/or at any times, etc.

For example, in one embodiment, a part of memory, part of a datapath, traffic class, virtual channel, memory class, combinations of these and/or other similar metrics, markings, designations, etc. may be specified, programmed, configured, and/or otherwise set etc. by any techniques. For example, in one embodiment, a part of memory may be specified by an address (e.g. in a command, in a request, etc.). In this case, for example, in one embodiment, a range of addresses may be specified by a command, message, etc. For example, a memory class may be specified, defined, etc. by one or more ranges of addresses, groups of addresses, sets of addresses, etc. that may be held in one or more tables, memory, and/or any other storage structures, etc. For example, in one embodiment, a traffic class may be specified by a bit, field, flag, code, etc. in one or more commands, requests, etc. For example, in one embodiment, a channel, class, etc. may be specified by a bit, field, flag, code, encoding, data, information, etc. in one or more commands, requests, etc. For example, in one embodiment, a channel, class, etc. may be specified by bit values “01” that may correspond to a table entry that includes an address range “0000_0000” to “0001_000”, for example. Of course any format, size, length, etc. of bit fields etc. and any format, size, length, etc. of address range(s) etc. in any number, form, type, etc. of table(s) and/or similar structure(s) etc. may be used. The programming etc. of command behavior, memory classes, virtual channels, address ranges, combinations of these and/or any other factors, properties, metrics, parameters, timing, signals, etc. that may affect, control, determine, govern, implement, direct, etc. one or more aspects of command functions, operations, behavior, signals, timing, grouping, etc. may be performed at any time. For example, in one embodiment, programming etc. may be performed at design time, manufacture, assembly, test, start-up, boot time, during operation, at combinations of these times, and/or at any times, etc.

Example embodiments described above, elsewhere herein, and/or in one or more specifications incorporated by reference may include one or more systems, techniques, algorithms, mechanisms, functions, circuits, etc. to execute, perform, retire, schedule, time, etc. commands, command operations, command functions, related functions and the like etc. in a memory system. Note that the use, meaning, etc. of terms commands, command operations, command signals, and/or any other aspects of command operations etc. may be slightly different in the context of their use. For example, the use of these and/or any other related terms may be different with respect to a stacked memory package (e.g. using SDRAM, flash, and/or any other memory technology, etc.) relative to (as compared to, in comparison with, etc.) their use with respect to, for example, a standard SDRAM part. For example, one or more commands (e.g. command types, types of command, etc.) may be applied to the pins of a standard SDRAM part as signals. For example, a DDR SDRAM command bus may include, but is not limited to, the following signals: a clock enable, chip select, row and column addresses, bank address, and a write enable. Commands may be entered, registered, sampled, etc. on the positive edges of clock, and data may be sampled on both positive and negative edges of the clock. In some SDRAM parts, the external pins (e.g. signals, etc.) CKE, CK, CK# may form inputs to the control logic. For example, in some SDRAM parts, external pins such as CS#, RAS#, CAS#, WE# etc. may form inputs to the command decode logic, which may be part of the control logic. Further, in some SDRAM parts, the control logic and/or command decode logic may generate one or more signals that may control the operations, functions, behaviors, etc. of the part. The use and meaning of terms including commands, command operations, command signals and the like etc. in the context of, for example, a stacked memory package (e.g. possibly without external pins CS#, RAS#, CAS#, WE#, CKE, and/or any other signals etc.) may be different from that of a standard part and may be further defined, clarified, expanded, etc, in one or more of the embodiments described herein and/or in one or more specifications incorporated by reference. The timings (e.g. timing parameters, timing restrictions, relative timing, timing windows, timing margins, timing requirements, minimum timing, maximum timing, combinations of these and/or any other timings, parameters, etc.) of commands, command operations, associated operations, command signals, any other command properties, behaviors, functions, combinations of these, etc. may be different in the context of their use. For example, timings etc. may be different with respect to a stacked memory package (e.g. using SDRAM, flash, combinations of these, and/or any other memory technology, etc.) relative to (as compared to, in comparison with, etc.) their use with respect to, for example, a standard SDRAM part.

For example, in one embodiment, one or more memory controllers may include one or more memory access schedulers. Of course, a memory access scheduler may operate, function, etc. in any manner, fashion, etc. and may or may not be part of, included within, etc. a memory controller. For example, in one embodiment, a memory access scheduler may schedule, order, prioritize, queue, and/or otherwise control, manage, arbitrate, etc. the execution, retirement, performance, etc. of one or more commands, requests, accesses, references, etc. For example, in one embodiment, one or more memory controllers may schedule pipeline operations, accesses, etc. (e.g. for future time intervals, future time slots, operations on different memory sets, etc.) upon receiving one or more commands (e.g. including commands of any type, form, number, etc.), instructions, requests, messages, etc. In one embodiment, one or memory controllers, memory access schedulers, and/or similar logic functions and the like may perform scheduling etc. as a result of command interleaving, command nesting, command structuring, etc.

For example, in one embodiment, a memory access scheduler, parts of a memory access scheduler, etc. may be implemented in the context of FIG. 26-2 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description including, but not limited to, the description of command interleaving, command nesting, command structuring, etc. Thus, for example, in one embodiment, as an option, memory access scheduling (including, but not limited to, command ordering, command reordering, and/or any ordering operations and the like etc.) may comprehend (e.g. account for, be compatible with, etc.) command interleaving, command nesting, command structuring, and the like etc.

In one embodiment, memory access scheduling (including, but not limited to, ordering, reordering, etc.) may comprehend complex command structures etc. For example, in one embodiment, a first command and a second command may be, may comprise, may include, etc. two parts, portions, pieces, etc. of a third command, referred to as a multi-part command, that may carry one or more embedded (e.g. inserted, nested, included, contained, etc.) commands, such as the first command and the second command. For example, in one embodiment, the third command may include, comprise, contain, etc. the first command and the second command. For example, in one embodiment, a command (e.g. a long write command, a command with large data payload, etc.) may be divided (e.g. into one or more pieces, parts, portions, etc. of equal or different lengths, etc.) to allow any other commands, or any other information (e.g. status, control information, control words, control signals, error information, responses, completions, combinations of these and/or any other commands and/or command related information, etc.) to be inserted into, contained within, carried by, transported by, conveyed by, transmitted by, etc. a multi-part command. In one embodiment, for example, the multi-part command may occupy (e.g. be carried by, may use, etc.) one or more packets. In one embodiment, for example, a packet may carry one or more multi-part commands. In one embodiment, for example, one or more packets may carry one or more multi-part commands. In one embodiment, for example, one or more packets may carry any number of parts, portions (including all), etc. of one or more multi-part commands and/or any number of parts, portions (including all), etc. of any other commands, instructions, macro instructions, macro commands, atomic instructions, supper commands, jumbo commands, and/or parts, portions (including all), etc. of any other type, number, form of command, request, response, completion, instruction, combinations of these and the like, etc. Of course multi-command commands, any other complex commands, internal commands, external commands, and/or any command, instruction, request, completion, combinations of these and the like etc. may be carried, transmitted, and/or otherwise transported, conveyed, etc. in any manner, in any number of parts, etc.

In one embodiment, for example, a command may include multiple commands. For example, a write with reads command may include a write command with one or more embedded read commands. Such a command (referred to as a multi-command command, a jumbo command, a super command, etc.) may be used, for example, in one embodiment, to logically inject, insert, etc. one or more read commands into a long write command. For example, in one embodiment, a write with reads command may be similar or identical in format (e.g. bit sequence, appearance, fields, etc.) to a sequence such as command sequence WRITE1.1, READ2, WRITE1.2, or command sequence WRITE1.1, READ1, READ2, WRITE1.2, etc. Similarly, in one embodiment, a long read response may also include one or more write completions for one or more nonposted write commands, etc. Any number, type, combination, etc. of commands (e.g. commands, responses, requests, completions, control options, control words, status, etc.) may be embedded in a multi-command command. The formats, behavior, contents, types, etc. of multi-command commands may be fixed and/or programmable. The formats, behavior, contents, types, etc. of multi-command commands may be programmed and/or configured, changed etc. at design time, at manufacture, at test, at assembly, at start-up, during operation, at combinations of these times and/or at any time, etc. In one embodiment, commands may be structured (e.g. formatted, designed, constructed, configured, etc.) to improve memory system performance. For example, in one embodiment, a multi-command write command (jumbo command, super command, compound command, etc.) may be structured as follows: WRITE1.1, WRITE1.2, WRITE1.3, WRITE1.4, WRITE1.5, WRITE1.6, WRITE1.7, WRITE1.8, WRITE1.9, WRITE1.10, WRITE1.11, WRITE1.12. In one embodiment, WRITE1.1-WRITE1.12 may be formed from (or included in, etc.) one or more packets, separate commands, parts of commands, form a multi-command command, etc. For example, in one embodiment, WRITE1.1-WRITE1.12 may be packet fragments, etc. For example, WRITE1.1-WRITE1.4 may include four write commands (e.g. with four addresses, for example). In one embodiment, WRITE1.1-WRITE1.4 may be included in one packet. In one embodiment, WRITE1.1-WRITE1.4 may be included in multiple packets. For example, WRITE1.5-WRITE1.12 may include write data. For example, in one embodiment, WRITE1.5 and WRITE1.9 may include data corresponding to the write command included in WRITE1.1, etc. In this manner, multiple write commands may be batched (e.g. collected, batched, grouped, aggregated, coalesced, clumped, glued, etc.). For example, a packet or packets etc. including one or more of WRITE1.1-WRITE1.4 may be transmitted ahead of WRITE1.5-WRITE1.12, separately from WRITE1.5-WRITE1.12, interleaved with any other packets and/or commands, etc. For example, in one embodiment, a packet or packets etc. including one or more of WRITE1.5-WRITE1.12 may be interleaved with any other packets and/or commands, etc. Such batching and/or any other structuring, etc. of write commands and/or any other commands, requests, completions, responses, messages, etc. may improve scheduling of operations (e.g. writes and any other operations such as reads, refresh, etc.). For example, in one embodiment, one or more memory controllers may schedule pipeline operations, accesses, etc. (e.g. for future time intervals, future time slots, operations on different memory sets, etc.) upon receiving one or more of WRITE1.1-WRITE1.4. For example, in one embodiment, any structure of batched commands, etc. may be used. For example, in one embodiment, any commands may be structured, batched, etc. For example, read responses may be structured (e.g. batched, etc.) in a similar manner. For example, in one embodiment, any number, type, format, length, etc. of commands may be structured (e.g. batched, etc.). For example, in one embodiment, the formats, behavior, contents, types, etc. of structured (e.g. batched, etc.) commands may be fixed and/or programmable. For example, in one embodiment, batched commands may include a single ID or tag. For example, in one embodiment, batched commands may include an ID or tag for each command. For example, in one embodiment, batched commands may include an ID, tag, etc. for the batched command (e.g. a compound tag, compound ID, extended tag, extended ID, etc.) and an ID or tag for each command. The formats, behavior, contents, types, forms, number, etc. of structured (e.g. batched, etc.) commands, tags, IDs, and/or any data, information, etc. associated with, corresponding to, etc. one or more structured (e.g. batched, etc.) commands may be programmed and/or configured, changed etc. at design time, at manufacture, at test, at assembly, at start-up, during operation, at combinations of these times and/or at any time, etc. in any manner, fashion, etc., and/or using any techniques.

In one embodiment, such command interleaving, command nesting, command structuring, etc. as described above, elsewhere herein, and/or in one or more specifications incorporated by reference may be used to control ordering, re-ordering, etc. For example, a group of commands (e.g. writes, etc.) may be batched (e.g. logically stuck together, logically glued together, otherwise combined, etc.) together to assure (or enable, permit, allow, guarantee, etc.) one or more (or all) commands may be executed together (e.g. as one or more atomic commands, etc.). Note that typically a compound command may be viewed as a command that may include one or more commands, while typically an atomic command may not include more than one command. However, in one embodiment, a group of commands that are batched together or otherwise structured, etc. may be treated (e.g. parsed, stored, prioritized, executed, completed, etc.) as if the group of commands were an atomic command. For example, in one embodiment, a group of commands (e.g. writes, etc.) may be batched together to assure all commands may be reversed (e.g. undone, rolled back, etc.) together (e.g. as one, as an atomic process, etc.). For example, a group of commands (e.g. one or more writes followed by one or more reads, one or more reads followed by one or more writes, sequences of reads and/or writes, etc.) may be batched together to assure one or more commands in the group of commands may be executed together in order (e.g. write always precedes read, read always precedes write, etc.). Such command interleaving, command nesting, command structuring, etc. as described above, elsewhere herein, and/or in one or more specifications incorporated by reference may be used, for example, in database or similar applications where it may be desired, required, etc. to ensure one or more transactions (e.g. financial trades, data transfer, snapshot, roll back, back-up, retry, etc.) are executed and the one or more transactions may include one or more commands.

In one embodiment, for example, such command interleaving, command nesting, command structuring, etc. as described above, elsewhere herein, and/or in one or more specifications incorporated by reference may be used, for example, in applications where data integrity may be required, desired, etc. in the event of system failure and/or any other failure(s). For example, in one embodiment, one or more logs, lists, records, etc. (e.g. of transactions performed, instructions executed, memory locations accessed, writes completed, etc.) may be used to recover, reconstruct, rollback, retry, undo, delete, etc. one or more transactions. For example, the transactions etc. may include one or more commands. In one embodiment, for example, the stacked memory package may determine that a first set (e.g. sequence, collection, series, group, etc.) of one or more commands may have failed and/or any other failure preventing execution of one or more commands may have occurred, etc. In this case, in one embodiment for example, the stacked memory package may issue one or more error messages, responses, completions, status reports, etc. In this case, in one embodiment for example, the stacked memory package may retry, replay, repeat, etc. a second set of one or more commands associated with the failure. The second set of commands (e.g. retry commands, etc.) may be the same as the first set of commands (e.g. original commands, etc.) or may be a superset of the first set (e.g. include the first set, etc.) or may be different (e.g. calculated, composed, etc. to have a desired retry effect, etc.). For example, commands may be reordered to attempt to work around a problem (e.g. signal integrity, etc.). The second set of commands, e.g. including one or more retried commands, etc, may be structured, batched, reordered, otherwise modified, changed, altered, etc, for example. In one embodiment, the tags, ID, sequence numbers, any other data, fields, etc. of the original command(s) may be saved, stored, etc. In one embodiment, the tags, ID, sequence numbers, any other data, fields, etc. of the original command(s) (e.g. first set of commands, etc.) may be restored, copied, inserted, etc. in one or more of the retried command(s) (e.g. second set of commands, etc.), and/or in any other commands, requests, etc. In one embodiment, the tags, ID, sequence numbers, any other data, fields, etc. of the original command(s) (e.g. first set of commands, etc.) may be restored, copied, inserted, etc. in one or more completions, responses, etc. of the retried command(s) (e.g. second set of commands, etc.), and/or in any other commands, requests, responses, completions, etc. In one embodiment, the tags, ID, sequence numbers, any other data, fields, etc. of the original command(s) may be restored, copied, inserted, changed, altered, modified, etc. into one or more completions, responses, etc. that may correspond to one or more of the original commands, etc. In this manner, in one embodiment, the CPU (or any other command source, etc.) may be unaware that a command retry or command retries may have occurred. In this manner, in one embodiment, the CPU etc. may be able to proceed with knowledge (e.g. via notification, error message, status messages, one or more flags in responses, etc.) that one or more retries and/or error(s) and/or failure(s), etc. may have occurred but the CPU and system etc. may able to proceed as if the command responses, completions, etc. were generated without retries, etc. In one embodiment, the stacked memory package may issue one or more error messages and the CPU may replay, retry, repeat, etc. one or more commands in a different order. In one embodiment, the stacked memory package may issue one or more error messages and the CPU may replay, retry, repeat, etc. one or more commands in a different order by using one or more batched commands, for example. In one embodiment, the CPU may replay, retry, repeat, etc. one or more commands and mark one or more commands as being associated with replay, retry, etc. The stacked memory package may recognize such marked commands and handle retry commands, replay commands, etc. in a different, or otherwise programmed or defined fashion, manner, etc. For example, the stacked memory package may reorder retry commands using a different algorithm, may prioritize retry commands using a different algorithm, or otherwise execute retry commands, etc. in a different, programmed manner, etc. The algorithms, etc. for the handling of retry commands or otherwise marked, etc. commands may be fixed, programmed, configured, etc. The programming may be performed at design time, manufacture, assembly, test, start-up, during operation, at combinations of these times and/or any other time, etc.

In one embodiment, for example, such command interleaving, command nesting, command structuring, etc. as described above, elsewhere herein, and/or in one or more specifications incorporated by reference may be used, for example, to simulate, emulate and/or otherwise mimic the function, etc. of commands and/or create one or more virtual commands, etc. For example, a structured (e.g. batched, etc.) command that may include a posted write and a read to the same address may simulate a non-posted write, etc. For example, a structured, batched, etc. command that may include two 64-byte read commands to the same address may simulate a 128-byte read command, etc. For example, in one embodiment, a sequence of read commands that may be associated with access to a first set of data (e.g. an audio track of a multimedia database, etc.) may be batched and/or otherwise structured, etc. with read commands that may be associated with a second set of possibly related data (e.g. the video track of a multimedia database, etc.). For example, in one embodiment, a sequence, series, collection, set, etc. of commands may be batched to emulate a test-and-set command and/or any other commands, instructions, etc. related to locks, semaphores, and/or any other synchronization primitives, techniques, and the like, etc. A test-and-set command may correspond, for example, to a CPU instruction used to write to a memory location and return the old value of the memory location as a single atomic (e.g. non-interruptible, non-reducible, etc.) operation. Other instructions, operations, commands, functions, behavior, etc. may be emulated using the same techniques, in a similar manner, etc. Any type, number, combination, etc. of commands may be batched, structured, etc. in this manner and/or similar manners, etc.

In one embodiment, for example, such command interleaving, command nesting, command structuring, etc. as described above, elsewhere herein, and/or in one or more specifications incorporated by reference may be used, for example, in combination with logical operations, etc. that may be performed by one or more logic chips and/or any other logic, etc. in a stacked memory package. For example, in one embodiment, one or more commands may be structured (e.g. batched, etc.) to emulate the behavior of a CAS command, CAS instruction, CAS operation, etc. A CAS command etc. may correspond, for example, to a CPU compare-and-swap instruction or similar instruction(s), etc. that may correspond to one or more atomic instructions used, for example, in multithreaded execution, etc. in order to implement synchronization, etc. A CAS command etc. may, for example, in one embodiment, compare the contents of a target memory location to a field in the CAS command and if they are equal, may update the target memory location. An atomic command, instruction, etc. or series of atomic commands, etc. may guarantee that a first update of one or more memory locations may be based on known state (e.g. up to date information, etc.). For example, the target memory location may have been already altered, etc. by a second update performed by another thread, process, command, etc. In the case of a second update, in one embodiment, the first update may not be performed. The result of the CAS command etc. may, for example, in one embodiment, be a completion that may indicate the update status of the target memory location(s). In one embodiment, the combination of a CAS command etc. with a completion may be, emulate, etc. a compare-and-set command. In one embodiment, a response may return the contents read from the memory location (e.g. not the updated value that may be written to the memory location). A similar technique may, in one embodiment, be used to emulate, simulate, etc. one or more other similar instructions, commands, behaviors, etc. (e.g. a compare and exchange instruction, double compare and swap, single compare double swap, etc.).

In one embodiment, for example, the use of commands and/or command manipulation and/or command construction techniques and/or command interleaving, command nesting, command structuring, etc. as described above, elsewhere herein, and/or in one or more specifications incorporated by reference may be used for example to implement synchronization primitives, mutexes, semaphores, locks, spinlocks, atomic instructions, combinations of these and/or any other similar instructions, instructions with similar functions and/or behavior and/or semantics, signaling schemes, etc. Such techniques may be used, for example, in one embodiment, in memory systems for (e.g. used by, that are part of, etc.) multiprocessor systems, etc.

Note that a CAS instruction, command, operation, etc. may be used as an example above, elsewhere herein, and/or in one or more specifications incorporated by reference. For example, the CAS instruction may be used as an example in order to describe the functions, operations, behaviors, processes, algorithms, circuits, etc. used to implement, architect, design, etc. the command set, external commands, internal commands, command architecture, command structure, etc. For example, the CAS instruction may be used as an example in order to describe the functions etc. of compound commands, etc. For example, the CAS instruction may be used as an example in order to describe the functions etc. of synchronization primitives, locks, etc. Other synchronization primitives (e.g. test-and-set, fetch-and-add, or any other similar operation, instruction, primitive etc.) may be used, implemented, supported, etc. in an embodiment. However, it should be strongly noted that the use of, for example, the CAS instruction as an example in order to describe these functions, similar functions, other functions, etc. is by way of example only. Thus, the use of the CAS instruction as an example is not intended to represent, convey and/or otherwise imply, for example, that the CAS instruction is the best, only, preferred, optimum, technique etc. for example to perform synchronization, etc. Rather the use of the CAS instruction as an example is intended to convey by way of a representative example (and in particular a representative example of an instruction, command, operation, etc.) the various techniques, algorithms, structures, architecture, etc. that are described above, elsewhere herein, and/or in one or more specifications incorporated by reference.

In one embodiment, for example, such command interleaving, command nesting, command structuring, etc. as described above, elsewhere herein, and/or in one or more specifications incorporated by reference may be used, for example, to construct, simulate, emulate and/or otherwise mimic, perform, execute, etc. one or more operations that may be used to implement one or more transactional memory semantics (e.g. behaviors, appearances, aspects, functions, etc.) or parts of one or more transactional memory semantics. For example, in one embodiment, transactional memory may be used in concurrent programming to allow a group of load and store instructions to be executed in an atomic manner. For example, in one embodiment, command structuring, batching, etc. may be used to implement commands, functions, behaviors, etc. that may be used, employed, etc. to support (e.g. implement, emulate, simulate, execute, perform, enable, etc.) one or more of the following (but not limited to the following); hardware lock elision (HLE), instruction prefixes (e.g. XACQUIRE, XRELEASE, etc.), nested instructions and/or transactions (e.g. using XBEGIN, XEND, XABORT, etc.), restricted transactional memory (RTM) semantics and/or instructions, transaction read-sets (RS), transaction write-sets (WS), strong isolation, commit operations, abort operations, combinations of these and/or any other instruction primitives, prefixes, predictions, hints, functions, behaviors, etc. Such command interleaving, command nesting, command structuring, etc. as described above, elsewhere herein, and/or in one or more specifications incorporated by reference may be used, for example, to simulate, emulate and/or otherwise mimic and/or augment, supplement, etc. the function, behavior, properties, etc. of one or more virtual channels, memory classes, prioritized channels, combinations of these and/or any other memory traffic aggregation, separation, classification techniques, etc.

For example, in one embodiment, one or more commands (e.g. read commands, write commands, etc.) may be structured, batched, etc. to control the bandwidth to be dedicated to a particular function, channel, memory region, etc. for a period of time, etc. For example, in one embodiment, one or more commands (e.g. read responses, etc.) may be structured, batched, etc. to control performance (e.g. stuttering, delay variation, synchronization, latency, bandwidth, etc.) for memory operations such as multimedia playback (e.g. an audio track, video track, movie, etc.) for a period of time, etc. For example, in one embodiment, one or more commands (e.g. read/write commands, read responses, etc.) may be structured, batched, etc. to emulate, simulate, etc. real-time operation, real-time control, performance monitoring, system test, etc. For example, in one embodiment, one or more commands (e.g. read/write commands, read responses, etc.) may be structured, batched, etc. to ensure, simulate, emulate, etc. synchronized operation, behavior, etc. Such command interleaving, command nesting, command structuring, etc. as described above, elsewhere herein, and/or in one or more specifications incorporated by reference may be used, for example, to improve the efficiency of memory system operation. For example, in one embodiment, one or more commands (e.g. read commands, write commands) may be structured, batched, grouped, etc. so that one or more stacked memory chips may perform operations (e.g. read operations, write operations, refresh operations, any other operations, etc.) more efficiently and/or otherwise improve performance, etc. For example, in one embodiment, one or more read commands may be structured, batched, etc. so that a large fraction of a DRAM row (e.g. a complete page, half a page, etc.) may be read at one time. For example, in one embodiment, one or more commands may be batched so that a complete DRAM row (e.g. page, etc.) may be accessed at one time. For example, in one embodiment, one or more read commands may be structured, batched, etc. so that one or more memory operations, commands, functions, etc. may be pipelined, performed in parallel or nearly in parallel, performed synchronously or nearly synchronously, etc. For example, in one embodiment, one or more commands may be structured, batched etc. to control the performance of one or more buses, multiplexed buses, shared buses, etc. used by one or more logic chips and/or one or more stacked memory chips, etc. For example, in one embodiment, one or more commands may be batched or otherwise structured to reduce or eliminate bus turnaround times and/or control any other bus timing parameters, etc. In one embodiment, memory commands, operations, raw commands, native commands, and/or suboperations etc. such as precharge, refresh or parts of refresh, activate, etc. may be optimized by structuring, batching etc. one or more commands, etc. In one embodiment, commands may be batched and/or otherwise structured by the CPU and/or any other part of the memory system. In one embodiment, commands may be batched and/or otherwise structured by one or more stacked memory packages. For example, in one embodiment, the Rx datapath on one or more logic chips of a stacked memory datapath may batch or otherwise structure, modify, alter etc. one or more read commands and/or batch etc. one or more write commands, etc. For example, in one embodiment, the CPU and/or any other part of the memory system may embed one or more hints, tags, guides, flags, and/or any other information, marks, data fields, etc. as instruction(s), guidance, etc. to perform command structuring, batching, etc. and/or for execution of command structuring, etc. For example, in one embodiment, the CPU may mark (e.g. include field(s), flags, data, information, and/or otherwise indicate, mark, etc.) one or more commands in a stream as candidates for structuring (e.g. batching, etc.) and/or as instructions to batch one or more commands, etc and/or as instructions to handle one or more commands in a different and/or programmed manner, and/or as information to be used in command structuring, etc. For example, in one embodiment, the CPU may mark one or more commands in a stream as atomic operations, transactions (e.g. of any type, form, structure, nature, etc.), and/or any other similar structures, functions, behaviors, and the like etc. For example, in one embodiment, the CPU may mark one or more commands in a stream as candidates for reordering and/or as instructions to reorder one or more commands, etc and/or as the order in which a group, collection, set, etc. of commands may, should, must, etc. be executed, and/or convey any other instructions, information, data, etc. to the Rx datapath or any other logic, etc.

Such command interleaving, command nesting, command structuring, etc. as described above, elsewhere herein, and/or in one or more specifications incorporated by reference may be applied to responses, messages, probes, etc. and/or any other information carried by (e.g. transmitted by, conveyed by, etc.) one or more packets, commands, combinations of these and/or similar structures, etc. For example, in one embodiment, one or more batched write commands, read commands, etc. may result in one or more batched responses, completions, etc. (e.g. the number of batched responses may be equal to the number of batched commands, but need not be equal, etc.). A batched read response, for example, may allow the CPU or any other part of the system to improve latency, bandwidth, efficiency, combinations of these and/or any other memory system metrics. For example, in one embodiment, one or more write completions (e.g. for non-posted writes, etc.) and/or one or more status or any other messages, control words, etc. may be batched with one or more read responses, any other completions, etc. Such command interleaving, command nesting, command structuring, etc. as described above, elsewhere herein, and/or in one or more specifications incorporated by reference may be used to control, direct, steer, guide, etc. the behavior of one or more caches, stores, buffers, lists, tables, stores, etc. in the memory system (e.g. caches etc. in one or more CPUs, in one or more stacked memory packages, and/or in any other system components, etc.). For example, in one embodiment, the CPU or any other system component etc. may mark (e.g. by setting one or more flags, fields, etc.) one or more commands, requests, completions, responses, probes, messages, etc. to indicate that data (e.g. payload data, any other information, etc.) may be cached to improve system performance. For example, in one embodiment, a system component (e.g. CPU, stacked memory package, etc.) may batch, structure, etc. one or more commands with the knowledge (e.g. implicit knowledge, explicit knowledge, and/or any other received information, generated information, calculated information, etc.) that the grouping etc. of one or more commands may guide, steer and/or otherwise direct one or more cache algorithms, caches, cache logic, buffer stores, arbitration logic, lookahead logic, prefetch logic, prediction logic, and/or cause, control, manage, direct, steer, guide, etc. any other logic and/or logical processes etc. to cache and/or otherwise perform caching operation(s) (e.g. clear cache, delete cache entry, insert cache entry, rearrange cache entries, modify cache entries and/or contents, update cache(s), combinations of these and/or any other cache operations, etc.) and/or or similar operations (e.g. prioritize data, update use indexes, update statistics and/or any other metrics, update frequently used or hot data information, update hot data counters and/or any other hot data information, update cold data counters and/or any other cold data information, update flags, update fields, combinations of these and/or any other operations, etc.) on data and/or cache(s), etc. that may improve one or more aspects, parameters, metrics, etc. of system performance. Such techniques, functions, behavior, etc. related to command interleaving, command nesting, command structuring, etc. as described above, elsewhere herein, and/or in one or more specifications incorporated by reference may be used in combination. For example, in one embodiment, a CPU may mark a series, collection, set, etc. (e.g. contiguous or non-contiguous, etc.) of commands as belonging to a batch, group, set, etc. The stacked memory package may then batch one or more responses. For example, in one embodiment, the CPU may mark a series of nonposted writes as a batch and the stacked memory package may issue a single completion response. Any number, type, order, etc. of commands, requests, responses, completions etc. may be used with any combinations of techniques, etc. Any combinations of command interleaving, command nesting, command structuring, etc. may be used. Such combinations of techniques and their uses as described above, elsewhere herein, and/or in one or more specifications incorporated by reference (e.g. function(s), behavior(s), semantic(s), etc.) may be fixed and/or programmable. The formats, behavior, functions, contents, types, etc. of combinations of command interleaving, command nesting, command structuring, etc. may, in one embodiment, be programmed and/or configured, changed, etc. at design time, at manufacture, at test, at assembly, at start-up, during operation, at combinations of these times and/or at any time, etc. In one embodiment, the CPU may mark and/or identify one or more commands and/or insert information in one or more commands etc. that may be interpreted, used, employed, etc. by one or more stacked memory packages for the purposes of command interleaving, command nesting, command structuring, combinations of these and/or any other operations, etc. For example, in one embodiment, a CPU may issue (e.g. send, transmit, etc.) command A with address ADDR1 followed by command B with ADDR2. The CPU may store copies of one or more transmitted command fields, including, for example, addresses. The CPU may compare commands issued in a sequence. For example, in one embodiment, the CPU may compare command A and command B and determine that the relationship between ADDR1 and ADDR2 is such that command A and command B may be candidates for command structuring, etc. (e.g. batching, etc.). For example, in one embodiment, ADDR1 may be equal to ADDR2, or ADDR1 may be in the same page, row, etc. as ADDR2, etc. Since command A may already have been transmitted, the CPU may mark command B as a candidate for one or more operations to be performed in one or more stacked memory packages. Marking (of a command, etc.) may include setting a flag (e.g. bit field, etc.), and/or including the tag(s) of commands that may be candidates for possible operations, and/or any other technique to mark, identify, include information, data, fields, etc. The stacked memory package may then, in one embodiment, receive command A at a first time t1 and command B at as second, (e.g. later, etc.) time t2. One or more logic chips in a stacked memory package may, in one embodiment, include Rx datapath logic that may process command A and command B in order. Commands may be processed in a pipelined fashion, for example. When the Rx datapath processes marked command B, the datapath logic may then perform, for example, one or more operations on command A and command B. For example, in one embodiment, the datapath logic may identify command A as being a candidate for combined operations with command B. In one embodiment, identification may be performed, for example, by comparing addresses of commands in the pipelines (e.g. using marked command B as a hint that one or more commands in the pipeline may be candidates for combined operations, etc.). In one embodiment, identification may be performed, for example, by using one or more tags or any other ID fields, etc. that may be included in command B. For example, in one embodiment, command B may include the tag, ID, etc. of command A. Any form of identification of combined commands, etc. may be used. After being identified, command A may be delayed and combined (e.g. batched, etc.) with command B. Any form, type, set, order, etc. of combined operation(s) may be performed. For example, in one embodiment, command A and/or command B may be changed, modified, altered, deleted, reversed, undone, combined, merged, reordered, etc. In this manner, etc. the processing, execution, ordering, prioritization, etc. of one or more commands may be performed in a cooperative, combined, joint, etc. fashion between the CPU (or any other command sources, etc.) and one or more stacked memory packages (or any other command sinks, etc.). For example, in one embodiment, depending on the depth of the pipelines in the CPU and the stacked memory packages, information included in the commands by the source may help the sink identify commands that are to be processed in various ways that may not be possible without marking, etc. For example, in one embodiment, the depth of the command pipeline etc. in the CPU may be D1 and the depth of the pipeline etc. in the stacked memory package may be D2, then the use of marking, etc. may allow optimizations to be performed as if the depth of the pipeline in the stacked memory package was D1+D2, etc.

Such command interleaving, command nesting, command structuring, etc. as described above, elsewhere herein, and/or in one or more specifications incorporated by reference may reduce the latency of reads during long writes, for example. Such command interleaving, command nesting, command structuring, etc. may help, for example, to improve latency, scheduling, bandwidth, efficiency, and/or any other memory system performance metrics etc and/or reduce or prevent artifacts (e.g. behavior, etc.) such as stuttering (e.g. long delays, random pauses, random delays, large delay variations compared to average latency, etc.) or any other performance degradation, signal integrity issues, power supply noise, etc. Commands, responses, completions, status, control, messages, and/or any other data, information, etc. may be included in a similar fashion with (e.g. inserted in, interleaved with, batched with, etc.) read responses, any other responses, completions, messages, probes, etc. for example, and with similar benefits, etc. Such command interleaving, command nesting, command structuring, etc. as described above, elsewhere herein, and/or in one or more specifications incorporated by reference may result in the reordering, rearrangement, etc. of one or more command streams, for example. Thus, using one or more of the above cases as examples, a first stream of interleaved commands (e.g. containing, including etc. one or more command fragments, etc.) may be rearranged, ordered, prioritized, mapped, transformed, changed, altered, and/or otherwise modified, etc. to form a second stream of interleaved commands.

Such command interleaving, command nesting, command structuring, etc. as described above, elsewhere herein, and/or in one or more specifications incorporated by reference may be performed, executed at one or more points, levels, parts, etc. of a memory system. For example, in one embodiment, command interleaving, command nesting, command structuring, etc. may be performed on the packets, etc. carried (e.g. transmitted, coupled, etc.) between CPU(s), stacked memory package(s), any other system component(s), etc. For example, in one embodiment, command interleaving, command nesting, command structuring, etc. may be performed on the commands, etc. carried between one or more logic chips and one or more stacked memory chips in a stacked memory package. For example, in one embodiment, command interleaving, command nesting, command structuring, etc. may be performed at the level of raw, native etc. SDRAM commands, etc. In one embodiment, packets (e.g. command packets, read requests, write requests, etc.) may be coupled between one or more logic chips and one or more stacked memory chips. In this case, for example, one or more memory portions and/or groups of memory portions on one or more stacked memory chips may form a packet-switched network. In this case, for example, command interleaving, command nesting, command structuring, etc. and/or any other operations on one or more command streams may be performed on one or more stacked memory chips.

Thus it may be seen that commands may have complex structures according to the above description and/or descriptions elsewhere herein and/or descriptions in one or more specifications incorporated by reference. Thus the terms order, ordering, scheduling, reordering, pre-emption, arbitration, timing, etc. as used to describe command ordering and related techniques may be applied to such complex command structures. For example, in one embodiment, command ordering may be applied to command, parts or portions of commands, etc. In one embodiment, as an option, an order of commands (e.g. the ordering, scheduling, execution, etc. of commands) may be applied to a first command, command1, and a second command, command2. In one embodiment, as an option, in general, command1 and command2 may be any type, form, number, etc. of commands including part(s) of a complex command, etc. In one embodiment, as an option, in general, the ordering (including, but not limited to, the scheduling, reordering, pre-emption, arbitration, timing, etc.) of commands may depend on one or more of the following (but not limited to the following): serial link(s) used to transmit/receive the commands; the memory address(es) or reference(s); the corresponding memory controller(s); the target memory package(s); the command source(s); the virtual channel(s) (if any); the memory class(es) (if any); timestamp(s) (if used); and/or any other command property, aspect, parameter, bit, field, flag, parameter; combinations of these and the like etc. In one embodiment, as an option, in general, the ordering (including, but not limited to, the scheduling, reordering, pre-emption, arbitration, timing, etc.) of commands may depend on one or more additional factors, parameters, modes, configurations, architectures, etc. including one or more of the following (but not limited to the following): caches, caching structures, caching operations, cut-through modes, bypass modes, acceleration modes, retry operations, repair operations, data scrubbing, self-test operations, calibration operations, combinations of these and/or any other operations, modes, and the like etc.

In one embodiment, as an option, the command ordering may be programmable, configurable, pre-determined, etc. and may depend for example on one or more of the following (but not limited to the following factors, parameters, etc for command1 and command2 serial link same/different; address same/different; memory controller same/different; stacked memory package same/different; source same/different; virtual channel same/different; memory class same/different; timestamp (execute command with earlier timestamp before later timestamp); any other command property, aspect, parameter, bit, field, flag, parameter, etc. same/different. Such programmable, configurable, pre-determined, etc. command ordering may thus follow, adhere to, etc. one or more ordering rules, collections of rules, rule sets, modes, configurations, ordering modes, etc.

Note that there may be a variable delay in different parts of the system. The variable delay may occur before or after ordering. Ordering rules, behavior and command operations may or may not include (e.g. factor in, account for, etc.) such variable delay and/or any other factors, events, etc. that may affect command ordering. For example, a retry on high-speed serial link may affect the ordering of one or more commands. For example, a cache hit may affect the ordering of command completions, etc. Such events, situations, etc. may cause one or more ordering exceptions. In one embodiment, as an option, a system may account for ordering exceptions including events, situations, etc. that may affect command ordering. For example, as an option, ordering exceptions caused by link retry and/or any other similar conditions, events, occurrences, etc. (including, but not limited to, for example, error conditions, etc.) may be signaled (e.g. using messages, bits, fields, signals, combinations of these and/or any other indicators, indications and the like etc.). For example, as an option, ordering exceptions that might be caused by caches, acceleration structures and the like etc. may be signaled. The time, manner, fashion, nature, content, etc. of such ordering exception signals may be configured, programmed, etc. at any time in any manner, fashion, etc.

In one embodiment, as an option, ordering rules etc. that may be programmed, configured, pre-determined, etc. may include options, parameters, etc. that may cause, effect, program, configure etc. one or more modes of operation. For example, in one or more ordering modes corresponding to the use of one or more sets, collections, groups, etc. of ordering rules circuits, functions, behaviors, etc. may be modified, altered, changed, configured, programmed, etc. For example, one or more ordering rules may cause caches to be disabled/enabled, acceleration structures to be enabled/disabled and/or any other circuit, function, behaviors, etc. to be changed, modified, switched on, switched off, enabled, disabled, configured, altered, and/or otherwise controlled, etc.

In one embodiment, for example, one or more locks, memory locks, process locks, thread locks, synchronization functions, and/or any other locks, access controls, and/or similar software, logic, etc. constructs, techniques, mechanisms, algorithms, etc. (e.g. as described above, elsewhere herein, and/or in one or more specifications incorporated by reference, etc.) may be performed, implemented, executed, supported, etc. by one or more logic chips, memory controllers, associated logic and/or any logic, circuits, functions, etc. In one embodiment, for example, locking etc. may involve more than one memory controller and/or other logic, etc. In this case, for example, one or more memory controllers, logic functions, logic blocks, etc. may exchange information, use coupled signals, and/or use any other techniques etc. to collaborate, cooperate, communicate, etc. in order to perform, execute, implement, etc. one or more locking functions and the like, etc.

In one embodiment, for example, commands may be processed by logic using tables and/or other similar structures. In one embodiment, for example, these tables and/or other logic etc. may be used to process compound instructions etc. associated with locking functions etc. In one embodiment, for example, these tables and/or other logic etc. may be used to process atomic instructions, atomic commands, atomic operations, transactions, commit of a transaction, atomic tasks, composable tasks, noncomposable tasks, consistent operations, isolated operations, durable operations, linearizable operations, indivisible operations, uninterruptible operations, chained commands, connected commands, merged commands, expanded commands, multi-part commands, multi-command commands, super commands, jumbo commands, compound commands, complex commands, spin locks, semaphores, mutexes, seqlocks, read-copy-update (RCU), read-modify-write (RMW) instructions, raw commands, read writer locks, RCU primitives, wait handles, event wait handles, lightweight synchronization, spin wait, barriers, double-checked locking, lock hints, recursive locks, timed locks, hierarchical locks, hardware lock elision (HLE), instruction prefixes (e.g. XACQUIRE, XRELEASE, etc.), nested instructions and/or transactions (e.g. using XBEGIN, XEND, XABORT, etc.), restricted transactional memory (RTM) semantics and/or instructions, transaction read-sets (RS), transaction write-sets (WS), strong isolation, commit operations, abort operations, test instructions, register operations, mode register operations, configuration operations, messages, status, combinations of these and/or any other commands, requests, responses, completions, instructions, primitives, locks and the like, etc.

In one embodiment, for example, a stream of (e.g. multiple, set of, group of, one or more, etc.) requests (e.g. commands, raw commands, packets, read commands, write commands, messages, etc.) may be received by (e.g. processed by, operated on, coupled by, etc.) a receive datapath (e.g. included in a logic chip in a stacked memory package, etc. as described elsewhere herein and/or in one or more applications incorporated by reference).

For example, a request may include (but is not limited to) one or more of the following fields: (1) CMD: a command code, operation code, etc.; (2) Address: the memory address; (3) Data: write data and/or other data; (4) VC: the virtual channel number; (5) SEQ: a sequence number, identifying each command in the system. Ad an option, any number and type of fields may be used. For example, the command code may use a 2-bit field and may be used to indicate, denote, etc. a command in one or more command sets, e.g. 11=standard write, 01=partial write with first word valid, 10=partial write with second word valid, 00=read, etc. The command code may be any length, use any coding/encoding scheme, etc. In one embodiment the command code may include more than one field. For example, in one embodiment the command code may be split into command type (e.g. read, write, raw command, response, other, etc.) and command sub-type (e.g. 32-byte read, masked write, etc.). There may be any number, type, organization of commands. Commands may be read requests, write requests of different formats (e.g. short, long, masked, etc.), responses, etc. Commands may include raw memory or other commands e.g. commands to generate one or more activate, precharge, refresh, and/or other native DRAM commands, test signals, calibration cycles, power management, termination control, register reads/writes, combinations of these and/or any other like signals, commands, instructions, etc. Commands may be messages (e.g. from CPU to memory system, between logic chips in stacked memory packages, and/or between any system components, etc.). For example, a virtual channel field may be a 1-bit field, but may use any length and/or format. For example, a sequence number may be a 3-bit field but may use any length and/or format. In one embodiment, for example, the sequence number may be a unique identifier for each command in a system. Typically for example, the sequence number may be long enough (e.g. use enough bits etc.) to keep track of some or all commands pending, outstanding, queued, etc. For example, if it is required to have up to 256 commands pending, the sequence number may be log(2) 256, or 8 bits long etc. In one embodiment, any technique, logic, tables, structures, fields, etc. may be used to track, list, maintain, etc. one or more types of commands (e.g. posted commands, nonposted commands, etc.). In one embodiment, for example, more than one type of sequence numbering (e.g. more than one sequence) may be used (e.g. different sequences for different command types, etc.). In one embodiment, the request, command, response, completion, message etc. fields may be different for different commands, may use different lengths, may be in a different order, may not be present, may use more than one bit group, etc. In one embodiment, one or more fields described may not be present in all commands, requests, etc.

In one embodiment, for example, a stream of requests may be received by a receive datapath and processed, executed, queued, stored, multiplexed, and/or otherwise processed etc. by one or more optimization systems. In one embodiment, for example, one or more such optimization systems may include one or more tables, data structures, storage structures, and/or other similar logical structures and the like etc. The one or more tables etc. may be used to optimize commands, requests, data, responses, combinations of these and the like etc. For example, the optimization system may perform, implement, partially implement, etc. one or more optimizations of commands, data, requests, responses, etc. For example, the optimization system may perform command operations as command re-ordering, command combining, command splitting, command aggregation, command coalescing, command buffering, command expansion, command timing, command arbitration, command queuing, command manipulations, non-posted and other command tracking, command parsing, command checking, response generation, data caching, combinations of these and/or other similar operations on one or more commands, requests, responses, messages, data, etc. As an option, for example, the optimization system may be implemented in the context of one or more other Figures that may include one or more components, circuits, functions, behaviors, architectures, etc. associated with, corresponding to, etc. optimization systems, datapaths, other command processing systems, and/or other similar structures, circuits, functions, blocks, etc. that may be included in one or more other applications incorporated by reference.

In one embodiment, for example, one or more optimization tables may be filled, populated, generated, etc. using information, data, fields, etc. from one or more commands, requests, responses, packets, messages, etc. In one embodiment, one or more optimization tables may be filled, populated, generated, etc. using one or more population policies (e.g. rules, protocol, settings, etc.). In one embodiment, for example, a population policy may control, dictate, govern, indicate, and/or otherwise specify etc. how a table is populated. For example, a population policy may control which commands are used to populate a table. For example, a population policy may control which fields are used to populate a table. For example, a population policy may specify fields that are generated to populate a table. In one embodiment, for example, a policy (including, but not limited to, a population policy) may control, specify, etc. any aspect of one or more tables and/or logic etc. associated with one or more tables etc. In one embodiment, for example, a population policy may be programmed, configured, and/or otherwise set, changed, altered, etc. In one embodiment, for example, a population policy may be programmed, configured etc. at design time, manufacture, assembly, start-up, boot time, during operation, at combinations of these times and/or at any time etc. In one embodiment, for example, any policy, settings, configuration, etc. may be programmed at any time. For example, the command optimization table may be populated from a command. The command may be a read request, write request, raw command, etc. In one embodiment, for example, only commands that may be eligible (e.g. appropriate, legal, validated, satisfy constraints, filtered, constrained, selected, etc.) may be used to populate the command optimization table. For example, control logic associated with (e.g. coupled to, connected to, etc.) the command optimization table may populate a valid field that may be used to indicate which data bytes in the command optimization table are valid. The valid field may be derived from the command code, for example. In one embodiment, for example, commands may include one or more subcommands etc. that may be eligible to populate the command optimization table. For example, in one embodiment, one or more commands may be expanded. In this case, the command expansion may include the insertion, creation, generation, a combination of these and/or other similar operations and the like etc. of one or more table entries per command. For example, a write command with an embedded read command may be expanded to two commands. An expanded command may result from expanding a command with one or more embedded commands, etc. For example, a write command with an embedded read command may be expanded to an expanded read command and an expanded write command. For example, a write command with an embedded read command may be expanded to one or more expanded read commands and one or more expanded write commands. In one embodiment, the expansion process, procedures, functions, algorithms, etc. and/or any related operations etc. may be programmed, configured, etc. The programming etc. may be performed at any time and/or in any manner, fashion, etc.

In one embodiment, command expansion from a command with embedded commands may result in the creation, generation, addition, insertion, etc. of one or more commands other than the embedded commands. For example, a write command with an embedded read command may be expanded to one or more read commands and one or more write commands and/or one or more other expansion commands. For example, in one embodiment, a write command with an embedded read command may be expanded to one or more read commands and one or more write commands and/or one or more ordering commands, fence commands, raw commands, and/or any other commands, signals, packets, responses, messages, combinations of these and the like etc. In one embodiment, any command, command sequence, set of commands, group of commands, etc. (including a single multi-purpose command, for example) may be expanded to one or more commands, expanded commands, messages, responses, raw commands, signals, ordering commands, fence commands, combinations of these and/or any other commands, signals, packets, responses, messages and the like etc.

In one embodiment, for example, command splitting may be regarded as, viewed as, function as, etc. a subset of, as part of, as being related to, etc. command expansion. Thus, for example, a write command with a 256-byte data payload may be split or expanded to two writes with 128-byte payloads, etc. In one embodiment, command expansion may be viewed as more flexible and powerful than command splitting. For example, command expansion may be defined as the technique by which any ordering commands, signals, techniques etc. that may be used (e.g. as expansion commands, etc.) may be inserted, generated, controlled, implemented, etc.

Note that one or more operations may be performed on embedded commands as part of command expansion, etc. For example, data fields may be modified (e.g. divided, split, separated, etc.). For example, sequence numbers may be created, added, modified, etc. In one embodiment, any modification, generation, alteration, creation, translation, mapping, etc. of one or more fields, data, and/or other information in a command, request, raw request, response, message etc. may be performed. For example, the modification etc. may be performed as part of command expansion etc. For example, the command modification etc. may be programmed, configured, etc. For example, the command modification programming etc. may be performed at any time.

In one embodiment, for example, the command modification, field modification etc. may be implemented in the context of FIG. 19-11 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” and/or in the accompanying text including, but not limited to, the text describing, for example, address expansion.

In one embodiment, for example, command expansion may include the generation, creation, insertion, etc. of one or more fields, bits, data, and/or other information etc. For example, command expansion may include the generation of one or more valid bits. In one embodiment, any number of bits, fields, types of fields, data, and/or other information may be generated using command expansion. The one or more fields, bits, data, and/or other information etc. may be part of a command, expanded command, generated command, etc. and/or may form, generate, create, etc. one or more table entries, one or more parts of one or more table entries, and/or generate any other part, piece, portion, etc. of data, information, signals, etc.

In one embodiment, for example, one or more expanded commands (e.g. expanded read commands and/or expanded write commands, etc.) and/or expanded fields (e.g. addresses, other fields, etc.) may correspond to, result in, generate, create, etc. multiple entries and/or multiple fields in one or more optimization tables.

In one embodiment, for example, the optimization system described above, elsewhere herein, and/or described in one or more applications incorporated by reference may be implemented in the context of the packet structures, command structures, command formats, packet formats, request formats, response formats, etc. that may be shown in one or more Figures of U.S. application Ser. No. 13/710,411, filed Dec. 10, 2012, titled “SYSTEM, METHOD, AND COMPUTER PROGRAM PRODUCT FOR IMPROVING MEMORY SYSTEMS”, which is hereby incorporated by reference in its entirety for all purposes. For example, the address field formats etc. may be implemented in the context of FIG. 23-4 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, the addressing of one or more memory chips, stacked memory packages, portions or parts of one or more memory chips (e.g. echelons, sections, banks, sub-banks, etc. as defined herein and/or in one or more applications incorporated by reference, etc.) may be implemented in the context of FIG. 23-5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS”. For example, the formats of various commands, requests, etc. may be implemented in the context of FIG. 23-6A and/or FIG. 23-6B, and/or FIG. 23-6C of U.S. application Ser. No. 13/710,411, filed Dec. 10, 2012, titled “SYSTEM, METHOD, AND COMPUTER PROGRAM PRODUCT FOR IMPROVING MEMORY SYSTEMS” along with the accompanying text. For example, the formats of various commands, requests, etc. that may include various sub-commands, sub-requests, embedded requests, etc. may be implemented in the context of FIG. 23-7 and/or FIG. 23-8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” along with the accompanying text.

For example, in one embodiment, a read request may include (but is not limited to) the following fields: ID, identification; a read address field that in turn may include (but is not limited to) module, package, echelon, bank, subbank fields. Other fields (e.g., control fields, error checking, flags, options, etc.) may be present in the read requests. For example, a type of read (e.g., including, but not limited to, read length, etc.) may be included in the read request. For example, the default access size (e.g., read length, write length, etc.) may be a cache line (e.g., 32 bytes, 64 bytes, 128 bytes, etc.). Other read types may include a burst (of 1 cache line, 2 cache lines, 4 cache lines, 8 cache lines, etc.). As one option, a chopped (e.g. short, early termination, etc.) read type may be supported (for 3 cache lines, 5 cache lines, etc.) that may terminate a longer read type. Other flags, options and types may be used in the read requests. For example, when a burst read is performed the order in which the cache lines are returned in the response may be programmed etc. Not all of the fields described need be present. For example, if there are no subbanks used, then the subbank field may be absent (e.g. not present, present but not used, zero or a special value, etc.), or ignored by the receiver datapath, etc.

For example, in one embodiment, a read response may include (but is not limited to) the following fields: ID, identification; a read data field that in turn may include (but is not limited to) data fields (or subfields) D0, D1, D1, D2, D3, D4, D5, D6, D7. Other fields, subfields, flags, options, types etc. may be (and generally are) used in the read responses. Not all of the fields described need be present. Of course, other sizes for each field may be used. Of course, different numbers of fields (e.g. different numbers of data fields and/or data subfields, bit groups, etc. may be used). Fields may be a single group (e.g. collection, sequence, etc.) of bits, and/or one or more bit groups, related bit groups, and/or any combination of these and the like, etc.

For example, in one embodiment, a write request may include (but is not limited to) the following fields: ID, identification; a write address field that in turn may include (but is not limited to) module, package, echelon, bank, subbank fields; a write data field that in turn may include (but is not limited to) data fields (or subfields) D0, D1, D1, D2, D3, D4, D5, D6, D7. Other fields (e.g., control fields, error checking, flags, options, etc.) subfields, etc. may be present in the write requests. For example, a type of write (e.g. including, but not limited to, write length, etc.) may be included in the write request. For example, the default write size may be a cache line (e.g., 32 bytes, 64 bytes, 128 bytes, etc.). Other flags, options and types may be used in the write requests. Not all of the fields described need be present. For example, if there are no subbanks used, then the subbank field may be absent (e.g. not present, present but not used, zero or a special value, etc.), or may be ignored by the datapath receiver, other logic, etc. Of course, other sizes for each field may be used. Of course, different numbers of fields (e.g. different numbers of data fields and/or data subfields etc. may be used).

In one embodiment, the command optimization table may function, for example, to perform write combining. For example, the command optimization table may include two writes. In one embodiment, for example, these two partial writes may be combined to produce a single write. In one embodiment, any types of commands, requests, messages, responses, combinations of these and the like etc. may be combined, aggregated, coalesced, etc. For example, in one embodiment, one or more masked writes, partial writes, etc. may be combined. For example, in one embodiment, one or more reads may be combined. For example, in one embodiment, one or more commands may be combined to allow optimization of one or more commands at the memory chips. For example, multiple commands may be combined to allow for burst DRAM operations (reads, writes, etc.). For example, such combining and/or other command manipulation etc. may be performed in the context of FIG. 23-5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” and the accompanying text including, but not limited to, the description of supporting memory chip burst lengths, etc. Such combining, and/or other command manipulation, etc. may be programmed, configured, etc. The programming etc. of combining functions, behavior, techniques, etc. and/or other command manipulation, etc. may be performed at any time.

In one embodiment, the command optimization table and/or other tables, structures, logic, etc. may function, for example, to expand raw commands. For example, a raw command may contain a native DRAM instruction. For example, a native DRAM instruction may include (but is not limited to) commands such as: activate (ACT), precharge (PRE), refresh, read (RD), write (WR), register operations, configuration, calibration control, termination control, error control, status signaling, etc. For example, a raw command may contain a command code etc. such that the raw command may be expanded to a sequence, group, set, collection, etc. of commands, signals, etc. that may include one or more native DRAM commands, command signals (e.g. CKE, ODT, CS, etc.), address signals, row address, column address, bank address, multiplexed address signals, combinations of these and the like etc. For example, these expanded commands may be forwarded to one or more memory controllers and/or applied to (e.g. transferred to, queued for, forwarded to, sent to, coupled to, communicated to, etc.) one or more DRAM, stacked memory chips, portions of stacked memory chips, etc. Such expansion may include the generation, creation, translation, etc. of one or more control signals, addresses, command fields, command signals, and/or any other similar command, command component, signal, combinations of these and the like etc. For example, chip select signals, ODT signals, refresh commands, combinations of these and/or other signals, commands, data, information, combinations of these and the like etc. may be generated, translated, timed, retimed, staggered, and/or otherwise manipulated etc. possibly as a function or functions of other signals, command fields, settings, configurations, modes, etc. For example, refresh signals may be generated, created, ordered, scheduled, etc. in a staggered fashion in order to minimize maximum power consumption, minimize signal interference, minimize supply voltage noise, minimize ground bounce, and/or optimize any combinations of these factors and/or any other factors etc.

Thus, for example, in one embodiment, a command optimization table and/or other tables, structures, logic, associated logic, combinations of these and the like etc. may function, operate, etc. to control not only the content (e.g. of fields, bits, data, other information, etc.) of one or more commands, expanded commands, issued commands, queued commands, requests, etc. but also the timing (e.g. absolute timing of command execution, relative timing of execution of one or more commands, etc.) of commands, expanded commands, generated commands, raw commands, etc.

For example, in one embodiment, a command optimization table and/or other tables, structures, logic, etc. may function, operate, etc. to control the sequence of a number of commands. For example, the sequencing may be such that a sequence of commands meets, satisfies, respects, obeys, fulfills, etc. one or more timing parameters, timing restrictions, desired operating behavior, etc. of one or more stacked memory chips and/or portions of one or more stacked memory chips. For example, sequencing may include ensuring that a DRAM parameter such as tFAW is met. Of course, it may be desired to sequence commands etc. such that any timing parameter and/or similar rule, restriction, protocol requirement, etc. for any memory technology and/or combination of memory technologies etc. and/or timing behavior of any associated circuits, functions, etc. may be met, satisfied, obeyed, etc. For example, it may be desired, beneficial, etc. to sequence commands such that a target balance between types of commands may be met. For example, it may be beneficial to balance reads and write commands in order to maximize bus utilization, memory efficiency, etc. For example, it may be beneficial to sequence commands to reduce or eliminate bus turnaround times. For example, it may be beneficial to sequence commands to reduce or eliminate bus collision. For example, it may be beneficial to sequence commands to reduce or eliminate signal interference, power noise, power consumption and the like. In one embodiment, for example, the control, programming, configuration, operation, functions, etc. of command sequencing may be performed, partly performed, etc. by one or more state machines and/or similar logic, circuits, etc. Such state machines etc. may be programmed, configured, etc. For example, the state machine transitions, states, triggers etc. may be programmed using a simple code, text file, command code, mode change, configuration write, register write, combinations of these and/or other similar operations etc. that may be conveyed, transmitted, signaled, etc. in a command, raw command, configuration write, combinations of these and/or other similar operations etc. The programming etc. of such state machines may be performed at any time. For example, in this way the order, priority, timing, sequence, and/or other properties of one or more commands sequences, sets and/or groups of commands etc. issued, executed, queued, transferred etc. to one or more memory chips, portions of one or more memory chips, one or more memory controllers, etc. may be controlled, managed, etc.

In one embodiment, logic (e.g. the logic chip(s) in a stacked memory package, datapath logic, memory controllers, one or more optimization units, combinations of these and/or other logic circuits, structures and the like etc.) may translate (e.g., modify, store and modify, merge, separate, split, create, alter, logically combine, logically operate on, etc.) one or more requests (e.g., read request, write request, message, flow control, status request, configuration request and/or command, other commands embedded in requests (e.g., memory chip and/or logic chip and/or system configuration commands, memory chip mode register or other memory chip and/or logic chip register reads and/or writes, enables and enable signals, controls and control signals, termination values and/or termination controls, I/O and/or PHY settings, coding and data protection options and controls, test commands, characterization commands, raw commands including one or more DRAM commands, other raw commands, calibration commands, frequency parameters, burst length mode settings, timing parameters, latency settings, DLL modes and/or settings, power saving commands or command sequences, power saving modes and/or settings, etc.), combinations of these, etc.) directed at one or more logic chip(s) and/or one or more memory chips. For example, logic in a stacked memory package may split a single write request packet into two write commands per accessed memory chip. For example, logic may split a single read request packet into two read commands per accessed memory chip with each read command directed at a different portion of the memory chip (e.g., different banks, different subbanks, etc.). As an option, logic in a first stacked memory package may translate one or more requests directed at a second stacked memory package.

In one embodiment, logic in a stacked memory package may translate one or more responses (e.g., read response, message, flow control, status response, characterization response, etc.). For example, logic may merge two read bursts from a single memory chip into a single read burst. For example, logic may combine mode or other register reads from two or more memory chips. As an option, logic in a first stacked memory package may translate one or more responses from a second stacked memory package, etc.

In one embodiment, the command optimization table may function to perform, for example, command buffering. For example, the command optimization table may include two writes. In one embodiment, these two writes may be retired (e.g. removed, transferred, operations performed, commands executed, etc.) from the table according to one or more arbitration, control, throttling, priority, and/or other similar policies, algorithms, techniques and the like etc. For example, commands, requests, etc. such as reads, writes, etc. may be transferred to one or more memory controllers and data written to DRAM and/or data read from DRAM on one or more stacked memory chips. For example, the command optimization table may be used to retire (e.g. participate in retiring, be used to control retiring, track the retiring, etc.) a write to DRAM.

In one embodiment, the command optimization table structure may be optimized to reduce the storage (e.g. space, number of bits, etc.) used to hold (e.g. store, etc.) multiple partial writes. In one embodiment, the command optimization table structure may be optimized, altered, modified, etc. to increase the speed of operation (e.g. of one or more optimization functions, etc.). Thus, for example, in one embodiment, the fields, contents, encoding, etc. of one or more tables may be altered, varied, different, etc. from that described.

In one embodiment, for example, one or more tables may be constructed, designed, structured, and/or otherwise made operable to operate in one or more modes of operation. For example, a first mode of operation of one or more optimization tables and/or optimization units, control logic, etc. may be such to optimize speed (e.g. latency, bandwidth, combinations of these and/or other related performance metrics, etc.). For example, chosen metrics may include, but are not limited to, one or more of the following: peak bandwidth, minimum bandwidth, maximum bandwidth, average bandwidth, standard deviation of bandwidth, other statistical measures of bandwidth, average latency, maximum latency, minimum latency, standard deviation of latency, other statistical measures of latency, combinations of these and/or other measures, metrics and the like etc. For example, a second mode of operation of one or more optimization tables and/or optimization units, control logic, etc. may be such to optimize power (e.g. minimize power, operate such that power does not exceed a threshold, etc.). One or more such operating modes may be configured, programmed, etc. Configuration etc. of one or more such operating modes may be performed at any time.

In one embodiment, for example, one or more modes of operation and/or any other aspect, property, behavior, function, etc. of one or more optimization tables, optimization units, control logic associated with optimization, and/or any other logic, circuits, functions, etc. may be configured, programmed, etc. using a model. For example, in one embodiment, the optimization system may be implemented in the context of FIGS. 23-6A, 23-6B, and/or 23-6C of U.S. application Ser. No. 13/710,411, filed Dec. 10, 2012, titled “SYSTEM, METHOD, AND COMPUTER PROGRAM PRODUCT FOR IMPROVING MEMORY SYSTEMS” and the accompanying text including, but not limited to, the text describing the models, protocols, channel efficiency, etc. For example, in one embodiment, one or more measurements, parameters, settings, etc. may be used as one or more inputs to a model, collection of models, etc. that may model the behavior, aspects, functions, responses, performance, etc. of one or more parts of a memory system. For example, in one embodiment, the model may then be used to adjust, alter, modify, tune, and/or otherwise program, configure, reconfigure etc. one or more aspects, features, parameters, inputs, outputs, behavior, algorithms, and/or other functions of the like of one or more optimization tables, optimization data structures, optimization units, control logic and/or any other logic, control logic, logic structures, etc. of a memory system.

In one embodiment, the command optimization table may be split, divided, separated, etc. into one or more separate tables for command combining and command buffering, for example. In one embodiment, the command optimization table may be split etc. into separate tables for read buffering and write buffering, for example.

In one embodiment, the command optimization table may perform command reordering. For example, in one embodiment, command reordering may be based on the sequence number. For example, in one embodiment, command reordering may be controlled by, determined by, governed by, etc. one or more memory ordering rules, ordering policies, etc. For example, in one embodiment, command reordering may be determined by the memory type, memory class (as described herein and/or in one or more applications incorporated by reference), etc.

In one embodiment, the command optimization table or any tables, structures, etc. may perform or be used to perform any type of command, request, etc. processing, handling, operations, manipulations, changes, and/or similar functions and the like etc.

In one embodiment, any number, type, form, of tables with any content, data, information, format, structure, etc. may be used for any number, type, etc. of optimization functions and the like, etc.

In one embodiment, the write optimization table may be populated from a request. In one embodiment, only commands that may be eligible (e.g. appropriate, legal, satisfy constraints, etc.) may be used to populate the write optimization table. For example, control logic associated with (e.g. coupled to, connected to, etc.) the write optimization table may populate the write optimization table with write request or a subset of write requests, etc. The eligible commands, requests, etc. may be configured and/or programmed.

In one embodiment, for example, the configuration etc. of table population rules, algorithms and other similar techniques etc. and/or configuration of any aspect, behavior, etc. of table operation may be performed at any time. In one embodiment, for example, a command, request, trigger, etc. to configure etc. one or more tables, table structures, table functions, table behavior, table contents, etc. may result in the emptying, clearing, flushing, zeroing, resetting, etc. of one or more fields, bits, structures, tables and/or logic associated with, coupled to, connected with, etc. one or more tables etc.

In one embodiment, for example, control logic associated with (e.g. coupled to, connected to, etc.) the write optimization table may populate the valid field, which may be used to indicate which data bytes in the write optimization table are valid. The valid field may be derived from the command code, for example. For example, control logic associated with the write optimization table may populate the dirty bit, which may be used to indicate which entries in the write optimization table are dirty.

In one embodiment, the write optimization table may act to perform as a cache, temporary store, etc. for write data. For example, a write optimization table entry may store data that is scheduled to be written to an address. For example, a table entry may store data to be written to address 001. If, for example, a read request is received while this entry is in the write optimization table, the data may be forwarded to the transmit datapath. For example, the data may be forwarded using a read bypass technique and using a read bypass path as described herein and/or in one or more applications incorporated by reference. Forwarded data may be combined with the sequence number from the read request (and possibly other information, data, fields, etc.) to form one or more read responses.

In one embodiment, combined writes (e.g. from a command optimization table, etc.) may be included in the write optimization table. In one embodiment, combined writes may be excluded from the write optimization table (for example, to preserve program order and/or other memory ordering model etc.).

In one embodiment, the write optimization table may use an address organized (e.g. including, etc.) as tag, index, offset, etc. (e.g. in order to reduce cache size, increase cache speed, etc.). In one embodiment, the write optimization table may be of any size, type, organization, structure, etc. In one embodiment, the write optimization table may use any population policy, replacement policy, write policy, hit policy, miss policy, combinations of these and/or any other policy and the like, etc.

In one embodiment, a stream of (e.g. multiple, set of, group of, one or more, etc.) responses (e.g. read responses, messages, etc.) may be processed by a transmit datapath (e.g. included in a logic chip in a stacked memory package, etc. as described elsewhere herein and/or in one or more applications incorporated by reference). In one embodiment, the responses may include data from a memory controller connected to memory (e.g. DRAM in one or more stacked memory chips, etc.). For example, a response etc. may include (but is not limited to) one or more of the following fields: (1) Data: read data and/or other data; (2) SEQ: a sequence number, identifying each command in the system. Any number and type of fields may be used.

For example, the read optimization table may be populated from a response. Table population (e.g. for any tables, structures, etc.) may be performed by control logic, state machines, and/or other logic etc. that may be coupled to, connected to, associated with, etc. one or more tables, table structures, table storage, etc. In one embodiment, only commands, responses, etc. that may be eligible may be used to populate the read optimization table. For example, control logic associated with the read optimization table may populate the read optimization table with read responses or a subset of read responses, etc. The eligible commands, requests, etc. may be configured and/or programmed. Configuration etc. of table population rules, algorithms and other similar techniques etc. and/or configuration of any aspect, behavior, etc. of table operation may be performed at any time. For example, control logic associated with (e.g. coupled to, connected to, etc.) the read optimization table may populate a valid field, which may be used to indicate which data bytes in the read optimization table are valid. In one embodiment, the read optimization table may act to perform as a cache, temporary store, etc. for read data. For example, a read optimization table entry may store data that is stored in a memory address. For example, a table entry may store data in memory address 010. If, for example, a read request is received for address 010 while the corresponding read optimization table entry is in the read optimization table, the data from the read optimization table entry may be used in the transmit datapath to form the read response. In one embodiment, the data from the read optimization table entry may be combined with the sequence number from the read request to form the response, for example. Note that reads of length that are less than a full read optimization table entry may also be completed using the valid bits to determine if the requested data is valid data in the read optimization table entry.

In one embodiment, one or more read optimization tables may act, operate, function, etc. to allow the ordering, reordering, interleaving, and/or other similar organization of one or more read responses etc. For example, in one embodiment, responses may be reordered to correspond to program order. For example, in one embodiment, responses may be reordered to correspond to the order in which read requests were received. For example, in one embodiment, responses may be reordered to correspond to a function of sequence numbers (e.g. by increasing sequence number, etc.). For example, in one embodiment, responses may be reordered to correspond to a function of one or more parameters, metrics, measures, etc. For example, in one embodiment, responses may be reordered by a hierarchical technique, in a hierarchical manner, according to hierarchical rules, etc. For example, in one embodiment, responses may be ordered by source of the request first (e.g. at the highest level of hierarchy, etc.) and then by sequence number. Of course, any parameter, field, metric, data, information, combinations of these and the like may be used to control ordering. For example, ordering may be a function of virtual channel, traffic class, memory class (as defined herein and/or in one or more applications incorporated by reference), etc. Such ordering control etc. may be configured, programmed, etc. Such programming etc. of ordering may be performed at any time. Ordering may be controlled by the request, for example. For example, in one embodiment, a request for multiple words, cache lines, etc. may include a desired response ordering. For example, a CPU may indicate that a response include a critical word first. For example, a CPU may indicate a particular response ordering, etc. Of course any technique etc. may be used to program, configure, control, alter, modify, etc. one or more operations, behavior, functions, etc. of ordering.

In one embodiment, the read optimization table may be part of the optimization units, tables, etc. that may be part of the Rx datapath. In this case, for example, the data may be forwarded using a read bypass technique and using a read bypass path as described herein and/or in one or more applications incorporated by reference. Forwarded data may be combined with the sequence number from the read request (and possibly other information, data, fields, etc.) to form one or more read responses.

In one embodiment, the read optimization table may use an address organized (e.g. including, etc.) as tag, index, offset, etc. (e.g. in order to reduce cache size, increase cache speed, etc.). In one embodiment, the read optimization table may be of any size, type, organization, structure, etc. In one embodiment, the read optimization table may use any population policy, replacement policy, write policy, hit policy, miss policy, combinations of these and/or any other policy and the like, etc. In one embodiment, the read optimization table may be combined with, part of, included with, coupled to, connected to, and/or otherwise logically associated with one or more other tables. For example, in one embodiment, the read optimization table, or parts of the read optimization table, may be combined with one or more parts of a write optimization table. In one embodiment, any table, or part of a table, may be combined, integrated, coupled to, connected to, joined with, shared with, cooperate with, collaborate with, etc. one or more other tables.

In one embodiment, the optimization tables may use (e.g. be constructed with, employ, etc.) different formats. For example, the write optimization table may use a 2-bit valid field and dirty bit and the read optimization table may have no dirty bit. In one embodiment, the optimization tables may use different formats from that described above, elsewhere herein, and/or in one or more specifications incorporated by reference. For example, depending on the polices and algorithms used one or more optimization tables may contain additional fields (e.g. additional address parts or portions, indexes, offsets, pointers, combinations of these and/or other similar data, information and the like, etc.), different sized fields (e.g. different number of bits, etc.), different bits (e.g. additional flags, marks, pointers, etc.), etc. from that described. For example, in one embodiment, a common structure may be used for one or more optimization tables. For example, in one embodiment, one or more read optimization tables and one or more write optimization tables may be combined in such a way as to form one or more read/write optimization tables. For example, in one embodiment, the percentage of table space (e.g. number of table entries, etc.) used for read optimization and/or write optimization in a read/write optimization table may be varied. For example, in one embodiment, the percentage of table spaces used for optimization in a read/write optimization table may be programmed, configured, etc. In one embodiment any combinations of tables may be used in one or more locations in a datapath (e.g. command optimization tables, read optimization tables, write optimization tables, read/write optimization tables, command/read/write optimization tables, etc.).

In one embodiment, for example, the configuration of table space may be performed at design time, manufacture, assembly, test, boot, start-up, during operation, at combinations of these times and/or at any time, etc. For example, the allocation of storage, memory, etc. to one or more tables (e.g. command optimization tables, read optimization tables, write optimization tables, read/write optimization tables, command/read/write optimization tables, etc.) may be a function of performance. For example, in one embodiment, one or more control logic blocks, circuits, functions, etc. may monitor the performance of one or more optimization tables and/or parts, portions of one or more optimization tables, etc. For example, in one embodiment, the hit rate of one or more optimization tables may be measured, monitored, sampled, predicted, modeled, and/or otherwise obtained in a similar manner etc. Of course, any measure, metric, parameters, function, etc. related to, associated with, corresponding to any aspect, behavior, etc. of performance may be so obtained. For example, if a read optimization table is performing with a high hit rate, the table space assigned to the read optimization table may be increased, etc. Of course, any aspect, parameter, structure, function, behavior, size, format, combinations of these and/or other similar properties and the like of one or more optimization tables and/or logic, functions, circuits, etc. associated with, connected to, coupled to, attached to, corresponding to, etc. one or more optimization tables may be changed, programmed, altered, modified, configured, set, and/or otherwise controlled, etc. In one embodiment, for example, the configuration of table space, control of table functions, and/or any other aspect of tables, associated logic etc. may be static (e.g. fixed, relatively fixed, may be held fixed, may be set, etc.) and/or dynamic (e.g. may be changed, may be changed continuously, may be changed at a steady rate, may be changed in response to system events, may be changed in response to signals, may be changed in response to one or more commands, may be changed in response to measurement, may be changed in a feedback loop, may be changed according to user input, may be changed according to combinations of these and/or other similar actions, events, triggers, etc.).

Note that the sizes of fields, widths of fields, contents of fields, etc. in the data structures, tables, etc. may be different from that described. For example, the command fields may be 8 bits wide, or any number. For example, the address field in a 64-bit system may be 64 bits wide, or any number. For example, the address field in a 32-bit system may be 32 bits wide, or any number. For example, the data field may be 2, 4, 8, 16, 32, 64, 72, 128, 256 bytes wide, or any number. For example, the data field may be variable width and depend on command (e.g. may be different widths depending on the type of write command, etc.). For example, any field may be variable width and depend, for example, on command (e.g. fields may be different widths depending on the type of command and/or other factors, etc.). For example, the data field may be zero for read commands, etc. For example, the data field (and/or any field) may be used for information other than data in certain commands types (e.g. raw commands etc.). For example, the virtual channel field may be 2, 4, 8 bits wide, or any number. For example, the sequence number field may be 8, 16 bits wide, or any number. For example, the valid field may be 1, 2, 8, 16, 32, 64 bits wide, or any number and/or may depend on (e.g. be a function of, etc.) the width of the data field. For example, there may be any number of dirty bits.

In one embodiment, for example, one or more fields in one or more tables etc. may be split. For example, one or more commands may include sub-commands. For example, one or more read commands may be included, piggy-backed, etc. in a write command. Thus, the format, shape, appearance, layout, structure etc. of commands, requests, responses, messages, raw commands, etc. may be such that the corresponding, associated, etc. format, shape, appearance, layout, structure etc. of one or more tables, data structures, fields in these structures and/or tables, etc. may also be varied, shaped, designed, etc. accordingly (e.g. to accommodate, hold, store, process, operate on, etc. one or more commands, raw commands, requests, responses, messages, etc.).

As described above, elsewhere herein and/or in one or more specifications incorporated by reference, one or more optimization systems possibly including tables, storage tables, and/or other logic, functions, etc. may be used to process one or more instructions, commands, etc. In one embodiment, for example, these optimization systems, tables, and/or other logic, logic structures, data structures, etc. may be used to process atomic instructions, atomic commands, atomic operations, transactions, commit of a transaction, atomic tasks, composable tasks, noncomposable tasks, consistent operations, isolated operations, durable operations, linearizable operations, indivisible operations, uninterruptible operations, chained commands, connected commands, merged commands, expanded commands, multi-part commands, multi-command commands, super commands, jumbo commands, compound commands, complex commands, spin locks, semaphores, mutexes, seqlocks, read-copy-update (RCU), read-modify-write (RMW) instructions, raw commands, read writer locks, RCU primitives, wait handles, event wait handles, lightweight synchronization, spin wait, double-checked locking, lock hints, recursive locks, timed locks, hierarchical locks, hardware lock elision (HLE), instruction prefixes (e.g. XACQUIRE, XRELEASE, etc.), nested instructions and/or transactions (e.g. using XBEGIN, XEND, XABORT, etc.), restricted transactional memory (RTM) semantics and/or instructions, transaction read-sets (RS), transaction write-sets (WS), strong isolation, commit operations, abort operations, test instructions, register operations, mode register operations, configuration operations, messages, status, serializing instructions, read memory barriers, write memory barriers, memory barriers, barriers, fences, memory fences, instruction fences, command fences, optimization barriers, compare-and-swap, test-and-set, fetch-and-add, arithmetic instructions (add, decrement, subtract, increment, combinations of these, etc.), logic instructions (shift, arithmetic shift, logic shift, barrel shift, etc.), combinations of these and/or any other commands, requests, responses, completions, instructions, operations, primitives, locks, ordering, barriers, and the like, etc.

In one embodiment, for example, one or more local resources may be used to perform such operations as compound instructions etc. In one embodiment, a local resource may be all, a part, a portion, etc. of a logic function, logic block, computation function, processor, programmable logic, and/or any similar logic function (using hardware, software, firmware, a combination of these, etc.) that may be local to (e.g. coupled to, in proximity to, located nearby, logically grouped with, etc.) any component, circuit, block, functions, and the like etc. For example, in one embodiment, one or more local resources may be distributed on a logic chip. For example, in one embodiment, a local resource may be located nearby each memory controller on a logic chip. For example, in one embodiment, a local comparator (e.g. local to a memory controller and/or other logic etc.) may be used to perform part of a CAS instruction, etc.

In one embodiment, for example, one or more global resources may be used to perform such operations as compound instructions etc. For example, in one embodiment, one or more global resources may be distributed on a logic chip. For example, in one embodiment, a global resource may be located such that each global resource is shared by one or more memory controllers on a logic chip. For example, in one embodiment, a single macro engine may be used as a global resource (e.g. coupled to each memory controller and/or other logic etc.) and may be used to perform macros etc (e.g. compound instructions, test commands, and/or any other macro-enabled functions and the like, etc.). For example, a macro engine and/or similar logic (e.g. CPU, processor, microcontroller, ALU, execution unit, programmable logic, program store, combinations of these and/or any other logic functions, circuits, blocks, and the like etc.) may be used to perform such operations as test instructions, more complex compound instructions, etc.

In one embodiment, for example, additional functions, circuits, blocks, resources, etc. that may be local to the memory subsystem, stacked memory package, and/or other component, hub device, buffer, etc. may include, form, implement, etc. one or more local resources and/or one or more global resources. In one embodiment, for example, additional functions, circuits, blocks, resources, etc. that may reside local to the memory subsystem, stacked memory package, and/or other component, hub device, buffer, etc. may include (but are not limited to) one or more of the following: data, control, write and/or read buffers (e.g. registers, FIFOs, LIFOs, etc), data and/or control arbitration, command reordering, command retiming, one or more levels of memory cache, local pre-fetch logic, data encryption and/or decryption, data compression and/or decompression, data packing functions, protocol (e.g. command, data, format, etc.) translation, protocol checking, channel prioritization control, link-layer functions (e.g. coding, encoding, scrambling, decoding, etc.), link and/or channel characterization, command prioritization logic, voltage and/or level translation, error detection and/or correction circuitry, RAS features and functions, RAS control functions, repair circuits, data scrubbing, test circuits, self-test circuits and functions, diagnostic functions, debug functions, local power management circuitry and/or reporting, power-down functions, hot-plug functions, operational and/or status registers, initialization circuitry, reset functions, voltage control and/or monitoring, clock frequency control, link speed control, link width control, link direction control, link topology control, link error rate control, instruction format control, instruction decode, bandwidth control (e.g. virtual channel control, credit control, score boarding, etc.), performance monitoring and/or control, one or more coprocessors, arithmetic functions, macro functions, software assist functions, move/copy functions, pointer arithmetic functions, counter (e.g. increment, decrement, etc.) circuits, programmable functions, data manipulation (e.g. graphics, etc.), search engine(s), virus detection, access control, security functions, memory and cache coherence functions (e.g. MESI, MOESI, MESIF, directory-assisted snooping (DAS), etc.), other functions that may have previously resided in other memory subsystems or other systems (e.g. CPU, GPU, FPGA, etc.), combinations of these, etc.

In one embodiment, for example, by placing one or more functions local (e.g. electrically close, logically close, physically close, within, etc.) to the memory subsystem, added performance may be obtained as related to the specific function, often while making use of unused circuits or making more efficient use of circuits within the subsystem. For example, one or more of the above functions, circuits, blocks, etc. and/or parts, portions of the above may be placed, located, distributed, etc. on one or more logic chips, on one or more stacked memory chips, and/or other locations in a stacked memory package. For example, one or more of the above functions, circuits, blocks, etc. and/or parts, portions of the above may be placed, located, distributed, etc. on one or more logic chips, on one or more stacked memory chips, and/or other locations in a stacked memory package as one or more local resources and/or one or more global resources, etc.

In one embodiment, the logic chip(s) and/or other logic in a stacked memory package may include one or more compute processors, macro engines, local CPUs, ALUs, Turing machines, combinations of these and/or any other similar logic, functions, circuits, blocks, etc. For example, it may be advantageous, beneficial, etc. to provide the logic chip with various compute resources. For example, it may be advantageous etc. to provide the logic chip with various compute resources as local resources and/or global resources.

For example, to increment a counter the system CPU may normally perform the following steps: (1) fetch a counter variable stored in the memory system as data from a memory address (possibly involving a fetch of 256 bits or more depending on cache size and word lengths, possibly requiring the opening of a new page etc.); (2) increment the counter; (3) store the modified variable back in main memory (possibly to an already closed page, thus incurring extra latency etc.).

In one embodiment, for example, a stacked memory package may use, employ, etc. one or more macro engines etc. (e.g. located for example in a logic chip and/or elsewhere in a stacked memory package, etc.) that may be programmed (e.g. by command, instruction, packet, message, request, and/or by any other techniques, etc.) to increment a counter etc. directly in memory. In this case, for example, incrementing a counter etc. directly in memory may thus possibly reduce latency (e.g. time to complete the increment operation, etc.) and possibly reduce power (e.g. by saving operation of PHY and link layers, etc.) and/or possibly achieve, realize, effect, etc. other benefits, advantages, etc.

In one embodiment, the uses of a macro engine etc. may include, but are not limited to, one or more of the following (either directly (e.g. self-contained, in cooperation with, collaboration with, etc. other logic on the logic chip, and/or any other logic, etc.) and/or indirectly in cooperation with other system components, etc.); to perform pointer arithmetic; move, transfer, and/or otherwise copy blocks, regions, areas, ranges, etc. of memory (e.g. perform CPU software bcopy( ) functions, etc.); be operable to aid in direct memory access (DMA) operations (e.g. increment address counters, etc.); compress data in memory or in requests (e.g. gzip, 7z, etc.) or expand data; scan data (e.g. for virus, programmable (e.g. by packet, message, etc.) or preprogrammed patterns, etc.); compute hash values (e.g. MD5, etc.); implement automatic packet or data counters; read/write counters; error counting; perform semaphore operations; perform atomic load and/or store operations; perform memory indirection operations; be operable to aid in providing or directly provide transactional memory; compute memory offsets; perform memory array functions; perform matrix operations; implement counters for self-test; perform or be operable to perform or aid in performing self-test operations (e.g. walking ones tests, etc.); compute latency or other parameters to be sent to the CPU or other logic chips; perform search functions; create metadata (e.g. indexes, etc.); analyze memory data; track memory use; perform prefetch or other optimizations; calculate refresh periods; perform temperature throttling calculations or other calculations related to temperature; handle cache policies (e.g. manage dirty bits, write-through cache policy, writeback cache policy, etc.); manage priority queues; perform memory RAID operations; perform error checking (e.g. CRC, ECC, SECDED, etc.); perform error encoding (e.g. ECC, Huffman, LDPC, etc.); perform error decoding; or enable; perform or be operable to perform any other system operation that may require or otherwise benefit from programmed or programmable calculations, logic, operations and the like; etc. In one embodiment the one or more macro engine(s) may be programmable using high-level instruction codes (e.g. increment this address, etc.) etc. and/or low-level (e.g. microcode, machine instructions, etc.) sent in messages and/or requests. In one embodiment the logic chip may contain stored program memory (e.g. in volatile memory (e.g. SRAM, eDRAM, etc.) or in non-volatile memory (e.g. flash, NVRAM, etc.). Stored program code may be moved between non-volatile memory and volatile memory to improve execution speed. Program code and/or data may also be cached by the logic chip using fast on-chip memory, etc. Programs and algorithms may be sent to the logic chip and stored at start-up, during initialization, at run time or at any time during the memory system operation. Operations may be performed on data contained in one or more requests, already stored in memory, data read from memory as a result of a request or command (e.g. memory read, etc.), data stored in memory (e.g. in one or more stacked memory chips (e.g. data, register data, etc.); in memory or register data etc. on a logic chip; etc.) as a result of a request or command (e.g. memory system write, configuration write, memory chip register modification, logic chip register modification, etc.), or combinations of these, etc.

In one embodiment, for example, the uses of macros block(s) etc. may include, but are not limited to, one or more of the following (either directly (e.g. self-contained, in cooperation with, collaboration with, etc. other logic on the logic chip, and/or any other logic etc.) and/or indirectly in cooperation with, in collaboration with, in conjunction with, etc. other system components, one or more CPUs, etc.); to perform pointer operations and/or arithmetic, logical, and/or any other computation functions; move, relocate, shadow, duplicate, and/or otherwise copy etc. blocks, regions, areas, ranges, etc. of memory (e.g. perform CPU software bcopy( ) functions; and/or other similar OS macros, functions, routines; and/or other similar copy functions, behaviors, algorithms, routines, and the like etc.); perform, maintain, control, operate, manage, etc. or be operable to aid in, perform etc. one or more direct memory access (DMA) and/or remote DMA (RDMA) operations (e.g. including, but not limited to, one or more of the following: increment address counters, implement memory and/or other protection tables, perform address translation, perform other related, similar, etc. memory functions, operations, and the like etc.); perform, maintain, control, operate, manage, etc. cache functions and/or cache related functions, operations, etc; perform, maintain, control, operate, manage, etc. caches, cache operations, cache contents, cache fields, cache behavior, cache policies, cache settings, cache types, and/or any cache related operations, functions, algorithms, behaviors, and the like etc; perform, maintain, control, operate, manage, etc. memory coherence policies and the like; deduplicate data in memory, in requests, in responses, etc; and/or otherwise perform deduplication functions and the like etc.; compress data (and/or otherwise map data etc.) in memory, in requests, in responses, etc. (e.g. using gzip, 7z, and/or any other compression algorithm, format, standard, algorithm, and/or similar technique etc.); expand (e.g. decompress, and/or otherwise map etc.) data; scan, parse, and/or otherwise process data (e.g. for virus content, etc.) in a programmable fashion (e.g. by packet, message, etc.) and/or by using preprogrammed patterns, etc.; check hash values, checksums, check values, message digests, and/or other hash functions and the like etc. and/or compute hash values etc. (e.g. including, but not limited to one or more of the following: MD5, MD6, SHA-1, SHA-2, other ciphers, checksums, hashes, hash functions, and/or any other similar algorithms and the like, etc.); implement, handle, maintain, etc. automatic packet counters and/or data counters and/or other counters etc.; implement, handle, maintain, etc. memory read/write counters; perform, maintain, control, operate, manage, etc. error management, error tracking, error counting, error reporting, and/or other error related functions, operations, behaviors, etc.; perform, maintain, control, operate, manage, etc. semaphore and/or any similar or related lock operations, primitives, instructions, etc.; perform, maintain, control, operate, manage, etc. operations to filter, modify, transform, alter, manipulate, and/or otherwise change data, information, metadata, and the like etc. (e.g. in memory, in requests, in commands, in responses, in completions, in packets, and/or in any location, in any manner, in any fashion, etc.); perform, maintain, control, operate, manage, etc. atomic load and/or store operations; perform, maintain, control, operate, manage, etc. memory indirection operations; perform, maintain, control, operate, manage, etc. and/or be operable to aid in providing or directly provide transactional memory and/or transactional operations (e.g. atomic transactions, database operations, other related operations and the like etc.); maintain, control, operate, manage, etc. one or more databases, database operations, etc; perform one or more database operations (e.g. in response to commands, requests, signals, etc.); manage, maintain, control, etc. memory access (e.g. via password, keys, and/or any other controls, etc.); perform, control, maintain, etc. security operations (e.g. encryption, decryption, key management, other related operations and the like etc.); compute memory offsets and/or other memory related metrics, parameters and the like etc.; perform memory array functions and/or memory vector operations and the like etc.; perform matrix operations; implement counters for self-test; perform, maintain, control, operate, manage, etc. or be operable to perform or aid in performing etc. self-test and/or other test related functions, operations and the like (e.g. walking ones tests, other tests and/or test patterns, etc.); compute, maintain, control, manage, etc. latency and/or other parameters, metrics, measures, values, records, logs, etc. e.g. to be sent to the CPU and/or other logic chips; perform search functions and/or search operations; create metadata (e.g. indexes, other data properties and the like, etc.); analyze memory data; track memory use; perform prefetch, prediction, and/or any other similar calculations, optimizations, and the like; maintain, control, calculate, etc. refresh periods and/or refresh related data, information, timing, etc.; maintain, control, manage, perform, etc. temperature measurement, throttling calculations and/or other calculations, operations, etc. related to temperature; maintain, control, manage, handle etc. one or more cache policies (e.g. manage dirty bits, write-through cache policy, write-back cache policy, other cache functions, combinations of these and/or other cache functions, etc.); maintain, control, operate, manage, etc. one or more priority queues; maintain, control, operate, manage, etc. one or more virtual channels; maintain, control, operate, manage, etc. one or more traffic queues; maintain, control, operate, manage, etc. memory sparing; maintain, control, operate, manage, etc. hot swap; maintain, control, operate, manage, etc. memory scrubbing and/or other memory reliability functions; initialize memory (e.g. to all zeros, to all ones, etc.); perform, maintain, control, operate, manage, etc. memory RAID operations and/or other operations related to RAID or similar memory arrangements, structures, etc.; perform, maintain, control, operate, manage, etc. error checking (e.g. CRC, ECC, SECDED, combinations of these and/or other error checking codes, coding, etc.); perform, maintain, control, operate, manage, etc. error encoding (e.g. ECC, Huffman, LDPC, combinations of these and/or other error codes, coding, etc.); perform, maintain, control, operate, manage, etc. error decoding; perform, maintain, control, operate, manage, etc. records, tables, indexes, catalogs, use, etc. of one or more spare memory regions, spare circuits, spare functions, etc; enable, perform, manage, etc. testing of TSV arrays and/or other connections; perform control, management, etc. of memory repair operations, functions, algorithms, etc; enable, perform or be operable to perform any other logic function, system operation, etc. that may require programmed or programmable calculations; perform combinations of these functions, operations, etc. and/or any other functions, operations etc.

In one embodiment, for example, the one or more macro engine(s) and/or macros block(s) etc. may be programmable, configurable, controlled, etc. In one embodiment, for example, the macro engine(s) etc. may be programmed, configured, controlled, etc. using high-level instruction codes etc. (e.g. increment a specified address, etc.) and/or low-level instructions etc. (e.g. using, employing, etc. microcode, machine instructions, and/or similar instructions, commands, and the like etc.). In one embodiment, for example, the macro engine(s) etc. may be programmed etc. using instructions etc. sent, carried, conveyed, etc. in messages, requests, commands, instructions and/or any other similar techniques and the like etc. Of course, programming, configuration, control, etc. may be performed in any manner, fashion, etc. at any time.

In one embodiment, for example, there may be several copies of local resources, and a single copy of a global resource. For example, in one embodiment, there may be a single copy of a macro engine etc. used as a global resource. For example, in one embodiment, the macro engine may be a global resource located on a single logic chip in stacked memory package, etc. For example, in one embodiment, there may be multiple copies of a comparator etc. used as a local resource. For example, in one embodiment, a comparator may be a local resource located in proximity to (e.g. coupled to, in close physical and/or electrical, logical proximity to, etc.) each memory controller on a single logic chip in a stacked memory package, etc. Of course there may be any type, number, form, architecture, design, implementation, location, etc. of one or more local resources and/or one or more global resources. Thus, for example, in one embodiment a local resource may mean a local resource per memory controller. Thus, for example, in one embodiment a global resource may mean a global resource per logic chip. Note that any number of global resources may be used per logic chip. Note that any number of local resources may be used per logic chip. Note that a local resource and/or a global resource may be local to any circuits, blocks, functions, etc. For example, a global resource that has one copy per logic chip may still be referred to as local to the stacked memory package, local to the memory system, etc. Note that a local resource and/or a global resource may be distributed (e.g. located on one or more chips and/or located, included, placed, etc. in one or more circuits, functions, blocks, etc.).

In one embodiment, for example, as an option, one or more requests and/or responses may perform, be used to perform, correspond to performing, form a part of portion of performing, etc. and/or otherwise support (e.g. implement, etc.) one or more operations, transactions, messages, status, etc. that may correspond to (e.g. form part of, implement, etc.) one or more memory-consistency models as described above, elsewhere herein, and/or in one or more specifications incorporated by reference, etc. For example, one or more requests etc. may perform etc. one or more operations etc. that may correspond to one or more memory-consistency models including, but not limited to, one or more of the following: sequential memory-consistency models, relaxed consistency models, weak consistency models, TSO, PSO, program ordering, strong ordering, processor ordering, write ordering with store-buffer forwarding, combinations of these and/or any other similar, related models and the like, etc.

In one embodiment, for example, as an option, one or more parts, portions, etc. of one or more memory chips, memory portions of logic chips, combinations of these and/or any other memory portions may form one or more caches, cache structures, cache functions, combinations of these and/or any other similar cache structures, functions, and the like, etc.

In one embodiment, for example, as an option, one or more caches, buffers, stores, etc. may be used to cache (e.g. store, hold, etc.) data, information, etc. stored in one or more stacked memory chips. In one embodiment, for example, one or more caches may be implemented (e.g. architected, designed, etc.) using memory on one or more logic chips. In one embodiment, for example, one or more caches may be constructed (e.g. implemented, architected, designed, etc.) using memory on one or more stacked memory chips. In one embodiment, for example, as an option, one or more caches may be constructed (e.g. implemented, architected, designed, logically formed, etc.) using a combination of memory on one or more stacked memory chips and/or one or more logic chips. For example, in one embodiment, as an option, one or more caches may be constructed etc. using non-volatile memory (e.g. NAND flash, etc.) on one or more logic chips. For example, in one embodiment, as an option, one or more caches may be constructed etc. using logic NVM (e.g. MTP logic NVM, etc.) on one or more logic chips. For example, in one embodiment, as an option, one or more caches may be constructed etc. using volatile memory (e.g. SRAM, embedded DRAM, eDRAM, etc.) on one or more logic chips. For example, in one embodiment, one or more caches may be constructed using any memory technology, storage technology, memory circuits, and the like etc.

In one embodiment, for example, as an option, one or more caches, buffers, stores, etc. may be logically connected in series (e.g. and/or otherwise coupled to, connected with, the datapath, etc.) with one or more memory systems, memory structures, memory circuits, etc. included on one or more stacked memory chips and/or one or more logic chips. For example, the CPU may send a request to a stacked memory package. For example, the request may be a read request. For example, as an option, a logic chip may check, inspect, parse, deconstruct, examine, etc. the read request and determine if the target (e.g. object, destination, reference, etc.) of the read request (e.g. memory location, memory address, memory address range, memory reference, etc.) is held (e.g. stored, saved, present, etc.) in one or more caches, buffers, stores, etc. If the data etc. requested is present in one or more caches etc. then the read request, as an option, may be completed (e.g. read data etc. provided, supplied, etc.) from a cache (or combination of caches, etc.). If the data, etc. requested is not present in one or more caches then the read request, as an option, may be forwarded to the memory system, memory structures, etc. For example, the read request may be forwarded to one or more memory controllers, etc.

In one embodiment, for example, as an option, one or more memory structures, temporary storage, buffers, stores, combinations of these and the like etc. (e.g. in one or more logic chips, in one or more datapaths, in one or more memory controllers, in one or more stacked memory chips, in combinations of these and/or in any memory structures in the memory system, etc.) may be used to optimize, accelerate, etc. one or more writes, write commands, etc. For example, as an option, acceleration etc. of one or more write requests may be implemented, etc. by retiring (e.g. completing, satisfying, signaling a request as completed, generating a response, making a write commitment, executing, queuing, etc.) ahead of, before, etc. these actions may normally be performed, executed, etc. For example, as an option, one or more write requests may be retired (e.g. completed, satisfied, signaled as completed, response generated, write commit made, executed, queued, etc.) by storing write data and/or any other data, information, etc. in one or more write acceleration structures, optimization units, and/or any other circuits that may optimize and/or otherwise change, modify, improve performance, etc. Similarly, as an option, one or more like memory structures etc. may be used, designed, configured, programmed, operated, enabled, disabled, switched on, switched off, etc. to optimize, accelerate, etc. one or more reads, read commands, etc. Similarly, as an option, one or more like memory structures etc. may be used, designed, configured, programmed, operated, enabled, disabled, etc. to optimize, accelerate, and/or otherwise modify the behavior, properties, function, performance, power, etc. of any number, type, form, class, mode, etc. of any commands, requests, responses, messages, etc.

For example, in one embodiment, as an option, one or more write acceleration structures, circuits, blocks, functions, etc. may include one or more write acceleration buffers (e.g. FIFOs, register files, any other storage structures, data structures, etc.). For example, in one embodiment, as an option, one or more write acceleration buffers may be used on one or more logic chips, in the datapaths of one or more logic chips, in one or more memory controllers, in one or more memory chips, and/or in combinations of these etc. For example, in one embodiment, as an option, one or more write acceleration buffers may include one or more structures (e.g. circuits, arrays, blocks, etc.) of non-volatile memory (e.g. NAND flash, logic NVM, etc.). For example, in one embodiment, a write acceleration buffer may include one or more structures of volatile memory (e.g. SRAM, eDRAM, etc.). For example, in one embodiment, as an option, a write acceleration buffer may include any number, type, arrangement, etc. of memory, memory circuits, and the like, etc.

For example, in one embodiment, as an option, a write acceleration buffer may be battery backed to ensure the contents are not lost in the event of system failure or any other similar system events, etc. Of course, any form of cache protocol, cache management, etc. may be used for one or more write acceleration buffers (e.g. copy back, writethrough, etc.). In one embodiment, as an option, the form, behavior, function, etc. of cache protocol, cache management, and/or any other cache features, parameters, etc. may be programmed, configured, enabled, disabled, and/or otherwise altered e.g. at design time, assembly, manufacture, test, boot time, start-up, during operation, at combinations of these times and/or at any times, etc. In one embodiment, as an option, a write acceleration buffer may be backed, protected, powered, etc. using any energy storage device (e.g. battery, supercapacitor, and the like etc.).

In one embodiment, for example, as an option, one or more caches may be logically separate from the memory system (e.g. any other parts of the memory system, etc.) in one or more stacked memory packages. For example, as an option, one or more caches may be accessed directly by one or more CPUs. For example, one or more caches may form an L1, L2, L3 cache, and/or any other cache structure etc. of one or more CPUs. In one embodiment, for example, as an option, one or more CPU die may be stacked together with one or more stacked memory chips in a stacked memory package. Thus, in this case, for example, as an option, one or more stacked memory chips may form one or more cache structures etc. for one or more CPUs in a stacked memory package.

For example, in FIG. 18-2, as an option, the CPU 18-232 may be integrated with one or more stacked memory packages and/or otherwise included, attached, directly coupled, assembled, packaged in, combinations of these and/or using any other integration techniques and the like etc.

For example, as an option, one or more CPUs may be included at the top, bottom, middle, multiple locations, etc. and/or anywhere in one or more stacks of one or more stacked memory devices. For example, one or more CPUs may be included on one or more chips (e.g. logic chips, buffer chips, memory chips, memory devices, etc.).

For example, in FIG. 18-2, as an option, chip 0 may be a CPU chip, part of one or more CPUs, include one or more CPUs, types of CPUs, etc. (e.g. CPU, multicore CPU, multiple CPU types on one chip, heterogeneous CPU chips, combinations of these and/or any other arrangements, architectures, partitions, parts, portions, etc. of CPUs, GPUs, any other types of processors, equivalent circuits, similar circuits and the like etc.).

Thus, for example, descriptions of structures, architectures, designs, etc. of stacked memory chips, parts and/or portions of stacked memory chips, memory system using one or more stacked memory chips, etc. may also, equally, etc. be applied, as an option, to systems, memory systems, etc. that employ, use, implement, etc. stacking, joining, and/or any other assemblies, structures, and the like etc. to couple, connect, interconnect, etc. any memory, CPU, GPU, etc. functions and the like etc. in any manner, fashion, structure, assembly, package, module, etc.

For example, in FIG. 18-2, as an option, one or more of chip 1, chip 2, chip 3, chip 4; parts of these chips; combinations of parts of these chips; and/or combinations of any parts of these chips with any other memory (e.g. on one or more logic chips, on the CPU die, etc.) may function, behave, operate, etc. as one or more caches. In one embodiment, for example, as an option, one or more caches may be coupled to the CPUs separately from the rest of the memory system, etc. For example, as an option, one or more CPU caches may be coupled to the CPUs using wide I/O or any other similar coupling technique that may employ TSVs, TSV arrays, combinations of these and/or any other interconnect structures and the like, etc. For example, as an option, one or more connections may be or may include one or more high-speed serial links or any other high-speed interconnect technology and the like, etc. For example, as an option, the interconnect between one or more CPUs and one or more caches may be designed, architected, constructed, assembled, etc. to include one or more high-bandwidth, low latency links, connections, etc. For example, in FIG. 18-2, in one embodiment, as an option, the memory bus may include more than one link, connection, interconnect structure, combinations of these and the like, etc. For example, as an option, a first memory bus, first set of memory buses, first set of memory signals, etc. may be used to carry, convey, transmit, couple, etc. memory traffic, packets, signals, combinations of these and the like, etc. to one or more caches located, situated, etc. on one or more memory chips, logic chips, combinations of these, etc. For example, as an option, a second memory bus, second set of memory buses, second set of memory signals, etc. may be used to carry, convey, transmit, couple, etc. memory traffic, packets, signals, combinations of these and the like, etc. to one or more memory systems (e.g. one or more memory systems, memory structures, memory circuits, etc. separate from the memory caches, etc.) located, situated, etc. on one or more memory chips, logic chips, combinations of these, etc. In one embodiment, for example, as an option, one or more caches may be logically connected, coupled, etc. to one or more CPUs etc. in any fashion, manner, arrangement, etc. (e.g. using any logical structure, logical architecture, etc.).

In one embodiment, for example, as an option, one or more requests and/or responses may perform, may be used to perform, may correspond to performing, may form a part of performing or a portion of performing, etc. one or more operations, transactions, messages, status, combinations of these and/or any other similar operations, etc. that may correspond to (e.g. may form part of, may implement, etc.) one or more memory types and/or any other similar memory classifications and the like, etc. In one embodiment, for example, as an option, one or more requests, responses, messages, etc. may perform, may be used to perform, may correspond to performing, may form a part, portion, etc. of performing, executing, initiating, completing, etc. one or more operations, transactions, messages, control, status, combinations of these and/or any other similar operations, etc. that may correspond to (e.g. may form part of, may implement, may construct, may build, may execute, may perform, may create, etc.) one or more of the following (but not limited to the following) memory types: Uncacheable (UC), Cache Disable (CD), Write-Combining (WC), Write-Combining Plus (WC+), Write-Protect (WP), Writethrough (WT), Writeback (WB), combinations of these and/or any other similar memory types, classifications, designations, and the like, etc.

In one embodiment, for example, as an option, one or more requests and/or responses etc. may perform, may be used to perform, may correspond to performing, may form a part of performing and/or a portion of performing, etc. one or more operations, transactions, messages, status, combinations of these and/or any other similar operations, and the like etc. that may correspond to (e.g. may form part of, may implement, etc.) one or more of the following (but not limited to the following): serializing instructions, read memory barriers, write memory barriers, memory barriers, barriers, fences, memory fences, instruction fences, command fences, optimization barriers, combinations of these and/or any other similar, barrier, fence, ordering, reordering instructions, commands, operations, and the like, etc.

In one embodiment, for example, as an option, one or more requests and/or responses may perform, may be used to perform, may correspond to performing, may form a part of performing or a portion of performing, etc. one or more operations, transactions, messages, status, combinations of these, etc. that may correspond to (e.g. may form part of, may implement, etc.) one or more semantic operations (e.g. corresponding to volatile keywords, and/or any other similar constructs, keywords, syntax, and the like, etc.). In one embodiment, for example, as an option, one or more requests, commands, responses, messages, etc. may perform, may be used to perform, may correspond to performing, may form a part, portion, etc. of performing, controlling, signaling, generating, etc. one or more operations, transactions, messages, status, combinations of these and/or any other similar operations and the like etc. In one embodiment, for example, as an option, one or more such requests etc. may correspond to (e.g. may form part of, may implement, etc.) one or more operations with release semantics, acquire semantics, combinations of these and/or any other similar semantics and the like, etc.

In one embodiment, for example, as an option, one or more requests and/or responses may perform, be used to perform, correspond to performing, form a part of portion of performing, etc. one or more operations, transactions, messages, status, etc. that may correspond to (e.g. form part of, implement, etc.) one or more of the following (but not limited to the following): memory barriers, per-CPU variables, atomic operations, spin locks, semaphores, mutexes, seqlocks, local interrupt disable, local softirq disable, read-copy-update (RCU), combinations of these and/or any other similar operations and the like, etc. In one embodiment, for example, as an option, one or more requests and/or responses may perform, may be used to perform, may correspond to performing, may form a part of portion of performing, etc. one or more operations, transactions, messages, status, combinations of these and/or any other similar operations and the like, etc. that may correspond to (e.g. may form part of, may implement, etc.) one or more of the following (but not limited to the following) macros and/or functions: smp_mb( ), smp_rmb( ), smp_wmb( ), mmiowb( ), any other similar Linux macros, any other similar Linux functions, etc. combinations of these and/or any other similar OS operations, macros, functions, routines, and the like, etc.

In one embodiment, as an option, one or more requests and/or responses may include any information, data, fields, messages, status, combinations of these and other data etc. (e.g. in a stacked memory package system, memory system, and/or other system, etc.).

In one embodiment, the memory system 18-200 may be implemented in the context of one or more memory classes; may use, employ, implement, etc. one or more memory classes; may be operable to couple, communicate, connect with, etc. one or more memory classes; and/or may be operable to function, behave, operate as, emulate, simulate, etc. one or more memory classes. For example, the use of one or more memory classes included in, included with, provided by, etc. the memory system 18-200 may be implemented in the context of FIG. 1A of U.S. application Ser. No. 13/441,132, filed Apr. 6, 2012, titled “MULTIPLE CLASS MEMORY SYSTEMS”, which is hereby incorporated by reference in its entirety for all purposes.

For example, in FIG. 18-2, as an option, one or more of chip 1, chip 2, chip 3, chip 4; parts of these chips; combinations of parts of these chips; and/or combinations of any parts of these chips with any other memory (e.g. on one or more logic chips, on the CPU die, etc.) may function, behave, operate, etc. as one or more memory classes. Of course any number, type, form of parts, portions, regions, combinations of these, etc. of any number, type, form, etc. of one or more memory chips, logic chips, and/or any other memory, storage, etc. and the like may be used to form, simulate, emulate, provide, etc. all, part, portions, etc. of one or more memory classes, etc.

Reliability

In one embodiment, as an option, the memory system 18-200 may include one or more schemes, techniques, etc. to provide internal data correction, data protection, error correction, combinations of these and/or any other data correction schemes, data correction techniques and the like, etc. For example, internal data correction etc. may be applied, implemented, etc. with respect to data as it is stored, kept, held, etc. in one or more memory chips, memory cells, related circuits, etc. For example, internal data correction may include one or more error-correcting codes (ECC). For example, as an option, internal data correction etc. may be implemented in the context of FIG. 19-14 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, as an option, internal data correction etc. may be implemented in the context of FIG. 20-21 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, as an option, internal data correction etc. may be implemented in the context of FIG. 25-13 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description.

In one embodiment, for example, as an option, one or more internal data correction etc. schemes etc. may be used in conjunction with, in combination with, including, incorporating, etc. one or more memory classes. For example, as an option, a first memory class may use a first internal data correction scheme and a second memory class may use a second internal data correction scheme, etc.

In one embodiment, as an option, the memory system 18-200 may include one or more schemes, techniques, algorithms, etc. to provide, implement, perform, etc. one or more Reliability, Availability and Serviceability (RAS) features, functions, behaviors, etc. For example, in one embodiment, basic and/or advanced RAS features may include (but are not limited to) one or more of the following: single-bit memory error correction; double-bit memory error detection; memory error retry; memory error correction on one or more data buses; internal logic error checking; bad data containment; memory sparing; memory mirroring; memory hot swap; fatal error indication; data scrubbing; data hardening; data poisoning, combinations of these and/or any other similar features and the like, etc.

In one embodiment, for example, as an option, single-bit memory error correction may allow single-bit memory errors to be detected and corrected. For example, as an option, one or more of the above RAS features may be combined, etc. For example, as an option, double-bit memory error correction and retry may allow double-bit memory errors to be detected and a memory read retried.

In one embodiment, for example, as an option, data scrubbing (e.g. data hardening, data cleaning, and/or any other data maintenance operations, similar housekeeping functions, behaviors, and the like etc.) may include an error correction technique that may use a background data scrubbing task to periodically inspect, check, etc. memory for one or more data errors. In one embodiment, for example, as an option, the data scrubbing task may then correct the data errors. In one embodiment, for example, as an option, data scrubbing may use a copy of the data to correct errors. In one embodiment, for example, data scrubbing may use one or more error correcting codes to correct errors. In one embodiment, for example, as an option, data scrubbing may reduce the probability that correctable errors accumulate and thus may reduce the probability that one or more uncorrectable errors may occur. In one embodiment, for example, as an option, data scrubbing and/or data hardening etc. may be implemented in the context of FIG. 20-21 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. Of course, in this example, in any other examples herein, and/or in one or more examples included in one or more specifications incorporated by reference, data scrubbing may be used, viewed, regarded, etc. as an example and any similar data manipulation techniques and the like may be used, employed, implemented, etc.

In one embodiment, as an option, the memory system 18-200 may include one or more schemes, techniques, etc. to provide one or more memory repair features. For example, in one embodiment, as an option, one or more stacked memory packages may provide the capability to provide one or more repairs to memory circuits, structures, connections, interconnects, and/or any other similar, related functions, etc. In one embodiment, as an option, one or more repair capabilities may be provided so that repair may be performed at manufacture, assembly, packaging, test, start-up, boot time, during operation, at combinations of these times and/or at any time, etc. Thus, for example, repair may be made in a static fashion, dynamic fashion, etc.

In one embodiment, for example, as an option, repair etc. may be implemented in the context of FIG. 10 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, as an option, a stacked memory package may include one or more spare memory chips, portions of memory chips, and/or any other spare circuits, components, connections, and the like etc.

In one embodiment, for example, as an option, repair etc. may be implemented in the context of FIG. 41 of U.S. application Ser. No. 13/441,132, filed Apr. 6, 2012, titled “MULTIPLE CLASS MEMORY SYSTEMS” and the accompanying text description. For example, as an option, a stacked memory package may include one or more memory classes that may include one or more spare memory chips, parts and/or portions of memory chips, etc. Thus, for example, as an option, one or more memory classes that may include one or more stacked memory packages, portions of stacked memory packages, memory chips, portions of memory chips, combinations of these and/or any other similar parts, portions, etc. of stacked memory packages may be used for repair as spares, redundant circuits, redundant components, etc.

For example, in one embodiment, as an option, one or more memory classes may be used to hold data, process data, etc. during repair operations. For example, in one embodiment, as an option, one or more logic chips may include a memory class that may be used to hold, store, keep, etc. data while one or more repair operations are being performed. For example, in one embodiment, as an option, a first memory area, region, etc. may fail, be detected as failing, cause more than a predetermined number of errors (e.g. exceed an error threshold, etc.) and/or otherwise targeted for repair, etc. In this case, for example, as an option, a second memory area may be designated as a replacement. For example, as an option, the first memory area may be located on a first memory chip and the second memory area located on a second memory chip, etc. In this case, for example, as an option, a third memory area may be used to temporarily hold data in the transfer of data from the first memory area to the second memory area. For example, in one embodiment, as an option, the third memory area may be located on one or more logic chips.

In one embodiment, for example, as an option, repair etc. may be implemented in the context of FIG. 14 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, as an option, a stacked memory package may perform, be operable to perform, include all or part of the capability to perform, etc. one or more forms of repair. For example, as an option, a stacked memory package may perform static repair. For example, as an option, a stacked memory package may perform dynamic repair, etc. In one embodiment, for example, as an option, one or more repair features, techniques, etc. may be performed by one or more logic chips in a stacked memory package. In one embodiment, for example, as an option, one or more repair features, techniques, etc. may be performed by one or more memory chips in a stacked memory package. In one embodiment, for example, as an option, one or more repair features, techniques, etc. may be performed by a combination of one or more logic chips, one or more memory chips, and/or any other logic, circuits, blocks, firmware, hardware, software, combinations of these and the like, etc. in any system component (e.g. buffer, logic chip, memory chip, CPU, and/or any other system components, combinations of these and/or any other similar components and the like, etc.) in a stacked memory package. In one embodiment, for example, as an option, one or more repair features, techniques, etc. may be performed by the combination, cooperation, collaboration, communication, etc. of one or more stacked memory packages and/or any other system components. For example, as an option, one or more stacked memory packages, portions of stacked memory packages, etc. may act as one or more spares, substitutes, copies, etc.

In one embodiment, for example, as an option, one or more stacked memory packages may be capable of performing repair to one or more failed, failing, damaged, non-working, unreliable, etc. circuits, components, etc. In one embodiment, for example, as an option, one or more stacked memory packages may be capable of performing repair to one or more failed circuits etc. after one or more package assembly steps is complete (e.g. post-assembly repair, field repair, in-field repair, etc.).

In one embodiment, as an option, the memory system 18-200 may include one or more high-speed interfaces, etc. In one embodiment, for example, as an option, a high-speed interface may be implemented in the context of FIG. 2 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, as an option, the memory bus may include one or more multi-lane serial links, etc. In most high-speed serial links data is transmitted using differential signals. A lane in a high-speed serial link may be considered to consist of 2 wires (one pair, transmit or receive, as in Intel QPI) or 4 wires (2 pairs, transmit and receive, as in PCI Express). As used herein and/or in one or more specifications incorporated by reference a lane consists of 4 wires (2 pairs, transmit and receive). The links, as an option, may be capable of operating at multiple speeds (e.g. 10 Gbps, 20 Gbps, 32 Gbps, combinations of these speeds and/or any speeds, etc.). The links, as an option, may use any number of lanes (e.g. 2, 4, 8, 16, 32, and/or any number, etc.). The links, as an option, may be partitioned, split, combined, segregated, assigned, labeled, virtualized, grouped, collected, etc. in any manner, fashion, etc. In one embodiment, for example, as an option, a high-speed interface may be partitioned etc. in the context of FIG. 25-12 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, as an option, a high-speed serial link with 32 lanes may be partitioned, split, etc. into two groups of 16 lanes, four groups of eight lanes, 16+8+8 lanes, etc. Thus, for example, as an option, a 32-lane link may be used in a half-width (16 lane) configuration etc. In one embodiment, for example, as an option, link and/or lane assignments, configuration, etc. may be programmable, configurable, managed, controlled, switched, etc. For example, as an option, lane and/or link assignments may be dynamically allocated, programmed, configured, etc. according to traffic, status, errors, failures, and/or any similar metrics, parameters, events, and the like etc.

In one embodiment, for example, as an option, data protection (e.g. coding, codes, coding schemes, etc.) may be assigned, partitioned, arranged, designed, programmed, configured, etc. In one embodiment, for example, as an option, data protection etc. may be assigned etc. as a function of how a high-speed serial link, bus, and/or other logical interconnect and the like etc. may be partitioned, split, configured, programmed, used, etc. Thus, for example, a 32-lane link may be used, as an option, in a half-width (16 lane) configuration etc. and each half-width configuration may use a separate data protection scheme. In one embodiment, as an option, the data protection scheme (e.g. the coding scheme, CRC polynomial, checksum algorithm, etc.) may be the same across all parts, portions, widths, lanes, paths, etc. of a high-speed serial link etc. In one embodiment, as an option, the data protection scheme used in different parts etc. of one or more links, paths, interconnects, etc. may be different. Thus, for example, as an option, one part, portion, etc. of a link, bus, path, interconnect, etc. may operate at a different speed (and/or differ in some other fashion, parameter, setting, mode, manner, etc.) than another part etc. of the link etc. In this case, for example, as an option, a different CRC, checksum, and/or any other coding scheme etc. may be used for different parts etc. of one or more links etc. For example, in one embodiment, as an option, a transmit link etc. may be split into two parts. In this case, for example, as an option, a first part of the link etc. may use a first CRC scheme and the second part of the link etc. may use a second CRC scheme, etc. For example, in one embodiment, as an option, the transmit part of a link etc. may use a first CRC scheme and the receive part of a link etc. may use a second CRC scheme etc. Of course, in this example, in any other examples herein, and/or in one or more examples included in one or more specifications incorporated by reference, a CRC code, a CRC scheme, etc. may be used by way of example only and any coding scheme, data protection scheme, combinations of schemes, techniques, etc. and/or any protection scheme(s) and the like may be used. Of course, in this example, in any other examples herein, and/or in one or more examples included in one or more specifications incorporated by reference, a high-speed serial link etc. may be used by way of example only and any links, connections, couplings, buses, signals, collection of signals, protocol, network, interconnect, etc. and/or any communication techniques, similar schemes and the like may be used.

In one embodiment, as an option, one or more links etc. may be capable of operating, operable to perform, etc. in one or more modes, communication modes, etc. For example, as an option, one or more links etc. may be configured, programmed, designed, etc. to operate in a full-duplex mode. A full-duplex (FDX) (also double-duplex) mode, for example, may allow communication in both directions (e.g. upstream and downstream). For example, as an option, one or more links etc. may be configured, programmed, designed, etc. to operate in a half-duplex mode. In one embodiment, as an option, one or more links etc. may be programmed, configured, etc. to operate in any mode (e.g. frequency-division duplex, time-division duplex, full-duplex, half-duplex, combinations of these and/or any other similar communications modes, schemes, techniques and the like, etc.). In one embodiment, for example, as an option, a link etc. may be programmed to, configured to, switched to, etc. a half-duplex mode with operation, for example, in either upstream or downstream directions. Any mode, communication mode, aspect of mode, mode function, mode operations, mode behavior, combinations of these and/or other aspects, functions, etc. of one or more links, link modes, etc. may be programmed, configured, etc. Programming etc. of modes, mode aspects, mode features, mode settings, mode parameters, etc. may be performed, as an option, at any time in any manner, fashion, etc. In one embodiment, for example, as an option, data protection (e.g. coding, codes, coding schemes, etc.) may be a function, depend on, etc. one or more modes, communication modes, etc. For example, in one embodiment, as an option, a CRC scheme or any other data protection scheme may depend on one or more modes, communication modes, etc. For example, in one embodiment, as an option, a first high-speed mode may use (e.g. employ, etc.) a first CRC that may be chosen, designed, programmed, set, configured, etc. to provide data protection at the first speed and a second mode (e.g. operating at a speed lower than the first mode, etc.) may use a second CRC that may be chosen etc. to provide data protection at the speed of the second mode. Thus, for example, in one embodiment, as an option, a higher speed mode (e.g. higher frequency serial link, higher bus clock frequency, etc.) may use a simpler, faster to calculate CRC and a slower speed mode may use a more complex but more powerful CRC (e.g. capable of providing greater data protection, etc.), etc. Of course any CRC, type of CRC, any other data protection scheme, etc. may be used for any mode(s), combinations of modes, and the like etc. Of course any bus, link, and/or other connection scheme, etc. may be used etc.

In one embodiment, as an option, the memory system 18-200 may include one or more packet-based interfaces, etc. In one embodiment, for example, as an option, a packet-based interface may be implemented in the context of FIG. 19-8 of U.S. application Ser. No. 13/710,411, filed 12-10-2012, titled “SYSTEM, METHOD, AND COMPUTER PROGRAM PRODUCT FOR IMPROVING MEMORY SYSTEMS,” and the accompanying text description. For example, in one embodiment, as an option, a basic command set may include read requests, write requests, etc. A command set may be divided, partitioned, grouped, etc. into, for example, two sets that may include requests and completions and/or be viewed as a single set including all commands, completions, requests, responses, messages, status, flow control, etc. For example, in one embodiment, as an option, a read request may request a basic unit of data (e.g. equal to a CPU cache line size, etc.) multiples or sub-multiples of a basic unit of data. For example, in one embodiment, the memory system cache line size may be 64 bytes. For example, in one embodiment, a read request may request a cache line (64 bytes). In one embodiment, for example, the cache line size of 64 bytes may correspond to four basic units of data. Thus, for example, in this case, the basic unit of data may be 16 bytes. In one embodiment, read requests and/or write requests may reference 1, 2, 3, 4, 5, 6, 7, 8 or any number of basic units of data. For example, in one embodiment, as an option, requests, commands, etc. of various sizes, lengths, types, forms, formats, designs, etc. may be implemented in the context of FIG. 23-5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, in one embodiment, as an option, a basic unit of data may be a word. For example, as an option, a word may be 8 bytes of data. For example, as an option, a word may be 8 bytes of data plus one or more error codes, etc. For example, in one embodiment, as an option, a data word may be 8 bytes or 64 bits of data plus one byte or 8 bits of error code. Of course a word may be any length, and may contain, include, comprise, etc. any number of bits, bytes, and take any form, format, etc. Of course, as an option, any number, length, type of error codes may be used. Of course, as an option, data may be transmitted (e.g. internally to/from one or more logic chips, to/from one or more stacked memory chips, externally to/from one or more stacked memory packages, etc.) in any form, format, etc. (e.g. with/without one or more error codes, etc.). Of course, as an option, data may be stored, kept, held, queued, etc. in a stacked memory package, in a stacked memory chip, in logic chip memory, etc. in any form (e.g. with/without one or more error codes, etc.).

In one embodiment, for example, as an option, a packet-based interface and/or formats of requests, commands, etc. of various sizes, lengths, types, etc. may be implemented in the context of FIGS. 23-6A, 23-6B, 23-6C of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, in one embodiment, as an option, a read request may include one or more of the following (but not limited to the following): header, address, error code, and/or any other bits, fields, flags, data, and the like etc. For example, in one embodiment, as an option, a read response may include one or more of the following (but not limited to the following): header, read data, error code and/or any other bits, fields, flags, data, and the like etc. For example, in one embodiment, as an option, a write request may include one or more of the following (but not limited to the following): header, address, write data, error code and/or any other bits, fields, flags, data, and the like etc.

In one embodiment, for example, as an option, a packet-based interface and/or formats of requests, commands, etc. of various sizes, lengths, types, etc. may be implemented in the context of FIGS. 23-7, 23-8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, in one embodiment, as an option, a request may include sub-requests. For example, in one embodiment, as an option, a request may include one or more markers. For example, in one embodiment, as an option, requests, commands, etc. may be multi-part commands (e.g. multi-part write, etc.), For example, multi-part requests, commands, and/or multiple requests, commands, etc. of various sizes, lengths, types, etc. may be implemented in the context of FIG. 28-6 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description.

In one embodiment, for example, as an option, the request, access, etc. functions may be implemented in the context of FIG. 19-8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, in one embodiment, as an option, a read request, and/or any other access, memory access, reference, etc. may be supported by (e.g. may have access to, may utilize, may specify, etc.) various arrangements, architectures, etc. For example, in one embodiment, as an option, a read request etc. may be supported etc. by various arrangements etc. of portions of memory chips grouped, collected, etc. in one or more echelons, slices, portions, sections, banks, chips, mats, subbanks, and/or any other similar memory circuit groupings and the like, etc. For example, in one embodiment, as an option, a read request etc. may be supported etc. by various burst modes and/or any other modes, configurations, arrangements, architectures, etc. (including, but not limited to, for example, the descriptions of chopped modes, MCBL, SMPBL, PMCBL, PSMPBL, etc. that may be described in the context of FIG. 19-8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description).

In one embodiment, for example, as an option, requests, commands, etc. of various sizes, lengths, types, forms, formats, etc. may include one or more error codes and the like. For example, as an option, one or more error codes etc. used, employed, included in one or more requests, commands, messages, etc. may include one or more cyclic-redundancy check (CRC) fields. Of course, any codes, code fields, coding scheme, combinations of coding schemes, etc. may be used. For example, in one embodiment, as an option, one or more blocks of data, information, fields, etc. in a request, etc. may include one or more check values (e.g. CRC field, CRC value, checksum, remainder, syndrome, digest, byte count, hash, cipher, combinations of these and/or similar computed values, codes, and the like etc.). For example, a CRC field may be equal to the remainder of a polynomial division. and/or based on, computed from, derived from, etc. the remainder of a polynomial division and/or the result of any other similar operations, computations, calculations, algorithms, manipulations, and the like etc. For example, in one embodiment, as an option, CRC protection, codes, coding schemes, and/or any other protection schemes and the like may be implemented in the context of FIG. 19-8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. Of course, such data protection schemes, check values, etc. are not limited to CRC values, CRC schemes, etc. and any data protection schemes, techniques, and the like etc. may be used.

In one embodiment, for example, as an option, one or more CRC codes, checks, check values, error correcting codes, ciphers, etc. may be used to protect data in one or more network flows, data streams, packet streams, lanes, links, high-speed serial connections, etc. For example, in one embodiment, as an option, data may be transmitted, transferred, moved, copied, etc. using one or more packets and/or any other similar groupings, collections, sets, bundles, structures, vectors, streams, and the like etc. In one embodiment, packets etc. may be striped, divided, spread, partitioned, multiplexed, etc. across, using, employing, etc. one or more lanes, links, buses, etc. (e.g. of one or more high-speed serial links etc.). For example, in one embodiment, as an option, CRCs etc. may be calculated per lane (e.g. using the definition of lane in a high-speed serial ink as four wires, including transmit and receive pairs, a first CRC may be used for a transmit lane, a second CRC for a receive lane, etc.). For example, in one embodiment, as an option, a CRC etc. may be calculated per packet. Any arrangement(s) of data, fields, packets, payloads, links, lanes, paths, connections, error codes, etc. may be used and data protection schemes may be used in any form, fashion, etc. to protect any type, number, form, formats, parts, portions of the data etc. Thus, it should be noted that one or more examples presented herein and/or in one or more specifications incorporated by reference may use data protection of a packet, data protection of a high-speed serial link lane, etc. as an example, but any arrangement, architecture, formulation, assignment, etc. of data protection (e.g. across a lane, across a packet, across portions of these, across collections of these and/or any other similar structures, etc.) may be used.

In one embodiment, for example, as an option, one or more CRC codes, checks, check values, error correcting codes, ciphers, etc. may be programmed, configured, adjusted, modified, altered, set, etc. as a function of error behavior, error count, error statistics, signal integrity measurements, combinations of these and/or any other measurements, characteristics, metrics, parameters, etc. For example, in one embodiment, as an option, error information may be monitored, stored, counted, recorded, etc. For example, as an option, the number of data transmission errors detected by CRC errors (e.g. a CRC error, etc.) may be monitored, etc. For example, as an option, if the number of CRC errors exceeds a threshold, limit, etc. then one or more properties, behaviors, functions, metrics, parameters, etc. of one or more CRC schemes and/or any other data protection schemes may be modified, changed, altered, programmed, configured, etc. For example, as an option, if a high-speed serial link experiences a high error count (e.g. due to signal integrity issues, interference, etc.) the data protection scheme (e.g. ECC, CRC, any other codes, schemes and the like etc.) may be changed. For example, in one embodiment, as an option, a change in a CRC scheme and/or any other data protection schemes may be effected automatically (e.g. by CRC logic, any other logic, etc.). For example, in one embodiment, as an option, an error, the error count, error status, other error parameters, metrics, and the like etc. may be signaled and/or otherwise indicated, flagged, etc. (e.g. using a message, signal, packet, flag, and/or any other indication that may, for example, as an option, be transmitted to a CPU or any other system component, etc.). For example, in one embodiment, as an option, an error etc. may be signaled etc. and, as an option, a change in CRC scheme and/or any other data protection schemes may be effected. For example, in one embodiment, as an option, a change in CRC scheme and/or any other data protection schemes may be effected. by programming, configuring, etc. a mode register etc. in the memory system and/or using any other techniques etc. For example, in one embodiment, a change in CRC scheme and/or any other data protection schemes may be effected, implemented, triggered, signaled, controlled, etc. by sending a message, command, request, etc. to one or more stacked memory packages and/or any other system components, etc. For example, in one embodiment, as an option, any change, modification, setting, configuration, programming, etc of CRC scheme, any other data protection schemes, etc. may be effected, performed, implemented, etc. by negotiation and/or any other information exchange and the like, etc. For example, as an option, logic etc. at the ends of a communication link etc. (e.g. transmit and/or receive logic at one or more ends of one or more high-speed serial links, etc.) may negotiate the type, form, parameters, etc. of one or more data protection schemes. For example, as an option, such negotiation may be effected etc. in one or more steps. For example, as an option, a first step may include the advertising, listing, etc. of capabilities, properties, parameters, etc. For example, as an option, a first node, station, logic, circuit, etc. at one end of a link may advertise etc. the CRC and/or any other data protection scheme capabilities. For example, as an option, as a second step, a second node etc. may then determine, e.g. based on advertised capabilities, etc. which data protection scheme should be used. For example, as an option, a third step may then include the second node sending the first node instructions, messages, configurations, parameters, etc. on which data protection scheme. For example, as an option, a fourth step may include the first and second nodes changing the data protection scheme. Of course, any number of steps, and/or any other steps, functions, etc. may be included in the process to change data protection schemes, etc. Of course, any other techniques, flows, processes, etc. may be used to effect, implement, etc. any change, modification, alteration, programming, configuration, etc. of data protection schemes, parameters, metrics, features, functions, behaviors, and the like, etc.

In one embodiment, for example, as an option, one or more CRC codes, checks, check values, checksums, error correcting codes, ciphers, etc. may be used to protect data in one or more network packets and/or similar structures and the like etc. In one embodiment, for example, one or more CRC codes etc. may combined with one or more additional data protection schemes. For example, in one embodiment, data protection may be nested, operated in a hierarchical fashion, etc. For example, in one embodiment, a first CRC code and/or any other protection scheme etc. may be applied, used, employed, configured, programmed, implemented etc. at a first layer of hierarchy (e.g. in a network, on one or more logic chips, in memory, in buses, combinations of these and/or in any other components, signals, data, information, etc.); and a second scheme etc. may be applied etc. to a second level of hierarchy. For example, in one embodiment, data protection may overlap. For example a first packet may contain, include, etc. a first set, collection, group, etc. of data and a second set etc. of data. In this case, for example, a first CRC (or any other protection scheme etc.) may cover, protect, apply to, etc. the first set of data; and a second CRC etc. may apply to the first set of data and the second set of data. Such an arrangement may be beneficial to protect data and header information in a packet, for example.

In one embodiment, for example, one or more CRC codes, checks, check values, error correcting codes, ciphers, etc. may be adjusted, altered, modified, changed according to traffic patterns, data analysis, and/or any other similar parameter, metric, feature, behavior, function, measurement, statistic, and the like etc. For example, some CRC polynomials may be better suited (e.g. offer stronger data protection, offer more relaible data protection, etc.) to long blocks of data. For example, a memory system may use, employ, implement, etc. a 32-bit CRC scheme (e.g. use a CRC32 scheme, etc.). For example, a first CRC32 polynomial may be used for data traffic, data payloads, commands, requests, etc. that may have a first set of properties, parameters, metrics, etc. and a second CRC32 polynomial may be used for data traffic etc. with a second set of properties etc. For example, a first CRC or any other data protection scheme etc. may be used for read requests (e.g. short commands, etc.) and a second CRC etc. may be used for long write commands (e.g. with large data payloads, etc.). For example, one or more read responses and/or writes may be chained, connected, merged, etc. For example, a chained response may include a series of responses, parts or portions of responses, etc. that may be linked, chained, and/or otherwise logically coupled together. For example, a chained read response may include a series of contiguous parts, etc. For example, a connected response may include a series of responses, parts or portions of responses, etc. that may be logically connected together, but that may use non-contiguous parts, etc. For example, a merged response may be a single response that may be constructed from merging several responses, parts or portions of responses, etc. and/or from coalescing, collapsing, merging, etc. one or more parts of responses, chained responses, connected responses, other responses, combinations of these, etc. Of course, variations in the construction, structures, form, and/or use of chained responses, connected responses, merged responses, etc. are possible. The terms chained request, connected requests, merged request may, for example, be defined similarly to their response counterparts.

For example, one or more commands, requests, etc. may be multi-part commands, etc. In this case, for example, it may be desired to protect a large data payload or effective payload (e.g. a large amount of data spread between one or more responses, included in one or more responses, packets, etc.). In this case, for example, a different CRC or any other data protection scheme may be used, may be programmed, may be set, etc. that may be beneficial, better suited, offer better data protection, offer more reliable data protection, etc. For example, certain commands, command codes, etc. may trigger, set, force, program, configure, etc. logic to use different CRC codes or any other data protection schemes. In one embodiment, for example, a bit, field, code, flag, and/or any other signal, data, information, etc. may be set to indicate which CRC or any other data protection scheme should be used, etc. For example a command may include a bit which when set causes a different CRC polynomial to be used, etc. Of course any number, type, form, format, etc. of data protection schemes may be set, modified, programmed, configured, altered, changed, etc. in the manner described above.

In one embodiment, for example, one or more CRC codes, checks, check values, checksums, FCS, digests, error correcting codes, etc. may be used to protect data in one or more network packets. For example, a single CRC field may be used to cover, protect, digest, etc. data, information, etc. that may be included in more than one packet. For example, a multi-part write command may include two or more packets. In one embodiment, for example, a single CRC value may cover data in more than one packet of the multi-part write command. For example, in one embodiment, a command may include packets P1, P2, P3. In one embodiment, for example, a first CRC field, CRC1, may cover data, information, fields, etc. in packets P1, P2; a second CRC field, CRC2, may cover data, information, fields, etc. in packets P2, P3; a third CRC field, CRC3, may cover data, information, fields, etc. in packets P1, P2, P3. Of course any permutation, combination, arrangement, etc. of CRC fields, error correcting codes, checksums, FCS, digests, combinations of these and the like etc. may be used to provide data protection across any type, number, form, etc. of packets.

In one embodiment, for example, one or more CRC codes, checks, check values, checksums, FCS, digests, error correcting codes, combinations of these, and/or any other data protection schemes etc. may be used to protect data by using a first data protection scheme to protect a first portion, group, block, set, collection, payload, etc. of data and a second data protection scheme to protect a second portion etc. of data. For example, in one embodiment, the first portion of data and the second portion of data may overlap (e.g. some data may be contained in, included in, part of, etc. the first portion and the second portion, etc.). For example, in one embodiment, data may be considered to be transmitted, transferred, copied, conveyed, carried, and/or otherwise moved etc. in one or more blocks, units, packets, etc. For example, in one embodiment, a block may be 512 bits of data arranged in a block of size (e.g. with dimensions of, using an arrangement of, in a grid, in a matrix of, etc.) 16 bits by 32 bits. For example, the data block may be considered to be 16 bits in the x-direction and 32 bits in the y-direction etc. For example, in one embodiment, a first data protection scheme (e.g. code, CRC, checksum, parity, etc.) may be used to protect 16 bits at a time in the x-direction. For example, a second data protection scheme etc. may be used to protect 32 bits at a time in the y-direction. Of course data may be protected in any arrangement, block size, block shape, matrix, etc. Of course data may be arranged in any number of dimensions (e.g. grid, cube, hypercube, combinations of these and/or any other arrangements, etc.). Of course data may be protected using any number, type, form, combination, arrangement, structure, etc. of one or more codes, ciphers, and the like etc. Of course data may be arranged, carried, transported, held, collected, stored, kept, queued, moved, copied, etc. in any type, form, structure, arrangement, etc. of blocks, packets, sets, groups, collections, combinations of these and the like etc.

In one embodiment, for example, one or more data protection schemes etc. may be used to protect data in such a way that a data protection scheme etc. may protect data at a first transport layer (or any other hierarchical division, layer, OSI layer, virtual layer, channel, and/or any other similar abstract division, etc.) and a second data protection scheme etc. may protect data at a second transport layer etc.

For example, in one embodiment, a first data protection scheme etc. may be used to protect information, fields, etc. that may include a first set of address information, routing information, etc. using one or more packets, buses, and/or other communication schemes etc. and a second data protection scheme etc. may be used to protect a second set of data and/or any other information etc. in the one or more packets etc. For example, in one embodiment, the first set of address information etc. and the second set of data may overlap (e.g. the first and second set may have one or more common fields, etc.). For example, in one embodiment, the first set of address information etc. and the second set of data may not overlap (e.g. the sets may be disjoint, etc.). For example, in one embodiment, the first data protection scheme may be chosen (e.g. selected, designed, implemented, etc.) so that the address information, routing information, etc. may be checked quickly, simply, efficiently, etc. In this case, for example, a stacked memory chip may check, validate, verify, etc. one or more packets etc. that need to be forwarded. Thus, the header (e.g. packet header, and/or other header information, bus signals, etc.), address information, routing information, etc. may be quickly inspected, parsed, checked, etc. before, for example, forwarding the packet etc. In this case, for example, the data fields, packet etc. payloads, any other information, and/or data protection codes etc. may remain unchanged. Of course any arrangement, format, overlap, data, information, codes, coding, communication scheme, etc. may be used.

For example, in one embodiment, a first data protection scheme etc. may be used for packets, data, information, etc. received by a stacked memory package and/or any other system component etc. and a second data protection scheme etc. may be used for packets, data, information, etc. transmitted by a stacked memory package and/or any other system component etc. For example, in this case, it may be beneficial to match, design, etc. the data protection scheme(s) to the transmission medium, bus technology, communication scheme, etc. Of course any arrangement of fields, data, information, packets, bus technology, protocol, communication scheme, etc. may be used. Of course any number, type, form, structure, etc. of data protection with any number, type, form of sets of data, information, etc. may be used.

Such an arrangement of multiple coding schemes, formats, overlaps, etc. may thus be beneficial for example to improve the performance, reduce power, and/or control any other metrics, features etc. of a memory system that may route, steer, move, convey, carry, etc. one or more packets etc. and/or any other information, data, etc. between one or more stacked memory chips and/or any other system components etc. For example, in one embodiment, a simple checksum that may be computed quickly, efficiently, simply, etc. may be used to protect header, address information, routing information, any other fields, information, data, combinations of these and the like etc. and a stronger code (e.g. CRC or any other code, etc.) may be used to protect data, payloads, and/or any other fields, etc. Of course any number, type, form, structure, combination, etc. of codes, coding schemes, etc. may be used for any purposes (e.g. to increase reliability, reduce power, reduce latency, etc.). Of course any communication scheme, packet format, bus protocol, etc. may be used.

Of course any number, type, arrangement, combinations, etc. of codes etc. may be used in the fashion, manner, etc. described above. Such an arrangement of multiple codes, coding schemes, etc. may be beneficial, for example, when forwarding of packets etc. may use a cut-through scheme, bypassing scheme, etc. in one or more datapaths, logic paths, and/or any other similar datapaths, flows, circuits, circuit paths, etc. Of course any type, number, form, combinations, etc. of one or more data protections schemes may be used at any point in any OSI layer, network layer, transport layer, bus protocol, network protocol, or at any level of hierarchy, communication layer, virtual layer, channel, and the like, etc.

In one embodiment, for example, one or more data protection schemes etc. may be employed such that a data protection code, field, check value, checksum, etc. may be calculated, checked, formed, etc. by logic in a stacked memory package. In one embodiment, for example, one or more data protection codes, check values, etc. may be calculated etc. by a logic chip, stacked memory chip, combinations of these and/or any other logic etc. In one embodiment, for example, one or more data protection codes may be stored, kept, maintained, etc. with data in a part, portions, etc. of one or more stacked memory chips. For example, in one embodiment, one or more write commands may cause a block, set, collection, field, etc. of data to be stored etc. in one or more stacked memory chips, and/or stored in any other memory etc. in a stacked memory package. In one embodiment, for example, a first error protection code e.g. an ECC code etc. may be generated and/or stored with data blocks of a first size. For example, an ECC code of 8 bits may be stored with every 64 bits of data. In one embodiment, for example, a second error protection code may be generated and stored when a write command corresponding to a write of a large block of data is performed. For example, a series of write commands, an atomic group of write commands, a multi-part write command, etc. may cause a write of 256 bytes of data. In this case, for example, a second data protection code e.g. a CRC code, may be generated and stored. The second data protection code may be associated with, correspond to, be attached to, stored with, and/or otherwise logically connected to the data block that it protects, etc. Of course, one or more data protection codes may be calculated, checked, generated, etc. by any logic, combinations of logic, etc. in a system using stacked memory packages. For example, in one embodiment, a system CPU may calculate etc. one or more data protection codes. In one embodiment, for example, the system CPU may transmit, send, move, copy, transfer, etc. one or more data protection codes to one or more stacked memory packages, and/or to any other system components, etc. For example, one or more of these codes may be used to check transmission of data, information, etc. For example, one or more of these codes may be stored, kept, associated with, etc. data, information, etc. For example, in one embodiment, one or more codes may be stored with data in one or more stacked memory chips. For example, in one embodiment, one or more data protection codes etc. may be stored separately from data. For example, in one embodiment, data may be stored in one or more stacked memory chips and one or more data protection codes may be stored in one or more logic chips. For example, data protection codes may be stored in non-volatile logic memory and/or any other memory structures, memory technology, etc. on one or more logic chips in a stacked memory package, etc. Of course data protection codes may be stored in any locations, in any manner, etc. in one or more stacked memory chips. In one embodiment, for example, data protection may be a function of memory class (as defined herein and/or in one or more specifications incorporated by reference). In one embodiment, for example, a first class of memory may be used to store data with extra, additional, etc. data protection codes and a second class of memory etc. may be used to store data without extra, additional, etc. data protection codes and/or with a different set of codes, number of codes, type of codes, etc. from the first memory class. Of course, any arrangement of data protection schemes, codes, memory classes, etc. may be used. Note that if a data protection code is generated and associated with data in a memory class, it is not necessary that the data and code be stored together (e.g. using the same memory technology, etc.) though they may be. For example, a first write command (e.g. type of write command, write command code, etc.) and/or any other commands etc. may specify (and/or otherwise cause etc.) data be stored in a first memory class with a first type, form, etc. of data protection code. In this case, for example, logic e.g. in a logic chip in a stacked memory package etc. may generate the first protection code and store it in non-volatile memory on the logic chip along with the address (and/or any other information, data, address information, etc.) of the data that may be stored in one or more stacked memory chips, etc. Of course, the first protection code may be stored in any locations, in any manner, fashion, etc. In one embodiment, for example, a second write command etc. may specify etc. that data be stored in a second memory class possibly with a second type etc. of code. In this case, for example, the second code may be stored along with data e.g. in one or more stacked memory chips etc. Of course, any arrangement of codes, storage locations, data and code associations, etc. may be used. Of course codes may be generated, calculated, checked, errors corrected, errors detected, etc. in any locations, combinations of locations, in a distributed fashion, and/or in any manner, fashion, etc. Thus, it may be seen that a memory class is not restricted to a single memory technology, and a memory class may, for example, include, comprise, group, collect, associate, etc. one or more pieces of data, information, codes, and the like etc. For example, one or more pieces of data, information, codes, etc. in a memory class may be stored in different locations, using different memory technology, and/or in any manner, fashion, etc. Thus, for example, a memory class may be used, employed, configured, programmed, controlled, etc. to associate, collect, group, etc. one or more pieces of information, data for any purpose, reason, technique, etc. including, but not limited to, data protection. For example, in one embodiment, data may be encrypted, ciphered, and/or otherwise protected, encoded, etc. For example, in one embodiment, data stored in a first memory class may be encrypted etc. while data stored in a second memory class may not be encrypted or may use a different form, strength, type, etc. of encryption etc. In this case, for example, a memory class may associate encryption keys and/or any other data, information, settings, etc. with data. Of course operations are not limited to data protection, ciphering, encryption, etc. For example, in one embodiment, any operations, combinations of operations, etc. may be used in the manner described. For example, in one embodiment, any operations, combinations of operations, etc. may be associated with, correspond to, be employed with, uniquely apply to, etc. one or more memory classes, etc.

In one embodiment, one or more aspects, features, parameters, functions, settings, configurations, modes, data coverage, nesting, overlap, hierarchy, polynomials, algorithms, etc. of one or more CRC codes, coding schemes, correction schemes, CRC generation, CRC algorithms, CRC logic, CRC engines, code fields, checksums, digest, data digest, frame check sequence (FCS), error correcting codes, ciphers, block ciphers, and/or any other aspects of any coding, error coding, ciphering, and/or similar schemes etc. as well as the code generation, code checking and similar, related operations etc. may be varied, programmed, configured, altered, modified, changed, etc. In one embodiment, for example, one or more aspects, features, parameters, functions, etc. of one or more CRC codes, coding schemes, correction schemes, CRC generation, CRC checking, checksums, digest, data digest, FCS, error correcting codes, ciphers, etc. may include one or more of the following (but not limited to the following): CRC polynomial; algorithm used for division; algorithm used for calculation of remainder; algorithm used for rolling CRC; algorithm for error correcting codes; use of a fixed bit pattern prefix; appending of one or more zero bits before division; XOR of fixed bit pattern; bit order; byte order; polynomial format (e.g. omission of high-order bit, low-order bit, and/or any other simplifications and the like etc.); checksum algorithm; lookup tables; combinations of these; and/or any other similar aspects, parameters, formats, and the like etc.

In one embodiment, for example, one or more circuits, functions, blocks etc. may perform one or more data protection operations, functions, etc. Thus, for example, CRC logic, data protection logic, error correction logic (CRC logic etc.) may perform CRC calculations, error correcting code calculations, checks, comparisons, corrections, error flagging, status generation, etc. Data protection may utilize combinations of one or more techniques. For example, an ECC code may be used together with a CRC, etc. In one embodiment, for example, any number, type, form, technique, combination, etc. of CRC, ECC, and/or any other error coding, data protection schemes, and the like etc. may be used.

In one embodiment, for example, CRC logic etc. may compute remainders, CRC values, checksums, etc. in an incremental manner, incrementally, continuously, in a rolling fashion, and/or by any other similar techniques and the like etc.

In one embodiment, for example, CRC logic etc. may signal one or more error situations. For example, a failed CRC check may be signaled by poisoning data, information, packets, etc. For example, data poisoning and/or any other poisoning, invalidation, deliberate corruption, marking, indication, error flagging, error signaling, etc. may occur by inserting an invalid CRC check value in one or more packets. In one embodiment, for example, any form of invalidation (e.g. corruption or stomping, etc.) of check values and/or any other bits, fields, flags, etc. may be used. In one embodiment, for example, data and/or any other fields may be stomped. Stomping may include replacement of data fields with zero values, for example. Any value may be used for stomping (including random values, programmed values, garbage values, all zeros, all ones, and/or any other bits, patterns, etc.). For example, in one embodiment, response data may be stomped in order to avoid any possible exposure of sensitive data in an error situation, error condition, etc. For example, in one embodiment, write data may be stomped in order to avoid any possible accidental recording of sensitive data in an errant location in memory under an error condition, etc. For example, in one embodiment, the CRC logic etc. may invert the CRC value in order to poison etc. one or more packets, etc. For example, in one embodiment, the CRC logic etc. may set, flag, mark, indicate, etc. a poison field in one or more packets, etc. For example, a poison bit and/or any other similar indication, flag, field, etc. may be contained, included, embedded, etc. within one or more packet headers, tails, digests, combinations of these and/or any other fields, parts, portions, etc. of one or more packets, bus signals, etc. Of course, any poisoning, stomping, marking, indication, error flagging, error signaling, etc. technique, scheme, and the like may be used. Of course, any poisoning etc. schemes may be applied, used, employed, utilized, etc. on data, information, etc. at any location, position, etc. in a system. For example, poisoning etc. may be applied etc. at the PHY layer of one or more high-speed links between CPU and/or stacked memory chips. For example, poisoning etc. may be applied etc. at the packet level. For example, poisoning etc. may be applied etc. at the bus level (e.g. internal to a logic chip, internal to a stacked memory chip, and/or elsewhere in the memory system, etc.). For example, poisoning etc. may be applied etc. at the raw command level (e.g. in raw commands sent to one or more stacked memory chips, etc.). For example, poisoning etc. may be applied etc. to the commands issued to, transmitted to, etc. one or more stacked memory chips (e.g. by a logic chip, etc.). For example, poisoning etc. may be applied etc. to any such level and the like etc.

For example, in one embodiment, poisoning etc. may be applied etc. in a collaborative, cooperative, distributed, etc. fashion and/or manner, etc. For example, in one embodiment, a first stacked memory chip may encounter an error and indicate that a response, part of a response, and/or any other data, information, etc. is to be poisoned, stomped, and/or otherwise invalidated, etc. For example, in this case, a first circuit (e.g. on a stacked memory chip and/or elsewhere, etc.) may set a bit, flag, and/or any other indicator etc. to indicate poisoning etc. of a response etc. is to occur, is to be performed, etc. In this case, for example, a second circuit may poison, stomp, etc. data in the response etc. For example, in this case, the response etc. may comprise, include, etc. data from a first memory chip and a second memory chip. In this case, for example, the first circuit may indicate to the second circuit that data, information, etc. collected, aggregated, formed, etc. from the first and second memory chips is to be poisoned, stomped etc. Of course any number, type, arrangement, design, architecture of circuits may be used in any combination to effect the poisoning, stomping, etc. of any data, information, fields, etc. that may be collected, aggregated, gathered, etc. from any number, type, form, structures, etc. of memory circuits, stacked memory chips, etc.

In one embodiment, for example, CRC logic etc. may prefix, insert, append, add, etc. a fixed bit pattern or one or more patterns to one or more data, blocks, information, message, bitstream, etc. to be checked. Such prefix etc. operations may be beneficial, for example, when clocking, shifting, alignment, stuffing, padding, and/or any other similar operations etc. may prefix, insert, append, add, etc. one or more zero bits and/or any other bits, patterns, etc. in front of data, in data, after data, etc. in a bitstream, etc. For example, such prefixing, inserting, appending, adding, etc. one or more bits, patterns, etc. to one or more data blocks etc. may in some circumstances leave a CRC calculation, check value, etc. unchanged. Addition of a prefix etc. may be beneficial in this situation. In one embodiment, for example, the fixed bit pattern(s) to be prefixed etc; the technique used to prefix etc; and/or any other aspects of the operation, behavior, function, etc. to prefix etc. may be configured, programmed, etc. at any time and/or in any manner, fashion, context, etc.

In one embodiment, for example, logic etc. (e.g. part, portion of the CRC logic, any other logic, etc.) may prefix, insert, append, add, etc. one or more bit patterns, markers, tags, flags, etc. in order to mark, identify, synchronize, initialize, and/or otherwise provide a known reference point in a bitstream, etc. For example, it may be desired to check a bitstream (e.g. using a logic analyzer, etc.). In this case, for example, it may be beneficial to know the location of a window, block, portion, etc. (e.g. used for CRC calculation, etc.) of data occurs (e.g. within a stream of data, within a bitstream, etc.). For example, if a CRC is calculated every 512 bits, a marker etc. may be placed every 512 bits (and/or at any other intervals, etc.). For example, a marker may be placed every 1024 bits. For example, a marker may be paced every 128 bits. Any spacing of markers relative to the CRC length (e.g. a multiple, sub-multiple, or any length, etc.) and/or relative to any other property of the bitstream etc. may be used. For example, in one embodiment, a first type of marker may be placed every 512 bits. For example, in one embodiment, a first type of marker may be placed every 32 bits and a second type of marker every 512 bits. Of course, any type, form, number, format, kind, etc. of markers etc. may be used. Of course, any spacing, arrangement, pattern, etc. of markers etc. may be used. In one embodiment, for example, the bit pattern(s), markers, marker positions, marker spacing, marker functions, marker insertion, and/or any other aspects of the operation, behavior, function, etc. to mark one or more intervals etc. may be configured, programmed, etc. Such programming, configuration, etc. may be performed at any time, in any manner, context, fashion, etc. Of course, such marking, identification, synchronization, initialization, etc. may be used for any purpose, function, etc.

In one embodiment, for example, CRC logic etc. may prefix, insert, append, add, etc. one or more bit patterns that may be the results of one or more CRC operations or derived from the results of one or more CRC operations etc. For example, in one embodiment, CRC logic etc. may prefix, insert, append, add, include, etc. a bit pattern corresponding to the result of a previous CRC operation in order to create a rolling CRC, chained CRC, continuous CRC, sliding window CRC, and/or other similar CRC algorithm, technique, etc. For example, a rolling CRC may be calculated using a sliding window. For example, a first window may include a first block of data and a first CRC may be calculated using the first window. For example, a second window may include a second block of data and a second CRC may be calculated using the second window, possibly using the first CRC. This process may be repeated using third, fourth, etc. windows. In one embodiment, one or more windows may overlap. In one embodiment, the windows may be contiguous, touching, nonoverlapping, etc. Any form, number, type, variation, length, format, kind, etc. of windows may be used. In one embodiment, the windows may be fixed in size, etc. In one embodiment, the windows may be variable in size, etc. In one embodiment, the window size, etc. may be programmable, configurable, etc. Programming etc. of windows, window aspects, window settings, window parameters, and/or any other aspects of rolling CRC calculation, chained CRC calculation, and/or other aspects of CRC calculation, generation, etc. may be performed at any time and/or in any manner, fashion, context, etc. In one embodiment, logic (including but not limited to, CRC logic, etc.) may similarly calculate a rolling checksum, hash value, parity, and/or employ, utilize, etc. any other check code, check values, data protection code, ciphers, combinations of schemes (e.g. CRC and checksum, etc.), and the like, etc.

In one embodiment, for example, CRC logic and/or any other logic may use coding, CRC, checksums, ciphers, one or more rolling CRC calculations, rolling checksum calculations, hash codes, combinations of these, and/or any other data coding scheme, data protection scheme, etc. in order to label, mark, identify, finger-print, validate, protect, secure, etc. data. In one embodiment, for example, such labels etc. may be used to identify duplicate data. In one embodiment, for example, such labels etc. may be used to ensure data integrity, ensure data has not been tampered with, protect data from unauthorized modification, provide timestamps, provide audit trails, validate information, establish trust, ensure security, combinations of these, and/or provide one or more data marking, identification, etc. schemes and the like, etc.

In one embodiment, for example, CRC logic etc. may append one or more bits to the data to be checked before performing the polynomial division associated with CRC calculation, generation, checking, etc. In one embodiment, for example, CRC logic etc. may append n zero bits to the data to be checked before performing the polynomial division. In one embodiment, for example, n may be the length of the CRC and/or related to the length of the CRC. In one embodiment, for example, n may be a multiple or sub-multiple of the length of the CRC and/or otherwise related to the length, polynomial size, and/or any other aspect, parameter, metric, function, behavior, etc. of the CRC. Such a prefix operation may be beneficial, for example, to cause the remainder of polynomial division of the original data with the check value appended to be zero. Thus, in this case, for example, the CRC value may be checked by performing the polynomial division on the data to be checked and comparing the remainder with zero. In one embodiment, the number, value, etc. of bits to be appended and/or the manner, algorithm, etc. that bits are to be appended etc. may be configured, programmed, etc. in any manner, fashion, etc.

In one embodiment, for example, CRC logic etc. may use shift-register(s), tables(s), combinations of these, and/or any other circuits, firmware, hardware, software, etc. In one embodiment, for example, CRC logic etc. may use the associative properties and/or commutative properties of the exclusive-OR operator. For example, table-based CRC logic and/or any other CRC logic etc. may perform in a manner, obtain a result, perform a calculation, etc. that is mathematically, numerically, etc. equivalent, similar, identical, etc. to appending zero bits (e.g. without explicitly appending any bits, etc.). For example, CRC logic etc. may use an algorithm that combines the data in bitstream format with the bitstream shifted out of a CRC shift-register, etc.

In one embodiment, for example, CRC logic etc. may exclusive-OR a fixed bit pattern into the remainder of the polynomial division. In one embodiment, the fixed bit pattern to be used in this operation may be configured, programmed, etc.

In one embodiment, for example, the bit order of CRC logic etc. may be programmed, controlled, set, configured, etc. For example, a first CRC scheme may view the low-order bit of each byte in the data to be checked as the first bit. In this case, the first bit may correspond to the left most bit during polynomial division. In this case, left most bit may be contrary to the customary use of low-order. The first CRC scheme may be used, for example, in order to check serial data transmissions that may transmit bytes least-significant bit first. For example, a second CRC scheme may view the low-order bit of each byte in the data to be checked as the last bit. In one embodiment, for example, CRC logic may be programmed to operate according to the first scheme, and/or the second scheme, and/or any number, type, version, etc. of any similar schemes, configurations, settings, etc.

In one embodiment, for example, the byte order of CRC logic etc. may be programmed, controlled, set, configured, etc. For example, if the data to be checked contains, includes, etc. one or more bytes of data the byte transmitted first, stored in the lowest-addressed byte of memory, etc. may be set, programmed, configured, etc. as the least-significant byte (LSB) or the most-significant byte (MSB). Such a configuration option etc. may be beneficial, for example, in conjunction with the use of CRC schemes that may swap the bytes of the check value (e.g. as may be implemented, performed, employed, used, etc. by some standard 16-bit CRC schemes, etc.). Of course any interpretation, manner or fashion of inference, and/or similar behavior with respect to byte order etc. may be used, implemented, programmed, configured, controlled, managed, etc.

In one embodiment, for example, the CRC logic, configuration messages, register settings, etc. may omit, suppress, delete, ignore, generate, and/or otherwise modify, comprehend, interpret, etc. the high-order bit of the divisor polynomial. For example, in one embodiment, the high-order bit of a CRC polynomial may always be equal to 1. Thus, for example, the CRC logic may assume, infer, etc. the presence, value, etc. of the high-order bit. Thus, for example, a configuration and/or programming of the CRC logic etc. may assume the presence etc. of the high-order bit. Of course any interpretation, inference, and/or similar behavior with respect to polynomials, polynomial bits, polynomial terms, any other functions, and/or any other similar characteristics, parameters, metrics, settings, and the like etc. may be used, implemented, programmed, configured, etc. Such programming etc. may be performed at any time, in any manner, fashion, context, etc.

In one embodiment, for example, the CRC logic etc. may omit etc. the low-order bit of the divisor polynomial. For example, in one embodiment, the low-order bit of a divisor polynomial may always be equal to 1. Thus, for example, a configuration and/or programming of the CRC logic etc. may assume the presence etc. of the low-order bit.

In one embodiment, for example, the CRC logic, CRC code logic, CRC polynomial, divisor polynomial, etc. may use one or more representations, conventions, etc. including (but not limited to) one or more of the following: omission of polynomial high-order bit, omission of polynomial low-order bit (e.g. x\hat{ }0 term, 1 term, etc.), MSB-first code (normal representation), LSB-first code (reversed representation), reversed reciprocal, Koopman notation, combinations of these and/or any other similar representations and the like, etc. For example, the polynomial x\hat{ }4+x+1 may be represented as 0x3 (MSB first, normal), 0xC (LSB first, reversed), 0x9 (reversed reciprocal), etc. Of course, any polynomial representation may be used, employed, configured, programmed, etc. Of course any interpretation, inference, and/or similar behavior with respect to polynomial representation, any other representations, any other settings, configurations, modes and the like etc. may be used, implemented, programmed, configured, etc. Such programming etc. may be performed at any time, in any fashion, context, manner, etc.

In one embodiment, for example, the CRC logic etc. may be configured to allow the use of one or more CRC calculations techniques, CRC polynomials, etc. In one embodiment, for example, a packet may contain, include, etc. a field, bit, data, and/or any other information etc. that may control one or more CRC calculation techniques, CRC polynomials, etc. For example, in one embodiment, the CRC logic etc. may be configured to calculate both CRC-32C and CRC-32K. In this case, a bit may be set (e.g. in a packet header, etc.) to indicate the polynomial to be used. Of course, any variation, configuration, setting, parameter, behavior, function, etc. associated with CRC checks, error correction, data protection, etc. may be so indicated, similarly indicated, etc. by the use of one or more bits, fields, flags, combinations of these and/or any other indicators and the like etc.

In one embodiment, for example, the CRC logic, data protection logic, error correction logic, etc. may be configured to allow the use of one or more CRC calculation techniques, CRC polynomials, and/or any other aspects of data protection etc. that may depend on data length, data type, and/or any other aspects of data etc. For example, in one embodiment, a first CRC polynomial and/or any other data protection technique may be used for short command packet types (e.g. a read request, etc.) and a second CRC polynomial and/or any other data protection technique may be used for long command packet types (e.g. a write command with a large amount of data, etc.). For example, in one embodiment, a first CRC polynomial and/or any other data protection technique may be used for messages, error packets, completion status, flow control, etc. (e.g. a first subset of commands, etc.) and a second data protection technique etc. may be used for any other commands, requests, completions, responses, etc. (e.g. a second subset of commands, etc.). Of course, data protection, aspects of data protection, etc. may depend on any aspect, feature, property, etc. of data, information, commands, requests, messages, combinations of these, and/or the like etc.

In one embodiment, for example, the CRC logic, any other data protection logic etc. may be configured to allow the use of one or more CRC calculation techniques, CRC generation techniques, data protection schemes, CRC polynomials, error correcting codes, ciphers, hashes, checksums, check values, and/or any other similar codes, schemes and the like etc. that may depend on any aspect of packet type, bus technology, data conveyed, traffic class, memory address, memory technology, and/or any aspect of a memory system etc. For example, in one embodiment, a first type of data protection may be applied to packets, commands, requests, etc. that target a first type of memory (e.g. flash, EEPROM, non-volatile logic memory, logic NVM, embedded NVM, etc.) and a second type of data protection may be applied to packets, commands, requests, etc. that target a second type of memory. For example, in one embodiment, the data protection, CRC codes, used, employed, configured, programmed etc. may depend on the memory class. Such configuration, programming etc. may be performed at any time, in any manner, fashion, etc.

In one embodiment, one or more CRC fields, codes, FCS, check values, checksums, ciphers, digests, remainders, messages, configuration settings, register settings, status, configuration requests/commands, combinations of these, etc. may include information, data, remainders, values, etc. that may be part of, derived from, associated with, etc. one or more of the following (but not limited to the following) codes: CRC-1 (parity), CRC-4-ITU, CRC-5-EPC, CRC-5-ITU, CRC-5-USB, CRC-6-ITU, CRC-7, CRC-8-CCITT, CRC-8-Dallas/Maxim, CRC-8, CRC-8-SAE J1850, CRC-8-WCDMA, CRC-10, CRC-11, CRC-12, CRC-15-CAN, CRC-15-MPT1327, CRC-16-IBM, CRC-16-CCITT, CRC-16-T10-DIF, CRC-16-DNP, CRC-16-DECT, CRC-16-ARINC, Fletcher checksum, CRC-24, CRC-24-Radix-64, CRC-30, Adler-32, CRC-32, CRC-32C (Castagnoli), CRC-32K (Koopman), CRC-32Q, CRC-40-GSM, CRC-64-ISO, CRC-64-ECMA-182, any other similar CRC codes, any other checksum algorithms, any other similar codes, variations of these codes, derivatives of these codes, any other coding schemes, and/or combinations of these and the like, etc.

In one embodiment, one or more hash codes, ciphers, any other codes, etc. may be used for data protection and/or any other functions (e.g. labeling, etc.) and the like, etc. For example, hash codes etc. may include, but are not limited to, one or more of the following: BLAKE-256, BLAKE-512, ECOH, FSB, GOST, Grøstl, HAS-160, HAVAL, JH, MD2, MD4, MD5, MD6, RadioGatún, RIPEMD-64, RIPEMD-160, RIPEMD-320, SHA-1, SHA-2, SHA-224, SHA-256, SHA-384, SHA-512, SHA-3 (Keccak), Skein, SipHash, Snefru, Spectral Hash, SWIFFT, Tiger, Whirlpool, combinations of these and/or any other similar hash functions, CRC codes, checksums, ciphers, any other codes and the like, etc.

For example, data protection, data labeling, finger-printing, marking, etc. may use one or more of the following (but not limited to the following): hash functions, hash tables, hashed search table, hashed cache, Bloom filters, checksums, check digits, fingerprints, randomization functions, error correcting codes, cryptographic hash functions, keys, buckets, strings, Rabin-Karp algorithm, cells, arrays, indices, grid file, grid index, bucket grid, geometric hashing, grid techniques, perfect hash functions, dynamic hash tables, dynamic hash functions, minimal perfect hash, Merkle-Damgård construction, heuristic hash functions, checksum hash functions, CRC32 hash functions, SHA-1 hash functions, SHA-2 hash functions, other hash functions, locality-sensitive hashing (LSH), Bernstein hash, Fowler-Noll-Vo hash functions (e.g. 32, 64, 128, 256, 512, or 1024 bits), Jenkins hash functions, Pearson hashing, Zobrist hashing, coalesced hashing, cuckoo hashing, hopscotch hashing, combinations of these and/or any other similar hash functions, CRC codes, checksums, ciphers, block ciphers, any other codes, coding schemes, and the like, etc.

System Management

In one embodiment, the memory system 18-200 may include one or more management features, schemes, techniques, combinations of these and the like etc. In one embodiment, for example, the memory system may include one or more power management features, schemes, techniques, combinations of these and the like etc. Power management etc. may include, but is not limited to, the control, configuration, programming, setting, management, limiting, etc. of voltage, current, power (e.g. product of voltage and current), energy (e.g. the product of power and time, power integrated over time, etc.), the rate of change of voltage (e.g. dV/dt), the rate of change of current (e.g. dI/dt), the rate of change of power, combinations of these and/or any other voltage-related, current-related, power-related, and/or energy-related metrics, parameters, functions, and the like etc. For example, the regulation, control, etc. of dV/dt may be used to manage, control etc. one or more system metrics such as interference, signal integrity, crosstalk, etc. For example, the regulation, control, etc. of dI/dt may be used to manage, control etc. power metrics such as ground bounce, supply bounce, etc. Control, management, regulation, etc. of voltage, power, etc. may apply to, be used to control, etc. the power supplies (e.g. ground, GND, VDD, VCC, VREF, etc.) and/or power supply signals, reference signals (e.g. current, voltage, etc.), reference levels, etc. and/or to individual signals, logic signals, etc. For example, control etc. of dV/dt may be used to control the slew rate of signals, etc. (e.g. to limit interference, signal crosstalk on buses, etc.). For example, control etc. of one or more signal properties etc. (e.g. timing, pulse width, rise time, fall time, slew rate, period, frequency, overshoot, undershoot, etc.) may be used to control, manage, limit, etc. interference, signal crosstalk, etc. on buses, etc. Of course any parameter, characteristic, metric, feature, behavior, timing, level, magnitude, slew rate, and/or any function, feature, metric, parameter, value, statistic, etc. of any signal, supply, reference, etc. may be managed, controlled, regulated, governed, limited, etc. in a manner, fashion, etc. described herein and/or in one or more specifications incorporated by reference.

In one embodiment, for example, power management may be implemented in the context of FIG. 19-15 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. In one embodiment, for example, one or more bypass paths (e.g. logical short-circuits, fast paths, logical paths, alternative routes, alternative paths, alternative connections, etc.) may be activated, used, employed, selected, etc. (e.g. connected using a MUX/DEMUX, coupled using switches, and/or any other switching, selective coupling techniques, and/or the like etc.). For example, one or more bypass paths etc. may be used when it is desired to achieve lower latency and/or save power by bypassing one or more circuits (e.g. crossbars, switches, switch matrix, and/or any other circuits, paths, logic, blocks, functions, and the like etc.). Of course any altering, modifying, changing, etc. the topology, connection, interconnection, arrangement, coupling, functions, behavior, etc. of one or more circuits, blocks, functions, datapaths, circuit paths, and the like etc. may be used. A trade off may be that the interconnectivity (e.g. numbers, types, permutations of connections, etc.) or some other function, feature, behavior, process, parameter, metric, etc. of the system, circuits, datapath, memory, etc. may be reduced, changed or otherwise altered when one or more alternative paths are used, etc.

In one embodiment, for example, one or more circuits, datapaths, circuit blocks, functions, etc. may be constructed, implemented, designed, programmed, configured, wired, connected, etc. as a group (e.g. collection, set, association, collective, etc.) that may be changed (e.g. variably sized, modified, configured, controlled, programmed, and/or otherwise altered etc. in arrangement, form, connection, operation, configuration, coupling, number, etc.) in order that power and/or one or more power-related properties, parameters, metrics, features, behavior, etc. may be managed, controlled, varied, altered, modified, changed, governed, limited, monitored, etc. Any such programming, configuration, etc. may be performed at any time, in any manner, fashion, etc. Thus for example, if a full-bandwidth mode is desired all inputs may be connected to a receiver block, etc. Thus for example, if a low-power mode is desired only a subset of inputs may be connected to the receiver block, etc. Of course any arrangement, architecture, etc. of circuits, blocks, functions, logic, etc. may be used in any form, manner, fashion, etc. in order to manage power in a similar or like manner, fashion, technique, etc. to that described.

In one embodiment, for example, the memory system 18-200 may include VC mapping and/or any other types/forms of channel mapping, traffic control, traffic prioritization, combinations of these and/or any other queuing, control, prioritization, shaping, etc. of data, traffic, commands, requests and the like etc. that may be used to modify, configure, program, set, alter, etc. latency, performance, bandwidth, response times, combinations of these and/or any other parameters etc. in combination with the management of power and/or one or more power-related properties, functions, parameters, metrics, features, behaviors, etc. For example, shaping of data traffic may include the control, management, throttling, bandwidth control, latency control, etc. of data, information, etc. For example, data traffic shaping may use any of one or more aspects of flow, flow control, etc.

In one embodiment, for example, one or more alternative timings (e.g. of commands, requests, command timing, signals, operations, flows, behaviors, functions, processes, etc.) may be used, employed, programmed, configured, set, etc. in order that power etc. and/or one or more power-related properties, parameters, metrics, features, behavior, etc. may be managed, controlled, varied, altered, modified, changed, etc. Such programming, configuration, etc. may be performed at any time, and/or in any manner, fashion, etc.

In one embodiment, for example, the timing between a command (e.g. read request, etc.) and a response (e.g. read completion, etc.) may be managed, controlled, varied, programmed, configured, etc. Such programming etc. may be performed at any time, and/or in any manner, etc. For example, a first timing may correspond to a first mode of behavior, operation, etc. (e.g. non power-managed mode, normal functions, high-power operation, etc.). For example, a second timing may introduce an additional delay, different circuit operation or behavior, different timings, etc. and may correspond to a power-managed state, and/or other state, etc. In one embodiment, for example, one or more power-managed states may be controlled, managed, programmed, configured, etc. by one or more logic chips e.g. in a stacked memory package etc. In one embodiment, for example, the logic chip may place one or more stacked memory chips (e.g. DRAM, etc.) in a power-managed state (e.g. CKE registered low, precharge power-down, active power-down/slow exit, active power-down/fast exit, sleep, power-down mode, and/or any other power states, modes, configurations, etc.). In a power-managed state and/or other state, etc. a DRAM circuit, function, etc. may not respond, for example, within the same time (e.g. may not have the same timing, etc.) and/or in the same manner, fashion, etc. as if the DRAM etc. is not in a power-managed state etc. (e.g. is in a non-power managed state, is in a normal mode of operation, other mode of operation, etc.). For example, if one or more DRAMs is in one or more power-managed states, one or more enable signals (e.g. CKE, chip select, control, enable, combinations of these, functions of these and/or any other control signals, any other signals, etc.) may be asserted to change, modify, alter etc. the DRAM state(s) (e.g. wake up, power up, change state, change mode, combinations of these and the like etc.). Thus, for example, in one or more power-managed modes etc. one or more enable signals etc. may be asserted to change the power state of one or more stacked memory chips, etc. Thus, for example, the logic chip in a stacked memory package may place one or more DRAMs in one or more power-managed states and/or otherwise manage power of one or more stacked memory chips to manage power in a stacked memory package, etc.

In one embodiment, for example, the logic chip and/or any other logic etc. may reorder commands, requests, responses, messages, packets and the like in order to perform power management and/or in order to manage, control, program, configure, etc. one or more power-related properties, parameters, metrics, features, behavior, etc. Such programming etc. may be performed at any time, and/or in any manner, fashion, etc.

In one embodiment, for example, the logic chip and/or any other logic etc. may assert CKE and/or similar control signals, other signals, etc. of one or more DRAM circuits, stacked memory chips, and/or any other memory circuits etc. in order to perform power management, in order to regulate power, in order to govern power, in order to limit power, and/or to otherwise manage, control, program, configure, monitor, limit, govern, regulate, etc. one or more of any power-related properties, parameters, metrics, features, behavior, functions and the like etc.

In one embodiment, for example, one or more crossbars and/or logic structures, switching structures, multiplexed structures, etc. that may perform one or more logically equivalent, electrically equivalent, and/or related, similar, like, etc. functions to a crossbar etc. (e.g. matrix, MUX/de-MUX, combinations of these and any other similar functions, circuits and the like etc.) may use connection sets (as defined herein and/or in one or more specifications incorporated by reference). In one embodiment, for example, one or more connection sets and/or any other similar modes, settings, configurations, programmed settings, and the like may be used to manage power and/or manage, control, program, configure, limit, govern, modulate, manipulate, etc. one or more power-related properties, parameters, metrics, features, behaviors, and/or combinations of these and the like, etc. Such programming etc. may be performed at any time, and/or in any context, manner, fashion, etc.

In one embodiment, for example, the power-management techniques described herein and/or in one or more specifications incorporated by reference may be combined into one or more power modes, power settings, power configurations, power profiles, power programs, power behaviors, combinations of these and any other similar settings, profiles, and the like etc. Thus, for example, an aggressive (e.g. highest-level, most power savings, etc.) power mode (e.g. hibernate etc.) may apply all, or nearly all, power saving techniques etc. while, for example, a minimal power saving mode (e.g. snooze, etc.) may only apply the least aggressive power saving techniques etc. Of course any level, mode, setting, programming, type, form, kind, etc. of power management etc. may be used. Of course any number, type, form, kind, etc. of power management levels etc. may be used individually, in combination, etc.

In one embodiment, for example, one or more power modes may be controlled, applied, set, programmed, configured, managed, monitored, changed, modified, etc. by one or more system CPUs and/or any other system components in a memory system. Such programming etc. may be performed at any time, in any manner, etc. For example, a system CPU and/or any other system component etc. may transmit, send, convey, carry, etc. one or more messages, configurations, register settings, mode register settings, power management signals, combinations of these and the like etc. In one embodiment, for example, one or more power modes may be controlled, applied, set, programmed, configured, managed, etc. by one or more logic chips in a stacked memory package (e.g. in an autonomous fashion, semi-autonomous fashion, etc.). In one embodiment, for example, one or more power modes may be controlled, applied, set, programmed, configured, managed, etc. by a combination of logic, programs, etc. external to a stacked memory package (e.g. one or more system CPUs, one or more system components, combinations of these and the like etc.) and/or logic, programs, etc. internal to a stacked memory package (e.g. including, but not limited to, a logic chip, one or more stacked memory chips, etc.). Of course power management etc. may be controlled, programmed, configured, defined, regulated, initialized, gated, monitored, measured, effected, implemented, etc. at any time and/or in any fashion, manner, etc.

In one embodiment, for example, power management may be implemented in the context of FIG. 20-14 and/or any other figures of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. In one embodiment, for example, a system including one or more stacked memory packages may be operable to be managed, controlled, regulated, directed, etc. (e.g. power managed, otherwise managed, etc.). In one embodiment, for example, a system CPU, stacked memory package, logic chip, and/or any other system component may alter (e.g. change, modify, configure, program, reprogram, reconfigure, set, etc.) one or more properties of the one or more stacked memory packages and/or any other system component etc. For example, one or more properties changed may include one or more of the following, but not limited to the following: bus frequency, clock frequency, circuit delay, signal timing, timing of refresh operations and/or any other operations, command priority, virtual channel property, bus termination, bus equalization, IO circuit parameters, power, voltage, current, combinations of these and/or any other parameters, values, timings, and the like etc.

In one embodiment, for example, the frequency of one or more buses (e.g. links, lanes, high-speed serial links, connections, external connections, internal buses, clock frequencies, network-on-chip operating frequencies, signal rates, etc.) may be altered, programmed, configured, etc. Such programming etc. may be performed at any time, and/or in any context, manner, fashion, etc.

In one embodiment, for example, the power consumption of one or more system components, circuits, blocks, functions, etc. and/or one or more other power-related properties (e.g. voltage supply, current draw, resistance, drive strength, termination resistance, reference levels, signal slew rates, operating power, duty cycle, frequency, delay, timing, and/or any other properties, parameters, values, metrics, modes, configurations, and the like etc.) may be altered, programmed, configured, etc. Such programming etc. may be performed at any time, and/or in any context, manner, fashion, etc.

In one embodiment, for example, a memory system using one or more stacked memory packages may be managed, maintained, and/or otherwise controlled etc. In one embodiment the memory system management system may include management systems, controllers, controls, circuits, functions, etc. on one or more stacked memory packages. In one embodiment the memory system management system may be operable to alter, change, modify, control, program, configure, etc. one or more properties of one or more stacked memory packages and/or any other system components etc. In one embodiment, for example, a stacked memory package may include a management system, etc. For example, one or more logic chips included in a stacked memory package may function, perform, implement, execute, etc. one or more power management functions, etc.

In one embodiment, for example, the management system etc. of a stacked memory package may be operable to alter etc. one or more system properties etc. In one embodiment, for example, the system properties of a stacked memory package that may be managed may include power. In one embodiment, the managed system properties of a memory system using one or more stacked memory packages may include circuit frequency. In one embodiment the managed circuit frequency may include bus frequency. Of course any properties, metrics, parameters, behaviors, functions, etc. of a stacked memory package may be so managed, controlled, etc.

In one embodiment, for example, the managed circuit frequency may include clock frequency. In one embodiment the managed system properties of a memory system using one or more stacked memory packages may include one or more circuit supply voltages, any other voltages, reference values, currents, resistances, termination values, combinations of these and/or related parameters, metrics, values, settings, configurations, modes, etc. In one embodiment the managed system properties of a memory system using one or more stacked memory packages may include one or more circuit termination resistances, termination values, type of termination, combinations of these, and/or any other bus termination related properties and the like etc.

In one embodiment, for example, the managed system properties of a memory system that may include one or more stacked memory packages may include one or more circuit currents, reference currents, operating currents, operating power, and the like etc. For example, IO circuits, PHY circuits, high-speed serial link receivers, high-speed serial link transmitters, and/or any other similar circuits, functions, blocks, etc. may be managed, controlled, configured, etc. For example, the speed, latency, etc. of an input receiver etc. may depend on the current supplied to the input receiver circuit(s) etc. For example, in order to configure, program, etc. operation in a high-speed, low latency, etc. mode, configuration, etc. the current supplied to one or more input receiver circuits etc. may be increased. Of course any similar scheme, technique, etc. to modify, control, alter, change, and/or otherwise manage the behaviors, functions, performance, power, latency, speed, parameters, features, etc. of one or more circuits, functions, blocks, etc. may be used, employed, etc. Of course any parameter, feature, metric, etc. may be so managed, controlled, etc. (e.g. current, voltage, resistance, timing, frequency, combinations of these and/or any value, parameter, setting, configuration, and the like etc.).

In one embodiment the managed system properties of a memory system using one or more stacked memory packages may include one or more circuit configurations. Thus, for example, a low-power configuration may use a subset of available circuit resources, etc. For example, in a low-power mode, configuration, setting, etc. one or more IO circuits may be disconnected, disabled, operate with reduced power, set to low-power modes, etc.

In one embodiment, for example, a CPU and/or any other system component etc. may issue, transmit, send, convey, etc. one or more requests, commands, messages, control signals, combinations of these and the like etc. for purposes including, but not limited to, power management, power control, and/or management, control, configuration, programming, etc. of any function, behavior, flow, scheme, process, and the like etc. In one embodiment, for example, the requests etc. may control, manage, alter, modify, program, configure, and/or otherwise change or cause to be changed etc. one or more circuit properties, circuit functions, circuit behaviors, configurations, settings, behaviors, and the like etc. Such programming etc. may be performed at any time, in any manner, fashion, etc. In one embodiment, for example, the requests etc. may control, manage, alter, modify, program, configure, and/or otherwise change or cause to be changed etc. one or more frequencies and/or frequency-related property (e.g. frequency of circuit operation, frequency of bus operation, DLL or PLL frequency, oscillator frequency, combinations of these and/or frequency or frequency-related property of any circuit, function, block, component, and the like etc.). For example, the request may be intended to change (e.g. update, modify, alter, increase, decrease, reprogram, set, initialize, etc.) the frequency and/or frequency-related properties etc. (e.g. clock frequency, bus frequency, combinations of these etc.) of one or more circuits (e.g. components, buses, links, buffers, oscillators, frequency synthesizers, frequency dividers, counters, etc.) in one or more logic chips, in one or more stacked memory packages, and/or in any other system components, etc. For example, the request may contain, include, etc. one or more of each of the following information (e.g. data, fields, parameters, etc.), but is not limited to the following: target identification (e.g. circuit, bus, etc. to be modified), request tag etc, change or type of change etc. (e.g. change frequency command, command code, command field, instruction, combinations of these and/or any other indication of change to be made, etc.), data and/or parameters etc. (e.g. frequency, frequency code, frequency identification, frequency multipliers (e.g. 1×, 2×, 3×, 0.5×, 1.5×, etc.), any other parameter(s) and/or values to be changed, index to a table, tables(s) of values, pointer to a value, combinations of these, sets of these, and/or any parameter, metric, setting, configuration, value, number, timing, signal list, signal value, register value, register setting, mode, multiplier, divider, multiplicand, divisor, etc. that may be changed, altered, modified, programmed, configured, etc.), target module (e.g. target module identification, target stacked memory package number or any other identification, code, tag, etc.), target bus(s) (e.g. first, second, third, etc. bus identification field, list, code, etc.), and/or any other similar fields, parameters, bits, flags, and the like etc.

In one embodiment, for example, the stacked memory package may receive a request etc. (e.g. including, but not limited to, management request, control command, signals, etc.). In one embodiment, for example, the stacked memory package may determine that the request etc. may be targeted to (e.g. routed to, intended for, the target is, etc.) itself. The determination may be made, for example, by using the target module field in the request and/or by decoding, checking etc. one or more address fields etc. and/or similar techniques, equivalent techniques, etc. In one embodiment, for example, the logic chip may then determine that the request is a frequency change request etc.

In one embodiment, for example, the frequency of a bus (e.g. high-sped serial link(s), lane(s), SMBus, any other bus, combinations of buses, etc.) that may connect two or more components (e.g. CPU to stacked memory package, stacked memory package to stacked memory package, stacked memory package to IO device, etc.) may be changed in a number of ways, using a number of techniques, etc. For example, a frequency change request may be sent to each of the transmitters (e.g. on a bus, high-speed link, etc.). Thus, for example, a first frequency change request may be sent to logic chip 1 to change the frequency of logic chip 1-2 Tx link and a second frequency change request may be sent to logic chip 2 to change the frequency of logic chip 2-1 Tx link etc. Of course any parameter, mode, configuration, value, setting, etc. may be changed, managed, controlled, altered, modified, regulated, etc. at any time and/or in any similar, equivalent, etc. fashion, manner, etc.

In one embodiment, for example, the data traffic (e.g. requests, responses, messages, data flow, information flow, data streams, and the like etc.) between two or more system components may be managed, controlled, altered, modified, etc. (e.g. stopped, halted, paused, stalled, modulated, regulated, governed, and/or any other similar modifications, changes, alterations, etc. made) when a change in the properties of one or more connections, couplings, etc. between the two or more system components is made, requested, programmed, configured, etc. For example, in the case that one or more connections between two or more system components may use multiple links, multiple lanes, configurable links and/or lanes, multiple buses, etc. then the width (e.g. number, pairing, etc.) and/or any other properties of lanes, links, buses, signals, etc. may be modified, changed, altered, etc. separately. Of course properties etc. may be modified etc. at any time and/or in any manner, fashion, etc. Thus, for example, a connection C1 between system component A and system component B may use a link K1 with four lanes L1-L4. System component A and system component B may be CPUs, stacked memory packages, IO devices, and/or any other system components, etc. In one embodiment, for example, it may be desired to change the frequency of connection C1. A first technique may, for example, stop or pause data traffic on connection C1 as described above. A second technique may reconfigure lanes L1-L4 separately. Of course any similar, equivalent technique or indeed any technique, combination of techniques, etc. may be used. For example, first all traffic may be diverted to lanes L1-L2, then lanes L3-L4 may be changed in frequency (e.g. reconfigured, otherwise changed, etc.), then all traffic diverted to lanes L3-L4, then lanes L1-L2 may be changed in frequency (or otherwise reconfigured, etc.), then all traffic diverted to lanes L1-L4 etc. Such changes, modification, alterations, control, etc. may be used for any type, form, kind, number of interconnections, couplings, buses, links, and the like etc. Such changes, modification, alterations, control, etc. and/or similar changes etc. may be made at any time and/or in any context, fashion, manner, etc.

In one embodiment, for example, the techniques described to alter, modify, change, manage, control, program, configure etc. one or more links, buses, and/or any other interconnect, connections, buses, links, circuits, etc. (e.g. as described above, elsewhere herein, and/or in one or more specifications incorporated by reference) may be used, employed, implemented etc. in order to change, alter, modify, repair, replace, etc. one or more connections, couplings, interconnect, buses, etc. that connect, couple, etc. one or more chips, die, circuits, etc. in a stacked memory package. In one embodiment, for example, one or more TSVs, TSV arrays, chip-to-chip buses, chip-to-chip coupling, and/or any coupling, interconnect, connections, etc. may be repaired, replaced, tested, checked, probed, characterized, and/or any other similar operations and the like may be performed using one or more of the techniques described above, elsewhere herein, and/or any other similar techniques, etc. In this case, for example, one or more requests for such operations etc. may be received externally (e.g. received by a stacked memory package from an external system component, etc.) and/or may be created, generated, signaled, etc. internally and/or using a combination of internal and external requests, commands, signals, etc. For example, a logic chip may control, signal, create, generate, etc. requests, signals, commands, and the like etc. in order to effect, execute, implement, perform, etc. one or more repair, replacement, change, etc. operations and/or to effect etc. one or more modifications, alterations, etc. and/or effect the configuration, programming, etc. of interconnect, links, TSVs, TSV arrays, TSV matrix, TSV related circuits (e.g. switches, MUXes, selectors, drivers, etc.), combinations of these and the like etc. Of course the creation, generation, execution, implementation, performance, etc. of such operations (e.g. including but not limited to repair, replacement, checking, testing, characterization, etc.) may be performed, executed, implemented, programmed, configured, etc. at any time and/or in any manner, fashion, etc.

In one embodiment, for example, one or more TSVs, TSV arrays, connections using TSVs, etc. may be replaced during operation, etc. Such repair, replacement, etc. operations may form part of one or more dynamic sparing operations, for example. In one embodiment, for example, one or more TSVs, TSV arrays, connections using TSVs, etc. may be replaced at assembly time, fabrication time, at test, at other times during production, etc. Such repair, replacement, etc. operations may form part of one or more static repair operations, for example. Static repair may also be performed at start-up, during a pause in operation, after halting operation, before commencing operation, etc.

In one embodiment, for example, it may be beneficial to characterize, test, repair, replace, etc. one or more TSVs, TSV arrays, and/or other circuits, functions, blocks, etc. that may be associated with, coupled with, connected to, etc. one or more TSVs, TSV arrays, etc.

For example, in one embodiment, it may be detected, determined, etc. (e.g. at initialization, at start-up, during self-test, at run time using error counters, etc.) that one or more connections (e.g. TSVs, TSV arrays, and/or other connections, etc.) used by, employed by, etc. the memory system, stacked memory package(s), stacked memory chip(s), logic chip(s), combinations of these and/or any other part of the memory system, stacked memory package, etc. is in one or more failure modes (e.g. has failed, is likely to fail, is prone to failure, is exposed to failure, exhibits signs or warnings of failure, produces errors, exceeds an error or other monitored threshold, is worn out, has reduced performance or exhibits other signs, fails one or more tests, etc.). In this case the logic layer of the logic chip may act to substitute (e.g. swap, insert, replace, repair, etc.) the failed or failing connections.

For example, in one embodiment, one or more circuits, functions, blocks and/or other logic etc. may act to characterize, measure, probe, etc. one or more connections, interconnects, paths, segments, and/or other coupling structures and the like, etc. For example, in one embodiment, as an option, one or more connections, possibly including one or more TSVs, may be characterized to determine the resistance, and/or any other metrics, parameters, electrical properties, etc. of the connections etc.

For example, in one embodiment, one or more circuits, functions, blocks and/or any other logic etc. may perform tests on, act to test, initiate testing of, etc. one or more connections etc. For example, in one embodiment, as an option, one or more connections, possibly including one or more TSVs, may be tested, probed, examined, etc. to ensure the integrity of the connections (e.g. connectivity, effectiveness of connection, logical connection, etc.). For example, in one embodiment, as an option, one or more circuits etc. may test for failure (e.g. due to failed connections, failed circuits or other components, failed or failing interconnections, faulty wiring and/or traces, intermittent connections, poor solder or other connection joins, manufacturing defect(s), marginal test results, infant mortality, excessive errors, design flaws, etc.) of any connections, interconnections, TSVs, TSV arrays, and/or associated circuits, components etc. of a stacked memory chip (e.g. in production, at start-up, during self-test, at run time, and/or at any time etc.).

For example, in one embodiment, one or more circuits, functions, blocks and/or other logic etc. may act to repair one or more connections. For example, in one embodiment, as an option, one or more connections, possibly including one or more TSVs, may be repaired, replaced, and or otherwise modified to ensure proper connection, connectivity, coupling, etc.

For example, in one embodiment, one or more circuits, functions, blocks and/or other logic etc. may act to replace one or more connections. For example, in one embodiment, as an option, one or more connections, possibly including one or more TSVs, may be replaced, and/or the configuration of connections may otherwise modified, changed, altered, etc. to form proper connections (e.g. logical connections, electrical connections, etc.).

For example, in one embodiment, as an option, one or more circuits, functions, blocks and/or other logic etc. may further act to match connections as part of a repair operation, after a repair operation, and/or at any time, etc. Connections may be matched, for example, as described elsewhere herein and/or in one or more specifications incorporated by reference.

For example, as an option, such repair, repair operations, repair functions, etc. may be effected etc. in one or more steps. For example, as an option, a first step may include the determination, listing, cataloging, etc. of connection capabilities, properties, parameters, options (e.g. repair options, reconfiguration options, etc.) and/or any other connection related parameters, properties, functions, behaviors, etc. For example, as an option, a stacked memory package may be programmed with the capabilities, alternative configurations, number of spare components, number and type of spare TSVs and/or other spare connections, operations etc. to be performed in repair, and/or any other values, parameters, configurations, etc. that may be related to repair operations, repair algorithms, performance of repairs, and the like etc. For example, as an option, as a second step, one or more circuits, functions, blocks and/or other logic etc. may determine, e.g. based on programmed capabilities, etc. which repair scheme, repair operations, repair functions, spare circuits, spare components, repair timing, repair algorithm and/or any other techniques, schemes, etc, related to repair etc. should be used. For example, as an option, a third step may then include one or more circuits, functions, blocks and/or other logic etc. sending, conveying, asserting, transmitting, etc. instructions, messages, configurations, parameters, signals, etc. related to one or more repair operations, repair procedures, repair functions, and the like etc. For example, as an option, a fourth step may include one or more circuits, functions, blocks and/or other logic etc. changing, modifying, programming, configuring and/or otherwise altering one or more connections, interconnections, paths, circuits, etc. in order to perform, effect, implement, etc. one or more repairs etc. Of course, any number of steps, and/or any other steps, functions, etc. may be included in the process to perform one or more repair schemes, repair functions, repair operations, and the like etc. Of course, any other techniques, flows, processes, etc. may be used to effect, implement, etc. any change, modification, alteration, programming, configuration, etc. of connection repair schemes, features, functions, behaviors, and the like, etc.

In one embodiment, for example, a memory system using one or more stacked memory packages may be managed and/or otherwise controlled etc. In one embodiment, for example, one or more supply voltages and/or one or more voltage-related parameters may be managed, controlled, regulated, monitored, limited, altered, modified, changed, programmed, configured, etc.

In one embodiment, for example, a request (e.g. including, but not limited to, management request, control command, signals, etc.) may be received from the CPU etc. For example, the request may be intended to change (e.g. update, modify, alter, increase, decrease, program, reprogram, configure, reconfigure, etc.) one or more supply voltages and/or one or more voltage-related parameters (e.g. reference voltage(s), termination voltage(s), bias voltage(s), back-bias voltages, programming voltages, precharge voltages, emphasis voltages, pre-emphasis voltages, VDD, VCC, VREF, supply voltage(s), voltage multipliers, voltage divisors, combinations of these and/or any other voltage-related parameters and the like etc.). For example, the voltages etc. may supply one or more circuits (e.g. components, buses, links, buffers, receivers, drivers, memory circuits, chips, die, subcircuits, circuit blocks, IO circuits, IO transceivers, controllers, decoders, reference generators, back-bias generators, etc.) in one or more logic chips, one or more stacked memory packages, and/or any other system components, etc. Of course any voltage and/or voltage-related parameters, settings, configurations, modes, values, numbers, etc. may be so changed etc. For example, one or more voltages may be increased, otherwise changed etc. in order to increase speed, reduce latency, and/or otherwise introduce, configure, set, achieve, realize, etc. one or more other benefits etc. For example, one or more voltages may be decreased, otherwise changed etc. in order to reduce power, reduce noise, and/or otherwise introduce one or more other benefits etc. Of course other parameters may be so changed, managed, controlled, etc. For example, in one embodiment, one or more currents (e.g. supply current, reference current, etc.) may be so changed etc. as described.

In one embodiment, for example, any system property, metric, parameter, value, etc. or collection, set, group, etc. of system properties etc. in addition to frequency and/or voltage may be changed, modified, altered, managed, controlled, programmed, configured, etc. Of course any properties etc. (e.g. parameter, number, code, frequency, timing, scheduling, current, resistance, capacitance, inductance, encoded value, index, setting, mode, number, register value, configuration, combinations of these and/or any other similar parameters and the like, etc.) may be included in a system management command, request, signal, scheme, and/or combinations of these and the like etc. Of course any number, type, form, kind, etc. of system management command(s) etc. may be used in any manner, fashion, etc. and/or at any time.

In one embodiment, for example, a request (e.g. including, but not limited to, management request, control command, signals, etc.) to change voltage, voltage-related properties, and/or any other parameters (e.g. current, frequency, resistance, timing, delay, power, etc.) may contain, carry, convey, transmit, include, etc. one or more of each of the following information (e.g. data, fields, parameters, lists, tables, configurations, settings, modes, values, numbers, multipliers, divisors, combinations of these and any other parameters and the like etc.), but is not limited to the following: request ID, tag, identification, etc; parameter(s) to be changed (e.g. change voltage command, command code, command field, instruction, etc.); one or more values (e.g. voltage(s), voltage code(s), voltage identification, index to voltage table(s), any other parameters, values, tables, lists, codes, etc. for current, frequency, resistance, timing, power, etc.); module (e.g. target module identification(s), target stacked memory package number(s), etc.); bus (e.g. first, second, third, etc. bus identification field(s), list, code(s), etc.); any other parameter, fields, flags, and the like etc.

In one embodiment, for example, the stacked memory package may receive a request (e.g. including, but not limited to, management request, control command, signals, and the like etc.). The stacked memory package may determine that the request is targeted to (e.g. is routed to, is intended for, the target is, etc.) itself. The determination may be made, for example, by using, decoding, checking, comparing, etc. the target module field in the request and/or by decoding, checking etc. one or more address fields etc. The logic chip may then determine that the request is a voltage change request, etc.

In one embodiment, for example, the voltages and/or any other properties of one or more system components, circuits within system components, subcircuits, circuits and/or chips within packages, circuits/connections/interconnect that may couple two or more system components etc. may be changed, managed, controlled, altered, modified, programmed, configured, and/or otherwise maintained, etc. in a number of ways, by a number of techniques, and/or by any process, mechanism, etc. For example, in one embodiment, one or more circuits, functions, blocks, etc. possibly including interconnect, interconnect structures, TSVs, TSV arrays, and/or any interconnections, connections, coupling, etc. may be stopped, paused, switched off, disconnected, reconfigured, configured, altered, modified, changed, placed in sleep state(s), powered down, repaired, replaced, swapped, and/or otherwise maintained, etc. For example, in one embodiment, one or more circuits, functions, interconnect, etc. may be partially reconfigured, changed, programmed, modified, altered, repaired, replaced, etc. (e.g. voltages, frequency, connections, connectivity, any other physical and/or logical properties, etc. changed) so that part(s) of circuit blocks, portion(s) of circuit blocks, branches, subcircuits, combinations of these and/or part(s), portion(s) of any circuits, blocks, functions, interconnect, coupling, links, chips, packages, etc. may be reconfigured, altered and/or otherwise modified, changed, etc. while remaining parts etc. may continue to perform (e.g. operate, function, execute, etc.). In one embodiment, the circuits that continue to operate may be placed in one or more alternative modes, configurations, states, etc. For example, the circuits etc. that continue to operate may be paused, placed in a low-power mode, set to a particular state, etc. In this fashion, for example, in one embodiment, a technique, techniques, combinations of techniques, etc. such as that described above (and/or elsewhere herein and/or in one or more specifications incorporated by reference) may be employed, used, utilized, etc. for a bus frequency change, repair operation etc. In this case, for example, in one embodiment, one or more circuits, blocks, functions, etc. may be configured, partially configured, partially reconfigured, programmed, etc. in successive parts (e.g. sets, groups, subsets, portions, etc.), employing one or more stages, using one or more steps, etc. In this case, for example, in one embodiment, one or more circuit(s), block(s), bus(es), interconnection(s), link(s), etc. may remain functional (e.g. continue to function, continue to operate, continue to execute, remain connected, etc.) during configuration, reconfiguration, repair, replacement, programming, and/or during any other operations and the like etc. Of course variations on the techniques described are possible and are contemplated. For example, during one or more such management etc. operations a first set, collection, group, etc. of resources (e.g. circuits, interconnect, buses, links, etc.) may be stopped, paused, disconnected, powered down, switched off, configured, programmed, and/or otherwise modified, changed, altered, etc. while a second set etc. of resources etc. may continue to operate (possibly in a changed state, etc.). Of course any timing, level of control, type of operation, modification of function, alteration of configuration, combinations of these and any other similar operations etc. may be used.

In one embodiment, for example, power management may operate to limit, manage, and/or otherwise control etc. maximum normal power. The maximum normal power may be a maximum limit, threshold, etc. of power consumed by a memory system, parts or portions of a memory system under normal operating conditions with normally expected read, write traffic distributions, for example.

In one embodiment, for example, power management may operate to limit, manage, and/or otherwise control etc. maximum theoretical power. The maximum theoretical power may be a maximum limit, threshold, etc. of power consumed by a memory system, parts or portions of a memory system under any operating conditions. Fore ample, an abnormal traffic distribution of 100% writes etc. may correspond to the maximum theoretical power, but may be unlikely to occur under normal operating conditions for example.

In one embodiment, for example, power management may operate to limit, manage, and/or otherwise control etc. a power virus, thermal virus, and/or other power-based thermal attack, virus, malicious intent, etc. A power virus may be software, firmware, code and/or other programming, configuration, etc. that is loaded, injected, programmed, or otherwise placed in a system to deliberately cause damage through thermal runaway, power overload, voltage droop, and/or other deleterious thermal, power, etc. effects etc.

In one embodiment, for example, power management may operate at the level of macro power management. In one embodiment, macro power management, for example, may be implemented, may occur, be performed, be executed, etc. at the system level and one or more system CPUs and/or other system components may be responsible for managing, maintaining and/or otherwise controlling overall system power. In one embodiment, for example, In one embodiment, macro power management, for example, may be implemented, may apply to a collection, group, set, etc. of one or more stacked memory packages. Such a collection etc. may form a memory module, for example. Thus, for example, the system may act to control, govern, regulate the power dissipation of one or more memory modules, the power dissipation of one or more stacked memory packages included in one or more memory modules, and/or the power dissipation of any function, behavior of any circuit, component, etc. included in any stacked memory package etc.

In one embodiment, for example, power management may operate at the level of micro power management. In one embodiment, micro power management, for example, may be implemented, may occur, be performed, be executed, etc. at the level of the stacked memory package and/or at lower levels including, but not limited to, one or more of the following: at the level of a stacked memory chip, at the level of one or more portions of a stacked memory chip, at the level of a memory class (as defined herein and/or in one or more specifications incorporated by reference), at the level of combinations of these, and/or at any the level of any circuits, components, memory areas, memory regions, address ranges, and the like etc.

In one embodiment, for example, power management may operate at a combination of macro and micro power management. For example, power management at system level may implement, employ, use, etc. any of the mechanisms, techniques, algorithms, etc. described herein to provide, implement, etc. one or more refresh operations etc.

In one embodiment, for example, as an option, the power management system for a system, memory system, stacked memory package, stacked memory chip, etc. may be implemented in the context of the description of any other operations, functions, behaviors, etc. that may affect and/or otherwise relate to power. For example, power management may be implemented in the context of one or more techniques etc. (e.g. using one or more similar techniques, etc.) to manage, control, etc. refresh operations. For example, in one embodiment, it may be beneficial to combine one or more of the techniques described for power management with one or more one or more techniques etc. to manage, control, etc. refresh operations. In one embodiment, for example, as an option, the power management system for a system, memory system, stacked memory package, stacked memory chip, etc. may be implemented in the context of the environment, design, architecture, scheme, etc. of one or more of any previous Figure(s) and/or any subsequent Figure(s) and/or any Figure(s) in one or more specifications incorporated by reference and/or in the context of the text accompanying any Figure. Of course, however, the power management system for a stacked memory package may be implemented in the context of any desired environment, combinations of environments, etc.

In one embodiment, for example, a memory system using one or more stacked memory packages may be managed and/or otherwise controlled etc. In one embodiment, for example, one or more test functions, test commands, test instructions, self-test modes, test modes, and/or any other function, property, behavior, operation, command, instruction, etc. related to test, self-test, built-in self-test, testing, etc. may be managed, controlled, regulated, monitored, limited, altered, modified, changed, programmed, configured, etc.

In one embodiment, for example, a memory system, stacked memory package, any other system components, etc. may include one or more test, self-test, BIST, and/or any type, form of test or test-related etc. features, behaviors, modes, etc. In one embodiment, for example, the memory system may include the ability and/or be operable to capture, read, write, set, store, hold, convey, transfer, copy, move, export, configure, program, set, etc. one or more states and/or state or state-related information, etc. In one embodiment, for example, the memory system may include one or more JTAG features, properties, functions, behaviors, etc. (e.g. using, following, following, etc. one or more standards such as IEEE 1149.1-2001, IEEE 1149.6, and/or combinations of these with any other standards, any other test techniques, functions, behaviors and the like etc). In one embodiment, for example, the memory system may be operable to capture state, transfer state. move state, copy state, and/or otherwise manipulate, store, operate on, etc. state information and the like, etc. In one embodiment, for example, state information may be used to monitor, check, test, etc. one or more logic circuits, interconnections, couplings, memory circuits, combinations of these and the like etc. In one embodiment, for example, state information of (e.g. included in, that is part of, that is embedded in, that is stored in, that is held in, etc.) one or more logic chips, memory chips, and/or any other components etc. may be captured to allow the partial and/or complete memory system state to be recorded, stored, held, etc. (e.g. as a snapshot, checkpoint, etc.). For example, in one embodiment, a JTAG scan chain etc. may be used to capture state information held in memory, registers, buffers, FIFOs, queues, caches, flip-flops, and/or any other storage elements, sequential logic, combinations of these and/or any other storage elements and the like, etc. For example, in one embodiment, such state capture may be used to capture the state of one or more operations (e.g. write commands, etc.) that may be in flight, in progress, in one or more pipeline stages, held or kept in temporary storage, queued, etc.

State information may be partitioned, divided, viewed, etc. as state information associated with, corresponding to, included within, etc. one or more parts, portions, etc. of a system. For example, a system may include one or more system CPUs, one or more stacked memory packages, and/or one or more other system components. Thus, for example, a system CPU and/or other system components etc. may be regarded as having, viewed to posses, considered to include, etc. a state (e.g. single state vector, entire state, complete state, etc.) or set of states (e.g. one of more sets of state vectors, collection of state sets, etc.). Thus, the system CPU etc. may be partitioned, divided, etc. with respect to state etc. and may be regarded, viewed, considered, etc. to have a set of states. Note that any CPU, processor, controller, microcontroller, macro engine, other components and the like etc. that may be used in a stacked memory package (e.g. as part of and/or included in one or more logic chips, etc.) may be handled, treated, processed, viewed, operated on, etc. in a similar fashion, manner, etc. to that described herein with respect to a system CPU, etc. In fact, any circuits, functions, blocks and the like that may be included in a stacked memory package (e.g. as part of and/or included in one or more logic chips, etc.) that may include state, state information, etc. may be so handled etc. In fact, any circuits, functions, blocks and the like that may be included in a memory system that includes state, state information, etc. may be so handled etc. For example, a stacked memory package may be partitioned etc. with respect to state etc. and may be regarded, viewed, considered, etc. to have a set of states. For example, the data held, stored, etc. in one or more stacked memory chips may be regarded as a first set of state information included in a stacked memory package. For example, if an intent, purpose, desire, requirement, etc. is to capture, restore, save, load, reload, store, restore, snapshot, checkpoint, etc. only the data stored within a stacked memory package then the first set of state information may be sufficient, adequate, satisfactory, etc. However, in some situations, in some modes of operations, in some types of systems, etc. it may be beneficial, required, desired, etc. to capture etc. all state information (e.g. including operations in progress, writes in flight, power settings, register settings, any other states, settings, any other state information etc.) in a stacked memory package. In this case, for example, it may be beneficial to capture etc. state information held in memory, registers, buffers, FIFOs, queues, caches, flip-flops, and/or any other storage elements, sequential logic, combinations of these and/or any other types, kinds, forms, etc. of storage elements and the like, etc. In some situations, for example, it may be beneficial, required, desired, etc. to capture etc. all state information in a memory system. Thus, for example, it may be beneficial to capture etc. state information from one or more stacked memory packages, one or more system CPUs, and/or one or more other system components and the like. Thus, for example, the capture etc. of state involving, including, etc. in-flight write operations may include the capture etc. of the state of in-flight write operations in one or more system CPUs (or other similar system components and the like) and/or the capture etc. of state of in-flight write operations in one or more stacked memory packages and/or any other system components, etc.

In one embodiment, for example, state information may be captured etc. from one or more system CPUs, one or more stacked memory packages, one or more logic chips, one or more stacked memory chips, and/or any other system components etc. For example, state capture etc. may include the use of one or more BIST functions, JTAG functions, JTAG scan chains, JTAG commands, data shift operations, memory read operations, register read operations, and/or any other similar test, probe, command, and the like operations, functions, etc.

In one embodiment, for example, state capture etc. may use one or more shift-registers, scan chains, and/or similar clocked circuits etc. For example, it may be beneficial to divide, partition, separate, etc. circuits, functions, blocks etc. that store, hold, keep, carry, etc. state information. For example, it may be beneficial to divide circuits that store state into groups, sets, collections, etc. For example, those circuits that store state associated with, representing, corresponding to, etc. in-flight writes may be divided into a first state set, etc. For example, those circuits that store state associated with, representing, corresponding to, etc. in-flight read responses may be divided into a second state set, etc. In one embodiment, for example, writes may be considered committed once issued by a system CPU, other system component, etc. In this case, on a system failure, error, and/or any other situation in which in-flight writes may not be completed, it may be beneficial to capture, save, etc. the state of in-flight writes as a first state set. Thus, for example, the state of in-flight writes may be restored, recovered, etc. on system recovery, system re-start, and/or any other similar re-try, re-start, etc. operations and the like. For example, restored etc. using the first state set, etc. In this case, for example, it may be required, desired, and/or otherwise beneficial to store, save, capture, etc. the state of in-flight writes as a first state set separately from in-flight read responses as a second state set and/or any other state, states, etc. of any other circuits etc. (e.g. command pipelines, datapath state, etc.) as separate state sets. Thus, in this case, for example, it may be beneficial to divide circuits and/or state information into one or more state sets. In one embodiment, for example, it may be required, desired, and/or otherwise beneficial to restore etc. only in-flight writes. In this case, for example, state capture etc. may be programmed, configured, controlled, etc. to capture only the first state set associated with in-flight writes. In one embodiment, for example, it may be required, desired, and/or otherwise beneficial to restore etc. in-flight writes and in-flight read responses. In this case, for example, state capture etc. may be programmed, configured, controlled, etc. to capture the first state set associated with in-flight writes and the second state set associated with in-flight reads responses. Of course, any number, type, form etc. of state sets may be used. Any technique may be used to program, configure, control, etc. state capture. In one embodiment, for example, a first group of one or more state sets may be captured, a second group of one or more captured state sets may be saved, and a third group of one or more saved state sets may be restored, etc. Thus, it may be seen, for example, that the division of state into one or more state sets may provide one or more restore options, recovery options, and the like etc.

In one embodiment, for example, a system CPU and/or any other system components etc. may trigger and/or otherwise initiate, control, command, etc. state capture, saving of state, storing of state, manipulation of state information, and/or one or more other operations associated with state capture, state sets, and the like etc. For example, a system CPU and/or any other system components etc. may provide, transmit, convey, etc. one or more signals, messages, commands, instructions, etc. to the memory system (e.g. to one or more stacked memory packages, to one or more logic chips in one or more stacked memory packages, etc.). For example, one or more such signals etc. may convey, carry, indicate, etc. that a system failure, error, and/or any other event has occurred, is about to occur, is predicted to occur, will occur, etc. In this case, for example, one or more logic chips, and/or other logic, etc. may initiate, command, control, etc. one or more operations to capture state, save state, and/or any other related, similar, operations and the like etc.

In one embodiment, for example, a stacked memory package (e.g. logic chip in a stacked memory package, etc.) may trigger and/or otherwise initiate, control, command, etc. state capture, saving of state, storing of state, restoring of state, transfer of state, checkpointing, manipulation of state information, and/or one or more operations associated with state capture, state sets, and the like etc. For example, a logic chip etc. may detect an error, fatal error, unrecoverable error, imminent failure, error condition(s), and/or any other event, occurrence, etc. In this case, for example, the logic chip etc. may initiate, command, control, generate, create, signal, etc. one or more operations to capture state, save state, etc. Variations of such techniques to capture, save, restore etc. state, state sets, and/or similar techniques involving state-related operations and the like etc. are possible. For example, a logic chip etc. may signal a system CPU and/or one or more other system components etc. that an error and/or any other event etc. has occurred, may occur, will occur, etc. In this case, for example, the system CPU and/or any other system components etc. may then signal, indicate, etc. to one or more stacked memory packages etc. that state is to be captured and/or saved etc. In one embodiment, for example, one or more logic chips etc. may be configured, programmed, etc. to capture, save, etc. one or more state sets. For example, at start-up, boot time, etc. a system CPU and/or any other system components etc. may program, configure, etc. one or more stacked memory packages (e.g. logic chips, etc.) etc. with those state sets, etc. to be captured, saved, etc. Of course the programming, configuration, etc. of which state sets to be captured, saved, etc. and/or the programming, configuration, etc. of any operations, parameters, and the like that may be associated with, that may be a part or portion of, that may correspond to, etc. one or more state operations or any other state-related behavior etc. may be performed at any time, and in any context, manner, fashion, etc.

In one embodiment, for example, the functions, behavior, operations, etc. associated with system recovery and/or restoring state, one or more state sets, etc. may be controlled, managed, triggered, etc. in a fashion, manner, etc. similar to that described for controlling, managing, triggering, etc. state capture, and/or saving of state, etc. For example, a system CPU and/or any other system component etc. may, at boot time, at start-up, and/or at any time etc. and/or in any manner, fashion, etc. trigger, command, signal, etc. one or more restore operations. For example, a system CPU etc. may transmit, convey, etc. one or more signals, commands, instructions, messages, etc. to a stacked memory package (e.g. to a logic chip, etc.) in order to restore one or more state sets, perform state-related functions, and/or perform, execute, implement, etc. any state-related functions, operations, behaviors, etc. In one embodiment, for example, the system CPU etc. may signal, command, etc. the logic chip etc. to restore one or more state sets. For example, the state set information may be included in a command, in one or more commands, etc. For example, the state set information (e.g. state to be restored, etc.) may be configured, programmed, etc. For example, the state (including but not limited to state sets, multiple states, etc.) to be restored on a restore command/signal, at restore time, and/or at any other time related to a system restore event, recovery event, etc. may be saved, stored, etc. in one or more configuration registers, etc. Of course, the state sets, state capture information, states to be saved, state to be restored, and/or any other state-related information, data, operations, behavior, functions, etc. may be managed, controlled, saved, stored, read, written, saved, manipulated, created, generated, conveyed, transmitted, etc. in any manner, fashion, etc.

In one embodiment, for example, data stored in one or more stacked memory chips and/or logic chips (e.g. in DRAM, in flash, in logic NVM, etc.) may be viewed, regarded, etc. as a state set and/or one or more state sets. Thus, for example, to copy, mirror, replicate, transfer, move, backup, checkpoint and/or perform any other similar copy functions etc. the state (e.g. data contents, information, etc.) in all, part, portions, etc. of one or more memory chips and/or logic chips may also (e.g. in addition to any other state information, state sets, etc.) be captured, saved, restored, recovered, etc.

In one embodiment, for example, one or more operations, techniques, architectures, and/or any other similar functions and the like to copy, mirror, replicate, transfer, move, backup, checkpoint and/or perform any other similar copy functions may be implemented in the context of FIG. 7 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, a checkpoint command may be issued by a system CPU and/or any other system component to cause one or more parts, portions of one or more memory chips to be copied. In one embodiment, for example, one or more memory classes (as defined herein and/or in one or more specifications incorporated by reference) may form a state set. Thus, for example, certain regions of memory, parts of memory, portions of memory, one or more memory chips, combinations of these and/or any parts, portions, etc. of any memory may be programmed to be all or part of a state set, configured to be all or part of a state set, etc. In this case, for example, certain parts, regions, etc. of memory may form one or more state sets, parts of one or more state sets, etc. For example, it may be desired, required, otherwise beneficial etc. to perform one or more operations, functions, etc. to copy, mirror, replicate, transfer, move, backup, checkpoint and/or perform any other similar copy functions on one or more such state sets. For example, a region of memory, a memory class, part of a memory class, etc. may be considered more critical, valuable, important, and/or otherwise different in some aspect etc. In this case, for example, one or more critical etc. areas of memory may be designated, configured, etc. as one or more state sets that may be the subject, object, target, etc. of one or more operations to copy, mirror, replicate, transfer, move, backup, checkpoint and/or the subject etc. of any other similar copy functions. In this manner, for example, a system CPU and/or any other system component may handle, manage, control one or more copy functions, etc. Of course any area, region, section, part, portion, memory class, etc. of any memory, storage, etc. may be so handled, managed, controlled, etc. in the same fashion, manner, etc. Such state sets may be copied etc. in any manner, fashion, etc. using any technique.

In one embodiment, for example, a critical etc. area of memory may be captured using test techniques, shift registers, JTAG, BIST, scan chains, and/or any other state capture related operations, circuits, functions, and the like etc. (e.g. as described above for the capture etc. of state sets involving in-flight commands etc.). For example, in this case, a system CPU, and/or other system component, etc. may issue a command that may correspond to a JTAG command and/or other similar command, instruction, signal, message, etc. In one embodiment, for example, one or more JTAG and/or any other similar commands, and/or other commands, instructions, messages, signals, etc. may be used to manage, control, initiate, trigger, manipulate, etc. one or more operations to copy, mirror, replicate, duplicate, transfer, move, backup, checkpoint, and/or manage etc. any other similar copy functions, operations, behaviors, and the like etc. For example, a system CPU may initiate etc. a checkpoint operation using a JTAG and/or similar command etc. For example, a system CPU may initiate a restore operation using a JTAG or similar command etc. In this case, for example, the JTAG command etc. may interface directly with JTAG and/or any other similar test logic, test functions, BIST functions, and/or other similar test functions and the like etc. In this case, for example, the test functions and the like etc. may be located on one or more logic chips, one or more stacked memory chips, combinations of these (e.g. in a distributed fashion, manner, etc.) and/or in any location etc. In this case, for example, the test logic etc. may be responsible for, be operable to, etc. copy, move, transfer, capture, read, restore, and/or perform any other similar operations etc. on memory data etc. In one embodiment, for example, one or more JTAG or any other commands, instructions, messages, etc. may interface with (e.g. may function as an input, may be coupled to, may control, etc.) the read/write logic, memory controllers, datapaths, and/or any other logic located on one or more logic chips, one or more memory chips, and/or other locations etc. In this case, for example, a system CPU etc. may issue a capture command, and/or other commands, instructions, etc. that may cause one or more state sets that may contain, include, etc. data stored in one or more memory chips, logic chips, etc. to be captured, stored, held, etc. Similarly, a system CPU etc. may issue one or more commands etc. to perform, trigger, initiate, execute, implement, etc. one or more copy operations, checkpoint operations, restore operations, recovery operations, save operations, move operations, transfer operations, and/or any other similar functions, behaviors, operations, and the like, etc. Variations of such techniques to capture, save, restore, etc. state, state sets, and/or similar techniques involving state-related operations and the like etc. are possible. For example, the system CPU may use a first signal to signal one or more logic chips (using any form of command, message, signal, control signals, combinations of these and the like, etc.) and in response to such a first signal etc. the one or more logic chips may initiate, generate, create, modify, alter, process, manipulate, etc. one or more second signals in the form of commands, messages, signals, etc. that may perform or cause to be performed one or more operations to copy, move, transfer, capture, read, restore, etc. memory data etc.

In one embodiment, for example, a system CPU and/or logic chip and/or any other system component etc. may use one or more read commands, one or more special read commands, and/or any form, type, number of commands, instructions, signals, etc. to read (e.g. capture, store, hold, keep, etc.) memory data, state sets, etc. from one or more memories (e.g. parts, portions of stacked memory chips, memory located on one or more logic chips, etc.). For example, a command set (e.g. set of commands, requests, messages, etc. that a stacked memory chip supports, recognizes, etc.) may include a special command that may correspond to state set capture, etc. For example, any other similar commands, instructions, signals, etc. may be used for saving captured state (e.g. in one or more non-volatile memory locations, etc.); moving state, captured state, and/or saved state etc. (e.g. from one or more volatile memory regions, memory classes, etc. to one or more non-volatile memory regions etc.); restoring saved state (e.g. from a non-volatile memory regions to a volatile memory region, etc.) and/or performing any other similar operations, functions, etc. on captured state, saved state, restored state, state sets, and/or any other state or state-related information, data, etc.

In one embodiment, for example, a system may perform, execute, control, manage, etc. a process, algorithm, mechanism, etc. that issues, sends, transmits, etc. one or more state capture commands, messages, control signals, and/or state restore commands etc, and/or any other related commands etc. and the like. For example, the CPU in a system may issue etc. one or more commands etc. in order to capture state, data, information, etc. from a memory system. For example, the state, data, information capture etc. may be part of a checkpointing procedure and/or part of one or more checkpoint operations, etc. For example, one or more checkpoints, checkpoint operations, checkpointing procedures, etc. may be used to load, establish, restore, reload, recreate, etc. parts or all of the system state, data, information, etc. For example, one or more checkpoints etc. may be used, for example, to restore etc. system state etc. after, following, etc. a system failure and/or other similar system event, etc.

In one embodiment, for example, one or more operations, techniques, architectures, and/or any other similar functions and the like to copy, mirror, replicate, transfer, move, backup, checkpoint and/or perform any other similar copy functions may be implemented in the context of FIG. 8 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, a checkpoint command, signal, etc. may be issued by a CPU and/or any other system component to cause one or more parts, portions of one or more volatile memory chips to be copied to one or more parts, portions of one or more non-volatile memory chips. Variations of such techniques to capture, save, restore etc. state, state sets, and/or similar techniques involving state-related operations and the like etc. are possible. For example, checkpoint operations etc. may use any form of non-volatile memory including, but not limited to: logic NVM, CMOS NVM, NAND flash, and/or any non-volatile memory and/or groups, sets, collections, etc. of non-volatile memory. The non-volatile memory may be located in one or more locations (e.g. may be distributed, etc.) including, but not limited to, one or more stacked memory chips, one or more logic chips, and/or any other locations, etc. For example, a checkpoint command, signal, etc. may be generated, created, issued, etc. by one or more logic chips. For example, such a command, signal, etc. may be generated etc. as a result of a timer, external command, external configuration, programming, internal signal, external signal, combinations of these and/or any other signal, command, trigger, event, and the like etc.

In one embodiment, for example, a checkpoint and/or any other command, signal, etc. may be generated on detection of system error, unrecoverable error, and/or any other error, failure, event and the like etc. For example, a CPU may flush data, copy data, copy memory data, and/or perform any other similar operation with state, data, information, and/or any other state-related data, etc. For example, a CPU and/or any other system component may flush, copy, move, save, store, etc. internal data, state, etc. (e.g. in-flight write data, etc.) to non-volatile memory.

In one embodiment, for example, a checkpoint command and/or any other command, signal, etc. may be generated by a stacked memory package on detection of an event such as power failure, component failure, and/or any other failure or similar event etc. In one embodiment, for example, one or more logic chips in a stacked memory package and/or other logic etc. may monitor, measure, sample, etc. one or more voltage levels and/or other power supply metrics, parameters, and/or any system parameter, metric, operation, and the like etc. For example, voltage, current, power, temperature, data errors, and/or any similar system metric may be monitored. In one embodiment, for example, one or more trigger, alert, failure, threshold, etc. levels, values, etc. may be set, programmed, configured, etc. For example, when a temperature reaches a set threshold, one or more actions, procedures, algorithms, mechanisms, processes, etc. may be triggered, initiated, etc. For example, when a temperature reaches a set threshold one or more checkpoint operations, commands, instructions, signals, etc. and/or any other command, signal, etc. may be generated.

In one embodiment, for example, a system error, power event, temperature event, memory system error, unrecoverable error, and/or any other similar event and the like may cause one or more CPUs and/or logic chips and/or other logic etc. to flush state data, state sets, and/or perform any other copy, save, capture, store, etc. operations, functions, etc. on state, state sets, data and/or any other state-related information, etc. For example, when a system error condition (e.g. component failure, power supply failure, predicted failure, imminent failure, possible failure, and/or any other similar system error condition, event, occurrence, situation, scenario, etc.) is indicated, detected, predicted, signaled, etc. all state, state sets, etc. may be captured, saved, stored, etc. For example, such capture etc. operations may be performed in order that a restore operation may be completed when the system is re-started etc. For example, the information, data, etc. associated with, corresponding to, etc. the state, state sets, etc. that are captured, saved, stored, etc. may include all information needed to capture the state of one or more in-process, in-flight, etc. commands, requests, messages, responses, etc. Thus, for example, state capture may include both the state of internal CPU state (e.g. with respect to in-flight writes, writes in one or more CPU pipelines, writes in one or more CPU buffers, and/or internal state etc. information associated with any command, request, etc. being processed by the CPU, etc.) as well as state included in one or more logic chips and/or one or more memory chips, and/or any other CPUs, circuits, functions, logic etc. that may contain state, data, information to be saved etc. Thus, for example, in order to successfully, completely, fully, partially, etc. restore the system, memory system, etc. state on a system failure it may be required, desired, beneficial, etc. to capture some or all state information included in one or more CPUs, one or more logic chips, one or more stacked memory chips, and/or one or more other system components, and/or any other components and the like etc.

In one embodiment, for example, it may be required, desired, beneficial, etc. to save some or all state data, information, etc. associated with one or more write commands and/or other commands, instructions, etc. that may be in-flight (e.g. currently being executed, and/or that may be pipelined, queued, stored, otherwise held, etc.) and/or otherwise in process etc. Thus, for example, the entire contents of a write command, the complete set of information associated with a write command, and/or any other data, information, fields, derived information, etc. may be captured, saved, kept, held, stored etc. e.g. for later restore operations, etc. In this case, for example, a system re-start my allow the write command to be re-started, restored, recreated, etc. Similarly, all state data may be captured, saved, stored etc. for read responses, and/or any other commands, requests, messages, etc.

In one embodiment, for example, it may be required, desired, beneficial, etc. to save a subset of state data associated with one or more write commands that are in-flight etc. For example, it may be required, desired, beneficial, etc. to save one or more tags, ID, identification, etc. that may label and/or otherwise identify a write command, etc. In this case, for example, a list of, manifest of, index of, and/or any other information associated with etc. one or more in-flight write commands and/or any other commands, requests, messages, responses, packets, etc. that were in-flight or otherwise being processed, executed, queued, parsed, pipelined, held, stored, etc. may be created, generated, etc. when a system event (e.g. error, unrecoverable error, predicted failure, etc.) may occur. For example, the list may include a list of tags, ID, etc. Of course any subset(s) of state information, state sets, state data and/or any other state-related information may be so created, managed, manipulated, etc. For example, one or more CPUs, logic chips, etc. may maintain one or more replay buffers and/or similar buffer, register, storage, etc. functions. In this case, for example, a list of tags, ID, etc. may allow the replay buffer contents to be captured, stored, saved, etc. For example, a memory system, stacked memory package, logic chip, and/or any other system component etc. may save, act to save, initiate the saving of, etc. state information before, as part of, etc. performing one or more system operations. For example, state information may be saved before performing one or more repair operations, test operations, self-test operations, calibration, data retry operations, data replay operations, and/or any other similar operations and the like etc.

In one embodiment, for example, one or more operations, techniques, architectures, and/or any other similar functions and the like to checkpoint, copy, mirror, replicate, transfer, move, backup, checkpoint and/or perform any other similar copy functions that may use one or more test, JTAG, BIST, scan chain, etc. functions, etc. may be implemented in the context of FIG. 20-3 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. For example, the test circuits etc. described with reference to FIG. 20-3 of U.S. application Ser. No. 13/710,411, filed Dec. 10, 2012, titled “SYSTEM, METHOD, AND COMPUTER PROGRAM PRODUCT FOR IMPROVING MEMORY SYSTEMS” may be used to perform operations on one or more test requests, commands, etc. from a system CPU and/or any other system component etc. such that a first test request, command, etc. may be translated (e.g. operated on, transformed, changed, modified, split, joined, separated, and/or otherwise altered etc.) and one or more parts, portions, etc. may be forwarded (e.g. sent, transmitted, etc.) as a second test request e.g. to one or more stacked memory chips in a stacked memory package. Of course test and/or any other requests including, but not limited to, checkpoint, copy, mirror, replicate, transfer, move, backup, and/or perform any other similar copy functions may be translated, modified, changed, altered, generated, etc. in any fashion, manner, etc. For example, a checkpoint and/or any other request may be received externally (e.g. as a packet, message, command, etc.) by a logic chip and translated etc. to one or more internal commands, signals, functions, operations, and the like etc.

For example, in one embodiment, one or more checkpoint, copy, mirror, replicate, transfer, move, backup, and/or perform any other similar copy functions may be performed according to a set, programmed, configured, etc. schedule, timing, interval, etc. For example, in one embodiment, the schedule etc. may be set etc. by a system CPU and/or any other system component. For example, in one embodiment, the schedule etc. may be set etc. by a logic chip. Of course, the schedule, timing, etc. may be set etc. by any techniques etc. in any manner, fashion, etc. Of course checkpoint etc. functions, commands, requests, signals, etc. may be triggered, initiated, etc. in any fashion, manner, etc.

In one embodiment, for example, one or more operations, techniques, architectures, and the like that may use one or more checkpoint and/or any other related copy functions etc. may be implemented in the context of FIG. 20-12 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text description. In one embodiment, for example, a copy engine may receive a copy request (e.g. copy, checkpoint (CHK), backup, mirror, etc.) and copy a range (e.g. block, blocks, areas, part(s), portion(s), etc.) of addresses from a first location or set of locations to a second location or set of locations, etc.

In one embodiment, for example, in a memory system it may be required, desired, beneficial, etc. to checkpoint a range of addresses (e.g. data, information, etc.) stored in volatile memory to a range of addresses stored in non-volatile memory. The system CPU and/or any system component may issue a request including a copy command (e.g. checkpoint command (CHK), any other similar command, any other similar request, etc.). For example, the command etc. may include a first address range (e.g. source, etc.) and a second address range (e.g. target, destination, etc.). In one embodiment, for example, the logic chip in a stacked memory package may receive the request and may decode the command. In one embodiment, for example, the logic chip may perform one or more copies (e.g. source to target, source to destination, etc.) using one or more copy engines etc.

In one embodiment, for example, a system CPU and/or any other system component may act to flush, save, store, copy, etc. state, data, information, etc. to NVM included in one or more logic chips in one or more stacked memory packages. In one embodiment, for example, the NVM located on one or more logic chips may include logic NVM, CMOS NVM, and/or other NVM and the like etc.

In one embodiment, for example, a system CPU and/or any other system component may act to flush, save, store, copy, etc. data, information, state, etc. to NAND flash included in one or more stacked memory packages.

In one embodiment, for example, the saved data, information, state, etc. may be saved in a combination of memory technologies, possibly in a combination of locations, packages, components, etc. For example, some or all of the saved data, information, state, etc. may be saved in logic NVM on one or more logic chips, some or all of the saved data, information, state, etc. may be saved in DRAM in one or more stacked memory chips, and some or all of the saved data, information, state, etc. may be saved in NAND flash included in one or more stacked memory packages. For example, one or more stacked memory packages in a memory system may include NAND flash that may be used for saving state, data, information, etc. from other components, stacked memory packages, etc. in the memory system.

Connections and Repair

In one embodiment, the memory system 18-200 may include one or more interconnection, coupling, connection, etc. structures etc. that may use, employ, implement, etc. one or more through-silicon via (TSV) structures, TSV arrays, through-wafer interconnect, interposers, spacers, substrates, redistribution layers (RDLs), C4 bumps, pillars, micropillars, solder bumps, signal traces, PCB traces, conductors, microinterconnect, package-on-package structures, package-in-package structures, multi-chip modules, 3D interconnect structures, face-to-face chip bonding, wafer-on-wafer structures, die-on-wafer structures, die-on-die structures, die stacking structures, vertical interconnect, combinations of these and/or any other similar interconnect, connection, coupling, communicative, etc. structures and the like etc. that may couple, connect, interconnect, etc. in a horizontal direction (e.g. including, but not limited to, across chip, die, wafer, etc.) and/or vertical direction (e.g. including, but not limited to, between chip, die, wafer, etc.), in three-dimensions, and/or in any direction, manner, fashion, etc. For example, a stacked memory package may include such interconnection etc. structures.

In one embodiment, for example, one or more TSV structures etc. may be implemented in the context of FIG. 10 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or as described in the accompanying text.

Of course any other technologies may be used in addition to TSVs or instead of TSVs, etc. For example, optical vias (e.g. using polymer, fluid, transparent vias, etc) or any other connection, interconnect, coupling, etc. (e.g. wireless, magnetic or any other proximity, induction, capacitive, near-field RF, NFC, chemical, nanotube, biological, etc) technologies and the like may be used (e.g. to logically couple, connect, interconnect signals between stacked memory chips and logic chip(s), etc) in any architectures described herein and/or described in one or more specifications incorporated by reference. Of course combinations, variations, etc. of technologies may be used. For example TSVs and/or other low-resistance coupling techniques etc. may be used for power distribution (e.g. VDD, GND, reference voltages, etc) and optical vias and/or other connection technology etc. used for high-speed logical signaling, etc. Of course any number, type, form, kind, etc. of coupling etc. may be used for different purposes, functions, etc.

In one embodiment, for example, one or more TSV structures etc. may be constructed, designed, implemented, architected, etc. in the context of FIG. 19-3 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or as described in the accompanying text.

For example, in one embodiment, the TSVs, TSV arrays, and/or associated interconnect, coupling, etc. may be designed so that the parasitic components (e.g. parasitic resistance, parasitic capacitance, coupling capacitance, etc.) and/or effects (e.g. delay, and/or any other electrical properties, etc.) may be matched. For example, a first connection from a logic chip to one or more stacked memory chips may be matched to a second connection from the logic chip to the one or more memory chips. For example, matching of parasitic components, parasitic effects, etc. may allow the delay of a first signal on a bus to match, closely follow, be nearly equal to, have a known relationship to, etc. a second signal on a bus, etc. For example, matching of one or more properties including (but not limited to) parasitic components, parasitic effects, etc. may allow the delay, average delay, etc. of a first group, set, collection, etc. of signals on a first bus to match, closely follow, be nearly equal to, have a known (e.g. fixed, etc.) relationship to, behave in a similar fashion to, etc. a second group, set, collection, etc. of signals on a second bus. Of course any type, number, form of physical, electrical, and/or any other property (e.g. resistance, length, electrical length, inductance, capacitance, delay, frequency response, impulse response, dispersion characteristics, impedance, transmission line characteristics, signal propagation characteristics, and/or any other electrical parameters, metrics, etc.) may be matched. Of course matching may include making values more nearly equal and/or making one or more values exhibit a fixed, constant or known relationship. For example, matching may include the adjustment etc. of values so that they track (e.g. may vary but in concert, in a fixed relationship, etc.). For example, values may be matched so that the values track with changes in temperature, voltage, etc. Thus, for example, matching may be made, implemented over a range of temperature, voltage, and/or some other parameter, etc. Thus, for example, two values v1 and v2 may be matched such that v1 equals v2 (or nearly equals, equals to within some error, etc.). Thus, for example, two values v1 and v2 may be matched such that v1 equals k*v2 (or nearly equals, equals to within some error, etc.) where k may be a constant, etc.

In one embodiment, for example, bus, interconnect, and/or any other coupling structures may be used to couple a logic chip to one or more stacked memory chips, etc. Thus, in this case, for example, referring to the stacked memory package shown in FIG. 18-2, a first set of one or more connections may be made from a logic chip (chip 0) to stacked memory chip, chip 1, and a second set of one or more connections may be made from a logic chip (chip 0) to stacked memory chip, chip 4. Similar sets of connections may be made to chip 2 and chip 3. For example, it may be required, desired, beneficial, etc. to match the first and second set of connections. Similarly, it may be required, desired, beneficial etc. to match one or more other sets of connections (e.g. from chip 0 to chip 2, from chip 0 to chip 3, etc.). For example, it may be required, desired, beneficial, etc. to match the delay, timing skew, and/or any other timing parameter, timing-related aspect, etc. of one or more clock signals, enable signals, control signals, data signals, address signals, termination control signals, bus control signals, and/or any other signals etc. that may be transmitted from the logic chip to one or more stacked memory chips and/or transmitted from one or more stacked memory chips to a logic chip, etc. In this case, for example, the physical distances, separations between connecting points (e.g. distances between end points of connections, and/or distances between similar intermediate connections points, etc.), conductor lengths, etc. may be different between the first set of connections between chip 0 and chip 1 and the second set of connections between chip 0 and chip 4. In this case, for example, the parasitic elements (e.g. resistance, capacitance, etc.) may be different between the first set of connections between chip 0 and chip 1 and the second set of connections between chip 0 and chip 4. Thus, for example, in this case, it may be beneficial to modify the topology, materials, conductor arrangement, shape, length, area, cross-section, and/or one or more of any other electrical, physical, etc. properties of one or more parts, pieces, segments, portions, etc. of one or more of the connections between chips. Thus, in the case of the above example, the topology, materials, conductor arrangement, shape, length, area, cross-section, and/or one or more of any other electrical, physical, etc. properties of the first set of connections may be altered, modified, changed, designed, tailored, programmed, configured, and/or otherwise arranged differently from the second set of connections such that the physical and/or electrical properties of the first and second set of connections match, more closely match, have a known (or fixed, etc.) relationship to each other, and/or are made more similar with respect to delay, timing and/or any other physical, electrical parameter, aspect, property, etc.

In one embodiment, for example, a connection between stacked chips (e.g. between a logic chip and one or more stacked memory chips, etc.) may include one or more segments. For example, a connection segment or segment may include one or more parts, portions, pieces, etc. of a connection. For example, a segment may include one or more of each of the following (but not limited to the following): a length of metal trace on a chip, a TSV, a PCB trace, a substrate trace, a solder ball, a bump, a via, and/or any other part, portion, piece of interconnect, coupling, connection and the like etc. Thus, for example, in order to match connections it may be beneficial to add, adjust, tailor, modify, and/or otherwise later one or more segments of a first set of connections in order to match, more closely match, etc. to a second set of connections, etc. Thus, for example, in one embodiment, one or more extra segments, parts, portions, etc. may be inserted in a first set of connections in order to match to a second set of connections. Thus, for example, in one embodiment, one or more similar segments (e.g. segments in a first set of connections that correspond to segments in a second set of connections, etc.) may be modified, changed, altered, and/or otherwise made different in some aspect etc. in the first set of connections in order to match to a second set of connections, etc.

In one embodiment, for example, one or connections, one or more sets of connections, and/or any coupling, etc. may be used as spare, redundant, replacement, etc. connections and/or otherwise used for repair, etc. In this case, for example, it may be required, desired, beneficial, etc. to match the spare elements (e.g. connections, coupling structures, etc.) to the elements to be replaced, repaired, etc. For example, it may be required, desired, etc. to replace a first set of connections with a second set of connections. In this case, for example, it may be required, desired, beneficial to match the second set of connections with the first set of connections. Techniques such as those described above, elsewhere herein, and/or in one or more specifications incorporated by reference may be used to perform, effect, implement, program, configure, etc. such matching etc. In one embodiment, for example, matching may switch in, connect, add, disconnect, etc. one or more segments. In one embodiment, for example, matching may modify, alter, change, etc. one or more segments (e.g. alter resistance, etc.).

In one embodiment, for example, matching etc. may be performed as part of one or more other operations, etc. For example, matching of one or more connections, coupling, interconnect, etc. may be performed as part of one or more repair operations, etc. For example, one or more repair operations may introduce new connections, components and the like etc. and/or introduce new paths, routes, segments, TSVs, and the like etc. and/or may similarly remove connections etc. and/or otherwise change the properties etc. of one or more connections etc. For example, in this case, matching may be performed as part of, and/or after repair operations etc.

For manufacturing and cost reasons it may be important that each of the stacked memory chips in a stacked memory package are identical and/or may be manufactured, processed, fabricated, assembled, etc. in an identical, or closely identical fashion, manner, etc. However, it may be that buses, connection, sets of connections, etc. between one or more stacked chips may not have the same equivalent circuits, physical properties, electrical properties, delay, parasitic elements, parasitic components, etc. It may be, for example, that in a finished article, not all components, connections, paths, etc. are identical or can be made, manufactured, assembled, fabricated, processed, etc. to be identical. Thus for example, a first bus may have only one TSV while a second bus may have more than one TSVs. It may be required, desired, beneficial, etc. to match the electrical properties of the first bus and the second bus. Of course it may be required, desired, beneficial, etc. to match any components, circuits, connections, paths, combinations of these and/or match any other similar, related, etc. objects and the like etc.

For example, one or more buses etc. may be used to drive logic signals from a logic chip to one or more stacked memory chips. Because buses may not have the same physical structure their electrical properties may differ. Thus for example, a first bus may have a longer propagation delay (e.g. latency, etc.) and/or lower frequency capability (e.g. higher parasitic impedances, etc.) than a second bus. For example, buses may be constructed (e.g. wired, laid out, shaped, etc.) so as to reduce (e.g. alter, ameliorate, dampen, etc.) the difference in electrical properties or match electrical properties between different buses. For example, one or more buses may be viewed, regarded, divided, partitioned, etc. such that it may have two portions. A first bus, for example, may have a first portion that connects a logic chip to a second stacked memory chip through a first stacked memory chip (making an electrical connection between the logic chip and second stacked memory chip, but making no electrical connection to circuits on the first stacked memory chip). The first bus, for example, may have a second portion that connects to one or more other stacked memory chips (but makes no electrical connection to circuits on any other chip). For example, the two portions may be constructed in an attempt to match the lengths of all similar connections that may connect the logic chip to each of the stacked memory chips (e.g. the connections from logic chip to the second stacked memory chip may be constructed so as to try and match the connections from logic chip to first memory chip, etc.).

In one embodiment, for example, a circuit, interconnect path, extra segment, etc. may be inserted between the first and second portions of each bus. In one embodiment, for example, the circuit etc. may include wiring (e.g. connection, trace, metal line, etc.) on a stacked memory chip. In the above example, a bus may use wiring on the second stacked memory chip to connect, couple, etc. the first and second portions of the bus. The wiring, matching segments (e.g. extra, additional, modified, altered, changed, etc. segments used for matching purposes, etc.), and/or any other modified, changed, tailored, configured, programmed, etc. segments, connection parts, interconnect portions, interconnect components, etc. that may be used in, inserted in, employed in, designed into, etc. one or more buses, bus parts, bus portions, etc. (e.g. segments, parts, portions of buses that together make up a bus, etc.) that may form part of any other buses, bus portions, etc. may be referred to as RC adjust. For example, the value of the components in an RC adjust segment may be used to match the electrical properties of buses that use TSVs.

In one embodiment, for example, the electrical properties (e.g. timing, impedance, etc.) of buses may be more closely matched using such techniques as described above, elsewhere herein, and/or in one or more specifications incorporated by reference. Note that when a bus is referred to as matched (or reference is made to match or matching properties of a bus, etc.), it may mean, indicate, etc. that one or more electrical properties of one conductor etc. in a bus are matched to one or more of any other conductors in that bus. Of course, conductors may also be matched between different buses, etc. TSV matching as used herein may mean that buses, connections, interconnect, paths, etc. that may use one or more TSVs may be matched. For example, TSV matching may be improved by using one or more RC adjust segments. For example, the logical connections (e.g. take off points, taps, etc.) may be different (e.g. at different locations on the equivalent circuit, etc.) for one or more buses. In one embodiment, for example, by controlling the value of one or more RC adjust segments (e.g. adjusting, designing different values at manufacture; controlling values during operation; etc.) the timing (e.g. delay properties, propagation delay, transmission line delay, etc.) between each bus may be matched (e.g. brought closer together in value, equalized, made nearly equal, etc.) even though the logical connection points on each bus may be different. This may be understood, for example, by considering the case that the impedance of an RC adjust segment (e.g. equivalent resistance and/or equivalent capacitance, delay, etc.) may be so much larger than a TSV that the TSV equivalent circuit elements are negligible (e.g. negligible in effect, introduce negligible delay, etc.) in comparison with the RC adjust segment circuit elements. In this case, for example, the electrical circuit equivalents for buses may become identical (or nearly identical, identical in the limit, closely equal, etc.). In one embodiment, for example, implementations may choose a trade-off between the added impedance of an RC adjust segment and the degree of matching desired (e.g. amount of matching, equalization, etc. desired; matching error desired; etc.).

Variations, alternative techniques, additional techniques, etc. may be used as alternatives to, in combination with, etc. TSV matching. In one embodiment, for example, an arrangement, design, topology, layout, structure, architecture, etc. for a first bus may be constructed, assembled, viewed as a transformed version (e.g. folded, compressed, mirrored, and/or otherwise structured, etc.) of the arrangement etc. of a second bus. In one embodiment, for example, one or more RC adjust segments, matching segments, etc. may also be included in the arrangement of the first and/or second bus. Of course any variations, alternative techniques, additional techniques, etc. may be used to perform matching etc. of any components including, but not limited to, one of more of the following: buses, bus conductors, bus traces, interconnect segments, contacts, connection paths, path segments, path sections, vias, TSVs, package connections, package traces, PCB traces, combinations of these and/or any other conductors, wires, paths, and the like etc.

In one embodiment, for example, the folding, compression, mirroring, and/or other structuring etc. of more TSV structures, buses employing TSVs, etc. may be implemented, architected, designed, etc. in the context of FIG. 19-3 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or as described in the accompanying text.

In one embodiment, for example, the selection of TSV matching techniques, arrangements, layout, etc. may include a dependence on, for example, TSV properties. Thus, for example, if TSV series resistance is very low (e.g. 1 Ohm or less) then the use of the RC adjust technique described may not be needed. To understand this situation consider the case that the TSV resistance is zero. Then, in this case, either a first arrangement with no RC adjust or a second arrangement with RC adjust will match buses almost equally with respect to parasitic capacitance.

Variations, alternative techniques, additional techniques, etc. may be used as alternatives to, in combination with, etc. the technique(s) of using one or more matching segments, RC adjust segments, performing adjustment(s), implementing adjustment(s), inserting adjustment(s), adjusting, etc. In one embodiment, for example, a matching segment, RC adjust segment, adjustment, etc. may use components in addition to resistors and/or capacitors. Thus, for example, an RC adjust segment may be more generally used as an impedance adjust segment and/or delay adjust segment (that may also be referred to as an adjustment, etc.).

In one embodiment, for example, an impedance adjust segment, adjustment, trim, etc. may use any combination of passive components e.g. including, but not limited to, resistors, capacitors, inductors, and/or including the parasitic resistance, parasitic capacitance, parasitic inductance of components etc. A passive component may be any passive, linear, lossless, two-port electrical network element (e.g. including gyrator, etc.). For example, an impedance adjust segment may match inductance properties, values, parameters without using a discrete, wound, specific, actual, etc. inductor by using the parasitic, inherent, etc. values of inductance (e.g. including self inductance, mutual inductance, any other inductive effects, etc.) of a component (e.g. of a connection path, conductive trace, via, TSV, and/or any other component, part, portion, piece, segment, path, etc. of interconnect, connection, coupling, trace, path, conductor, etc.). In a similar fashion, manner, using similar techniques, etc. an impedance adjust segment may match capacitance and/or resistance. In one embodiment, for example, it may be beneficial to match the dominant impedance, largest effect, most important effect, etc. Thus, for example, if the delay needed, required, desired, etc. to match two paths etc. is dominated by, dictated by, largely determined by, etc. a resistance and capacitance then an impedance adjust segment may be used that may largely be used to match resistance and capacitance, etc. Note that delay etc. may be a complex, complicated, etc. function of the equivalent circuit of an impedance adjust segment, the arrangement of conductive paths within an impedance adjust segment, the physical structure (e.g. in the case of the use of TSVs, vias, etc.) of an impedance adjust segment and/or physical structure of the connections, buses, paths, vias, etc. to be matched etc. Thus, for example, the design, use, etc. of one or more impedance adjust segments, etc. may not necessarily require, involve, need, etc. the matching of any specific capacitance, resistance, inductance, etc. value between two paths, buses, connections, segments, etc. to be matched. For example, the design of matching segments, etc. may involved the overall optimization, design, etc. of delay and/or any other electrical properties, physical properties, etc. of the matching segments and their effects on the delay etc. of the paths etc. to be matched. For example, bus A may have an extra, additional, etc. delay of 1 ns with respect to bus B. The extra delay of bus B may be due to one or more extra (bus, trace, path, etc.) segments, extra TSVs, and/or any other component(s), extra trace length(s), etc. with (effective, parasitic, etc.) resistance 1 kiloOhm and capacitance of 1 picoFarad, for example (e.g. an effective, equivalent, extracted, etc. resistance of 1 kiloOhm in series with the connection and a effective, equivalent, extracted, etc. capacitance of 1 picoFarad to ground, etc.). In one embodiment, for example, an impedance adjust segment may be added to bus A in order to match bus B. For example, the impedance adjust segment may introduce a (nominal, designed, average, effective, etc.) delay of 1 ns. For example, the impedance adjust segment may include an effective series resistance of 1.1 kiloOhm and effective capacitance of 0.9 picoFarad, etc. Thus, it may be seen, for example, that an impedance matching segment and/or any matching segment(s) etc. do not necessarily have to have the same component values, effective component values, etc. as the segments etc. to be matched (but they may have the same values, same nominal values, etc.).

In one embodiment, for example, a delay adjust segment may use any combination of one or more passive components (e.g. as described above, elsewhere herein and/or in one or more specifications incorporated by reference, etc.) and/or one or more active components (e.g. transistors, op-amps, and/or any other active components, circuits, and the like etc.). A delay adjust segment may use any type, form, number of passive and/or active components, including, for example, one or more active components used to simulate, emulate, etc. a passive component. For example, one or more active components, circuits, etc. may be used to simulate, emulate, etc. an inductor, inductance, inductive effects, etc.

In one embodiment, for example, delay may be adjusted, programmed, configured, altered, modified, changed, tailored, etc. by switching in (and/or switching out) extra components, segments, adjustments, etc. For example, additional, extra, components (e.g. resistors, capacitors, inductors, components with complex impedance values, TSVs, via, conductive paths, traces, and/or any other parts, pieces, portions of interconnect etc.) may be connected in series, parallel, series/parallel, etc. to form one or more matching elements, matching segments, RC adjust segments, impedance adjust segments, delay adjust segments, etc.

Note that matching may use, employ, match, etc. similar and/or dissimilar components, circuits, elements, paths, etc. Thus, for example, delay etc. caused by, due to, effected by, etc. component(s) X in bus, connection, path, etc. A may be matched by component(s) X and/or Y in bus B, etc. Thus, for example, a first number of one or more copies of component Y may be used to match, emulate, simulate, mimic, etc. one or more properties of a second number of one or more copies of component X, etc. For example, in one embodiment, one or more extra TSVs in a first connection may be matched by inserting extra TSVs and/or extra path length(s), etc. in a second connection, etc. Of course, any number, type, form, part, portion, piece, etc. of a first component, connection, bus, interconnect, path, via, etc. may be matched etc. by any number, type, form, part, portion, piece, etc. of a second component etc. For example, delay etc. caused by, due to, effected by, implemented by, etc. any first number(s), type(s), form(s), arrangement(s), topology, etc. of one or more component(s) P, Q in bus, connection, path, etc. A may be matched by any second number(s), type(s), form(s), arrangement(s), topology, etc. of one or more component(s) P, Q, R, S in bus, connection, path B, etc.

For example, in one embodiment, the choice, design, programming, configuration, etc. of the use of matching components, adjustments, trimming, etc. may vary depending on resources available, matching desired, and/or any other factors, parameters, etc. For example, in one embodiment, in the above case, a choice may be made between using extra TSVs and/or extra path lengths etc. depending on the tolerance of matching (e.g. of delay, etc.) required, desired, etc. For example, in one embodiment, in the above case, one or more TSVs may be added to provide, produce, etc. an (initial, approximate, first-order, coarse adjust, etc.) match, adjustment, etc. and/or one or more parts, pieces, portions of extra path(s), segment(s), conductor(s), circuit(s), device(s), and the like etc. may be added to provide a trim, trimming, fine adjust, control, etc. function, capability, etc. Of course, matching, trimming, programming, configuration, adjustment, etc. of one or more matching segments, matching connections, matching paths, matching conductors, matching buses, matching components, matching circuits, matching effects, and/or any other matching related functions, behaviors, properties, designs, adjustments, and the like may be implemented, designed, architected, made, performed, executed, adjusted, etc. at any time and/or in any context, manner, fashion, etc.

In one embodiment, for example, TSVs may be co-axial with shielding. In one embodiment, for example, the use of co-axial TSVs may be used to reduce parasitic capacitance between bus conductors for example.

Inductive parasitic elements, and/or any other inductive elements, etc. may be modeled in a similar way to the modeling of parasitic capacitance, parasitic resistance, etc. as described above, elsewhere herein, and/or in one or more specifications incorporated by reference. In one embodiment, matching, TSV matching, etc. as described above for example, may also be used to match inductive elements. Of course any electrical (e.g. resistance, capacitance, inductance, complex impedance, etc.), physical (e.g. length, width, area, depth, height, etc.), layout, parasitic, timing, frequency, time domain, frequency domain, combinations of these and/or any other properties, aspects, parameters, metrics, functions, behaviors, and the like etc. (physical and/or electrical, etc.) of interconnect, coupling, sets of connections, buses, signal traces, TSVs, TSV arrays, and/or similar connections and the like may be matched using techniques, adjustments, designs, architectures, layout, structures, etc. shown above, elsewhere herein and/or in one or more specifications incorporated by reference, etc. Physical properties (e.g. of interconnect, connections, components, etc.) may include, but are not limited to: number, length, width, height, depth, volume, shape, area, cross-section, size, combinations of these and the like etc. Electrical properties (e.g. of interconnect, connections, and/or any other components, etc.) may include, but are not limited to, one or more of the following: (parasitic) capacitance, (parasitic) resistance, (parasitic) inductance, equivalent circuits, characteristic impedance and/or any other transmission line characteristics, complex impedance (e.g. real and imaginary impedance), frequency response, delay, impulse response, linearity, loss, radiation impedance and/or any other frequency, radio-frequency, etc. characteristics, combinations of these and/or any other similar characteristics and the like etc.

In one embodiment, for example, buses, connections, interconnect, sets of connections, etc. may be made up of any type of coupling and/or connection in addition to TSVs (e.g. paths, signal traces, PCB traces, conductors, microinterconnect, solder balls, C4 balls, solder bumps, bumps, via chains, via connections, any other buses, combinations of these, and the like etc.). Of course TSV matching methods, techniques, and systems employing these may be used for any arrangement of buses using TSVs. In one embodiment, for example, TSV matching may be used in a system that uses one or more stacked semiconductor platforms to match one or more properties (e.g. electrical properties, physical properties, length, parasitic components, parasitic capacitance, parasitic resistance, parasitic inductance, transmission line impedance, signal delay, etc.) between two or more conductors (e.g. traces, via chains, signal paths, any other microinterconnect technology, combinations of these and the like, etc.) in one or more buses (e.g. groups or sets of conductors, etc.) that use one or more TSVs to connect the stacked semiconductor platforms. In one embodiment, for example, TSV matching may use one or more RC adjust segments (and/or any other matching techniques, adjustment techniques, adjustments, etc. as described above, elsewhere herein and/or in one or more specifications incorporated by reference) to match one or more properties between two or more conductors of one or more buses that use one or more TSVs. In one embodiment, for example, the power delivery system (e.g. connection of power, ground, and/or reference signals, etc.) of a stacked memory package etc. may be challenging (e.g. difficult, employ optimized wiring, etc.) due to the large transient currents (e.g. during refresh, etc.) and high frequencies involved (e.g. challenging signal integrity, etc.). In one embodiment, TSV matching may be used for power, ground, and/or reference signals (e.g. VDD, VREF, GND, etc.).

Note that matching may be applied at any level, hierarchical level, level of datapath, etc. For example, a signal SA1 may be sent on a first path, bus, connection, etc. A1 from a logic chip to a stacked memory chip with delay DA1. For example, a signal SB1 may be returned on a second path, bus, connection, etc. B1 from a logic chip to a stacked memory chip with delay DB1. The overall delay that may be desired to be matched may be DA1+DB1, for example. Thus, for example, a signal SA2 may be sent, transmitted, etc. on a path, bus, connection, etc. A2 from a logic chip to a stacked memory chip with delay DA2; and a signal SB2 may be returned, transmitted, etc. on a path, bus, connection, etc. B2 from a logic chip to a stacked memory chip with delay DB2. Thus it may be required, desired, beneficial, etc. to match delay DA1+DA2 to delay DB1+DB2, for example. In one embodiment, for example, delay DA1 may be matched to delay DB1 (e.g. by adding adjustments to path etc. A1 and/or path etc. B1, etc.); and delay DA2 may be matched to delay DB2 (e.g. by adding adjustments to path etc. A1 and/or path etc. B1, etc.). In one embodiment, for example, the overall delay DA1+DA2 may be matched to delay DB1+DA2 (e.g. by adding adjustments in a fashion, manner etc. so that delay DA1 may not necessarily match delay DB1 and/or delay DA2 may not necessarily match delay DB2, etc.). Of course, any number, type, form, kind, arrangement, topology, level of hierarchy, etc. of buses, connections, signal paths, delays, etc. may be matched at any time in this fashion, manner, using these and/or similar, related, etc. techniques and the like etc.

Note that matching does not necessarily have to make a physical property and/or electrical property equal, nearly equal, similar, etc. For example, it may be required, desired, beneficial, etc. to introduce, design, program, configure, set, etc. a difference, a delta, a change, a ratio, etc. and/or to create tracking, etc. between physical, electrical properties, parameters, metrics, characteristics, aspects, values, etc. Thus, for example, it may be desired, required, beneficial, etc. to make, design, program, configure, etc. one or more paths, connections, components, etc. to be dissimilar rather than similar, etc. For example, in one embodiment, it may be required, desired, beneficial, etc. to stagger the arrival times of one or more signals (e.g. on one or more signal paths, on one or more buses, etc.). Such a design may be useful in reducing power supply noise and/or any other forms of interference, noise, unwanted coupling, etc. In this case, a matching (e.g. one choice of matching, etc.) of path A to path B may result in the deliberate addition of a (differential, e.g. with respect to path A, etc.) delay to path B, for example, in order to make, effect, design, program, configure, etc. a difference (e.g. in delay, etc.) between path A and path B. Of course any form, type, etc. of matching (e.g. equalization of delay, equalization of electrical and/or any other properties, introduction of delay and/or any other parameter, property, aspect, etc.) may be used at any time and/or in any manner, fashion, etc. and/or using any techniques, combinations of techniques, etc.

In one embodiment, for example, the differential aspects, properties, behaviors, functions, etc. of one or more connections, circuits, components, paths, etc. may be controlled, managed, programmed, configured, etc. For example, the differential delay of paths A and B may be controlled etc. In this case, the differential delay of paths A and B may be the difference in delay between path A and the delay of path B (e.g. the delay of path A minus the delay of path B, etc.). Note that, in some cases for example, path A and path B may themselves consist of paths, intermediate circuits, components, vias, TSVs, connections, etc. each of which themselves may have delay(s), etc. In one embodiment, for example, one or more differential aspects etc. may be controlled etc. to be zero, close to zero (e.g. aspects may be equal, closely equal, similar, matched, etc.). In one embodiment, for example, one or more differential aspects etc. may be controlled etc. to be a fixed and/or variable amount, number, value, etc. (e.g. one or more aspects may be different, unequal, dissimilar, etc.). In one embodiment, for example, a first number of one or more differential aspects etc. may be controlled etc. to be zero etc. and a second number of differential aspects etc. may be controlled etc. to be non-zero etc. In one embodiment, for example, one or more differential aspects etc. may be controlled etc. to differ by a fixed amount. In one embodiment, for example, one or more differential aspects etc. may be controlled etc. to track (e.g. with temperature, with voltage, etc.). In one embodiment, for example, one or more differential aspects etc. may be controlled etc. to a fixed ratio. Thus, for example, the delay of path A may be controlled to be a fixed ratio with respect to the delay of path B, etc. In general, for example, one or more differential aspects etc. may be controlled etc. to be any number, value, parameter, range of values, etc. (e.g. including zero, etc.). Differential aspects (e.g. of paths, connections, sets of paths, circuits, vias, TSVs, coupling, logical paths, datapaths, parts of these, portions of these, combinations of these and/or any other parts, portions, pieces, etc. of one or more buses, signal paths, etc.) may include, but are not limited to: delay, resistance, capacitance, inductance, parasitic values, complex impedance, frequency response, impulse response, combinations of these and/or any other parameter, metric, etc.). Of course matching etc. may be made between any number of connections, paths, couplings, and/or any other components, other objects and the like etc. in any number of buses or similar sets, collections, groupings, etc. of connections, other objects and the like etc.

In one embodiment, for example, a system may employ, use, implement, etc. a closed-loop feedback circuit, function, etc. with a reference value. Of course, any number, type, form, kind, arrangement, architecture, etc. of feedback circuit, function, etc. may be used. For example, a feedback system may be used to manage, calibrate, maintain, track, fix, vary, alter, modify, change, control, etc. one or more electrical parameters. For example, a feedback system may be used to manage etc. the resistance, delay, and/or one or more other properties of one or more connections, etc.

In one embodiment, for example, a system may characterize, measure, probe, evaluate, and/or otherwise test etc. one or more components, connections, and the like etc. In one embodiment, for example, a system may use a pseudo-random binary sequence (PRBS) to measure the frequency characteristics, impulse response, connectivity, and/or other electrical properties of a connection, parts of a connection, parts of a TSV array, and/or any other connections, path, route etc. For example, by correlating the response of a circuit, connection, etc. to multiple delayed versions of a PRBS with the original PRBS, the impulse response and/or an approximation to the impulse response of a circuit etc. may be formed. The frequency, delay, etc. properties of a circuit etc. may then be derived, calculated, interpolated, and/or otherwise formed from the impulse response characteristics etc. In one embodiment, for example, a system may test, quantify, measure, probe, etc. the integrity (e.g. suitability for intended purpose, etc.) of one or more connections, paths, interconnects, TSV arrays, TSV connections, etc. Of course any similar digital, analog, or any other form of waveform, signal, sequence, etc. may be used in a similar fashion, etc.

In one embodiment, for example, a system may adjust, control, modify, change, and or otherwise alter etc. one or more circuits, connections, components, etc. For example, adjustment etc. may be made based on one or more characterization operations, etc. For example, connections may be adjusted, tuned, changed, modified, altered, programmed, configured, reconfigured, etc. based on one or more characterization operations, etc. For example, the resistance, delay, and/or any other property etc. of a connection, interconnect, circuit, component, etc. may be adjusted etc.

In one embodiment, for example, a system may test, probe, characterize, etc. one or more circuits, interconnects, connections, couplings, paths, etc. as part of one or more repair operations. For example, a logic chip in a stacked memory package may test etc. one or more connections using, employing, implemented with, etc. one or more TSVs. In one embodiment, for example, a system may test etc. connections etc. to determine whether repairs etc. should be made. In one embodiment, for example, a system may diagnose faulty, potentially faulty, failing, etc. connections etc. to determine whether repairs etc. should be made. In one embodiment, for example, a system may test one or more spare circuits, connections, TSVs, TSV arrays, combinations of these and/or any other components and the like etc. to determine which components etc. may be used in repair operations. Testing, characterization, probing, measurement, etc. may be carried out, performed, initiated, etc. at any time and in any manner, fashion, etc.

In one embodiment, for example, one or more TSV structures etc. may be used to allow dynamic sparing, memory sparing, replacement, etc. implemented in the context of FIG. 19-14 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or as described in the accompanying text.

In one embodiment, for example, one or more TSV arrays etc. may be implemented in the context of FIG. 21-10 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or as described in the accompanying text.

In one embodiment, for example, one or more TSV arrays etc. may be implemented in the context of FIG. 24-5 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or as described in the accompanying text.

In one embodiment, for example, one or more TSV arrays etc. may be implemented in the context of FIG. 25-3 of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and/or as described in the accompanying text.

In one embodiment, for example, one or more TSV arrays, TSVs, connections using TSVs, and/or any connection, interconnect, path, route, circuit, etc. may be replaced using one or more repair operations, etc. For example, connections etc. may be replaced using one or more spare connections etc.

In one embodiment, for example, one or more TSV arrays, TSVs, connections using TSVs, and/or any connection, interconnect, path, route, circuit, etc. may be swapped, reconfigured, reprogrammed, rearranged, reconfigured, etc. In one embodiment, for example, it may be beneficial to swap connections to improve signal integrity, reduce coupling noise, and/or for any other beneficial reasons, to effect other improvements, etc.

In one embodiment, for example, one or more TSV arrays and/or other connection structures etc. may be replaced in a hierarchical fashion, manner, etc. For example, there may be four similar connections C1, C2, C3, C4 that may be a part of a circuit, block, function, etc. B1. In this case, for example, connections C1 and C2 may fail, be faulty, test as faulty, be predicted to fail, etc. and/or be desired to be repaired, replaced for any reason. In this case, for example, connections C1 and C2 may be replaced by spare connections etc. SC1 and SC2. In this case, for example, a third connection C4 may fail. In this case, for example, there may be no more spare connections or the supply of spare connections may be below a pre-determined, programmed, configured threshold etc. In this case, for example, the repair of C4 may involve the replacement of block B1 by a spare block, SB1. Of course repair, replacement, etc. may be made with any number, type, form, kind, etc. of spare components, circuits, connections, etc. arranged in any hierarchical fashion, manner, etc. Such repair, replacement, etc. may be made at any time and/or in any manner, fashion, etc.

In one embodiment, for example, in-place repair, dynamic repair, dynamic sparing, static repair, replacement, and/or any other repair related operations etc. may trigger, effect, initiate, control, etc. one or more other system operations. For example, repair operations etc. may act to pause, stop, slow down, and/or otherwise modify, alter, change, etc. the functions, behavior, timing etc. of one or more system operations etc. For example, repair operations may cause modification of datapath operations and slow down, pause, and/or otherwise throttle, regulate, govern, etc. operations such as memory access (e.g. to the memory region(s) being repaired, replaced, etc.).

In one embodiment, for example, in-place repair etc. may involve the copying of data, use of temporary memory regions etc. For example, a stacked memory package may include three memory regions: A, B, C. For example, it may be desired, required, etc. to repair, replace etc. memory region A. In order to perform this repair etc. it may be necessary to temporarily disable, remove, disconnect, memory region A and/or otherwise effect the ability of the system to access memory region A etc. In this case, for example, as a first step, memory region A may be copied to memory region B. In a second step, memory region A may be replaced by spare memory region C. In a third step memory region B may be copied to memory region C. In a fourth step, memory region C may be activated and replace the functions of memory region A. In this manner, fashion, etc. memory regions may be tested, repaired, characterized, etc. and as a result be disconnected and/or otherwise removed, disabled etc. while normal operations may be continued etc. Of course other variations, implementations, steps, algorithms, etc. are possible to copy, move, and/or otherwise temporarily hold, sore, etc. data etc. while performing, as part of performing, etc. one or more repair operations.

In one embodiment, for example, one or more repair, replacement, and/or other operations that may involve, use, employ etc. copying, moving, duplication etc. operations may be scheduled, timed, adjusted, etc. to overlap, coincide, and/or otherwise interact with one or more refresh operations etc. For example, copying etc. of memory in an area, region, space, address range to be repaired, replaced, etc. may replace, augment, overlap, be swapped with, and/or otherwise interact with one or more refresh operations that may include the area etc. to be copied, repaired, replaced, etc. For example, instead of performing a scheduled refresh on an area etc. to be repaired etc. a copy operation may be performed. Thus, for example, the reading of data that may be performed as part of a copy operation may replace, substitute for, etc. part or all of one or more refresh operations, etc. In this manner, fashion, etc. one or more parts, portions, etc. of one or more repair etc. operations may be hidden and/or other benefits may be realized, achieved, etc. For example, in this manner, fashion, etc. one or more parts, portions, etc. of one or more repair etc. operations may be merged and/or otherwise integrated with refresh operations, including the timing, scheduling, and/or any other re-timing, re-scheduling, etc. that may be used to perform refresh operations, and/or other actions associated with refresh, etc. Such integration of repair etc. operations with refresh operations may be extended to one or more other operations. For example, any operation involving access, processing, etc. of data in a block, region, area, etc. may be similarly integrated with one or more refresh operations. In one embodiment, for example, such integrated operations (e.g. copying, deduplication, repair, replacement, moving, data transfer, and/or any other similar operations and the like etc.) may be performed at the same level of granularity as one or more refresh operations. Thus, for example, refresh operations may be performed at the level of a DRAM row. The

In one embodiment, for example, NVM in a stacked memory package may store, maintain, control, keep, hold, etc. data, information, etc. on, related to, that is part of, etc. repair operations, repaired components, repaired circuits, repaired connections and/or may store etc. data, information, etc. related to any repair operations being performed, queued repair operations, repairs scheduled to be performed, and the like etc. In one embodiment, for example, logic NVM, NAND flash, and/or other non-volatile memory etc. may store etc. one or more maps, tables, indexes, pointers, lists of pointers, lists of addresses, lists of address ranges, and/or other data structures and the like etc. For example, one or more logic chips may include logic NVM to store information about repair operations, memory regions to be repaired, repair data, and/or any other data, information, etc. pertaining to repairs, spare circuits, spare connections, and/or programming data, configuration information, etc. related to repairs, spare circuits, etc.

In one embodiment, for example, maps, and/or any other data structures and the like, etc. associated with, corresponding to, etc. that are part of, etc. one or more repairs, repair operations, etc. may be read, saved, stored, restored, loaded, and/or otherwise managed, controlled, maintained, and/or otherwise manipulated etc. using state capture and/or other techniques as described above and/or elsewhere herein and/or in one or more specifications incorporated by reference.

In one embodiment, for example, NVM in a stacked memory package may store, maintain, control, keep, hold, etc. data, information, etc. on, related to, that is part of, etc. testing, characterization, and/or any other similar, related, etc. operations.

In one embodiment, for example, the memory system 18-200 may include one or more logic chips (LC). For example, the logic chip may be located at the bottom of a stack of stacked memory chips. Of course the logic chip and/or logic chip functions may be included, located, positioned, etc. at any location(s) (e.g. including distributed locations, etc.) in a stacked memory package. In one embodiment, for example, one or more logic chips may be a chip platform, semiconductor platform, platform, base, foundation, base chip, logic base, etc. In one embodiment, for example, a logic chip etc. may be implemented in the context of FIG. 1B of U.S. application Ser. No. 13/710,411, filed Dec. 10, 2012, titled “SYSTEM, METHOD, AND COMPUTER PROGRAM PRODUCT FOR IMPROVING MEMORY SYSTEMS,” and the accompanying text descriptions of this and any other figures in U.S. application Ser. No. 13/710,411, filed Dec. 10, 2012, titled “SYSTEM, METHOD, AND COMPUTER PROGRAM PRODUCT FOR IMPROVING MEMORY SYSTEMS,” that may depict, illustrate, describe, etc. logic chips etc. and/or the architectures, circuits, contents, functions, behaviors, features, and/or any other aspects and the like of logic chips, similar functions, etc. A stacked memory package, may, for example, include one or more logic chips and one or more stacked memory chips. For example, the stacked memory chips and/or logic chips may be connected, coupled, joined, interconnected, stacked, etc. using TSV and/or any other connection technologies, techniques, etc.

In one embodiment, logic chip functions, responsibilities, behaviors, operations, and/or other similar features etc. may include one or more of the following (but not limited to the following): repair (e.g. of circuits, connections, components, memory circuits, combinations of these and the like etc.), dynamic sparing (e.g. during operation, etc.), static repair (e.g. at test, at start-up, etc.), component replacement, system management, system maintenance, test functions, self-test functions, calibration (e.g. of PHY circuits, equalization, levelization, etc.), data retry (e.g. on error conditions, on failed transmissions, etc.), data replay, and/or other similar, related, etc. functions, processes, operations, behaviors, and/or the like etc. In one embodiment, such logic chip functions may use one or more techniques, mechanisms, processes, behaviors, algorithms, architectures, designs, and/or combinations of these and/or other similar, related, etc. techniques etc. as may be described above and/or elsewhere herein and/or in one or more specifications incorporated by reference.

In one embodiment, one or more logic chips in a stacked memory package may include one or more memory controllers. For example, each memory controller may be connected to, coupled to, joined to, interconnected to, associated with, correspond to, etc. one or more regions, areas, etc. of memory in one or more stacked memory chips. For example, each memory controller may be connected etc. to one or more echelons, sections, slices, combinations of these and/or any other groups, collections, sets, etc. of memory regions. For example, each memory controller may control, operate, manage, maintain, etc. one or more of these echelons etc. In one embodiment, one or more memory controllers may perform, execute, implement, manage, etc. all or nearly all of the memory control functions (e.g. may operate in an autonomous or nearly autonomous fashion, manner, etc.). For example, a system CPU may configure, control, test, initialize, etc. one or more memory controllers, but the normal operation of memory control (e.g. for reading data, writing data, and/or performing etc. other similar, related, etc. operations, commands, instructions, etc.) may be assigned to, performed by, etc. the memory controllers. Thus, in this case, for example, one or more memory controllers may be considered to operate in an autonomous manner (or independent manner, etc.) for reading, writing etc. As an alternative view, for example, may consider the role of a system CPU and/or other system component etc. in communicating configuration information, etc. to the memory controllers etc. and thus one or more memory controllers may also be regarded as operating in a semi-autonomous manner (e.g. with some input, limited input, initial configuration input, some programming, etc. from one or more external sources, system CPUs, other system components, etc.). In one embodiment, one or more memory controllers may perform, execute, implement, etc. memory control functions in collaboration with, in cooperation with, jointly with, etc. one or more any other memory controllers, memory control functions, memory control circuits, etc. Thus, in this case, for example, memory control functions, behavior, operations, etc. may be regarded, viewed, etc. as distributed between one or more system components (e.g. between CPU and stacked memory package, etc.). Thus, in this case, for example, memory control functions, may be implemented, executed, etc. in a distributed fashion, manner, etc. In one embodiment, for example, a first memory control function, set of control functions, memory controller, control circuits, control operations, parts and/or portions of these, any other similar control circuits, functions and the like etc. may be located in one or more system CPUs in a memory system and a second memory control function etc. may be located in a logic chip and/or any other logic in a stacked memory package.

This specification and one or more specifications incorporated by reference may use the term echelon to describe a group of sections (e.g. groups of arrays, groups of banks, any other portions(s), etc.) that are grouped together logically (possibly also grouped together electrically and/or grouped together physically, etc.) possibly on multiple stacked memory chips, for example. The logical access to an echelon may be achieved by the coupling of one or more sections to one or more logic chips, for example.

A slice may be a collection, group, set, etc. or memory regions, parts, portions, etc. One or more of the specifications incorporated by reference may use the term slice in a similar, but not necessarily identical, manner. Thus, to avoid any confusion over the use of the term slice, this specification may use the term section to describe a group of portions (e.g. arrays, subarrays, banks, and/or any number, type, kind of other portions(s), part(s), etc.) that are grouped together logically (possibly also electrically and/or physically), possibly on the same stacked memory chip, and that may form part of a larger group across multiple stacked memory chips for example.

In one embodiment, one or more memory controllers in a stacked memory package may control, handle, execute, buffer, retire, perform, manage, and/or otherwise implement etc. one or more requests, commands, instructions, etc. For example, each memory controller may control etc. all requests etc. directed at, targeted at, directed to, addressed to, etc. one or more memory regions etc. that may be coupled to, connected to, associated with, correspond to, etc. the memory controller.

In one embodiment, one or more memory controllers in a stacked memory package may control, handle, execute, perform, etc. one or more refresh operations, etc.

In one embodiment, one or more memory controllers in a stacked memory package may control, handle, execute, perform, etc. one or more refresh operations, etc. in an independent manner, fashion etc. from the host memory controller, system CPU, and/or equivalent, similar, related system components, etc. Thus, in this case, for example, one or more memory controllers may operate independently, in an autonomous manner, in a semi-autonomous manner, independent of a host controller, etc.

In one embodiment, one or more memory controllers in a stacked memory package may control, handle, execute, perform, etc. one or more refresh operations, etc. collaboratively with, in a collaborative fashion with, in conjunction with, including input, etc. one or more host memory controllers, and/or any other system components, etc.

In one embodiment, one or more memory controllers in a stacked memory package may return one or more responses, completions, etc. In one embodiment, one or more memory controllers in a stacked memory package may transmit, prepare, assemble, merge, create, generate, etc. one or more completions, responses, etc. For example, in one embodiment, one or more memory controllers and/or associated logic etc. may track non-posted commands and/or tags, IDs and/or other similar sequence numbers and the like etc. that may be part of one or more non-posted commands. For example, in one embodiment, one or more memory controllers and/or associated logic etc. may insert one or more tags etc. in one or more responses, completions, etc. For example, the tags etc. may act to uniquely identify one or more responses, completions, etc. with one or more commands, requests, etc. that may be sent to one or more stacked memory packages, etc.

In one embodiment, one or more memory controllers in a stacked memory package may manage, handle, maintain, etc. the ordering of responses, completions, etc. For example, the order of responses may be managed etc. as a function of the order of corresponding commands received etc. For example, ordering of responses, completions, etc. may be managed as a function of the order that commands are received on one or more high-speed links, etc. For example, ordering of responses, completions, etc. may be managed as a function of the order specified, programmed, configured etc. by a host controller, system CPU, other system component, etc. For example, ordering of responses, completions, etc. may be managed as a function of one or more ordering rules, an ordering rule set, etc. For example, ordering of responses, completions, etc. may be managed as described elsewhere herein and/or in one or more specifications incorporated by reference, etc.

It should be noted that, one or more aspects of the various embodiments of the present invention may be included in an article of manufacture (e.g. one or more computer program products) having, for instance, computer usable media. The media has embodied therein, for instance, computer readable program code for providing and facilitating the capabilities of the various embodiments of the present invention. The article of manufacture can be included as a part of a computer system or sold separately.

Additionally, one or more aspects of the various embodiments of the present invention may be designed using computer readable program code for providing and/or facilitating the capabilities of the various embodiments or configurations of embodiments of the present invention.

Additionally, one or more aspects of the various embodiments of the present invention may use computer readable program code for providing and facilitating the capabilities of the various embodiments or configurations of embodiments of the present invention and that may be included as a part of a computer system and/or memory system and/or sold separately.

Additionally, at least one program storage device readable by a machine, tangibly embodying at least one program of instructions executable by the machine to perform the capabilities of the various embodiments of the present invention can be provided.

Additionally, as an option, one or more aspects of the various embodiments of the present invention (including those embodiments described in one or more applications incorporated by reference and combinations thereof) may be programmed, configured, reconfigured and or otherwise modified, altered, changed, etc. Of course, not all aspects need be programmable, configurable or reconfigurable. As an option, one or more aspects of the various embodiments of the present invention may be fixed, or a subset of aspects of the various embodiments may be fixed (e.g. programmed etc.), at design time (through design options and/or CAD program options and/or any other design or designer choices and the like etc.), at manufacturing time (according to demand for example, by fuse or any other programming options, using mask or assembly options, combinations of these and the like etc.); at test time (depending on test results, yield, failure mechanisms, diagnostics, measurements, combinations of these and/or any other results etc.); at start-up (depending on BIOS settings, configuration files, preferences, operating modes, performance desired, user settings, configuration files, combinations of these and the like etc.); at run time (depending on use, power, performance desired, feedback from measurements, circuit functions, combinations of these and the like etc.); at combinations of these times and/or at any time etc.

The diagrams depicted herein are just examples. There may be many variations to these diagrams or the steps (or operations) described therein without departing from the spirit of the various embodiments of the invention. For instance, the steps may be performed in a differing order, or steps may be added, deleted or modified. All of these variations are considered a part of the claimed invention.

In various optional embodiments, the features, capabilities, techniques, and/or technology, etc. of the memory and/or storage devices, networks, mobile devices, peripherals, hardware, and/or software, etc. disclosed in the following applications may or may not be incorporated into any of the embodiments disclosed herein: U.S. Provisional Application No. 61/472,558, filed Apr. 6, 2011, titled “Multiple class memory systems”; U.S. Provisional Application No. 61/502,100, filed Jun. 28, 2011, titled “SYSTEM, METHOD, AND COMPUTER PROGRAM PRODUCT FOR IMPROVING MEMORY SYSTEMS”; U.S. Provisional Application No. 61/515,835, filed Aug. 5, 2011, titled “STORAGE SYSTEMS”; U.S. Provisional Application No. 61/566,577, filed Dec. 2, 2011, titled “IMPROVED MOBILE DEVICES”; U.S. Provisional Application No. 61/470,336, filed Mar. 31, 2011, titled “SYSTEM, METHOD, AND COMPUTER PROGRAM PRODUCT FOR UTILIZING IMAGE RECOGNITION TO PERFORM AN ACTION”; U.S. Provisional Application No. 61/470,391, filed Mar. 31, 2011, titled “SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE”; U.S. Provisional Application No. 61/569,213, filed Dec. 9, 2011, titled “SYSTEM, METHOD, AND COMPUTER PROGRAM PRODUCT FOR MODIFYING CONTENT”; U.S. Provisional Application No. 61/569,107, filed Dec. 9, 2011, titled “SYSTEM, METHOD, AND COMPUTER PROGRAM PRODUCT FOR IMPROVING MEMORY SYSTEMS”; U.S. Provisional Application No. 61/580,300, filed Dec. 26, 2011, titled “SYSTEM, METHOD, AND COMPUTER PROGRAM PRODUCT FOR IMPROVING MEMORY SYSTEMS”; U.S. Provisional Application No. 61/585,640, filed Jan. 31, 2012, titled “SYSTEM, METHOD, AND COMPUTER PROGRAM PRODUCT FOR IMPROVING MEMORY SYSTEMS”; U.S. Provisional Application No. 61/581,918, filed Jan. 13, 2012, titled “USER INTERFACE SYSTEM, METHOD, AND COMPUTER PROGRAM PRODUCT”; U.S. Provisional Application No. 61/602,034, filed Feb. 22, 2012, titled “SYSTEM, METHOD, AND COMPUTER PROGRAM PRODUCT FOR IMPROVING MEMORY SYSTEMS”; US Provisional application Ser. No. 61/608,085, filed Mar. 7, 2012, titled “SYSTEM, METHOD, AND COMPUTER PROGRAM PRODUCT FOR IMPROVING MEMORY SYSTEMS”; US Provisional application Ser. No. 61/635,834, filed Apr. 19, 2012, titled “SYSTEM, METHOD, AND COMPUTER PROGRAM PRODUCT FOR IMPROVING MEMORY SYSTEMS”; U.S. application Ser. No. 13/441,132, filed Apr. 6, 2012, titled “MULTIPLE CLASS MEMORY SYSTEMS”; U.S. application Ser. No. 13/433,283, filed Mar. 28, 2012, titled “SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE”; U.S. application Ser. No. 13/433,279, filed Mar. 28, 2012, titled “SYSTEM, METHOD, AND COMPUTER PROGRAM PRODUCT FOR UTILIZING IMAGE RECOGNITION TO PERFORM AN ACTION”; U.S. Provisional Application No. 61/647,492, filed May 15, 2012, titled “SYSTEM, METHOD, AND COMPUTER PROGRAM PRODUCT FOR CONFIGURING A SYSTEM ASSOCIATED WITH MEMORY”; US Provisional application Ser. No. 61/665,301, filed Jun. 27, 2012, titled “SYSTEM, METHOD, AND COMPUTER PROGRAM PRODUCT FOR ROUTING PACKETS OF DATA”; U.S. Provisional Application No. 61/673,192, filed Jul. 19, 2012, titled “SYSTEM, METHOD, AND COMPUTER PROGRAM PRODUCT FOR REDUCING A LATENCY ASSOCIATED WITH A MEMORY SYSTEM”; US Provisional application Ser. No. 61/679,720, filed Aug. 4, 2012, titled “SYSTEM, METHOD, AND COMPUTER PROGRAM PRODUCT FOR PROVIDING CONFIGURABLE COMMUNICATION PATHS TO MEMORY PORTIONS DURING OPERATION”; US Provisional application Ser. No. 61/698,690, filed Sep. 9, 2012, titled “SYSTEM, METHOD, AND COMPUTER PROGRAM PRODUCT FOR TRANSFORMING A PLURALITY OF COMMANDS OR PACKETS IN CONNECTION WITH AT LEAST ONE MEMORY”; U.S. Provisional Application No. 61/712,762, filed Oct. 11, 2012, titled “SYSTEM, METHOD, AND COMPUTER PROGRAM PRODUCT FOR LINKING DEVICES FOR COORDINATED OPERATION;” U.S. Provisional Application No. 61/714,154, filed Oct. 15, 2012, titled “SYSTEM, METHOD, AND COMPUTER PROGRAM PRODUCT FOR CONTROLLING A REFRESH ASSOCIATED WITH A MEMORY;” U.S. Provisional Application No. 61/730,404, filed Nov. 27, 2012, titled “SYSTEM, METHOD, AND COMPUTER PROGRAM PRODUCT FOR MAKING AT LEAST ONE FUNCTIONALITY ASSOCIATED WITH A FIRST DEVICE AVAILABLE ON A SECOND DEVICE;” U.S. application Ser. No. 13/433,279, filed Mar. 28, 2012, titled “SYSTEM, METHOD, AND COMPUTER PROGRAM PRODUCT FOR UTILIZING IMAGE RECOGNITION TO PERFORM AN ACTION;” U.S. application Ser. No. 13/433,283, filed Mar. 28, 2012, titled “SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE;” U.S. application Ser. No. 13/441,132, filed Apr. 6, 2012, titled “MULTIPLE CLASS MEMORY SYSTEMS;” U.S. application Ser. No. 13/567,004, filed Aug. 3, 2012, titled “USER INTERFACE SYSTEM, METHOD, AND COMPUTER PROGRAM PRODUCT;” U.S. application Ser. No. 13/690,781, filed Nov. 30, 2012, titled “MOBILE DEVICES;” U.S. application Ser. No. 13/710,411, filed Dec. 10, 2012, titled “SYSTEM, METHOD, AND COMPUTER PROGRAM PRODUCT FOR IMPROVING MEMORY SYSTEMS;” U.S. Provisional Application No. 61/759,764, filed Feb. 1, 2013, titled “SYSTEM, METHOD, AND COMPUTER PROGRAM PRODUCT FOR MODIFYING COMMANDS DIRECTED TO MEMORY;” U.S. Provisional Application No. 61/763,774, filed Feb. 12, 2013, titled “SYSTEM, METHOD, AND COMPUTER PROGRAM PRODUCT FOR DERIVED MODEL-BASED FUNCTIONALITY;” U.S. Provisional Application No. 61/805,507, filed Mar. 26, 2013, titled “SYSTEM, METHOD, AND COMPUTER PROGRAM PRODUCT FOR DEVICE INTEROPERABILITY;” and U.S. Provisional Application No. 61/833,408, filed Jun. 10, 2013, titled “SYSTEM, METHOD, AND COMPUTER PROGRAM PRODUCT FOR PATH OPTIMIZATION”. Each of the foregoing applications are hereby incorporated by reference in their entirety for all purposes.

References in this specification and/or references in specifications incorporated by reference to “one embodiment,” “an embodiment,” “another embodiment,” “the embodiment,” “other embodiment,” and other similar terms may mean that particular aspects, architectures, functions, features, structures, characteristics, behaviors, and the like etc. of an embodiment that may be described in connection with the embodiment may be included in at least one implementation. Thus references to “in one embodiment” and other similar terms may not necessarily refer to the same embodiment. The particular aspects etc. may be included in forms other than the particular embodiment described and/or illustrated and all such forms may be encompassed within the scope and claims of the present application.

References in this specification and/or references in specifications incorporated by reference to “for example” may mean that particular aspects, architectures, functions, features, structures, characteristics, behaviors, etc. described in connection with the embodiment or example may be included in at least one implementation. Thus references to an “example” may not necessarily refer to the same embodiment, example, etc. The particular aspects etc. may be included in forms other than the particular embodiment or example described and/or illustrated and all such forms may be encompassed within the scope and claims of the present application.

References in this specification and/or references in specifications incorporated by reference to “as an option” may mean that particular aspects, architectures, functions, features, structures, characteristics, behaviors, etc. described in connection with the embodiment or example may be included in at least one implementation. Thus references to an “as an option” may not necessarily require aspects etc. to be configurable, programmable, etc. though they may be. The particular aspects etc. may be included in forms other than the particular embodiment or example described and/or illustrated and all such forms may be encompassed within the scope and claims of the present application.

This specification and/or specifications incorporated by reference may refer to a list of alternatives. For example, a first reference such as “A (e.g. B, C, D, E, etc.)” may refer to a list of alternatives to A including (but not limited to) B, C, D, E. A second reference to “A etc.” may then be equivalent to the first reference to “A (e.g. B, C, D, E, etc.).” Thus, a reference to “A etc.” may be interpreted to mean “A (e.g. B, C, D, E, etc.).”

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1.-20. (canceled)

21. An apparatus, comprising:
a first semiconductor platform including a first memory; and
a second semiconductor platform stacked with the first semiconductor platform and including a second memory;
wherein the apparatus is operable for:
receiving a read command or write command,
identifying one or more faulty components of the apparatus, and
adjusting at least one timing in connection with the read command or write command, in response to the identification of the one or more faulty components of the apparatus.

22. The apparatus of claim 21, wherein the apparatus is operable for repairing the one or more faulty components of the apparatus.

23. The apparatus of claim 22, wherein the apparatus is operable for modifying the repairing in response to a command.

24. The apparatus of claim 21, wherein the apparatus is operable such that the one or more faulty components includes at least one circuit.

25. The apparatus of claim 21, wherein the apparatus is operable such that the one or more faulty components includes at least one through silicon via.

26. The apparatus of claim 21, wherein the apparatus is operable such that the one or more faulty components is part of a memory array.

27. An apparatus, comprising:
circuitry for use with:
a first semiconductor platform including a first memory, and
a second semiconductor platform stacked with the first semiconductor platform and including a second memory;
wherein the apparatus is operable for:
identifying one or more faulty components of at least one of the first semiconductor platform or the second semiconductor platform, and
adjusting at least one aspect in connection with at least one command communicated via a bus operable for variable latency such that a first latency of a first response to a first command is capable of being different than a second latency of a second response to a second command, based on the identification of the one or more faulty components of at least one of the first semiconductor platform or the second semiconductor platform.

28. The apparatus of claim 27, wherein the apparatus is operable such that the at least one aspect in connection with the at least one command includes a timing thereof.

29. The apparatus of claim 27, wherein the apparatus is operable such that the at least one aspect in connection with the at least one command includes a destination thereof.

30. The apparatus of claim 29, wherein the apparatus is operable for redirecting the at least one command from a first destination address associated with the one or more faulty components to a second destination address.

31. The apparatus of claim 30, wherein the apparatus is operable such that the second destination address is associated with one or more spare components.

32. The apparatus of claim 27, wherein the apparatus is operable such that the adjusting is hierarchical.

33. The apparatus of claim 27, wherein the apparatus is operable for identifying one or more spare components of at least one of the first semiconductor platform or the second semiconductor platform, where the one or more faulty components are components of one or more particular blocks including a plurality of non-faulty components.

34. The apparatus of claim 33, wherein the apparatus is operable for identifying one or spare blocks, and utilizing the one or spare blocks in place of the one or more particular blocks.

35. The apparatus of claim 33, wherein the apparatus is operable for identifying one or spare blocks, and utilizing the one or spare blocks in place of the one or more particular blocks, if the one or more spare components are incapable of being identified.

36. The apparatus of claim 33, wherein the apparatus is operable for identifying one or spare blocks, and utilizing the one or spare blocks in place of the one or more particular blocks, if the one or more spare components are unavailable.

37. The apparatus of claim 33, wherein the apparatus is operable for identifying one or spare blocks, and utilizing the one or spare blocks in place of the one or more particular blocks, if availability of the one or more spare components is below a predetermined threshold.

38. The apparatus of claim 27, wherein the apparatus is operable such that an operation that involves the adjusting results in at least one additional operation.

39. The apparatus of claim 38, wherein the apparatus is operable such that the at least one additional operation includes a copy operation.

40. The apparatus of claim 27, wherein the apparatus is operable such that at least one of:
said at least one aspect in connection with the at least one command includes a timing;
said at least one command includes a write command or a read command;
said at least one command include one or more requests;
said latency includes delay;
said bus includes a split transaction bus;
said identifying occurs after the at least one command is communicated;
said identifying occurs before the at least one command is communicated;
said identifying the one or more faulty components includes at least one of a diagnosis, a testing, a characterization, a probing, a prediction, or a measurement;
said one or more faulty components includes at least one of bad components, broken components, or suspect components;
the terms circuitry and apparatus both do not invoke 35 U.S.C. 112, sixth paragraph;
said one or more faulty components include one or more faulty components of the first semiconductor platform;
said one or more faulty components include one or more faulty components of the second semiconductor platform;
said adjusting of the at least one aspect in connection with the at least one command includes adjusting at least one aspect in connection with at least one instruction that, in turn, results in an adjustment of the at least one aspect in connection with the at least one command; or
said adjusting of the at least one aspect in connection with the at least one command, is in response to the identification of the one or more faulty components of at least one of the first semiconductor platform or the second semiconductor platform.

41. An apparatus, comprising:
a first semiconductor platform including a first memory; and
a second semiconductor platform stacked with the first semiconductor platform and including a second memory;
means for:
identifying one or more faulty components of the apparatus; and
adjusting at least one aspect in connection with a read command or a write command, in response to the identification of the one or more faulty components of the apparatus.

42. The apparatus of claim 39, wherein the apparatus is operable such that the copy operation includes copying data to a temporary memory.

43. The apparatus of claim 39, wherein the apparatus is operable such that the copy operation includes copying data to a temporary memory while the one or more faulty components of at least one of the first semiconductor platform or the second semiconductor platform are repaired.

44. The apparatus of claim 39, wherein the apparatus is operable such that the copy operation includes copying data to a temporary memory, so that normal operation is capable of continuing.

45. The apparatus of claim 44, wherein the apparatus is operable such that the copy operation is timed to coincide, at least in part, with a refresh operation.

46. The apparatus of claim 44, wherein the apparatus is operable such that the copy operation replaces, at least in part, a refresh operation.

47. The apparatus of claim 44, wherein the apparatus is operable such that the copy operation is integrated, at least in part, in a refresh operation.

48. The apparatus of claim 44, wherein the apparatus is operable such that the copy operation is performed at a same level of granularity as a refresh operation.

49. The apparatus of claim 27, wherein the apparatus is operable such that the adjusting is performed utilizing an address map.

50. The apparatus of claim 27, wherein the apparatus is operable such that the adjusting is performed utilizing a mat map.

51. The apparatus of claim 27, wherein the apparatus is operable such that the adjusting is performed utilizing a plurality of maps.

52. The apparatus of claim 51, wherein the apparatus is operable such that the plurality of maps includes a first type of map and a second type of map.

53. The apparatus of claim 52, wherein the apparatus is operable such that the first type of map includes an assembly map and the second type of map includes a run-time map.

54. The apparatus of claim 52, wherein the apparatus is operable such that the first type of map is stored utilizing a first type of memory and the second type of map is stored utilizing a second type of memory.

55. The apparatus of claim 54, wherein the apparatus is operable such that the first type of memory includes a one-time programmable memory and the second type of memory includes a multiple-time programmable memory.

56. The apparatus of claim 27, wherein the apparatus is operable such that one or more links are included between one or more logical memory addresses and at least one aspect of one or more physical memory addresses.

57. The apparatus of claim 56, wherein the apparatus is operable such that the at least one aspect of the one or more physical memory addresses includes the one or more physical memory addresses themselves.

58. The apparatus of claim 56, wherein the apparatus is operable such that the at least one aspect of the one or more physical memory addresses includes a location of the one or more physical memory addresses.

59. The apparatus of claim 56, wherein the apparatus is operable such that the at least one aspect of the one or more physical memory addresses includes a status of the one or more physical memory addresses.

60. The apparatus of claim 56, wherein the apparatus is operable such that the one or more links are updated at start-up.

61. The apparatus of claim 56, wherein the apparatus is operable such that the one or more links are stored on at least one of the first semiconductor platform or the second semiconductor platform.

62. The apparatus of claim 61, wherein the apparatus is operable such that the one or more links are loaded from at least one of the first semiconductor platform or the second semiconductor platform into separate memory which is utilized in connection with the adjusting.

63. The apparatus of claim 56, wherein the apparatus is operable such that the one or more links are stored on a central processing unit.

64. The apparatus of claim 56, wherein the apparatus is operable such that the one or more links are stored on a chip separate from a central processing unit, the first semiconductor platform, and the second semiconductor platform.

65. The apparatus of claim 27, wherein the apparatus is configured such that the circuitry is a component of a central processing unit.

66. The apparatus of claim 27, wherein the apparatus is configured such that the circuitry is a component of a chip operable for communicating between a central processing unit, and the first semiconductor platform and the second semiconductor platform.

67. The apparatus of claim 66, wherein the apparatus is configured such that the chip includes a logic chip.

68. The apparatus of claim 66, wherein the apparatus is configured such that the chip is stacked with the first semiconductor platform and the second semiconductor platform.

69. The apparatus of claim 27, wherein the apparatus is operable such that the one or more faulty components includes at least one circuit.

70. The apparatus of claim 27, wherein the apparatus is operable such that the one or more faulty components is part of a memory array.

71. The apparatus of claim 27, wherein the apparatus is operable such that the one or more faulty components includes at least one through silicon via.

72. The apparatus of claim 27, wherein the apparatus is operable for repairing the one or more faulty components of at least one of the first semiconductor platform or the second semiconductor platform.

73. A system including the apparatus of claim 27, and further comprising the first semiconductor platform and the second semiconductor platform.

74. A system including the apparatus of claim 27, and further comprising the bus, and the bus includes a split transaction bus.

75. The apparatus of claim 27, wherein the apparatus is operable for adjusting the at least one aspect in connection with the at least one command in response to a read or write command, for dynamically repairing the one or more faulty components of at least one of the first semiconductor platform or the second semiconductor platform.

76. The apparatus of claim 27, wherein the apparatus is operable for adjusting the at least one aspect in connection with the at least one command at start up, for statically repairing the one or more faulty components of at least one of the first semiconductor platform or the second semiconductor platform.

77. The apparatus of claim 27, wherein the apparatus is operable for adjusting a repairing in response to the at least one command.

78. The apparatus of claim 27, wherein the circuitry is operable for performing the identifying and the adjusting.

79. The apparatus of claim 21, wherein the apparatus is operable such that the read command or write command is received via a split transaction bus.

80. The apparatus of claim 21, wherein the apparatus is operable such that the read command or write command is received via a bus operable for variable response latency.

81. The apparatus of claim 21, wherein the apparatus is operable such that the read command or write command is received via a bus operable for variable latency such that responses to different commands have different latencies.

82. An apparatus, comprising:
a first semiconductor platform including a first memory;
a second semiconductor platform stacked with the first semiconductor platform and including a second memory; and
circuitry in communication with the first memory and the second memory, the circuitry configured to:
identify one or more faulty components of the apparatus, and
adjust at least one aspect in connection with a read command or a write command, in response to the identification of the one or more faulty components of the apparatus.
